(19) United States
(12) Patent Application Publication
(10) Pub. No.: US 2014/0375762 A1
(43) Pub. Date: Dec. 25, 2014

(54) INFORMATION PROCESSING APPARATUS AND METHOD, IMAGE PROCESSING APPARATUS AND METHOD, AND PROGRAM

(71) Applicant: Sony Corporation, Tokyo (JP)

(72) Inventor: Mitsuharu Ohki, Tokyo (JP)

(73) Assignee: Sony Corporation, Tokyo (JP)

(21) Appl. No.: 14/377,221

(22) PCT Filed: Feb. 1, 2013
(86) PCT No.: PCT/JP2013/052329

§ 371 Date: Aug. 7, 2014

(30) Foreign Application Priority Data
Feb. 17, 2012 (JP) 2012-032255

(51) Int. Cl. H04N 5/232

(52) U.S. Cl. CPC H04N 5/23238
USPC 348/36

(57) ABSTRACT

The present technology relates to information processing apparatus and method, image processing apparatus and method, and a program which enable acquisition of a panoramic image with higher quality.

According to the image processing apparatus, homogeneous transformation matrixes H′_{s,s+1} between adjacent captured images are acquired under a more generous condition, and homogeneous transformation matrixes H″_{s,s+1} between the adjacent captured images are acquired under a more strict condition, for N captured images which are successively captured. Furthermore, the homogeneous transformation matrixes H′_{s,s+1} and the homogeneous transformation matrixes H″_{s,s+1} are accumulated to acquire a homogeneous transformation matrix H′_{1,s} between first and s-th captured images, and the homogeneous transformation matrixes H″_{s,s+1} are accumulated to acquire a homogeneous transformation matrix H″_{1,s} between the first and the s-th captured images. The respective captured images are connected based on a homogeneous transformation matrix acquired by performing weighted addition of the homogeneous transformation matrix H′_{1,s} and the homogeneous transformation matrix H″_{1,s}, and a panoramic image is generated. The present technology can be applied to the image processing apparatus.

### TECHNICAL FIELD

The present technology relates to an information processing apparatus and method, an image processing apparatus and method, and a program, and particularly to an information processing apparatus and method, an image processing apparatus and method, and a program capable of acquiring a panoramic image with higher quality.

### BACKGROUND ART

For example, a technology for generating a wide panoramic image by using a plurality of captured images which are successively captured while a camera is rotated is known (see PTL 1, for example). Such a panoramic image is generated by aligning and synthesizing the plurality of captured images.

### CITATION LIST

### Patent Literature

PTL 1: Japanese Patent No. 3168443

### SUMMARY OF INVENTION

### Technical Problem

However, it is not possible to acquire a panoramic image with high quality according to the aforementioned technology since positional relationships, color phases, and the like of the captured images to be synthesized are not taken into consideration.

The present technology was achieved in view of such circumstances, and an object thereof is to make it possible to acquire a panoramic image with higher quality.

### Solution to Problem

An information processing apparatus according to a first aspect of the present invention, which generates a single data item by connecting a plurality of data arranged in an order, includes: a first map calculation unit which calculates a map H1 representing a correlation between mutually adjacent data items under a first condition with a higher degree of freedom; a second map calculation unit which calculates a map H2 representing the correlation between the mutually adjacent data items under a second condition with a lower degree of freedom as compared to the first condition; and a data generation unit which acquires a map H3 and generates the single data item based on the map H3, the map H3 being configured such that the correlation between target data as the data item and adjacent data adjacent to the target data becomes a relationship closer to the correlation represented by the map H1 than to the correlation represented by the map H2 at a position in the target data close to the adjacent data and becomes a relationship closer to the relationship represented by the map H2 than to the correlation represented by the map H1 at a position in the target data far from the adjacent data, based on the map H1 and the map H2.

The map H3 may be a map configured such that the correlation at each position in the target data is a relationship acquired by prorating the correlation represented by the map H1 and the correlation represented by the map H2 in accordance with the position in the target data.

The map H3 may be a map configured such that the correlation between the target data and the adjacent data becomes the correlation represented by the map H1 at a first position in the target data in the vicinity of the adjacent data and becomes the correlation represented by the map H2 at a second position in the target data far from the adjacent data.

The plurality of data items may be a plurality of captured images arranged in an order, and the data generation unit may generate a panoramic image as the single data by acquiring homogeneous transformation matrixes representing positional relationships between the captured images as the map H3 and connecting the captured images based on the homogeneous transformation matrix.

The first map calculation unit may calculate a homogeneous transformation matrixes Q1 which represent positional relationships between the mutually adjacent captured images as the map H1, the second map calculation unit may calculate homogeneous transformation matrixes Q2 which represent positional relationships between the mutually adjacent captured images as the map H2 under a condition that the map H2 is an orthogonal matrix, the information processing apparatus may further include a first homogeneous transformation matrix calculation unit which calculates a homogeneous transformation matrix Q1₁ₛ representing a positional relationship between a reference first captured image and an s-th captured image by accumulating the homogeneous transformation matrixes Q2 acquired for the first captured image to an s−1-th captured image in the captured images arranged in an order and multiplying the accumulated homogeneous transformation matrixes Q2 by the homogeneous transformation matrix Q1 of the s-th captured image, and a second homogeneous transformation matrix calculation unit which calculates a homogeneous transformation matrix Q2₁ₛ representing a positional relationship between the first and the s-th captured images by accumulating the homogeneous transformation matrixes Q2 acquired for the first to the s-th captured images, and the data generation unit may calculate a homogeneous transformation matrix Q3₁ₛ as the map H3 representing a positional relationship between the first and the s-th captured images based on the homogeneous transformation matrix Q1₁ₛ, and the homogeneous transformation matrix Q2₁ₛ.

The data generation unit may acquire the homogeneous transformation matrix Q3₁ₛ at each position on the s-th captured image by performing weighted addition of the homogeneous transformation matrix Q1₁ₛ and the homogeneous transformation matrix Q2₁ₛ with a weight in accordance with the position on the s-th captured image.

The plurality of data items may be a plurality of captured images arranged in an order, and the data generation unit may generate a panoramic image as the single data item by acquiring gain values of the respective color components between the captured images as the map H3 and connecting the captured images after gain adjustment based on the gain values.

The first map calculation unit may calculate gain values G1 of the respective color components between the mutually adjacent captured images as the map H1 under a condition that the gain values of the respective color components are independent, the second map calculation unit may calculate gain values G2 of the respective color components between the mutually adjacent captured images as the map H2 under a condition that the gain values of the respective color components are the same, the information processing apparatus may further include a first accumulated gain value calculation unit which calculates a gain value G1₁ₛ between a reference first captured image and an s-th captured image by accumulating the gain values G2 acquired for the first captured image to an s−1-th captured image in the captured images arranged in an order and multiplying the accumulated gain values G2 by the gain value G1 of the s-th captured image, and a second accumulated gain value calculation unit which calculates a gain value G2₁ₛ between the first and the s-th captured images by accumulating the gain values G2 acquired for the first to the s-th captured images, and the data generation unit may calculate a gain value G3₁ₛ between the first and the s-th captured images as the map H3 based on the gain value G1₁ₛ and the gain value G2₁ₛ.

The data generation unit may acquire the gain value G3₁ₛ at each position on the s-th captured image by performing weighted addition of the gain value G1₁ₛ and the gain value G2₁ₛ with a weight in accordance with the position on the s-th captured image.

An information processing method or a program according to a first aspect of the present technology is an information processing method or a program for generating a single data item by connecting a plurality of data items arranged in an order, and the method or the program includes the steps of: calculating a map H1 which represents a correlation between mutually adjacent data items under a first condition with a higher degree of freedom; calculating a map H2 which represents the correlation between the mutually adjacent data items under a second condition with a lower degree of freedom as compared to the first condition; and acquiring a map H3 and generating the single data item based on the map H3, the map H3 being configured such that the correlation between target data as the data item and adjacent data adjacent to the target data becomes a relationship closer to the correlation represented by the map H1 than to the correlation represented by the map H2 at a position in the target data close to the adjacent data and becomes a relationship closer to the relationship represented by the map H2 than to the correlation represented by the map H1 at a position in the target data far from the adjacent data, based on the map H1 and the map H2.

According to the first aspect of the present technology, in information processing for generating a single data item by connecting a plurality of data items arranged in an order, a map H1 which represents a correlation between mutually adjacent data items is calculated under a first condition with a higher degree of freedom, a map H2 which represents the correlation between the mutually adjacent data items is calculated under a second condition with a lower degree of freedom as compared to the first condition, and a map H3 is acquired and the single data item is generated based on the map H3, the map H3 being configured such that the correlation between target data as the data item and adjacent data adjacent to the target data becomes a relationship closer to the correlation represented by the map H1 than to the correlation represented by the map H2 at a position in the target data close to the adjacent data and becomes a relationship closer to the relationship represented by the map H2 than to the correlation represented by the map H1 at a position in the target data far from the adjacent data.

An image processing apparatus according to a second aspect of the present technology includes: a forward direction calculation unit which calculates a homogeneous transformation matrix Q1 representing a positional relationship between a reference first captured image and an s-th captured image by accumulating, in ascending order from the first captured image to an s-th captured image, homogeneous transformation matrixes H representing positional relationships between mutually adjacent captured images acquired for the N respective captured images that an imaging device captures while being turned; a backward direction calculation unit which calculates a homogeneous transformation matrix Q2 representing a positional relationship between the first and the s-th captured images by accumulating inverse matrixes of the homogeneous transformation matrixes H in descending order from the N-th captured image to the s-th captured image; and a homogeneous transformation matrix calculation unit which calculates a homogeneous transformation matrix Q3 representing a positional relationship between the first and the s-th captured images by prorating the homogeneous transformation matrix Q1 and the homogeneous transformation matrix Q2.

The homogeneous transformation matrix calculation unit may prorate the homogeneous transformation matrix Q1 and the homogeneous transformation matrix Q2 such that a proportion of the proration of the homogeneous transformation matrix Q1 becomes greater as a difference in imaging orders between the first and the s-th captured images is smaller.

The homogeneous transformation matrix calculation unit may prorate the homogeneous transformation matrix Q1 and the homogeneous transformation matrix Q2 such that a difference between a proportion of the proration of the homogeneous transformation matrix Q1 for the s−1-th captured image and a proportion of the proration of the homogeneous transformation matrix Q1 for the s-th captured image becomes greater as an angle between a direction of the s−1-th captured image and a direction of the s-th captured image is larger.

The homogeneous transformation matrix calculation unit may prorate the homogeneous transformation matrix Q1 and the homogeneous transformation matrix Q2 by performing weighted addition of a direction acquired by transforming a predetermined direction with reference to the s-th captured image by the homogeneous transformation matrix Q1 and a direction acquired by transforming the predetermined direction by the homogeneous transformation matrix Q2.

The image processing apparatus may further include: a panoramic image generation unit which generates a panoramic image by connecting the captured images based on the homogeneous transformation matrix Q3.

An image processing method or a program according to a second aspect of the present technology includes the steps of: calculating a homogeneous transformation matrix Q1 representing a positional relationship between a reference first captured image and an s-th captured image by accumulating, in ascending order from the first captured image to an s-th captured image, homogeneous transformation matrixes H representing positional relationships between mutually adjacent captured images acquired for the N respective captured images that an imaging device captures while being turned; calculating a homogeneous transformation matrix Q2 representing a positional relationship between the first and the s-th captured images by accumulating inverse matrixes of the homogeneous transformation matrixes H in descending order from the N-th captured image to the s-th captured image; and calculating a homogeneous transformation matrix Q3 representing a positional relationship between the first and the s-th captured images by prorating the homogeneous transformation matrix Q1 and the homogeneous transformation matrix Q2.

According to the second aspect of the present technology, a homogeneous transformation matrix Q1 representing a positional relationship between a reference first captured image and an s-th captured image is calculated by accumulating, in ascending order from the first captured image to an s-th captured image, homogeneous transformation matrixes H representing positional relationships between mutually adjacent captured images acquired for the N respective captured images that an imaging device captures while being turned, a homogeneous transformation matrix Q2 representing a positional relationship between the first and the s-th captured images is calculated by accumulating inverse matrixes of the homogeneous transformation matrixes H in descending order from the N-th captured image to the s-th captured image, and a homogeneous transformation matrix Q3 representing a positional relationship between the first and the s-th captured images is calculated by prorating the homogeneous transformation matrix Q1 and the homogeneous transformation matrix Q2.

### Advantageous Effects of Invention

According to the first aspect and the second aspect of the present technology, it is possible to acquire a panoramic image with higher quality.

### BRIEF DESCRIPTION OF DRAWINGS

FIG. 1 is a diagram illustrating corresponding pixel positions between adjacent captured images.

FIG. 2 is a diagram illustrating corresponding pixel positions between adjacent captured images.

FIG. 3 is a diagram illustrating mapping in generation of a panoramic image.

FIG. 4 is a diagram illustrating an error between the first captured image and a captured image corresponding to turning.

FIG. 5 is a diagram illustrating allocation of the error between the first captured image and the captured image corresponding to the turning.

FIG. 6 is a diagram illustrating mapping in generation of a panoramic image.

FIG. 7 is a diagram illustrating a point defined for error allocation of the captured images.

FIG. 8 is a diagram illustrating allocation of the error between the first captured image and the captured image corresponding to the turning.

FIG. 9 is a diagram illustrating error allocation between adjacent captured images.

FIG. 10 is a diagram illustrating a concept of the present technology.

FIG. 11 is a diagram showing a configuration example of an image processing apparatus.

FIG. 12 is a flowchart illustrating panoramic image generation processing.

FIG. 13 is a flowchart illustrating panoramic image generation processing.

FIG. 14 is a diagram showing a configuration example of an image processing apparatus.

FIG. 15 is a flowchart illustrating panoramic image generation processing.

FIG. 16 is a flowchart illustrating panoramic image generation processing.

FIG. 17 is a diagram illustrating corresponding pixel positions between adjacent captured images.

FIG. 18 is a diagram illustrating corresponding pixel positions between adjacent captured images.

FIG. 19 is a diagram illustrating mapping in generation of a panoramic image.

FIG. 20 is a diagram illustrating an imaging direction corresponding to a forward direction of a captured image.

FIG. 21 is a diagram illustrating an imaging direction corresponding to a backward direction of a captured image.

FIG. 22 is a diagram illustrating an error of captured images in an imaging direction.

FIG. 23 is a diagram illustrating proration of imaging directions of captured images.

FIG. 24 is a diagram illustrating proration of imaging directions of captured images.

FIG. 25 is a diagram illustrating proration of imaging directions of captured images.

FIG. 26 is a diagram illustrating proration of imaging directions of captured images.

FIG. 27 is a diagram illustrating proration of imaging directions of captured images.

FIG. 28 is a diagram showing a configuration example of an image processing apparatus.

FIG. 29 is a flowchart illustrating panoramic image generation processing.

FIG. 30 is a flowchart illustrating panoramic image generation processing.

FIG. 31 is a diagram illustrating a representative point on a captured image.

FIG. 32 is a diagram showing a configuration example of an image processing apparatus.

FIG. 33 is a flowchart illustrating panoramic image generation processing.

FIG. 34 is a flowchart illustrating panoramic image generation processing.

FIG. 35 is a diagram showing a configuration example of an image processing apparatus.

FIG. 36 is a flowchart illustrating panoramic image generation processing.

FIG. 37 is a flowchart illustrating panoramic image generation processing.

FIG. 38 is a diagram illustrating corresponding pixel positions between adjacent captured images.

FIG. 39 is a diagram illustrating generation of a panoramic image.

FIG. 40 is a diagram illustrating advantages and disadvantages of the respective solutions for acquiring a positional relationship between captured images.

FIG. 41 is a diagram showing a positional relationship of the respective captured images.

FIG. 42 is a diagram illustrating generation of a panoramic image.

FIG. 43 is a diagram illustrating advantages and disadvantages of the respective solutions for acquiring a gain value between the respective captured images.

FIG. 44 is a diagram illustrating a concept of the present technology.

FIG. 45 is a diagram illustrating a concept of the present technology.

FIG. 46 is a diagram illustrating a concept of the present technology.

FIG. 47 is a diagram illustrating a concept of the present technology.

FIG. 48 is a diagram illustrating a concept of the present technology.

FIG. 49 is a diagram illustrating a concept of the present technology.

FIG. 50 is a diagram illustrating a concept of the present technology.

FIG. 51 is a diagram illustrating a concept of the present technology.

FIG. 52 is a diagram illustrating arrangement of the respective adjacent captured images.

FIG. 53 is a diagram illustrating arrangement of the respective adjacent captured images.

FIG. 54 is a diagram illustrating a coordinate system with reference to captured images.

FIG. 55 is a diagram showing a configuration example of an image processing apparatus.

FIG. 56 is a flowchart illustrating panoramic image generation processing.

FIG. 57 is a diagram illustrating gain correction of captured images in generation of a panoramic image.

FIG. 58 is a diagram illustrating gain correction of captured images in generation of a panoramic image.

FIG. 59 is a diagram illustrating a coordinate system with reference to captured images.

FIG. 60 is a diagram showing a configuration example of an image processing apparatus.

FIG. 61 is a flowchart illustrating panoramic image generation processing.

FIG. 62 is a diagram illustrating advantages of the present technology.

FIG. 63 is a diagram illustrating corresponding pixel positions between adjacent captured images.

FIG. 64 is a diagram illustrating mapping in generation of a panoramic image.

FIG. 65 is a diagram illustrating an error between the first captured image and a captured image corresponding to the turning.

FIG. 66 is a diagram illustrating allocation of the error between the first captured image and the captured image corresponding to the turning.

FIG. 67 is a diagram illustrating error allocation of captured images corresponding to the turning.

FIG. 68 is a diagram illustrating error allocation of the captured images corresponding to the turning.

FIG. 69 is a diagram illustrating error allocation of the captured images corresponding to the turning.

FIG. 70 is a diagram illustrating error allocation of the captured images corresponding to the turning.

FIG. 71 is a diagram showing a developed figure of a panoramic image.

FIG. 72 is a diagram illustrating mapping in generation of a panoramic image.

FIG. 73 is a diagram illustrating mapping in generation of a panoramic image.

FIG. 74 is a diagram showing a configuration example of an image processing apparatus.

FIG. 75 is a flowchart illustrating panoramic image generation processing.

FIG. 76 is a diagram illustrating error allocation of the captured image s corresponding to the turning.

FIG. 77 is a flowchart illustrating panoramic image generation processing.

FIG. 78 is a diagram showing a positional relationship of successively captured images.

FIG. 79 is a diagram illustrating a failure in an image, which is caused in generation of a panoramic image.

FIG. 80 is a diagram illustrating a failure in an image, which is caused in generation of a panoramic image.

FIG. 81 is a diagram illustrating a failure in an image, which is caused in generation of a panoramic image.

FIG. 82 is a diagram illustrating a failure in an image, which is caused in generation of a panoramic image.

FIG. 83 is a diagram illustrating a failure in an image, which is caused in generation of a panoramic image.

FIG. 84 is a diagram illustrating a failure in an image, which is caused in generation of a panoramic image.

FIG. 85 is a diagram illustrating a failure in an image, which is caused in generation of a panoramic image.

FIG. 86 is a diagram illustrating a failure in an image, which is caused in generation of a panoramic image.

FIG. 87 is a diagram illustrating discontinuity in brightness of a panoramic image.

FIG. 88 is a diagram illustrating discontinuity in brightness of a panoramic image.

FIG. 89 is a diagram illustrating gain adjustment of captured images.

FIG. 90 is a diagram illustrating generation of a panoramic image.

FIG. 91 is a diagram showing a configuration example of an image processing apparatus.

FIG. 92 is a flowchart illustrating panoramic image generation processing.

FIG. 93 is a flowchart illustrating function calculation processing.

FIG. 94 is a diagram showing a pseudo code executed in updating a function.

FIG. 95 is a diagram illustrating updating of a function.

FIG. 96 is a diagram illustrating a problem solved by the present technology.

FIG. 97 is a diagram showing a positional relationship of captured images captured at a constant tilt angle.

FIG. 98 is a diagram showing a relationship between the first captured image and a world coordinate system.

FIG. 99 is a diagram showing a configuration example of an image processing apparatus.

FIG. 100 is a flowchart illustrating panoramic image generation processing.

FIG. 101 is a diagram showing a configuration example of an image processing apparatus.

FIG. 102 is a flowchart illustrating panoramic image generation processing.

FIG. 103 is a diagram showing a relationship between the s-th captured image and a world coordinate system.

FIG. 104 is a diagram showing a relationship between the s-th captured image and a world coordinate system.

FIG. 105 is a diagram illustrating mapping in generation of a panoramic image.

FIG. 106 is a flowchart illustrating image analysis processing.

FIG. 107 is a flowchart illustrating panoramic image generation processing.

FIG. 108 is a diagram showing a positional relationship of successively captured images.

FIG. 109 is a diagram illustrating a coordinate system on a cylindrical surface for generating a panoramic image.

FIG. 110 is a flowchart illustrating panoramic image generation processing.

FIG. 111 is a diagram illustrating generation of a panoramic image.

FIG. 112 is a diagram illustrating inclination of an object on a panoramic image.

FIG. 113 is a diagram illustrating inclination of an object on a panoramic image.

FIG. 114 is a diagram illustrating vertical and horizontal projection to a panoramic image.

FIG. 115 is a diagram illustrating image deformation processing on a panoramic image.

FIG. 116 is a diagram illustrating a weight for acquiring a transformation equation in image deformation processing.

FIG. 117 is a diagram illustrating a weight for acquiring a transformation equation in image deformation processing.

FIG. 118 is a diagram illustrating a weight for acquiring a transformation equation in image deformation processing.

FIG. 119 is a diagram showing a configuration example of an image processing apparatus.

FIG. 120 is a flowchart illustrating panoramic image generation processing.

FIG. 121 is a diagram illustrating a distorted image caused by lens distortion.

FIG. 122 is a diagram showing a positional relationship between adjacent captured images.

FIG. 123 is a diagram showing a positional relationship of captured images in a case where there is no distortion.

FIG. 124 is a diagram showing a positional relationship of captured images in a case where there is barrel-shaped distortion.

FIG. 125 is a diagram showing a positional relationship of captured images in a case where barrel-shaped distortion is added.

FIG. 126 is a diagram illustrating a region used for calculating a homogeneous transformation matrix on captured images.

FIG. 127 is a diagram illustrating overlapping of deformed captured images.

FIG. 128 is a diagram illustrating overlapping of deformed captured images.

FIG. 129 is a diagram illustrating overlapping of deformed captured images in a case where there is bobbin-shaped distortion.

FIG. 130 is a diagram showing a positional relationship of captured images which are captured at a constant tilt angle.

FIG. 131 is a diagram showing a relationship of a homogeneous transformation matrix and a rotation direction and a tilt direction of an imaging device.

FIG. 132 is a diagram showing a configuration example of an image processing apparatus.

FIG. 133 is a flowchart illustrating distortion detection processing.

FIG. 134 is a diagram showing an example of a table recorded in a distortion specifying unit.

FIG. 135 is a diagram showing a configuration example of a computer.

### DESCRIPTION OF EMBODIMENTS

Hereinafter, embodiments to which the present technology is applied will be described with reference to drawings.

### [Three-Freedom-Level Turning Optimization Error N Equal Division]

### First Embodiment

### [Concerning Panoramic Image]

In a case of generating a panoramic image, it is possible to more simply acquire a panoramic image with high quality by assigning an error between a position of an imaging device after the turning and an original position thereof to each homogeneous transformation matrix indicating a positional relationship between captured images.

For example, it is possible to generate a panoramic image of 360° from a plurality of captured images acquired by successive imaging while an imaging device such as a digital camera is panned, that is, turned by 360°.

It is assumed that the captured images captured while the imaging device is turned are a total of N captured images including the first captured image, the second captured image, . . . , and the N-th captured image. In addition, it is assumed that a focal distance F of a lens during imaging is one. In a case where the focal distance F is not one, it is possible to create a virtual image with a focal distance F of one by enlarging or contracting the captured image, and therefore, description will be continued on the assumption that the focal distances F of all the captured images are one.

Such a panoramic image of 360° is generated as follows, for example.

First, a positional relationship between adjacent captured images is acquired. That is, it is assumed that an arbitrary imaging target object is projected at a position Vₛ in the s-th captured image and is also projected at a position Vₛ₊₁ in the s+1-th captured image. A relationship between the position Vₛ and the position Vₛ₊₁ at this time is acquired.

Such a positional relationship can be generally expressed by a homogeneous transformation matrix (homography) H_{s,s+1} represented by the following Equation (1).

[Math. 1]

Vₛ∝H_{s,s+1}Vₛ₊₁ (1)

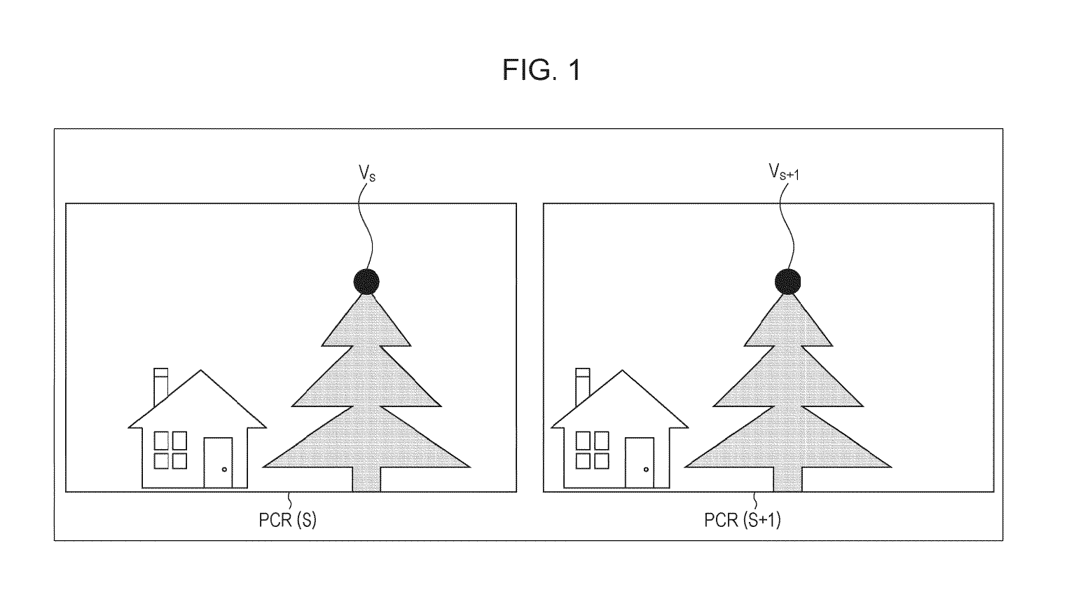

In a specific example, it is assumed that the same tree as an imaging target object is projected in the s-th captured image PCR(s) and in the s+1-th captured image PCR(s+1) as shown in FIG. 1, for example.

If attention is paid to a tip end of the tree as the imaging target object, the tip end portion of the tree is projected at a position Vₛ in the s-th captured image PCR(s) and is further projected at a position Vₛ₊₁ in the s+1-th captured image PCR(s+1). At this time, the position Vₛ and the position Vₛ₊₁ satisfy the aforementioned Equation (1).

Here, the position Vₛ and the position Vₛ₊₁ are expressed by same-order coordinates (also referred to as homogeneous coordinates). That is, each of the position Vₛ and the position Vₛ₊₁ is expressed by a three-dimensional vertical vector configured of three elements, namely an X coordinate of the captured image on the first line, a Y coordinate of the captured image on the second line, and 1 on the third line.

In addition, the homogeneous transformation matrix H_{s,s+1} is a 3×3 matrix representing a positional relationship between the s-th and the s+1-th captured images. In addition, s in Equation (1) satisfies s=1 to N. Moreover, it is assumed that s+1 is “1” when s=N. That is, the following Equation (2) is assumed.

[Math. 2]

V_{N}∝H_{N,1}V₁ (2)

Here, the homogeneous transformation matrix H_{N,1} in Equation (2) represents a positional relationship between a position V_{N} on the N-th captured image and a position V₁ on the first captured image. In the following description, it is assumed that s+1 in the index expressed as a combination of “s,s+1” means “1” in the case where s=N in the same manner. In addition, s−1 in the index expressed as a combination of “s−1,s” means “N” in the case where s=1.

The homogeneous transformation matrix H_{s,s+1} can be acquired by analyzing the s-th captured image and the s+1-th captured image.

Specifically, pixel positions on the s+1-th captured image corresponding to pixel positions of at least four points, for example, M points (Xa₍ₖ₎, Ya₍ₖ₎) (where k=1 to M) on the s-th captured image are acquired. That is, it is possible to acquire the pixel positions by considering a small region around the pixels in the s-th captured image and searching for a region matching with the small region in the s+1-th captured image.

Such processing is generally referred to as block matching. With such processing, the pixel positions (Xa₍ₖ₎, Ya₍ₖ₎) in the s-th captured image and the corresponding pixel positions (Xb₍ₖ₎, Yb₍ₖ₎) in the s+1-th captured image are acquired. Here, k=1 to M, and each of the pixel positions (Xa₍ₖ₎, Xb₍ₖ₎) and the pixel positions (Xb₍ₖ₎, Yb₍ₖ₎) is a position in an XY coordinate system with reference to each captured image.

Thus, it is only necessary to express these positions by the same-order coordinates and to acquire the matrix H_{s,s+1} which satisfies Equation (1). Since a method for acquiring the homogeneous transformation matrix by analyzing two images as described above is known, detailed description thereof will be omitted.

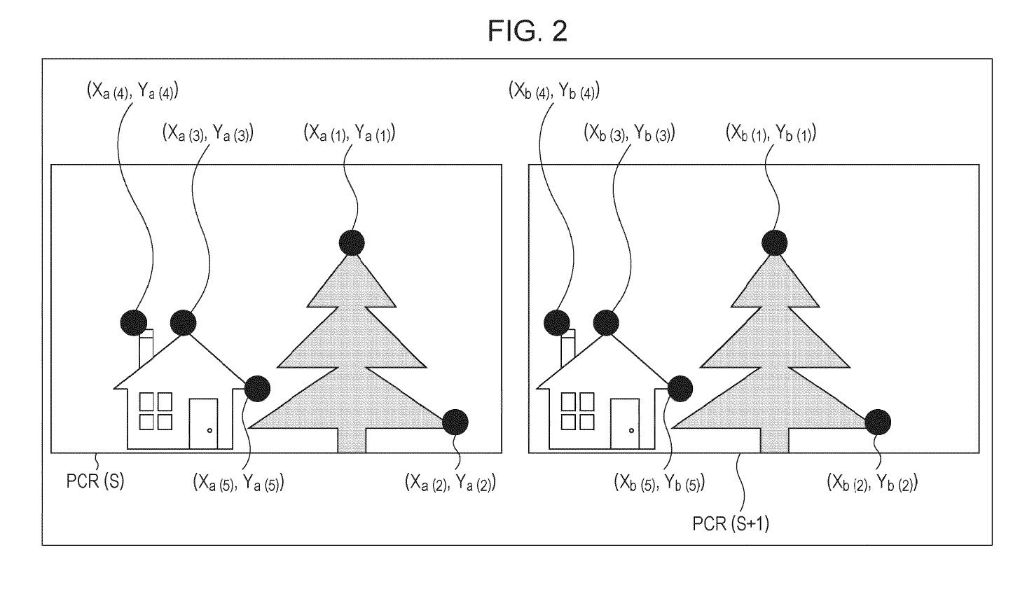

If such block matching is performed, the corresponding pixel positions between the adjacent captured images are acquired as shown in FIG. 2, for example. In FIG. 2, the same reference numerals are given to parts corresponding to those in FIG. 1, and the description thereof will be omitted.

In FIG. 2, five pixel positions (Xa₍ₖ₎, Ya₍ₖ₎) (where k=1 to 5) on the s-th captured image PCR(s) and five pixel positions (Xb₍ₖ₎, Yb₍ₖ₎) (where k=1 to 5) corresponding to the pixel positions on the s+1-th captured image PCR(s+1) are acquired. In this example, the number M of the corresponding pixel positions between the adjacent captured images is five.

Incidentally, a beam input direction on a three-dimensional space projected to a position W, (same-order coordinates) in the s-th captured image is a direction represented by the following Equation (3) in a three-dimensional coordinate system with reference to an imaging direction in which the first captured image is captured.

[Math. 3]

PₛWₛ (3)

However, a matrix Pₛ completely satisfies the following Equation (4). This is because the positional relationship between the s-th and the s+1-th captured images corresponds to the homogeneous transformation matrix H_{s,s+1}.

$$\begin{matrix}[ Math . 4 ] & \\ \begin{matrix}{P}_{2} = {P}_{1} {H}_{1 , 2} \\ {P}_{3} = {P}_{2} {H}_{2 , 3} \\ {P}_{4} = {P}_{3} {H}_{3 , 4} \\ ⋮ \\ {P}_{N - 1} = {P}_{N - 2} {H}_{N - 2 , N - 1} \\ {P}_{N} = {P}_{N - 1} {H}_{N - 1 , N} \\ {P}_{1} = {P}_{N} {H}_{N , 1}\end{matrix} & ( 4 )\end{matrix}$$

In addition, the matrix Pₛ is a homogeneous transformation matrix which represents the positional relationship between the s-th and the first captured images. In addition, the matrix P₁ is a 3×3 unit matrix. This is because the matrix P₁ is a coordinate system with reference to the first captured image, and therefore, it is a matter of course that transformation of the first captured image is identical transformation.

If the homogeneous transformation matrix Pₛ (where s=1 to N, P₁ is a unit matrix) represented by Equation (4) is acquired, it is possible to acquire a panoramic image (omnidirectional image) of 360° by mapping a pixel value of a pixel at each position Wₛ in each captured image in a canvas region as light coming from the direction represented by Equation (3). Here, the pixel value of the pixel in the captured image is generally a value from 0 to 255 when the captured image is a monochrome image, and is a value expressing three primary colors, namely red, green, and blue by 0 to 255 when the captured image is a color image.

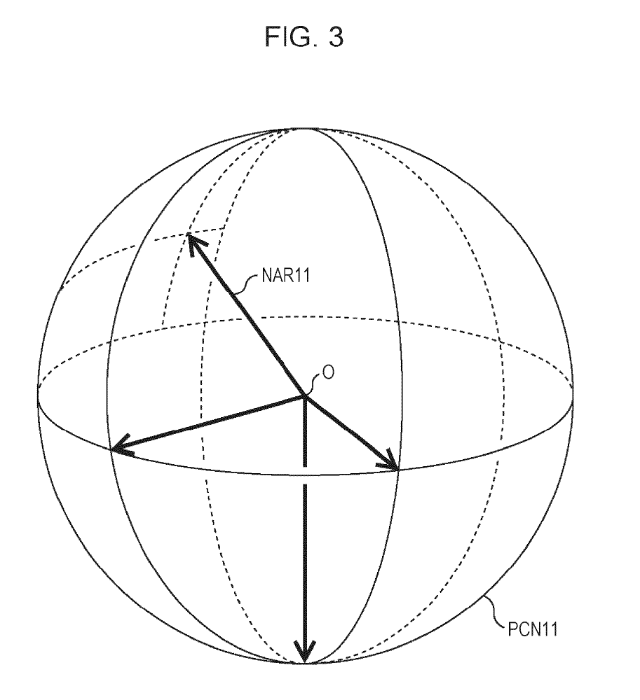

It is assumed that a surface of an omnidirectional sphere around an origin O in a three-dimensional coordinate system with reference to the direction in which the first captured image is captured is prepared in advance as a canvas region PCN11 as shown in FIG. 3, for example. It is assumed that a direction of the arrow NAR11 of the targeted pixel position in a predetermined captured image is acquired as the direction represented by Equation (3) at this time.

In such a case, a pixel value of the targeted pixel position in the captured image is mapped at a position of an intersection between the arrow NAR11 and the canvas region PCN11 in the canvas region PCN11. That is, the pixel value of the targeted pixel position in the captured image is set to a pixel value of a pixel at the position of the intersection between the arrow NAR11 and the canvas region PCN11.

An image on the canvas region PCN11 becomes a panoramic image of 360° if the respective positions on the respective captured images are mapped as described above.

Incidentally, since there is an error in the aforementioned homogeneous transformation matrix H_{s,s+1} in practice, it is not possible to completely satisfy Equation (4). Accordingly, Equation (5) is used in practice, and a homogeneous transformation matrix Pₛ as described below is acquired. In addition, since the desired homogeneous transformation matrix Pₛ includes N−1 matrixes excluding a matrix P₁ (unit matrix) and Equation (4) includes a total of N identity formulae, “the number of unknown numbers<the number of equations” is satisfied, and a solution which completely satisfies Equation (4) is not always present.

That is, since there is an error in the homogeneous transformation matrix H_{s,s+1}, the homogeneous transformation matrix Pₛ (where s=2 to N) is acquired such that each element in a 3×3 matrix Δ'ₛ (where s=1 to N) represented by the following Equation (5) instead of Equation (4) is minimized. In addition, P₁ represents a unit matrix.

$$\begin{matrix}[ Math . 5 ] & \\ {P}_{2} = {P}_{1} ( {H}_{1 , 2} + {Δ}_{1}^{′} ) \\ {P}_{3} = {P}_{2} ( {H}_{2 , 3} + {Δ}_{2}^{′} ) \\ {P}_{4} = {P}_{3} ( {H}_{3 , 4} + {Δ}_{3}^{′} ) \\ ⋮ \\ {P}_{N - 1} = {P}_{N - 2} ( {H}_{N - 2 , N - 1} + {Δ}_{N - 2}^{′} ) \\ {P}_{N} = {P}_{N - 1} ( {H}_{N - 1 , N} + {Δ}_{N - 1}^{′} ) \\ {P}_{1} = {P}_{N} ( {H}_{N , 1} + {Δ}_{N}^{′} ) & ( 5 )\end{matrix}$$

In other words, the homogeneous transformation matrix Pₛ (where s=2 to N) which minimizes the following Equation (6) is acquired.

$$\begin{matrix}[ Math . 6 ] & \\ {\sum }_{s = 1 to N} {\sum }_{{i = 1 to 3}_{j = 1 to 3}} {\{ {( {P}_{s}^{- 1} {P}_{s + 1} - {H}_{s , s + 1} )}_{column of}^{element on i \text{-} th row and j \text{-} th} \}}^{2} & ( 6 )\end{matrix}$$

Incidentally, the optimization problem is non-linear as can be understood from Equation (6), and a processing amount increases as can be understood from Equation (6). Since it is necessary to solve a non-linear problem which minimizes Equation (6) in order to acquire the homogeneous transformation matrix Pₛ (where s=2 to N) representing the optimal positional relationship between the s-th and the first captured images when the homogeneous transformation matrix H_{s,s+1} (where s=1 to N) as the positional relationship between the adjacent captured images is provided, a vast processing amount is required.

For this reason, it is not possible to simply and quickly generate a panoramic image.

The present technology was made in view of such circumstances and is designed to enable simple and quick acquisition of a panoramic image of 360°.

### [Concerning Overview of Present Technology]

First, description will be given of an overview of the present technology.

According to the present technology, an amount by which a captured image acquired after the imaging device is turned deviates from the original position of the first captured image although the captured image is supposed to return to the original position is regarded as a total amount of errors, the total amount of errors is divided into N, and the divided errors are assigned to positional relationships between adjacent captured images. With such processing, it is possible to simply acquire a homogeneous transformation matrix representing the positional relationships of the captured images. That is, it is possible to remarkably reduce the processing amount.

According to the present technology, first, the adjacent captured images are analyzed by block matching or the like, and the homogeneous transformation matrix H_{s,s+1} is acquired from a correspondence relationship between the objects projected to the captured images.

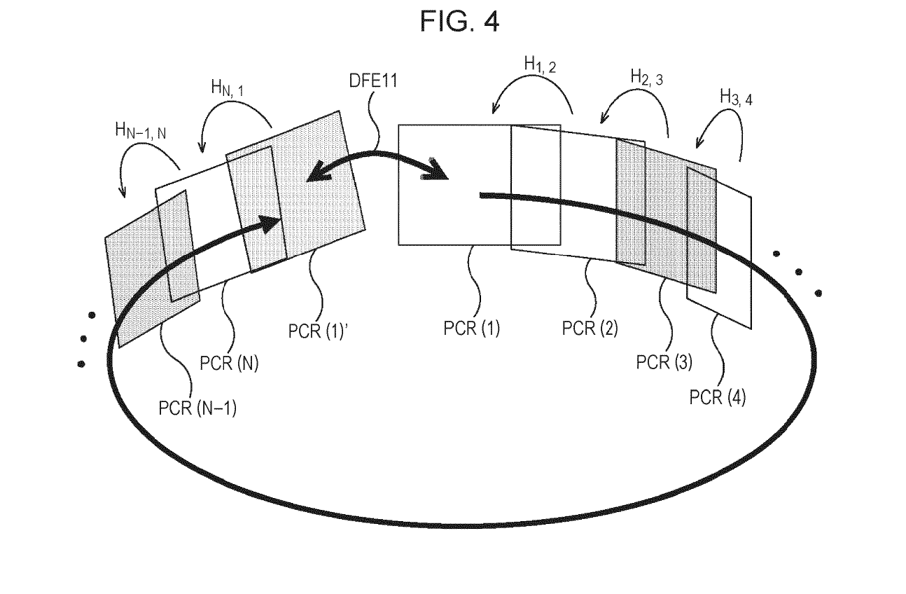

It is assumed that the second captured image PCR(2) is then arranged at a position represented by a homogeneous transformation matrix H_{1,2} with respect to the first captured image PCR(1) as shown in FIG. 4, for example. In addition, it is assumed that the third captured image PCR(3) is arranged at a position represented by a homogeneous transformation matrix H_{2,3} with respect to the second captured image PCR(2).

It is assumed that the N-th captured image PCR(N) is arranged thereafter at a position represented by a homogeneous transformation matrix H_{N-1,N} with respect to the N−1-th captured image PCR(N−1) in the same manner. Furthermore, it is assumed that the first captured image PCR(1) is arranged at a position represented by the homogeneous transformation matrix H_{N,1} with respect to the N-th captured image PCR(N) and is regarded as a captured image PCR(1)′.

In the drawing, H_{s,s+1} (where s=1 to N−1) represents a homogeneous transformation matrix as a positional relationship between the s-th and the s+1-th captured images, and H_{N,1} represents a homogeneous transformation matrix as a positional relationship between the N-th and the first captured images.

In FIG. 4, the captured image PCR(1)′ corresponding to the turning is arranged at a position corresponding to the turning which is acquired by accumulating the positional relationships (homogeneous transformation matrixes H_{s,s+1}) from the first to the N-th captured images in ascending order and further accumulating the positional relationship (homogeneous transformation matrix H_{N,1}) of the N-th and the first captured images.

For this reason, the position of the first captured image PCR(1)′ after the turning is supposed to overlap with the position of the original first captured image PCR(1) if no errors are incorporated. However, these captured images never overlap due to errors. In FIG. 4, the arrow DFE11 represents an error between the position of the captured image PCR(1)′ and the position of the captured image PCR(1), namely accumulated errors after the turning.

The error represented by the arrow DFE11 is a difference between the homogeneous transformation matrix represented by the following Equation (7) and the unit matrix.

$$\begin{matrix}[ Math . 7 ] & \\ {\prod }_{k = 1 to N} {H}_{k , k + 1} = {H}_{1 , 2} {H}_{2 , 3} {H}_{3 , 4 } … {H}_{N - 2 , N - 1} {H}_{N - 1 , N} {H}_{N , 1} & ( 7 )\end{matrix}$$

The matrix represented by Equation (7) is a matrix acquired by accumulating the homogeneous transformation matrixes H_{s,s+1} from s=1 to s=N. That is, the matrix is a homogeneous transformation matrix representing the position of the first captured image PCR(1)′ after the turning with respect to the first captured image PCR(1).

Since the difference between the homogeneous transformation matrix represented by Equation (7) and the unit matrix is the total amount of the errors after the turning, the total amount of the errors is divided into N according to the present technology. Here, the divided error is represented as Δ_{s,s+1} (where s=1 to N).

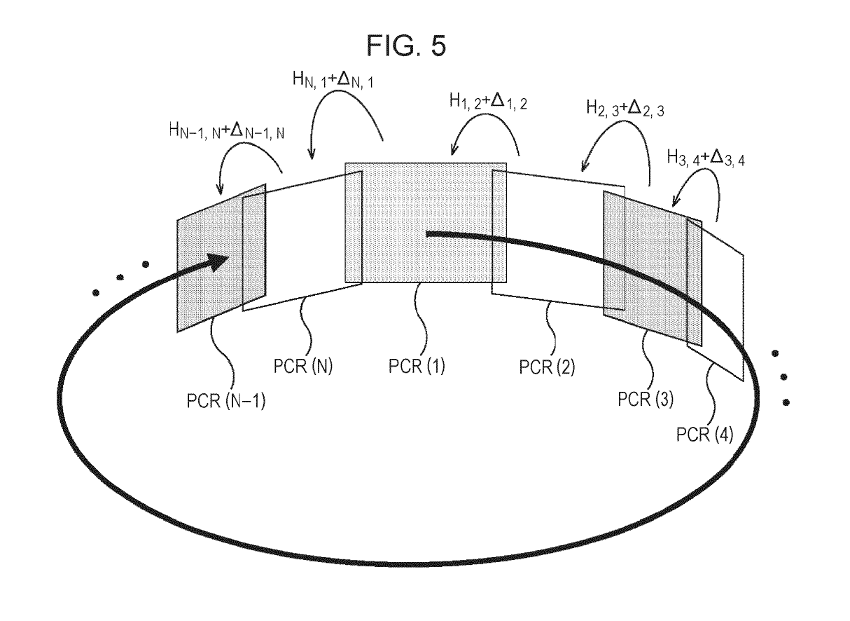

In addition, these divided errors are allocated to the positional relationships between the adjacent captured images as shown in FIG. 5, for example. In FIG. 5, the same reference numerals are given to the parts corresponding to those in FIG. 4, and the description thereof will be omitted.

In FIG. 5, the positional relationship between the s-th captured image PCR(s) and the s+1-th captured image PCR(s+1) corresponds to a sum of the homogeneous transformation matrix H_{s,s+1} and the divided error Δ_{s,s+1} (H_{s,s+1}+Δ_{s,s+1}) instead of the aforementioned homogenous transformation matrix H_{s,s+1}.

Therefore, the position of the first captured image PCR(1)′ after the turning (not shown) overlaps with the position of the original first captured image PCR(1).

Although the conceptual description was given above, features of the present technology will be further described below by using equations.

Although the error allocation (Δ_{s,s+1}) is added to the homogeneous transformation matrix H_{s,s+1} in the above conceptual description, the following description will be given on the assumption that error allocation (Tₛ which will be described later) is multiplied by the homogeneous transformation matrix H_{s,s+1}.

That is, the matrix Tₛ is substantially a unit matrix. In addition, if the matrix Tₛ is completely a unit matrix, no change occurs in the homogeneous transformation matrix H_{s,s+1} even if the homogeneous transformation matrix H_{s,s+1} is multiplied by the matrix Tₛ. In addition, if the matrix Tₛ is substantially a unit matrix, a result of multiplication is substantially the homogeneous transformation matrix H_{s,s+1} even if the homogeneous transformation matrix H_{s,s+1} is multiplied by the matrix Tₛ.

First, a matrix Tₛ (where s=1 to N) which satisfies the following Equation (8) is considered.

$$\begin{matrix} [ Math . 8 ] & \\ {\prod }_{k = 1 to N} ( {H}_{k , k + 1} {T}_{k} ) = {H}_{1 , 2} {T}_{2} {H}_{2 , 3} {T}_{3} {H}_{3 , 4} {T}_{4} … {H}_{N - 2 , N - 1} {T}_{N - 1} {H}_{N - 1 , N} {T}_{N} {H}_{N , 1} {T}_{1} ∝ [ \begin{matrix}1 & 0 & 0 \\ 0 & 1 & 0 \\ 0 & 0 & 1\end{matrix} ] & ( 8 )\end{matrix}$$

At this time, a matrix Qₛ represented by the following Equation (9) is a homogeneous transformation matrix representing the positional relationship of the s-th captured images in a reference coordinate system that it is desirable to finally achieve, namely in a three-dimensional coordinate system (hereinafter referred to as a world coordinate system) with reference to the imaging direction in which the first captured image is captured. In addition, although the aforementioned matrix P₁ is a unit matrix, the matrix Q₁ is not necessarily a unit matrix.

$$\begin{matrix}[ Math . 9 ] & \\ {Q}_{1} = {T}_{1} \\ {Q}_{2} = {Q}_{1} {H}_{1 , 2} {T}_{2} \\ {Q}_{3} = {Q}_{2} {H}_{2 , 3} {T}_{3} \\ {Q}_{4} = {Q}_{3} {H}_{3 , 4} {T}_{4} \\ ⋮ \\ {Q}_{N - 1} = {Q}_{N - 2} {H}_{N - 2 , N - 1} {T}_{N - 1} \\ {Q}_{N} = {Q}_{N - 1} {H}_{N - 1 , N} {T}_{N} & ( 9 )\end{matrix}$$

Accordingly, if the matrix Qₛ (where s=1 to N) represented by Equation (9) is acquired, it is possible to acquire a panoramic image (omnidirectional image) of 360° by mapping a pixel value of a pixel position at each pixel Wₛ in each captured image as light coming from the direction represented by the following Equation (10) in a canvas region which is prepared in advance. Here, the pixel value at each pixel position Wₛ is generally a value from 0 to 255 when the captured image is a monochrome image, and is a value expressing three primary colors, namely red, green, and blue by 0 to 255 when the captured image is a color image.

[Math. 10]

QₛWₛ (10)

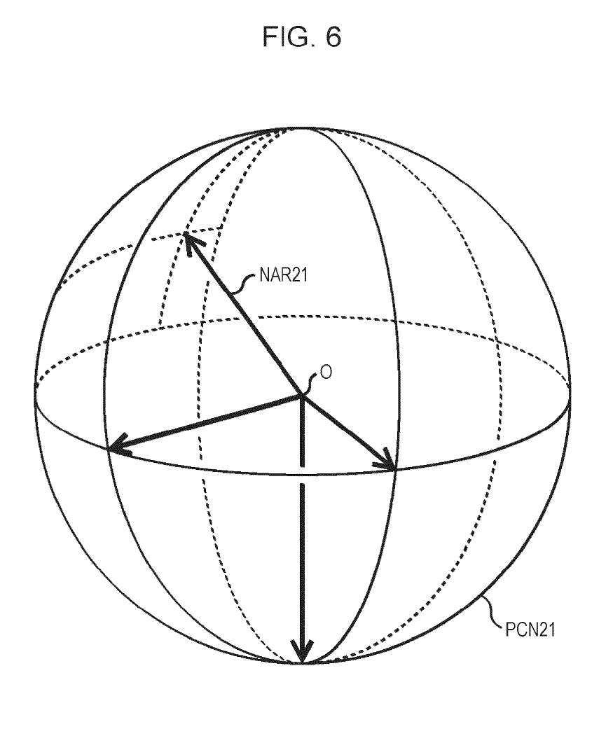

That is, it is assumed that a surface of a three-dimensional coordinate system with reference to the direction in which the first captured image is imaged, namely of an omnidirectional sphere around an origin O in the world coordinate system is prepared in advance as a canvas region PCN21 as shown in FIG. 6, for example.

It is assumed that a direction of the arrow NAR21 is acquired as a direction represented by Equation (10) for a targeted pixel position Wₛ in a predetermined captured image at this time.

In such a case, the pixel value at the pixel position Wₛ in the captured image is mapped at a position of an intersection between the arrow NAR21 and the canvas region PCN21 in the canvas region PCN21. That is, the pixel value of the pixel position Wₛ is regarded as a pixel value of a pixel at the position of the intersection between the arrow NAR21 and the canvas region PCN21.

If mapping is performed at the respective positions on the respective captured images as described above, an image on the canvas region PCN 21 becomes a panoramic image of 360°.

Now, it is assumed that the matrix Tₛ (where s=1 to N) in the above equation is set to be substantially a unit matrix. In relation to arbitrary s in s=1 to N−1, the positional relationship between the s-th captured image and the s+1-th captured image is (H_{s,s+1}Tₛ₊₁), which is substantially a homogeneous transformation matrix H_{s,s+1} in this case as can be understood from Equation (9).

Accordingly, substantially no failures occur at a boundary part at which the s-th captured image and the s+1-th captured image are mapped in the panoramic image (omnidirectional image) of 360°. That is, an image in which captured image connection parts are satisfactorily connected without any failure is acquired.

In addition, the following Equation (11) is derived from Equation (9) and Equation (8).

$$\begin{matrix} [ Math . 11 ] & \\ {Q}_{1} = {T}_{1} [ \begin{matrix}1 & 0 & 0 \\ 0 & 1 & 0 \\ 0 & 0 & 1\end{matrix} ] ∝ {T}_{1} {H}_{1 , 2} {T}_{2} {H}_{2 , 3} {T}_{3} {H}_{3 , 4} {T}_{4} … {H}_{N - 2 , N - 1} {T}_{N - 1} {H}_{N - 1 , N} {T}_{N} {H}_{N , 1} {T}_{1} = {Q}_{N} {H}_{N , 1} {T}_{1} & ( 11 )\end{matrix}$$

As can be understood from Equation (11), the positional relationship between the N-th captured image and the first captured image is (H_{N,1}T₁), which is substantially a homogeneous transformation matrix H_{N,1}. Therefore, substantially no failures occur at the boundary part at which the N-th captured image and the first captured image are mapped in the panoramic image (omnidirectional image) of 360° (an image in which connection parts are satisfactorily connected is acquired).

That is, substantially no failures occur at the boundary part between the s-th captured image and the s+1-th captured image in all the cases where s=1 to N.

Incidentally, the matrix Tₛ corresponding to the error allocation acquired by the present technology is acquired not by a least squares method as represented by the aforementioned Equation (6) but by a simpler method. That is, the matrix Tₛ is acquired by dividing a difference between the arrow DFE11 shown in FIG. 4, namely the homogeneous transformation matrix of Equation (7) and the unit matrix (the total amount of errors after the turning) by N. With such processing, it is possible to significantly reduce the processing amount.

In addition, since the homogeneous transformation matrix H_{s,s+1} generally has uncertainty in a constant factor, the description of the present technology will be given while excluding uncertainty by providing a condition of (the square of the third row and the first column in H_{s,s+1})+(the square of the third row and the second column in H_{s,s+1})+(the square of the third row and the third column in H_{s,s+1})=1.

Incidentally, a difference between the homogeneous transformation matrix of Equation (7) and the unit matrix shown by the arrow DFE11 in FIG. 4 (the total amount of errors after the turning) is defined as follows in this embodiment.

That is, first, a total of four points, namely a point K1₍ₛ₎, a point K2₍ₛ₎, a point K3₍ₛ₎, and a point K4^{(s)} defined below are considered on the s-th (where s=1 to N) captured image. These four points are four points with the following characteristics.

In addition, these four points are expressed by the same-order coordinates (also referred to as homogeneous coordinates). That is, the positions of these points are expressed by a three-dimensional vertical vector configured of three elements in which the first row corresponds to the X coordinate of a coordinate system with reference to the s-th captured image, the second row corresponds to the Y coordinate of the coordinate system with reference to the s-th captured image, and the third row is “1”.

The four points K1₍ₛ₎, K2₍ₛ₎, K3₍ₛ₎, and K4₍ₛ₎ on the s-th captured image have a characteristic in that pixel values of pixels in substantially the same region as a region surrounded by the four points on the s-th captured image are mapped in the panoramic image (omnidirectional image) of 360° as an output image. In addition, other captured images are mapped in regions different from the region where the region surrounded by the points K1₍ₛ₎ to K4₍ₛ₎ is mapped on the panoramic image of 360°.

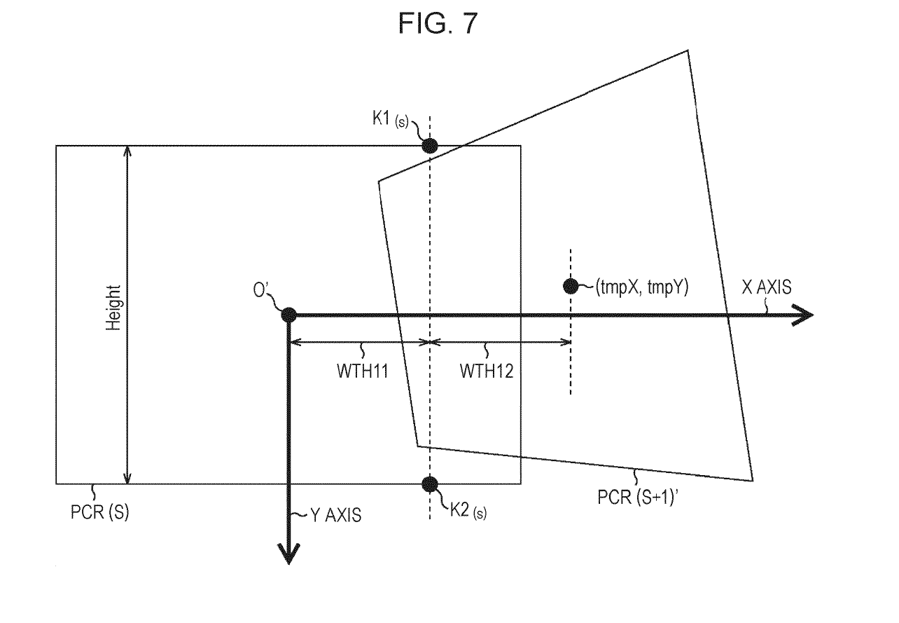

For example, the points K1₍ₛ₎ and K2₍ₛ₎ on the s-th captured image are points as shown in FIG. 7. In FIG. 7, the image PCR(s) represents the s-th captured image, and the image PCR(s+1)′ represents an image acquired by deforming the s+1-th captured image PCR(s+1) by the homogeneous transformation matrix H_{s,s+1}. That is, the captured image PCR(s+1)′ is an image acquired by projecting the captured image PCR(s+1) onto a coordinate system with reference to the captured image PCR(s).

In addition, an origin O′ is positioned at the center of the s-th captured image PCR(s) and represents an origin of the XY coordinate system with reference to the s-th captured image PCR(s). Furthermore, the X axis and the Y axis in the drawing represent the X axis and the Y axis in the XY coordinate system with reference to the captured image PCR(s).

In the example of FIG. 7, a position (X, Y)=(tmpX, tmpY) on the captured image PCR(s+1)′ represents the center position of the s+1-th captured image PCR(s+1) which is projected onto the coordinate system with reference to the s-th captured image PCR(s) by the homogeneous transformation matrix H_{s,s+1}.

When the point K1₍ₛ₎ and the point K2₍ₛ₎ on the s-th captured image are acquired, first, tmpX as an X coordinate of the position (tmpX, tmpY) is acquired, and the value of tmpX is divided by 2. The thus acquired value tmpX/2 is regarded as X coordinates of the point K1₍ₛ₎ and the point K2₍ₛ₎.

Accordingly, the point K1₍ₛ₎ and the point K2_{(S)} are positioned at intermediate points between the origin O′ and the position (tmpX, tmpY) on the captured image PCR(s) with respect to the X-axis direction. That is, the width in the X-axis direction represented by the arrow WTH11 is equal to the width in the X-axis direction represented by the arrow WTH12 in FIG. 7.

In addition, the positions of the point K1₍ₛ₎ and the point K2₍ₛ₎ in the Y-axis direction are set so as to be respectively positioned at an upper end of the lower end of the captured image PCR(s) in the drawing. For example, if it is assumed that the height of the captured image PCR(s) in the Y-axis direction is Height, the Y coordinate of the point K1₍ₛ₎ is +Height/2, and the Y coordinate of the point K2₍ₛ₎ is −Height/2.

The positions of these points K1₍ₛ₎ and K2₍ₛ₎ are expressed by the same-order coordinates as the following Equation (12).

$$\begin{matrix}[ Math . 12 ] & \\ K {1}_{( s )} ≡ [ \begin{matrix}tmpX / 2 \\ Height / 2 \\ 1\end{matrix} ] , \\ K {2}_{( s )} ≡ [ \begin{matrix}tmpX / 2 \\ - Height / 2 \\ 1\end{matrix} ] , \\ where \\ [ \begin{matrix}tmpX \\ tmpY \\ 1\end{matrix} ] ∝ {H}_{s , s + 1} [ \begin{matrix}0 \\ 0 \\ 1\end{matrix} ] & ( 12 )\end{matrix}$$

In addition, the point K3₍ₛ₎ and the point K4₍ₛ₎ on the s-th (where s=1 to N) captured image are points corresponding to the point K1₍ₛ₋₁₎ and the point K2₍ₛ₋₁₎ on the s−1-th (where s 1=N when s=1) captured image. That is, the point K3₍ₛ₎ and the point K4₍ₛ₎ are points expressed by Equation (13).

[Math. 13]

K1₍ₛ₋₁₎∝H_{s-1,s}K3₍ₛ₎,K2₍ₛ₋₁₎∝H_{s-1,s}K4₍ₛ₎ (13)

The positions of the point K1₍ₛ₎ and the point K2₍ₛ₎ defined as described above are near the boundary between the s-th captured image mapped in the panoramic image (omnidirectional image) of 360° and the s+1-th captured image mapped in the panoramic image of 360°.

In addition, the point K1₍ₛ₋₁₎ (that is, the point K3₍ₛ₎) and the point K2₍ₛ₋₁₎ (that is, the point K4₍ₛ₎) are near the boundary between the s−1-th captured image mapped in the panoramic image (omnidirectional image) of 360° and the s-th captured image mapped in the panoramic image of 360°.

Accordingly, the four points K1₍ₛ₎, K2₍ₛ₎, K3₍ₛ₎, and K4₍ₛ₎ defined as described above satisfy the aforementioned characteristics.

In actual calculation, the point K1₍ₛ₎ and the point K2₍ₛ₎ on all the captured images when s=1 to N are acquired by calculation first, and the thus acquired points K1₍ₛ₎ and K2₍ₛ₎ are used to acquire the points K3₍ₛ₎ and K4₍ₛ₎.

Incidentally, an input direction of a light beam in a three-dimensional space projected to four points K1₍₁₎, K2₍₁₎, K3₍₁₎, and K4₍₁₎ on the first captured image is a direction (a direction in a three-dimensional space) represented by the following Equation (14) in a three-dimensional coordinate system (world coordinate system) with reference to the imaging direction in which the first captured image is captured. In addition, P₁ represents a unit matrix as described above.

[Math. 14]

P₁K1₍₁₎=K1₍₁₎,

P₁K2₍₁₎=K2₍₁₎,

P₁K3₍₁₎=K3₍₁₎,

P₁K4₍₁₎=K4₍₁₎ (14)

In addition, it is assumed that a positional relationship between adjacent captured images is homogeneous transformation matrix H_{s,s+1} and that four points in the first captured image after the turning, which correspond to the point K1₍₁₎, the point K2₍₁₎, the point K3₍₁₎, and the point K4₍₁₎, are a point K1ᵣ, a point K2ᵣ, a point K3ᵣ, and a point K4ᵣ.

In such a case, an input direction of a light beam in a three-dimensional space which is projected to the four points K1ᵣ, K2ᵣ, K3ᵣ, and K4ᵣ in the first captured image after the turning is a direction represented by the following Equation (15) in a three-dimensional coordinate system with reference to the imaging direction in which the first captured image is captured.

$$\begin{matrix} [ Math . 15 ] & \\ K {1}_{r} ≡ ( {\prod }_{k = 1 to N} {H}_{k , k + 1} ) K {1}_{( 1 )} = {H}_{1 , 2} {H}_{2 , 3} {H}_{3 , 4} … {H}_{N - 2 , N - 1} {H}_{N - 1 , N} {H}_{N , 1} K {1}_{( 1 )} , \\ K {2}_{r} ≡ ( {\prod }_{k = 1 to N} {H}_{k , k + 1} ) K {2}_{( 1 )} = {H}_{1 , 2} {H}_{2 , 3} {H}_{3 , 4 } … {H}_{N - 2 , N - 1} {H}_{N - 1 , N} {H}_{N , 1} K {2}_{( 1 )} , \\ K {3}_{r} ≡ ( {\prod }_{k = 1 to N} {H}_{k , k + 1} ) K {3}_{( 1 )} = {H}_{1 , 2} {H}_{2 , 3} {H}_{3 , 4} … {H}_{N - 2 , N - 1} {H}_{N - 1 , N} {H}_{N , 1} K {3}_{( 1 )} , \\ K {4}_{r} ≡ ( {\prod }_{k = 1 to N} {H}_{k , k + 1} ) K {4}_{( 1 )} = {H}_{1 , 2} {H}_{2 , 3} {H}_{3 , 4 } … {H}_{N - 2 , N - 1} {H}_{N - 1 , N} {H}_{N , 1} K {4}_{( 1 )} , & ( 15 )\end{matrix}$$

Incidentally, although the directions represented by Equation (14) and Equation (15), namely the point K1₍₁₎ and the point K1ᵣ, the point K2₍₁₎ and the point K2ᵣ, the point K3₍₁₎ and the point K3ᵣ, and the point K4₍₁₎ and the point K4ᵣ are supposed to coincide with each other if there is no error, they do not coincide with each other since there are errors in practice.

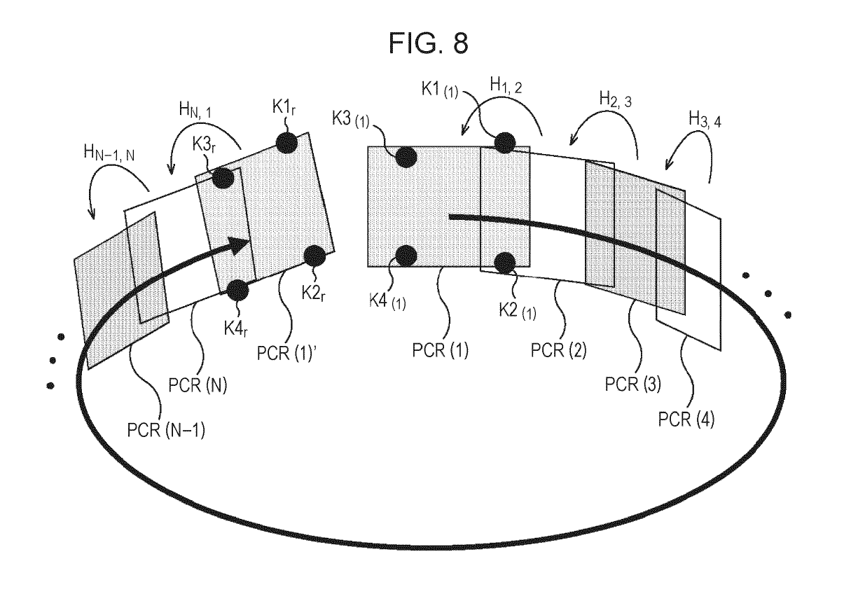

Thus, two differences, namely a difference between the point K3₍₁₎ and the point K3ᵣ and a difference between the point K4₍₁₎ and the point K4ᵣ are considered to be a difference between the homogeneous transformation matrix of Equation (7) and the unit matrix (the total amount of errors after the turning) as shown in FIG. 8. What should be noted here is that a difference between the point K1₍₁₎ and the point K1ᵣ and a difference between the point K2₍₁₎ and the point K2ᵣ are not considered.

In FIG. 8, the same reference numerals are given to parts corresponding to those in FIG. 4, and the description thereof will be omitted.

In FIG. 8, the captured image PCR(1)′ corresponding to the turning is arranged at a position corresponding to the turning, which is acquired by accumulating the positional relationships (homogeneous transformation matrixes H_{s,s+1}) from the first to the N-th captured image in ascending order and further accumulating the positional relationship (homogeneous transformation matrix H_{N,1}) of the N-th and the first captured images.

A difference between each of the two points K3ᵣ and K4ᵣ on the captured image PCR(1)′ and the two points K3₍₁₎ and K4₍₁₎ on the captured image PCR(1) is regarded as the total amount of errors after the turning.

Now, if Equation (13) in a case where s=1 is substituted in Equation (15), the point K3ᵣ and the point K4ᵣ are represented by the following Equation (16).

$$\begin{matrix} [ Math . 16 ] & \\ K {3}_{r} ∝ ( {\prod }_{k = 1 to N - 1} {H}_{k , k + 1} ) K {1}_{( N )} = {H}_{1 , 2} {H}_{2 , 3} {H}_{3 , 4} … {H}_{N - 2 , N - 1} {H}_{N - 1 , N} K {1}_{( N )} , \\ K {4}_{r} ∝ ( {\prod }_{k = 1 to N - 1} {H}_{k , k + 1} ) K {2}_{( N )} = {H}_{1 , 2} {H}_{2 , 3} {H}_{3 , 4} … {H}_{N - 2 , N - 1} {H}_{N - 1 , N} K {2}_{( N )} & ( 16 )\end{matrix}$$

Here, the difference between the point K3₍₁₎ and the point K3ᵣ and the difference between the point K4₍ᵣ₎ and the point K4ᵣ as the differences between the homogeneous transformation matrix of Equation (7) and the unit matrix (the total amount of errors after the turning) are defined by a 3×3 orthogonal matrix R_{(A1, B1, C1, θ1)} and an orthogonal matrix R_{(A2, B2, C2, θ2)} represented by the following Equation (17).

$$\begin{matrix} [ Math . 17 ] & \\ K {3}_{( 1 )} ∝ ( {\prod }_{k = 1 to N - 1} {H}_{k , k + 1} ) {R}_{( A 1 , B 1 , C 1 , θ1 )} K {1}_{( N )} = {H}_{1 , 2} {H}_{2 , 3} {H}_{3 , 4} … {H}_{N - 2 , N - 1} {H}_{N - 1 , N} {R}_{( A 1 , B 1 , C 1 , θ1 )} K {1}_{( N )} , \\ K {4}_{( 1 )} ∝ ( {\prod }_{k = 1 to N - 1} {H}_{k , k + 1} ) {R}_{( A 2 , B 2 , C 2 , θ2 )} K {2}_{( N )} = {H}_{1 , 2} {H}_{2 , 3} {H}_{3 , 4} … {H}_{N - 2 , N - 1} {H}_{N - 1 , N} {R}_{( A 2 , B 2 , C 2 , θ2 )} K {2}_{( N )} & ( 17 )\end{matrix}$$

In addition, the orthogonal matrix R_{(A, B, C, θ)} is transformation for rotated by an angle θ with respect to a direction of a vector (A, B, C), namely about the vector (A, B, C) as a rotation axis, and the orthogonal matrix R_{(A, B, C, θ)} is a unit matrix as will be described later. Here, A²+B²+C²=1. When A, B, C, and θ in the orthogonal matrix R_{(A, B, C, θ)} are A1, B1, C1, and θ1, respectively, for example, the orthogonal matrix R_{(A, B, C, θ)}=R_{(A1, B1, C1, θ1)}.

It is assumed that there are no errors and that the directions of the point K3ᵣ and the point K4ᵣ represented by Equation (15), namely Equation (16) coincide with the directions of the point K3₍ₗ₎ and the point K4₍ₗ₎, respectively. In such a case, the orthogonal matrix R_{(A1, B1, C1, θ1)} and the orthogonal matrix R_{(A2, B2, C2, θ2)} in Equation (17) are respectively unit matrixes.

Accordingly, the differences between the homogeneous transformation matrix of Equation (7) and the unit matrix (the total amount of errors after the turning) are an angle θ1 and an angle θ2.

Incidentally, a column of the point K1₍₁₎, the point K1₍₂₎, the point K1₍₃₎, . . . , the point K1₍ₛ₎, . . . , the point K1_{(N-1)}, and the point K1_{(N)} will be considered. These points correspond to a column of coordinates at upper right positions of the respective captured images.

If an amount of error to be assigned to these points K1₍ₛ₎ is considered, 100% of the total amount of errors after the turning is assigned to the point K1_{(N)}. This is because an error corresponding to an amount acquired by dividing the total amount of errors after the turning by N is assigned between adjacent points K1₍ₛ₎ and K1₍ₛ₊₁₎ and errors assigned to preceding points are also accumulated and assigned to each point.

In addition, a proportion of (N−1)/N of the total amount of errors after the turning is assigned to the point K1_{(N-1)}, and a proportion of (N−2)/N of the total amount of errors after the turning is assigned to the point K1_{(N-2)}. Hereinafter, the proportions of errors to be assigned to the respective points are made to decrease in the same manner, and a proportion of 1/N of the total amount of errors after the turning is assigned to the point K1₍₁₎.

With such processing, the deviation amount between the coordinates at the upper right positions of the adjacent captured images, namely between the point K1₍ₛ₎ and the point K1₍ₛ₊₁₎ becomes 1/N of the total amount of errors after the turning, which is a small amount.

In the same manner as in the case of the respective points K1₍ₛ₎, a column of a point K2₍₂₎, a point K2₍₂₎, a point K2₍₃₎, . . . , a point K2₍ₛ₎, . . . , a point K2_{(N-1)}, and a point K2_{(N)} is also considered, and proportions of errors to be assigned to the respective points K2₍ₛ₎ are determined. If this is expressed by an equation, the following Equation (18) is acquired.

$$\begin{matrix} [ Math . 18 ] & \\ ( {\prod }_{k = 1 to s - 1} {H}_{k , k + 1} ) {R}_{( A 1 , B 1 , C 1 , \frac{s \times θ1}{N} )} K {1}_{( s )} = {H}_{1 , 2} {H}_{2 , 3} {H}_{3 , 4} … {H}_{s - 2 , s - 1} {H}_{s - 1 , s} {R}_{( A 1 , B 1 , C 1 , \frac{s \times θ1}{N} )} K {1}_{( s )} , \\ ( {\prod }_{k = 1 to s - 1} {H}_{k , k + 1} ) {R}_{( A 2 , B 2 , C 2 , \frac{s \times θ2}{N} )} K {2}_{( s )} = {H}_{1 , 2} {H}_{2 , 3} {H}_{3 , 4} … {H}_{s - 2 , s - 1} {H}_{s - 1 , s} {R}_{( A 2 , B 2 , C 2 , \frac{s \times θ2}{N} )} K {2}_{( s )} & ( 18 )\end{matrix}$$

Here, in the first equation in Equation (18), namely in (πH_{k,k+1})R_{(A1,B1,C1,s×θ1/N)}K1₍ₛ₎, errors as the total amount of errors generated after the turning by the angle θ1 are allocated to the respective points K1₍ₛ₎ (where s=1 to N). In the second equation in Equation (18), namely in (πH_{k,k+1})R_{(A2,B2,C2,s×θ2/N)}K2₍ₛ₎, errors as the total amount of errors after turning by the angle θ2 are allocated to the respective points K2₍ₛ₎ (where s=1 to N).

Directions of the point K1₍ₛ₎ and the point K2₍ₛ₎ on the s-th (where s=1 to N) captured image in a reference coordinate system (world coordinate system) when the total amount of errors after the turning is divided into N and the errors divided into N are allocated to the respective points K1₍ₛ₎ and K2₍ₛ₎ (where s=1 to N) are directions represented by Equation (18).

In addition, directions of the point K1₍ₛ₎ and the point K2₍ₛ₎ on the s-th (where s=1 to N) captured image in the world coordinate system when errors after the turning are not taken into consideration, namely when allocation of the errors for returning to the original position after the turning is not performed are directions represented by the following Equation (19).

$$\begin{matrix} [ Math . 19 ] & \\ ( {\prod }_{k = 1 to s - 1} {H}_{k , k + 1} ) K {1}_{( s )} = {H}_{1 , 2} {H}_{2 , 3} {H}_{3 , 4} … {H}_{s - 2 , s - 1} {H}_{s - 1 , s} K {1}_{( s )} , \\ ( {\prod }_{k = 1 to s - 1} {H}_{k , k + 1} ) K {2}_{( s )} = {H}_{1 , 2} {H}_{2 , 3} {H}_{3 , 4} … {H}_{s - 2 , s - 1} {H}_{s - 1 , s} K {2}_{( s )} & ( 19 )\end{matrix}$$

In addition, the following Equation (20) is acquired from Equation (18) based on the aforementioned relationship of Equation (13). Directions of the point K3₍ₛ₎ and the point K4₍ₛ₎ on the s-th (where s=1 to N) captured image in the reference coordinate system (world coordinate system) when the total amount of errors after the turning is divided into N and the errors divided into N are allocated to the respective points K1₍ₛ₎ and K2₍ₛ₎ (where s=1 to N) are directions represented by Equation (20).

$$\begin{matrix} [ Math . 20 ] & \\ ( {\prod }_{k = 1 to s - 2} {H}_{k , k + 1} ) {R}_{( A 1 , B 1 , C 1 , \frac{( s - 1 ) \times θ1}{N} )} {H}_{s - 1 , s} K {3}_{( s )} = {H}_{1 , 2} {H}_{2 , 3} {H}_{3 , 4} … {H}_{s - 2 , s - 1} {R}_{( A 1 , B 1 , C 1 , \frac{( s - 1 ) \times θ1}{N} )} {H}_{s - 1 , s} K {3}_{( s )} , \\ ( {\prod }_{k = 1 to s - 2} {H}_{k , k + 1} ) {R}_{( A 2 , B 2 , C 2 , \frac{( s - 1 ) \times θ2}{N} )} {H}_{s - 1 , s} K {4}_{( s )} = {H}_{1 , 2} {H}_{2 , 3} {H}_{3 , 4} … {H}_{s - 2 , s - 1} {R}_{( A 2 , B 2 , C 2 , \frac{( s - 1 ) \times θ2}{N} )} {H}_{s - 1 , s} K {4}_{( s )} & ( 20 )\end{matrix}$$

Now, the vector (A1, B1, C1) and the angle θ1 and the vector (A2, B2, C2) and the angle θ2 in Equation (17) will be described here. In addition, A1²+B1²+C1²=1, and A2²+B2²+C2²=1.

The orthogonal matrix R_{(A, B, C, θ)} as transformation of rotating in the direction of the vector (A, B, C), namely about the vector (A, B, C) by the angle θ can generally be expressed by the following Equation (21). Here, A²+B²+C²=1.

$$\begin{matrix} [ Math . 21 ] & \\ {R}_{( A , B , C , θ )} ≡ [ \begin{matrix}{A}^{2} + ( 1 - {A}^{2} ) cos ( θ ) & AB ( 1 - cos ( θ ) ) - C sin ( θ ) & AC ( 1 - cos ( θ ) ) + B sin ( θ ) \\ AB ( 1 - cos ( θ ) ) + C sin ( θ ) & {B}^{2} + ( 1 - {B}^{2} ) cos ( θ ) & BC ( 1 - cos ( θ ) ) - A sin ( θ ) \\ AC ( 1 - cos ( θ ) ) - B sin ( θ ) & BC ( 1 - cos ( θ ) ) + Asin ( θ ) & {C}^{2} + ( 1 - {C}^{2} ) cos ( θ )\end{matrix} ] & ( 21 )\end{matrix}$$

Now, the following Equation (22) is acquired by deforming Equation (17).

$$\begin{matrix} [ Math . 22 ] & \\ {( {\prod }_{k = 1 to N - 1} {H}_{k , k + 1} )}^{- 1} K {3}_{( 1 )} = {( {H}_{1 , 2} {H}_{2 , 3} {H}_{3 , 4 } … {H}_{N - 2 , N - 1} {H}_{N - 1 , N} )}^{- 1} K {3}_{( 1 )} ∝ {R}_{( A 1 , B 1 , C 1 , θ1 )} K {1}_{( N )} , \\ {( {\prod }_{k = 1 to N - 1} {H}_{k , k + 1} )}^{- 1} K {4}_{( 1 )} = {( {H}_{1 , 2} {H}_{2 , 3} {H}_{3 , 4 } … {H}_{N - 2 , N - 1} {H}_{N - 1 , N} )}^{- 1} K {4}_{( 1 )} ∝ {R}_{( A 2 , B 2 , C 2 , θ2 )} K {4}_{( N )} & ( 22 )\end{matrix}$$

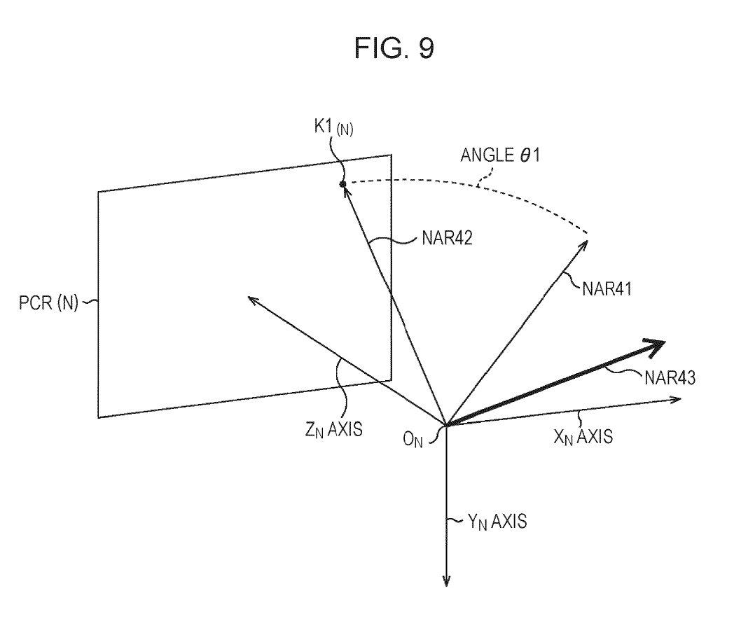

Thus, a direction which is orthogonal to two directions, that is, a direction expressed by the following Equation (23), namely a direction of the arrow NAR41 and a direction of a point K1_{(N)} on the N-th captured image PCR(N) is regarded as the vector (A1, B1, C1) as shown in FIG. 9.

In FIG. 9, the X_{N} axis, the Y_{N} axis, and the Z_{N} axis represent axes of a three-dimensional coordinate system with reference to an imaging direction of the N-th captured image PCR(N) which has a point O_{N} as an origin. In addition, the arrow NAR42 represents a direction from the origin O_{N} to the point K1_{(N)}, and the arrow NAR43 represents a direction of the vector (A1, B1, C1).

$$\begin{matrix} [ Math . 23 ] & \\ {( {\prod }_{k = 1 to N - 1} {H}_{k , k + 1} )}^{- 1} K {3}_{( 1 )} = {( {H}_{1 , 2} {H}_{2 , 3} {H}_{3 , 4} … {H}_{N - 2 , N - 1} {H}_{N - 1 , N} )}^{- 1} K {3}_{( 1 )} & ( 23 )\end{matrix}$$

As described above, the direction which is orthogonal to the direction of the arrow NAR41 and the direction of the arrow NAR42 is regarded as a direction of the vector (A1, B1, C1) of the arrow NAR43. In addition, a rotation angle when the direction of the point K1_{(N)} represented by the arrow NAR42 is rotated with respect to the direction of the vector (A1, B1, C1), namely about the vector (A1, B1, C1) so as to coincide with the direction of the arrow NAR41 is regarded as the angle θ1.

By defining the vector (A1, B1, C1) and the angle θ1 as described above, the vectors (A1, B1, C1) and the angles θ1 which satisfy the first equation in Equation (22), namely the equation of (πH_{k,k+1})⁻¹K3₍₁₎ are acquired. In addition, a method of acquiring the vector (A2, B2, C2) and the angle θ2 which satisfy the second equation in Equation (22), namely the equation of (πH_{k,k+1})⁻¹K4₍₁₎ is the same as the method of acquiring the vector (A1, B1, C1) and the angle θ1.

If these are expressed by equations, the vector (A1, B1, C1) and the angle θ1 which satisfy the following Equation (24) are acquired. In addition, the vector (A2, B2, C2) and the angle θ2 which satisfy the following Equation (25) are acquired.

$$\begin{matrix}[ Math . 24 ] & \\ \begin{matrix}( A 1 B 1 C 1 ) K {1}_{( N )} = 0 \\ ( A 1 B 1 C 1 ) {( {\prod }_{k = 1 to N - 1} {H}_{k , k + 1} )}^{- 1} K {3}_{( 1 )} = ( A 1 B 1 C 1 ) {( \begin{matrix}{H}_{1 , 2} {H}_{2 , 3} {H}_{3 , 4} … \\ {H}_{N - 2 , N - 1} {H}_{N - 1 , N}\end{matrix} )}^{- 1} K {3}_{( 1 )} = 0 \\ {( {\prod }_{k = 1 to N - 1} {H}_{k , k + 1} )}^{- 1} K {3}_{( 1 )} = {( \begin{matrix}{H}_{1 , 2} {H}_{2 , 3} {H}_{3 , 4} … \\ {H}_{N - 2 , N - 1} {H}_{N - 1 , N}\end{matrix} )}^{- 1} K {3}_{( 1 )} ∝ [ \begin{matrix}A {1}^{2} + ( \begin{matrix}1 - \\ A {1}^{2}\end{matrix} ) cos ( θ 1 ) & \begin{matrix}A 1 B 1 ( \begin{matrix}1 - \\ cos ( θ1 )\end{matrix} ) - \\ C 1 sin ( θ 1 )\end{matrix} & \begin{matrix}A 1 C 1 ( \begin{matrix}1 - \\ cos ( θ1 )\end{matrix} ) + \\ B 1 sin ( θ 1 )\end{matrix} \\ \begin{matrix}A 1 B 1 ( \begin{matrix}1 - \\ cos ( θ1 )\end{matrix} ) + \\ C 1 sin ( θ 1 )\end{matrix} & B {1}^{2} + ( \begin{matrix}1 - \\ B {1}^{2}\end{matrix} ) cos ( θ 1 ) & \begin{matrix}B 1 C 1 ( \begin{matrix}1 - \\ cos ( θ1 )\end{matrix} ) - \\ A 1 sin ( θ 1 )\end{matrix} \\ \begin{matrix}A 1 C 1 ( \begin{matrix}1 - \\ cos ( θ1 )\end{matrix} ) - \\ B 1 sin ( θ 1 )\end{matrix} & \begin{matrix}B 1 C 1 ( \begin{matrix}1 - \\ cos ( θ1 )\end{matrix} ) + \\ A 1 sin ( θ1 )\end{matrix} & C {1}^{2} + ( \begin{matrix}1 - \\ C {1}^{2}\end{matrix} ) cos ( θ 1 )\end{matrix} ] K {1}_{( N )}\end{matrix} \} & ( 24 ) \\ [ Math . 25 ] & \\ \begin{matrix}( A 2 B 2 C 2 ) K {2}_{( N )} = 0 \\ ( A 2 B 2 C 2 ) {( {\prod }_{k = 1 to N - 1} {H}_{k , k + 1} )}^{- 1} K {4}_{( 1 )} = ( A 2 B 2 C 2 ) {( \begin{matrix}{H}_{1 , 2} {H}_{2 , 3} {H}_{3 , 4} … \\ {H}_{N - 2 , N - 1} {H}_{N - 1 , N}\end{matrix} )}^{- 1} K {4}_{( 1 )} = 0 \\ {( {\prod }_{k = 1 to N - 1} {H}_{k , k + 1} )}^{- 1} K {4}_{( 1 )} = {( \begin{matrix}{H}_{1 , 2} {H}_{2 , 3} {H}_{3 , 4} … \\ {H}_{N - 2 , N - 1} {H}_{N - 1 , N}\end{matrix} )}^{- 1} K {4}_{( 1 )} ∝ [ \begin{matrix}A {2}^{2} + ( \begin{matrix}1 - \\ A {2}^{2}\end{matrix} ) cos ( θ 2 ) & \begin{matrix}A 2 B 2 ( \begin{matrix}1 - \\ cos ( θ2 )\end{matrix} ) - \\ C 2 sin ( θ 2 )\end{matrix} & \begin{matrix}A 2 C 2 ( \begin{matrix}1 - \\ cos ( θ2 )\end{matrix} ) + \\ B 2 sin ( θ 2 )\end{matrix} \\ \begin{matrix}A 2 B 2 ( \begin{matrix}1 - \\ cos ( θ2 )\end{matrix} ) + \\ C 2 sin ( θ 2 )\end{matrix} & B {2}^{2} + ( \begin{matrix}1 - \\ B {2}^{2}\end{matrix} ) cos ( θ 2 ) & \begin{matrix}B 2 C 2 ( \begin{matrix}1 - \\ cos ( θ2 )\end{matrix} ) - \\ A 2 sin ( θ 2 )\end{matrix} \\ \begin{matrix}A 2 C 2 ( \begin{matrix}1 - \\ cos ( θ2 )\end{matrix} ) - \\ B 2 sin ( θ 2 )\end{matrix} & \begin{matrix}B 2 C 2 ( \begin{matrix}1 - \\ cos ( θ2 )\end{matrix} ) + \\ A 2 sin ( θ2 )\end{matrix} & C {2}^{2} + ( \begin{matrix}1 - \\ C {2}^{2}\end{matrix} ) cos ( θ 2 )\end{matrix} ] K {2}_{( N )}\end{matrix} \} & ( 25 )\end{matrix}$$

However, the angle θ1 and the angle θ2 in Equation (24) and Equation (25) are equal to or greater than 0° and equal to or less than 180°.

Now, the directions of the respective points K1₍ₛ₎, K2₍ₛ₎, K3₍ₛ₎, and K4₍ₛ₎ (where s=1 to N) after the error allocation on the reference coordinate system (world coordinate system) are acquired as represented by Equation (18) and Equation (20) at this time.

Accordingly, the homogeneous transformation matrix Q′ₛ which represents the positional relationship of the s-th captured image in the reference coordinate system (world coordinate system) that it is desirable to finally achieve is obtained for each s from the four points, namely the point K1₍ₛ₎, the point K2₍ₛ₎, the point K3₍ₛ₎, and the point K4₍ₛ₎. That is, 3×3 matrix satisfying the following Equation (26) is obtained as a homogeneous transformation matrix Q′ₛ.

$$\begin{matrix}[ Math . 26 ] & \\ \begin{matrix}( \begin{matrix}Direction represented by first equation \\ in Equation ( 18 ) \\ ( that is , direction of K {1}_{( s )} in reference \\ coordinate system )\end{matrix} ) ∝ {Q}_{s}^{′} K {1}_{( s )} \\ ( \begin{matrix}Direction represented by second equation \\ in Equation ( 18 ) \\ ( that is , direction of K {2}_{( s )} in reference \\ coordinate system )\end{matrix} ) ∝ {Q}_{s}^{′} K {2}_{( s )} \\ ( \begin{matrix}Direction represented by first equation \\ in Equation ( 20 ) \\ ( that is , direction of K {3}_{( s )} in reference \\ coordinate system )\end{matrix} ) ∝ {Q}_{s}^{′} K {3}_{( s )} \\ ( \begin{matrix}Direction represented by second equation \\ in Equation ( 20 ) \\ ( that is , direction of K {4}_{( s )} in reference \\ coordinate system )\end{matrix} ) ∝ {Q}_{s}^{′} K {4}_{( s )}\end{matrix} \} & ( 26 )\end{matrix}$$

In addition, the directions of the point K1₍₁₎, the point K2₍₁₎, the point K3₍₁₎, the point K4₍₁₎, the point K3₍₂₎, and the point K4₍₂₎ in the reference coordinate system (world coordinate system) in Equation (26) are directions represented by the following Equation (27) instead of the directions represented by Equation (18) and Equation (20).

$$\begin{matrix}[ Math . 27 ] & \\ \begin{matrix}\begin{matrix}Direction of K {1}_{( 1 )} in \\ reference coordinate system\end{matrix} = {R}_{( A 1 , B 1 , C 1 , \frac{θ1}{N} )} K {1}_{( 1 )} \\ \begin{matrix}Direction of K {2}_{( 1 )} in \\ reference coordinate system\end{matrix} = {R}_{( A 2 , B 2 , C 2 , \frac{θ2}{N} )} K {2}_{( 1 )} \\ \begin{matrix}Direction of K {3}_{( 1 )} in \\ reference coordinate system\end{matrix} = K {3}_{( 1 )} \\ \begin{matrix}Direction of K {4}_{( 1 )} in \\ reference coordinate system\end{matrix} = K {4}_{( 1 )} \\ \begin{matrix}Direction of K {5}_{( 1 )} in \\ reference coordinate system\end{matrix} = {R}_{( A 1 , B 1 , C 1 , \frac{θ1}{N} )} {H}_{1 , 2} K {3}_{( 2 )} \\ \begin{matrix}Direction of K {6}_{( 1 )} in \\ reference coordinate system\end{matrix} = {R}_{( A 2 , B 2 , C 2 , \frac{θ2}{N} )} {H}_{1 , 2} K {4}_{( 2 )}\end{matrix} \} & ( 27 )\end{matrix}$$

In addition, although there is uncertainty in a constant factor if Equation (26) is solved for the homogeneous transformation matrix Q′ₛ, this is uncertainty in the homogeneous transformation matrix, and it is only necessary to exclude the uncertainty by providing a condition of (the square of the third row and the first column of Q′ₛ)+(the square of the third row and the second column of Q′ₛ)+(the square of the third row and the third column of Q′ₛ)=1, for example.

If the homogeneous transformation matrix Q′ₛ (where s=1 to N) is obtained as described above, it is possible to acquire a panoramic image (omnidirectional image) of 360° by mapping a pixel value of each pixel position Wₛ in each captured image as light coming from the direction represented by the following Equation (28) in the canvas region. Here, the pixel value of the pixel in each captured image is generally a value from 0 to 255 when the captured image is a monochrome image, and is a value expressing three primary colors, namely red, green, and blue by 0 to 255 when the captured image is a color image.

[Math. 28]

Q′ₛWₛ (28)

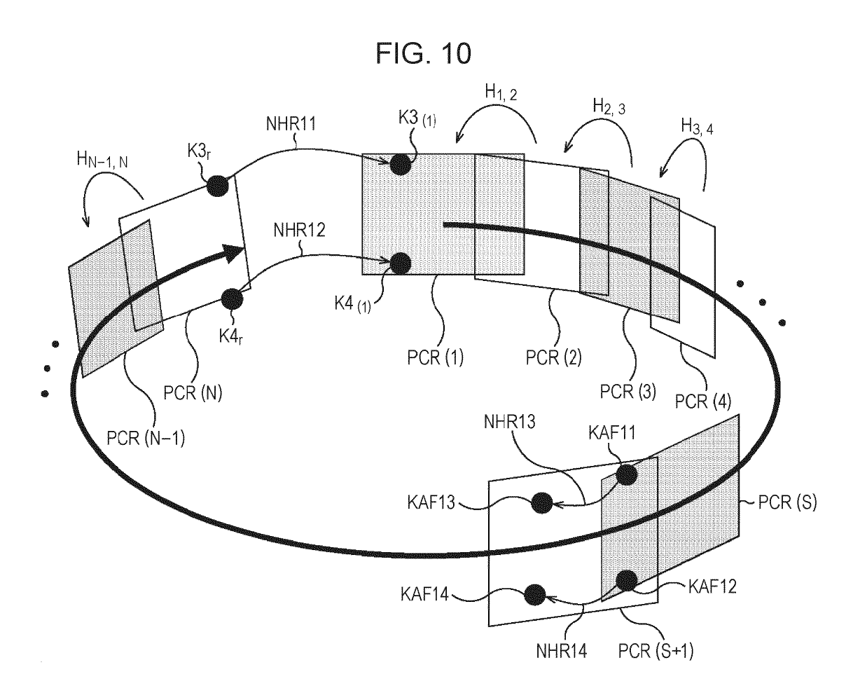

Here, a concept of the present technology will be described with reference to FIG. 10. In FIG. 10, the same reference numerals are given to parts corresponding to those in FIG. 8, and the description thereof will be appropriately omitted.

The difference between the homogeneous transformation matrix of Equation (7) and the unit matrix, namely the difference between the point K3₍₁₎ and the point K3ᵣ and the difference between the point K4₍₁₎ and the point K4ᵣ as a total amount of errors after the turning correspond to the 3×3 orthogonal matrix R_{(A1, B1, C1, θ1)} and the 3×3 orthogonal matrix R_{(A2, B2, C2, θ2)} represented by Equation (17), respectively. In FIG. 10, the arrow NHR11 and the arrow NHR12 represent the difference between the point K3₍₁₎ and the point K3ᵣ and the difference between the point K4₍₁₎ and the point K4ᵣ as the total amount of errors.

In addition, directions of the point KAF11 and the point KAF12 are directions represented by Equation (19). Moreover, the directions of the point KAF11 and the point KAF12 are directions corresponding to the point K1₍ₛ₎ and the point K2₍ₛ₎ and are directions corresponding to the point K3₍ₛ₊₁₎ and the point K4₍ₛ₊₁₎.

Directions of points obtained by performing transformation represented by the arrow NHR13 and the arrow NHR14, namely directional transformation by the orthogonal matrix R_{(A1, B1, C1, s×θ1/N)} and the orthogonal matrix R_{(A2, B2, C2, s×θ2/N)} on the directions of the point KAF11 and the point KAF12 are directions of the point KAF13 and the point KAF14.

These directions of the point KAF13 and the point KAF14 are directions represented by Equation (18). In addition, the directions of the point KAF13 and the point KAF14 are directions corresponding to the point K1₍ₛ₎ and the point K2₍ₛ₎ after the error allocation, and also are directions corresponding to the point K3₍ₛ₊₁₎ and the point K4₍ₛ₊₁₎. The movement amounts represented by the arrow NHR11 and the arrow NHR12, namely the movement amounts represented by the arrow NHR13 and the arrow NHR14 with respect to the angles θ1 and θ2 are amounts represented by s/N (that is, sθ1/N and sθ2/N).

### [Configuration Example of Image Processing Apparatus]

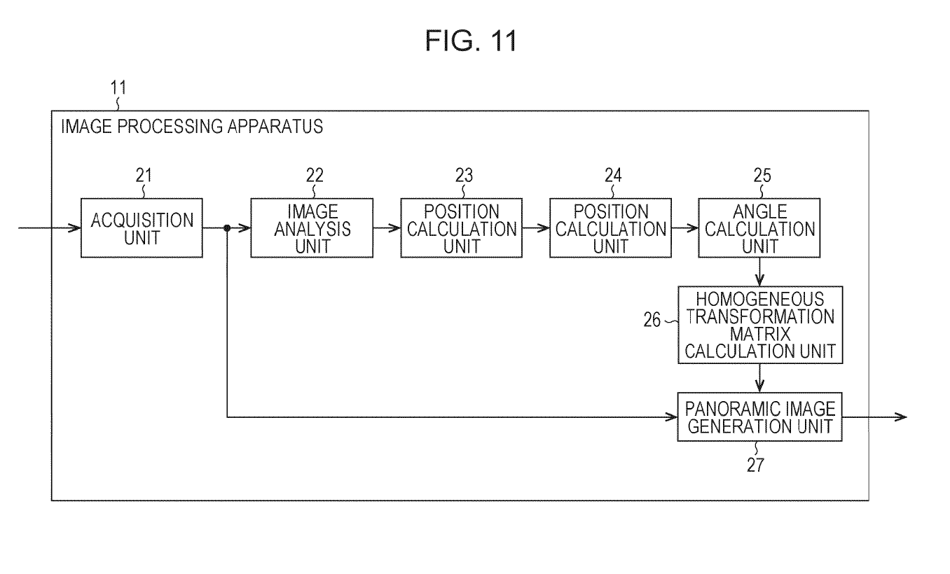

Next, description will be given of specific embodiments to which the present technology is applied. FIG. 11 is a diagram showing a configuration example of an embodiment of an image processing apparatus to which the present invention is applied.

An image processing apparatus 11 in FIG. 11 is configured of an acquisition unit 21, an image analysis unit 22, a position calculation unit 23, a position calculation unit 24, an angle calculation unit 25, a homogeneous transformation matrix calculation unit 26, and a panoramic image generation unit 27.

The acquisition unit 21 acquires N captured images which are successively captured while an imaging device such as a digital camera is rotated and supplies the captured images to the image analysis unit 22 and the panoramic image generation unit 27.

The image analysis unit 22 calculates a homogeneous transformation matrix H_{s,s+1} which represents positional relationships between adjacent captured images based on the captured images supplied from the acquisition unit 21 and supplies the homogeneous transformation matrix H_{s,s+1} to the position calculation unit 23. The position calculation unit 23 calculates positions of a point K1₍ₛ₎ and a point K2₍ₛ₎ based on the homogeneous transformation matrix H_{s,s+1} supplied from the image analysis unit 22 and supplies the homogeneous transformation matrix H_{s,s+l} and the positions of the point K1₍ₛ₎ and the point K2₍ₛ₎ to the position calculation unit 24.

The position calculation unit 24 calculates positions of a point K3₍ₛ₎ and a point K4₍ₛ₎ based on the homogeneous transformation matrix H_{s,s+1} and the positions of the point K1₍ₛ₎ and the point K2₍ₛ₎ from the position calculation unit 23 and supplies the homogeneous transformation matrix H_{s,s+1} and the positions of the point K1₍ₛ₎ to the point K4₍ₛ₎ to the angle calculation unit 25. The angle calculation unit 25 calculates a rotation angle which represents a total amount of errors after the turning based on the homogeneous transformation matrix H_{s,s+1} and the positions of the point K1₍ₛ₎ to the point K4₍ₛ₎ from the position calculation unit 24. In addition, the angle calculation unit 25 supplies the homogeneous transformation matrix H_{s,s+1}, the positions of the point K1₍ₛ₎ to the point K4₍ₛ₎, and the calculated rotation angle to the homogeneous transformation matrix calculation unit 26.

The homogeneous transformation matrix calculation unit 26 calculates a homogeneous transformation matrix Q′ₛ which represents a positional relationship between the first and s-th captured images based on the homogeneous transformation matrix H_{s,s+1}, the positions of the point K1₍ₛ₎ to the point K4₍ₛ₎, and the rotation angle from the angle calculation unit 25 and supplies the homogeneous transformation matrix Q′ₛ to the panoramic image generation unit 27.

The panoramic image generation unit 27 generates and outputs a panoramic image based on the captured images supplied from the acquisition unit 21 and the homogeneous transformation matrix Q′ₛ supplied from the homogeneous transformation matrix calculation unit 26.

### [Description of Panoramic Image Generation Processing]

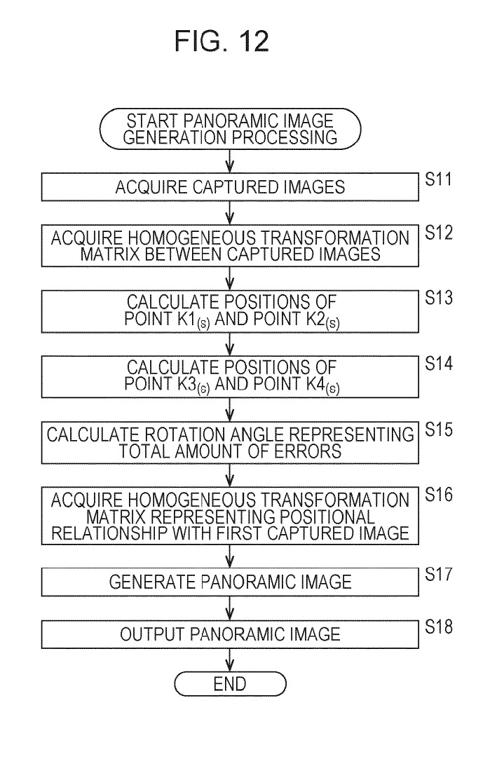

Next, description will be given of panoramic image generation processing by the image processing apparatus 11 with reference to the flowchart in FIG. 12.

In Step S11, the acquisition unit 21 acquires N captured images which are successively captured while the imaging device is rotated and supplies the captured images to the image analysis unit 22 and the panoramic image generation unit 27.

In Step S12, the image analysis unit 22 acquires a homogeneous transformation matrix H_{s,s+1} (where s=1 to N) between adjacent captured images represented by Equation (1) and Equation (2) by analyzing the adjacent captured images based on the captured images supplied from the acquisition unit 21. The image analysis unit 22 supplies the acquired homogeneous transformation matrix H_{s,s+1} to the position calculation unit 23.

In Step S13, the position calculation unit 23 calculates positions of the point K1₍ₛ₎ and the point K2₍ₛ₎ (where s=1 to N) represented by Equation (12) based on the homogeneous transformation matrix H_{s,s+1} supplied from the image analysis unit 22 and a pixel number Height of each captured image in the vertical direction.

The position calculation unit 23 supplies the homogeneous transformation matrix H_{s,s+1} and the calculated positions of the point K1₍ₛ₎ and the point K2₍ₛ₎ to the position calculation unit 24.

In Step S14, the position calculation unit 24 calculates positions of the point K3₍ₛ₎ and the point K4₍ₛ₎ (where s=1 to N) represented by Equation (13) based on the homogeneous transformation matrix H_{s,s+1} and the positions of the point K1₍ₛ₎ and the point K2₍ₛ₎ from the position calculation unit 23. The position calculation unit 24 supplies the homogeneous transformation matrix H_{s,s+1} and the positions of the point K1₍ₛ₎ to the point K4₍ₛ₎ to the angle calculation unit 25.

In Step S15, the angle calculation unit 25 calculates a rotation angle which represents a total amount of errors after the turning and a vector which functions as a rotation axis at that time based on the homogeneous transformation matrix H_{s,s+1} and the positions of the point K1₍ₛ₎ to the point K4₍ₛ₎ from the position calculation unit 24.

That is, the angle calculation unit 25 acquires a vector (A1, B1, C1) and an angle θ1 which satisfies Equation (24) and acquires a vector (A2, B2, C2) and an angle θ2 which satisfy Equation (25). However, the sizes of the three-dimensional vector (A1, B1, C1) and the vector (A2, B2, C2) are one, and the angle θ1 and the angle θ2 are angles which are equal to or greater than 0° and equal to or less than 180°.

The angle calculation unit 25 supplies the homogenous transformation matrix H_{s,s+1}, the positions of the point K1₍ₛ₎ to the point K4₍ₛ₎, the vector (A1, B1, C1), the angle θ1, the vector (A2, B2, C2), and the angle θ2 to the homogeneous transformation matrix calculation unit 26.

In Step S16, the homogeneous transformation matrix calculation unit 26 calculates a homogeneous transformation matrix Q′ₛ (where s=1 to N) which represents a positional relationship between the first and the s-th captured images based on the homogeneous transformation matrix H_{s,s+1}, the positions of the point K1₍ₛ₎ to the point K4₍ₛ₎, the angles, and the vectors from the angle calculation unit 25.

That is, the homogeneous transformation matrix calculation unit 26 acquires directions represented by Equation (18) and Equation (20) (or Equation (27) in a case where s=1) and calculates a 3×3 matrix Q′ₛ which satisfies Equation (26) as a homogeneous transformation matrix Q′ₛ (where s=1 to N). In addition, the respective rotation matrixes in Equation (18) and Equation (20), namely an orthogonal matrix R_{(A1, B1, C1, s×θ1/N)} and an orthogonal matrix R_{(A2, B2, C2, s×θ2/N)} are matrixes defined by Equation (21).

The homogeneous transformation matrix calculation unit 26 supplies each thus acquired homogeneous transformation matrix Q′ₛ (where s=1 to N) to the panoramic image generation unit 27.

In Step S17, the panoramic image generation unit 27 generates a panoramic image based on the captured image supplied from the acquisition unit 21 and the homogeneous transformation matrix Q′ₛ supplied from the homogeneous transformation matrix calculation unit 26.

Specifically, the panoramic image generation unit 27 generates a panoramic image of 360° by mapping a pixel value at each position Wₛ in the captured images, namely the first to N-th respective captured images, as light coming from the direction represented by Equation (28) in the canvas region prepared in advance. That is, the panoramic image generation unit 27 maps the pixel value of the pixel at the position Wₛ on a position, which is determined by the direction represented by Equation (28), in the canvas region.

Here, the pixel value of the pixel in each captured image is generally a value from 0 to 255 when the captured image is a monochrome image, and is a value expressing three primary colors, namely red, green, and blue by 0 to 255 when the captured image is a color image.

In Step S18, the panoramic image generation unit 27 regards the image on the canvas region as a panoramic image of 360° and outputs the panoramic image, and the panoramic image generation processing is completed.

As described above, the image processing apparatus 11 divides the total amount of errors after the turning into N, assigns the divided errors to the positional relationships between the adjacent captured images, acquires the homogeneous transformation matrix Q′ₛ which represents the positional relationship between the first and the s-th captured images after the error assignment, and generates the panoramic image. It is possible to acquire the homogeneous transformation matrix Q′ₛ with a simple operation and to thereby more simply and quickly generate the panoramic image.

### Modification Example 1 of First Embodiment

### Concerning Division of Total Amount of Errors

Incidentally, the angle θ1 and the angle θ2 which are the difference between the point K3₍₁₎ and the point K3ᵣ and the difference between the point K4₍₁₎ and the point K4ᵣ are divided into N in the first embodiment.

However, when an angular velocity at which the imaging device is panned is not constant, the following defect occurs. That is, it is assumed that ten captured images are captured from 40° to 50°, for example. Then, it is assumed that two captured images are captured from 80° to 90°.

In such a case, errors of the ten captured images are allocated from 40° to 50°, and errors of the two captured images are allocated from 80° to 90°. Since the errors are equally divided into N in the first embodiment, errors which are five times as large as those for the range from 80° to 90° are allocated to the range from 40° to 50° in the panoramic image (omnidirectional image) of 360° as a resulting image. For this reason, errors are concentrated on the part from 40° to 50°, and a failure (deterioration in how the images are connected) in the image at the part from 40° to 50° becomes noticeable.

Thus, the errors to be allocated may not be equally divided into N, and allocation proportions may be determined by applying weights.

That is, errors are allocated to the ten captured images at the part from 40° to 50° by applying a weight ⅕ times as large as that in the case of the two captured images at the part from 80° to 90°, for example. With such processing, it is possible to acquire a resulting image in which failures (failures in how the images are connected) are equally distributed over the entire part without causing the errors to be concentrated on the part from 40° to 50°.

For example, a weight is applied so as to be proportional to a difference between the imaging direction in which the s-th captured image is captured and the imaging direction in which the s+1-th captured image is captured. This is expressed as the following Equation (29). That is, an angle φₛ which satisfies Equation (29) is an angle between the imaging direction of the s-th captured image and the imaging direction of the s+1-th captured image.

$$\begin{matrix}[ Math . 29 ] & \\ ‖ {H}_{s , s + 1} [ \begin{matrix}0 \\ 0 \\ 1\end{matrix} ] ‖ cos ( {φ}_{s} ) = [ \begin{matrix}0 & 0 & 1\end{matrix} ] {H}_{s , s + 1} [ \begin{matrix}0 \\ 0 \\ 1\end{matrix} ] & ( 29 )\end{matrix}$$

Equation (29) implies the following fact. That is, a direction of a center position of the s+1-th captured image in a three-dimensional coordinate system with reference to the imaging direction in which the s-th captured image is captured is a direction represented by the following Equation (30).

$$\begin{matrix}[ Math . 30 ] & \\ {H}_{s , s + 1} [ \begin{matrix}0 \\ 0 \\ 1\end{matrix} ] & ( 30 )\end{matrix}$$

The angle between the imaging direction in which (the center position of) the s-th captured image is captured and the imaging direction in which (the center position of) the s+1-th captured image is captured is the angle φₛ represented by Equation (29) if an inner product of the vectors are considered. When s=N, s+1 means 1.

### [Description of Panoramic Image Generation Processing]

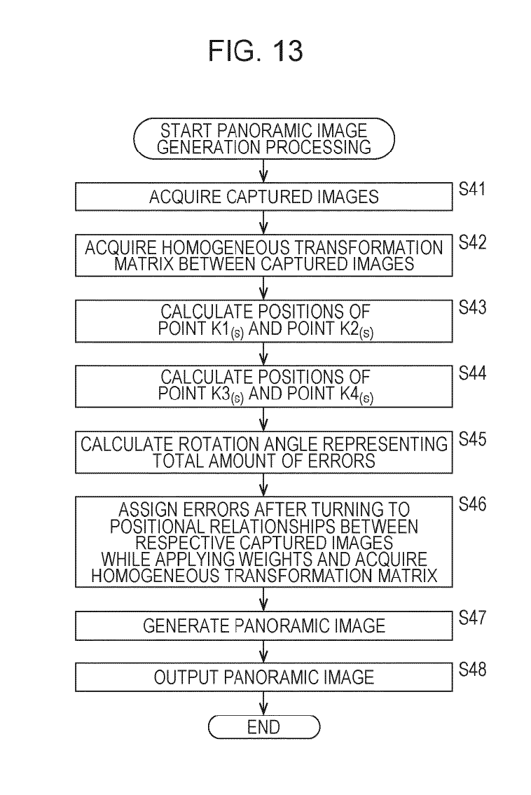

Accordingly, if the allocation proportions are set by applying weights when the total amount of errors after the turning is assigned to the positional relationships between the respective captured images, it is only necessary for the image processing apparatus 11 to perform the panoramic image generation processing as shown in FIG. 13.

Hereinafter, description will be given of the panoramic image generation processing by the image processing apparatus 11 with reference to the flowchart in FIG. 13. Since the processing from Step S41 to Step S45 is the same as that from Step S11 to Step S15 in FIG. 12, the description thereof will be omitted.

In Step S46, the homogeneous transformation matrix calculation unit 26 assigns the errors after the turning to the positional relationships between the respective captured images while applying weights and calculates the homogeneous transformation matrix Q′ₛ (where s=1 to N) based on the homogeneous transformation matrix H_{s,s+1}, the positions of the point K1₍ₛ₎ to the point K4₍ₛ₎, the angles, and the vectors from the angle calculation unit 25.

That is, the homogeneous transformation matrix calculation unit 26 acquires directions represented by the following Equation (31) and Equation (32) and calculates a 3×3 matrix Q′ₛ which satisfies the following Equation (33) as the homogeneous transformation matrix Q′ₛ (where s=1 to N).

$$\begin{matrix} [ Math . 31 ] & \\ ( {\prod }_{k = 1 to s - 1} {H}_{k , k + 1} ) {R}_{( A 1 , B 1 , C 1 , {G}_{s} \times θ1 )} K {1}_{( s )} = {H}_{1 , 2} {H}_{2 , 3} {H}_{3 , 4} … {H}_{s - 2 , s - 1} {H}_{s - 1 , s} {R}_{( A 1 , B 1 , C 1 , {G}_{s} \times θ1 )} K {1}_{( s )} , \\ ( {\prod }_{k = 1 to s - 1} {H}_{k , k + 1} ) {R}_{( A 2 , B 2 , C 2 , {G}_{s} \times θ2 )} K {2}_{( s )} = {H}_{1 , 2} {H}_{2 , 3} {H}_{3 , 4} … {H}_{s - 2 , s - 1} {H}_{s - 1 , s} {R}_{( A 2 , B 2 , C 2 , {G}_{s} \times θ2 )} K {2}_{( s )} & ( 31 ) \\ [ Math . 32 ] & \\ ( {\prod }_{k = 1 to s - 2} {H}_{k , k + 1} ) {R}_{( A 1 , B 1 , C 1 , {G}_{( s - 1 )} \times θ1 )} {H}_{s - 1 , s} K {3}_{( s )} = {H}_{1 , 2} {H}_{2 , 3} {H}_{3 , 4} … {H}_{s - 2 , s - 1} {R}_{( A 1 , B 1 , C 1 , {G}_{( s - 1 )} \times θ1 )} {H}_{s - 1 , s} K {3}_{( s )} , \\ ( {\prod }_{k = 1 to s - 2} {H}_{k , k + 1} ) {R}_{( A 2 , B 2 , C 2 , {G}_{( s - 1 )} \times θ2 )} {H}_{s - 1 , s} K {4}_{( s )} = {H}_{1 , 2} {H}_{2 , 3} {H}_{3 , 4} … {H}_{s - 2 , s - 1} {R}_{( A 2 , B 2 , C 2 , {G}_{( s - 1 )} \times θ2 )} {H}_{s - 1 , s} K {4}_{( s )} , & ( 32 ) \\ [ Math . 33 ] & \\ \begin{matrix}( \begin{matrix}Direction represented by first equation \\ in Equation ( 31 ) \\ ( that is , direction of K {1}_{( s )} in reference \\ coordinate system )\end{matrix} ) ∝ {Q}_{s}^{′} K {1}_{( s )} \\ ( \begin{matrix}Direction represented by second equation \\ in Equation ( 31 ) \\ ( that is , direction of K {2}_{( s )} in reference \\ coordinate system )\end{matrix} ) ∝ {Q}_{s}^{′} K {2}_{( s )} \\ ( \begin{matrix}Direction represented by second equation \\ in Equation ( 31 ) \\ ( that is , direction of K {3}_{( s )} in reference \\ coordinate system )\end{matrix} ) ∝ {Q}_{s}^{′} K {3}_{( s )} \\ ( \begin{matrix}Direction represented by second equation \\ in Equation ( 31 ) \\ ( that is , direction of K {4}_{( s )} in reference \\ coordinate system )\end{matrix} ) ∝ {Q}_{s}^{′} K {4}_{( s )}\end{matrix} \} & ( 33 )\end{matrix}$$

In addition, the respective rotation matrixes in Equation (31) and Equation (32), namely an orthogonal matrix R_{(A1, B1, C1, Gs×θ1)} and an orthogonal matrix R_{(A2, B2, C2, Gs×θ2)} are matrixes defined by Equation (21). In addition, Gₛ represents a value (weight) represented by the following Equation (34).

$$\begin{matrix}[ Math . 34 ] & \\ {G}_{s} = \frac{{\sum }_{k = 1}^{s} {φ}_{k}}{{\sum }_{k = 1}^{N} {φ}_{k}} & ( 34 )\end{matrix}$$

Furthermore, directions of the point K1₍₁₎, the point K2₍₁₎, the point K3₍₁₎, the point K4₍₁₎, the point K3₍₂₎, and the point K4₍₂₎ in Equation (33) in the reference coordinate system (world coordinate system) are directions represented by the following Equation (35) instead of the direction represented by Equation (31) and Equation (32).

$$\begin{matrix}[ Math . 35 ] & \\ \begin{matrix}\begin{matrix}Direction of K {1}_{( 1 )} in \\ reference coordinate system\end{matrix} = {R}_{( A 1 , B 1 , C 1 , {G}_{1} \times θ1 )} K {1}_{( 1 )} \\ \begin{matrix}Direction of K {2}_{( 1 )} in \\ reference coordinate system\end{matrix} = {R}_{( A 2 , B 2 , C 2 , {G}_{1} \times θ2 )} K {2}_{( 1 )} \\ \begin{matrix}Direction of K {3}_{( 1 )} in \\ reference coordinate system\end{matrix} = K {3}_{( 1 )} \\ \begin{matrix}Direction of K {4}_{( 1 )} in \\ reference coordinate system\end{matrix} = K {4}_{( 1 )} \\ \begin{matrix}Direction of K {3}_{( 2 )} in \\ reference coordinate system\end{matrix} = {R}_{( A 1 , B 1 , C 1 , {G}_{1} \times θ1 )} {H}_{1 , 2} K {3}_{( 2 )} \\ \begin{matrix}Direction of K {4}_{( 2 )} in \\ reference coordinate system\end{matrix} = {R}_{( A 2 , B 2 , C 2 , {G}_{1} \times θ2 )} {H}_{1 , 2} K {4}_{( 2 )}\end{matrix} \} & ( 35 )\end{matrix}$$

If the homogeneous transformation matrix Q′, is calculated as described above, the homogeneous transformation matrix calculation unit 26 supplies the calculated homogeneous transformation matrix Q′ₛ to the panoramic image generation unit 27. If the processing in Step S46 is performed, the processing in Step S47 and Step S48 is performed, and the panoramic image generation processing is completed. However, since the processing is the same as the processing in Step S17 and Step S18 in FIG. 12, the description thereof will be omitted.

It is possible to acquire a panoramic image with higher quality by allocating errors, which correspond to appropriate weights Gₛ determined by angles between imaging directions of the respective captured images with respect to the total amount of the errors after the turning, to the positional relationships between the respective captured images as described above.

### Second Embodiment

[Concerning Division of Total Amount of Errors]

Incidentally, when the captured images are captured while the imaging device is panned about an optical axis, the homogeneous transformation matrix H_{s,s+1}, which is a positional relationship between adjacent captured images, is supposed to be an orthogonal matrix.

Thus, it is assumed that a position on the s-th captured image and a corresponding point on the s+1-th captured image, namely a position Vₛ and a position Vₛ₊₁ are acquired and that a homogeneous transformation matrix H_{s,s+1} which satisfies Equation (1) (or Equation (2)) is acquired by the block matching. At this time, it is assumed that the homogeneous transformation matrix H_{s,s+1} is obtained while a restriction that the homogeneous transformation matrix H_{s,s+1} is an orthogonal matrix is applied.

To be more precise, it is a matter of course that an orthogonal matrix which satisfies Equation (1) (or Equation (2)) to the maximum extent is acquired as the homogeneous transformation matrix H_{s,s+1} since there is an error between the corresponding points (the position Vₛ and the position Vₛ₊₁).

Now, if the thus acquired homogeneous transformation matrixes H_{s,s+1} are accumulated from s=1 to s=N, the captured image is supposed to return to the original position after the turning, that is, a unit matrix is supposed to be acquired. However, since the matrix acquired by accumulating the homogeneous transformation matrixes H_{s,s+1} is not a unit matrix due to errors, error allocation to the image directions of the respective captured images is considered.

The technology described in this embodiment is characterized by how to allocate the errors in the case where the result of accumulating the homogeneous transformation matrixes H_{s,s+1}, which are orthogonal matrixes, from s=1 to s=N is not a unit matrix.

In this embodiment, the difference between the homogeneous transformation matrix of Equation (7) and the unit matrix (the total amount of errors after the turning) as shown in FIG. 4 is defined as follows.

First, a direction represented by the following Equation (36) is considered as a center direction of the first captured image after the turning in the case where the positional relationships between the adjacent captured images are assumed to be the homogeneous transformation matrix H_{s,s+1} (orthogonal matrix).

$$\begin{matrix} [ Math . 36 ] & \\ {\prod }_{k = 1 to N} {H}_{k , k + 1} [ \begin{matrix}0 \\ 0 \\ 1\end{matrix} ] = {H}_{1 , 2} {H}_{2 , 3} {H}_{3 , 4} … {H}_{N - 2 , N - 1} {H}_{N - 1 , N} {H}_{N , 1} [ \begin{matrix}0 \\ 0 \\ 1\end{matrix} ] & ( 36 )\end{matrix}$$

Although the direction represented by Equation (36) is supposed to be a direction of a vector (0, 0, 1) if there is no error, the direction represented by Equation (36) is not the direction of the vector (0, 0, 1) due to errors in practice. Thus, a transformation matrix (rotation matrix) for rotation from the direction represented by Equation (36) to the direction of the vector (0, 0, 1) is considered. That is, a rotation matrix R_{(A3,B3,C3,θ3)} which satisfies the following Equation (37) is considered.

$$\begin{matrix} [ Math . 37 ] & \\ [ \begin{matrix}0 \\ 0 \\ 1\end{matrix} ] ∝ ( {\prod }_{k = 1 to N} {H}_{k , k + 1} ) {R}_{( A 3 , B 3 , C 3 , θ3 )} [ \begin{matrix}0 \\ 0 \\ 1\end{matrix} ] = {H}_{1 , 2} {H}_{2 , 3} {H}_{3 , 4} … {H}_{N - 2 , N - 1} {H}_{N - 1 , N} {H}_{N , 1} {R}_{( A 3 , B 3 , C 3 , θ3 )} [ \begin{matrix}0 \\ 0 \\ 1\end{matrix} ] & ( 37 )\end{matrix}$$

Specifically, the parameters A3, B3, C3, and θ3 of the rotation matrix R_{(A3,B3,C3,θ3)} which satisfy Equation (37) are as follows. That is, the following Equation (38) is obtained by deforming Equation (37).

$$\begin{matrix} [ Math . 38 ] & \\ {( {\prod }_{k = 1 to N} {H}_{k , k + 1} )}^{- 1} [ \begin{matrix}0 \\ 0 \\ 1\end{matrix} ] = {( {H}_{1 , 2} {H}_{2 , 3} {H}_{3 , 4} … {H}_{N - 2 , N - 1} {H}_{N - 1 , N} {H}_{N , 1} )}^{- 1} [ \begin{matrix}0 \\ 0 \\ 1\end{matrix} ] ∝ {R}_{( A 3 , B 3 , C 3 , θ3 )} [ \begin{matrix}0 \\ 0 \\ 1\end{matrix} ] & ( 38 )\end{matrix}$$

That is, a matrix acquired by deforming the vector (0, 0, 1) to be placed in the left side of Equation (38) is the rotation matrix R_{(A3,B3,C3,θ3)}. Thus, a direction which is orthogonal to two directions, namely the direction of the vector (0, 0, 1) and the direction represented in the left side of Equation (38) is regarded as a direction of a vector (A3, B3, C3).

Then, the direction of the vector (0, 0, 1) is rotated with respect to the direction of the vector (A3, B3, C3) so as to coincide with the direction represented in the left side of Equation (38), and the rotation angle of the vector (0, 0, 1) at this time is regarded as an angle θ3. Here, it is assumed that A3²+B3²+C3²=1 and that the angle θ3 is equal to or greater than 0° and equal to or less than 180°.

Specifically, such a rotation matrix R_{(A3,B3,C3,θ3)} is a matrix determined by A3, B3, C3, and θ3 which satisfy the following Equation (39).

$$\begin{matrix}[ Math . 39 ] & \\ \begin{matrix}( A 3 B 3 C 3 ) [ \begin{matrix}0 \\ 0 \\ 1\end{matrix} ] = 0 \\ ( A 3 B 3 C 3 ) {( {\prod }_{k = 1 to N} {H}_{k , k + 1} )}^{- 1} [ \begin{matrix}0 \\ 0 \\ 1\end{matrix} ] = ( A 3 B 3 C 3 ) {( \begin{matrix}{H}_{1 , 2} {H}_{2 , 3} {H}_{3 , 4} … \\ {H}_{N - 2 , N - 1} {H}_{N - 1 , N} {H}_{N , 1}\end{matrix} )}^{- 1} [ \begin{matrix}0 \\ 0 \\ 1\end{matrix} ] = 0 \\ {( {\prod }_{k = 1 to N - 1} {H}_{k , k + 1} )}^{- 1} [ \begin{matrix}0 \\ 0 \\ 1\end{matrix} ] = {( \begin{matrix}{H}_{1 , 2} {H}_{2 , 3} {H}_{3 , 4} … \\ {H}_{N - 2 , N - 1} {H}_{N - 1 , N} {H}_{N , 1}\end{matrix} )}^{- 1} [ \begin{matrix}0 \\ 0 \\ 1\end{matrix} ] ∝ [ \begin{matrix}A {3}^{2} + ( \begin{matrix}1 - \\ A {3}^{2}\end{matrix} ) cos ( θ 3 ) & \begin{matrix}A 3 B 3 ( \begin{matrix}1 - \\ cos ( θ3 )\end{matrix} ) - \\ C 3 sin ( θ 3 )\end{matrix} & \begin{matrix}A 3 C 3 ( \begin{matrix}1 - \\ cos ( θ3 )\end{matrix} ) + \\ B 3 sin ( θ 3 )\end{matrix} \\ \begin{matrix}A 3 B 3 ( \begin{matrix}1 - \\ cos ( θ3 )\end{matrix} ) + \\ C 3 sin ( θ 3 )\end{matrix} & B {3}^{2} + ( \begin{matrix}1 - \\ B {3}^{2}\end{matrix} ) cos ( θ 3 ) & \begin{matrix}B 3 C 3 ( \begin{matrix}1 - \\ cos ( θ3 )\end{matrix} ) - \\ A 3 sin ( θ 3 )\end{matrix} \\ \begin{matrix}A 3 C 3 ( \begin{matrix}1 - \\ cos ( θ3 )\end{matrix} ) - \\ B 3 sin ( θ 3 )\end{matrix} & \begin{matrix}B 3 C 3 ( \begin{matrix}1 - \\ cos ( θ3 )\end{matrix} ) + \\ A 3 sin ( θ3 )\end{matrix} & C {3}^{2} + ( \begin{matrix}1 - \\ C {3}^{2}\end{matrix} ) cos ( θ 3 )\end{matrix} ] [ \begin{matrix}0 \\ 0 \\ 1\end{matrix} ]\end{matrix} \} & ( 39 )\end{matrix}$$

In Equation (39), A3²+B3²+C3²=1, and the angle θ3 is equal to or greater than 0° and equal to or less than 180°.

Incidentally, the rotation matrix R_{(A3,B3,C3,θ3)} merely expresses errors in a pitch component and a yaw component and does not express an error in a roll component. Thus, a rotation matrix configured only of the roll component is further considered. Rotation of the roll component is generally represented by the following Equation (40) when it is assumed that the rotation angle thereof is 84 (where the angle θ4 is equal to or greater than −180° and less than 180°).

$$\begin{matrix}[ Math . 40 ] & \\ [ \begin{matrix}cos ( θ4 ) & - sin ( θ4 ) & 0 \\ sin ( θ4 ) & cos ( θ4 ) & 0 \\ 0 & 0 & 1\end{matrix} ] & ( 40 )\end{matrix}$$

Therefore, it is possible to express the error in the roll component by acquiring the angle θ4 which satisfies the following Equation (41).

$$\begin{matrix} [ Math . 41 ] & \\ [ \begin{matrix}1 & 0 & 0 \\ 0 & 1 & 0 \\ 0 & 0 & 1\end{matrix} ] ∝ ( {\prod }_{k = 1 to N} {H}_{k , k + 1} ) [ \begin{matrix}cos ( θ4 ) & - sin ( θ4 ) & 0 \\ sin ( θ4 ) & cos ( θ4 ) & 0 \\ 0 & 0 & 1\end{matrix} ] {R}_{( A 3 , B 3 , C 3 , θ3 )} = {H}_{1 , 2} {H}_{2 , 3} {H}_{3 , 4} … {H}_{N - 2 , N - 1} {H}_{N - 1 , N} {H}_{N , 1} [ \begin{matrix}cos ( θ4 ) & - sin ( θ4 ) & 0 \\ sin ( θ4 ) & cos ( θ4 ) & 0 \\ 0 & 0 & 1\end{matrix} ] {R}_{( A 3 , B 3 , C 3 , θ3 )} & ( 41 )\end{matrix}$$

In Equation (41), the rotation matrix R_{(A3,B3,C3,θ3)} is a matrix acquired by Equation (39).

If the above description is summarized, the difference between the homogeneous transformation matrix of Equation (7) and the unit matrix (the total amount of errors after the turning) shown in FIG. 4 is expressed by using the two angles, namely the angle θ3 which represents the pitch component and the yaw component and the angle θ4 which represents the roll component in this embodiment.

That is, the difference between the homogeneous transformation matrix of Equation (7) and the unit matrix (the total amount of errors after the turning) shown in FIG. 4 is a matrix represented by the following Equation (42).

$$\begin{matrix}[ Math . 42 ] & \\ [ \begin{matrix}cos ( θ 4 ) & - sin ( θ 4 ) & 0 \\ sin ( θ 4 ) & cos ( θ 4 ) & 0 \\ 0 & 0 & 1\end{matrix} ] {R}_{( A 3 , B 3 , C 3 , θ 3 )} = [ \begin{matrix}cos ( θ 4 ) & - sin ( θ 4 ) & 0 \\ sin ( θ 4 ) & cos ( θ 4 ) & 0 \\ 0 & 0 & 1\end{matrix} ] [ \begin{matrix}A {3}^{2} + ( 1 - A {3}^{2} ) cos ( θ 3 ) & \begin{matrix}A 3 B 3 ( 1 - cos ( θ 3 ) ) - \\ C 3 sin ( θ 3 )\end{matrix} & \begin{matrix}A 3 C 3 ( 1 - cos ( θ 3 ) ) + \\ B 3 sin ( θ 3 )\end{matrix} \\ \begin{matrix}A 3 B 3 ( 1 - cos ( θ 3 ) ) + \\ C 3 sin ( θ 3 )\end{matrix} & \begin{matrix}B {3}^{2} + \\ ( 1 - B {3}^{2} ) cos ( θ 3 )\end{matrix} & \begin{matrix}B 3 C 3 ( 1 - cos ( θ 3 ) ) - \\ A 3 sin ( θ 3 )\end{matrix} \\ \begin{matrix}A 3 C 3 ( 1 - cos ( θ 3 ) ) - \\ B 3 sin ( θ 3 )\end{matrix} & \begin{matrix}B 3 C 3 ( 1 - cos ( θ 3 ) ) + \\ A 3 sin ( θ3 )\end{matrix} & \begin{matrix}C {3}^{2} + \\ ( 1 - C {3}^{2} ) cos ( θ 3 )\end{matrix}\end{matrix} ] & ( 42 )\end{matrix}$$

In addition, if there are no errors and the first captured image after the turning completely coincides with the original first captured image, θ3=0 and θ4=0 in Equation (41).

Thus, the error corresponding to (θ3/N)° for the pitch component and the yaw component and the error corresponding to (θ4/N)° for the roll component are assigned to the second captured image. In addition, the error corresponding to (2×θ3/N)° for the pitch component and the yaw component and the error corresponding to (2×θ4/N)° for the roll component are assigned to the third captured image.

Furthermore, the errors corresponding to (3×θ3/N)° for the pitch component and the yaw component and the error corresponding to (3×θ4/N)° for the roll component are assigned to the fourth captured image. Hereinafter, the error corresponding to ((N−1)×θ3/N)° for the pitch component and the yaw component and the error corresponding to ((N−1)×θ4/N)° for the roll component are similarly assigned to the N-th captured image.

If this is expressed by an equation, the following Equation (43) is acquired. In Equation (43), s=1 to N.

$$\begin{matrix} [ Math . 43 ] & \\ {Q}_{s}^{″} = ( {\prod }_{k = 1 to s - 1}^{ } {H}_{k , k + 1} ) [ \begin{matrix}cos ( \frac{( s - 1 ) \times θ 4}{N} ) & - sin ( \frac{( s - 1 ) \times θ 4}{N} ) & 0 \\ sin ( \frac{( s - 1 ) \times θ 4}{N} ) & cos ( \frac{( s - 1 ) \times θ 4}{N} ) & 0 \\ 0 & 0 & 1\end{matrix} ] {R}_{( A 3 , B 3 , C 3 , \frac{( s - 1 ) \times θ 3}{N} )} = {H}_{1 , 2} {H}_{2 , 3} {H}_{3 , 4} … {H}_{s - 2 , s - 1} {H}_{s - 1 , s} [ \begin{matrix}cos ( \frac{( s - 1 ) \times θ 4}{N} ) & - sin ( \frac{( s - 1 ) \times θ 4}{N} ) & 0 \\ sin ( \frac{( s - 1 ) \times θ 4}{N} ) & cos ( \frac{( s - 1 ) \times θ 4}{N} ) & 0 \\ 0 & 0 & 1\end{matrix} ] {R}_{( A 3 , B 3 , C 3 , \frac{( s - 1 ) \times θ 3}{N} )} & ( 43 )\end{matrix}$$

The homogeneous transformation matrix Q″ₛ represented by Equation (43) is a homogeneous transformation matrix which represents the positional relationship of the s-th captured image in the reference coordinate system (world coordinate system) that it is desirable to finally acquire. In this embodiment, the reference coordinate system (world coordinate system) coincides with the three-dimensional coordinate system with reference to the imaging direction in which the first captured image is captured. That is, the homogeneous transformation matrix Q″ₛ (that is, Q″₁) when s=1 is a unit matrix.

If the homogeneous transformation matrix Q″s (where s=1 to N) is acquired as described above, it is possible to acquire the panoramic image (omnidirectional image) of 360° by mapping the pixel value at each pixel position Wₛ in each captured image as light coming from the direction represented by the following Equation (44) in the canvas region. Here, the pixel value of the pixel in the captured image is generally a value from 0 to 255 when the captured image is a monochrome image, and is a value expressing three primary colors, namely red, green, and blue by 0 to 255 when the captured image is a color image.

[Math. 44]

Q″ₛW_{d} (44)

### [Configuration Example of Image Processing Apparatus]

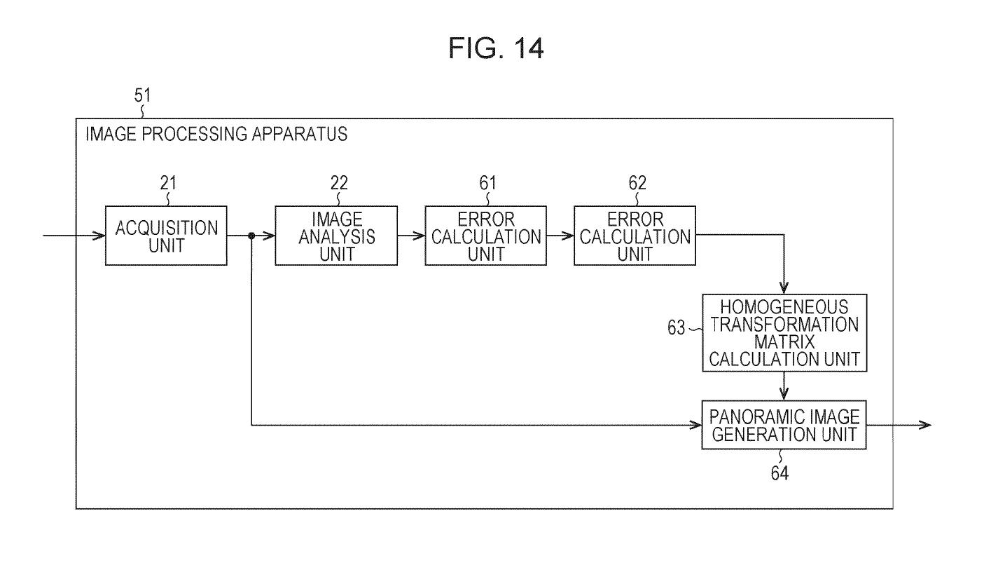

Next, description will be given of a specific embodiment to which the present technology is applied. FIG. 14 is a diagram showing a configuration example of an embodiment of an image processing apparatus to which the present technology is applied. In FIG. 14, the same reference numerals will be given to parts corresponding to those in FIG. 11, and the description thereof will be appropriately omitted.

An image processing apparatus 51 in FIG. 14 is configured of the acquisition unit 21, the image analysis unit 22, an error calculation unit 61, an error calculation unit 62, a homogeneous transformation matrix calculation unit 63, and a panoramic image generation unit 64.

The error calculation unit 61 acquires the angle θ3 which represents the pitch component and the yaw component in the total amount of errors after the turning based on the homogeneous transformation matrix H_{s,s+1} supplied from the image analysis unit 22 and supplies the homogeneous transformation matrix H_{s,s+1} and the angle θ3 to the error calculation unit 62. The error calculation unit 62 acquires the angle θ4 which represents the roll component in the total amount of errors after the turning based on the homogeneous transformation matrix H_{s,s+1} and the angle θ3 from the error calculation unit 61 and supplies the homogeneous transformation matrix H_{s,s+1}, the angle θ3, and the angle θ4 to the homogeneous transformation matrix calculation unit 63.

The homogeneous transformation matrix calculation unit 63 calculates the homogeneous transformation matrix Q″ₛ which represents the positional relationship between the first and the s-th captured image based on the homogeneous transformation matrix H_{s,s+1}, the angle θ3, and the angle θ4 from the error calculation unit 62 and supplies the homogeneous transformation matrix Q″ₛ to the panoramic image generation unit 64. The panoramic image generation unit 64 generates a panoramic image based on the captured images supplied from the acquisition unit 21 and the homogeneous transformation matrix Q″ₛ supplied from the homogeneous transformation matrix calculation unit 63 and outputs the panoramic image.

### [Description of Panoramic Image Generation Processing]

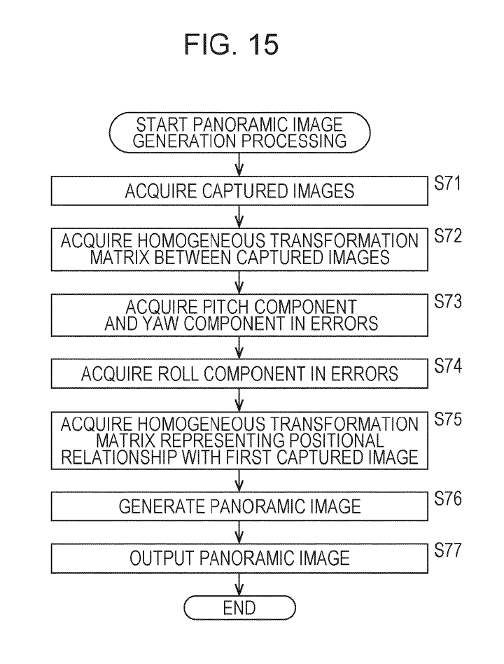

Next, description will be given of panoramic image generation processing by the image processing apparatus 51 with reference to the flowchart in FIG. 15. Since the processing in Step S71 and Step S72 is the same as the processing in Step S11 and Step S12 in FIG. 12, the description thereof will be omitted.

However, the homogeneous transformation matrix H_{s,s+1} is acquired under a condition of being an orthogonal matrix in Step S72. In addition, the homogeneous transformation matrix H_{s,s+1} acquired by the image analysis unit 22 is supplied to the error calculation unit 61.

In Step S73, the error calculation unit 61 acquires the angle θ3 which represents the pitch component and the yaw component in the total amount of errors after the turning and a vector (A3, B3, C3) which is a rotation axis at that time based on the homogeneous transformation matrix H_{s,s+1} supplied from the image analysis unit 22.

That is, the angle θ3 which satisfies Equation (39) and the vector (A3, B3, C3) are acquired. However, the size of the three-dimensional vector (A3, B3, C3) is one, and the angle θ3 is an angle which is equal to or greater than 0° and equal to or less than 180°.

The error calculation unit 61 supplies the homogeneous transformation matrix H_{s,s+1} and the obtained angle θ3 and vector (A3, B3, C3) to the error calculation unit 62.

In Step S74, the error calculation unit 62 acquires the angle θ4 which represents the roll component in the total amount of errors after the turning based on the homogeneous transformation matrix H_{s,s+1}, the angle θ3, and the vector (A3, B3, C3) supplied from the error calculation unit 61. That is, the angle θ4 which satisfies Equation (41) is acquired. Here, the angle θ4 is an angle which is equal to or greater than −180° and less than 180°.

The error calculation unit 62 supplies the homogeneous transformation matrix H_{s,s+1}, the angle θ3, the vector (A3, B3, C3), and the angle θ4 to the homogeneous transformation matrix calculation unit 63.

In Step S75, the homogeneous transformation matrix calculation unit 63 calculates Equation (43) based on the homogeneous transformation matrix H_{s,s+1}, the angle 83, the vector (A3, B3, C3), and the angle θ4 from the error calculation unit 62 and computes the 3x3 homogeneous transformation matrix Q″ₛ (where s=1 to N). The homogeneous transformation matrix calculation unit 63 supplies the computed homogeneous transformation matrix Q″ₛ which represents the positional relationship between the first and the s-th captured images to the panoramic image generation unit 64.

In Step S76, the panoramic image generation unit 64 generates a panoramic image based on the captured images from the acquisition unit 21 and the homogeneous transformation matrix Q″ₛ from the homogeneous transformation matrix calculation unit 63.

Specifically, the panoramic image generation unit 64 generates the panoramic image of 360° by mapping the pixel value of the pixel at each position W, in the captured images as light coming from the direction represented by Equation (44) in the canvas region prepared in advance for the first to N-th respective captured images. That is, the panoramic image generation unit 64 maps the pixel value of the pixel at the position Wₛ on a position, which is determined by the direction represented by Equation (44), in the canvas region.

Here, the pixel value of the pixel in the captured image is generally a value from 0 to 255 when the captured image is a monochrome image, and is a value expressing three primary colors, namely red, green, and blue by 0 to 255 when the captured image is a color image.

In Step S77, the panoramic image generation unit 64 regards the image on the canvas region as the panoramic image of 360° and outputs the panoramic image, and the panoramic image generation processing is completed.

As described above, the image processing apparatus 51 divides the total amount of errors after the turning into N, assigns the N errors to the positional relationships between the adjacent captured images, acquires the homogeneous transformation matrix Q″s which represents the positional relationship between the first and the s-th captured images after assigning the errors, and generates the panoramic image. It is possible to acquire the homogeneous transformation matrix Q″ₛ by simple computation and to thereby more simply and quickly generate the panoramic image.

### Modification Example 1 of Second Embodiment

### Concerning Division of Total Amount of Errors

Incidentally, the angle θ3 and the angle θ4 are equally divided into N in the second embodiment.

However, when an angular velocity at which the imaging device is panned is not constant, the following defect occurs. That is, it is assumed that ten captured images are captured from 40° to 50°, for example. Then, it is assumed that two captured images are captured from 80° to 90°.

In such a case, errors of the ten captured images are allocated from 40° to 50°, and errors of the two captured images are allocated from 80° to 90°. Since the errors are equally divided into N in the second embodiment, errors which are five times as large as those for the range from 80° to 90° are allocated to the range from 40° to 50° in the panoramic image (omnidirectional image) of 360° as a resulting image. For this reason, errors are concentrated on the part from 40° to 50°, and a failure (deterioration in how the images are connected) in the image at the part from 40° to 50° becomes noticeable.

Thus, the errors to be allocated may not be equally divided into N, and allocation proportions may be determined by applying weights.

That is, errors are allocated to the ten captured images at the part from 40° to 50° by applying a weight ⅕ times as large as that in the case of the two captured images at the part from 80° to 90°, for example. With such processing, it is possible to acquire a resulting image in which failures (failures in how the images are connected) are equally distributed over the entire part without causing the errors to be concentrated on the part from 40° to 50°.

### [Description of Panoramic Image Generation Processing]

Here, the weights as proportions for allocating the errors are computed by the same calculation as that in Modification Example 1 of the first embodiment, for example. That is, each weight is applied so as to be proportional to the difference between the imaging direction in which the s-th captured image is captured and the imaging direction in which the s+1-th captured image is imaged. This is expressed by Equation (29). That is, the angle φₛ which satisfies Equation (29) is an angle between the imaging direction of the s-th captured image and the imaging direction of the s+1-th captured image.

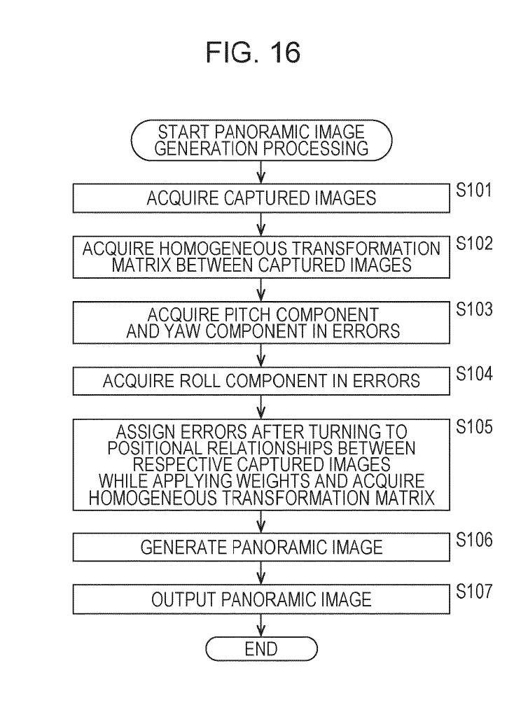

Accordingly, if the allocation proportions are determined by applying weights when the total amounts of errors after the turning is assigned to the positional relationships between the respective captured images, it is only necessary for the image processing apparatus 51 to perform the panoramic image generation processing shown in FIG. 16.

Hereinafter, description will be given of the panoramic image generation processing by the image processing apparatus 51 with reference to the flowchart in FIG. 16. Since the processing in Step S101 to Step S104 is the same as the processing in Step S71 to Step S74 in FIG. 15, the description thereof will be omitted.

In Step S105, the homogeneous transformation matrix calculation unit 63 assigns the errors after the turning with weights to the positional relationships between the respective captured images based on the homogeneous transformation matrix H_{s,s+1}, the angle θ3, the vector (A3, B3, C3), and the angle θ4 from the error calculation unit 62 and calculates the homogeneous transformation matrix Q″ₛ.

That is, the homogeneous transformation matrix calculation unit 63 calculates the following Equation (45) and computes the 3×3 homogeneous transformation matrix Q″ₛ (where s=1 to N). In Equation (45), G₍ₛ₋₁₎ is a value (weight) represented by the following Equation (34).

$$\begin{matrix} [ Math . 45 ] & \\ {Q}_{s}^{″} = ( {\prod }_{k = 1 to s - 1}^{ } {H}_{k , k + 1} ) [ \begin{matrix}cos ( {G}_{( s - 1 )} \times θ 4 ) & - sin ( {G}_{( s - 1 )} \times θ 4 ) & 0 \\ sin ( {G}_{( s - 1 )} \times θ 4 ) & cos ( {G}_{( s - 1 )} \times θ 4 ) & 0 \\ 0 & 0 & 1\end{matrix} ] {R}_{( A 3 , B 3 , C 3 , {G}_{( s - 1 )} \times θ 3 )} = {H}_{1 , 2} {H}_{2 , 3} {H}_{3 , 4} … {H}_{s - 2 , s - 1} {H}_{s - 1 , s} [ \begin{matrix}cos ( {G}_{( s - 1 )} \times θ 4 ) & - sin ( {G}_{( s - 1 )} \times θ 4 ) & 0 \\ sin ( {G}_{( s - 1 )} \times θ 4 ) & cos ( {G}_{( s - 1 )} \times θ 4 ) & 0 \\ 0 & 0 & 1\end{matrix} ] {R}_{( A 3 , B 3 , C 3 , {G}_{( s - 1 )} \times θ 3 )} & ( 45 )\end{matrix}$$

If the homogeneous transformation matrix Q″s is calculated as described above, the homogeneous transformation matrix calculation unit 63 supplies the calculated homogeneous transformation matrix Q″s to the panoramic image generation unit 64. If processing in Step S105 is performed, then processing in Step S106 and Step S107 is performed, and the panoramic image generation processing is completed. However, since the processing is the same as the processing in Step S76 and Step S77 in FIG. 15, the description thereof will be omitted.

It is possible to acquire a panoramic image with higher quality by allocating the errors corresponding to the appropriate weight Gₛ, which is determined by the angle between the imaging directions of the respective captured images, with respect to the total amount of errors after the turning to the positional relationship between the respective captured images as described above.

As described above in the first embodiment, the second embodiment, and the modification examples thereof, it is possible to simply solve the problem, in which a non-linear problem for minimizing Equation (6) in the related art is required to be solved, by the present technology. Specifically, it is possible to reduce the processing amount by dividing the difference between the homogeneous transformation matrix of Equation (7) and the unit matrix (the total amount of errors after the turning) shown in FIG. 4 into N and allocating the divided errors to the positional relationships between the respective adjacent captured images.

In addition, the present technology described in the first embodiment, the second embodiment, and the modification examples thereof can be configured as follows.

[1] An image processing method

using, as inputs, homogeneous transformation matrixes (homogeneous transformation matrixes H_{s,s+1} (s=1 to N−1) between the s-th and the s+1-th captured images (where s=1 to N−1) and a homogeneous transformation matrix H_{N,1} between the N-th and the first captured images) which represent positional relationships between adjacent captured images in N captured images (first to N-th captured images) that an imaging device successively captures while turning, and

outputting homogeneous transformation matrixes Qs which represent positions of the s-th captured images (s=1 to N) in a world coordinate system, the method including:

acquiring a homogeneous transformation matrix H_{1,t} with reference to the first captured image, which is acquired by accumulating the homogeneous transformation matrixes H_{s,s+1} in ascending order from s=1 to s=t−1 for arbitrary t (t=1 to N);

acquiring a matrix H_{round} by multiplying the homogeneous transformation matrix H_{1,t} when t=N, namely the homogeneous transformation matrix H_{1,N} by the homogeneous transformation matrix H_{N,1};

acquiring a value acquired by dividing a difference between the matrix H_{round} and a unit matrix into N, namely N divided errors; and

outputting, as a homogeneous transformation matrix Qt, a matrix acquired by applying t or t−1 divided errors to the homogeneous transformation matrix H_{1,t} (t=1 to N).

[2] The image processing method according to [1],

wherein the difference between the matrix H_{round} and the unit matrix is a movement amount by which a direction of a specific pixel position in the first captured image is moved by the matrix H_{round}, and

wherein rotation angles acquired by dividing a rotation amount corresponding to the movement amount into N are regarded as the divided errors.

[3] The image processing method according to [1],

wherein the difference between the matrix H_{round} and the unit matrix is a movement amount by which an imaging direction of the first captured image is moved by the matrix H_{round}, and

wherein a rotation angle corresponding to the movement amount is divided into two, namely pitch and yaw components and a roll component, and rotation angles acquired by dividing the respective components into N are regarded as the divided errors.

[4] The image processing method according to any one of [1] to [3],

wherein values acquired by dividing the difference between the matrix H_{round} and the unit matrix into N by applying weights in accordance with movement amounts by the homogeneous transformation matrix H_{s,s+1} are regarded as the divided errors.

### [Three-Freedom-Level Turning Optimization, Forward Direction-Backward Direction]

### Third Embodiment

### Concerning Panoramic Image

In addition, a homogeneous transformation matrix may be obtained by simpler computation by taking positional relationships of the respective captured images when the captured images are aligned in a forward direction and positional relationships of the respective captured images when the captured images are aligned in a backward direction into consideration when a panoramic image is generated.

For example, it is possible to generate a panoramic image of 360° from a plurality of captured images which successively captured and acquired by an imaging device such as a digital camera being panned, namely being turned by 360°.

It is assumed that the captured images captured while the imaging device is turned are a total of N captured images including the first captured image, the second captured image, . . . , and the N-th captured image. In addition, it is assumed that a focal distance F of a lens during imaging is one. In a case where the focal distance F is not one, it is possible to create a virtual image with a focal distance F of one by enlarging or contracting the captured image, and therefore, description will be continued on the assumption that the focal distances F of all the captured images are one.

Such a panoramic image of 360° is generated as follows, for example.

First, a positional relationship between adjacent captured images is acquired. That is, it is assumed that an arbitrary imaging target object is projected at a position Vₛ in the s-th captured image and is also projected at a position Vₛ₊₁ in the s+1-th captured image. A relationship between the position Vₛ and the position Vₛ₊₁ at this time is acquired.

Such a positional relationship can be generally expressed by a homogeneous transformation matrix (homography) H_{s,s+1} represented by the following Equation (46).

[Math. 46]

Vₛ∝H_{s,s+1}Vₛ₊₁ (46)

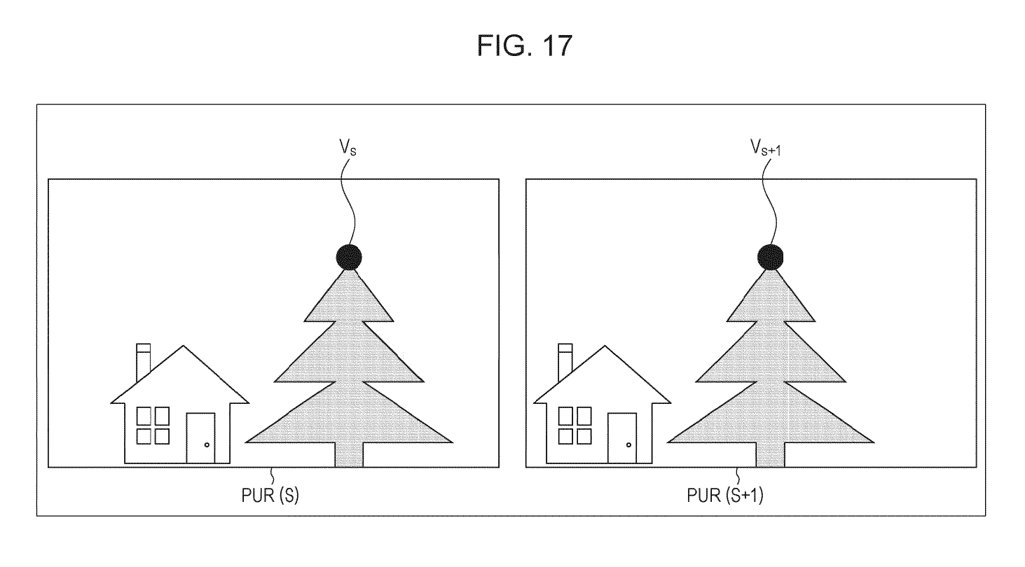

In a specific example, it is assumed that the same tree as an imaging target object is projected in the s-th captured image PUR(s) and in the s+1-th captured image PUR(s+1) as shown in FIG. 17, for example.

If attention is paid to a tip end of the tree as the imaging target object, the tip end portion of the tree is projected at a position Vₛ in the s-th captured image PUR(s) and is further projected at a position Vₛ₊₁ in the s+1-th captured image PUR(s+1). At this time, the position Vₛ and the position Vₛ₊₁ satisfy the aforementioned Equation (46).

Here, the position Vₛ and the position Vₛ₊₁ are expressed by same-order coordinates (also referred to as homogeneous coordinates). That is, each of the position Vₛ and the position Vₛ₊₁ is expressed by a three-dimensional vertical vector configured of three elements, namely an X coordinate of the captured image on the first line, a Y coordinate of the captured image on the second line, and 1 on the third line.

In addition, the homogeneous transformation matrix H_{s,s+1} is a 3×3 matrix representing a positional relationship between the s-th and the s+1-th captured images. In addition, s in Equation (46) satisfies s=1 to N. Moreover, it is assumed that s+1 is “1” when s=N. That is, the following Equation (47) is assumed.

[Math. 47]

V_{N}∝H_{N,1}V₁ (47)

Here, the homogeneous transformation matrix H_{N,1} in Equation (47) represents a positional relationship between a position V_{N} on the N-th captured image and a position V₁ on the first captured image. In the following description, it is assumed that s+1 in the index expressed as a combination of “s,s+1” means “1” in the case where s=N in the same manner. In addition, s−1 in the index expressed as a combination of “s−1,s” means “N” in the case where s=1.

The homogeneous transformation matrix H_{s,s+1} can be acquired by analyzing the s-th captured image and the s+1-th captured image.

Specifically, pixel positions on the s+1-th captured image corresponding to pixel positions of at least four points, for example, M points (Xa₍ₖ₎, Ya₍ₖ₎ (where k=1 to M) on the s-th captured image are acquired. That is, it is possible to acquire the pixel positions by considering a small region around the pixels in the s-th captured image and searching for a region matching with the small region in the s+1-th captured image.

Such processing is generally referred to as block matching. With such processing, the pixel positions (Xa₍ₖ₎, Ya₍ₖ₎) in the s-th captured image and the corresponding pixel positions (Xb₍ₖ₎, Yb₍ₖ₎) in the s+1-th captured image are acquired. Here, k=1 to M, and each of the pixel positions (Xa₍ₖ₎, Xb₍ₖ₎) and the pixel positions (Xb₍ₖ₎, Yb₍ₖ₎) is a position in an XY coordinate system with reference to each captured image.

Thus, it is only necessary to express these positions by the same-order coordinates and to acquire the matrix H_{s,s+1} which satisfies Equation (46). Since a method for acquiring the homogeneous transformation matrix by analyzing two images as described above is known, detailed description thereof will be omitted.

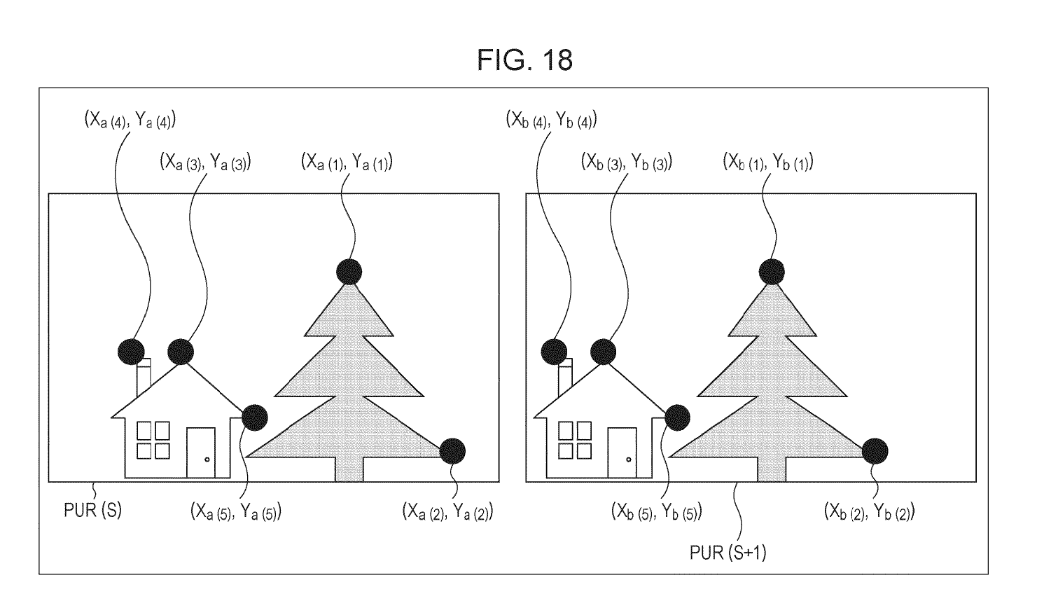

If such block matching is performed, the corresponding pixel positions between the adjacent captured images are acquired as shown in FIG. 18, for example. In FIG. 18, the same reference numerals are given to parts corresponding to those in FIG. 17, and the description thereof will be omitted.

In FIG. 18, five pixel positions (Xa₍ₖ₎, Ya₍ₖ₎) on the s-th captured image PUR(s) and five pixel positions (Xb₍ₖ₎, Yb₍ₖ₎) (where k=1 to 5) corresponding to the pixel positions on the s+1-th captured image PUR(s+1) are acquired. In this example, the number M of the corresponding pixel positions between the adjacent captured images is five.

Incidentally, a beam input direction on a three-dimensional space projected to a position Wₛ (same-order coordinates) in the s-th captured image is a direction represented by the following Equation (48) in a three-dimensional coordinate system with reference to a direction in which the first captured image is captured.

[Math. 48]

PₛWₛ (48)

However, a matrix Pₛ completely satisfies the following Equation (49). This is because the positional relationship between the s-th and the s+1-th captured images corresponds to the homogeneous transformation matrix H_{s,s+1}.

$$\begin{matrix}[ Math . 49 ] & \\ \begin{matrix}\begin{matrix}\begin{matrix}\begin{matrix}\begin{matrix}\begin{matrix}{P}_{2} = {P}_{1} {H}_{1 , 2} \\ {P}_{3} = {P}_{2} {H}_{2 , 3}\end{matrix} \\ {P}_{4} = {P}_{3} {H}_{3 , 4}\end{matrix} \\ ⋮\end{matrix} \\ {P}_{N - 1} = {P}_{N - 2} {H}_{N - 2 , N - 1}\end{matrix} \\ {P}_{N} = {P}_{N - 1} {H}_{N - 1 , N}\end{matrix} \\ {P}_{1} = {P}_{N} {H}_{N , 1}\end{matrix} & ( 49 )\end{matrix}$$

In addition, the matrix Pₛ is a homogeneous transformation matrix which represents the positional relationship between the s-th and the first captured images. In addition, the matrix P₁ is a 3×3 unit matrix. This is because the matrix P₁ is a coordinate system with reference to the first captured image, and therefore, it is a matter of course that transformation of the first captured image is identical transformation.

If the homogeneous transformation matrix Pₛ (where s=1 to N, P₁ is a unit matrix) represented by Equation (49) is acquired, it is possible to acquire a panoramic image (omnidirectional image) of 360° by mapping a pixel value of a pixel at each position Wₛ in each captured image in a canvas region as light coming from the direction represented by Equation (48). Here, the pixel value of the pixel in the captured image is generally a value from 0 to 255 when the captured image is a monochrome image, and is a value expressing three primary colors, namely red, green, and blue by 0 to 255 when the captured image is a color image.

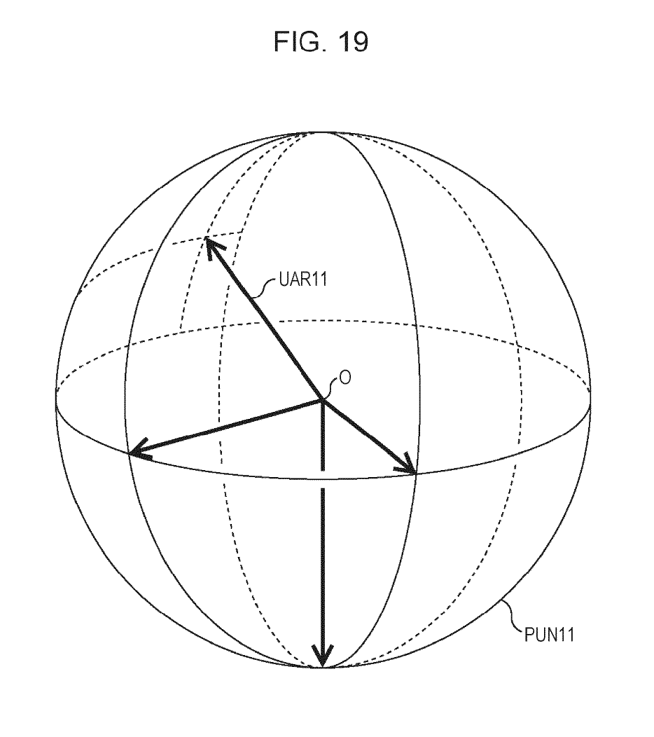

It is assumed that a surface of an omnidirectional sphere around an origin O in a three-dimensional coordinate system with reference to the direction in which the first captured image is captured is prepared in advance as a canvas region PUN11 as shown in FIG. 19, for example. It is assumed that a direction of the arrow UAR11 of the targeted pixel position in a predetermined captured image is acquired as the direction represented by Equation (48) at this time.

In such a case, a pixel value of the targeted pixel position in the captured image is mapped at a position of an intersection between the arrow UAR11 and the canvas region PUN11 in the canvas region PUN11. That is, the pixel value of the targeted pixel position in the captured image is set to a pixel value of a pixel at the position of the intersection between the arrow UAR11 and the canvas region PUN11.

An image on the canvas region PUN11 becomes a panoramic image of 360° if the respective positions on the respective captured images are mapped as described above.

Incidentally, since there is an error in the aforementioned homogeneous transformation matrix H_{s,s+1} in practice, it is not possible to completely satisfy Equation (49). Accordingly, Equation (50) is used in practice, and a homogeneous transformation matrix Pₛ as described below is acquired. In addition, since the desired homogeneous transformation matrix Pₛ includes N−1 matrixes excluding a matrix P₁ (unit matrix) and Equation (49) includes a total of N identity formulae, “the number of unknown numbers<the number of equations” is satisfied, and a solution which completely satisfies Equation (49) is not always present.

That is, since there is an error in the homogeneous transformation matrix H_{s,s+1}, the homogeneous transformation matrix Pₛ (where s=2 to N) is acquired such that each element in a 3×3 matrix Δ′ₛ (where s=1 to N) represented by the following Equation (50) instead of Equation (49) is minimized. In addition, P₁ represents a unit matrix.

$$\begin{matrix}[ Math . 50 ] & \\ \begin{matrix}\begin{matrix}\begin{matrix}\begin{matrix}\begin{matrix}\begin{matrix}{P}_{2} = {P}_{1} ( {H}_{1 , 2} + {Δ}_{1}^{′} ) \\ {P}_{3} = {P}_{2} ( {H}_{2 , 3} + {Δ}_{2}^{′} )\end{matrix} \\ {P}_{4} = {P}_{3} ( {H}_{3 , 4} + {Δ}_{3}^{′} )\end{matrix} \\ ⋮\end{matrix} \\ {P}_{N - 1} = {P}_{N - 2} ( {H}_{N - 2 , N - 1} + {Δ}_{N - 2}^{′} )\end{matrix} \\ {P}_{N} = {P}_{N - 1} ( {H}_{N - 1 , N} + {Δ}_{N - 1}^{′} )\end{matrix} \\ {P}_{1} = {P}_{N} ( {H}_{N , 1} + {Δ}_{N}^{′} )\end{matrix} & ( 50 )\end{matrix}$$

In other words, the homogeneous transformation matrix Pₛ (where s=2 to N) which minimizes the following Equation (51) is acquired.

$$\begin{matrix}[ Math . 51 ] & \\ {\sum }_{s = 1 to N}^{ } {{\sum }_{i = 1 to 3}^{ }}_{j = 1 to 3} {\{ {( {P}_{s}^{- 1} {P}_{s + 1} - {H}_{s , s + 1} )}_{column of}^{element on i \text{-} th row and j \text{-} th} \}}^{2} & ( 51 )\end{matrix}$$

Incidentally, the optimization problem is non-linear as can be understood from Equation (51), and the processing amount increases as can be understood from Equation (51). Since it is necessary to solve a non-linear problem which minimizes Equation (51) in order to acquire the homogeneous transformation matrix Pₛ (where s=2 to N) representing the optimal positional relationship between the s-th and the first captured images when the homogeneous transformation matrix H_{s,s+1} (where s=1 to N) as the positional relationship between the adjacent captured images is provided, a vast processing amount is required.

For this reason, it is not possible to simply and quickly generate a panoramic image.

The present technology was made in view of such circumstances and is designed to enable simple and quick acquisition of a panoramic image of 360°.

### [Concerning Overview of Present Technology]

According to the present technology, an optimal homogeneous transformation matrix is acquired by calculating homogeneous transformation matrixes which represent a positional relationship of a t-th captured image with respect to the first captured image for arbitrary t (where t=2 to N) in both the forward direction and the backward direction and prorating the homogeneous transformation matrixes. With such processing, it is possible to reduce the processing amount and more simply and quickly acquire a panoramic image with high quality.

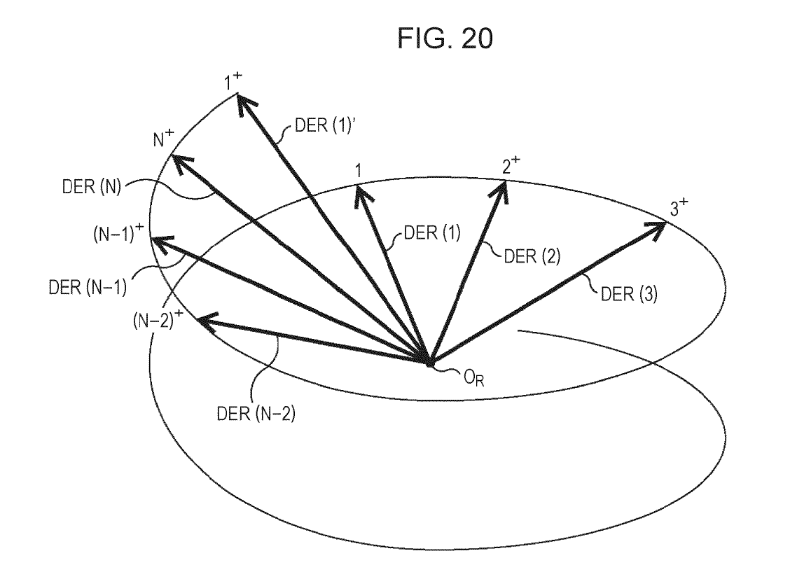

First, description will be given of a concept of the present technology with reference to FIGS. 20 to 27. Although FIGS. 20 to 27 should originally be described as one diagram, the diagram would be complicated, and therefore, FIGS. 20 to 27 are divided into a plurality of diagrams.

It is assumed that N captured images are captured while an imaging device is panned, namely is turned by 360° about a point O_{R} as a rotation center as shown in FIG. 20, for example. Here, the direction represented by the arrow DER(1) indicates the imaging direction in which the first captured image is captured.

Now, it is possible to acquire a homogeneous transformation matrix H_{1,2} which represents a positional relationship between the first captured image and the second captured image by analyzing these captured images as described above. By using the homogeneous transformation matrix H_{1,2}, an imaging direction of the second captured image with respect to the imaging direction of the first captured image is calculated. The direction represented by the arrow DER(2) indicates the imaging direction of the second captured image in FIG. 20, for example.

Furthermore, it is possible to acquire a homogeneous transformation matrix H_{2,3} which represents a positional relationship between the second captured image and the third captured image by analyzing these captured images, and an imaging direction of the third captured image with respect to the imaging direction of the second captured image is calculated by using the homogeneous transformation matrix H_{2,3}. The direction represented by the arrow DER(3) indicates the imaging direction of the third captured image in FIG. 20.

It is possible to acquire the directions of the respective captured images by image analysis thereafter in the same manner. The arrow DER(N−2) to the arrow DER(N) indicate imaging directions of the N−2-th to N-th captured images acquired by the image analysis in FIG. 20, for example. In addition, imaging directions of the fourth to (N−3)-th captured images are omitted in FIG. 20.

Furthermore, the arrow DER(1)′ indicates an imaging direction of the first captured image acquired from a homogeneous transformation matrix H_{N,1} which represents a positional relationship between the N-th and first captured images with respect to the imaging direction of the N-th captured image. The homogeneous transformation matrix H_{N,1} can be acquired by analyzing the N-th captured image and the first captured image.

Hereinafter, imaging directions of the captured images, which are represented by the respective arrows, namely the arrow DER(2) to the arrow DER(N) and the arrow DER(1)′ will also be referred to as imaging directions in the forward direction.

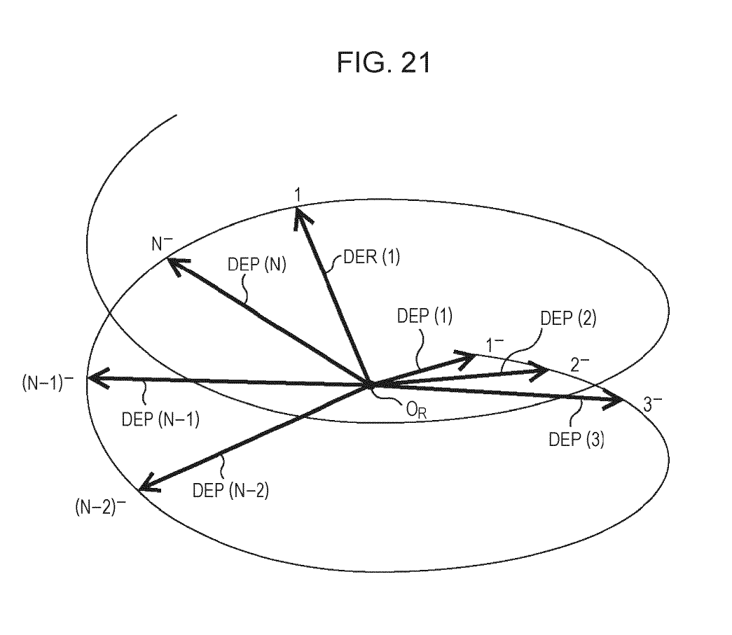

Next, the homogeneous transformation matrix H_{N,1} is acquired by analyzing the N-th captured image and the first captured image as shown in FIG. 21. In addition, it is possible to acquire the imaging direction in which the N-th captured image is captured, namely the direction represented by the arrow DEP(N) with respect to the imaging direction of the first captured image, namely the direction of the arrow DER(1) by using the homogeneous transformation matrix H_{N,1}.

Furthermore, a homogeneous transformation matrix H_{N-2,N} is acquired by analyzing the N−1-th captured image and the N-th captured image. It is possible to acquire an imaging direction in which the N−1-th captured image is captured, namely a direction represented by the arrow DEP(N−1) with respect to the imaging direction of the N-th captured image, namely the direction of the arrow DEP(N) by using the homogeneous transformation matrix H_{N-2,N}.

In addition, a homogeneous transformation matrix H_{N-2,N-1} is acquired by analyzing the N−2-th captured image and the N−1-th captured image. It is possible to acquire an imaging direction in which the N−2-th captured image is captured, namely a direction represented by the arrow DEP(N−2) with respect to the imaging direction of the N−1-th captured image by using the homogeneous transformation matrix H_{N-2,N-1}.

Hereinafter, it is possible to acquire the imaging directions of the respective captured images by the image analysis in the same manner. The arrow DEP(3) to the arrow DEP(1) indicate the imaging directions of the third to first captured images acquired by the image analysis in FIG. 21, for example. In FIG. 21, imaging directions of the fourth to (N−3)-th captured images are omitted in FIG. 21.

The homogeneous transformation matrix H_{1,2} is acquired by analyzing the second captured image and the first captured image, for example. It is possible to acquire the imaging direction in which the first captured image is captured, namely the direction represented by the arrow DEP(1) with respect to the imaging direction of the second captured image by using the homogeneous transformation matrix H_{1,2}.

Hereinafter, the imaging directions of the captured images represented by the respective arrows, namely the arrow DEP(1) to the arrow DEP(N) will also be referred to as imaging directions in the backward direction.

Here, the directions represented by the arrow DER(2) to the arrow DER(N) and the arrow DER(1)′ in FIG. 20 and directions represented by the arrow DEP(N) to the arrow DEP(1) in FIG. 21 are imaging directions acquired from the captured images by the image analysis. However, since errors are included in the image analysis, the directions are directions which are slightly different from the actual imaging directions.

If there are no errors in the image analysis, for example, an actual imaging direction of the first captured image, which is represented by the arrow DER(1), the imaging direction of the first captured image represented by the arrow DER(1)′ in the forward direction, and the imaging direction of the first captured image represented by the arrow DEP(1) in the backward direction are supposed to coincide with each other.

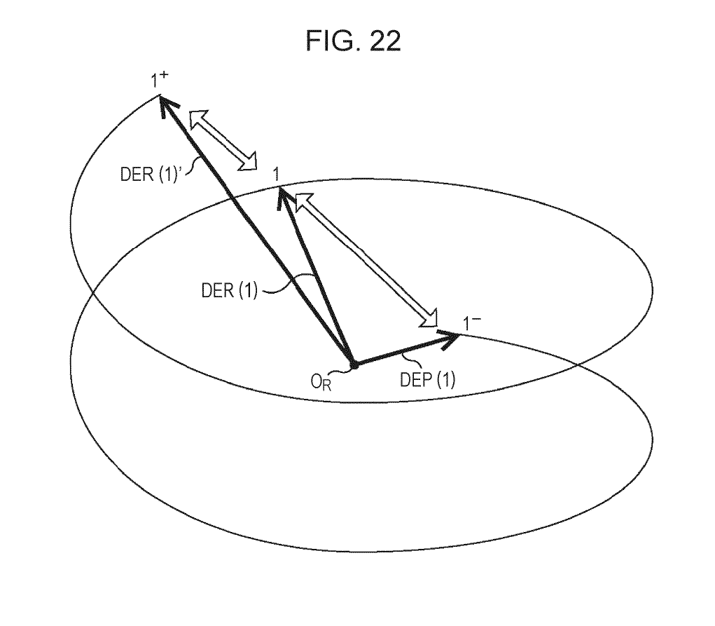

However, since there are errors in practice, these imaging directions represented by the arrow DER(1), the arrow DER(1)′, and the arrow DEP(1) do not coincide with each other as shown in FIG. 22.

Similarly, the imaging direction of the second captured image in the forward direction, which is represented by the arrow DER(2), and the imaging direction of the second captured image in the backward direction, which is represented by the arrow DEP(2), do not coincide with each other due to an error. In addition, imaging directions of other captured images in the forward direction and the backward direction, such as the imaging direction of the N-th captured image in the forward direction, which is represented by the arrow DER(N) and the imaging direction of the N-th captured image in the backward direction, which is represented by the arrow DEP(N), do not coincide with each other due to errors.

Thus, optimal imaging directions of the respective captured images are acquired by prorating these errors according to the present technology.

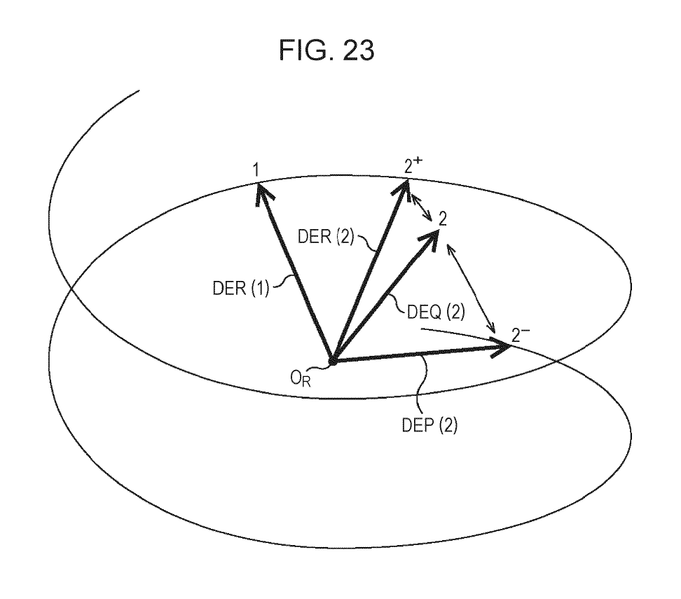

A direction acquired by prorating, at a ratio of N−1:1, the imaging direction in the forward direction which is represented by the arrow DER(2) and the imaging direction in the backward direction which is represented by the arrow DEP(2), namely a direction represented by the arrow DEQ(2) is acquired as shown in FIG. 23, for example. The thus acquired direction of the arrow DEQ(2) is regarded as an optimal imaging direction of the second captured image.

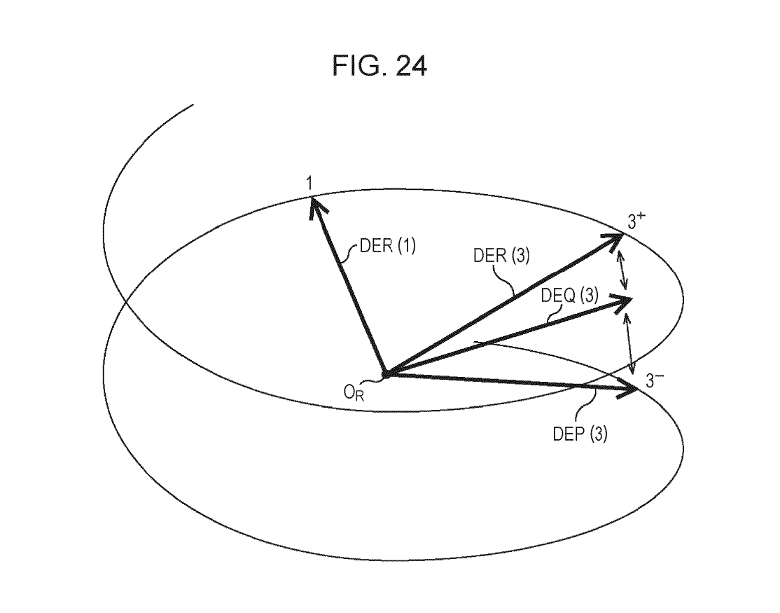

In addition, a direction acquired by prorating, at a ratio of N−2:2, the imaging direction in the forward direction which is represented by the arrow DER(3) and the imaging direction in the backward direction which is represented by the arrow DEP(3), namely a direction represented by the arrow DEQ(3) is acquired as shown in FIG. 24. Then, the thus acquired direction of the arrow DEQ(3) is regarded as an optimal imaging direction of the third captured image.

Hereinafter, the imaging directions of the captured images, namely the fourth to (N−3)-th captured images, in the forward direction and the backward direction are prorated in accordance with the positions of the captured images, that is, in accordance with which order the captured images are captured in, and optimal imaging directions of the captured images are acquired in the same manner.

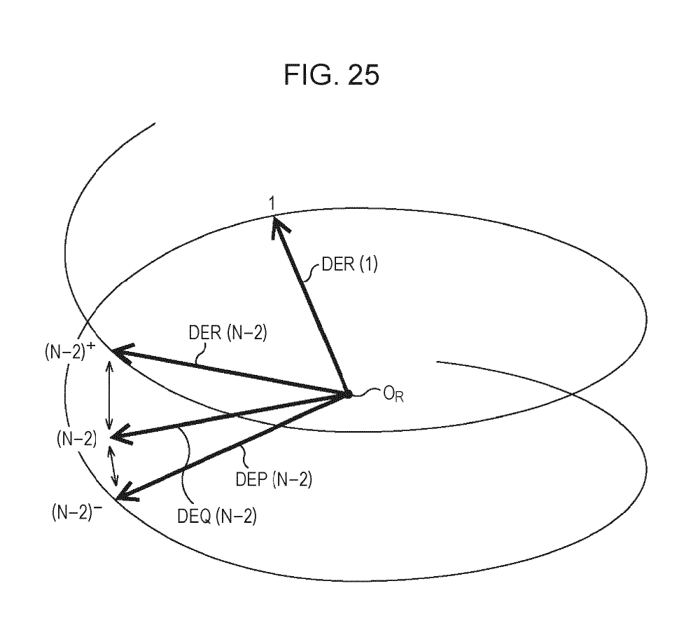

A direction acquired by prorating, at a ratio of 3:N−3, the imaging direction in the forward direction which is represented by the arrow DER(N−2) and the imaging direction in the backward direction which is represented by the arrow DEP(N−2), namely a direction represented by the arrow DEQ(N−2) is acquired as shown in FIG. 25. The thus acquired direction of the arrow DEQ(N−2) is regarded as an optimal imaging direction of the N−2-th captured image.

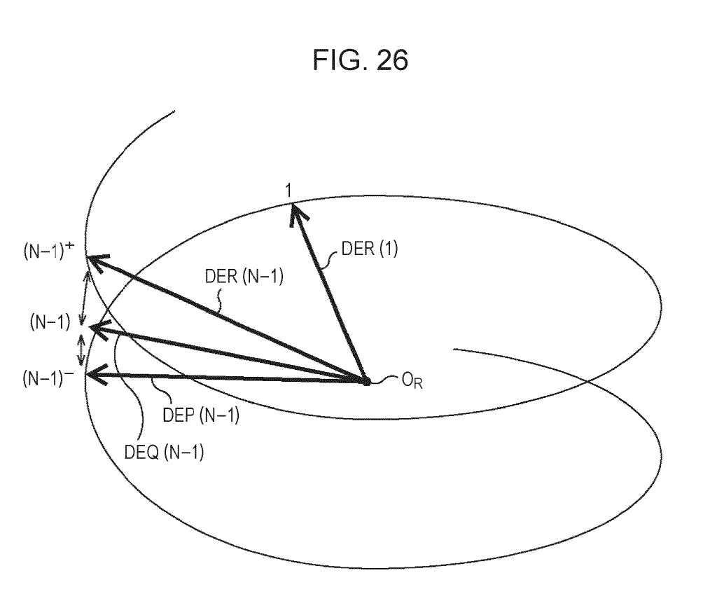

A direction acquired by prorating, at a ratio of 2:N−2, the imaging direction in the forward direction which is represented by the arrow DER(N−1) and the imaging direction in the backward direction which is represented by the arrow DEP(N−1), namely the direction represented by the arrow DEQ(N−1) is acquired as shown in FIG. 26. The thus acquired direction of the arrow DEQ(N−1) is regarded as an optimal imaging direction of the N−1-th captured image.

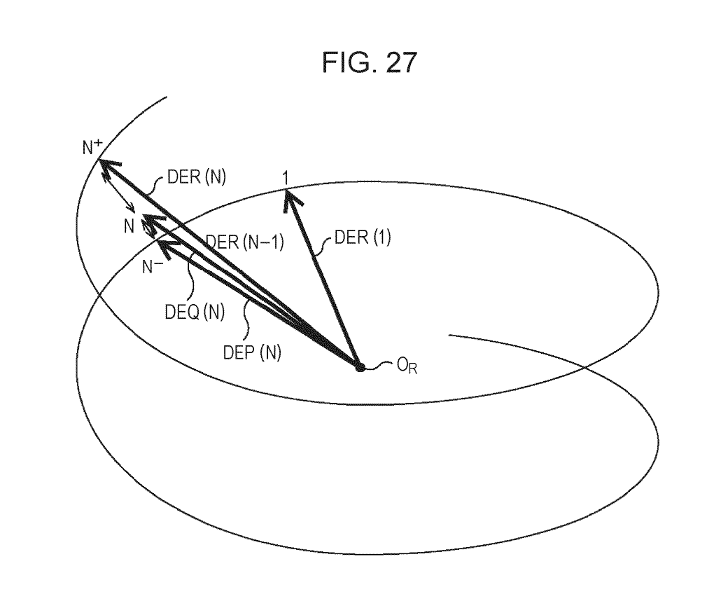

Furthermore, a direction acquired by prorating, at a ratio of 1:N−1, the imaging direction in the forward direction represented by the arrow DER(N) and the imaging direction in the backward direction which is represented by the arrow DEP(N), namely a direction represented by the arrow DEQ(N) is acquired as shown in FIG. 27. The thus acquired direction of the arrow DEQ(N) is regarded as an optimal imaging direction of the N-th captured image.

Now, the thus optimized imaging direction of the s-th captured image and the optimized imaging direction of the s+1-th captured image will be considered (where s=2 to N−1).

For example, a relationship between the imaging direction of the s-th captured image in the forward direction (hereinafter, also referred to as an s⁺ direction) and the imaging direction of the s+1-th captured image in the forward direction (hereinafter, also referred to as an (s+1)⁺ direction) is a positional relationship which is represented as a homogeneous transformation matrix H_{s,s+1}.

Therefore, if the s-th captured image is projected in the s⁺ direction and the s+1-th captured image is projected in the (s+1)⁻ direction, then these two projected images (captured images) are smoothly connected.

Similarly, a relationship between the imaging direction of the s-th captured image in the backward direction (hereinafter, also referred to as an s⁻ direction) and the imaging direction of the s+1-th captured image in the backward direction (hereinafter, also referred to as an (s+1)⁻ direction) is a positional relationship which is represented as a homogeneous transformation matrix H_{s,s+1}.

Therefore, if the s-th captured image is projected in the s⁻ direction and the s+1-th captured image is projected in the (s+1)⁻ direction, then these two projected images (captured images) are smoothly connected.

Now, how about the optimal imaging direction of the s-th captured image described with reference to FIGS. 23 to 27, namely a direction acquired by prorating the s⁺ direction and the s⁻ direction (hereinafter, also referred to as an s direction) and the optimal imaging direction of the s+1-th captured image (hereinafter, also referred to as an (s+1) direction).

The s direction is a direction acquired by prorating the s⁺ direction and the s⁻ direction at a ratio of N+1-s:s−1. In addition, the (s+1) direction is a direction acquired by prorating the (s+1)⁺ direction and the (s+1)⁻ direction at a ratio of N-s:s.

The proration at the ratio of N+1-s:s−1 and the proration at the ratio of N-s:s are substantially equal to each other. Accordingly, if the s-th captured image is projected in the s direction and the s+1-th captured image is projected in the (s+1) direction, then these two projected images (captured images) are also smoothly connected.

That is, adjacent captured images are smoothly connected by projecting the respective captured images (the s-th captured image) in the s direction described with reference to FIGS. 23 to 27, namely the imaging direction of the s-th captured image which is optimized according to the present technology.

According to the present technology, the s⁺ direction (the imaging direction in the forward direction) acquired by accumulating the homogeneous transformation matrixes H_{s,s+1} acquired by the image analysis in the forward direction (in ascending order with respect to s) and the s⁻ direction (the imaging direction in the backward direction) acquired by accumulating the homogeneous transformation matrixes H_{s,s+1} in the backward direction (in descending order with respect to s) are prorated.

Then, the s direction acquired by prorating the s⁺ direction and the s⁻ direction as described above is regarded as the optimized imaging direction of the s-th captured image that it is desirable to finally obtain. With such processing, it is possible to acquire the homogeneous transformation matrix which represents the positional relationship between the first captured image and the s-th captured image with a smaller processing amount without the non-linear problem for minimizing Equation (51) being required to be solved unlike in the related art.

In addition, since the homogeneous transformation matrix H_{s,s+1} generally has uncertainty in a constant factor, the present technology will be described while excluding the uncertainty by applying a condition of (the square of the third row and the first column of H_{s,s+1})+(the square of the third row and the second column of H_{s,s+1})+(the square of the third row and the third column of H_{s,s+1})=1.

[Concerning Proration of Imaging Directions]

Now, although the above description was given in which the two directions, namely the s⁺ direction and the s⁻ direction are prorated, a detailed description will be given of how specifically the proration is performed below.

First, description will be given of meaning of the homogeneous transformation matrix H_{s,s+1}.

It is assumed that a homogeneous transformation matrix which represents a positional relationship between the s-th and the first captured image is represented by H_{1,s}. At this time, if an object projected at a position Vₛ in the s-th captured image is also projected at a position V₁ in the first captured image, the following Equation (52) is established.

[Math. 52]

V₁∝H_{1,s}Vₛ (52)

Here, the position V₁ and the position Vₛ are expressed by same-order coordinates (also referred to as homogeneous coordinates).

Now, it is possible to consider that the homogeneous transformation matrix H_{1,s} is a coordinate transformation matrix from a three-dimensional coordinate system with reference to the imaging direction in which the s-th captured image is captured to a three-dimensional coordinate system with reference to the imaging direction in which the first captured image is captured.

That is, a unit vector in the X-axis direction in the three-dimensional coordinate system with reference to the imaging direction in which the s-th captured image is captured is transformed into a vector represented by the following Equation (53).

$$\begin{matrix}[ Math . 53 ] & \\ {H}_{1 , s} [ \begin{matrix}1 \\ 0 \\ 0\end{matrix} ] & ( 53 )\end{matrix}$$

In addition, a unit vector in the Y-axis direction in the three-dimensional coordinate system with reference to the imaging direction in which the s-th captured image is captured is transformed into a vector represented by the following Equation (54). Furthermore, a unit vector in the Z-axis direction in the three-dimensional coordinate system with reference to the imaging direction in which the s-th captured image is captured is transformed into a vector represented by the following Equation (55).

$$\begin{matrix}[ Math . 54 ] & \\ {H}_{1 , s} [ \begin{matrix}0 \\ 1 \\ 0\end{matrix} ] & ( 54 ) \\ [ Math . 55 ] & \\ {H}_{1 , s} [ \begin{matrix}0 \\ 0 \\ 1\end{matrix} ] & ( 55 )\end{matrix}$$

Thus, it is assumed that the aforementioned s⁺ direction and the s⁻ direction are prorated by respectively performing proration with respect to these three axes in this embodiment. Specific description will be given below.

First, a homogenous transformation matrix H⁺_{1,s} acquired by accumulating the homogeneous transformation matrixes H_{s,s+1} for arbitrary s (where s=2 to N) in the forward direction (in ascending order) is acquired by the calculation of the following Equation (56).

$$\begin{matrix}[ Math . 56 ] & \\ \begin{matrix}{H}_{1 , s}^{+} ≡ [ \begin{matrix}{H}_{1 , s ( 1 , 1 )}^{+} & {H}_{1 , s ( 1 , 2 )}^{+} & {H}_{1 , s ( 1 , 3 )}^{+} \\ {H}_{1 , s ( 2 , 1 )}^{+} & {H}_{1 , s ( 2 , 2 )}^{+} & {H}_{1 , s ( 2 , 3 )}^{+} \\ {H}_{1 , s ( 3 , 1 )}^{+} & {H}_{1 , s ( 3 , 2 )}^{+} & {H}_{1 , s ( 3 , 3 )}^{+}\end{matrix} ] \\ ≡ {\prod }_{k = 1 to s - 1}^{ } {H}_{k , k + 1} \\ = {H}_{1 , 2} {H}_{2 , 3} {H}_{3 , 4} … {H}_{s - 2 , s - 1} {H}_{s - 1 , s}\end{matrix} & ( 56 )\end{matrix}$$

The thus acquired homogeneous transformation matrix H⁺_{1,s} in the forward direction is a homogeneous transformation matrix which is acquired from the positional relationship between the adjacent captured images from the first captured image to the s-th captured image and which represents the positional relationship between the s-th and the first captured images, and corresponds to the aforementioned s⁺ direction.

Next, a homogeneous transformation matrix H⁻_{1,s} in the backward direction which is acquired by accumulating the homogeneous transformation matrixes H_{s,s+1} in the backward direction (in descending order) is acquired by calculation of the following Equation (57).

$$\begin{matrix}[ Math . 57 ] & \\ \begin{matrix}{H}_{1 , s}^{-} ≡ [ \begin{matrix}{H}_{1 , s ( 1 , 1 )}^{-} & {H}_{1 , s ( 1 , 2 )}^{-} & {H}_{1 , s ( 1 , 3 )}^{-} \\ {H}_{1 , s ( 2 , 1 )}^{-} & {H}_{1 , s ( 2 , 2 )}^{-} & {H}_{1 , s ( 2 , 3 )}^{-} \\ {H}_{1 , s ( 3 , 1 )}^{-} & {H}_{1 , s ( 3 , 2 )}^{-} & {H}_{1 , s ( 3 , 3 )}^{-}\end{matrix} ] \\ ≡ {( {\prod }_{k = s to N}^{ } {H}_{k , k + 1} )}^{- 1} \\ = {( {H}_{s , s + 1} {H}_{s + 1 , s + 2} {H}_{s + 2 , s + 3} … {H}_{N - 2 , N - 1} {H}_{N - 1 , N} {H}_{N , 1} )}^{- 1} \\ = {H}_{N , 1}^{- 1} {H}_{N - 1 , N}^{- 1} {H}_{N - 2 , N - 1}^{- 1} … {H}_{s + 2 , s + 3}^{- 1} {H}_{s + 1 , s + 2}^{- 1} {H}_{s , s + 1}^{- 1}\end{matrix} & ( 57 )\end{matrix}$$

The thus acquired homogeneous transformation matrix H⁻_{1,s} in the backward direction is a homogeneous transformation matrix which is acquired from the positional relationship between the first and the N-th captured images and from the positional relationships between adjacent captured images from the N-th to the s-th captured images and represents the positional relationship between the s-th and the first captured images. The homogeneous transformation matrix H⁻_{1,s} corresponds to the s direction.

In Equation (56) and Equation (57), the respective elements in the 3×3 matrixes are represented by using the indexes (1,1) to (3,3). Although the homogeneous transformation matrix H⁺_{1,s} or the homogeneous transformation matrix H⁻_{1,s} are acquired by accumulating the homogeneous transformation matrixes in the forward direction or in the backward direction from the first to the s-th captured images with reference to the first captured image in the description herein, an arbitrary t-th captured image may be regarded as a reference, and the homogeneous transformation matrixes of the t-th to the s-th captured images may be accumulated.

Now, the homogeneous transformation matrix H⁺_{1,s} represented by Equation (56) is considered to be a coordinate transformation matrix from the three-dimensional coordinate system with reference to the imaging direction in which the s-th captured image is captured to the three-dimensional coordinate system with reference to the imaging direction in which the first captured image is captured. Then, a vector acquired by transforming the unit vector in the X-axis direction in the three-dimensional coordinate system with reference to the imaging direction in which the s-th captured image is captured by the homogeneous transformation matrix H⁺_{1,s} based on the following Equation (58) is considered.

$$\begin{matrix}[ Math . 58 ] & \\ {H}_{1 , s}^{+} [ \begin{matrix}1 \\ 0 \\ 0\end{matrix} ] = [ \begin{matrix}{H}_{1 , s ( 1 , 1 )}^{+} \\ {H}_{1 , s ( 2 , 1 )}^{+} \\ {H}_{1 , s ( 3 , 1 )}^{+}\end{matrix} ] & ( 58 )\end{matrix}$$

Similarly, the homogeneous transformation matrix H⁻_{1,s} represented by Equation (57) is considered to be a coordinate transformation matrix from the three-dimensional coordinate system with reference to the imaging direction in which the s-th captured image is captured to the three-dimensional coordinate system with reference to the imaging direction in which the first captured image is captured. In addition, a vector acquired by transforming, by the homogeneous transformation matrix H⁻_{1,s} based on the following Equation (59), the unit vector in the X-axis direction in the three-dimensional coordinate system with reference to the imaging direction in which the s-th captured image is captured is considered.

$$\begin{matrix}[ Math . 59 ] & \\ {H}_{1 , s}^{-} [ \begin{matrix}1 \\ 0 \\ 0\end{matrix} ] = [ \begin{matrix}{H}_{1 , s ( 1 , 1 )}^{-} \\ {H}_{1 , s ( 2 , 1 )}^{-} \\ {H}_{1 , s ( 3 , 1 )}^{-}\end{matrix} ] & ( 59 )\end{matrix}$$

Furthermore, a vector acquired by prorating the two vectors acquired by Equation (58) and Equation (59) at a ratio of N+1-s:s−1 is acquired. That is, a vector represented by the following Equation (60) is a vector after proration.

$$\begin{matrix} [ Math . 60 ] & \\ [ \begin{matrix}{H}_{1 , s ( 1 , 1 )}^{\pm } \\ {H}_{1 , s ( 2 , 1 )}^{\pm } \\ {H}_{1 , s ( 3 , 1 )}^{\pm }\end{matrix} ] = \frac{( N + 1 - s ) ‖ [ \begin{matrix}{H}_{1 , s ( 1 , 1 )}^{+} \\ {H}_{1 , s ( 2 , 1 )}^{+} \\ {H}_{1 , s ( 3 , 1 )}^{+}\end{matrix} ] ‖ + ( s - 1 ) ‖ [ \begin{matrix}{H}_{1 , s ( 1 , 1 )}^{-} \\ {H}_{1 , s ( 2 , 1 )}^{-} \\ {H}_{1 , s ( 3 , 1 )}^{-}\end{matrix} ] ‖}{N} \times \frac{( ( N + 1 - s ) [ \begin{matrix}{H}_{1 , s ( 1 , 1 )}^{+} \\ {H}_{1 , s ( 2 , 1 )}^{+} \\ {H}_{1 , s ( 3 , 1 )}^{+}\end{matrix} ] + ( s - 1 ) [ \begin{matrix}{H}_{1 , s ( 1 , 1 )}^{-} \\ {H}_{1 , s ( 2 , 1 )}^{-} \\ {H}_{1 , s ( 3 , 1 )}^{-}\end{matrix} ] )}{‖ ( N + 1 - s ) [ \begin{matrix}{H}_{1 , s ( 1 , 1 )}^{+} \\ {H}_{1 , s ( 2 , 1 )}^{+} \\ {H}_{1 , s ( 3 , 1 )}^{+}\end{matrix} ] + ( s - 1 ) [ \begin{matrix}{H}_{1 , s ( 1 , 1 )}^{-} \\ {H}_{1 , s ( 2 , 1 )}^{-} \\ {H}_{1 , s ( 3 , 1 )}^{-}\end{matrix} ] ‖} & ( 60 )\end{matrix}$$

The direction of the vector represented by Equation (60) is a direction acquired by prorating the vector represented by Equation (58) and the vector represented by Equation (59) at the ratio of N+1-s:s−1. Furthermore, the size of the vector represented by Equation (60) is a size acquired by prorating the size of the vector represented by Equation (58) and the size of the vector represented by Equation (59) at the ratio of N+1-s:s−1.

In Equation (60), the vector represented by Equation (58) and the vector represented by Equation (59) are subjected to weighed addition with a weight in accordance with a position (imaging order) of the s-th captured image. In such a case, the proration ratio of the vector represented by Equation (58) increases as a difference in the imaging orders between the first captured image and the s-th captured image becomes smaller, that is, as s becomes smaller.

Similarly, a vector acquired by prorating, at the ratio of the N+1-s:s−1, a vector acquired by transforming the unit vector in the Y-axis direction in the three-dimensional coordinate system with reference to the imaging direction in which the s-th captured image is captured by the homogeneous transformation matrix H⁺_{1,s} and the homogeneous transformation matrix H⁻_{1,s}, respectively by the following Equation (61) is acquired.

$$\begin{matrix} [ Math . 61 ] & \\ [ \begin{matrix}{H}_{1 , s ( 1 , 2 )}^{\pm } \\ {H}_{1 , s ( 2 , 2 )}^{\pm } \\ {H}_{1 , s ( 3 , 2 )}^{\pm }\end{matrix} ] = \frac{( N + 1 - s ) ‖ [ \begin{matrix}{H}_{1 , s ( 1 , 2 )}^{+} \\ {H}_{1 , s ( 2 , 2 )}^{+} \\ {H}_{1 , s ( 3 , 2 )}^{+}\end{matrix} ] ‖ + ( s - 1 ) ‖ [ \begin{matrix}{H}_{1 , s ( 1 , 2 )}^{-} \\ {H}_{1 , s ( 2 , 2 )}^{-} \\ {H}_{1 , s ( 3 , 2 )}^{-}\end{matrix} ] ‖}{N} \times \frac{( ( N + 1 - s ) [ \begin{matrix}{H}_{1 , s ( 1 , 2 )}^{+} \\ {H}_{1 , s ( 2 , 2 )}^{+} \\ {H}_{1 , s ( 3 , 2 )}^{+}\end{matrix} ] + ( s - 1 ) [ \begin{matrix}{H}_{1 , s ( 1 , 2 )}^{-} \\ {H}_{1 , s ( 2 , 2 )}^{-} \\ {H}_{1 , s ( 3 , 2 )}^{-}\end{matrix} ] )}{‖ ( N + 1 - s ) [ \begin{matrix}{H}_{1 , s ( 1 , 2 )}^{+} \\ {H}_{1 , s ( 2 , 2 )}^{+} \\ {H}_{1 , s ( 3 , 2 )}^{+}\end{matrix} ] + ( s - 1 ) [ \begin{matrix}{H}_{1 , s ( 1 , 2 )}^{-} \\ {H}_{1 , s ( 2 , 2 )}^{-} \\ {H}_{1 , s ( 3 , 2 )}^{-}\end{matrix} ] ‖} & ( 61 )\end{matrix}$$

In addition, a vector acquired by prorating, at the ratio of N+1-s:s−1, a vector acquired by transforming the unit vector in the Z-axis direction in the three-dimensional coordinate system with reference to the imaging direction in which the s-th captured image is captured by the homogeneous transformation matrix H⁺_{1,s} and the homogeneous transformation matrix H⁻_{1,s}, respectively by the following Equation (62) is acquired.

$$\begin{matrix} [ Math . 62 ] & \\ [ \begin{matrix}{H}_{1 , s ( 1 , 3 )}^{\pm } \\ {H}_{1 , s ( 2 , 3 )}^{\pm } \\ {H}_{1 , s ( 3 , 3 )}^{\pm }\end{matrix} ] = \frac{( N + 1 - s ) ‖ [ \begin{matrix}{H}_{1 , s ( 1 , 3 )}^{+} \\ {H}_{1 , s ( 2 , 3 )}^{+} \\ {H}_{1 , s ( 3 , 3 )}^{+}\end{matrix} ] ‖ + ( s - 1 ) ‖ [ \begin{matrix}{H}_{1 , s ( 1 , 3 )}^{-} \\ {H}_{1 , s ( 2 , 3 )}^{-} \\ {H}_{1 , s ( 3 , 3 )}^{-}\end{matrix} ] ‖}{N} \times \frac{( ( N + 1 - s ) [ \begin{matrix}{H}_{1 , s ( 1 , 3 )}^{+} \\ {H}_{1 , s ( 2 , 3 )}^{+} \\ {H}_{1 , s ( 3 , 3 )}^{+}\end{matrix} ] + ( s - 1 ) [ \begin{matrix}{H}_{1 , s ( 1 , 3 )}^{-} \\ {H}_{1 , s ( 2 , 3 )}^{-} \\ {H}_{1 , s ( 3 , 3 )}^{-}\end{matrix} ] )}{‖ ( N + 1 - s ) [ \begin{matrix}{H}_{1 , s ( 1 , 3 )}^{+} \\ {H}_{1 , s ( 2 , 3 )}^{+} \\ {H}_{1 , s ( 3 , 3 )}^{+}\end{matrix} ] + ( s - 1 ) [ \begin{matrix}{H}_{1 , s ( 1 , 3 )}^{-} \\ {H}_{1 , s ( 2 , 3 )}^{-} \\ {H}_{1 , s ( 3 , 3 )}^{-}\end{matrix} ] ‖} & ( 62 )\end{matrix}$$

Then, if a 3×3 matrix is configured by respectively regarding the vectors of Equation (60), Equation (61), and Equation (62) as vertical vectors, a matrix represented by the following Equation (63) is acquired.

$$\begin{matrix}[ Math . 63 ] & \\ {H}_{1 , s}^{\pm } ≡ [ \begin{matrix}{H}_{1 , s ( 1 , 1 )}^{\pm } & {H}_{1 , s ( 1 , 2 )}^{\pm } & {H}_{1 , s ( 1 , 3 )}^{\pm } \\ {H}_{1 , s ( 2 , 1 )}^{\pm } & {H}_{1 , s ( 2 , 2 )}^{\pm } & {H}_{1 , s ( 2 , 3 )}^{\pm } \\ {H}_{1 , s ( 3 , 1 )}^{\pm } & {H}_{1 , s ( 3 , 2 )}^{\pm } & {H}_{1 , s ( 3 , 3 )}^{\pm }\end{matrix} ] & ( 63 )\end{matrix}$$

The 3×3 matrix H⁻_{1,s} represented by Equation (63) is a matrix acquired by prorating the homogeneous transformation matrix H⁺_{1,s} and the homogeneous transformation matrix H⁻_{1,s} at the ratio of N+1-s:s−1. That is, the matrix H^{±}_{1,s} is an optimized homogeneous transformation matrix which represents the positional relationship between the s-th and the first captured images.

If the homogeneous transformation matrix H^{±}_{1,s} (where s=1 to N) is acquired as described above, it is possible to acquire a panoramic image (omnidirectional image) of 360° by mapping a pixel value of each pixel at each position Wₛ in each captured image as light coming from a direction represented by the following Equation (64) in the canvas region.

Here, the pixel value of the pixel in the captured image is generally a value from 0 to 255 when the captured image is a monochrome image, and is a value expressing three primary colors, namely red, green, and blue by 0 to 255 when the captured image is a color image. In this embodiment, the homogeneous transformation matrix H^{±}_{1,s} when s=1 is a unit matrix.

[Math. 64]

H^{±}_{1,s}Wₛ (64)

### [Configuration Example of Image Processing Apparatus]

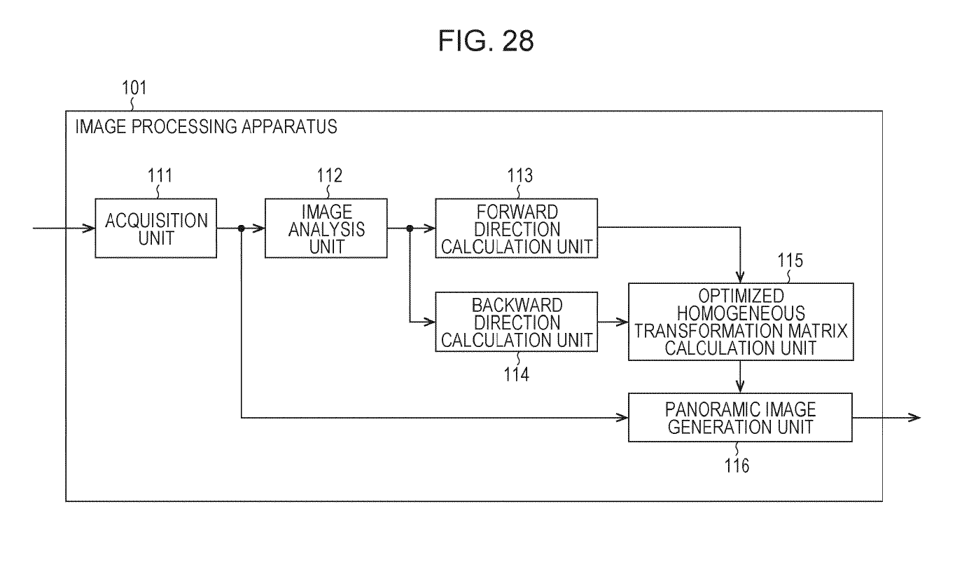

Next, description will be given of a specific embodiment to which the present technology is applied. FIG. 28 is a diagram showing a configuration example of an embodiment of an image processing apparatus to which the present technology is applied.

An image processing apparatus 101 in FIG. 28 is configured of an acquisition unit 111, an image analysis unit 112, a forward direction calculation unit 113, a backward direction calculation unit 114, an optimized homogeneous transformation matrix calculation unit 115, and a panoramic image generation unit 116.

The acquisition unit 111 acquires N captured images which are successively captured while an imaging device such as a digital camera is rotated, and supplies the captured images to the image analysis unit 112 and the panoramic image generation unit 116. The image analysis unit 112 calculates the homogeneous transformation matrixes H_{s,s+1} between the adjacent captured images based on the captured images supplied from the acquisition unit 111 and supplies the homogeneous transformation matrixes H_{s,s+1} to the forward direction calculation unit 113 and the backward direction calculation unit 114.

The forward direction calculation unit 113 accumulates the homogeneous transformation matrixes H_{s,s+1} supplied from the image analysis unit 112 in the forward direction, acquires the homogeneous transformation matrix H⁺_{1,s} in the forward direction, and supplies the homogeneous transformation matrix H⁺_{1,s} to the optimized homogeneous transformation matrix calculation unit 115. The backward direction calculation unit 114 accumulates the homogeneous transformation matrixes H_{s,s+1} supplied from the image analysis unit 112 in the backward direction, acquires the homogeneous transformation matrix H⁻_{1,s} in the backward direction, and supplies the homogeneous transformation matrix H⁻_{1,s} to the optimized homogeneous transformation matrix calculation unit 115.

The optimized homogeneous transformation matrix calculation unit 115 acquires an optimized homogeneous transformation matrix H⁻¹_{1,s} by prorating the homogeneous transformation matrix H⁺_{1,s} from the forward direction calculation unit 113 and the homogeneous transformation matrix H⁻_{1,s} from the backward direction calculation unit 114 and supplies the optimized homogeneous transformation matrix H^{±}_{1,s} to the panoramic image generation unit 116. The panoramic image generation unit 116 generates and outputs a panoramic image based on the captured images from the acquisition unit 111 and the homogeneous transformation matrix H^{±}_{1,s} from the optimized homogeneous transformation matrix calculation unit 115.

### [Description of Panoramic Image Generation Processing]

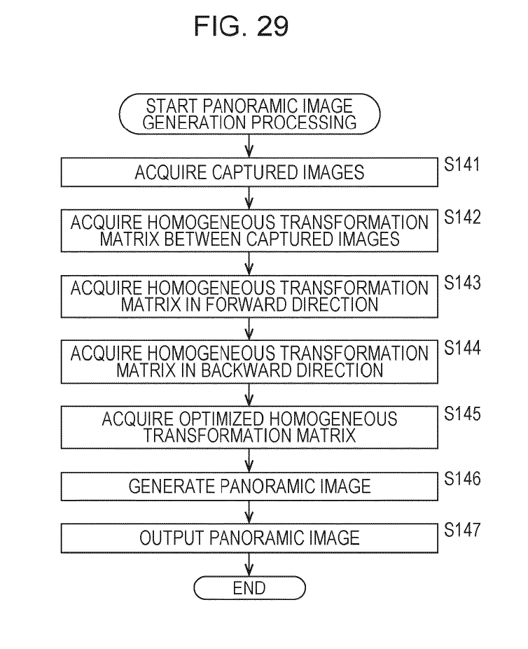

Next, description will be given of panoramic image generation processing by the image processing apparatus 101 with reference to the flowchart in FIG. 29.

In Step S141, the acquisition unit 111 acquires N captured images which are successively captured while the imaging device is rotated, and supplies the captured images to the image analysis unit 112 and the panoramic image generation unit 116.

In Step S142, the image analysis unit 112 acquires the homogeneous transformation matrixes H_{s,s+1} (where s=1 to N) between the adjacent captured images represented by Equation (46) and Equation (47) by analyzing the adjacent captured images based on the captured images supplied from the acquisition unit 111. The image analysis unit 112 supplies the acquired homogeneous transformation matrixes H_{s,s+1} to the forward direction calculation unit 113 and the backward direction calculation unit 114.

In Step S143, the forward direction calculation unit 113 acquires the homogeneous transformation matrix H⁺_{1,s} (where s=2 to N) in the forward direction by calculating Equation (56) to accumulate the homogeneous transformation matrixes H_{s,s+1} supplied from the image analysis unit 112 in the forward direction, and supplies the homogeneous transformation matrix to to the optimized homogeneous transformation matrix calculation unit 115.

In Step S144, the backward direction calculation unit 114 acquires the homogeneous transformation matrix H⁻_{1,s} (where s=2 to N) in the backward direction by calculating Equation (57) to accumulate the homogeneous transformation matrixes H_{s,s+1} supplied from the image analysis unit 112 in the backward direction, and supplies the homogeneous transformation matrix H⁻¹_{1,s} to the optimized homogeneous transformation matrix calculation unit 115.

In Step S145, the optimized homogeneous transformation matrix calculation unit 115 acquires the optimized homogeneous transformation matrix H^{±}_{1,s} (where s=2 to N) by prorating the homogeneous transformation matrix H⁺_{1,s} from the forward direction calculation unit 113 and the homogeneous transformation matrix H⁻_{1,s} from the backward direction calculation unit 114.

That is, calculation of the aforementioned Equation (60) to Equation (62) is performed, and the homogeneous transformation matrix H^{±}_{1,s} (where s=2 to N) represented by Equation (63) is further acquired from the calculation results. The optimized homogeneous transformation matrix calculation unit 115 supplies the acquired homogeneous transformation matrix H^{±}_{1,s} to the panoramic image generation unit 116.

In Step S146, the panoramic image generation unit 116 generates a panoramic image based on the captured images from the acquisition unit 111 and the homogeneous transformation matrix H^{±}_{1,s} from the optimized homogeneous transformation matrix calculation unit 115.

Specifically, the panoramic image generation unit 116 generates the panoramic image of 360° by mapping a pixel value of a pixel at each position Wₛ in the respective captured images, namely the first to N-th captured images as light coming from the direction represented by Equation (64) in the canvas region prepared in advance. That is, the panoramic image generation unit 116 maps the pixel value of the pixel at the position Wₛ on the position, which is determined by the direction represented by Equation (64), in the canvas region.

Here, the pixel value of the pixel in the captured image is generally a value from 0 to 255 when the captured image is a monochrome image, and is a value expressing three primary colors, namely red, green, and blue by 0 to 255 when the captured image is a color image. In addition, the homogeneous transformation matrix H^{±}_{1,1} is a unit matrix.

In Step S147, the panoramic image generation unit 116 regards the image on the canvas region as a panoramic image of 360° and outputs the panoramic image, and the panoramic image generation processing is completed.

As described above, the image processing apparatus 101 accumulates the homogeneous transformation matrixes between the adjacent captured images in the forward direction and the backward direction and acquires the homogeneous transformation matrixes between the first and the s-th captured images in the forward direction and the backward direction. Then, the image processing apparatus 101 prorates the homogeneous transformation matrix in the forward direction and the homogeneous transformation matrix in the backward direction and uses the homogeneous transformation matrix acquired as a result to generate the panoramic image.

As described above, it is possible to acquire the homogeneous transformation matrix which represents the positional relationship between the first captured image and the s-th captured image with a smaller processing amount by prorating the homogeneous transformation matrixes in the forward direction and in the backward direction and acquiring the optimized homogeneous transformation matrix. As a result, it is possible to more simply and quickly acquire the panoramic image of 360°.

### Modification Example 1 of Third Embodiment

### Concerning Proration between Captured Images

Incidentally, the proportion at which the homogeneous transformation matrixes in the forward direction and in the backward direction are prorated between the adjacent captured images is changed by 1/N in accordance with the positions of the captured images in the third embodiment.

However, when an angular velocity at which the imaging device is panned is not constant, the following defect occurs. That is, it is assumed that ten captured images are captured from 40° to 50°, for example. Then, it is assumed that two captured images are captured from 80° to 90°.

In such a case, errors of the ten captured images (10/N) are allocated from 40° to 50°, and errors of the two captured images (2/N) are allocated from 80° to 90°. Since the errors are equally divided into N in the third embodiment, errors which are five times as large as those for the range from 80° to 90° are allocated to the range from 40° to 50° in the panoramic image (omnidirectional image) of 360° as a resulting image. For this reason, errors are concentrated on the part from 40° to 50°, and a failure (deterioration in how the images are connected) in the image at the part from 40° to 50° becomes noticeable.

Thus, the errors to be allocated may not be equally divided into N, and allocation proportions may be determined by applying weights.

That is, errors are allocated to the ten captured images at the part from 40° to 50° by applying a weight ⅕ times as large as that in the case of the two captured images at the part from 80° to 90°, for example. With such processing, it is possible to acquire a resulting image in which failures (failures in how the images are connected) are equally distributed over the entire part without causing the errors to be concentrated on the part from 40° to 50°.

Here, a weight is applied so as to be proportional to a difference between the imaging direction in which the s-th captured image is captured and the imaging direction in which the s+1-th captured image is captured. This is expressed as the following Equation (65). That is, an angle φₛ which satisfies Equation (65) is an angle between the imaging direction of the s-th captured image and the imaging direction of the s+1-th captured image.

$$\begin{matrix}[ Math . 65 ] & \\ ‖ {H}_{s , s + 1} [ \begin{matrix}0 \\ 0 \\ 1\end{matrix} ] ‖ cos ( {φ}_{s} ) = [ \begin{matrix}0 & 0 & 1\end{matrix} ] {H}_{s , s + 1} [ \begin{matrix}0 \\ 0 \\ 1\end{matrix} ] & ( 65 )\end{matrix}$$

Equation (65) means the following fact. That is, a direction of a center position of the s+1-th captured image in a three-dimensional coordinate system with reference to the imaging direction in which the s-th captured image is captured is a direction represented by the following Equation (66).

$$\begin{matrix}[ Math . 66 ] & \\ {H}_{s , s + 1} [ \begin{matrix}0 \\ 0 \\ 1\end{matrix} ] & ( 66 )\end{matrix}$$

The angle between the imaging direction in which (the center position of) the s-th captured image is captured and the imaging direction in which (the center position of) the s+1-th captured image is captured is the angle φₛ represented by Equation (65) if an inner product of the vectors are considered. When s=N, s+1 means 1.

Accordingly, a case where the value of the angle φₛ which satisfies Equation (65) is small means that the imaging direction when the s-th captured image is captured and the imaging angle when the s+1-th captured image is captured are substantially equal to each other. In such a case, a proration proportion for optimizing the s-th captured image and a proration proportion for optimizing the s+1-th captured image are set to be substantially equal to each other.

In contrast, a case where the value of the angle φₛ which satisfies Equation (65) is large means that the imaging direction when the s-th captured image is captured and the imaging direction when the s+1-th captured image is captured greatly differ from each other. In such a case, it is only necessary to greatly change the proration proportion for optimizing the s-th captured image and the proration proportion for optimizing the s+1-th captured image.

Thus, it is only necessary to use a variable Gₛ which is represented by the following Equation (67), to use the following Equation (68) instead of Equation (60), to use the following Equation (69) instead of Equation (61), and further to use the following Equation (70) instead of Equation (62).

$$\begin{matrix} [ Math . 67 ] & \\ {G}_{s} ≡ \frac{{\sum }_{k = 1}^{s - 1} {φ}_{k}}{{\sum }_{k = 1}^{N} {φ}_{k}} & ( 67 ) \\ [ Math . 68 ] & \\ [ \begin{matrix}{H}_{1 , s ( 1 , 1 )}^{\pm } \\ {H}_{1 , s ( 2 , 1 )}^{\pm } \\ {H}_{1 , s ( 3 , 1 )}^{\pm }\end{matrix} ] ( ( 1 - {G}_{s} ) ‖ [ \begin{matrix}{H}_{1 , s ( 1 , 1 )}^{+} \\ {H}_{1 , s ( 2 , 1 )}^{+} \\ {H}_{1 , s ( 3 , 1 )}^{+}\end{matrix} ] ‖ + {G}_{s} ‖ [ \begin{matrix}{H}_{1 , s ( 1 , 1 )}^{-} \\ {H}_{1 , s ( 2 , 1 )}^{-} \\ {H}_{1 , s ( 3 , 1 )}^{-}\end{matrix} ] ‖ ) \times \frac{( ( 1 - {G}_{s} ) [ \begin{matrix}{H}_{1 , s ( 1 , 1 )}^{+} \\ {H}_{1 , s ( 2 , 1 )}^{+} \\ {H}_{1 , s ( 3 , 1 )}^{+}\end{matrix} ] + {G}_{s} [ \begin{matrix}{H}_{1 , s ( 1 , 1 )}^{-} \\ {H}_{1 , s ( 2 , 1 )}^{-} \\ {H}_{1 , s ( 3 , 1 )}^{-}\end{matrix} ] )}{‖ ( 1 - {G}_{s} ) [ \begin{matrix}{H}_{1 , s ( 1 , 1 )}^{+} \\ {H}_{1 , s ( 2 , 1 )}^{+} \\ {H}_{1 , s ( 3 , 1 )}^{+}\end{matrix} ] + {G}_{s} [ \begin{matrix}{H}_{1 , s ( 1 , 1 )}^{-} \\ {H}_{1 , s ( 2 , 1 )}^{-} \\ {H}_{1 , s ( 3 , 1 )}^{-}\end{matrix} ] ‖} & ( 68 ) \\ [ Math . 69 ] & \\ [ \begin{matrix}{H}_{1 , s ( 1 , 2 )}^{\pm } \\ {H}_{1 , s ( 2 , 2 )}^{\pm } \\ {H}_{1 , s ( 3 , 2 )}^{\pm }\end{matrix} ] = ( ( 1 - {G}_{s} ) ‖ [ \begin{matrix}{H}_{1 , s ( 1 , 2 )}^{+} \\ {H}_{1 , s ( 2 , 2 )}^{+} \\ {H}_{1 , s ( 3 , 2 )}^{+}\end{matrix} ] ‖ + {G}_{s} ‖ [ \begin{matrix}{H}_{1 , s ( 1 , 2 )}^{-} \\ {H}_{1 , s ( 2 , 2 )}^{-} \\ {H}_{1 , s ( 3 , 2 )}^{-}\end{matrix} ] \vert ) \times \frac{( ( 1 - {G}_{s} ) [ \begin{matrix}{H}_{1 , s ( 1 , 2 )}^{+} \\ {H}_{1 , s ( 2 , 2 )}^{+} \\ {H}_{1 , s ( 3 , 2 )}^{+}\end{matrix} ] + {G}_{s} [ \begin{matrix}{H}_{1 , s ( 1 , 2 )}^{-} \\ {H}_{1 , s ( 2 , 2 )}^{-} \\ {H}_{1 , s ( 3 , 2 )}^{-}\end{matrix} ] )}{‖ ( 1 - {G}_{s} ) [ \begin{matrix}{H}_{1 , s ( 1 , 2 )}^{+} \\ {H}_{1 , s ( 2 , 2 )}^{+} \\ {H}_{1 , s ( 3 , 2 )}^{+}\end{matrix} ] + {G}_{s} [ \begin{matrix}{H}_{1 , s ( 1 , 2 )}^{-} \\ {H}_{1 , s ( 2 , 2 )}^{-} \\ {H}_{1 , s ( 3 , 2 )}^{-}\end{matrix} ] ‖} & ( 69 ) \\ [ Math . 70 ] & \\ [ \begin{matrix}{H}_{1 , s ( 1 , 3 )}^{\pm } \\ {H}_{1 , s ( 2 , 3 )}^{\pm } \\ {H}_{1 , s ( 3 , 3 )}^{\pm }\end{matrix} ] = ( ( 1 - {G}_{s} ) ‖ [ \begin{matrix}{H}_{1 , s ( 1 , 3 )}^{+} \\ {H}_{1 , s ( 2 , 3 )}^{+} \\ {H}_{1 , s ( 3 , 3 )}^{+}\end{matrix} ] ‖ + {G}_{s} ‖ [ \begin{matrix}{H}_{1 , s ( 1 , 3 )}^{-} \\ {H}_{1 , s ( 2 , 3 )}^{-} \\ {H}_{1 , s ( 3 , 3 )}^{-}\end{matrix} ] ‖ ) \times \frac{( ( 1 - {G}_{s} ) [ \begin{matrix}{H}_{1 , s ( 1 , 3 )}^{+} \\ {H}_{1 , s ( 2 , 3 )}^{+} \\ {H}_{1 , s ( 3 , 3 )}^{+}\end{matrix} ] + {G}_{s} [ \begin{matrix}{H}_{1 , s ( 1 , 3 )}^{-} \\ {H}_{1 , s ( 2 , 3 )}^{-} \\ {H}_{1 , s ( 3 , 3 )}^{-}\end{matrix} ] )}{‖ ( 1 - {G}_{s} ) [ \begin{matrix}{H}_{1 , s ( 1 , 3 )}^{+} \\ {H}_{1 , s ( 2 , 3 )}^{+} \\ {H}_{1 , s ( 3 , 3 )}^{+}\end{matrix} ] + {G}_{s} [ \begin{matrix}{H}_{1 , s ( 1 , 3 )}^{-} \\ {H}_{1 , s ( 2 , 3 )}^{-} \\ {H}_{1 , s ( 3 , 3 )}^{-}\end{matrix} ] ‖} & ( 70 )\end{matrix}$$

In the calculation of Equation (68), for example, the vector represented by Equation (58) and the vector represented by Equation (59) are subjected to weighted addition. At this time, the proration proportion of the vector represented by Equation (58) increases as s becomes smaller. In addition, a difference between the proration proportion of the vector represented by Equation (58) in the calculation of Equation (68) for the s+1-th captured image and the proration proportion of the vector represented by Equation (58) in the calculation of Equation (68) for the s-th captured image increases as an angle between the imaging directions of the s+1-th and the s-th captured images increases.

### [Description of Panoramic Image Generation Processing]

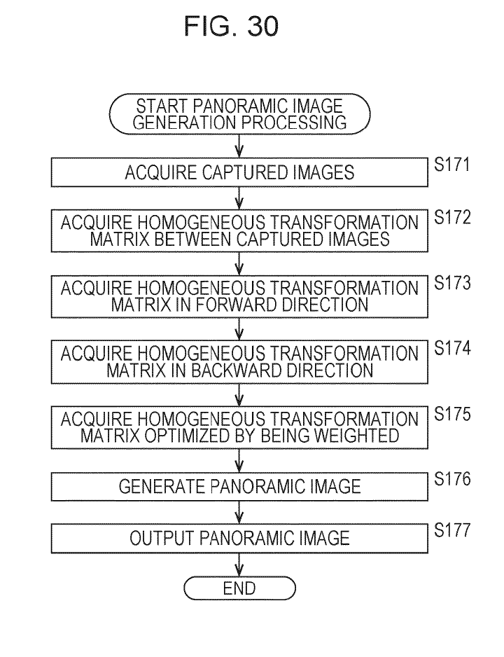

In such a case, panoramic image generation processing as shown in FIG. 30 is performed by the image processing apparatus 101. Hereinafter, description will be given of the panoramic image generation processing by the image processing apparatus 101 with reference to the flowchart in FIG. 30.

In addition, since processing in Step S171 to Step S174 is the same as the processing in Step S141 to Step S144 in FIG. 29, the description thereof will be omitted.

In Step S175, the optimized homogeneous transformation matrix calculation unit 115 prorates the homogeneous transformation matrix H⁺_{1,s} from the forward direction calculation unit 113 and the homogeneous transformation matrix H⁻_{1,s} from the backward direction calculation unit 114 with a weight in accordance with the angle φₛ, and acquires the optimized homogeneous transformation matrix H^{±}_{1,5} (where s=2 to N).

That is, the variable Gₛ is acquired in the calculation of Equation (65) and Equation (67), the acquired variable Gₛ is used to perform the calculation of Equation (68) to Equation (70), and further, the homogeneous transformation matrix H^{±}_{1,s} (where s=2 to N) represented by Equation (63) is acquired from these calculation results. At this time, the optimized homogeneous transformation matrix calculation unit 115 acquires the homogeneous transformation matrix H_{s,s+1} from the image analysis unit 112 as necessary. The optimized homogeneous transformation matrix calculation unit 115 supplies the acquired homogeneous transformation matrix H^{±}_{1,s} to the panoramic image generation unit 116.

If the optimized homogeneous transformation matrix H^{±}_{1,s} is acquired, then the processing in Step S176 and Step S177 is performed, and the panoramic image generation processing is completed. However, since the processing is the same as the processing in Step S146 and Step S147 in FIG. 29, the description thereof will be omitted.

As described above, it is possible to acquire the homogeneous transformation matrix which represents the positional relationship between the first and the s-th captured images with a smaller processing amount by prorating the homogeneous transformation matrixes in the forward direction and in the backward direction based on the appropriate weight Gₛ which is determined by the angle between the imaging directions of the respective captured images. Accordingly, it is possible to more simply and quickly acquire a panoramic image with high quality.

### Fourth Embodiment

### Concerning Optimized Homogeneous Transformation Matrix

Incidentally, the homogeneous transformation matrixes accumulated in the forward direction and the homogeneous transformation matrixes accumulated in the backward direction are respectively considered as coordinate transformation matrixes, and the optimized homogeneous transformation matrix is acquired by prorating the transformed X axis, the Y axis, and the Z axis in the aforementioned third embodiment and Modification Example 1 thereof.

In contrast, representative positions (a point K1₍ₛ₎, a point K2₍ₛ₎ which will be described later) are determined from each captured image in this embodiment. In which direction the determined positions are brought by the transformation by the homogeneous transformation matrixes accumulated in the forward direction (Equation (72) and Equation (73) which will be described later) and in which direction the determined positions are brought by the transformation by the homogeneous transformation matrixes accumulated in the backward direction (Equation (74) and Equation (75) which will be described later) are considered. Furthermore, these two directions acquired by the transformation are prorated, and the optimized homogeneous transformation matrix is acquired.

Thus, the representative points (positions) on a captured image will be described first. That is, the point K1₍ₛ₎ and the point K2₍ₛ₎ defined below will be considered on the s-th (where s=1 to N) captured image. The two points are two points with the following characteristics.

In addition, these two points are expressed by same-order coordinates (also referred to as homogeneous coordinates). That is, each of the positions is expressed by a three-dimensional vertical vector configured of three elements, namely an X coordinate in a coordinate system with reference to the s-th captured image on the first line, a Y coordinate in the coordinate system with reference to the s-th captured image on the second line, and 1 on the third line.

The two points K1₍ₛ₎ and K2₍ₛ₎ on the s-th captured image have a characteristic in that pixel values of pixels in a region which is substantially the same as a region on the left side from the two points (on the side of the s−1-th captured image) on the s-th captured image are mapped in the panoramic image (omnidirectional image) of 360° as an output image. In addition, in relation to a region on the right side from the point K1₍ₛ₎ and the point K2₍ₛ₎ (on the side of the s+1-th captured image), the s+1-th captured image is mapped in the panoramic image (omnidirectional image) of 360°.

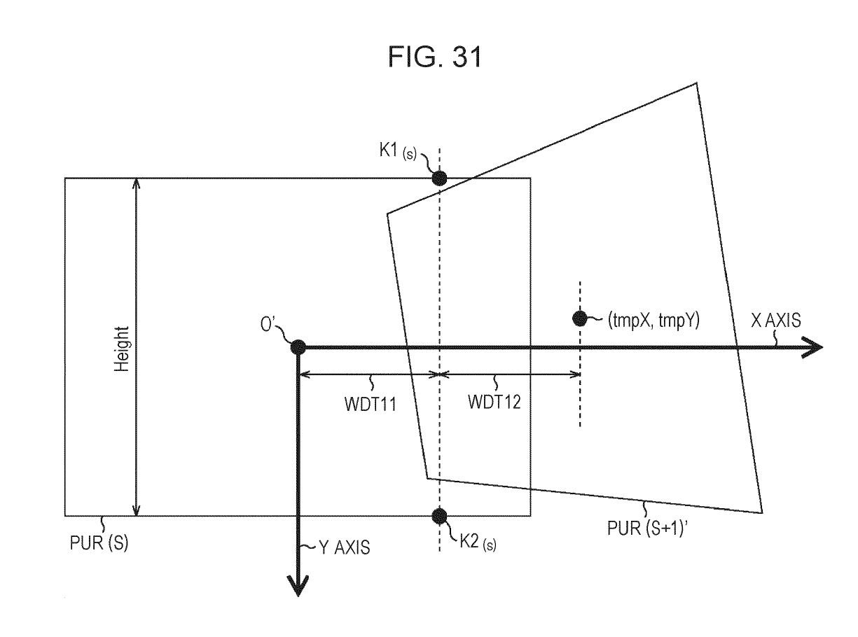

For example, the point K1₍ₛ₎ and the point K2₍ₛ₎ on the s-th captured image are points as shown in FIG. 31. In FIG. 31, the image PUR(s) represents the s-th captured image, and the image PUR(s+1)′ represents an image acquired by deforming the s+1-th captured image PUR(s+1) by the homogeneous transformation matrix H_{s,s+1}. That is, the captured image PUR(s+1)′ is an image acquired by projecting the captured image PUR(s+1) onto the coordinate system with reference to the captured image PUR(s).

In addition, the origin O′ is positioned at the center of the s-th captured image PUR(s) and represents an origin of an XY coordinate system with reference to the s-th captured image PUR(s). Furthermore, the X axis and the Y axis in the drawing represent an X axis and an Y axis in the XY coordinate system with reference to the captured image PUR(s).

In the example of FIG. 31, the position (X, Y)=(tmpX, tmpY) on the captured image PUR(s+1)′ represents the center position of the s+1-th captured image PUR(s+1) which is projected onto the coordinate system with reference to the s-th captured image PUR(s) by the homogeneous transformation matrix H_{s,s+1}.

When the point K1₍ₛ₎ and the point K2₍ₛ₎ on the s-th captured image are acquired, tmpX which is an X coordinate of the position (tmpX, tmpY) is acquired, and the value of tmpX is divided by two. The acquired value tmpX/2 is regarded as the X coordinate of the point K1₍ₛ₎ and the point K2₍ₛ₎.

Accordingly, the point K1₍ₛ₎ and the point K2₍ₛ₎ are positioned at the middle between the origin O′ and the position (tmpX, tmpY) on the captured image PUR(s) in the X-axis direction. That is, the width in the X-axis direction which is represented by the arrow WDT11 in FIG. 31 and the width in the X-axis direction which is represented by the arrow WDT12 are equal to each other.

In addition, the positions of the point K1₍ₛ₎ and the point K2₍ₛ₎ in the Y-axis direction are determined so as to be positioned at the upper end and the lower end of the captured image PUR(s) in the drawing, respectively. If it is assumed that the height of the captured image PUR(s) in the Y-axis direction is represented as Height, for example, the Y coordinate of the point K1₍ₛ₎ is +Height/2, and the Y coordinate of the point K2₍ₛ₎ is −Height/2.

If the positions of the point K1₍ₛ₎ and the point K2₍ₛ₎ are expressed by same-order coordinates, the positions are represented by the following Equation (71).

$$\begin{matrix}[ Math . 71 ] & \\ K {1}_{( s )} ≡ [ \begin{matrix}tmpX / 2 \\ Height / 2 \\ 1\end{matrix} ] , \\ K {2}_{( s )} ≡ [ \begin{matrix}tmpX / 2 \\ - Height / 2 \\ 1\end{matrix} ] , \\ where \\ [ \begin{matrix}tmpX \\ tmpY \\ 1\end{matrix} ] ∝ {H}_{s , s + 1} [ \begin{matrix}0 \\ 0 \\ 1\end{matrix} ] & ( 71 )\end{matrix}$$

The positions of the point K1₍ₛ₎ and the point K2₍ₛ₎ defined as described above are near the boundary between the s-th captured image which is mapped in the panoramic image (omnidirectional image) of 360° and the s+1-th captured image which is mapped in the panoramic image of 360°. Accordingly, the two points K1₍ₛ₎ and K2₍ₛ₎ defined as described above satisfy the aforementioned characteristics.

Incidentally, if the homogeneous transformation matrixes H_{s,s+1} are accumulated in the forward direction, the homogeneous transformation matrix H⁺_{1,s} of Equation (56) is acquired. If the positions of the two points K1₍ₛ₎ and the point K2₍ₛ₎ on the s-th captured image in the three-dimensional coordinate system with reference to the imaging direction, in which the first captured image is captured, are acquired by the homogeneous transformation matrix H⁺_{1,s} for arbitrary s (where s=2 to N), the positions as represented by the following Equation (72) and Equation (73) are acquired.

[Math. 72]

H⁺_{1,s}K1₍ₛ₎ (72)

[Math. 73]

H⁺_{1,s}K2₍ₛ₎ (73)

Here, an application range of Equation (72) and Equation (73) is set to s=1 to N including a case where s=1 by configuring the homogeneous transformation matrix H⁺_{1,s} in the case where s=1 as a unit matrix.

If the homogeneous transformation matrixes H_{s,s+1} are accumulated in the backward direction, the homogeneous transformation matrix H⁻_{1,s} of Equation (57) is acquired. If the positions of the two points K1₍ₛ₎ and K2₍ₛ₎ on the s-th captured image in the three-dimensional coordinate system with reference to the imaging direction in which the first captured image is captured are acquired by the homogeneous transformation matrix H⁻_{1,s} with respect to arbitrary s (where s=2 to N), the positions are as represented by the following Equation (74) and Equation (75).

[Math. 74]

H⁻_{1,s}K1₍ₛ₎ (74)

[Math. 75]

H⁻_{1,s}K2₍ₛ₎ (75)

Here, the aforementioned s⁺ direction corresponds to Equation (72) and Equation (73) in this embodiment. In addition, the s⁻ direction corresponds to Equation (74) and Equation (75).

Next, proration of the position represented by Equation (72) and the position represented by Equation (74) will be considered. Similarly, proration of the position represented by Equation (73) and the position represented by Equation (75) will be considered. That is, the point K1^{±}₍ₛ₎ and the point K2^{±}₍ₛ₎ (where s=1 to N) at the positions represented by the following Equation (76) and Equation (77) will be considered.

$$\begin{matrix} [ Math . 76 ] & \\ K {1}_{( s )}^{\pm } = \frac{( N + 1 - s ) ‖ {H}_{1 , s}^{+} K {1}_{( s )} ‖ + ( s - 1 ) ‖ {H}_{1 , s}^{-} K {1}_{( s )} ‖}{N} \times \frac{( ( N + 1 - s ) {H}_{1 , s}^{+} K {1}_{( s )} + ( s - 1 ) {H}_{1 , s}^{-} K {1}_{( s )} )}{‖ ( N + 1 - s ) {H}_{1 , s}^{+} K {1}_{( s )} + ( s - 1 ) {H}_{1 , s}^{-} K {1}_{( s )} ‖} \\ however , \\ K {1}_{( 1 )}^{\pm } = K {1}_{( s )}^{\pm } = {H}_{1 , s}^{+} K {1}_{( s )} = {H}_{1 , 1}^{+} K {1}_{( 1 )} = K {1}_{( 1 )} \\ when \\ s = 1 & ( 76 ) \\ [ Math . 77 ] & \\ K {2}_{( s )}^{\pm } = \frac{( N + 1 - s ) ‖ {H}_{1 , s}^{+} K {2}_{( s )} ‖ + ( s - 1 ) ‖ {H}_{1 , s}^{-} K {2}_{( s )} ‖}{N} + \frac{( ( N + 1 - s ) {H}_{1 , s}^{+} K {2}_{( s )} + ( s - 1 ) {H}_{1 , s}^{-} K {2}_{( s )} )}{‖ ( N + 1 - s ) {H}_{1 , s}^{+} K {2}_{( s )} + ( s - 1 ) {H}_{1 , s}^{-} K {2}_{( s )} ‖} \\ however , \\ K {2}_{( 1 )}^{\pm } = K {2}_{( s )}^{\pm } = {H}_{1 , s}^{+} K {2}_{( s )} = {H}_{1 , 1}^{+} K {2}_{( 1 )} = K {2}_{( 1 )} \\ when \\ s = 1 & ( 77 )\end{matrix}$$

Here, the direction of the vector represented by Equation (76), namely the direction of the point K1^{±}₍ₛ₎ is a direction acquired by prorating the vector represented by Equation (72) and the vector represented by Equation (74) at the ratio of N+1-s:s−1. In addition, the size of the vector represented by Equation (76) is a size acquired by prorating the size of the vector represented by Equation (72) and the size of the vector represented by Equation (74) at the ratio of N+1-s:s−1.

The direction of the vector represented by Equation (77), namely the direction of the point K2^{±}₍ₛ₎ is a direction acquired by prorating the vector represented by Equation (73) and the vector represented by Equation (75) at the ratio of N+1-s:s−1. Furthermore, the size of the vector represented by Equation (77) is a size acquired by prorating the size of the vector represented by Equation (73) and the size of the vector represented by Equation (75) at the ratio of N+1-s:s−1.

The thus acquired directions of the point K1^{±}₍ₛ₎ and the point K2^{±}₍ₛ₎ are final directions of the representative pixel positions (the point K1₍ₛ₎ and the point K2₍ₛ₎) in the s-th captured image.

In relation to the two points at the representative positions in the s-th captured image, namely the point K1₍ₛ₎ and the point K2₍ₛ₎ represented by Equation (71), it is only necessary to map the pixel values of the pixels at the positions (the point K1₍ₛ₎ and the point K2₍ₛ₎) as light coming from the direction of the vectors (K1^{±}₍ₛ₎, K2^{±}₍ₛ₎) represented by Equation (76) and Equation (77) in the panoramic image of 360°. Here, the pixel values of the pixels in the captured image are generally values from 0 to 255 when the captured image is a monochrome image, and are values expressing three primary colors, namely red, green, and blue by 0 to 255 when the captured image is a color image.

Incidentally, objects projected to the point K1₍ₛ₎ and the point K2₍ₛ₎ which are pixel positions in the s-th captured image with respect to arbitrary s (where s=1 to N) are also projected to a point K3₍ₛ₊₁₎ and a point K4₍ₛ₊₁₎ which are pixel positions in the s+1-th captured image.

Here, the point K3₍ₛ₊₁₎ and the point K4₍ₛ₊₁₎ are defined by the following Equation (78) and Equation (79) and are represented by same-order coordinates (also referred to as homogeneous coordinates).

[Math. 78]

K1₍ₛ₎∝H_{s s+1}K3₍ₛ₊₁₎ (78)

[Math. 79]

K2₍ₛ₎∝H_{s,s+1}K⁴₍ₛ₊₁₎ (79)

Accordingly, it is only necessary to map the point K3₍ₛ₊₁₎ and the point K4₍ₛ₊₁₎ which are pixel positions in the s+1-th captured image with respect to arbitrary s (where s=1 to N) as light coming from the directions of the vectors (K1^{±}₍ₛ₎, K2^{±}₍ₛ₎) represented by Equation (76) and Equation (77) on the panoramic image.

In addition, s+1 means 1 when s=N as described above. Thus, when s=N, it is only necessary to map the point K3₍₁₎ and the point K4₍₁₎ which are pixel positions in the first captured image as light coming from the direction of the vectors (K1^{±}_{(N)}, K2^{±}_{(N)}) represented by Equation (76) and Equation (77) in the panoramic image (omnidirectional image) of 360°.

Now, if s is replaced with s−1 for easy viewing, Equation (78) and Equation (79) are changed as represented by the following Equation (80) and Equation (81). When the index s is one in Equation (80) and Equation (81), the index s−1 means N.

[Math. 80]

K1₍ₛ₋₁₎∝H_{s-1,s}K3₍ₛ₎ (80)

[Math. 81]

K2₍ₛ₋₁₎∝H_{s-1,s}K4₍ₛ₎ (81)

If s is replaced with s−1 for easy viewing, Equation (76) and (77) are changed as represented by the following Equation (82) and Equation (83).

$$\begin{matrix} [ Math . 82 ] & \\ K {1}_{( s - 1 )}^{\pm } = \frac{( N + 2 - s ) ‖ {H}_{1 , s - 1}^{+} K {1}_{( s - 1 )} ‖ + ( s - 2 ) ‖ {H}_{1 , s - 1}^{-} K {1}_{( s - 1 )} ‖}{N} \times \frac{( ( N + 2 - s ) {H}_{1 , s - 1}^{+} K {1}_{( s - 1 )} + ( s - 2 ) {H}_{1 , s - 1}^{-} K {1}_{( s - 1 )} )}{‖ ( N + 2 - s ) {H}_{1 , s - 1}^{+} K {1}_{( s - 1 )} + ( s - 2 ) {H}_{1 , s - 1}^{-} K {1}_{( s - 1 )} ‖} \\ however , \\ K {1}_{( 1 )}^{\pm } = K {1}_{( s - 1 )}^{\pm } = {H}_{1 , s - 1}^{+} K {1}_{( s )} = {H}_{1 , 1}^{+} K {1}_{( 1 )} = K {1}_{( 1 )} \\ when \\ s = 2. \\ In addition , \\ K {1}_{( N )}^{\pm } = K {1}_{( s - 1 )}^{\pm } = \frac{‖ {H}_{1 , N}^{+} K {1}_{( N )} ‖ + ( N - 1 ) ‖ {H}_{1 , N}^{-} K {1}_{( N )} ‖}{N} \times \frac{( {H}_{1 , N}^{+} K {1}_{( N )} + ( N - 1 ) {H}_{1 , N}^{-} K {1}_{( N )} )}{‖ {H}_{1 , N}^{+} K {1}_{( N )} + ( N - 1 ) {H}_{1 , N}^{-} K {1}_{( N )} ‖} \\ when \\ s = 1. & ( 82 ) \\ [ Math . 83 ] & \\ K {2}_{( s - 1 )}^{\pm } = \frac{( N + 2 - s ) ‖ {H}_{1 , s - 1}^{+} K {2}_{( s - 1 )} ‖ + ( s - 2 ) ‖ {H}_{1 , s - 1}^{-} K {2}_{( s - 1 )} ‖}{N} \times \frac{( ( N + 2 - s ) {H}_{1 , s - 1}^{+} K {2}_{( s - 1 )} + ( s - 2 ) {H}_{1 , s - 1}^{-} K {2}_{( s - 1 )} )}{‖ ( N + 2 - s ) {H}_{1 , s - 1}^{+} K {2}_{( s - 1 )} + ( s - 2 ) {H}_{1 , s - 1}^{-} K {2}_{( s - 1 )} ‖} \\ however , \\ K {2}_{( 1 )}^{\pm } = K {2}_{( s - 1 )}^{\pm } = {H}_{1 , s - 1}^{+} K {2}_{( s )} = {H}_{1 , 1}^{+} K {2}_{( 1 )} = K {2}_{( 1 )} \\ when \\ s = 2. \\ In addition , \\ K {2}_{( N )}^{\pm } = K {2}_{( s - 1 )}^{\pm } = \frac{‖ {H}_{1 , N}^{+} K {2}_{( N )} ‖ + ( N - 1 ) ‖ {H}_{1 , N}^{-} K {2}_{( N )} ‖}{N} \times \frac{( {H}_{1 , N}^{+} K {2}_{( N )} + ( N - 1 ) {H}_{1 , N}^{-} K {2}_{( N )} )}{‖ {H}_{1 , N}^{+} K {2}_{( N )} + ( N - 1 ) {H}_{1 , N}^{-} K {2}_{( N )} ‖} \\ when \\ s = 1. & ( 83 )\end{matrix}$$

If the above description is summarized, it is only necessary to map the pixel value of the pixel at the position of the point K1₍ₛ₎ in the s-th captured image as light coming from the direction of the vector K1^{±}₍ₛ₎ represented by Equation (76) in the panoramic image (omnidirectional image) of 360°. In addition, the point K1₍ₛ₎ is at the position defined by Equation (71).

Then, it is only necessary to map the pixel value of the pixel at the position of the point K2₍ₛ₎ in the s-th captured image as light coming from the direction of the vector K2^{±}₍ₛ₎ represented by Equation (77) in the panoramic image of 360°. In addition, the point K2₍ₛ₎ is at the position defined by Equation (71).

In addition, it is only necessary to map the pixel value of the pixel at the position of the point K3₍ₛ₎ in the s-th captured image as light coming from the direction of the vector K1^{±}₍ₛ₋₁₎ represented by Equation (82) in the panoramic image of 360°. In addition, the point K3₍ₛ₎ is at the position defined by Equation (80).

Furthermore, it is only necessary to map the pixel value of the pixel at the position of the point K4₍ₛ₎ in the s-th captured image as light coming from the direction of the vector K2^{±}₍ₛ₋₁₎ represented by Equation (83) in the panoramic image of 360°. In addition, the point K4₍ₛ₎ is at the position defined by Equation (81).

Here, the pixel value of the pixel in the captured image is generally a value from 0 to 255 when the captured image is a monochrome image, and is a value expressing three primary colors, namely red, green, and blue by 0 to 255 when the captured image is a color image.

Now, if it is determined in which directions the positions of the four points on an image are generally mapped in the three-dimensional space, a homogeneous transformation matrix of the image is acquired. Since the four pixel positions in the s-th captured image, namely the directions of the point K1₍ₛ₎ to the point K4₍ₛ₎ have been acquired as described above, the homogeneous transformation matrix of the s-th captured image is acquired. Accordingly, the homogeneous transformation matrix may be regarded as an optimized homogeneous transformation matrix. That is, the homogeneous transformation matrix which satisfies the following Equation (84) may be regarded as an optimized homogeneous transformation matrix H^{±}_{1,s}.

$$\begin{matrix} [ Math . 84 ] & \\ \begin{matrix}K {1}_{( s )}^{\pm } ∝ {H}_{1 , s}^{\pm } K {1}_{( s )} & \\ K {2}_{( s )}^{\pm } ∝ {H}_{1 , s}^{\pm } K {2}_{( s )} & \\ K {1}_{( s - 1 )}^{\pm } ∝ {H}_{1 , s}^{\pm } K {3}_{( s )} & ( However , when s = 1 , K {1}_{( N )}^{\pm } ∝ {H}_{1 , 1}^{\pm } K {3}_{( 1 )} ) \\ K {2}_{( s - 1 )}^{\pm } ∝ {H}_{1 , s}^{\pm } K {4}_{( s )} & ( However , when s = 1 , K {2}_{( N )}^{\pm } ∝ {H}_{1 , 1}^{\pm } K {4}_{( 1 )} )\end{matrix} \} & ( 84 )\end{matrix}$$

The 3x3 homogeneous transformation matrix H^{±}_{1,s} represented by Equation (84) is an optimized homogeneous transformation matrix which represents the positional relationship between the s-th and the first captured images. In the optimized homogeneous transformation matrix, the homogeneous transformation matrix H^{±}_{1,1} which represents the position of the first captured image is not necessarily a unit matrix.

If the homogeneous transformation matrix H^{±}_{1,s} (where s=1 to N) is acquired as described above, it is possible to acquire a panoramic image (omnidirectional image) of 360° by mapping the pixel value of the pixel at each position Wₛ in each captured image as light coming from the direction represented by Equation (64). In this embodiment, the homogeneous transformation matrix H^{±}_{1,s} when s=1 is not necessarily a unit matrix. In addition, the pixel value of the pixel in the captured image is generally a value from 0 to 255 when the captured image is a monochrome image, and is a value expressing three primary colors, namely red, green, and blue by 0 to 255 when the captured image is a color image.

### [Configuration Example of Image Processing Apparatus]

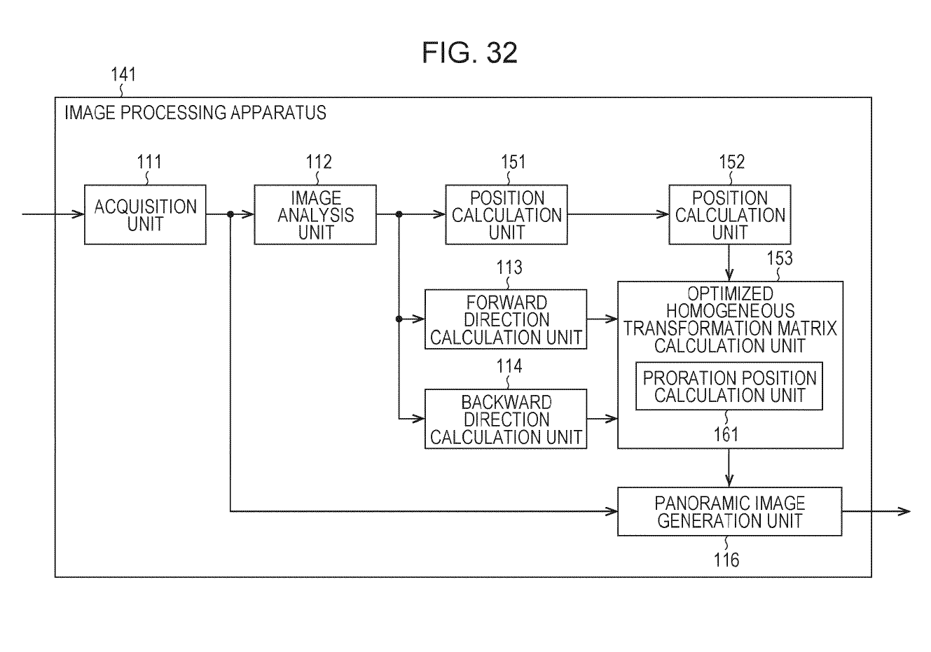

Next, description will be given of a specific embodiment to which the present technology is applied. FIG. 32 is a diagram showing a configuration example of an embodiment of an image processing apparatus to which the present technology is applied. In FIG. 32, the same reference numerals are given to parts corresponding to those in FIG. 28, and the description thereof will be omitted.

An image processing apparatus 141 in FIG. 32 is configured of the acquisition unit 111, the image analysis unit 112, a position calculation unit 151, a position calculation unit 152, the forward direction calculation unit 113, the backward direction calculation unit 114, an optimized homogeneous transformation matrix calculation unit 153, and the panoramic image generation unit 116.

The position calculation unit 151 calculates the positions of the point K1₍ₛ₎ and the point K2₍ₛ₎ on the captured image based on the homogeneous transformation matrix H_{s,s+1} supplied from the image analysis unit 112 and supplies the homogeneous transformation matrix H_{s,s+1} and the positions of the point K1₍ₛ₎ and the point K2₍ₛ₎ to the position calculation unit 152.

The position calculation unit 152 calculates the positions of the point K3₍ₛ₎ and the point K4₍ₛ₎ based on the homogeneous transformation matrix H_{s,s+1} and the positions of the point K1₍ₛ₎ and the point K2₍ₛ₎ from the position calculation unit 151 and supplies the positions of the point K1₍ₛ₎ to the point K4₍ₛ₎ to the optimized homogeneous transformation matrix calculation unit 153.

The optimized homogeneous transformation matrix calculation unit 153 calculates the optimized homogeneous transformation matrix H^{±}_{1,s} based on the positions of the point K1₍ₛ₎ to the point K4₍ₛ₎ from the position calculation unit 152, the homogeneous transformation matrix H⁺_{1,s} from the forward direction calculation unit 113, and the homogeneous transformation matrix H⁻_{1,s} from the backward direction calculation unit 114 and supplies the optimized homogeneous transformation matrix H^{±}_{1,s} to the panoramic image generation unit 116. In addition, the optimized homogeneous transformation matrix calculation unit 153 is provided with a proration position calculation unit 161, and the proration position calculation unit 161 acquires a point K1^{±}₍ₛ₎ and a point K2^{±}₍ₛ₎ which are acquired by prorating the point K1₍ₛ₎ and the point K2₍ₛ₎, respectively when the homogeneous transformation matrix H^{±}_{1,s} is calculated.

### [Description of Panoramic Image Generation Processing]

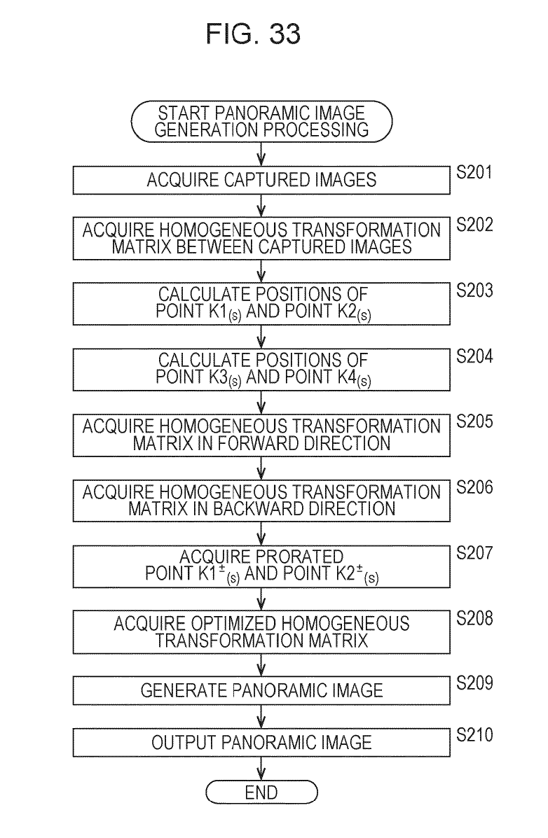

Next, description will be given of panoramic image generation processing by the image processing apparatus 141 with reference to the flowchart in FIG. 33.

In addition, since processing in Step S201 and Step S202 is the same as the processing in Step S141 and Step S142 in FIG. 29, the description thereof will be omitted. However, the homogeneous transformation matrix H_{s,s+1} (where s=1 to N) acquired in the processing in Step S202 is supplied from the image analysis unit 112 to the position calculation unit 151, the forward direction calculation unit 113, and the backward direction calculation unit 114.

In Step S203, the position calculation unit 151 calculates the positions of the point K1₍ₛ₎ and the point K2₍ₛ₎ (where s=1 to N) on the captured image, which are represented by Equation (71), based on the homogeneous transformation matrix H_{s,s+1} and the pixel number Height of the captured image in the vertical direction supplied from the image analysis unit 112. The position calculation unit 151 supplies the homogeneous transformation matrix H_{s,s+1} and the positions of the point K1₍ₛ₎ and the point K2₍ₛ₎ to the position calculation unit 152.

In Step S204, the position calculation unit 152 calculates the positions of the point K3₍ₛ₎ and the point K4₍ₛ₎ (where s=1 to N) represented by Equation (80) and Equation (81) based on the homogeneous transformation matrix H_{s,s+1} and the positions of the point K1₍ₛ₎ and the point K2₍ₛ₎ from the position calculation unit 151. The position calculation unit 152 supplies the positions of the point K1₍ₛ₎ to the point K4₍ₛ₎ to the optimized homogeneous transformation matrix calculation unit 153.

In Step S205, the forward direction calculation unit 113 accumulates the homogeneous transformation matrixes H_{s,s+1} supplied from the image analysis unit 112 in the forward direction by calculating Equation (56) and acquires the homogeneous transformation matrix H⁺_{1,s} (where s=2 to N) in the forward direction. Furthermore, the forward direction calculation unit 113 configures the homogeneous transformation matrix H⁺_{1,s} where s=1 (that is H⁺_{1,1}) as a unit matrix.

The forward direction calculation unit 113 supplies the acquired homogeneous transformation matrix H⁺_{1,s} (where s=1 to N) in the forward direction to the optimized homogeneous transformation matrix calculation unit 153.

In Step S206, the backward direction calculation unit 114 accumulates the homogeneous transformation matrixes H_{s,s+1} supplied from the image analysis unit 112 in the backward direction by calculating Equation (57), acquires the homogeneous transformation matrix H⁻_{1,s} (where s=2 to N) in the backward direction, and supplies the homogeneous transformation matrix H⁻_{1,s} to the optimized homogeneous transformation matrix calculation unit 153.

In Step S207, the proration position calculation unit 161 acquires the prorated point K1^{±}₍ₛ₎ and the prorated point K2^{±}₍ₛ₎ based on the homogeneous transformation matrix H⁺_{1,s} from the forward direction calculation unit 113, the homogeneous transformation matrix H⁻_{1,s} from the backward direction calculation unit 114, and the positions of the point K1₍ₛ₎ and the point K2₍ₛ₎ from the position calculation unit 152. That is, the aforementioned calculation of Equation (76) is performed for s=1 to N to acquire the point K1^{±}₍ₛ₎, and the calculation of Equation (77) is performed to acquire the point K2^{±}₍ₛ₎.

In Step S208, the optimized homogeneous transformation matrix calculation unit 153 acquires the optimized homogeneous transformation matrix H^{±}_{1,s} (where s=1 to N) which satisfies Equation (84) based on the positions of the point K1₍ₛ₎ to the point K4₍ₛ₎ and the positions of the point K1^{±}₍ₛ₎ and the point K2^{±}₍ₛ₎ from the position calculation unit 152.

The optimized homogeneous transformation matrix calculation unit 153 supplies the acquired homogeneous transformation matrix H^{±}_{1,s} to the panoramic image generation unit 116.

In Step S209, the panoramic image generation unit 116 generates a panoramic image based on the captured images from the acquisition unit 111 and the homogeneous transformation matrix H^{±}_{1,s} from the optimized homogeneous transformation matrix calculation unit 153.

Specifically, the panoramic image generation unit 116 generates a panoramic image of 360° by mapping the pixel value of the pixel at each position Wₛ in the respective captured images, namely the first to the N-th captured images as light coming from the direction represented by Equation (64) in the canvas region prepared in advance. That is, the panoramic image generation unit 116 maps the pixel value of the pixel at the position Wₛ on the position, which is determined by the direction represented by Equation (64), in the canvas region.

Here, the pixel value of the pixel in the captured image is generally a value from 0 to 255 when the captured image is a monochrome image, and is a value expressing three primary colors, namely red, green, and blue by 0 to 255 when the captured image is a color image.

In Step S210, the panoramic image generation unit 116 regards the image on the canvas region as a panoramic image of 360° and outputs the panoramic image, and the panoramic image generation processing is completed.

As described above, the image processing apparatus 141 determines the representative point K1₍ₛ₎ and the point K2₍ₛ₎ on each captured image, prorates points acquired by transforming these points by the homogeneous transformation matrix H⁺_{1,s} in the forward direction and the homogeneous transformation matrix H⁻_{1,s} in the backward direction, respectively, and acquires the point K1^{±}₍ₛ₎ and the point K2^{±}₍ₛ₎.

Then, the image processing apparatus 141 acquires the optimized homogeneous transformation matrix H⁺_{1,s} from the point K1₍ₛ₎ to the point K4₍ₛ₎ and the point K1^{±1}₍ₛ₎ and the point K2^{±}₍ₛ₎ and generates the panoramic image.

It is possible to acquire the homogeneous transformation matrix which represents the positional relationship between the first captured image and the s-th captured image with a smaller processing amount by prorating the points acquired by transforming the representative points by the homogeneous transformation matrixes in the forward direction and in the backward direction and acquiring the optimized homogeneous transformation matrix as described above. As a result, it is possible to more simply and quickly acquire the panoramic image of 360°.

### Modification Example 1 of Fourth Embodiment

### Concerning Proration between Captured Images

Incidentally, a proportion for prorating the representative positions in the respective captured images, namely the representative positions of the point K1₍ₛ₎ and the point K2₍ₛ₎ between the adjacent captured images in the forward direction and in the backward direction are changed by 1/N in accordance with the position of the captured image in the fourth embodiment.

However, when an angular velocity at which the imaging device is panned is not constant, the following defect occurs. That is, it is assumed that ten captured images are captured from 40° to 50°, for example. Then, two captured images are captured from 80° to 90°.

In such a case, errors of the ten captured images (10/N) are allocated from 40° to 50°, and errors of the two captured images (2/N) are allocated from 80° to 90°. Since the errors are equally divided into N in the fourth embodiment, errors which are five times as large as those for the range from 80° to 90° are allocated to the range from 40° to 50° in the panoramic image (omnidirectional image) of 360° as a resulting image. For this reason, errors are concentrated on the part from 40° to 50°, and a failure (deterioration in how the images are connected) in the image at the part from 40° to 50° becomes noticeable.

Thus, the errors to be allocated may not be equally divided into N, and allocation proportions may be determined by applying weights.

That is, errors are allocated to the ten captured images at the part from 40° to 50° by applying a weight ⅕ times as large as that in the case of the two captured images at the part from 80° to 90°, for example. With such processing, it is possible to acquire a resulting image in which failures (failures in how the images are connected) are equally distributed over the entire part without causing the errors to be concentrated on the part from 40° to 50°.

Although the above description was given in which the errors with a weight ⅕ times as large as that in the case of the two captured images at the part from 80° to 90° are allocated to the ten captured images at the part from 40° to 50°, more specifically, the following weight is applied thereto.

That is, when there is a long distance between the point K1₍ₛ₎ and the point K3₍ₛ₎ or when there is a distance between the point K2₍ₛ₎ and the point K4₍ₛ₎, the s-th captured image in the panoramic image (omnidirectional image) of 360° is rendered in a wide range. Thus, it is only necessary to consider an average value of the distance between the point K1₍ₛ₎ and the point K3₍ₛ₎ and the distance between the point K2₍ₛ₎ and the point K4₍ₛ₎ as a weight.

Accordingly, it is only necessary to use a weight G′ₛ defined by the following Equation (85), to employ the following Equation (86) instead of Equation (76), and to employ the following Equation (87) instead of Equation (77).

$$\begin{matrix} [ Math . 85 ] & \\ {G}_{s}^{′} ≡ \frac{{\sum }_{k = 2}^{s} ( \frac{‖ K {1}_{( k )} - K {3}_{( k )} ‖ + ‖ K {2}_{( k )} - K {4}_{( k )} ‖}{2} )}{{\sum }_{k = 1}^{N} ( \frac{‖ K {1}_{( k )} - K {3}_{( k )} ‖ + ‖ K {2}_{( k )} - K {4}_{( k )} ‖}{2} )} & ( 85 ) \\ [ Math . 86 ] & \\ K {1}_{( s )}^{\pm } = ( ( 1 - {G}_{s}^{′} ) ‖ {H}_{1 , s}^{+} K {1}_{( s )} ‖ + {G}_{s}^{′} ‖ {H}_{1 , s}^{-} K {1}_{( s )} ‖ ) \times \frac{( ( 1 - {G}_{s}^{′} ) {H}_{1 , s}^{+} K {1}_{( s )} + {G}_{s}^{′} {H}_{1 , s}^{-} K {1}_{( s )} )}{‖ ( 1 - {G}_{s}^{′} ) {H}_{1 , s}^{+} K {1}_{( s )} + {G}_{s}^{′} {H}_{1 , s}^{-} K {1}_{( s )} ‖} \\ However , \\ K {1}_{( 1 )}^{\pm } = K {1}_{( s )}^{\pm } = {H}_{1 , s}^{\pm } K {1}_{( s )} = {H}_{1 , 1}^{+} K {1}_{( 1 )} = K {1}_{( 1 )} \\ when \\ s = 1. & ( 86 ) \\ [ Math . 87 ] & \\ K {2}_{( s )}^{\pm } = ( ( 1 - {G}_{s}^{′} ) ‖ {H}_{1 , s}^{+} K {2}_{( s )} ‖ + {G}_{s}^{′} ‖ {H}_{1 , s}^{-} K {2}_{( s )} ‖ ) \times \frac{( ( 1 - {G}_{s}^{′} ) {H}_{1 , s}^{+} K {2}_{( s )} + {G}_{s}^{′} {H}_{1 , s}^{-} K {2}_{( s )} )}{‖ ( 1 - {G}_{s}^{′} ) {H}_{1 , s}^{+} K {2}_{( s )} + {G}_{s}^{′} {H}_{1 , s}^{-} K {2}_{( s )} ‖} \\ However , \\ K {2}_{( 1 )}^{\pm } = K {2}_{( s )}^{\pm } = {H}_{1 , s}^{+} K {2}_{( s )} = {H}_{1 , 1}^{+} K {2}_{( 1 )} = K {2}_{( 1 )} \\ when \\ s = 1. & ( 87 )\end{matrix}$$

### [Description of Panoramic Image Generation Processing]

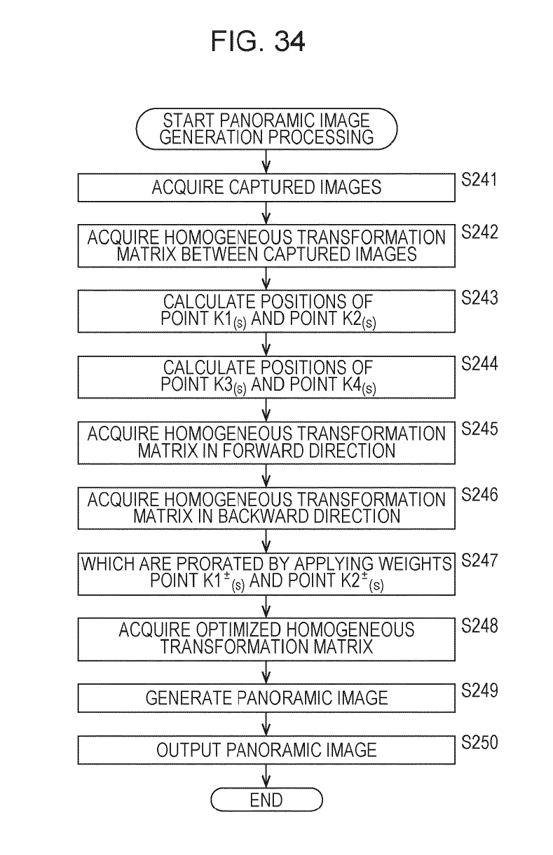

In such a case, panoramic image generation processing as shown in FIG. 34 is performed by the image processing apparatus 141. Hereinafter, description will be given of the panoramic image generation processing by the image processing apparatus 141 with reference to the flowchart in FIG. 34.

In addition, since processing in Step S241 to Step S246 is the same as the processing in Step S201 to Step S206 in FIG. 33, the description thereof will be omitted.

In Step S247, the proration position calculation unit 161 acquires the point K1⁺₍ₛ₎ and the point K2^{±}₍ₛ₎ prorated with weights based on the homogeneous transformation matrix H⁺_{1,s} from the forward direction calculation unit 113, the homogeneous transformation matrix H⁻_{1,s} from the backward direction calculation unit 114, and the positions of the point K1₍ₛ₎ to the point K4₍ₛ₎ from the position calculation unit 152.

That is, the proration position calculation unit 161 acquires the point K1^{±}₍ₛ₎ by performing the aforementioned calculation of Equation (86) for s=1 to N and acquires the point K2^{±}₍ₛ₎ by performing the calculation of Equation (87). In addition, the weight G′ₛ in Equation (86) and Equation (87) is a weight defined by Equation (85).

If the prorated point K1⁺₍ₛ₎ and the point K2^{±}₍ₛ₎ are acquired, then the processing in Step S248 to Step S250 is performed, and the panoramic image generation processing is completed. However, since the processing is the same as the processing in Step S208 to Step S210 in FIG. 33, the description thereof will be omitted.

It is possible to acquire the homogeneous transformation matrix which represents the positional relationship between the first and the s-th captured images with a smaller processing amount by prorating the representative point on the captured image in the forward direction and in the backward direction based on the weight G's determined by the positions of the point K1₍ₛ₎ to the point K4₍ₛ₎ on each captured image as described above. Therefore, it is possible to more simply and quickly acquire a panoramic image with high quality.

### Fifth Embodiment

### Concerning Optimized Homogeneous Transformation Matrix

Incidentally, the homogeneous transformation matrix H_{s,s+1} which represents the positional relationship between the adjacent captured images is supposed to be an orthogonal matrix when the images are captured while the imaging device is panned about an optical axis center.

Thus, it is assumed that correspondence points on the s-th captured image and on the s+1-th captured image, namely the position Vₛ and the position Vₛ₊₁ are acquired by using the block matching technology, and that the homogeneous transformation matrix H_{s,s+1} which satisfies Equation (46) (or Equation (47)) is acquired.

At this time, it is assumed that the homogeneous transformation matrix H_{s,s+1} is acquired with a restriction that the homogeneous transformation matrix H_{s,s+1} is an orthogonal matrix. Since it is a matter of course that there is an error between the corresponding points (the V position Vₛ and the position Vₛ₊₁), more specifically, an orthogonal matrix which satisfies equation (46) (or Equation (47)) to the maximum extent is acquired as the homogeneous transformation matrix H_{s,s+1}.

Incidentally, if the thus acquired homogeneous transformation matrixes H_{s,s+1}, which are orthogonal matrixes, are accumulated from s=1 to N, the matrix is supposed to return to an original position after the turning, namely the matrix supposed to be a unit matrix. However, since the matrix acquired by accumulating the homogeneous transformation matrixes H_{s,s+1} is not a unit matrix due to errors, error allocation in the imaging directions of the respective captured images is considered.

That is, although the above description was given in which the two directions (the s+ direction and the s− direction) are prorated, this embodiment is characterized in a way of proration in a case where the homogeneous transformation matrix H_{s,s+1} which is a positional relationship between the adjacent captured images is an orthogonal matrix.

For example, the homogeneous transformation matrix which represents the positional relationship between the s-th and the first captured images is represented as H_{1,s}. At this time, if an object which is projected at the position Vₛ in the s-th captured image is also projected at a position V₁ in the first captured image, the aforementioned relationship represented by Equation (52) is established. Here, the position Vₛ and the position V₁ are expressed by same-order coordinates (also referred to as homogeneous coordinates).

It is possible to consider that the homogeneous transformation matrix H_{1,s} is a coordinate transformation matrix from a three-dimensional coordinate system with reference to the imaging direction in which the s-th captured image is captured to a three-dimensional coordinate system with reference to the imaging direction in which the first captured image is captured. That is, a unit vector in the X-axis direction in the three-dimensional coordinate system with reference to the imaging direction in which the s-th captured image is captured is transformed into the vector represented by Equation (53).

In addition, a unit vector in the Y-axis direction in the three-dimensional coordinate system with reference to the imaging direction in which the s-th captured image is captured is transformed into a vector represented by Equation (54). Furthermore, a unit vector in the Z-axis direction in the three-dimensional coordinate system with reference to the imaging direction in which the s-th captured image is captured is transformed into a vector represented by Equation (55).

Thus, in this embodiment, the aforementioned s+ direction and the s− direction are prorated by respectively prorating these three axes in the same manner as in the third embodiment. Specific description will be given below.

First, a homogeneous transformation matrix H⁺_{1,s} acquired by accumulating the homogeneous transformation matrix H_{s,s+1} for arbitrary s (where s=2 to N) in the forward direction (in ascending order) is acquired by the calculation of Equation (56). The thus acquired homogeneous transformation matrix H⁺_{1,s} in the forward direction is a homogeneous transformation matrix which is acquired from the positional relationships between the adjacent captured images among the first to the s-th captured images and represents positional relationship between the s-th and the first captured images, and corresponds to the aforementioned s⁺ direction.

Next, the homogeneous transformation matrix H⁻_{1,s} in the backward direction which is acquired by accumulating the homogeneous transformation matrixes H_{s,s+1} in the backward direction (in descending order) is acquired by the calculation of Equation (57). The thus acquired homogeneous transformation matrix H⁻_{1,s} in the backward direction is a homogeneous transformation matrix which is acquired from the positional relationship between the first and the N-th captured images and the positional relationships between the adjacent captured images among the N-th to the s-th captured images and represents the positional relationship between the s-th and the first captured images. The homogeneous transformation matrix H⁻_{1,s} corresponds to the s direction.

In this embodiment, the 3x3 homogeneous transformation matrix H⁺_{1,s} and the homogeneous transformation matrix H⁻_{1,s} represented by Equation (56) and Equation (57) are orthogonal matrixes.

First, proration of the Z axis will be considered in this embodiment.

That is, the homogeneous transformation matrix H⁺_{1,s} represented by Equation (56) is considered as a coordinate transformation matrix from the three-dimensional coordinate system with reference to the imaging direction in which the s-th captured image is captured to the three-dimensional coordinate system with reference to the imaging direction in which the first captured image is captured.

Then, a vector acquired by transforming the unit vector in the Z-axis direction in the three-dimensional coordinate system with reference to the imaging direction in which the s-th captured image is captured by the homogeneous transformation matrix H⁺_{1,s} as shown in the following Equation (88) is considered.

$$\begin{matrix}[ Math . 88 ] & \\ {H}_{1 , s}^{+} [ \begin{matrix}0 \\ 0 \\ 1\end{matrix} ] = [ \begin{matrix}{H}_{1 , s ( 1 , 3 )}^{+} \\ {H}_{1 , s ( 2 , 3 )}^{+} \\ {H}_{1 , s ( 3 , 3 )}^{+}\end{matrix} ] & ( 88 )\end{matrix}$$

Similarly, the homogeneous transformation matrix H⁻_{1,s} represented by Equation (57) is considered as a coordinate transformation matrix from the three-dimensional coordinate system with reference to the imaging direction in which the s-th captured image is captured to the three-dimensional coordinate system with reference to the imaging direction in which the first captured image is captured. Then, a vector acquired by transforming the unit vector in the Z-axis direction in the three-dimensional coordinate system with reference to the imaging direction in which the s-th captured image is captured by the homogeneous transformation matrix H⁻_{1,s} as represented by the following Equation (89) is considered.

$$\begin{matrix}[ Math . 89 ] & \\ {H}_{1 , s}^{-} [ \begin{matrix}0 \\ 0 \\ 1\end{matrix} ] = [ \begin{matrix}{H}_{1 , s ( 1 , 3 )}^{-} \\ {H}_{1 , s ( 2 , 3 )}^{-} \\ {H}_{1 , s ( 3 , 3 )}^{-}\end{matrix} ] & ( 89 )\end{matrix}$$

Furthermore, a vector which prorates the two vectors represented by Equation (88) and Equation (89) is considered. Generally, an orthogonal matrix R_{(A, B, C, θ)} which is transformation of rotation by the angle θ with respect to a direction of a vector (A, B, C), that is, about the vector (A, B, C) as an axis can be expressed by the following Equation (90). Here, A²+B²+C²=1.

$$\begin{matrix}[ Math . 90 ] & \\ {R}_{( A , B , C , θ )} ≡ [ \begin{matrix}{A}^{2} + ( 1 - {A}^{2} ) cos ( θ ) & AB ( 1 - cos ( θ ) ) - C sin ( θ ) & AC ( 1 - cos ( θ ) ) + B sin ( θ ) \\ AB ( 1 - cos ( θ ) ) + C sin ( θ ) & {B}^{2} + ( 1 - {B}^{2} ) cos ( θ ) & BC ( 1 - cos ( θ ) ) - A sin ( θ ) \\ AC ( 1 - cos ( θ ) ) - B sin ( θ ) & BC ( 1 - cos ( θ ) ) + A sin ( θ ) & {C}^{2} + ( 1 - {C}^{2} ) cos ( θ )\end{matrix} ] & ( 90 )\end{matrix}$$

Thus, a rotation angle θs at which the vector represented by Equation (88) is rotated with respect to an axis which is orthogonal to two vectors, namely the vector represented by Equation (88) and the vector represented by Equation (89) so as to coincide with the vector represented by Equation (89) is acquired.

Then, a vector acquired by rotating the vector represented by Equation (88) by {(s−1)/N}×θₛ° is regarded as a vector acquired by prorating the two vectors represented by Equation (88) and Equation (89), respectively.

That is, it is only necessary to acquire Aₛ, Bₛ, Cₛ, and θₛ which satisfy the following Equation (91). In addition, it is assumed that (Aₛ)²+(Bₛ)²+(Cₛ)²=1 and that the angle θₛ is equal to or greater than 0° and equal to or less than 180°.

$$\begin{matrix}[ Math . 91 ] & \\ \begin{matrix}( \begin{matrix}{A}_{s} & {B}_{s} & {C}_{s}\end{matrix} ) [ \begin{matrix}{H}_{1 , s ( 1 , 3 )}^{+} \\ {H}_{1 , s ( 2 , 3 )}^{+} \\ {H}_{1 , s ( 3 , 3 )}^{+}\end{matrix} ] = 0 \\ ( \begin{matrix}{A}_{s} & {B}_{s} & {C}_{s}\end{matrix} ) [ \begin{matrix}{H}_{1 , s ( 1 , 3 )}^{-} \\ {H}_{1 , s ( 2 , 3 )}^{-} \\ {H}_{1 , s ( 3 , 3 )}^{-}\end{matrix} ] = 0 \\ [ \begin{matrix}{H}_{1 , s ( 1 , 3 )}^{-} \\ {H}_{1 , s ( 2 , 3 )}^{-} \\ {H}_{1 , s ( 3 , 3 )}^{-}\end{matrix} ] = {R}_{( As , Bs , Cs , θ s )} [ \begin{matrix}{H}_{1 , s ( 1 , 3 )}^{+} \\ {H}_{1 , s ( 2 , 3 )}^{+} \\ {H}_{1 , s ( 3 , 3 )}^{+}\end{matrix} ] \\ However , {R}_{( As , Bs , Cs , θ s )} satisfies \\ {R}_{( As , Bs , Cs , θ s )} ≡ [ \begin{matrix}{A}_{s}^{2} + ( 1 - {A}_{s}^{2} ) cos ( {θ}_{s} ) & {A}_{s} {B}_{s} ( 1 - cos ( {θ}_{s} ) ) - {C}_{s} sin ( {θ}_{s} ) & {A}_{s} {C}_{s} ( 1 - cos ( {θ}_{s} ) ) + {B}_{s} sin ( {θ}_{s} ) \\ {A}_{s} {B}_{s} ( 1 - cos ( {θ}_{s} ) ) + {C}_{s} sin ( {θ}_{s} ) & {B}_{s}^{2} + ( 1 - {B}_{s}^{2} ) cos ( {θ}_{s} ) & {B}_{s} {C}_{s} ( 1 - cos ( {θ}_{s} ) ) - {A}_{s} sin ( {θ}_{s} ) \\ {A}_{s} {C}_{s} ( 1 - cos ( {θ}_{s} ) ) - {B}_{s} sin ( {θ}_{s} ) & {B}_{s} {C}_{s} ( 1 - cos ( {θ}_{s} ) ) + {A}_{s} sin ( {θ}_{s} ) & {C}_{s}^{2} + ( 1 - {C}_{s}^{2} ) cos ( {θ}_{s} )\end{matrix} ]\end{matrix} \} & ( 91 )\end{matrix}$$

At this time, the vector (Aₛ, Bₛ, Cₛ) is the axis which is orthogonal to the two vectors, namely the vector represented by Equation (88) and the vector represented by Equation (89).

In addition, the vector acquired by rotating the vector represented by Equation (88) about the axis of the vector (Aₛ, Bₛ, Cₛ) by {(s−1)/N}×θₛ° can be expressed by the following Equation (92). The vector of Equation (92) is a vector acquired by prorating the two vectors represented by Equation (88) and Equation (89).

$$\begin{matrix}[ Math . 92 ] & \\ [ \begin{matrix}{H}_{1 , s ( 1 , 3 )}^{\pm } \\ {H}_{1 , s ( 2 , 3 )}^{\pm } \\ {H}_{1 , s ( 3 , 3 )}^{\pm }\end{matrix} ] = {R}_{( As , Bs , Cs , \frac{( s - 1 ) \times θ s}{N} )} [ \begin{matrix}{H}_{1 , s ( 1 , 3 )}^{+} \\ {H}_{1 , s ( 2 , 3 )}^{+} \\ {H}_{1 , s ( 3 , 3 )}^{+}\end{matrix} ] & ( 92 )\end{matrix}$$

In addition, the vector represented by Equation (92) is a vector acquired by inversely rotating the vector represented by Equation (89) about the axis of the vector (Aₛ, Bₛ, Cₛ) by {(N+1−s)/N}×θₛ°.

Next, proration of the X axis will be considered. That is, a vector acquired by prorating the aforementioned vectors represented by Equation (58) and Equation (59) will be considered.

Since the rotation in the Z-axis direction has already been determined, a vector in consideration of the rotation will be considered. The rotation in the Z-axis direction is rotation with respect to the axis of the vector (Aₛ, Bₛ, Cₛ) by {(s−1)/N}×θₛ° in relation to the matrix accumulated in the forward direction, and is an inverse rotation with respect to the axis of the vector (Aₛ, Bₛ, Cₛ) by {N+1−s/N}×θₛ° in relation to the matrix accumulated in the backward direction.

Specifically, a vector represented by the following Equation (93) will be considered instead of the aforementioned Equation (58), a vector represented by the following Equation (94) will be considered instead of Equation (59), and proration of these two vectors will be considered.

$$\begin{matrix}[ Math . 93 ] & \\ {R}_{( As , Bs , Cs , \frac{( s - 1 ) \times θ s}{N} )} [ \begin{matrix}{H}_{1 , s ( 1 , 1 )}^{+} \\ {H}_{1 , s ( 2 , 1 )}^{+} \\ {H}_{1 , s ( 3 , 1 )}^{+}\end{matrix} ] & ( 93 ) \\ [ Math . 94 ] & \\ {R}_{( As , Bs , Cs , \frac{- ( N + 1 - s ) \times θ s}{N} )} [ \begin{matrix}{H}_{1 , s ( 1 , 1 )}^{-} \\ {H}_{1 , s ( 2 , 1 )}^{-} \\ {H}_{1 , s ( 3 , 1 )}^{-}\end{matrix} ] & ( 94 )\end{matrix}$$

Directions of both the vectors of Equation (93) and Equation (94) are orthogonal to the direction of the vector represented by Equation (92). Thus, a rotation angle ψₛ at which the vector represented by Equation (93) is rotated about the vector represented by Equation (92) as an axis so as to coincide with the vector represented by Equation (94) is acquired.

Then, a vector acquired by rotating the vector represented by Equation (93) by {(s−1)/N}×ψₛ° is regarded as a vector acquired by prorating the two vectors represented by Equation (93) and Equation (94).

That is, it is only necessary to acquire the angle ψs which satisfies the following Equation (95). In addition, the angle ψₛ is equal to or greater than −180° and less than 180°.

$$\begin{matrix} [ Math . 95 ] & \\ {R}_{( As , Bs , Cs , \frac{- ( N + 1 - s ) \times θ s}{N} )} [ \begin{matrix}{H}_{1 , s ( 1 , 1 )}^{-} \\ {H}_{1 , s ( 2 , 1 )}^{-} \\ {H}_{1 , s ( 3 , 1 )}^{-}\end{matrix} ] = {R}_{( {H}_{1 , s ( 1 , 3 )}^{\pm } , {H}_{1 , s ( 2 , 3 )}^{\pm } , {H}_{1 , s ( 3 , 3 )}^{\pm } , {ψ}_{s} )} {R}_{( As , Bs , Cs , \frac{( s - 1 ) \times θ s}{N} )} [ \begin{matrix}{H}_{1 , s ( 1 , 1 )}^{+} \\ {H}_{1 , s ( 2 , 1 )}^{+} \\ {H}_{1 , s ( 3 , 1 )}^{+}\end{matrix} ] & ( 95 )\end{matrix}$$

In addition, a vector acquired by rotating the vector represented by Equation (93) about the vector represented by Equation (92) as an axis by {(s−1)/N}ψₛ° can be expressed by the following Equation (96). The vector of Equation (96) is regarded as a vector acquired by prorating the two vectors represented by Equation (93) and Equation (94).

$$\begin{matrix} [ Math . 96 ] & \\ [ \begin{matrix}{H}_{1 , s ( 1 , 1 )}^{\pm } \\ {H}_{1 , s ( 2 , 1 )}^{\pm } \\ {H}_{1 , s ( 3 , 1 )}^{\pm }\end{matrix} ] = {R}_{( {H}_{1 , s ( 1 , 3 )}^{\pm } , {H}_{1 , s ( 2 , 3 )}^{\pm } , {H}_{1 , s ( 3 , 3 )}^{\pm } , \frac{( s - 1 ) \times ψ s}{N} )} {R}_{( As , Bs , Cs , \frac{( s - 1 ) \times θ s}{N} )} [ \begin{matrix}{H}_{1 , s ( 1 , 1 )}^{+} \\ {H}_{1 , s ( 2 , 1 )}^{+} \\ {H}_{1 , s ( 3 , 1 )}^{+}\end{matrix} ] & ( 96 )\end{matrix}$$

In addition, the vector represented by Equation (96) is also a vector acquired by inversely rotating the vector represented by Equation (94) about the vector represented by Equation (92) by {(N+1−S)/N}×φₛ°.

Furthermore, proration of the Y axis will also be considered. It is only necessary to consider the proration of the Y axis in the same manner as the X axis, and the vector acquired by the proration can be expressed by the following Equation (97) by using the aforementioned angle ψₛ.

$$\begin{matrix} [ Math . 97 ] & \\ [ \begin{matrix}{H}_{1 , s ( 1 , 2 )}^{\pm } \\ {H}_{1 , s ( 2 , 2 )}^{\pm } \\ {H}_{1 , s ( 3 , 2 )}^{\pm }\end{matrix} ] = {R}_{( {H}_{1 , s ( 1 , 3 )}^{\pm } , {H}_{1 , s ( 2 , 3 )}^{\pm } , {H}_{1 , s ( 3 , 3 )}^{\pm } , \frac{( s - 1 ) \times ψ s}{N} )} {R}_{( As , Bs , Cs , \frac{( s - 1 ) \times θ s}{N} )} [ \begin{matrix}{H}_{1 , s ( 1 , 2 )}^{+} \\ {H}_{1 , s ( 2 , 2 )}^{+} \\ {H}_{1 , s ( 3 , 2 )}^{+}\end{matrix} ] & ( 97 )\end{matrix}$$

Then, the 3x3 homogeneous transformation matrix H^{±}_{1,s} represented by Equation (63) is acquired by using the values of Equation (92), Equation (96) and Equation (97).

The homogeneous transformation matrix H^{±}_{1,s} is a matrix acquired by prorating the homogenous transformation matrix H⁺_{1,s} which is an orthogonal matrix and a homogeneous transformation matrix H⁻_{1,s} which is an orthogonal matrix at a ratio of N+1-s:s−1. That is, the homogeneous transformation matrix H^{±1}_{1,s} is an optimized homogeneous transformation matrix which represents the positional relationship between the s-th and the first captured images.

If the homogeneous transformation matrix H^{±}_{1,s} (where s=1 to N) is acquired as described above, it is possible to acquire the panoramic image (omnidirectional image) of 360° by mapping the pixel value of the pixel at each position Wₛ in each captured image as light coming from the direction represented by Equation (64).

In this embodiment, the homogeneous transformation matrix H^{±}_{1,s} when s=1 is a unit matrix. In addition, the pixel value of the pixel in the captured image is generally a value from 0 to 255 when the captured image is a monochrome image, and is a value expressing three primary colors, namely red, green, and blue by 0 to 255 when the captured image is a color image.

### [Configuration Example of Image Processing Apparatus]

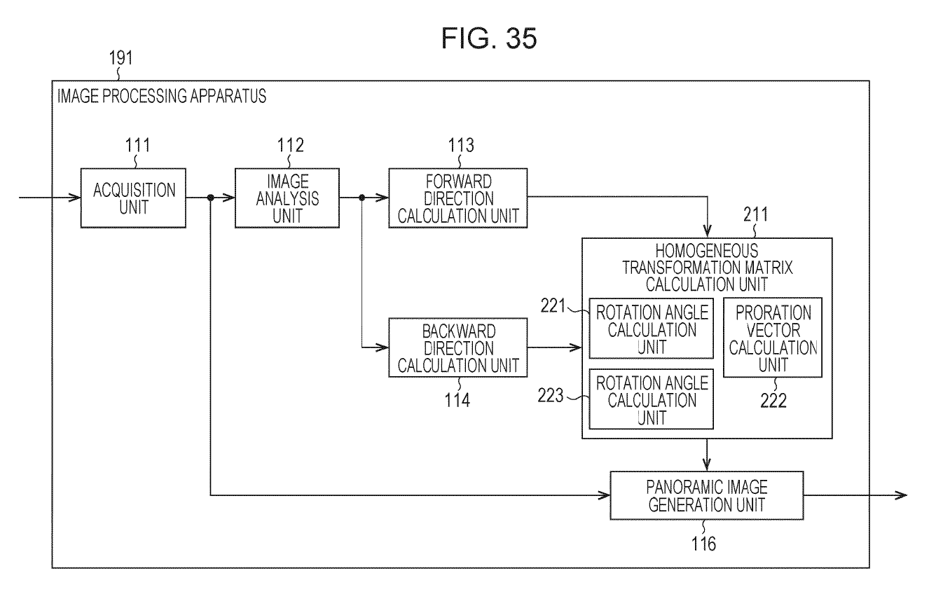

Next, description will be given of a specific embodiment to which the present technology is applied. FIG. 35 is a diagram showing a configuration example of an embodiment of an image processing apparatus to which the present technology is applied. In FIG. 35, the same reference numerals are given to parts corresponding to those in FIG. 28, and the description thereof will be omitted.

An image processing apparatus 191 in FIG. 35 is configured of the acquisition unit 111, the image analysis unit 112, the forward direction calculation unit 113, the backward direction calculation unit 114, a homogeneous transformation matrix calculation unit 211, and the panoramic image generation unit 116.

The homogeneous transformation matrix calculation unit 211 calculates the optimized homogeneous transformation matrix H^{±}_{1,s} based on the homogeneous transformation matrix H⁺_{1,s} from the forward direction calculation unit 113 and the homogeneous transformation matrix H⁻_{1,s} from the backward direction calculation unit 114 and supplies the optimized homogeneous transformation matrix H^{±}_{1,s} to the panoramic image generation unit 116.

The homogeneous transformation matrix calculation unit 211 is provided with a rotation angle calculation unit 221, a proration vector calculation unit 222, and a rotation angle calculation unit 223.

The rotation angle calculation unit 221 calculates a rotation angle θₛ and a vector (Aₛ, Bₛ, Cₛ) which functions as an axis of the rotation based on the homogeneous transformation matrix H⁺_{1,s} and the homogeneous transformation matrix H⁻_{1,s}.

In addition, the proration vector calculation unit 222 calculates a prorated vector which is represented by Equation (92) based on the homogeneous transformation matrix H⁺_{1,s} in the forward direction, the rotation angle θₛ, and the vector (Aₛ, Bₛ, Cₛ). Here, the vector of Equation (92) is a vector acquired by prorating the two vectors which are acquired by transforming a unit vector in the Z-axis direction in the three-dimensional coordinate system with reference to the imaging direction of the s-th captured image by the homogeneous transformation matrixes in the forward direction and in the backward direction, respectively.

The rotation angle calculation unit 223 calculates a rotation angle ψₛ based on the homogeneous transformation matrix H⁺_{1,s} the homogeneous transformation matrix H⁻_{1,s} the rotation angle θₛ the vector (Aₛ, Bₛ, Cₛ), and the vector of Equation (92).

### [Description of Panoramic Image Generation Processing]

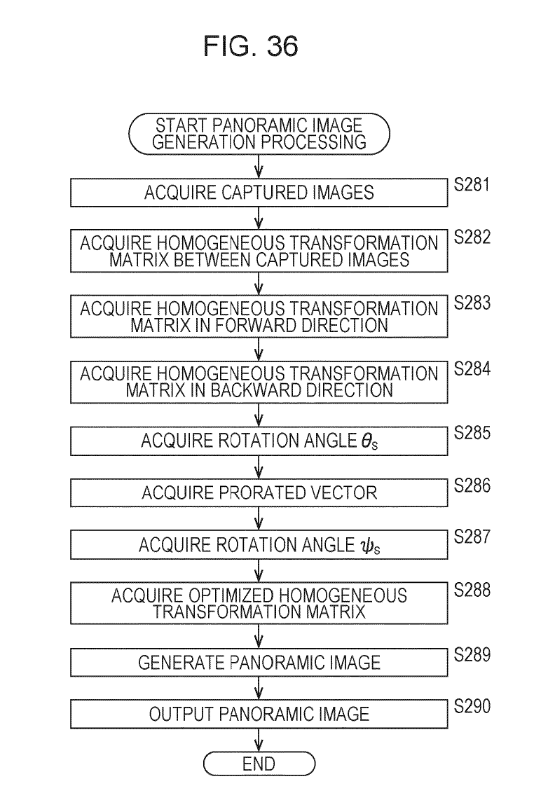

Next, description will be given of panoramic image generation processing by the image processing apparatus 191 with reference to the flowchart in FIG. 36.

Since processing in Step S281 to Step S284 is the same as the processing in Step S141 to Step S144 in FIG. 29, the description thereof will be omitted.

However, each homogeneous transformation matrix H_{s,s+1} (where s=1 to N) is acquired under the condition that the homogeneous transformation matrix H_{s,s+1} is an orthogonal matrix in Step S282. In addition, the homogeneous transformation matrix H⁺_{1,s} calculated by the forward direction calculation unit 113 and the homogeneous transformation matrix H⁻_{1,s} calculated by the backward direction calculation unit 114 are supplied to the homogeneous transformation matrix calculation unit 211.

In Step S285, the rotation angle calculation unit 221 acquires the rotation angle θₛ and the vector (Aₛ, Bₛ, Cₛ) based on the homogeneous transformation matrix H⁺_{1,s} and the homogeneous transformation matrix H⁻_{1,s}.

That is, the rotation angle calculation unit 221 acquires a vector obtained by transforming the unit vector in the Z-axis direction in the three-dimensional coordinate system with reference to the imaging direction of the s-th captured image by homogeneous transformation matrixes in the forward direction and in the backward direction by calculating Equation (88) and Equation (89). Furthermore, the rotation angle calculation unit 221 acquires the angle θₛ and the vector (Aₛ, Bₛ, Cₛ) (where s=2 to N) which satisfies Equation (91) from the acquired vector. In addition, the angle θₛ is equal to or greater than 0° and equal to or less than 180°.

In Step S286, the proration vector calculation unit 222 performs calculation of Equation (92) based on the homogeneous transformation matrix H⁺_{1,s} in the forward direction, the rotation angle θₛ, and the vector (Aₛ, Bₛ, Cₛ) and acquires a vector by prorating the two vectors represented by Equation (88) and Equation (89). Here, s=2 to N.

In Step S287, the rotation angle calculation unit 223 acquires the rotation angle ψₛ (where s=2 to N) which satisfies Equation (95) based on the homogeneous transformation matrix H⁺_{1,sr} the homogeneous transformation matrix H⁻_{1,s}, the rotation angle θₛ, the vector (Aₛ, Bₛ, Cₛ), and the vector of Equation (92).

In Step S288, the homogeneous transformation matrix calculation unit 211 calculates the optimized homogeneous transformation matrix H^{±}_{1,s} (where s=2 to N) and supplies the optimized homogeneous transformation matrix H^{±}_{1,s} to the panoramic image generation unit 116.

That is, the homogeneous transformation matrix calculation unit 211 performs calculation of Equation (96) and Equation (97) based on the homogeneous transformation matrix H⁺_{1,s}, the rotation angle θₛ, the vector (Aₛ, Bₛ, Cₛ), the vector of Equation (92), and the rotation angle ψₛ. Then, the homogeneous transformation matrix calculation unit 211 configures the 3×3 matrix represented by Equation (63) to be the optimized homogeneous transformation matrix H^{±}_{1,s} by using the values of the vectors represented by Equation (92), Equation (96), and Equation (97).

In Step S289, the panoramic image generation unit 116 generates a panoramic image based on the captured images from the acquisition unit 111 and the homogeneous transformation matrix H^{±}_{1,s} (where s=1 to N) from the homogeneous transformation matrix calculation unit 211.

Specifically, the panoramic image generation unit 116 generates the panoramic image of 360° by mapping the pixel value of the pixel at each position Wₛ in the respective captured images, namely the first to N-th captured images as light coming from the direction represented by Equation (64) in the canvas region prepared in advance. That is, the panoramic image generation unit 116 maps the pixel value of the pixel at the position Wₛ on the position, which is determined by the direction represented by Equation (64), in the canvas region.

Here, the homogeneous transformation matrix H^{±}_{1,1} is a unit matrix. In addition, the pixel value of the pixel in the captured image is generally a value from 0 to 255 when the captured image is a monochrome image, and is a value expressing three primary colors, namely red, green, and blue by 0 to 255 when the captured image is a color image.

In Step S290, the panoramic image generation unit 116 regards the image on the canvas region as the panoramic image of 360° and outputs the panoramic image, and the panoramic image generation processing is completed.

The image processing apparatus 191 acquires the rotation angle, performs proration for every axis of the coordinate system, acquires the optimized homogeneous transformation matrix H^{±}_{1,s}, and generates the panoramic image as described above when the homogeneous transformation matrix H_{s,s+1} is the orthogonal matrix.

It is possible to acquire the homogeneous transformation matrix which represents the positional relationship between the first captured image and the s-th captured image with a smaller processing amount by performing proration while rotating the axes of the coordinate system and acquiring the optimized homogeneous transformation matrix. As a result, it is possible to more simply and quickly acquire the panoramic image of 360°.

### Modification Example 1 of Fifth Embodiment

### Concerning Proration between Captured Images

Incidentally, the proportion for prorating the homogeneous transformation matrixes in the forward direction and in the backward direction between the adjacent captured images is varied by 1/N in accordance with the positions of the captured images in the fifth embodiment.

However, when an angular velocity at which the imaging device is panned is not constant, the following defect occurs. That is, it is assumed that ten captured images are captured from 40° to 50°, for example. Then, two captured images are captured from 80° to 90°.

In such a case, errors of the ten captured images (10/N) are allocated from 40° to 50°, and errors of the two captured images (2/N) are allocated from 80° to 90°. Since the errors are equally divided into N in the fifth embodiment, errors which are five times as large as those for the range from 80° to 90° are allocated to the range from 40° to 50° in the panoramic image (omnidirectional image) of 360° as a resulting image. For this reason, errors are concentrated on the part from 40° to 50°, and a failure (deterioration in how the images are connected) in the image at the part from 40° to 50° becomes noticeable.

Thus, the errors to be allocated may not be equally divided into N, and allocation proportions may be determined by applying weights.

That is, errors are allocated to the ten captured images at the part from 40° to 50° by applying a weight ⅕ times as large as that in the case of the two captured images at the part from 80° to 90°, for example. With such processing, it is possible to acquire a resulting image in which failures (failures in how the images are connected) are equally distributed over the entire part without causing the errors to be concentrated on the part from 40° to 50°.

As the weight which is the error allocation proportion, the variable Gₛ acquired from the angle φₛ, which satisfies Equation (65), and represented by Equation (67) may be used in the same manner as in Modification Example 1 of the third embodiment.

That is, the following Equation (98) may be used instead of Equation (92), the following Equation (99) may be used instead of Equation (95), the following Equation (100) may be used instead of Equation (96), and further, the following Equation (101) may be used instead of Equation (97).

$$\begin{matrix} [ Math . 98 ] & \\ [ \begin{matrix}{H}_{1 , s ( 1 , 3 )}^{\pm } \\ {H}_{1 , s ( 2 , 3 )}^{\pm } \\ {H}_{1 , s ( 3 , 3 )}^{\pm }\end{matrix} ] = {R}_{( As , Bs , Cs , {G}_{s} \times θ s )} [ \begin{matrix}{H}_{1 , s ( 1 , 3 )}^{+} \\ {H}_{1 , s ( 2 , 3 )}^{+} \\ {H}_{1 , s ( 3 , 3 )}^{+}\end{matrix} ] & ( 98 ) \\ [ Math . 99 ] & \\ {R}_{( As , Bs , Cs , - ( 1 - {G}_{s} ) \times {θ}_{s} )} [ \begin{matrix}{H}_{1 , s ( 1 , 1 )}^{-} \\ {H}_{1 , s ( 2 , 1 )}^{-} \\ {H}_{1 , s ( 3 , 1 )}^{-}\end{matrix} ] = {R}_{( {H}_{1 , s ( 1 , 3 )}^{\pm } , {H}_{1 , s ( 2 , 3 )}^{\pm } , {H}_{1 , s ( 3 , 3 )}^{\pm } , {ψ}_{s} )} {R}_{( As , Bs , Cs , {G}_{s} \times θ s )} [ \begin{matrix}{H}_{1 , s ( 1 , 1 )}^{+} \\ {H}_{1 , s ( 2 , 1 )}^{+} \\ {H}_{1 , s ( 3 , 1 )}^{+}\end{matrix} ] & ( 99 ) \\ [ Math . 100 ] & \\ [ \begin{matrix}{H}_{1 , s ( 1 , 1 )}^{\pm } \\ {H}_{1 , s ( 2 , 1 )}^{\pm } \\ {H}_{1 , s ( 3 , 1 )}^{\pm }\end{matrix} ] = {R}_{( {H}_{1 , s ( 1 , 3 )}^{\pm } , {H}_{1 , s ( 2 , 3 )}^{\pm } , {H}_{1 , s ( 3 , 3 )}^{\pm } , {G}_{s} \times {ψ}_{s} )} {R}_{( As , Bs , Cs , {G}_{s} \times θ s )} [ \begin{matrix}{H}_{1 , s ( 1 , 1 )}^{+} \\ {H}_{1 , s ( 2 , 1 )}^{+} \\ {H}_{1 , s ( 3 , 1 )}^{+}\end{matrix} ] & ( 100 ) \\ [ Math . 101 ] & \\ [ \begin{matrix}{H}_{1 , s ( 1 , 2 )}^{\pm } \\ {H}_{1 , s ( 2 , 2 )}^{\pm } \\ {H}_{1 , s ( 3 , 2 )}^{\pm }\end{matrix} ] = {R}_{( {H}_{1 , s ( 1 , 3 )}^{\pm } , {H}_{1 , s ( 2 , 3 )}^{\pm } , {H}_{1 , s ( 3 , 3 )}^{\pm } , {G}_{s} \times {ψ}_{s} )} {R}_{( As , Bs , Cs , {G}_{s} \times θ s )} [ \begin{matrix}{H}_{1 , s ( 1 , 2 )}^{+} \\ {H}_{1 , s ( 2 , 2 )}^{+} \\ {H}_{1 , s ( 3 , 2 )}^{+}\end{matrix} ] & ( 101 )\end{matrix}$$

### [Description of Panoramic Image Generation Processing]

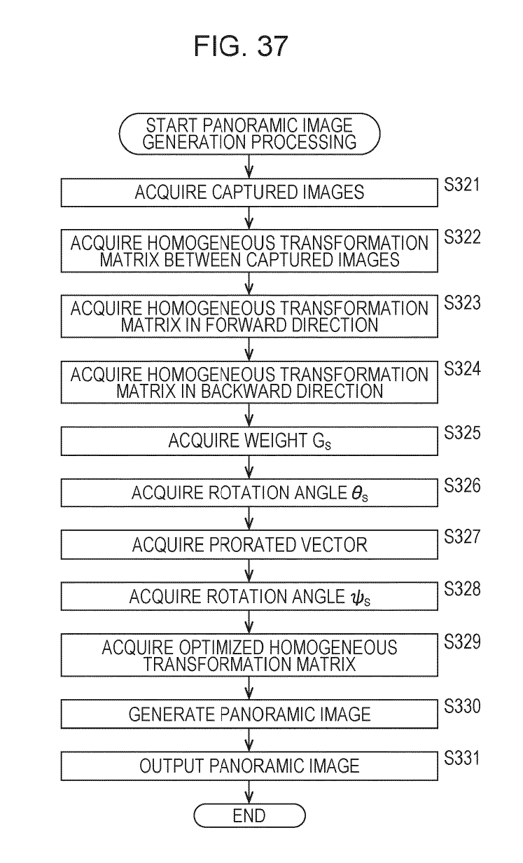

In such a case, panoramic image generation processing shown in FIG. 37 is performed by the image processing apparatus 191. Hereinafter, description will be given of the panoramic image generation processing by the image processing apparatus 191 with reference to the flowchart in FIG. 37.

In addition, since processing in Step S321 to Step S324 is the same as the processing in Step S281 to Step S284 in FIG. 36, the description thereof will be omitted. However, the forward direction calculation unit 113 supplies the homogeneous transformation matrix in the forward direction and the homogeneous transformation matrix H_{s,s+1} to the homogeneous transformation matrix calculation unit 211 in Step S323.

In Step S325, the proration vector calculation unit 222 acquires the weight Gₛ in accordance with the angle φₛ based on the homogeneous transformation matrix H_{s,s+1}.

Specifically, the proration vector calculation unit 222 calculates the weight Gₛ (where s=1 to N) by acquiring the angle φₛ which satisfies Equation (65) based on the homogeneous transformation matrix H_{s,s+1} and further calculating Equation (67) by using the acquired angle φₛ.

In Step S326, the rotation angle calculation unit 221 acquires the rotation angle θₛ and the vector (Aₛ, Bₛ, Cₛ) based on the homogeneous transformation matrix H⁺_{1,s} and the homogeneous transformation matrix H⁻_{1,s}.

That is, the rotation angle calculation unit 221 calculates Equation (88) and Equation (89), and further, acquires the angle θₛ and the vector (Aₛ, Bₛ, Cₛ) (where s=2 to N) which satisfy Equation (91) by using the calculation result. In addition, the angle θₛ is equal to or greater than 0° and equal to or less than 180°.

In Step S327, the proration vector calculation unit 222 performs calculation of Equation (98) based on the weight Gₛ, the vector represented by Equation (88), the rotation angle θₛ, and the vector (Aₛ, Bₛ, Cₛ) and acquires the vector by prorating the vectors represented by Equation (88) and Equation (89). Here, s=2 to N.

In Step S328, the rotation angle calculation unit 223 acquires the rotation angle ψₛ (where s=2 to N) which satisfies Equation (99) based on the homogeneous transformation matrix H⁺_{1,s}, the homogeneous transformation matrix H⁻_{1,s}, the weight Gₛ, the rotation angle θₛ, the vector (Aₛ, Bₛ, Cₛ), and the vector of Equation (92). In addition, the angle ψₛ is equal to or greater than −180° and less than 180°.

In Step S329, the homogeneous transformation matrix calculation unit 211 calculates the optimized homogeneous transformation matrix H^{±}_{1,s} (where s=2 to N) and supplies the optimized homogeneous transformation matrix H^{±}_{1,s} to the panoramic image generation unit 116.

That is, the homogeneous transformation matrix calculation unit 211 performs calculation of Equation (100) and Equation (101) based on the homogeneous transformation matrix H⁺_{1,s}, the weight Gₛ, the rotation angle θₛ, the vector (Aₛ, Bₛ, Cₛ), the vector of Equation (98), and the rotation angle ψₛ. Then, the homogeneous transformation matrix calculation unit 211 acquires the 3×3 matrix represented by Equation (63) by using the values of the vectors represented by Equation (98), Equation (100), and Equation (101) and regards the 3×3 matrix as the optimized homogeneous transformation matrix H^{±}_{1,s}.

If the optimized homogeneous transformation matrix H^{±}_{1,s} is acquired, then the processing in Step S330 and Step S331 is performed, and the panoramic image generation processing is completed. However, since the processing is the same as the processing in Step S289 and Step S290 in FIG. 36, the description thereof will be omitted.

It is possible to acquire a panoramic image with higher quality by allocating the errors corresponding to the appropriate weight Gₛ determined by the angle between the imaging directions of the respective captured images to the positional relationships between the respective captured images as described above.

As described above, the direction (s⁺ direction) acquired by accumulating the homogeneous transformation matrixes H_{s,s+1} in the forward direction and the direction (s⁻ direction) acquired by accumulating the homogeneous transformation matrixes H_{s,s+1} in the backward direction are acquired in the third embodiment to the fifth embodiment and the modification examples thereof. Then, a direction acquired by prorating the above two directions is regarded as the optimized direction of the s-th captured image that it is desirable to finally acquire.

With such processing, it is not necessary to solve the non-linear problem for minimizing Equation (51) unlike in the related art, and it is possible to quickly acquire the homogeneous transformation matrix which represents the positional relationship between the first and the s-th captured images with a smaller processing amount.

[Compromise Plan between Three Freedom Levels and Eight Freedom Levels]

### Sixth Embodiment

### Concerning Panoramic Image

In addition, when a homogeneous transformation matrix to be used in generating a panoramic image is acquired, a homogeneous transformation matrix which further reduces a failure in the panoramic image may be acquired.

For example, it is possible to generate a panoramic image by editing a plurality of captured images which are captured and acquired by an imaging device such as a digital camera being rotated (panned) in various directions. That is, it is possible to generate a wide panoramic image by connecting the first to the N-th captured images, namely the total of N captured images.

First, a positional relationship between mutually adjacent captured images, namely between the s-th and the s+1-th captured images (where s=1 to N−1), for example, is acquired when the panoramic image is generated.

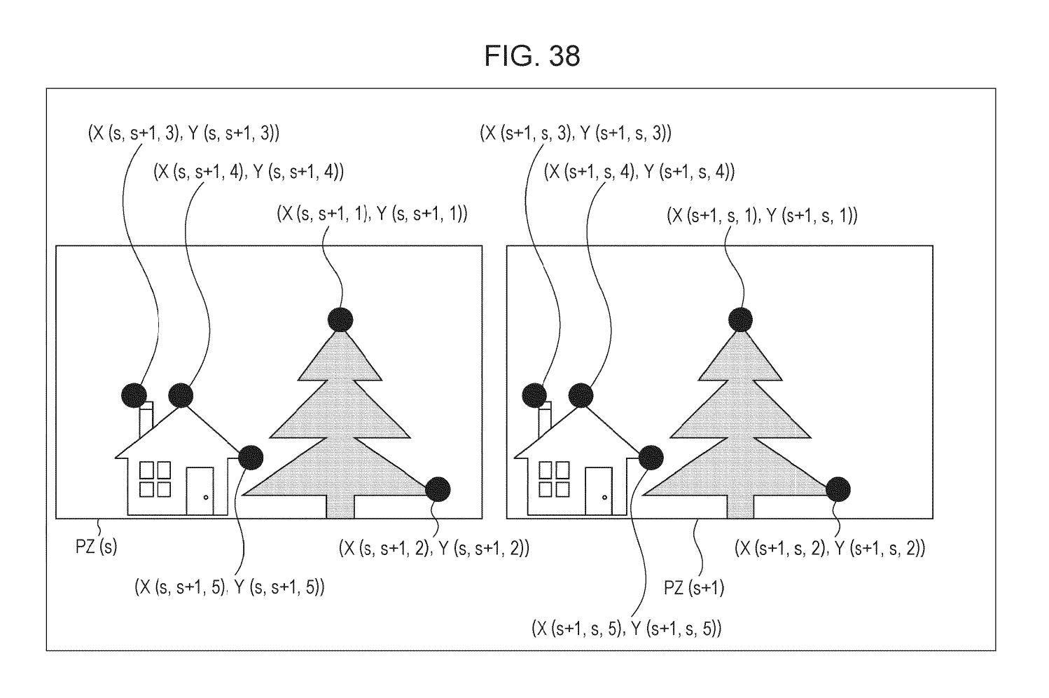

Specifically, a position onto which the same object as a projected image in the s-th captured image PZ(s) is searched for in the s+1-th captured image PZ(s+1) as shown in FIG. 38, for example. Such processing of searching for the corresponding position is called image matching processing.

In FIG. 38, a tip end part of a tree as an object is projected to a position (X(s, s+1, 1), Y(s, s+1, 1)) on the s-th captured image PZ(s) and is also projected to a position (X(s+1, s, 1), Y(s+1, s, 1) on the s+1-th captured image PZ(s+1).

Similarly, another part of the object is projected to a position (X(s, s+1, k), Y(s, s+1, k)) on the s-th captured image PZ(s) and a position (X(s+1, s, k), Y(s+1, s, k)) on the s+1-th captured image PZ(s+1) (k=2 to 5).

If the correspondence relationships of the respective positions on the captured images are acquired as described above, a positional relationship between the adjacent captured images, namely between the s-th and the s+1-th captured images is acquired.

That is, a scalar value H_{s,s+1(i,j)} which satisfies the following Equation (102) is acquired for arbitrary k (k=1 to 5 in FIG. 38). Here, i=1 to 3, and j=1 to 3.

$$\begin{matrix}[ Math . 102 ] & \\ \begin{matrix}\frac{X ( s , s + 1 , k )}{f} = \frac{\begin{matrix}{H}_{s , s + 1 ( 1 , 1 )} X ( s + 1 , s , k ) + \\ {H}_{s , s + 1 ( 1 , 2 )} Y ( s + 1 , s , k ) + {H}_{s , s + 1 ( 1 , 3 )} f\end{matrix}}{\begin{matrix}{H}_{s , s + 1 ( 3 , 1 )} X ( s + 1 , s , k ) + \\ {H}_{s , s + 1 ( 3 , 2 )} Y ( s + 1 , s , k ) + {H}_{s , s + 1 ( 3 , 3 )} f\end{matrix}} \\ \frac{Y ( s , s + 1 , k )}{f} = \frac{\begin{matrix}{H}_{s , s + 1 ( 2 , 1 )} X ( s + 1 , s , k ) + \\ {H}_{s , s + 1 ( 2 , 2 )} Y ( s + 1 , s , k ) + {H}_{s , s + 1 ( 2 , 3 )} f\end{matrix}}{\begin{matrix}{H}_{s , s + 1 ( 3 , 1 )} X ( s + 1 , s , k ) + \\ {H}_{s , s + 1 ( 3 , 2 )} Y ( s + 1 , s , k ) + {H}_{s , s + 1 ( 3 , 3 )} f\end{matrix}}\end{matrix} \} & ( 102 )\end{matrix}$$

In Equation (102), f represents a focal distance of a lens of the imaging device which captures the captured images. In addition, it is assumed that focal distances f of the lens for the respective first to N-th captured images are the same value. That is, it is assumed that the focal distance f of the lens is always a constant value.

Incidentally, a parallax problem caused because the imaging device such as a digital camera cannot be rotated correctly about an optical axis center, distortion of the captured images due to distortion of the lens, an error caused by noise in the captured images, and the like are present in practice. For this reason, there is no case where Equation (102) is satisfied for all k.

Thus, an optimal value is acquired by a least squares method in actual processing. That is, a scalar value H_{s,s+1(i,j)} which minimize the following Equation (103) is acquired. Here, i=1 to 3, and j=1 to 3. In addition, f in Equation (103) represents a focal distance of the lens of the imaging device.

$$\begin{matrix}[ Math . 103 ] & \\ \begin{matrix}{\sum }_{k}^{ } {\{ \frac{X ( s , s + 1 , k )}{f} - \frac{\begin{matrix}{H}_{s , s + 1 ( 1 , 1 )} X ( s + 1 , s , k ) + \\ {H}_{s , s + 1 ( 1 , 2 )} Y ( s + 1 , s , k ) + \\ {H}_{s , s + 1 ( 1 , 3 )} f\end{matrix}}{\begin{matrix}{H}_{s , s + 1 ( 3 , 1 )} X ( s + 1 , s , k ) + \\ {H}_{s , s + 1 ( 3 , 2 )} Y ( s + 1 , s , k ) + \\ {H}_{s , s + 1 ( 3 , 3 )} f\end{matrix}} \}}^{2} + \\ {\sum }_{k}^{ } {\{ \frac{Y ( s , s + 1 , k )}{f} - \frac{\begin{matrix}{H}_{s , s + 1 ( 2 , 1 )} X ( s + 1 , s , k ) + \\ {H}_{s , s + 1 ( 2 , 2 )} Y ( s + 1 , s , k ) + \\ {H}_{s , s + 1 ( 2 , 3 )} f\end{matrix}}{\begin{matrix}{H}_{s , s + 1 ( 3 , 1 )} X ( s + 1 , s , k ) + \\ {H}_{s , s + 1 ( 3 , 2 )} Y ( s + 1 , s , k ) + \\ {H}_{s , s + 1 ( 3 , 3 )} f\end{matrix}} \}}^{2}\end{matrix} & ( 103 )\end{matrix}$$

As described above, the positional relationships between the s-th and the s+1-th captured images are acquired for all s (where s=1 to N−1).

In addition, the scalar value H_{s,s+1(I,j)} acquired for each s has uncertainty in a constant factor. Thus, the uncertainty is excluded by applying a condition represented by the following Equation (104).

[Math. 104]

[H_{s,s+1(3,1)}]²+[H_{s,s+1(3,2)}]²+[H_{s,s+1(3,3)}]²=1 (104)

Incidentally, the 3×3 matrix H_{s,s+1} represented by the following Equation (105) is generally called a homogeneous transformation matrix (homography), and Equation (102) becomes the same value as the following Equation (106), for example, by introducing such a matrix. In addition, since a formula in relation to the matrix can be used, the idea of the homogeneous transformation matrix is a significantly useful means for dealing with this type of problem.

$$\begin{matrix}[ Math . 105 ] & \\ {H}_{s , s + 1} ≡ [ \begin{matrix}{H}_{s , s + 1 ( 1 , 1 )} & {H}_{s , s + 1 ( 2 , 1 )} & {H}_{s , s + 1 ( 3 , 1 )} \\ {H}_{s , s + 1 ( 1 , 2 )} & {H}_{s , s + 1 ( 2 , 2 )} & {H}_{s , s + 1 ( 3 , 2 )} \\ {H}_{s , s + 1 ( 1 , 3 )} & {H}_{s , s + 1 ( 2 , 3 )} & {H}_{s , s + 1 ( 3 , 3 )}\end{matrix} ] & ( 105 ) \\ [ Math . 106 ] & \\ [ \begin{matrix}X ( s , s + 1 , k ) \\ Y ( s , s + 1 , k ) \\ f\end{matrix} ] ∝ {H}_{s , s + 1} [ \begin{matrix}X ( s + 1 , s , k ) \\ Y ( s + 1 , s , k ) \\ f\end{matrix} ] & ( 106 )\end{matrix}$$

If the images are captured while the imaging device is rotated substantially about the optical axis center, the matrix represented by Equation (105) approximately becomes an orthogonal matrix.

Accordingly, acquisition of the scalar value H_{s,s+1(i,j)} for minimizing Equation (103) by applying a condition that Equation (105) is an orthogonal matrix can also be considered.

If the above descriptions are summarized, the following two solutions, namely Solution 1 and Solution 2 can be considered as solutions for acquiring positional relationships between adjacent captured images.

### (Solution 1 of Acquiring Positional Relationship Between Captured Images)

The s-th and the s+1-th captured images are analyzed, and a corresponding positional relationship between (X(s,s+1,k), Y(s,s+1,k)) and (X(s+1,s,k), Y(s+1,s,k)) is acquired.

Then, the scalar value H_{s,s+1 (i,j)} which minimizes Equation (103) is acquired under a condition that Equation (104) is satisfied. The processing is performed for all s (where s=1 to N−1).

(Solution 2 of Acquiring Positional Relationship between Captured Images)

The s-th and the s+1-th captured images are analyzed, and a corresponding positional relationship between (X(s,s+1,k), Y(s,s+1,k)) and (X(s+1,s,k), Y(s+1,s,k)) is acquired.

Then, the scalar value H_{s,s+1(i,j)} which minimizes Equation (103) is acquired under conditions that Equation (104) is satisfied and that Equation (105) is an orthogonal matrix. The processing is performed for all s (where s=1 to N−1).

As the solutions for acquiring the positional relationship between the adjacent captured images, the aforementioned two solutions, namely Solution 1 and Solution 2 can be considered.

If the scalar value H_{s,s+1(i,j)} as the positional relationship between the adjacent captured images is acquired by any one of the aforementioned two solutions, then positional relationships of the respective captured images with reference to the first captured image are acquired.

That is, each element H_{1,s(i,j)} in the 3x3 homogeneous transformation matrix H_{1,s} is acquired (where s=2 to N, i=1 to 3, and j=1 to 3) by accumulating the homogeneous transformation matrixes H_{s,s+1} as represented by the following Equation (107).

$$\begin{matrix}[ Math . 107 ] & \\ \begin{matrix}{H}_{1 , s} ≡ [ \begin{matrix}{H}_{1 , s ( 1 , 1 )} & {H}_{1 , s ( 2 , 1 )} & {H}_{1 , s ( 3 , 1 )} \\ {H}_{1 , s ( 1 , 2 )} & {H}_{1 , s ( 2 , 2 )} & {H}_{1 , s ( 3 , 2 )} \\ {H}_{1 , s ( 1 , 3 )} & {H}_{1 , s ( 2 , 3 )} & {H}_{1 , s ( 3 , 3 )}\end{matrix} ] \\ ≡ ( {\prod }_{t = 1}^{s - 1} {H}_{t , t + 1} ) \\ = {H}_{1 , 2} {H}_{2 , 3} … {H}_{s - 2 , s - 1} {H}_{s - 1 , s}\end{matrix} & ( 107 )\end{matrix}$$

Finally, a pixel value of a pixel at each position (Xₛ, Yₛ) in each captured image is mapped on a position in the first captured image, which is represented by the following Equation (108). With such processing, it is possible to acquire a panoramic image. In addition, the pixel value of the pixel in each captured image is generally a value from 0 to 255 when the captured image is a monochrome image, and is a value expressing three primary colors, namely red, green, and blue by 0 to 255 when the captured image is a color image.

$$\begin{matrix}[ Math . 108 ] & \\ ( \begin{matrix}f \times \frac{{H}_{1 , s ( 1 , 1 )} {X}_{s} + {H}_{1 , s ( 1 , 2 )} {Y}_{s} + {H}_{1 , s ( 1 , 3 )} f}{{H}_{1 , s ( 3 , 1 )} {X}_{s} + {H}_{1 , s ( 3 , 2 )} {Y}_{s} + {H}_{1 , s ( 3 , 3 )} f} , \\ f \times \frac{{H}_{1 , s ( 2 , 1 )} {X}_{s} + {H}_{1 , s ( 2 , 2 )} {Y}_{s} + {H}_{1 , s ( 2 , 3 )} f}{{H}_{1 , s ( 3 , 1 )} {X}_{s} + {H}_{1 , s ( 3 , 2 )} {Y}_{s} + {H}_{1 , s ( 3 , 3 )} f}\end{matrix} ) & ( 108 )\end{matrix}$$

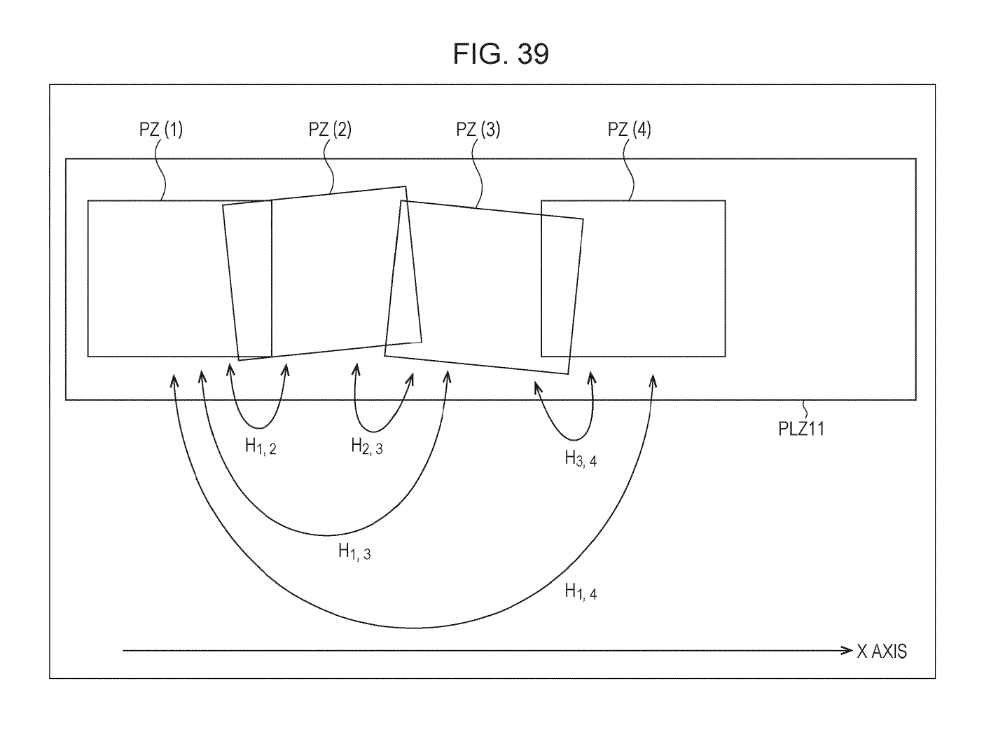

If the first captured image PZ(1) to the fourth captured image PZ(4) are mapped as shown in FIG. 39, for example, a single panoramic image PLZ11 is acquired.

In FIG. 39, the horizontal direction in the drawing represents the X-axis direction of the coordinate system with reference to the first captured image. In FIG. 39, the drawing of the fifth captured image and the following captured images is omitted. Furthermore, the respective captured images are captured while the imaging device is panned in the right direction (the positive direction of the X axis) in the drawing in this example.

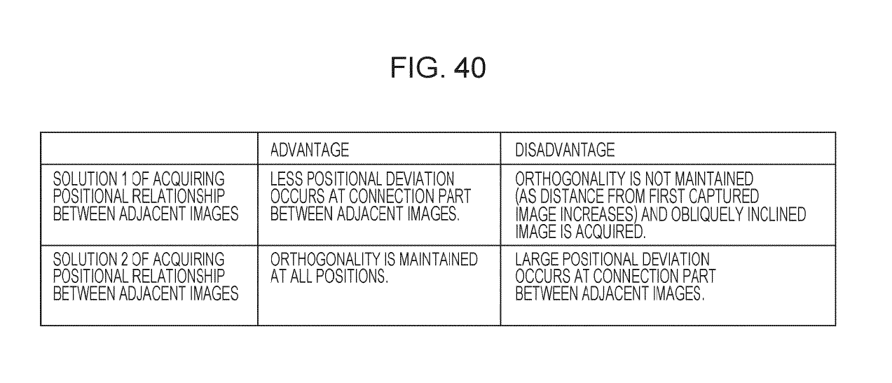

Incidentally, aforementioned Solution 1 and Solution 2 of acquiring positional relationships between the adjacent captured images have advantages and disadvantages shown in FIG. 40, respectively.

(Advantage of Solution 1 of Acquiring Positional Relationship between Captured Images)

Solution 1 of acquiring a positional relationship between the captured images has advantages that there are less restriction conditions than those of Solution 2 of acquiring a positional relationship between the captured images when the scalar value H_{s,s+1(i,j)} is acquired and that it is possible to acquire a positional relationship between the adjacent captured images including less errors.

That is, it is possible to cause the corresponding positional relationship between (X(s,s+1,k), Y(s,s+1,k)) and (X(s+1,s,k), Y(s+1,s,k)) to substantially reliably satisfy Equation (102). This means that there is substantially no positional deviation between the adjacent captured images when the panoramic image is generated by mapping the pixel value of the pixel at each position (Xₛ, Yₛ) in each captured image on the position in the first captured image, which is represented by Equation (108).

(Disadvantage of Solution 1 of Acquiring Positional Relationship between Captured Images)

Since there are no conditions in which the matrix represented by Equation (105) is an orthogonal matrix in Solution 1 of acquiring a positional relationship between the captured images, the 3x3 homogeneous transformation matrix H_{s,s+1} of Equation (105), which is configured by the acquired scalar value H_{s,s+1(i,j)}, is not necessarily an orthogonal matrix.

The matrix represented by Equation (105) is a homogeneous transformation matrix, and is a transformation matrix which transforms coordinates on the s+1-th captured image into coordinates on the s-th captured image. If the transformation matrix is not an orthogonal matrix, two straight lines which are orthogonal on the s+1-th captured image are not orthogonal on the s-th captured image.

Accordingly, Solution 1 of acquiring a positional relationship between the captured images has a disadvantage that a rectangle (a building as an artificial object, for example) projected onto the s+1-th captured image appears as a parallelogram when transformed onto the s-th captured image, that is, the building is obliquely inclined.

It is a matter of course that the images are captured while the imaging device is rotated substantially about the optical axis center, and the homogeneous transformation matrix H_{s,s+1} (the positional relationship between the s-th and the s+1-th captured images) represented by Equation (105) inevitably becomes substantially an orthogonal matrix if the solution which minimize Equation (103) is acquired. Accordingly, even if the building on the captured image is obliquely inclined as described above, the inclination is minute inclination that humans can rarely sense.

However, it is necessary to acquire the positional relationship of the s-th captured image with reference to the first captured image in order to generate the panoramic image in practice. That is, it is necessary to accumulate the homogeneous transformation matrixes H_{s,s+1} which are positional relationships between the adjacent captured images as represented by Equation (107).

Therefore, although the inclination is minute inclination and is ignorably minute in the positional relationship between the adjacent two captured images, which is represented by Equation (105), the minute inclination is also accumulated while Equation (107) is calculated, and inclination becomes unignorable.

In other words, when the value of s in Equation (107) is small, the problem in that the rectangle on the captured image appears as a parallelogram, that is, the problem in that the building is obliquely inclined is ignorable. However, the problem in that the rectangle on the captured image appears as a parallelogram (the building is obliquely inclined) becomes pronounced as the value of s increases.

For this reason, orthogonality is maintained and the building is not obliquely inclined in the vicinity of the first captured image in the finally acquired panoramic image. However, the building is obliquely inclined and an unnatural image is acquired at a position distant from the first captured image.

(Advantage of Solution 2 of Acquiring Positional Relationship between Captured Images)

Since Solution 2 of acquiring a positional relationship between the captured images has a condition that the homogeneous transformation matrix H_{s,s+1} represented by Equation (105) is an orthogonal matrix, the accumulated homogeneous transformation matrixes H_{1,s} (the positional relationship of the s-th captured image with reference to the first captured image) represented by Equation (107) is also an orthogonal matrix.

Accordingly, Solution 2 of acquiring a positional relationship between the captured images has an advantage that an unnatural image, such as an image in which a building or the like on the captured image is obliquely inclined, is not acquired.

(Disadvantage of Solution 2 of Acquiring Positional Relationship between Captured Images)

Solution 2 of acquiring a positional relationship between the captured images has more restriction conditions than those of Solution 1 of acquiring a positional relationship between the adjacent captured images when the scalar value H_{s,s+1(i,j)} is acquired. Specifically, there is a condition that the homogeneous transformation matrix H_{s,s+1} represented by Equation (105) is required to be an orthogonal matrix.

Since the scalar value H_{s,s+1(i,j)} minimizing Equation (103) within a range in which the condition is satisfied is acquired for this reason, Solution 2 of acquiring a positional relationship between the captured images has a disadvantage that a positional relationship between the captured images including more errors than those in Solution 1 of acquiring a positional relationship between captured images is acquired. That is, according to Solution 2 of acquiring a positional relationship between the captured images, it is not possible to state that the corresponding positional relationship between (X(s,s+1,k), Y(s,s+1,k)) and (X(s+1,s,k), Y(s+1,s,k)) satisfies Equation (102) as compared with Solution 1 of acquiring a positional relationship between the captured images.

This means that positional deviation between the adjacent captured images increases when the panoramic image is created by mapping the pixel value of the pixel at each position (Xₛ, Yₛ) in each captured image at a position on the first captured image, which is represented by Equation (108).

### [Concerning Gain Adjustment in Captured Images]

Next, description will be given of gain adjustment in each captured image when the panoramic image is generated.

It is assumed that a plurality of, for example, N captured images are captured while the imaging device such as a digital camera is moved in the horizontal direction (X-axis direction).

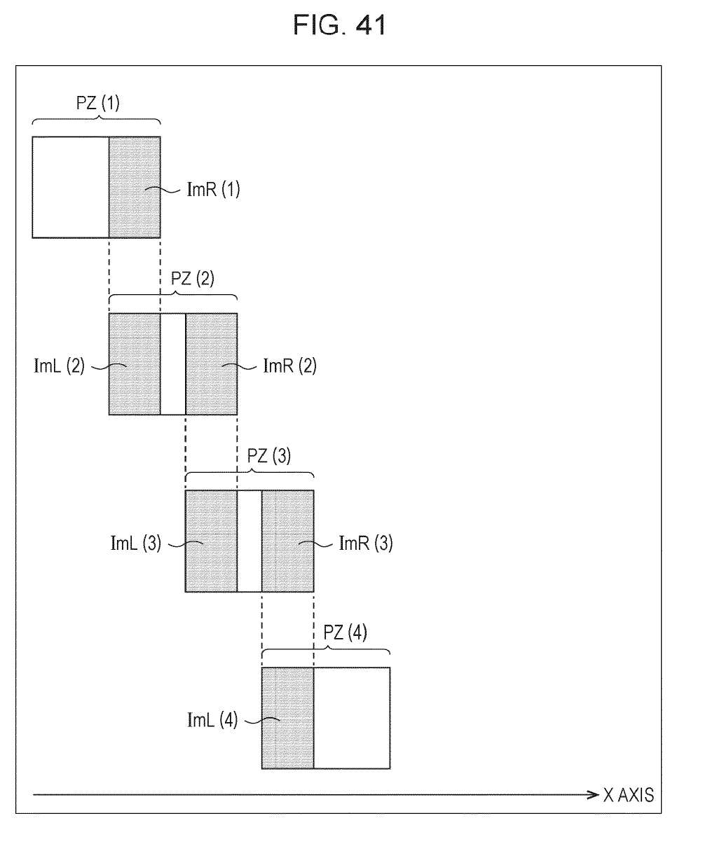

In addition, it is assumed that these captured images are captured such that projected images thereon have exactly 20% overlapping parts as shown in FIG. 41. In FIG. 41, the horizontal direction of the drawing represents the X-axis direction which is a moving direction of the imaging device. In FIG. 41, only the first captured image PZ(1) to the fourth captured image PZ(4) are illustrated, and illustration of the remaining fifth to N-th captured images is omitted.

In the example of FIG. 41, the same object is projected to a 20% region ImR(K) in the k-th captured image PZ(k) on the right side in the drawing and a 20% region ImL(k+1) in the k+1-th captured image PZ(k+1) on the left side. Here, k=1 to N−1.

In addition, since the region ImR(k) and the region ImL(k+1) in FIG. 41 are illustrated in an emphasized manner, the region ImR(k) and the region ImL(k+1) are illustrated to be larger than actual areas, and the areas of the regions correspond to the sizes of 20% of the areas of the captured images in practice.

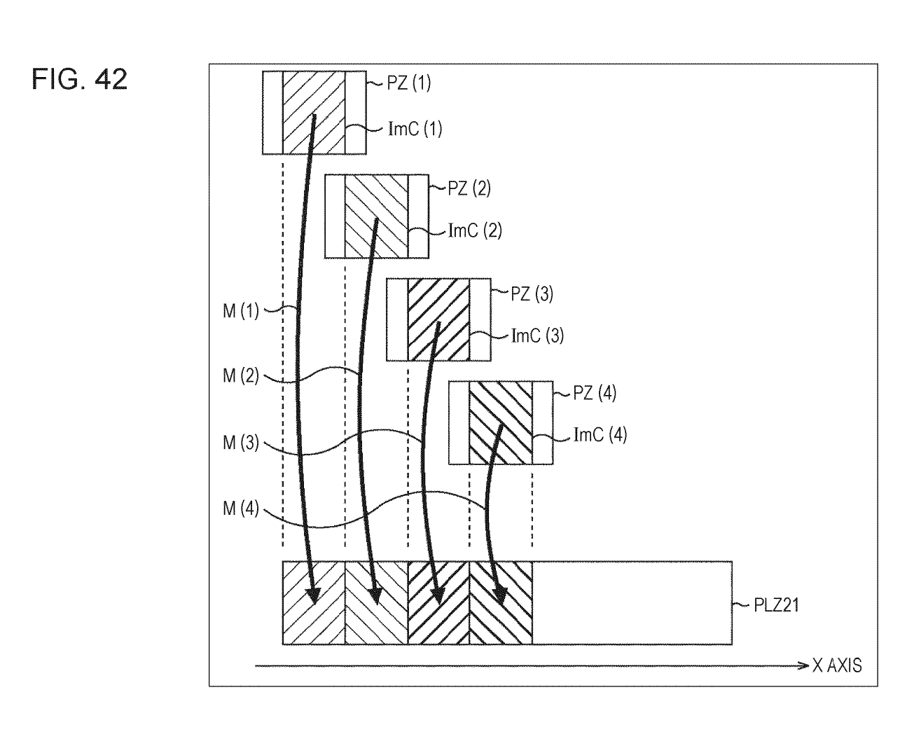

From the N captured images captured as described above, it is possible to acquire the panoramic image PLZ21 by the mapping of the respective regions in the captured images as shown in FIG. 42.

In FIG. 42, only the first captured image PZ(1) to the fourth captured image PZ(4) are illustrated, and illustration of the remaining fifth to N-th captured images is omitted. In FIG. 42, the horizontal direction of the drawing represents the X-axis direction.

Mutually adjacent captured images have overlapping regions which correspond to 20% of the entire regions of the captured images, namely regions where the same object is projected.

Thus, parts with areas of 10% of the entire areas of the captured images, which are at both ends of the captured images, are ignored, and the remaining regions with areas of 80% are used to generate the panoramic image PLZ21. That is, regions ImC(k) (where k=1 to N) at the centers of the respective captured image PZ(k) are connected to each other, and the panoramic image PLZ21 is generated.

In FIG. 42, processing of cutting the region ImC(k) with the size of 80% of the entire area, which is at the center of the k-th captured image PZ(k), and attaching the region ImC(k) to the panoramic image PLZ21 is represented as M(k).

Incidentally, if imaging is performed by employing so-called automatic exposure when the respective images are captured, EV values (Exposure Values) which represent the exposure of the respective captured images are not necessarily constant. For this reason, it is necessary to adjust brightness in the region ImC(k) when the processing M(k) of attaching the region ImC(k) on the k-th captured image PZ(k) is performed. That is, it is necessary to perform gain adjustment.

In order to do this, it is necessary to acquire a gain amount first. That is, an average of pixel values of pixels in the region ImR(k) is compared with an average of pixel values of pixels in the region ImL(k+1), and a gain value between the k-th and the k+1-th captured images is determined.

Specifically, the following Equation (109) or the following Equation (110) is calculated to acquire a gain value Gain_{k,k+1}(R), a gain value Gain_{k,k+1}(G), and a gain value Gain_{k,k+1}(B).

$$\begin{matrix}[ Math . 109 ] & \\ \begin{matrix}\begin{matrix} \\ {Gain}_{k , k + 1} ( R ) = \frac{{\sum }_{( x , y ) ∈ ImR ( k )}^{ } \{ {R}_{k} ( x , y ) \}}{{\sum }_{( x , y ) ∈ ImL ( k + 1 )}^{ } \{ {R}_{k + 1} ( x , y ) \}}\end{matrix} \\ {Gain}_{k , k + 1} ( G ) = \frac{{\sum }_{( x , y ) ∈ ImR ( k )}^{ } \{ {G}_{k} ( x , y ) \}}{{\sum }_{( x , y ) ∈ ImL ( k + 1 )}^{ } \{ {G}_{k + 1} ( x , y ) \}} \\ {Gain}_{k , k + 1} ( B ) = \frac{{\sum }_{( x , y ) ∈ ImR ( k )}^{ } \{ {B}_{k} ( x , y ) \}}{{\sum }_{( x , y ) ∈ ImL ( k + 1 )}^{ } \{ {B}_{k + 1} ( x , y ) \}}\end{matrix} \} & ( 109 ) \\ [ Math . 110 ] & \\ \begin{matrix}\begin{matrix}{Gain}_{k , k + 1} ( R ) = \frac{{\sum }_{( x , y ) ∈ ImR ( k )}^{ } \{ \frac{\begin{matrix}{R}_{k} ( x , y ) + {G}_{k} ( x , y ) + \\ {B}_{k} ( x , y )\end{matrix}}{3} \}}{{\sum }_{( x , y ) ∈ ImL ( k + 1 )}^{ } \{ \frac{\begin{matrix}{R}_{k + 1} ( x , y ) + {G}_{k + 1} ( x , y ) + \\ {B}_{k + 1} ( x , y )\end{matrix}}{3} \}} \\ {Gain}_{k , k + 1} ( G ) = {Gain}_{k , k + 1} ( R )\end{matrix} \\ {Gain}_{k , k + 1} ( B ) = {Gain}_{k , k + 1} ( R )\end{matrix} \} & ( 110 )\end{matrix}$$

In Equation (109) and Equation (110), Rₛ(x, y), Gₛ(x, y), and Bₛ(x, y) represent pixel values of a red component, a green component, and a blue component at a pixel position (x, y) in the s-th captured image.

In addition, the gain value Gain_{k,k+1}(R), the gain value Gain_{k,k+1}(G), and the gain value Gain_{k,k+1}(B) are a gain value of the red component, a gain value of the green component, and a gain value of the blue component between the k-th and the k+1-th captured images, respectively.

As described above, the gain values between the k-th and the k+1-th captured images are acquired for all k (where k=1 to N−1). In addition, a difference between acquisition of the respective gains by Equation (109) and acquisition of the respective gains by Equation (110) will be described later.

Incidentally, if the gain value Gain_{k,k+1}(R), the gain value Gain_{k,k+1}(G), and the gain value Gain_{k,k+1}(B) between the adjacent captured images are acquired by any one of the two solutions, namely Solution 1 of acquiring gain values by Equation (109) and Solution 2 of acquiring gain values by Equation (110), then the gain values of the respective captured images with reference to the first captured image are acquired.

That is, the gain value Gain_{1,s}(R), the gain value Gain_{1,s}(G), and the gain value Gain_{1,s}(B) (where s=2 to N) are acquired by accumulating the gain values as represented by the following Equation (111).

$$\begin{matrix} [ Math . 111 ] & \\ \begin{matrix}\begin{matrix}\begin{matrix}{Gain}_{1 , s} ( R ) ≡ ( {\prod }_{t = 1}^{s - 1} {Gain}_{t , t + 1} ( R ) ) \\ = {Gain}_{1 , 2} ( R ) {Gain}_{2 , 3} ( R ) … {Gain}_{s - 2 , s - 1} ( R ) {Gain}_{s - 1 , s} ( R )\end{matrix} \\ \begin{matrix}{Gain}_{1 , s} ( G ) ≡ ( {\prod }_{t = 1}^{s - 1} {Gain}_{t , t + 1} ( G ) ) \\ = {Gain}_{1 , 2} ( G ) {Gain}_{2 , 3} ( G ) … {Gain}_{s - 2 , s - 1} ( G ) {Gain}_{s - 1 , s} ( G )\end{matrix}\end{matrix} \\ \begin{matrix}{Gain}_{1 , s} ( B ) ≡ ( {\prod }_{t = 1}^{s - 1} {Gain}_{t , t + 1} ( B ) ) \\ = {Gain}_{1 , 2} ( B ) {Gain}_{2 , 3} ( B ) … {Gain}_{s - 2 , s - 1} ( B ) {Gain}_{s - 1 , s} ( B )\end{matrix}\end{matrix} & ( 111 )\end{matrix}$$

In addition, the gain value Gain_{1,s}(R), the gain value Gain_{1,s}(G), and the gain value Gain_{1,s}(B) are a gain value of the red component, a gain value of the green component, and a gain value of the blue component in the s-th captured image with reference to the first captured image, respectively.

If the gain values of the respective captured images with reference to the first captured image are acquired as described above, the red components at all the pixel positions in the region ImC(s) in the captured images are multiplied by the gain value Gain_{1,s}(R) when the respective processing M(s) in FIG. 42 is performed in practice. In addition, the green components at all the pixel positions in the region ImC(s) in the captured images are multiplied by Gain_{1,s}(G) and the blue components at all the pixel positions in the region ImC(s) in the captured images are multiplied by Gain_{1,s}(B) during execution of the processing M(s), and the acquired pixel values of the respective pixels are attached to the panoramic image.

Here, s=1 to N. In addition, it is assumed that the gain values Gain_{1,s}(R)=Gain_{1,s}(G)=Gain_{1,s}(B)=1 when s=1.

It is possible to acquire a panoramic image in which the respective colors have correct brightness by generating the panoramic image as described above. In addition, if such gain adjustment is not performed, a level difference in brightness occurs in the acquired panoramic image at a part between adjacent captured images.

Now the difference between the two solutions, namely Solution 1 of acquiring the gain values between captured images by Equation (109) and Solution 2 of acquiring the gain values between the captured images by Equation (110) will be described.

(Concerning Solution 1 of Acquiring Gain Values between Captured Images by Equation (109))

According to Solution 1 using Equation (109), the gain values of the respective colors are independently calculated. Then, the gain values of the respective colors are calculated by using the values of the components of the corresponding respective colors (red, blue, and green).

For example, the gain value Gain_{k,k+1}(R) is acquired by dividing a sum ΣRₖ(x,y) of the red components (pixel values) of the respective pixels in the region ImR(k) by a sum ΣRₖ₊₁(x,y) of the red components (pixel values) of the respective pixels in the region ImL(k+1).

Now, if images with brightness which is completely proportional to the amount of light beams of the respective colors which are input to the imaging device can be acquired as captured images, a ratio of the EV value of the k-th captured image to the EV value of the k+1-th captured image and the gain value between the adjacent captured images completely coincide.

That is, three values, namely the gain value Gain_{k,k+1}(R), the gain value Gain_{k,k+1}(G), and the gain value Gain_{k,k+1}(B) calculated by Equation (109) completely coincide, and the value thereof is the ratio of the EV value of the k-th captured image to the EV value of the k+1-th captured image.

However, since humans generally prefer a clear color tone, processing of emphasizing saturation is performed while the imaging device captures the images, and the results thereof appear in the captured images. Since the saturation emphasis is non-linear processing, the ratio of the EV value of the k-th captured image to the EV value of the k+1-th captured image and the gain value between the adjacent captured images do not coincide precisely. That is, the three values, namely the gain value Gain_{k,k+1}(R), the gain value Gain_{k,k+1}(G), and the gain value Gain_{k,k+1}(B) calculated by Equation (109) are different values.

(Concerning Solution 2 of Acquiring Gain Values between Captured Images by Equation (110))

In contrast, the gain values of the respective colors are not independent in Solution 2 using Equation (110), and these gain values are the same values regardless of the colors. In addition, the gain values of the respective colors are calculated by using an average value of the pixel values of the respective color components, namely the red, blue, and green components. In other words, the gain value between the adjacent captured images is acquired under a condition that the gain values of the respective colors are not independent and are the same values regardless of the colors.

Specifically, average values of the red, green, and blue color components of the pixels are acquired for the respective pixels in the region ImR(k), and the sum of the average values of the color components acquired for the respective pixels are acquired when the gain value is calculated. Moreover, average values of the red, green, and blue color components of the pixels are acquired for the respective pixels in the region ImL(k+1), and the sum of the average values of the color components acquired for the respective pixels is acquired. Then, the sum of the average values of the color components acquired for the region ImR(k) is divided by the sum of the average values of the color components acquired for the region ImL(k+1), and the gain value Gain_{k,k+1}(R), the gain value Gain_{k,k+1}(G), and the gain value Gain_{k,k+1}(B) are acquired.

As described above, the gain values of the respective colors between the respective captured images do not coincide precisely with the ratio of the EV values of the respective captured images due to the non-linear processing such as saturation emphasis in the imaging devices.

When the red gain value Gain_{k,k+1}(R) between adjacent captured images is acquired under such a circumstance, a level difference of the red components is less noticeable at the boundary between the adjacent captured images on the panoramic image in the case of Solution 1 (solution by Equation (109)) using only the pixel values of the red components while ignoring the green and blue components. The same is true to the other colors as well as the red color.

In contrast, if the three values, namely the gain value Gain_{k,k+1}(R), the gain value Gain_{k,k+1}(G), and the gain value Gain_{k,k+1}(B) are independently acquired, these three values do not become the same values. Accordingly, it is a matter of course that the gain values of the respective color components in the s-th captured image with reference to the first captured image, namely the gain value Gain_{1,s}(R), the gain value Gain_{1,s}(G), and the gain value Gain_{1,s}(B) acquired by the calculation of Equation (111) do not become the same values.

For this reason, a color phase (hue) at a part corresponding to the region ImC(s) differs from a color phase of the s-th captured image due to the processing M(s) when the panoramic image is generated. That is, an image with inappropriate white balance is acquired.

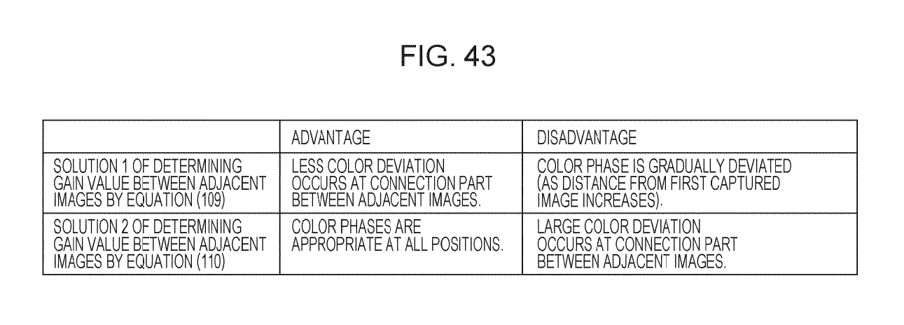

Next, description will be given of advantages and disadvantages of the aforementioned two solutions of acquiring the gain values between the captured images with reference to FIG. 43.

(Advantage of Solution 1 of Acquiring Gain Values between Captured Images by Equation (109))

An advantage of Solution 1 of acquiring the gain values between the captured images by Equation (109) is that level differences of the respective color components, namely the red, blue, and green components are less noticeable at the boundary between the adjacent captured images on the generated panoramic image as shown in FIG. 43.

(Disadvantage of Solution 1 of Acquiring Gain Values between Captured Images by Equation (109))

In contrast, a disadvantage of Solution 1 of acquiring the gain values between the captured images by Equation (109) is that the number of gain values to be accumulated increases in Equation (111) as the value of s increases.

In the calculation of Equation (111), the gain value Gain_{1,s}(R), the gain value Gain_{1,s}(G), and the gain value Gain_{1,s}(B) do not coincide and increasingly diverge as the value of s increases.

Accordingly, although the color phases are appropriate or only deviations which cannot be sensed by humans occur in the vicinity of the first captured image, the color phases are inappropriate at positions distant from the first captured image in the panoramic image. As a result, the panoramic image becomes an image with unnatural hues.

(Advantage of Solution 2 of Acquiring Gain Values between Captured Images by Equation (110))

An advantage of Solution 2 of acquiring the gain values between the captured images by Equation (110) is that the gain values satisfy Gain_{1,s}(R)=Gain_{1,s}(G)=Gain_{1,s}(B) for arbitrary s. Therefore, a color phase at an arbitrary position in the panoramic image is the same color phase as that in the captured image. That is, it is possible to acquire a panoramic image with appropriate color phases.

(Disadvantage of Solution 2 of Acquiring Gain Values between Captured Images by Equation (110))

A disadvantage of Solution 2 of acquiring the gain values between the captured images by Equation (110) is that level differences of the respective colors are more noticeable at the boundary between the adjacent captured images on the generated panoramic image as compared with the case of Solution 1 by Equation (109) since the gain values are not independently acquired for the respective colors.

The above descriptions were given of two examples of the technology in relation to positioning by acquiring the positional relationship between the adjacent captured images, namely the homogeneous transformation matrix H_{s,s+1} and the technology in relation to color phase matching by acquiring the gain value between the captured images, and the descriptions can be summarized as follows.

The technology in relation to the positioning and the technology in relation to the color phase matching respectively have two solutions, namely Solution 1 and Solution 2, and the respective solutions have advantages and disadvantages.

Solution 1 of the respective technologies relates to a method of acquiring a transformation function as a target of calculation under the generous restriction condition.

That is, Solution 1 of the first technology in relation to the positioning is a solution of acquiring a positional relationship between adjacent captured images without applying any condition to the homogeneous transformation matrix H_{s,s+1} of Equation (105). In addition, Solution 1 of the second technology in relation to the color phase matching is a solution of acquiring a gain value between captured images by Equation (109), in which the gain values of the respective colors between the adjacent captured images are not necessarily the same.

If the homogeneous transformation matrix or the gain value is acquired by Solution 1, less failures occur in the images if attention is paid to a micro part, namely the part between the adjacent captured images while the failures in the images are noticeable in the resulting image (the panoramic image, for example) in a macro view.

In addition, Solution 2 of the respective technologies relates to a method of acquiring a transformation function as a calculation target under a strict restriction condition.

That is, Solution 2 of the first technology in relation to the positioning is a solution of acquiring a positional relationship between adjacent captured images by applying the condition that the homogeneous transformation matrix H_{s,s+1} of Equation (105) is an orthogonal matrix. Moreover, Solution 2 of the second technology in relation to the color phase matching is a solution of acquiring a gain value between captured images by Equation (110) by applying a condition that the gain values of the respective colors between the adjacent captured images are the same.

If the homogeneous transformation matrix or the gain value is acquired by Solution 2, failures in the image are less noticeable in the resulting image (the panoramic image, for example) in the macro view while the failures in the image are noticeable when attention is paid to a micro part, namely a part between the adjacent captured images.

There has been a requirement for acquiring a map (transformation function), such as a homogeneous transformation matrix or a gain value, with which failures in images become less noticeable both in the micro view and in the macro view when a panoramic image is generated. However, it is difficult to meet such a requirement by the aforementioned technologies.

The present technology was made in view of such circumstances and is to enable acquisition of a panoramic image with high quality, in which less failures occur in the image when the panoramic image is generated by connecting a plurality of captured images.

### [Concerning Concept of Present Technology]

According to the present technology, a map acquired under a generous restriction condition is used between adjacent captured images, and a map acquired under a strict restriction condition is used in accumulating transformation functions between the adjacent captured images for acquiring a relationship with a reference captured image. With such a configuration, it is possible to acquire a map (transformation function) with which failures in the image are not noticeable both in the micro view and in the macro view.

First, description will be given of a concept of the present technology.

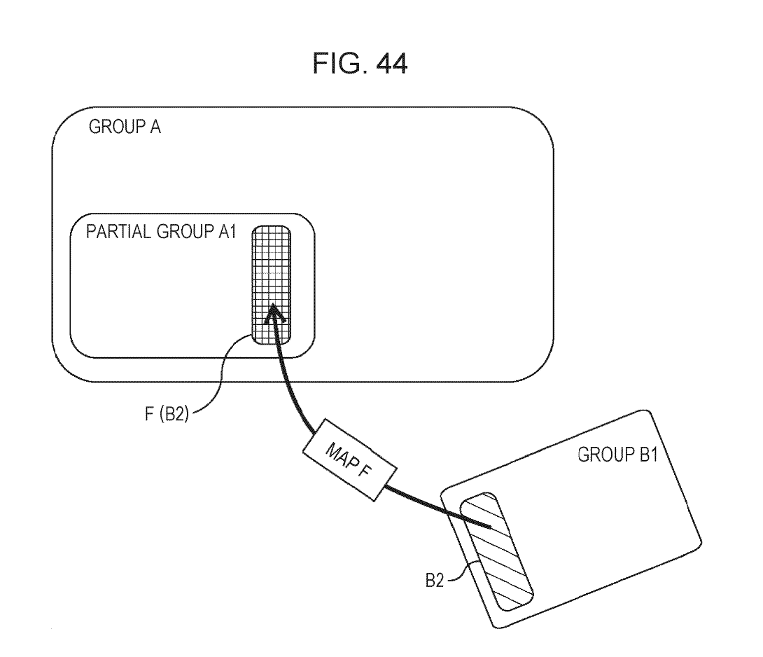

FIGS. 44 to 47 are diagrams illustrating the present technology by using Euler diagrams.

First, it is assumed that there is a partial group A1 in a group A, and there is a partial group B2 in a group B1 as shown in FIG. 44. In such a case, a map F from the partial group B2 to the partial group A1 will be considered. In this example, a map destination of the partial group B2 by the map F is a group F(B2) in the partial group A1.

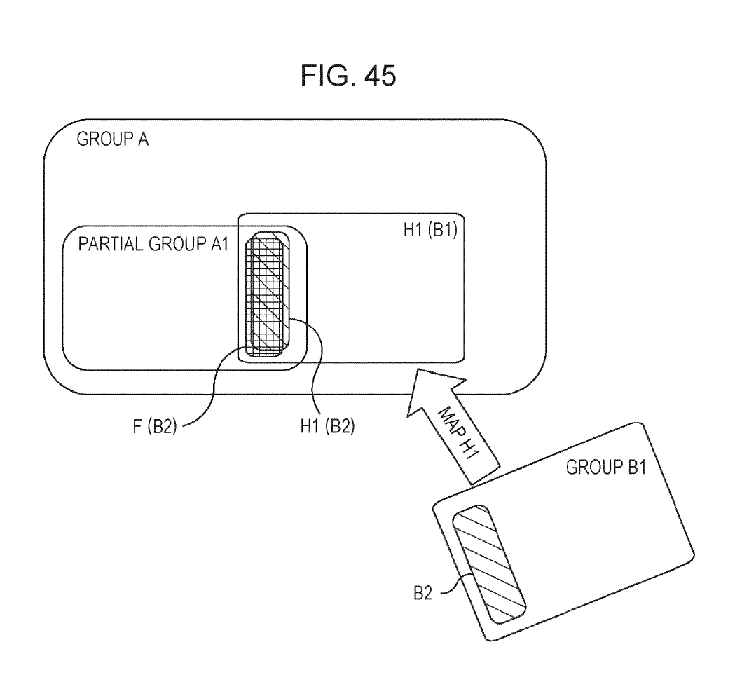

Next, a map from the group B1 to the group A is represented by H1 as shown in FIG. 45. In this example, a map destination of the group B1 by the map H1 is a group H1(B1) in the group A, and a map destination of a partial group B2 by the map H1 is a group H1(B2) in the partial group A1.

Here, the map H1 is a map which causes two images by maps, namely the map F and the map H1 among maps which satisfy a predetermined first condition, namely the group F(B2) and the group H1(B2) to be substantially the same. The map H1 corresponds to the homogeneous transformation matrix or the gain value between the adjacent captured images which is acquired by the aforementioned Solution 1, for example.

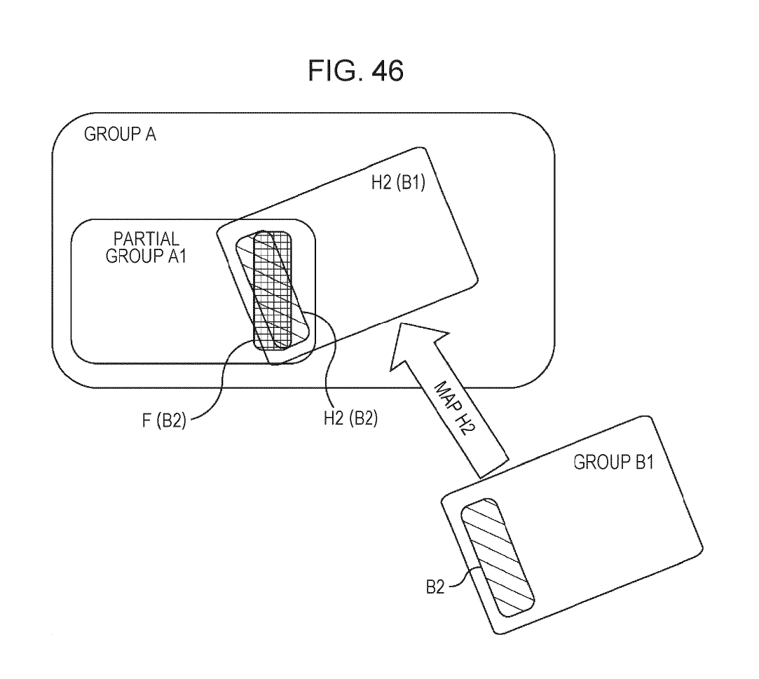

In contrast, a map from the group B1 to the group A is represented as H2 as shown in FIG. 46. In this example, a map destination of the group B1 by the map H2 is the group H2(B1) in the group A, and a map destination of the partial group B2 by the map H2 is the group H2(B2) in the partial group A1.

Here, the map H2 is a map which causes two images by the maps, namely the map F and the map H2 among maps which satisfy a predetermined second condition, namely the group F(B2) and the group H2(B2) to be substantially the same. The map H2 corresponds to the homogeneous transformation matrix or the gain value between the adjacent captured images which is acquired by the aforementioned Solution 2, for example.

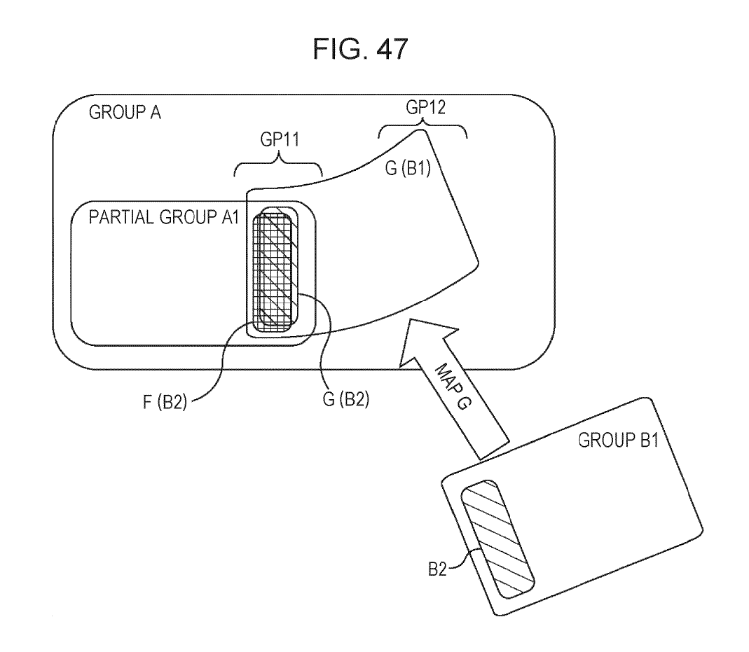

According to the present technology, the map H1 and the map H2 are used to acquire the final map G from the group B1 to the group A as shown in FIG. 47.

In FIG. 47, a map destination of the group B1 by the map G is a group G(B1) in the group A, and a map destination of the partial group B2 by the map G is a group G(B2) in the partial group A1.

As for the map G, the map G is substantially equal to the map H1 in a part corresponding to a region GP11 in the group G(B1) at the left end in the drawing, and the map G is substantially equal to the map H2 in a part corresponding to a region GP12 in the group G(B1) at the right end in the drawing.

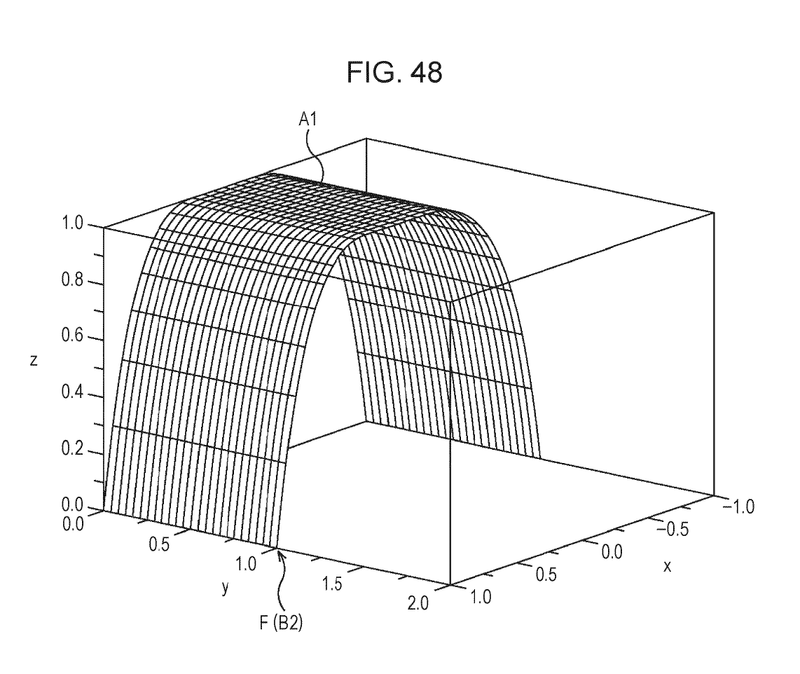

In addition, the concept of the present technology will be described again with reference to FIGS. 48 to 51 which correspond to FIGS. 44 to 47, respectively.

For example, it is assumed that there is a partial group A1 in a distance space A shown in FIG. 48. Here, the distance space A is a three-dimensional space (x, y, z) in which an x axis, a y axis and a z axis are included as the respective axes, and corresponds to the group A in FIG. 44.

In FIG. 48, a right oblique direction, a left oblique direction, and a vertical direction in the drawing represent an x-axis direction, a y-axis direction, and a z-axis direction, respectively.

In FIG. 48, the partial group A1 forms a curved surface in the distance space A, and a part, at which a y coordinate of the partial group A1 is 1, in the three-dimensional space (x, y, z) (a part where y=1) is a part corresponding to the group F(B2) in FIG. 44.

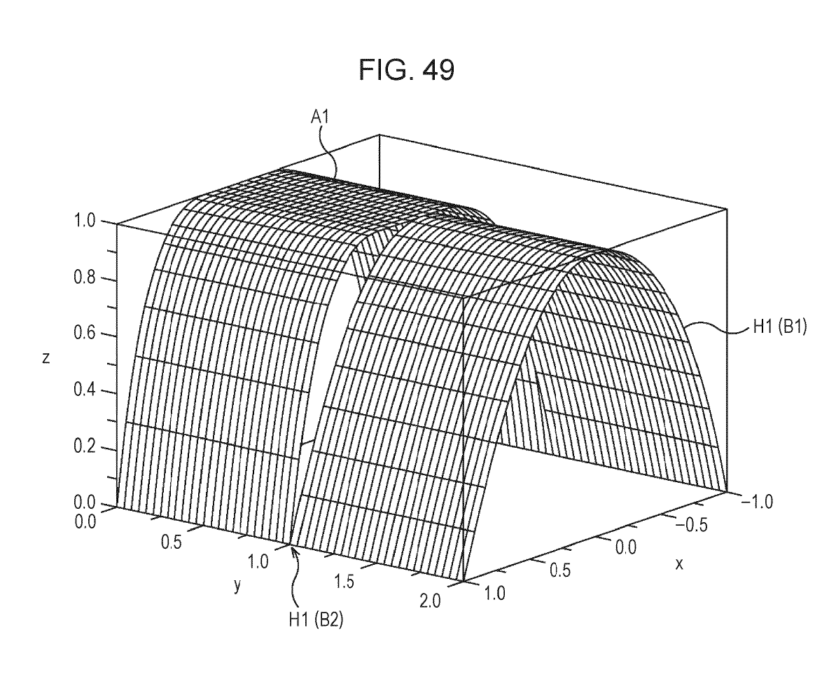

If the group B1 is mapped to such a distance space A by the map H1, the image thereof becomes the group H1(B1) as shown in FIG. 49. In FIG. 49, the partial group A1 and the group H1(B1) are adjacent to each other. In addition, a part, at which a y coordinate of the group H1(B1) is 1, in the distance space A (a part where y=1) is a part corresponding to the group H1(B2) in FIG. 45.

Here, the first condition when the map H1 is determined is a condition that an image of the map H1 forms a quadric surface. The group H1(B1) forms such an optimal quadric surface that the part where y=1 is smoothly connected to the partial group A1 to the maximum extent, that is, the group F(B2) and the group H1(B2) are substantially equal to each other to the maximum extent.

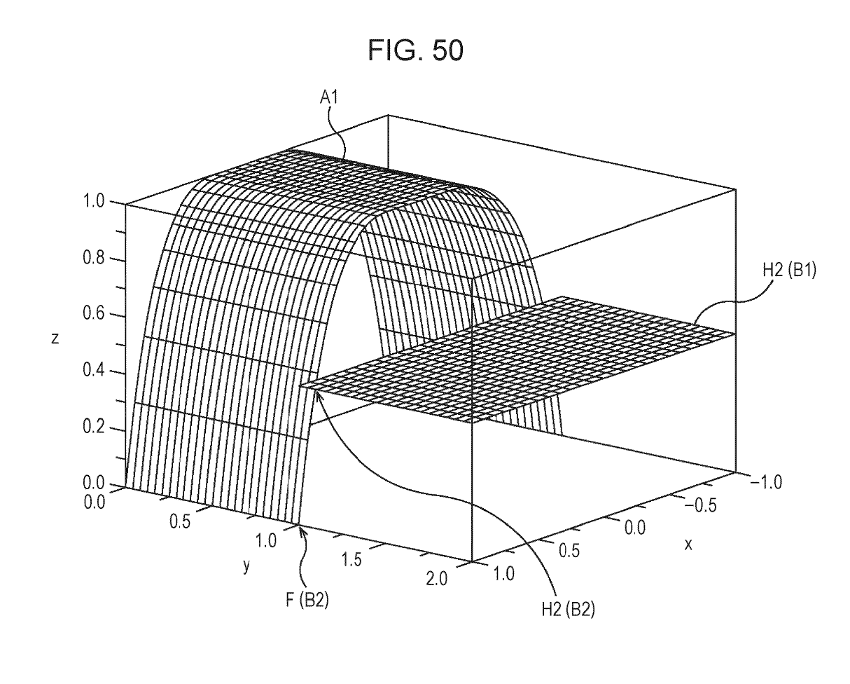

If the group B1 is mapped to the distance space A by the map H2, the image thereof becomes the group H2(B1) as shown in FIG. 50. In FIG. 50, the partial group A1 and the group H2(B1) are adjacent to each other. In the distance space A, a part, at which a y coordinate of the group H2(B1) is one, in the distance space A (a part where y=1) is a part corresponding to the group H2(B2) in FIG. 46.

Here, the second condition when the map H2 is determined is a condition that the image of the map H2 forms a plane. The group H2(B1) forms such an optimal plane that the part where y=1 is smoothly connected to the partial group A1 to the maximum extent, that is, the group F(B2) and the group H2(B2) are substantially equal to each other to the maximum extent.

If the parts where y=1 of the group H1(B1) in FIG. 49 and of the group H2(B1) in FIG. 50 are compared, it is possible to state the following fact. That is, the first condition has a higher degree of freedom than that of the second condition, namely, the first condition is a more generous restriction condition than the second condition, and therefore, the group H1(B1) is more smoothly connected to the partial group A1 than the group H2(B1).

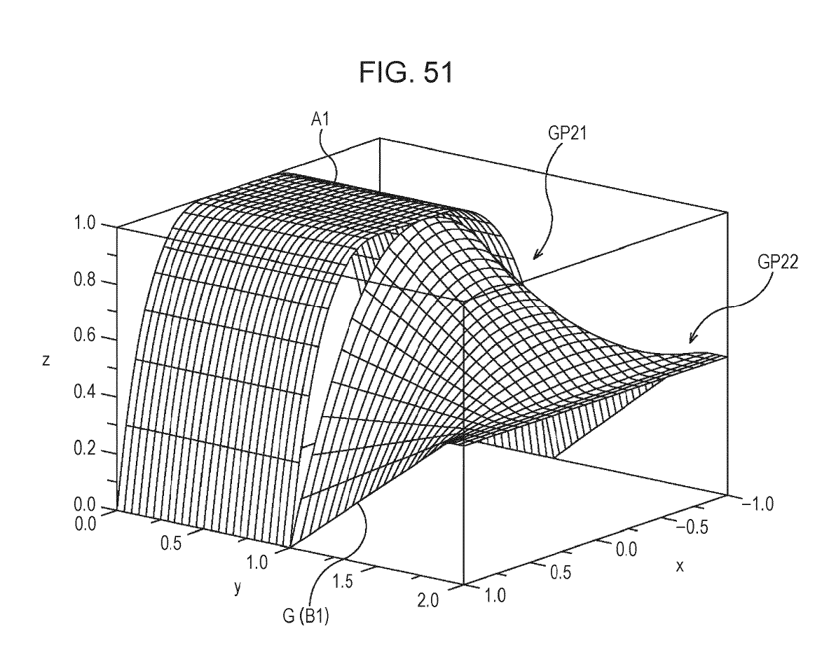

In addition, if the group B1 is mapped to the distance space A by the map G, the state as shown in FIG. 51 is achieved. That is, FIG. 51 shows the partial group A1 and the group G(B1) in the distance space A.

In the vicinity of the part represented by the arrow GP21 in the group G(B1), namely the part where the y coordinate of the group G(B1) is 1 (in the vicinity of the group F(B2)), the group G(B1)=the group H1(B1). That is, the part in the vicinity of y=1 in the group G(B1) is substantially equal to the part in the vicinity of y=1 in the group H1(B1).

In the vicinity of the part represented by the arrow GP22 in the group G(B1), namely the part where the y coordinate of the group G(B1) is 2 (in the part distant from the group F(B2)), the group G(B1)=the group H2(B1). That is, the part in the vicinity of y=2 in the group G(B1) is substantially equal to the part in the vicinity of y=2 in the group H2(B1).

The map G becomes a map with which the partial group A1 and the group G(B1) are smoothly connected in the vicinity of y=1 and the aforementioned second condition is satisfied in the vicinity of y=2 by acquiring such a map G. In addition, the map G becomes a map with which the group G(B1) is smoothly connected to the partial group A1 under the first condition with a higher degree of freedom (more generous restriction condition) on the side close to the partial group A1, namely in the vicinity of y=1. Furthermore, the map G is also a map with a lower degree of freedom (strict restriction condition) at a position distant from the partial group A1, namely in the vicinity of y=2, which satisfies the second condition. The reason of employing the condition of the lower degree of freedom (strict restriction condition) at the position distant from the partial group A1 will be described later.

### [Application of Present Technology to Technology in Relation to Positioning]

Now, specific description of the present technology will be given below. First, description will be given of a case where the present technology is applied to the aforementioned technology in relation to the positioning.

For example, it is assumed that a panoramic image is generated by editing a plurality of captured images which are captured and acquired while an imaging device such as a digital camera is rotated (panned) in various directions. That is, the first to N-th captured images, namely the total of N captured images are connected to each other to generate a wide panoramic image. In addition, it is assumed that the imaging is performed by panning the imaging device in the horizontal direction (the positive direction of the X axis) when viewed from a user.

If the captured images are acquired, first, a position at which the same object as a projected image in the s-th captured image is projected is searched for in the s+1-th captured image.

If the correspondence relationship is acquired, a positional relationship between adjacent captured images, namely between the s-th and the s+1-th captured images is acquired. That is, a scalar value H_{s,s+1(i,j)} which minimizes Equation (103) is acquired for arbitrary k.

Here, i=1 to 3, and j=1 to 3. In addition, f in Equation (103) represents a focal distance of the lens of the imaging device. In addition, it is assumed that the focal distance f is known and is always a constant value regardless of s. Furthermore, the scalar value H_{s,s+1(i,j)} which is acquired for each s has uncertainty in a constant factor. Thus, the uncertainty is excluded by applying a condition represented by Equation (104).

Incidentally, it is assumed that a result (solution) acquired by solving the minimum problem of Equation (103) without applying any condition is a homogeneous transformation matrix H′_{s,s+1} represented by the following Equation (112).

$$\begin{matrix}[ Math . 112 ] & \\ {H}_{s , s + 1}^{′} ≡ [ \begin{matrix}{H}_{s , s + 1 ( 1 , 1 )}^{′} & {H}_{s , s + 1 ( 2 , 1 )}^{′} & {H}_{s , s + 1 ( 3 , 1 )}^{′} \\ {H}_{s , s + 1 ( 1 , 2 )}^{′} & {H}_{s , s + 1 ( 2 , 2 )}^{′} & {H}_{s , s + 1 ( 3 , 2 )}^{′} \\ {H}_{s , s + 1 ( 1 , 3 )}^{′} & {H}_{s , s + 1 ( 2 , 3 )}^{′} & {H}_{s , s + 1 ( 3 , 3 )}^{′}\end{matrix} ] & ( 112 )\end{matrix}$$

Then, it is assumed that a result (solution) acquired by solving the minimum problem of Equation (103) by applying a condition that the matrix represented by Equation (105) is an orthogonal matrix is a homogeneous transformation matrix H″_{s,s+1} represented by the following Equation (113).

$$\begin{matrix}[ Math . 113 ] & \\ {H}_{s , s + 1}^{″} ≡ [ \begin{matrix}{H}_{s , s + 1 ( 1 , 1 )}^{″} & {H}_{s , s + 1 ( 2 , 1 )}^{″} & {H}_{s , s + 1 ( 3 , 1 )}^{″} \\ {H}_{s , s + 1 ( 1 , 2 )}^{″} & {H}_{s , s + 1 ( 2 , 2 )}^{″} & {H}_{s , s + 1 ( 3 , 2 )}^{″} \\ {H}_{s , s + 1 ( 1 , 3 )}^{″} & {H}_{s , s + 1 ( 2 , 3 )}^{″} & {H}_{s , s + 1 ( 3 , 3 )}^{″}\end{matrix} ] & ( 113 )\end{matrix}$$

In Equation (112) and Equation (113), s=1 to N−1.

Next, calculation of the following Equation (114) and Equation (115) is performed, and a positional relationship of the s-th captured image with reference to the first captured image is acquired.

$$\begin{matrix}[ Math . 114 ] & \\ {H}_{1 , 1}^{′} ≡ [ \begin{matrix}{H}_{1 , 1 ( 1 , 1 )}^{′} & {H}_{1 , 1 ( 2 , 1 )}^{′} & {H}_{1 , 1 ( 3 , 1 )}^{′} \\ {H}_{1 , 1 ( 1 , 2 )}^{′} & {H}_{1 , 1 ( 2 , 2 )}^{′} & {H}_{1 , 1 ( 3 , 2 )}^{′} \\ {H}_{1 , 1 ( 1 , 3 )}^{′} & {H}_{1 , 1 ( 2 , 3 )}^{′} & {H}_{1 , 1 ( 3 , 3 )}^{′}\end{matrix} ] ≡ [ \begin{matrix}1 & 0 & 0 \\ 0 & 1 & 0 \\ 0 & 0 & 1\end{matrix} ] \\ {H}_{1 , 2}^{′} ≡ [ \begin{matrix}{H}_{1 , 2 ( 1 , 1 )}^{′} & {H}_{1 , 2 ( 2 , 1 )}^{′} & {H}_{1 , 2 ( 3 , 1 )}^{′} \\ {H}_{1 , 2 ( 1 , 2 )}^{′} & {H}_{1 , 2 ( 2 , 2 )}^{′} & {H}_{1 , 2 ( 3 , 2 )}^{′} \\ {H}_{1 , 2 ( 1 , 3 )}^{′} & {H}_{1 , 2 ( 2 , 3 )}^{′} & {H}_{1 , 2 ( 3 , 3 )}^{′}\end{matrix} ] ≡ {H}_{1 , 2}^{′} \\ \begin{matrix}{H}_{1 , s}^{′} ≡ [ \begin{matrix}{H}_{1 , s ( 1 , 1 )}^{′} & {H}_{1 , s ( 2 , 1 )}^{′} & {H}_{1 , s ( 3 , 1 )}^{′} \\ {H}_{1 , s ( 1 , 2 )}^{′} & {H}_{1 , s ( 2 , 2 )}^{′} & {H}_{1 , s ( 3 , 2 )}^{′} \\ {H}_{1 , s ( 1 , 3 )}^{′} & {H}_{1 , s ( 2 , 3 )}^{′} & {H}_{1 , s ( 3 , 3 )}^{′}\end{matrix} ] \\ ≡ ( {\prod }_{t = 1}^{s - 2} {H}_{t , t + 1}^{″} ) {H}_{s - 1 , s}^{′} \\ = {H}_{1 , 2}^{″} {H}_{2 , 3}^{″} … {H}_{s - 3 , s - 2}^{″} {H}_{s - 2 , s - 1}^{″} {H}_{s - 1 , s}^{′} ( 3 \leq s \leq N )\end{matrix} & ( 114 ) \\ [ Math . 115 ] & \\ {H}_{1 , 1}^{″} ≡ [ \begin{matrix}{H}_{1 , 1 ( 1 , 1 )}^{″} & {H}_{1 , 1 ( 2 , 1 )}^{″} & {H}_{1 , 1 ( 3 , 1 )}^{″} \\ {H}_{1 , 1 ( 1 , 2 )}^{″} & {H}_{1 , 1 ( 2 , 2 )}^{″} & {H}_{1 , 1 ( 3 , 2 )}^{″} \\ {H}_{1 , 1 ( 1 , 3 )}^{″} & {H}_{1 , 1 ( 2 , 3 )}^{″} & {H}_{1 , 1 ( 3 , 3 )}^{″}\end{matrix} ] ≡ [ \begin{matrix}1 & 0 & 0 \\ 0 & 1 & 0 \\ 0 & 0 & 1\end{matrix} ] \\ {H}_{1 , 2}^{″} ≡ [ \begin{matrix}{H}_{1 , 2 ( 1 , 1 )}^{″} & {H}_{1 , 2 ( 2 , 1 )}^{″} & {H}_{1 , 2 ( 3 , 1 )}^{″} \\ {H}_{1 , 2 ( 1 , 2 )}^{″} & {H}_{1 , 2 ( 2 , 2 )}^{″} & {H}_{1 , 2 ( 3 , 2 )}^{″} \\ {H}_{1 , 2 ( 1 , 3 )}^{″} & {H}_{1 , 2 ( 2 , 3 )}^{″} & {H}_{1 , 2 ( 3 , 3 )}^{″}\end{matrix} ] ≡ {H}_{1 , 2}^{′} \\ \begin{matrix}{H}_{1 , s}^{″} ≡ [ \begin{matrix}{H}_{1 , s ( 1 , 1 )}^{″} & {H}_{1 , s ( 2 , 1 )}^{″} & {H}_{1 , s ( 3 , 1 )}^{″} \\ {H}_{1 , s ( 1 , 2 )}^{″} & {H}_{1 , s ( 2 , 2 )}^{″} & {H}_{1 , s ( 3 , 2 )}^{″} \\ {H}_{1 , s ( 1 , 3 )}^{″} & {H}_{1 , s ( 2 , 3 )}^{″} & {H}_{1 , s ( 3 , 3 )}^{″}\end{matrix} ] \\ ≡ ( {\prod }_{t = 1}^{s - 2} {H}_{t , t + 1}^{″} ) {H}_{s - 1 , s}^{″} \\ = ( {\prod }_{t = 1}^{s - 1} {H}_{t , t + 1}^{″} ) \\ = {H}_{1 , 2}^{″} {H}_{2 , 3}^{″} … {H}_{s - 3 , s - 2}^{″} {H}_{s - 2 , s - 1}^{″} {H}_{s - 1 , s}^{″} ( 3 \leq s \leq N )\end{matrix} & ( 115 )\end{matrix}$$

That is, a homogeneous transformation matrix H′_{1,s} is calculated by further multiplying a matrix, which is acquired by accumulating the respective homogeneous transformation matrixes from a homogeneous transformation matrix H″_{1,2} to a homogeneous transformation matrix H″_{s-2,s-1} by a homogeneous transformation matrix H′_{s-1,s}.

What should be noted here is that the homogeneous transformation matrixes between the adjacent captured images, which are accumulated by Equation (114) are homogeneous transformation matrixes H″_{s,s+1} acquired by Equation (113).

In Equation (115), a homogeneous transformation matrix H″_{1,s} is calculated by accumulating the respective homogeneous transformation matrixes from a homogeneous transformation matrix H″_{1,2} to a homogeneous transformation matrix H″_{s-1,s}.

Here, the homogeneous transformation matrix H′_{1,s}, which is represented by Equation (114), as a homogeneous transformation matrix of each captured image with reference to the first captured image and the homogeneous transformation matrix H″_{1,s}, which is represented by Equation (115), have the following characteristics.

That is, it is assumed that the k-th captured image is arranged at a position which is determined by the homogeneous transformation matrix H″_{1,k} represented by Equation (115) and that the k+1-th captured image is arranged at a position which is determined by the homogeneous transformation matrix H′_{1,k+1} represented by Equation (114) on the panoramic image.

If the homogeneous transformation matrix H″_{1,k} and the homogeneous transformation matrix H′_{1,k+1} are mentioned again, these homogeneous transformation matrixes are matrixes represented by the following Equation (116).

$$\begin{matrix} [ Math . 116 ] & \\ \begin{matrix}{H}_{1 , k}^{″} = ( {\prod }_{t = 1}^{k - 1} {H}_{t , t + 1}^{″} ) = {H}_{1 , 2}^{″} {H}_{2 , 3}^{″} … {H}_{k - 2 , k - 1}^{″} {H}_{k - 1 , k}^{″} \\ {H}_{1 , k + 1}^{′} = ( {\prod }_{t = 1}^{k - 1} {H}_{t , t + 1}^{″} ) {H}_{k , k + 1}^{″} = {H}_{1 , 2}^{″} {H}_{2 , 3}^{″} … {H}_{k - 2 , k - 1}^{″} {H}_{k - 1 , k}^{″} {H}_{k , k + 1}^{′} \end{matrix} \} & ( 116 )\end{matrix}$$

As can be understood from Equation (116), the position, at which the k+1-th captured image is arranged, and which is determined by the homogeneous transformation matrix H′_{1,k+1} is a position deviated from the position, at which the k-th captured image is arranged, and which is determined by the homogeneous transformation matrix H″_{1,k}, by an amount corresponding to the homogeneous transformation matrix H′_{k,k+1}.

That is, the positional relationship between the k-th captured image and the k+1-th captured image arranged as described above is equal to a positional relationship as a result of solving the minimum problem of Equation (103) without applying the condition that the homogeneous transformation matrix H_{s,s+1} is an orthogonal matrix. Accordingly, it is possible to arrange these captured images such that substantially no positional deviation occurs between the k-th captured image and the k+1-th captured image on the panoramic image by employing such arrangement.

In addition, it is not necessary to arrange all the pixel positions in the k-th captured image at positions determined by the homogeneous transformation matrix H′_{1,k} and to arrange all the pixel positions in the k+1-th captured image at positions determined by the homogeneous transformation matrix H′_{1,k+1}. It is sufficient that only a part, which overlaps with the k+1-th captured image, in the k-th captured image is arranged at a position determined by the homogeneous transformation matrix H″_{1,k} and that only a part, which overlaps with the k-th captured image, in the k+1-th captured image is arranged at a position determined by the homogeneous transformation matrix H′_{1,k+1}.

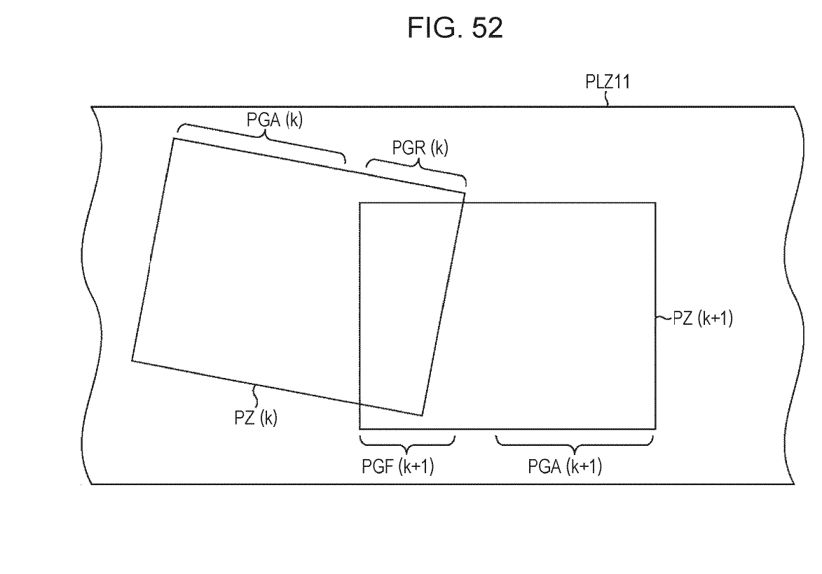

It is not necessary to arrange the other parts, namely the parts, which do not overlap with each other, in the k-th and the k+1-th captured images at positions determined by the homogeneous transformation matrix H″_{1,k} or the homogeneous transformation matrix H′_{1,k+1}. That is, it is possible to arrange the captured images such that substantially no positional deviation occurs between the k-th captured image and the k+1-th captured image on the panoramic image by employing the arrangement as shown in FIG. 52.

In FIG. 52, the k-th captured image PZ(k) and the k+1-th captured image PZ(k+1) are arranged on the panoramic image PLZ11. In FIG. 52, the same reference numerals are given to parts corresponding to those in FIG. 39, and the description thereof will be omitted.

As for a region PGR(k) at a part, which overlaps with the k+1-th captured image PZ(k+1), in the k-th captured image PZ(k) in this example, pixels in the region PGR(k) are arranged at positions determined by the homogeneous transformation matrix H″_{1,k}.

In contrast, as for a region PGA(k) at a part, which does not overlap with the k+1-th captured image PZ(k+1), in the k-th captured image PZ(k), it is not necessary to arrange the respective pixels at the positions determined by the homogeneous transformation matrix H″_{1,k}.

As for a region PGF(k+1) at a part, which overlaps with the k-th captured image PZ(k), in the k+1-th captured image PZ(k+1), pixels in the region PGF(k+1) are arranged at positions determined by the homogeneous transformation matrix H′_{1,k+1}.

In contrast, as for a region PGA(k+1) at a part, which does not overlap with the k-th captured image PZ(k), in the k+1-th captured image PZ(k+1), it is not necessary to arrange the respective pixels at the positions determined by the homogeneous transformation matrix H′_{1,k+1}.

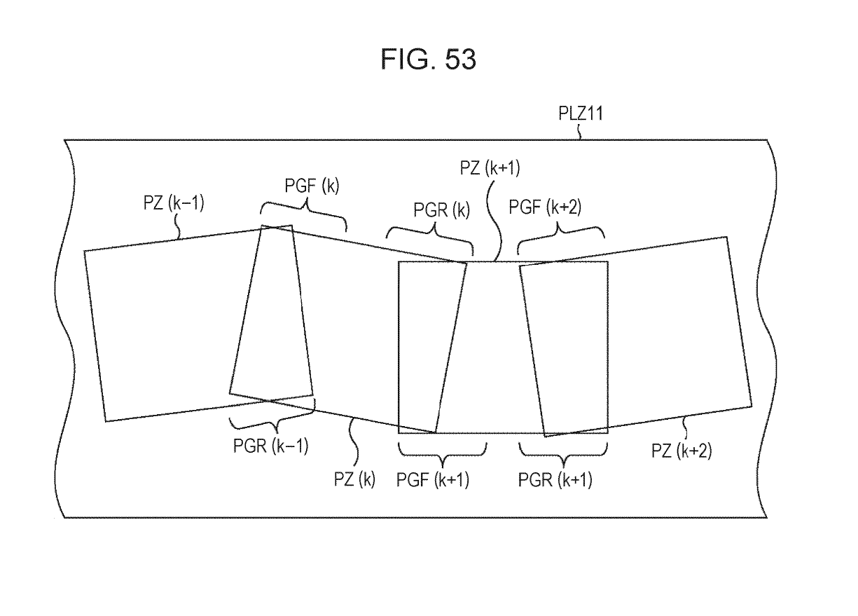

Now, the respective captured images are arranged on the panoramic image PLZ11 as shown in FIG. 53 paying attention to the above description according to the present technology. In FIG. 53, the same reference numerals are given to parts corresponding to those in FIG. 52, and the description thereof will be appropriately omitted.

In FIG. 53, as for a region PGR(k−1) at a part, which overlaps with the k-th captured image PZ(k), in the k−1-th captured image PZ(k−1), pixels in the region PGR(k−1) are arranged at positions determined by the homogeneous transformation matrix H″_{1,k-1}.

As for a region PGF(k) at a part, which overlaps with the k−1-th captured image PZ(k−1), in the k-th captured image PZ(k), pixels in the region PGF(k) are arranged at positions determined by the homogeneous transformation matrix H′_{1,k}. As for a region PGR(k) at a part, which overlaps with the k+1-th captured image PZ(k+1), in the k-th captured image PZ(k), pixels in the region PGR(k) are arranged at positions determined by the homogeneous transformation matrix H″_{1,k}.

Similarly, as for a region PGF(k+1) at a part, which overlaps with the k-th captured image PZ(k), in the k+1-th captured image PZ(k+1), pixels in the region PGF(k+1) are arranged at positions determined by the homogeneous transformation matrix H′_{1,k+1}. In addition, as for a region PGR(k+1) at a part, which overlaps with the k+2-th captured image PZ(k+2), in the k+1-th captured image PZ(k+1), pixels in the region PGR(k+1) are arranged at positions determined by the homogeneous transformation matrix H″_{1,k+1}.

Furthermore, as for a region PGF(k+2) at a part, which overlaps with the k+1-th captured image PZ(k+1), in the k+2-th captured image PZ(k+2), pixels in the region PGF(k+2) are arranged at positions determined by the homogeneous transformation matrix H′_{1,k+2}.

As described above, it is possible to substantially prevent positional deviation between the respective captured images on the panoramic image PLZ11 by arranging the regions of the respective captured images on the panoramic image PLZ11 to be generated.

Furthermore, each pixel position in each captured image is arranged as represented by the homogeneous transformation matrix of Equation (114) or Equation (115). Here, the homogeneous transformation matrix H″_{1,s} of Equation (115) is an orthogonal matrix, and the position determined by the homogeneous transformation matrix H″_{1,s} is a position, the orthogonality of which is maintained on the panoramic image.

In addition, the homogeneous transformation matrix H′_{1,s} of Equation (114) is not an orthogonal matrix in a strict sense, and a component which is not an orthogonal matrix is only a homogeneous transformation matrix H′_{s-1,s} which is finally multiplied among the homogeneous transformation matrixes accumulated to acquire the homogeneous transformation matrix H′_{1,s}.

For this reason, non-orthogonal matrixes are not accumulated in the homogeneous transformation matrix H′_{1,s} of Equation (114). Accordingly, the homogeneous transformation matrix H′_{1,s} of Equation (114) is also substantially an orthogonal matrix, and a positional deviation caused by the homogeneous transformation matrix H′_{1,s} is also within an allowable range. That is, the positional deviation caused by the homogeneous transformation matrix H′_{1,s} is not at a level at which humans can sense the deviation.

The above description was given with reference to the drawings, and more specifically, the pixel value of the pixel at each position (Xₛ, Yₛ) in each captured image (s-th captured image) may be mapped at a transformation position (117), on the panoramic image.

$$\begin{matrix}[ Math . 117 ] & \\ [ \begin{matrix}{X}_{1} \\ {Y}_{1} \\ f\end{matrix} ] ∝ ( ( 1 - Weight ) \times {H}_{1 , s}^{′} + Weight \times {H}_{1 , s}^{″} ) [ \begin{matrix}{X}_{s} \\ {Y}_{s} \\ f\end{matrix} ] , \\ Where \\ Weight ≡ \frac{{X}_{s} + ( Width / 2 )}{Width} . & ( 117 )\end{matrix}$$

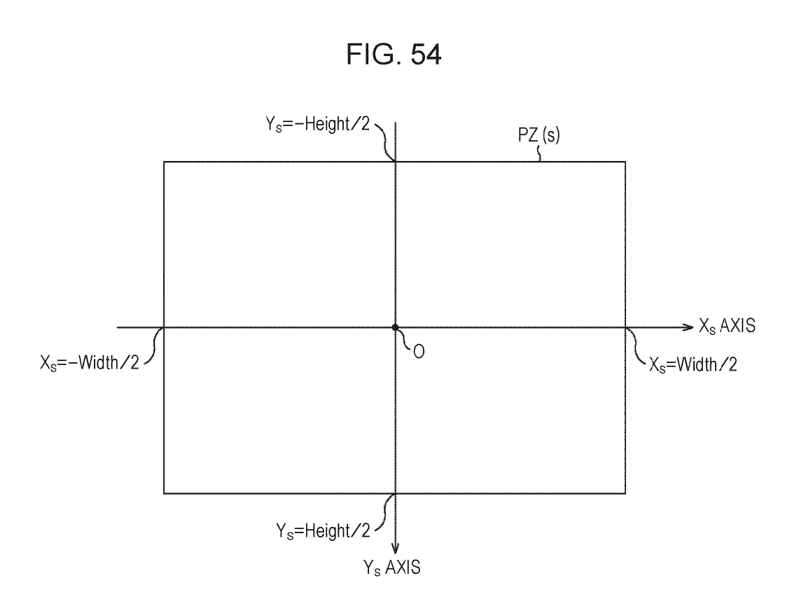

In addition, Width in Equation (117) represents a width of the captured image in the horizontal direction, namely a width of the captured image PZ(s) in the Xₛ-axis direction shown in FIG. 54.

As shown in FIG. 54, the center position of each captured image, namely the s-th captured image PZ(s) (where s=1 to N) is an origin O in a coordinate system (Xₛ, Yₛ) with reference to the s-th captured image PZ(s). In the drawing, the horizontal direction and the vertical direction represent an Xₛ-axis direction and a Yₛ-axis direction of the coordinate system with reference to the s-th captured image PZ(s), respectively.

In addition, the height in the vertical direction and the width in the horizontal direction of the captured image PZ(s) are represented as Height and Width in the example of FIG. 54. In addition, Xₛ coordinates of the captured image PZ(s) at the left end and the right end in the drawing are represented as −Width/2 and Width/2, and Yₛ coordinates of the captured image PZ(s) at the upper end and the lower end in the drawing are represented as −Height/2 and Height/2.

In addition, since the respective captured images are captured during imaging while the imaging device is panned in the right direction (the positive direction of the Xₛ axis) in the drawing, a region in the vicinity of the left end of each captured image PZ(s) in the drawing, namely in the vicinity of Xₛ=−Width/2 overlaps with the s−1-th captured image PZ(s−1). Similarly, a region in the vicinity of the right end of each captured image PZ(s) in the drawing, namely in the vicinity of Xₛ=Width/2 overlaps with the s+1-th captured image PZ(s+1).

In addition, the pixel value of the pixel at each position (Xₛ, Yₛ) in the s-th captured image may be mapped on the transformation position (X₁, Y₁), which is represented by the following Equation (118) instead of Equation (117), on the panoramic image.

$$\begin{matrix}[ Math . 118 ] & \\ [ \begin{matrix}{X}_{1} \\ {Y}_{1} \\ f\end{matrix} ] ∝ {Hapx}_{1 , s} [ \begin{matrix}{X}_{s} \\ {Y}_{s} \\ f\end{matrix} ] & ( 118 )\end{matrix}$$

In addition, the homogeneous transformation matrix Hapx_{1,s} in Equation (118) is a 3×3 matrix which satisfies the following Equation (119).

$$\begin{matrix}[ Math . 119 ] & \\ {H}_{1 , s}^{′} [ \begin{matrix}- \frac{Width}{2} \\ - \frac{Height}{2} \\ f\end{matrix} ] ∝ {Hapx}_{1 , s} [ \begin{matrix}- \frac{Width}{2} \\ - \frac{Height}{2} \\ f\end{matrix} ] and \\ {H}_{1 , s}^{′} [ \begin{matrix}- \frac{Width}{2} \\ - \frac{Height}{2} \\ f\end{matrix} ] ∝ {Hapx}_{1 , s} [ \begin{matrix}- \frac{Width}{2} \\ - \frac{Height}{2} \\ f\end{matrix} ] and \\ {H}_{1 , s}^{″} [ \begin{matrix}\frac{Width}{2} \\ - \frac{Height}{2} \\ f\end{matrix} ] ∝ {Hapx}_{1 , s} [ \begin{matrix}\frac{Width}{2} \\ - \frac{Height}{2} \\ f\end{matrix} ] and \\ {H}_{1 , s}^{″} [ \begin{matrix}\frac{Width}{2} \\ \frac{Height}{2} \\ f\end{matrix} ] ∝ {Hapx}_{1 , s} [ \begin{matrix}\frac{Width}{2} \\ \frac{Height}{2} \\ f\end{matrix} ] & ( 119 )\end{matrix}$$

It is possible to state that the method of acquiring a mapping destination of each pixel in the captured image by Equation (118) and Equation (119) approximates Equation (117).

That is, when it is assumed that the height of the captured image PZ(s) is Height, the homogeneous transformation matrix Hapx_{1,s}, is made to completely coincide with the homogeneous transformation matrix H′_{1,s} at a position (Xₛ, Yₛ)=((−Width/2), (Height/2)) and a position (Xₛ, Yₛ)=((−Width/2), (−Height/2)) on the captured image PZ(s).

Then, the homogeneous transformation matrix Hapx_{1,s} is made to completely coincide with the homogeneous transformation matrix H″_{1,s} at a position (Xₛ, Yₛ)=((Width/2), (Height/2)) and a position (Xₛ, Yₛ)=((−Width/2), (−Height/2)) on the captured image PZ(s).

The pixel value of the pixel at each position (Xs, Ys) in s-th captured image is mapped at the transformation position (X1, Y1), which is represented by Equation (118), on the panoramic image by using the homogeneous transformation matrix Hapx_{1,s} represented by Equation (119) as described above.

Since a unique homogeneous transformation matrix is acquired if four mapping positions are determined, the homogeneous transformation matrix Hapx_{1,s} of Equation (119) can be constantly calculated. The homogeneous transformation matrix Hapx_{1,s} is substantially the homogeneous transformation matrix H′_{1,s} on the left side of the s-th captured image PZ(S) in FIG. 54, and is substantially the homogeneous transformation matrix H″_{1,s} on the right side of the s-th captured image PZ(s). For this reason, transformation by the homogeneous transformation matrix Hapx_{1,s} is transformation in accordance with the gist of the present technology.

It is possible to acquire the panoramic image by mapping the pixel value of the pixel at each position (Xₛ, Yₛ) in the captured image PZ(s) on the position (X₁, Y₁), which is represented by Equation (117) or Equation (118), on the first captured image PZ(1). In addition, the pixel value of the pixel in the captured image is generally a value from 0 to 255 when the captured image is a monochrome image, and is a value expressing three primary colors, namely red, green, and blue by 0 to 255 when the captured image is a color image.

It is possible to acquire an appropriate map (transformation function), namely a homogeneous transformation matrix which represents a positional relationship of each captured image with reference to the first captured image, which is represented by Equation (117) or Equation (118), by applying the present technology to the positioning of the captured images as described above.

### [Configuration Example of Image Processing Apparatus]

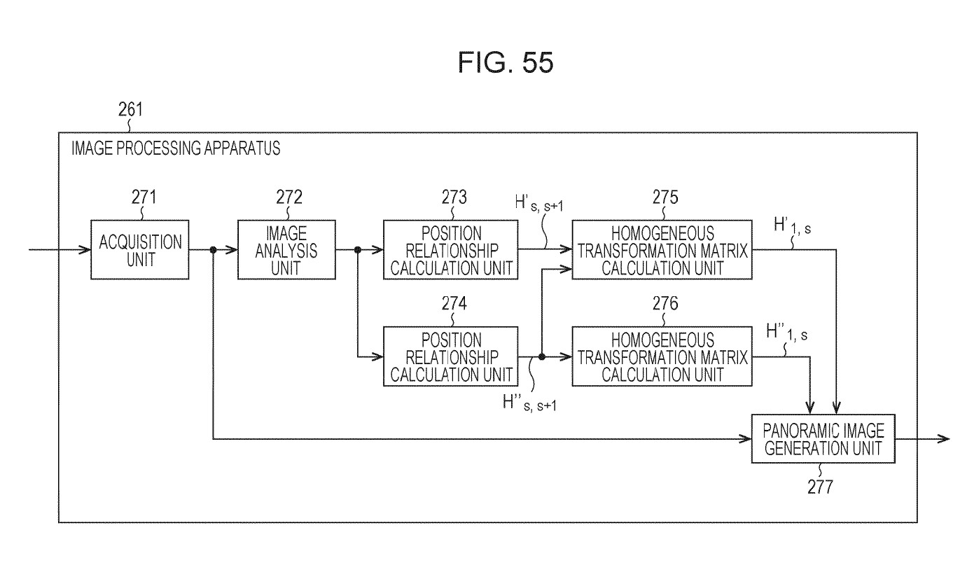

Next, description will be given of specific embodiments to which the present technology is applied. FIG. 55 is a diagram showing a configuration example of an embodiment of an image processing apparatus to which the present technology is applied.

An image processing apparatus 261 in FIG. 55 is configured of an acquisition unit 271, an image analysis unit 272, a positional relationship calculation unit 273, a positional relationship calculation unit 274, a homogeneous transformation matrix calculation unit 275, a homogeneous transformation matrix calculation unit 276, and a panoramic image generation unit 2777.

The acquisition unit 271 acquires N captured images which are successively captured while an imaging device such as a digital camera is rotated, and supplies the captured images to the image analysis unit 272 and the panoramic image generation unit 277. In addition, although the acquisition unit 271 acquires a focal distance f of each captured image and supplies the focal distance f to the image analysis unit 272 as necessary, the following description will be continued on the assumption that the focal distance f is known by the image processing apparatus 261.

The image analysis unit 272 acquires positions of the same object which is projected to the captured images by analyzing adjacent captured images based on the captured images from the acquisition unit 271, and supplies the respective acquired corresponding positional relationships to the positional relationship calculation unit 273 and the positional relationship calculation unit 274.

The positional relationship calculation unit 273 calculates the homogeneous transformation matrixes H′_{s,s+1} between the captured images under a more generous condition based on the corresponding positional relationships supplied from the image analysis unit 272, and supplies the homogeneous transformation matrix H′_{s,s+1} to the homogeneous transformation matrix calculation unit 275. The positional relationship calculation unit 274 calculates the homogeneous transformation matrixes H″_{s,s+1} between the captured images under a more strict condition based on the corresponding positional relationships supplied from the image analysis unit 272, and supplies the homogeneous transformation matrix H″_{s,s+1} to the homogeneous transformation matrix calculation unit 275 and the homogeneous transformation matrix calculation unit 276.

The homogeneous transformation matrix calculation unit 275 accumulates the homogeneous transformation matrixes H′_{s,s+1} from the positional relationship calculation unit 273 and the homogeneous transformation matrixes H″_{s,s+1} from the positional relationship calculation unit 274, calculates a homogeneous transformation matrix H′_{1,s} which represents a positional relationship between the first and the s-th captured images, and supplies the homogeneous transformation matrix H′_{1,s} to the panoramic image generation unit 277.

The homogeneous transformation matrix calculation unit 276 accumulates the homogeneous transformation matrix H′_{s,s+1} from the positional relationship calculation unit 274, calculates a homogeneous transformation matrix H″_{1,s} which represents a positional relationship between the first and the s-th captured image, and supplies the homogeneous transformation matrix H′_{1,s} to the panoramic image generation unit 277.

The panoramic image generation unit 277 generates a panoramic image based on the captured images from the acquisition unit 271, the homogeneous transformation matrix from the homogeneous transformation matrix calculation unit 275, and the homogeneous transformation matrix from the homogeneous transformation matrix calculation unit 276, and outputs the panoramic image.

### [Description of Panoramic Image Generation Processing]

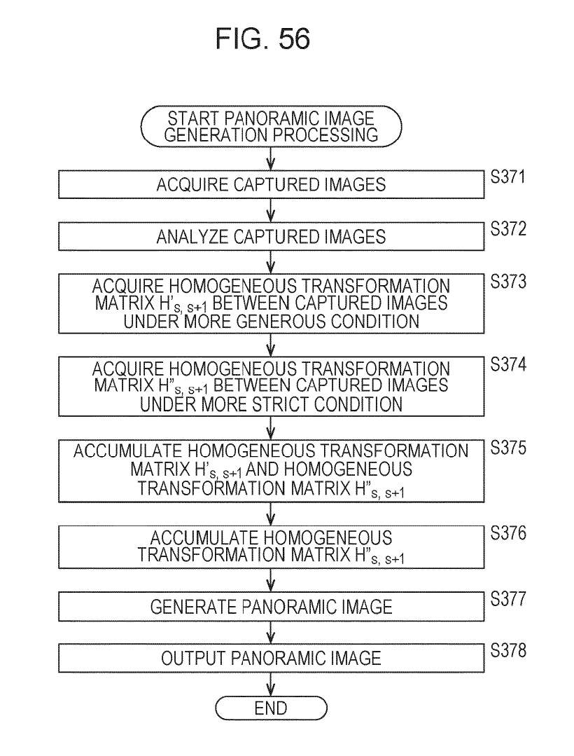

Next, description will be given of panoramic image generation processing by the image processing apparatus 261 with reference to the flowchart in FIG. 56.

In Step S371, the acquisition unit 271 acquires N captured images which are successively captured while the imaging device is rotated in the positive direction of the X axis, and supplies the captured images to the image analysis unit 272 and the panoramic image generation unit 277.

In Step S372, the image analysis unit 272 analyzes the adjacent s-th captured image and the s+1-th captured image (where s=1 to N−1) based on the captured images from the acquisition unit 271 and acquires positions of the same object which is projected to the captured images.

That is, a position (X(s,s+1,k), Y(s,s+1,k)) on the s-th captured image and a position (X(s+1,s,k), Y(s+1,s,k)) on the s+1-th captured image PZ(s+1) are acquired. The image analysis unit 272 supplies the respective corresponding positional relationships on the captured images, which are acquired as a result of the analysis, to the positional relationship calculation unit 273 and the positional relationship calculation unit 274.

In Step S373, the positional relationship calculation unit 273 calculates homogeneous transformation matrixes H′_{s,s+1} (where s=1 to N−1) between the captured images under the more generous condition based on the corresponding positional relationships supplied from the image analysis unit 272, and supplies the homogeneous transformation matrixes H′_{s,s+1} to the homogeneous transformation matrix calculation unit 275.

That is, the positional relationship calculation unit 273 acquires the homogeneous transformation matrixes H_{s,s+1}, which minimize Equation (103) and represent the positional relationship between adjacent captured images, without applying any condition, and regards the solution (homogeneous transformation matrixes H_{s,s+1}) acquired as a result as the homogeneous transformation matrixes H′_{s,s+1}.

In Step S374, the positional relationship calculation unit 274 calculates the homogeneous transformation matrixes H″_{s,s+1} (where s=1 to N−1) between the captured images under the more strict condition based on the corresponding positional relationships from the image analysis unit 272, and supplies the homogeneous transformation matrix H″_{s,s+1} to the homogeneous transformation matrix calculation unit 275 and the homogeneous transformation matrix calculation unit 276.

That is, the positional relationship calculation unit 274 acquires the homogeneous transformation matrixes H_{s,s+1}, which minimize Equation (103) and represent the positional relationships between the adjacent captured images, under a condition that the homogeneous transformation matrixes H_{s,s+1} are orthogonal matrixes. Then, the positional relationship calculation unit 274 regards the solution (homogeneous transformation matrixes H_{s,s+1}) acquired as a result as the homogeneous transformation matrixes H″_{s,s+1}.

In Step S375, the homogeneous transformation matrix calculation unit 275 accumulates the homogeneous transformation matrixes H′_{s,s+1} from the positional relationship calculation unit 273 and the homogeneous transformation matrixes H″_{s,s+1} from the positional relationship calculation unit 274, and calculates the homogeneous transformation matrix H′_{1,s} which represents the positional relationship between the first and the s-th captured images.

That is, the homogeneous transformation matrix calculation unit 275 calculates the homogeneous transformation matrix H′_{1,s} for each s (where s=1 to N) by performing the calculation of Equation (114), and supplies the homogeneous transformation matrix H′_{1,s} to the panoramic image generation unit 277.

In Step S376, the homogeneous transformation matrix calculation unit 276 accumulates the homogeneous transformation matrixes H″_{s,s+1} from the positional relationship calculation unit 274, calculates the homogeneous transformation matrix H″_{1,s} which represents the positional relationship between the first and the s-th captured images, and supplies the homogeneous transformation matrix H″_{1,s} to the panoramic image generation unit 277. That is, the calculation of Equation (115) is performed, and the homogeneous transformation matrix H″_{1,s} is calculated for each s (where s=1 to N).

In Step S377, the panoramic image generation unit 277 generates a panoramic image based on the captured images from the acquisition unit 271, the homogeneous transformation matrix H′_{1,s} from the homogeneous transformation matrix calculation unit 275, and the homogeneous transformation matrix H″_{1,s} from the homogeneous transformation matrix calculation unit 276.

Specifically, the panoramic image generation unit 277 generates the panoramic image by mapping the pixel value of the pixel at each position (Xₛ, Yₛ) in the respective captured images, namely the first to N-th captured images at the position (X₁, Y₁) on the first captured image, which is represented by Equation (117).

That is, the panoramic image generation unit 277 acquires the final homogeneous transformation matrix for the position (Xₛ, Yₛ) by performing weighted addition (proration) on the homogeneous transformation matrix H′_{1,s} and the homogeneous transformation matrix H″_{1,s} while applying a weight in accordance with the position (Xₛ, Yₛ) on the captured image. Then, the panoramic image generation unit 277 acquires the position (X₁, Y₁) on the first captured image, which corresponds to the position (Xₛ, Yₛ), from the acquired final homogeneous transformation matrix and maps, on the position (X₁, Y₁), the pixel value of the pixel at the position (Xₛ, Yₛ).

Here, the pixel value of the pixel in the captured image is generally a value from 0 to 255 when the captured image is a monochrome image, and is a value expressing three primary colors, namely red, green, and blue by 0 to 255 when the captured image is a color image.

In addition, Equation (118) may be used instead of Equation (117) in Step S377.

In such a case, the panoramic image generation unit 277 acquires the homogeneous transformation matrix Hapx_{1,s} which satisfies Equation (119) by using the homogeneous transformation matrix H′_{1,s} and the homogeneous transformation matrix H″_{1,s}. Then, the panoramic image generation unit 277 generates the panoramic image by mapping the pixel value of the pixel at each position (Xₛ, Yₛ) in the respective captured images, namely the first to the N-th captured images on the position (X₁, Y₁) on the first captured image, which is represented by Equation (118).

In Step S378, the panoramic image generation unit 277 outputs the generated panoramic image, and the panoramic image generation processing is completed.

As described above, the image processing apparatus 261 calculates the homogeneous transformation matrixes, which represent positional relationships between adjacent captured images, under two different conditions, and acquires the homogeneous transformation matrix H′_{1,s} and the homogeneous transformation matrix H″ _{1,s}, which represent the positional relationships between the first and the s-th captured images, from the acquired homogeneous transformation matrixes. Then, the image processing apparatus 261 generates a panoramic image by using a homogeneous transformation matrix which is acquired by prorating the acquired homogeneous transformation matrix H′_{1,s} and the homogeneous transformation matrix H″_{1,s} in accordance with the positions on the captured images.

It is possible to acquire a homogeneous transformation matrix (transformation function) with which failures in images are not noticeable both in the micro view and in the macro view by prorating the homogeneous transformation matrix H′_{1,s} and the homogeneous transformation matrix H″ _{1,s}, which are acquired under different conditions, in accordance with the positions on the captured image as described above. With such processing, it is possible to acquire a panoramic image with a high quality, which includes less failures.

In this embodiment, the s-th captured image corresponds to the partial group A1 in FIGS. 48 to 51, and the s+1-th captured image corresponds to the group B1. Accordingly, the map H1 is the homogeneous transformation matrix H′_{1,s+1}, and the map H2 is the homogeneous transformation matrix H″_{1,s+1}. Furthermore, the partial group B2 is the position (X(s+1,s,k), Y(s+1,s,k)), and the group F(B2) is the position (X(s,s+1,k), Y(s,s+1,k)).

### Seventh Embodiment

### Application of Present Technology to Technology in Relation to Color Phase Matching

Although the above description was given of the case where the present technology was applied to the technology in relation to the positioning, description of the case where the present technology is applied to the technology in relation to color phase matching will be given below.

For example, it is assumed that N captured images are captured while an imaging device such as a digital camera is moved in the horizontal direction (X-axis direction). In addition, it is assumed that these captured images are captured such that projected images thereof include 20% overlapping parts.

That is, the region ImR(k) in the k-th captured image PZ(k) on the right side in FIG. 41 and the region ImL(k+1) in the k+1-th captured image PZ(k+1) on the left side in FIG. 41 are parts where the same object is imaged as described above with reference to FIG. 41. In addition, k=1 to N−1, and the region ImR(k) and the region ImL(k+1) are regions with areas corresponding to 20% of the entire regions of the respective captured images.

According to the present technology, an average value of pixel values of pixels in the region ImR(k) and an average value of pixel values of pixels in the region ImL(k+1) are compared, and a gain value between the mutually adjacent k-th and the k+1-th captured images is determined.

Specifically, the following Equation (120) is calculated to acquire a gain value Gain′_{k,k+1}(R), a gain value Gain′_{k,k+1}(G), and a gain value Gain′_{k,k+1}(B), and the following Equation (121) is calculated to acquire a gain value Gain″_{k,k+1}(R), a gain value Gain″_{k,k+}(G), and a gain value Gain″_{k,k+1}(B).

$$\begin{matrix} [ Math . 120 ] & \\ \begin{matrix}\begin{matrix}{Gain}_{k , k + 1}^{′} ( R ) = \frac{{\sum }_{( x , y ) ∈ ImR ( k )} \{ {R}_{k} ( x , y ) \}}{{\sum }_{( x , y ) ∈ ImL ( k + 1 )} \{ {R}_{k + 1} ( x , y ) \}} \\ {Gain}_{k , k + 1}^{′} ( G ) = \frac{{\sum }_{( x , y ) ∈ ImR ( k )} \{ {G}_{k} ( x , y ) \}}{{\sum }_{( x , y ) ∈ ImL ( k + 1 )}^{ } \{ {G}_{k + 1} ( x , y ) \}}\end{matrix} \\ {Gain}_{k , k + 1}^{′} ( B ) = \frac{{\sum }_{( x , y ) ∈ ImR ( k )} \{ {B}_{k} ( x , y ) \}}{{\sum }_{( x , y ) ∈ ImL ( k + 1 )} \{ {B}_{k + 1} ( x , y ) \}}\end{matrix} \} & ( 120 ) \\ [ Math . 121 ] & \\ \begin{matrix}\begin{matrix}{Gain}_{k , k + 1}^{″} ( R ) = \frac{{\sum }_{( x , y ) ∈ ImR ( k )} \{ \frac{{R}_{k} ( x , y ) + {G}_{k} ( x , y ) + {B}_{k} ( x , y )}{3} \}}{{\sum }_{( x , y ) ∈ ImL ( k + 1 )} \{ \frac{{R}_{k + 1} ( x , y ) + {G}_{k + 1} ( x , y ) + {B}_{k + 1} ( x , y )}{3} \}} \\ {Gain}_{k , k + 1}^{″} ( G ) = {Gain}_{k , k + 1} ( R )\end{matrix} \\ {Gain}_{k , k + 1}^{″} ( B ) = {Gain}_{k , k + 1} ( R )\end{matrix} \} & ( 121 )\end{matrix}$$

In addition, the gain value Gain′_{k,k+1}(R), the gain value Gain and gain value Gain′_{k,k+1}(G), and the gain value Gain′_{k,k+1}(B) are a gain value of the red component, a gain value of a green component, and a gain value of a blue component between the k-th and the k+1-th captured images, respectively. Similarly, the gain value Gain″_{k,k+1}(R), the gain value Gain″_{k,k+1} (G), and the gain value Gain″_{k,k+1}(B) are a gain value of the red component, a gain value of the green component, and a gain value of the blue component between the k-th and the k+1-th captured images, respectively.

In Equation (120), the gain value Gain′_{k,k+1}(R) is acquired by dividing a sum ΣRₖ(x,y) of the red components (pixel values) of the respective pixels in the region ImR(k) by a sum ΣRₖ₊₁(x,y) of the red components (pixel values) of the respective pixels in the region ImL(k+1).

In Equation (121), average values of the red, green, and blue color components of each pixel in the region ImR(k) are acquired, and the sum of the average values of the color components acquired for the respective pixels are acquired. Furthermore, average values of the red, green, and blue color components of each pixel in the region ImL(K+1), and the sum of the average values of the color components acquired for the respective pixels is acquired. Then, the sum of the average values of the color components acquired for the region ImR(K) is divided by the sum of the average values of the color components acquired for the region ImL(k+1), and the results are regarded as the gain value Gain″_{k,k+1}(R), the gain value Gain″_{k,k+1}(G), and the gain value Gain″_{k,k+1}(B).

If the respective gain values between the adjacent captured images are acquired as described above, then the gain values of the respective captured images with reference to the first captured image are acquired.

That is, the following Equation (122) is calculated to acquire the gain value Gain′_{1,s}(R), the gain value Gain′_{1,s}(G), and the gain value Gain′_{1,s}(B), and the following Equation (123) is calculated to acquire the gain value Gain″_{1,s}(R), the gain value Gain″_{1,s}(G), and the gain value Gain″_{1,s}(B).

$$\begin{matrix}[ Math . 122 ] & \\ \begin{matrix}\begin{matrix}\begin{matrix}{Gain}_{1 , s}^{′} ( R ) ≡ ( {\prod }_{t = 1}^{s - 2} {Gain}_{t , t + 1}^{″} ( R ) ) {Gain}_{s - 1 , s}^{′} ( R ) \\ = {Gain}_{1 , 2}^{″} ( R ) {Gain}_{2 , 3}^{″} ( R ) … \\ {Gain}_{s - 2 , s - 1}^{″} ( R ) {Gain}_{s - 1 , s}^{′} ( R )\end{matrix} \\ \begin{matrix}{Gain}_{1 , s}^{′} ( G ) ≡ ( {\prod }_{t = 1}^{s - 2} {Gain}_{t , t + 1}^{″} ( G ) ) {Gain}_{s - 1 , s}^{′} ( G ) \\ = {Gain}_{1 , 2}^{″} ( G ) {Gain}_{2 , 3}^{″} ( G ) … \\ {Gain}_{s - 2 , s - 1}^{″} ( G ) {Gain}_{s - 1 , s}^{′} ( G )\end{matrix}\end{matrix} \\ \begin{matrix}{Gain}_{1 , s}^{′} ( B ) ≡ ( {\prod }_{t = 1}^{s - 2} {Gain}_{t , t + 1}^{″} ( B ) ) {Gain}_{s - 1 , s}^{′} ( B ) \\ = {Gain}_{1 , 2}^{″} ( B ) {Gain}_{2 , 3}^{″} ( B ) … \\ {Gain}_{s - 2 , s - 1}^{″} ( B ) {Gain}_{s - 1 , s}^{′} ( B )\end{matrix}\end{matrix} \} & ( 122 ) \\ [ Math . 123 ] & \\ \begin{matrix}\begin{matrix}\begin{matrix}{Gain}_{1 , s}^{″} ( R ) ≡ ( {\prod }_{t = 1}^{s - 2} {Gain}_{t , t + 1}^{″} ( R ) ) {Gain}_{s - 1 , s}^{″} ( R ) \\ = ( {\prod }_{t = 1}^{s - 1} {Gain}_{t , t + 1}^{″} ( R ) ) \\ = {Gain}_{1 , 2}^{″} ( R ) {Gain}_{2 , 3}^{″} ( R ) … \\ {Gain}_{s - 2 , s - 1}^{″} ( R ) {Gain}_{s - 1 , s}^{″} ( R )\end{matrix} \\ \begin{matrix}{Gain}_{1 , s}^{″} ( G ) ≡ ( {\prod }_{t = 1}^{s - 2} {Gain}_{t , t + 1}^{″} ( G ) ) {Gain}_{s - 1 , s}^{″} ( G ) \\ = ( {\prod }_{t = 1}^{s - 1} {Gain}_{t , t + 1}^{″} ( G ) ) \\ = {Gain}_{1 , 2}^{″} ( G ) {Gain}_{2 , 3}^{″} ( G ) … \\ {Gain}_{s - 2 , s - 1}^{″} ( G ) {Gain}_{s - 1 , s}^{″} ( G )\end{matrix}\end{matrix} \\ \begin{matrix}{Gain}_{1 , s}^{″} ( B ) ≡ ( {\prod }_{t = 1}^{s - 2} {Gain}_{t , t + 1}^{″} ( B ) ) {Gain}_{s - 1 , s}^{″} ( B ) \\ = ( {\prod }_{t = 1}^{s - 1} {Gain}_{t , t + 1}^{″} ( B ) ) \\ = {Gain}_{1 , 2}^{″} ( B ) {Gain}_{2 , 3}^{″} ( B ) … \\ {Gain}_{s - 2 , s - 1}^{″} ( B ) {Gain}_{s - 1 , s}^{″} ( B )\end{matrix}\end{matrix} \} & ( 123 )\end{matrix}$$

In Equation (122), for example, the gain value Gain″_{1,2}(R) to the gain value Gain″_{s-2,s-1}(R) are accumulated, and the accumulation result is further multiplied by the gain value Gain′_{s-1,s}(R), and the gain value Gain′_{1,s}(R) is calculated. In addition, the gain value Gain′_{1,s}(G) and the gain value Gain′_{1,s}(B) are calculated in the same manner as the gain value Gain′_{1,s}(R).

What should be noted here is that the gain values between the adjacent captured images, which are accumulated by Equation (122), are gain values acquired by Equation (121).

Furthermore, in Equation (123), the gain value Gain″_{1,2}(R) to the gain value Gain″_{s-1,s}(R) are accumulated, and the gain value Gain″_{1,s}(R) is calculated. In addition, the gain value Gain″_{1,s}(G) and the gain value Gain″_{1,s}(B) are calculated in the same manner as the gain value Gain″_{1,s}(R).

In addition, the gain value Gain′_{1,s}(G), the gain value Gain′_{1,s}(R), and the gain value Gain′_{1,s}(B) are a gain value of the red component, a gain value of the green component, and a gain value of the blue component of the s-th captured image with reference to the first captured image, respectively. Similarly, the gain value Gain″_{1,s}(R), the gain value Gain″_{1,s}(G), and the gain value Gain″_{1,s}(B) are a gain value of the red component, a gain value of the green component, and a gain value of the blue component of the s-th captured image with reference to the first captured image, respectively.

In addition, it is assumed that all the gain value Gain′_{1,s}(R), the gain value Gain′_{1,s}(G), the gain value Gain′_{1,s}(B), the gain value Gain″_{1,s}(R), the gain value Gain″_{1,s}(G), and the gain value Gain″_{1,s}(B) when s=1 are 1.

The gain value Gain′_{1,s}(R), the gain value Gain′_{1,s}(G), the gain value Gain′_{1,s}(B), the gain value Gain″_{1,s}(R), the gain value Gain″_{1,s}(G), and the gain value Gain″_{1,s}(B) of each captured image with reference to the first captured image, which are represented by Equation (122) and Equation (123), have the following characteristic.

That is, it is assumed that the respective color components in the k-th captured image are multiplied by gain values, namely the gain value Gain″_{1,k}(R), the gain value Gain″_{1,k}(G), and the gain value Gain″_{1,k}(B) represented by Equation (123) when the pixel values of the pixel on the captured images are mapped on the panoramic image.

In addition, it is assumed that the respective color components in the k+1-th captured image are multiplied by gain values, namely the gain value Gain′_{1,k+1}(R), the gain value Gain′_{1,k+1}(G), and the gain value Gain′_{1,k+1}(B) represented by Equation (122).

If the gain value Gain″1,k(R) and the gain value Gain′_{1,k+1}(R) are mentioned again, these gain values are gain values acquired by calculation represented by the following Equation (124). The cases of the other colors (green and blue) are the same as the case of the red, which is represented by Equation (124).

$$\begin{matrix}[ Math . 124 ] & \\ \begin{matrix}\begin{matrix}{Gain}_{1 , k}^{″} ( R ) ≡ ( {\prod }_{t = 1}^{k - 1} {Gain}_{t , t + 1}^{″} ( R ) ) \\ = {Gain}_{1 , 2}^{″} ( R ) {Gain}_{2 , 3}^{″} ( R ) … \\ {Gain}_{k - 2 , k - 1}^{″} ( R ) {Gain}_{k - 1 , k}^{″} ( R )\end{matrix} \\ \begin{matrix}{Gain}_{1 , k + 1}^{′} ( R ) ≡ ( {\prod }_{t = 1}^{k - 1} {Gain}_{t , t + 1}^{″} ( R ) ) {Gain}_{k , k + 1}^{′} ( R ) \\ = {Gain}_{1 , 2}^{″} ( R ) {Gain}_{2 , 3}^{″} ( R ) … \\ {Gain}_{k - 2 , k - 1}^{″} ( R ) {Gain}_{k - 1 , k}^{″} ( R ) {Gain}_{k , k + 1}^{′} ( R )\end{matrix}\end{matrix} \} & ( 124 )\end{matrix}$$

As can be understood from Equation (124), the multiplication by the gains in relation to the red components in the k+1-th captured image differs from the multiplication by the gains in relation to the red components in the k-th captured image by a value corresponding to the gain value Gain′_{k,k+1}(R).

That is, a gain ratio between the k-th and the k+1-th captured images becomes a gain ratio represented by Equation (120), which is acquired under the condition that the gain values of the respective colors may be independently calculated, that is, under the generous condition if the pixel values of the pixels in the k+1-th captured image are multiplied by the gain values as described above. Accordingly, the level difference of the red component is not noticeable at the boundary between the k-th captured image and the k+1-th captured image on the generated panoramic image in this case.

In addition, it is not necessary to multiply pixel values of all the pixels in the k-th captured image by the gain value Gain″_{1,k}(R) and to multiply pixel values of all the pixels in the k+1-th captured image by the gain value Gain′_{1,k+1}(R).

It is sufficient to multiply only a part, which is adjacent to the k+1-th captured image, in the k-th captured image by the gain value Gain″_{1,k}(R) and to multiply only a part, which is adjacent to the k-th captured image, in the k+1-th captured image by the gain value Gain′_{1,k+1}(R). It is not necessary to multiply the other parts in the k-th and the k+1-th captured images by the gain value Gain″_{1,k}(R) or the gain value Gain′_{1,k+1}(R).

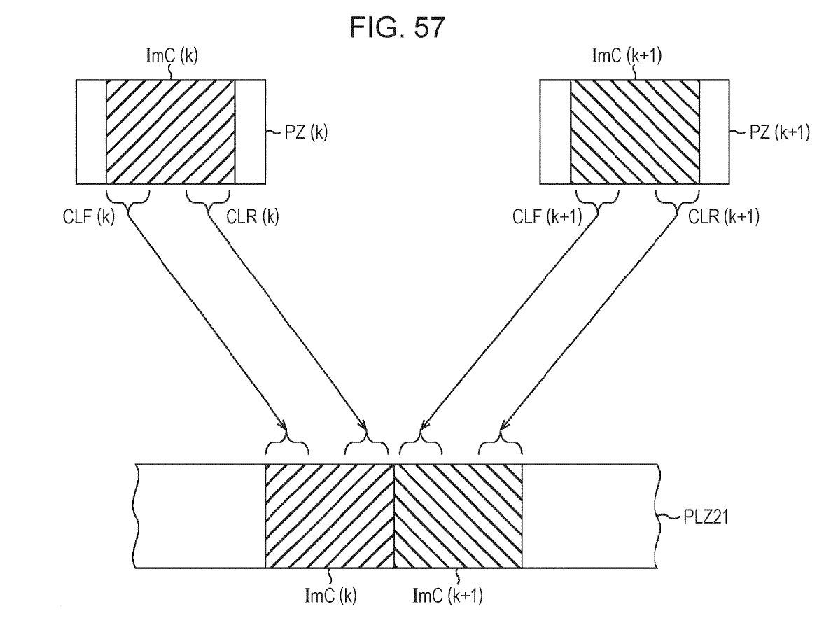

That is, if the respective regions in the captured images are multiplied by the gain values as shown in FIG. 57, it is possible to make the level difference of the red components unnoticeable at the boundary between the k-th captured image and the k+1-th captured image on the panoramic image PLZ21. In FIG. 57, the same reference numerals are given to parts corresponding to those in FIG. 42, and the description thereof will be appropriately omitted.

In FIG. 57, a center region ImC(k) of the k-th captured image PZ(k) and a center region ImC(k+1) of the k+1-th captured image PZ(k+1) are arranged on the panoramic image PLZ21. Here, the region ImC(k) and the region ImC(k+1) are regions with the sizes of 80% of the entire regions of the captured images, which are at the centers of the captured images, respectively.

When the region ImC(k) is arranged on the panoramic image PLZ21, a part corresponding to the region CLR(k) in the region ImC(k) on the right side in the drawing is arranged on the panoramic image PLZ21 after the red components of pixel values of pixels in the region CLR(k) are multiplied by the gain value Gain″_{1,k}(R). As for a part corresponding to a region CLF(k) in the region ImC(k) on the left side in the drawing, it is not necessary to multiply the red components of pixel values of pixels in the region CLF(k) by the gain value Gain″_{1,k}(R).

In addition, when the region ImC(k+1) is arranged on the panoramic image PLZ21, a part corresponding to a region CLF(k+1) in the region ImC(k+1) on the left side in the drawing is arranged on the panoramic image PLZ21 after the red components of pixel values of pixels in the region CLF(k+1) are multiplied by the gain value Gain′_{1,k+1}(R). As for a part corresponding to a region CLR(k+1) in the region ImC(k+1) on the right side in the drawing, it is not necessary to multiply the red components of pixel values of pixels in the region CLR(k+1) by the gain value Gain′_{1,k+1} at this time.

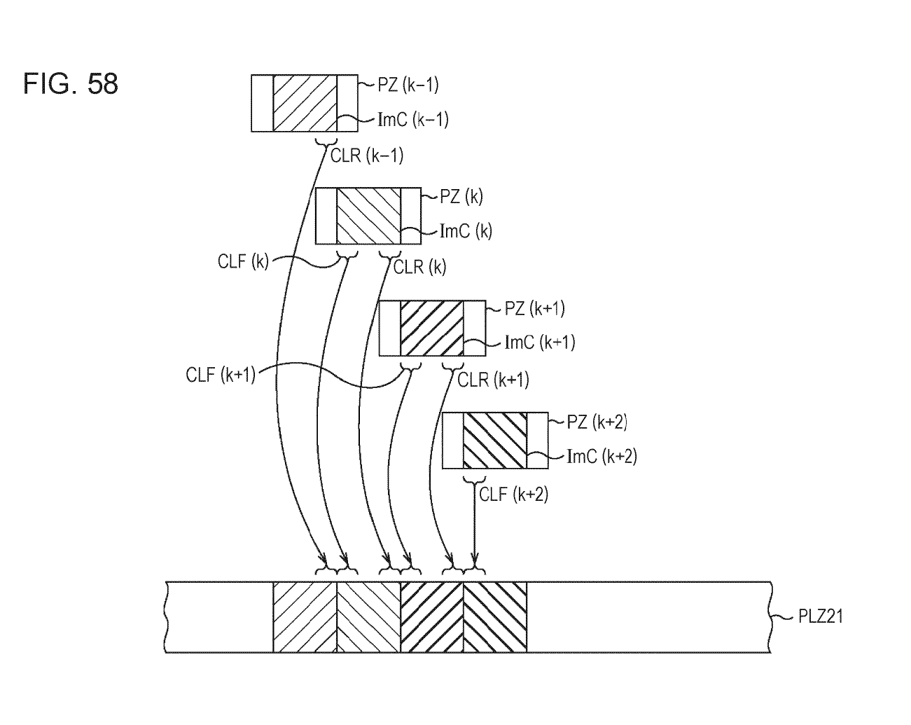

According to the present technology, the respective captured images are arranged on the panoramic image PLZ21 as shown in FIG. 58 paying attention to the above descriptions. In FIG. 58, the same reference numerals are given to parts corresponding to those in FIG. 57, and the description thereof will be appropriately omitted.

In this example, when the region ImC(k−1) to the region ImC(k+2) in the respective captured images are mapped on the panoramic image PLZ21, pixel values of pixels in these regions are multiplied by the gain values. Although description will be given of the red components among the respective color components in FIG. 58, the same processing is performed on the other color components.

That is, a part corresponding to a region CLR(k−1) in the region ImC(k−1), which is at the center of the k−1-th captured image PZ(k−1), on the right side in the drawing is arranged on the panoramic image PLZ21 after the red components of the pixel values of the pixels are multiplied by the gain value Gain″_{1,k-1}(R).

In addition, a part corresponding to a region CLF(k) in the region ImC(k), which is at the center of the k-th captured image PZ(k), on the left side in the drawing is arranged on the panoramic image PLZ21 after the red components of the pixel values of the pixels are multiplied by the gain value Gain′_{1,k}(R). A part corresponding to the region CLR(k) in the region ImC(k) on the right side in the drawing is arranged on the panoramic image PLZ21 after the red components of the pixel values of the pixels are multiplied by the gain value Gain″_{1,k}(R).

Furthermore, a part corresponding to a region CLF(k+1) in the region ImC(k+1), which is at the center of the k+1-th captured image PZ(k+1), on the left side in the drawing is arranged on the panoramic image PLZ21 after the red components of the pixel values of the pixels are multiplied by the gain value Gain′_{1,k+1}(R). A part corresponding to a region CLR(k+1) in the region ImC(k+1) on the right side in the drawing is arranged on the panoramic image PLZ21 after the red components of the pixel values of the pixels are multiplied by the gain value Gain″_{1,k+1}(R).

In addition, a part corresponding to a region CLF(k+2) in the region ImC(k+2), which is at the center of the k+2-th captured image PZ(k+2), on the left side in the drawing is arranged on the panoramic image PLZ21 after the red components of the pixel values of the pixels are multiplied by the gain value Gain′_{1,k+2}(R).

It is possible to make the level difference of the respective color components unnoticeable at the boundaries of the respective captured images by mapping the respective regions on the panoramic image PLZ21 after the multiplication by the gain values.

Furthermore, a value which is multiplied when the respective colors in the respective captured images are multiplied by the gains is a value represented by Equation (122) or Equation (123). As can be clearly understood from Equation (121), the gain value Gain″_{1,s}(R), the gain value Gain″_{1,s}(G), and the gain value Gain″_{1,s}(B) in Equation (123) are the same values. Accordingly, the respective regions on the panoramic image have appropriate color phases.

Although the gain value Gain′_{1,s}(R), the gain value Gain′_{1,s}(G), and the gain value Gain′_{1,s}(B) represented by Equation (122) are not the same value in a strict sense, the differences thereof are only the gain values Gain′_{s-1,s}(R), Gain′_{s-1,s}(G), and Gain′_{s-1,s}(B) as the last items on the right sides of the respective equations in Equation (122).

For this reason, the differences in the gain values of the respective color components are not accumulated in Equation (122), and therefore, the gain value Gain′_{1,s}(R), the gain value Gain′_{1,s}(G), and the gain value Gain′_{1,s}(B) are substantially equal to each other, and the difference in these gain values is within an allowable range. That is, the difference in the gain values is not at a level at which humans can sense the difference, and it is possible to state that the color phases in the respective regions are appropriate.

The above description was given with reference to the drawings, and more specifically, it is only necessary to perform gain correction represented by the following Equation (125) on the respective colors when the pixel value of the pixel at each position (Xₛ, Yₛ) in each captured image (s-th captured image) is mapped on the panoramic image.

$$\begin{matrix}[ Math . 125 ] & \\ \begin{matrix}\begin{matrix}\begin{matrix}GainR ( s , {X}_{s} , {Y}_{s} ) = ( \begin{matrix}( 1 - Weight ) \times {Gain}_{1 , s}^{′} ( R ) + \\ Weight \times {Gain}_{1 , s}^{″ } ( R )\end{matrix} ) , \\ GainG ( s , {X}_{s} , {Y}_{s} ) = ( \begin{matrix}( 1 - Weight ) \times {Gain}_{1 , s}^{′} ( G ) + \\ Weight \times {Gain}_{1 , s}^{″ } ( G )\end{matrix} ) ,\end{matrix} \\ GainB ( s , {X}_{s} , {Y}_{s} ) = ( \begin{matrix}( 1 - Weight ) \times {Gain}_{1 , s}^{′} ( B ) + \\ Weight \times {Gain}_{1 , s}^{″ } ( B )\end{matrix} ) ,\end{matrix} \\ Where Weight ≡ \frac{{X}_{s} + ( Width / 2 )}{Width} .\end{matrix} \} & ( 125 )\end{matrix}$$

In Equation (125), the gain value GainR(s, Xₛ/Yₛ), the gain value GainG(s, Xₛ, Yₛ), and the gain value GainB(s, Xₛ. Yₛ) are a gain value of the red component, a gain value of a green component, and a gain value of a blue component of a pixel at a position (Xₛ, Yₛ) in the s-th captured image with reference to the first captured image. In Equation (125), Width represents a width of a region ImC(s) in the horizontal direction on the captured image.

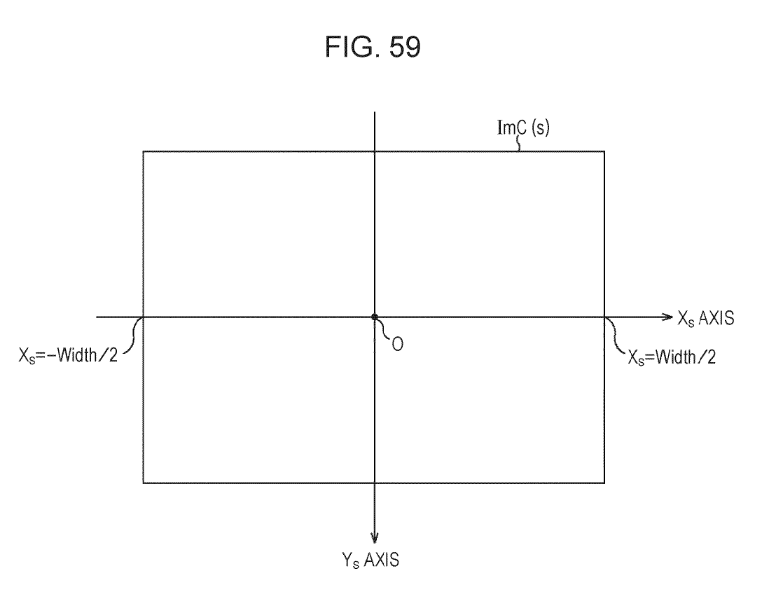

Here, a center position of the region ImC(s) at the center of each captured image, namely the s-th captured image PZ(s) (where s=1 to N) corresponds to an origin O in a coordinate system (Xₛ, Yₛ) with reference to the s-th captured image PZ(s) as shown in FIG. 59.

In addition, the horizontal direction and the vertical direction in the drawing represent an Xₛ-axis direction and a Yₛ-axis direction in the coordinate system with reference to the s-th captured image PZ(s), respectively. Moreover, the region ImC(s) is a region with a size of 80% of the entire region of the captured image PZ(s).

In the example of FIG. 59, the width of the region ImC(s) in the horizontal direction is represented as Width. In addition, Xₛ coordinates of the region ImC(s) at the left end and the right end in the drawing are represented as −Width/2 and Width/2.

Since the respective captured images are captured while the imaging device is panned in the right direction in the drawing (the positive direction of the Xₛ axis) during imaging, a region in the region ImC(s) in the vicinity of the left end in the drawing, namely in the vicinity of Xₛ=−Width/2 corresponds to the boundary with the s−1-th captured image PZ(s−1). In addition, a region in the region ImC(s) in the vicinity of the right end in the drawing, namely in the vicinity of Xₛ=Width/2 corresponds to the boundary with the s+1-th captured image PZ(s+1).

The gain value GainR(s, Xₛ, Yₛ) represented by Equation (125) is a gain of the green component to be multiplied when the pixel value of the pixel at the position (Xₛ, Yₛ) in the s-th captured image is mapped on the panoramic image.

In addition, the gain value GainG(s, Xₛ, Yₛ) represented by Equation (125) is a gain of the green component to be multiplied when the pixel value of the pixel at the position (Xₛ, Yₛ) in the s-th captured image is mapped on the panoramic image. Furthermore, the gain value GainB(s, Xₛ, Yₛ) represented by Equation (125) is a gain of the blue component to be multiplied when the pixel value of the pixel at the position (Xₛ, Yₛ) in the s-th captured image is mapped on the panoramic image.

By applying the present technology to the technology for color phase matching as described above, it is possible to acquire an appropriate map (transformation function) which is represented by Equation (125) and represents gain values of the respective colors in each captured image with reference to the first captured image.

### [Configuration Example of Image Processing Apparatus]

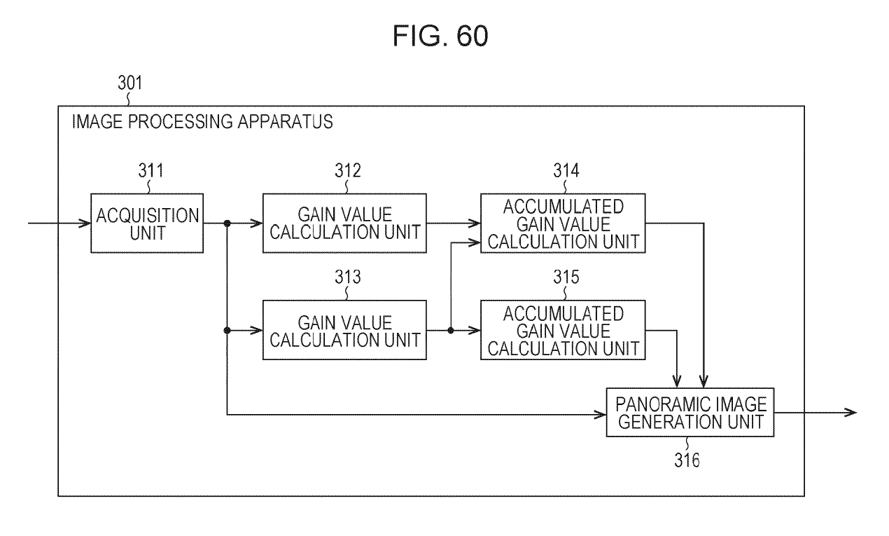

Next, description will be given of a specific embodiment to which the present technology is applied. FIG. 60 is a diagram showing a configuration example of an embodiment of an image processing apparatus to which the present technology is applied.

An image processing apparatus 301 in FIG. 60 is configured of an acquisition unit 311, a gain value calculation unit 312, a gain value calculation unit 313, an accumulated gain value calculation unit 314, an accumulated gain value calculation unit 315, and a panoramic image generation unit 316.

The acquisition unit 311 acquires N captured images which are successively captured while an imaging device such as a digital camera is rotated, and supplies the captured images to the gain value calculation unit 312, the gain value calculation unit 313, and the panoramic image generation unit 316.

The gain value calculation unit 312 calculates gain values between adjacent captured images under a condition that the gain values of the respective colors are independent, based on the captured images supplied from the acquisition unit 311, and supplies the gain values to the accumulated gain value calculation unit 314.

The gain value calculation unit 313 calculates gain values between adjacent captured images under a condition that the gain values of the respective colors are the same, based on the captured images supplied from the acquisition unit 311, and supplies the gain values to the accumulated gain value calculation unit 314 and the accumulated gain value calculation unit 315.

The accumulated gain value calculation unit 314 accumulates the gain values from the gain value calculation unit 312 and the gain values from the gain value calculation unit 313, calculates the gain values of the respective captured images with reference to the first captured image, and supplies the gain value to the panoramic image generation unit 316. The accumulated gain value calculation unit 315 accumulates the gain value from the gain value calculation unit 313, calculates the gain values of the respective captured images with reference to the first captured image, and supplies the gain values to the panoramic image generation unit 316.

The panoramic image generation unit 316 generates a panoramic image based on the captured images supplied from the acquisition unit 311, the gain values supplied from the accumulated gain value calculation unit 314, and the gain values supplied from the accumulated gain value calculation unit 315, and outputs the panoramic image.

### [Description of Panoramic Image Generation Processing]

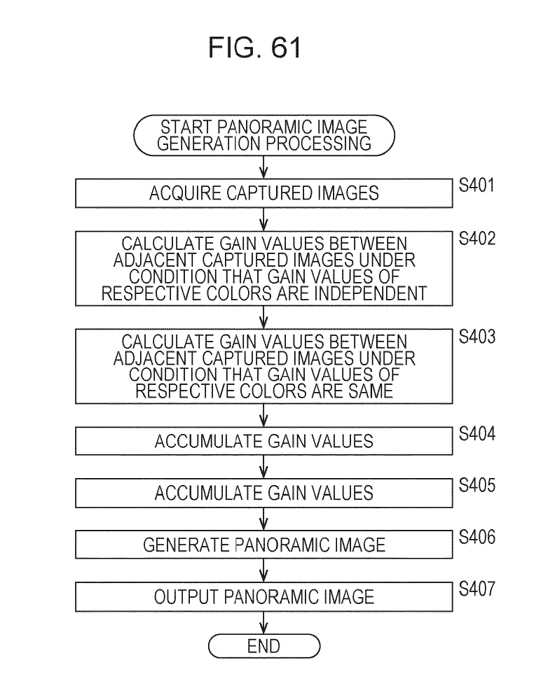

Next, description will be given of panoramic image generation processing by the image processing apparatus 301 with reference to the flowchart in FIG. 61.

In Step S401, the acquisition unit 311 acquires N captured images which are successively captured while the imaging device is rotated in the positive direction of the X axis, and supplies the captured images to the gain value calculation unit 312, the gain value calculation unit 313, and the panoramic image generation unit 316. In addition, the respective captured images are captured such that mutually adjacent captured images intersect (overlap) at regions corresponding to 20% of the entire areas of the captured images as shown in FIG. 41, for example.

In Step S402, the gain value calculation unit 312 calculates the gain values between the adjacent captured images under the condition that the gain values of the respective colors are independent by calculating Equation (120) based on pixel values of pixels in the regions, which overlap with the adjacent captured images, in the respective captured images, which are supplied from the acquisition unit 311.

With such processing, a gain value Gain_{k,k+1}(R), a gain value Gain′_{k,k+1}(G)ᵣ and a gain value Gain′_{k,k+1}(B) (where k=1 to N−1) of the respective color components are calculated. The gain value calculation unit 312 supplies the calculated gain values to the accumulated gain value calculation unit 314.

In Step S403, the gain value calculation unit 313 calculates the gain values between the adjacent captured images under the condition that the gain values of the respective colors are the same by calculating Equation (121) based on the pixel values of the pixels in the regions, which overlap with the adjacent captured images, in the respective captured images, which are supplied from the acquisition unit 311.

With such processing, a gain value Gain″_{k,k+1}(R), a gain value Gain″_{k,k+1}(G), and a gain value Gain″_{k,k+1}(B) (where k=1 to N−1) of the respective color components are calculated. The gain value calculation unit 313 supplies the calculated gain values to the accumulated gain value calculation unit 314 and the accumulated gain value calculation unit 315.

In Step S404, the accumulated gain value calculation unit 314 performs calculation of Equation (122) to accumulate the gain values from the gain value calculation unit 312 and the gain values from the gain value calculation unit 313, and calculates gain values of the respective captured images with reference to the first captured images.

With such processing, a gain value Gain′_{1,s}(R), a gain value Gain′_{1,s}(G), and a gain value Gain′_{1,s}(B) (where s=1 to N) of the respective colors are calculated. The accumulated gain value calculation unit 314 supplies the calculated gain value to the panoramic image generation unit 316.

In Step S405, the accumulated gain value calculation unit 315 performs calculation of Equation (123) to accumulate the gain values from the gain value calculation unit 313, and calculates gain values of the respective captured images with reference to the first captured image.

With such processing, a gain value Gain″_{1,s}(R), a gain value Gain″_{1,s}(G), and a gain value Gain″_{1,s}(B) (where s=1 to N) of the respective colors are calculated. The accumulated gain value calculation unit 315 supplies the calculated gain value to the panoramic image generation unit 316.

In addition, it is assumed that all the gain value Gain′_{1,s}(R), the gain value Gain′_{1,s}(G), the gain value Gain′_{1,s}(B), the gain value Gain″_{1,s}(R), the gain value Gain″_{1,s}(G), and the gain value Gain″_{1,s}(B) when s=1 are 1 in Step S404 and Step S405.

In Step S406, the panoramic image generation unit 316 generates a panoramic image based on the captured images supplied from the acquisition unit 311, the gain values supplied from the accumulated gain value calculation unit 314, and the gain values supplied from the accumulated gain value calculation unit 315.

Specifically, the panoramic image generation unit 316 multiplies a pixel value of a pixel at a position (Xₛ, Yₛ) in the region ImC(s) at the center of the s-th (where s−1 to N) captured image by the gain value represented by Equation (125).

For example, a value of red component configuring a pixel value of a pixel is multiplied by the gain value GainR(s, X_{S}, Yₛ) represented by Equation (125), and the red component is multiplied by the gain value. That is, the panoramic image generation unit 316 acquires a final gain value GainR(s, Xₛ, Yₛ) for the position (Xₛ, Yₛ) by performing weighted addition (proration) on the gain value Gain′_{1,s}(R) and the gain value Gain″_{1,s}(R) while applying a weight in accordance with the position (Xₛ, Yₛ) on the captured image. Then, the panoramic image generation unit 316 multiplies the red component of the pixel value of the pixel at the position (Xₛ, Yₛ) by the acquired gain value GainR(s, Xₛ, Yₛ).

Similarly, the green component and the blue component of the pixel are multiplied by the gain values GainG(s, Xₛ, Yₛ) and the gain value GainB(s, Xₛ, Yₛ), and gain correction of the respective color components is performed.

If the gain correction of the pixel values of the pixels in the region ImC(s) is performed as described above, the panoramic image generation unit 316 maps the pixel values of the pixels at the respective positions (Xₛ, Yₛ) after the gain correction on the panoramic image to be generated.

For example, a position, at which the pixel value of the pixel at each position (Xₛ, Yₛ) is mapped, on the panoramic image is a position determined by the homogeneous transformation matrix which represents the positional relationship between the first captured image and the s-th captured image. For example, the homogeneous transformation matrix may be acquired by the panoramic image generation unit 316 based on the captured images or may be acquired by the panoramic image generation unit 316 from the outside via the acquisition unit 311.

In Step S407, the panoramic image generation unit 316 outputs the generated panoramic image, and the panoramic image generation processing is completed.

As described above, the image processing apparatus 301 calculates gain values between adjacent captured images under two different conditions and acquires gain values between the first and the s-th captured images from the acquired gain value. Then, the image processing apparatus 301 performs gain corrections on the pixels in the captured images by using final gain values which are acquired by prorating the gain values between the first and the s-th captured images acquired under the different conditions in accordance with the positions on the captured images, and generates the panoramic image.

It is possible to acquire gain values (transformation functions) with which failures in the images are unnoticeable both in the micro view and in the macro view by prorating the gain values acquired under different conditions in accordance with the positions on the captured images. With such a configuration, it is possible to acquire a panoramic image with high quality, which includes less failures.

In this embodiment, the region ImC(s) with the size of 80% of the entire size of the captured image, which is at the center of the s-th captured image, corresponds to the partial group A1 in FIGS. 48 to 51, and the region ImC(s+1) in the s+1-th captured image corresponds to the group B1.

Accordingly, the map H1 is the gain value Gain′_{1,s}(R), the gain value Gain′_{1,s}(G), and the gain value Gain′_{1,s}(B) which represent gains of the respective red, green, and blue color components configuring a pixel value. In addition, the map H2 is the gain value Gain″_{1,s}(R), the gain value Gain″_{1,s}(G), and the gain value Gain″_{1,s}(B) which represent the gains of the respective red, green, and blue color components configuring a pixel value. Furthermore, the partial group B2 corresponds to the left end, namely the end on the side of the region ImC(s) of the region ImC(s+1), and the group F(B2) corresponds to the right end, namely the end on the side of the region ImC(s+1) of the region ImC(s).

### [Advantages of Present Technology]

Finally, advantages of the present technology described in the sixth embodiment and the seventh embodiment will be conceptually described.

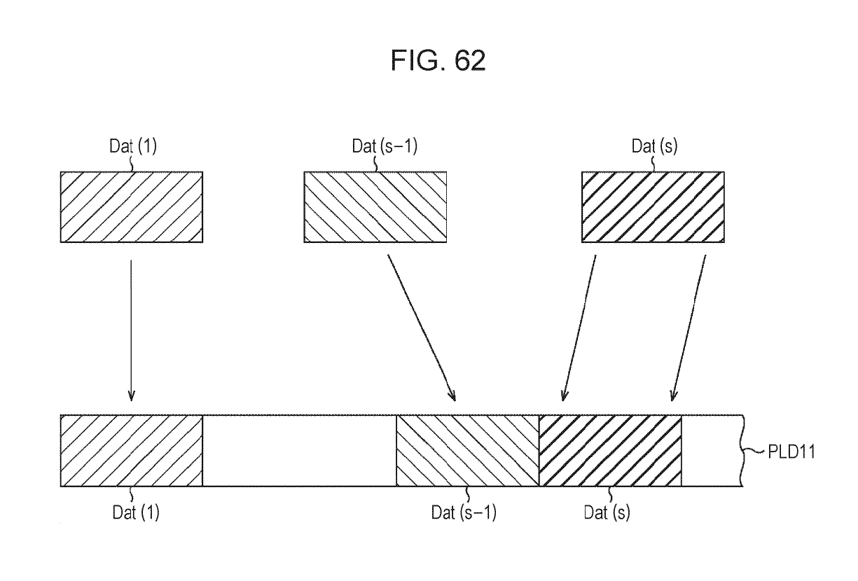

It is assumed that a plurality of data items including data Dat(1), data Dat(2), . . . , data Dat(s−1), data Dat(s), data Dat(s+1), . . . are provided as shown in FIG. 62, for example. In FIG. 62, illustration of the data Dat(2) to the data Dat(s−2) and the data after the data Dat(s+1) is omitted.

The present technology is for providing a method suitable for a case of generating a single data item PLD11 by connecting these provided data items.

According to the present technology, correlations of mutually adjacent data Dat(k), which are optimal under a strict condition, are acquired first.

In this case, no failures occur in the relationship of the data Dat(k) with reference to the data Dat(1), which is acquired by accumulating acquired correlations, since the strict condition is applied. However, the correlations between adjacent data items are not satisfactory even after the optimization since the strict condition with a low degree of freedom is applied.

Next, correlations of the mutually adjacent data Dat(k), which are optimal under a generous condition, are acquired.

In this case, the correlations of the adjacent data items are satisfactory due to the optimization since only the condition with a high degree of freedom, namely the generous condition is applied.

Target data is arranged on the data PLD11 such that the relationship acquired under the generous condition is achieved on the side, which is close to data represented by a smaller number than that of the target data, in the target data. In contrast, the target data is arranged on the data PLD11 such that the relationship acquired under the strict condition is achieved on the side, which is far from the data represented by a smaller number than that of the target data.

If attention is paid to the data Dat(s), for example, the data Dat(s) is arranged on the data PLD11 such that a relationship between the data Dat(s) and the data Dat(s−1) becomes a relationship acquired under the generous condition at a part of the data Dat(s) on the left side in the drawing.

In addition, the data Dat(s) is arranged on the data PDL11 such that the relationship between the data Dat(s) and the data Dat(s−1) becomes a relationship acquired under the strict condition at a part of the data Dat(s) on the right side in the drawing.

By arranging the respective data items on the data PLD11 as described above, it is possible to achieve arrangement with no failures both in the macro view and in the micro view.

The processing will be generalized and described as follows.

That is, it is assumed that there is a partial group A1 in a first distance space (A, d), that there is a partial group B2 in a second distance space B1, and that a map from the partial group B2 to the partial group A1 is represented as F. Here, both the first distance space (A, d) and the second distance space B1 are Euclidean spaces.

At this time, a continuous map H₁ which satisfies the following Equation (126) is acquired for an arbitrary continuous map H′ from the second distance space B1 to the first distance space (A, d), which satisfies a predetermined first condition. Here, the continuous map H₁ is a map from the second distance space B1 to the first distance space (A, d), which satisfies the first condition.

$$\begin{matrix}[ Math . 126 ] & \\ {\sum }_{b ∈ B 2} {d ( {H}_{1} ( b ) , F ( b ) )}^{2} \leq {\sum }_{b ∈ B 2} {d ( {H}^{′} ( b ) , F ( b ) )}^{2} & ( 126 )\end{matrix}$$

Next, a continuous map H₂ which satisfies the following Equation (127) is acquired for an arbitrary continuous map H″ from the second distance space B1 to the first distance space (A, d), which satisfies a predetermined second condition. Here, the continuous map H₂ is a map from the second distance space B1 to the first distance space (A, d), which satisfies the second condition.

$$\begin{matrix}[ Math . 127 ] & \\ {\sum }_{b ∈ B 2} {d ( {H}_{2} ( b ) , F ( b ) )}^{2} \leq {\sum }_{b ∈ B 2} {d ( {H}^{″} ( b ) , F ( b ) )}^{2} & ( 127 )\end{matrix}$$

Furthermore, a map G from the second distance space B1 to the first distance space (A, d) is acquired.

Here, the map G is such a map that a distance between an image G(b) by the map G and an image H₁(b) by the map H₁ is short in relation to an element b in the second distance space B1, which has a short distance between the element b space and the partial group B2, and a distance between the image G(b) and an image H₂(b) by the map H₂ is short in relation to an element b, which has a long distance between the element b and the partial group B2.

In addition, the map G depends on the distance between the element b and the partial group B2 in relation to an arbitrary element b in the second distance space B1 and is for mapping the element b at a position acquired by prorating the image H₁(b) and the image H₂(b).

Furthermore, the map G is a map which is an element in the second distance space B1 and satisfies G(b1)=H₁(b1) for a specific element b1 with a short distance from the partial group B2, and is a map which is an element in the second distance space B1 and satisfies G(b2)=H₂(b2) for a specific element b2 with a long distance from the partial group B2.

By acquiring the map G as described above, it is possible to acquire the map (transformation function) with which failures are less noticeable.

### [One Circuit May Not Be 360° ]

### Eighth Embodiment

### Concerning Panoramic Image of 360°

In addition, the captured images used for generating a panoramic image may not be captured images, the number of which corresponds to 360°.

For example, it is possible to generate a panoramic image of 360° from a plurality of captured images which are successively captured and acquired while an imaging device such as a digital camera is panned, namely turned by 360°

It is assumed that the captured images captured while turning are N captured images including the first captured image, the second captured image, . . . , the N-th captured image. In addition, it is assumed that a focal length F of the lens during imaging is known, and that the focal length F=1. In a case where the focal distance F is not one, it is possible to create a virtual image with a focal distance F of one by enlarging or contracting the captured image, and therefore, description will be continued on the assumption that the focal distances F of all the captured images are one.

### [Concerning Step STP1]

Processing of generating the panoramic image of 360° is performed in the following two steps (Step STP1 and Step STP2).

First, processing of associating the same projected substances which are present in adjacent captured images is performed in Step STP1.

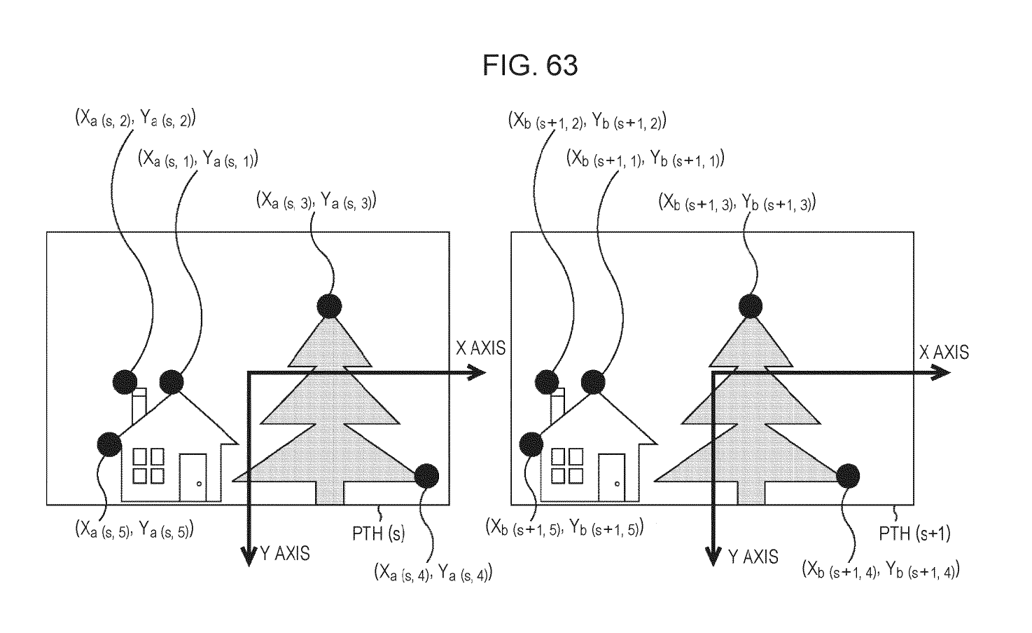

That is, positions corresponding to a position (X_{a(s,1)}, Y_{a(s,1)}) of a tip end of a roof of a house in the s-th captured image PTH(s), a position (X_{a(s,2)}, Y_{a(s,2)}) of a chimney, a position (X_{a(s,3)}, Y_{a(s,3)} of a tip end of a tree, and the like are detected in the s+1-th captured image PTH(s+1) as shown in FIG. 63, for example.

Here, the respective positions on the captured image PTH(s) are expressed by an XY coordinate system, which has an origin at the center of the captured image PTH(s), and in which the horizontal direction and the vertical direction in the drawing are an X axis and an Y axis, namely a coordinate system with reference to the captured image PTH(s). Similarly, the respective positions on the captured image PTH(s+1) are expressed by an XY coordinate system with reference to the captured image PTH(s+1).

In addition, it is possible to acquire a corresponding position by considering a small region around a pixel in the s-th captured image PTH(s) and searching for a region, which matches the small region, in the s+1-th captured image PTH(s+1). This is generally called block matching, and detailed description will be omitted since the block matching is a known technology.

By such block matching, a correspondence relationship of positions in adjacent images, which is represented by the following Equation (128), is detected.

[Math. 128]

(X_{a(s,m)},Y_{a(s,m)}) [symbol] (X_{b(s+1,m)},Y_{b(s+1,m)}) (128)

In Equation (128), s and s+1 represent the numbers of captured images, namely in what order the captured images are captured, and m represents an identification number of an object which appears both on the s-th captured image PTH(s) and the s+1-th captured image PTH(s+1).

In addition, (X_{a(s,m)}, Y_{a(s,m)}) represents a position of the object in the s-th captured image PTH(s), and (X_{b(s+1,m)}, Y_{b(s+1,m)}) represents a position of the object in the s+1-th captured image PTH(s+1).

Furthermore, “ [symbol] ” in Equation (128) means that the position in the s-th captured image PTH(s) corresponds to the position in the s+1-th captured image PTH(s+1).

A value of s in Equation (128) is any one of 1, 2, . . . , N. In addition, m is an integer starting from 1, and the possible maximum value of m depends on a combination of (s, s+1) as can be understood from the definition thereof.

As a specific example, FIG. 63 shows the position (X_{a(s,m)}, Y_{a(s,m)}) and the position (X_{b(s+1,m)}, Y_{b(s+1,m)}) of the tip end of the roof of the house, the tip end of the chimney, the tip end of the tree, and the like in cases where m=1, 2, 3, 4, and 5, respectively.

In addition, s+1 in Equation (128) means one when s=N. That is, the correspondence relationship between the positions of the object which appears in both the N-th captured image and the first captured image is represented as the following Equation (129).

[Math. 129]

(X_{a(N,m)},Y_{a(N,m)}) [symbol] (X_{b(1,m)},Y_{b(1,m)}) (129)

In the following description, it is assumed that s+1 in the index expressed as a combination of s and s+1 means one in the case where s=N in the same manner.

### [Concerning Step STP2]

If corresponding positions between the adjacent captured images are detected in Step STP1, then processing in Step STP2 is performed.

That is, a 3×3 matrix H_{s,s+1} which satisfies the following Equation (130) is acquired for all s (where s=1 to N) and m. That is, homogeneous transformation matrix (homography) which is positional relationship of the s+1-th captured image with reference to the s-th captured image is acquired.

$$\begin{matrix}[ Math . 130 ] & \\ [ \begin{matrix}{X}_{a ( s , m )} \\ {Y}_{a ( s , m )} \\ 1\end{matrix} ] ∝ {H}_{s , s + 1} [ \begin{matrix}{X}_{b ( s + 1 , m )} \\ {Y}_{b ( s + 1 , m )} \\ 1\end{matrix} ] & ( 130 )\end{matrix}$$

Since the homogeneous transformation matrix H_{s,s+1} has uncertainty in a constant factor, it is assumed that the following Equation (131) is satisfied.

$$\begin{matrix}[ Math . 131 ] & \\ \begin{matrix}{\sum }_{j = 1}^{3} {( {H}_{s , s + 1 ( j , 3 )} )}^{2} = {( {H}_{s , s + 1 ( 1 , 3 )} )}^{2} + {( {H}_{s , s + 1 ( 2 , 3 )} )}^{2} + {( {H}_{s , s + 1 ( 3 , 3 )} )}^{2} \\ = 1\end{matrix} & ( 131 )\end{matrix}$$

However, it is assumed that the homogeneous transformation matrix H_{s,s+1} is defined by the following Equation (132), and that elements of the homogeneous transformation matrix H_{s,s+1} satisfy Equation (131).

$$\begin{matrix}[ Math . 132 ] & \\ {H}_{s , s + 1} ≡ [ \begin{matrix}{H}_{s , s + 1 ( 1 , 1 )} & {H}_{s , s + 1 ( 1 , 2 )} & {H}_{s , s + 1 ( 1 , 3 )} \\ {H}_{s , s + 1 ( 2 , 1 )} & {H}_{s , s + 1 ( 2 , 2 )} & {H}_{s , s + 1 ( 2 , 3 )} \\ {H}_{s , s + 1 ( 3 , 1 )} & {H}_{s , s + 1 ( 3 , 2 )} & {H}_{s , s + 1 ( 3 , 3 )}\end{matrix} ] & ( 132 )\end{matrix}$$

In addition, it is assumed that rotation is not made at an angle of equal to or greater than 90° between the respective adjacent captured images, and a value on the third row and the third column of the homogeneous transformation matrix H_{s,s+1} (where s=1 to N) is a positive value.

Incidentally, it is necessary to acquire a solution which satisfies Equation (130) under a condition represented by the following Equation (133) since the image device is supposed to return the original position before turning when the imaging device is turned.

$$\begin{matrix} [ Math . 133 ] & \\ {\prod }_{k = 1 to N} {H}_{k , k + 1} = {H}_{1 , 2} {H}_{2 , 3} {H}_{3 , 4} … {H}_{N - 2 , N - 1} {H}_{N - 1 , N} {H}_{N , 1} ∝ [ \begin{matrix}1 & 0 & 0 \\ 0 & 1 & 0 \\ 0 & 0 & 1\end{matrix} ] & ( 133 )\end{matrix}$$

However, there is no case where Equation (130) is satisfied and Equation (133) is satisfied for all s (where s=1 to N) and m since errors are present in practice. Thus, it is considered that Equation (130) is substantially satisfied to the maximum extent under the condition of Equation (133).

That is a 3×3 matrix H_{s,s+1} which minimizes an error E expressed by the following Equation (134) is acquired under the conditions of Equation (131), Equation (133), and the condition that “the value on the third row and the third column of the homogeneous transformation matrix H_{s,s+1} is positive”.

$$\begin{matrix} [ Math . 134 ] & \\ \sum ≡ {\sum }_{s = 1 to N} {\sum }_{m} \{ \begin{matrix}{( {X}_{a ( s , m )} - \frac{\begin{matrix}{H}_{s , s + 1 ( 1 , 1 )} \times {X}_{b ( s + 1 , m )} + \\ {H}_{s , s + 1 ( 1 , 2 )} \times {Y}_{b ( s + 1 , m )} + {H}_{s , s + 1 ( 1 , 3 )}\end{matrix}}{\begin{matrix}{H}_{s , s + 1 ( 3 , 1 )} \times {X}_{b ( s + 1 , m )} + \\ {H}_{s , s + 1 ( 3 , 2 )} \times {Y}_{b ( s + 1 , m )} + {H}_{s , s + 1 ( 3 , 3 )}\end{matrix}} )}^{2} + \\ {( {Y}_{a ( s , m )} - \frac{\begin{matrix}{H}_{s , s + 1 ( 2 , 1 )} \times {X}_{b ( s + 1 , m )} + \\ {H}_{s , s + 1 ( 2 , 2 )} \times {Y}_{b ( s + 1 , m )} + {H}_{s , s + 1 ( 2 , 3 )}\end{matrix}}{\begin{matrix}{H}_{s , s + 1 ( 3 , 1 )} \times {X}_{b ( s + 1 , m )} + \\ {H}_{s , s + 1 ( 3 , 2 )} \times {Y}_{b ( s + 1 , m )} + {H}_{s , s + 1 ( 3 , 3 )}\end{matrix}} )}^{2}\end{matrix} \} & ( 134 )\end{matrix}$$

Incidentally, it is assumed that the 3×3 matrix H_{s,s+1} which minimizes the error E expressed by Equation (134) has been acquired. Here, it is assumed that a pixel position in the s-th captured image is expressed as (X₍ₛ₎, Y₍ₛ₎). An input direction of a light beam in a three-dimensional space, which is projected to the position (X₍ₛ₎, Y₍ₛ₎) in the s-th captured image is a direction represented by the following Equation (135) in a three-dimensional coordinate system with reference to the direction in which the first captured image is captured.

$$\begin{matrix} [ Math . 135 ] & \\ {\prod }_{k = 1 to s - 1} {H}_{k , k + 1} [ \begin{matrix}{X}_{( s )} \\ {Y}_{( s )} \\ 1\end{matrix} ] = {H}_{1 , 2} {H}_{2 , 3} {H}_{3 , 4} … {H}_{s - 2 , s - 1} {H}_{s - 1 , s} [ \begin{matrix}{X}_{( s )} \\ {Y}_{( s )} \\ 1\end{matrix} ] & ( 135 )\end{matrix}$$

However, when s=1, the input direction of the light beam in the three-dimensional direction, which is projected to a position (X₍₁₎, Y₍₁₎) in the first captured image is a direction represented by the following Equation (136) in the three-dimensional coordinate system with reference to the direction in which the first captured image is captured.

$$\begin{matrix}[ Math . 136 ] & \\ [ \begin{matrix}{X}_{( 1 )} \\ {Y}_{( 1 )} \\ 1\end{matrix} ] & ( 136 )\end{matrix}$$

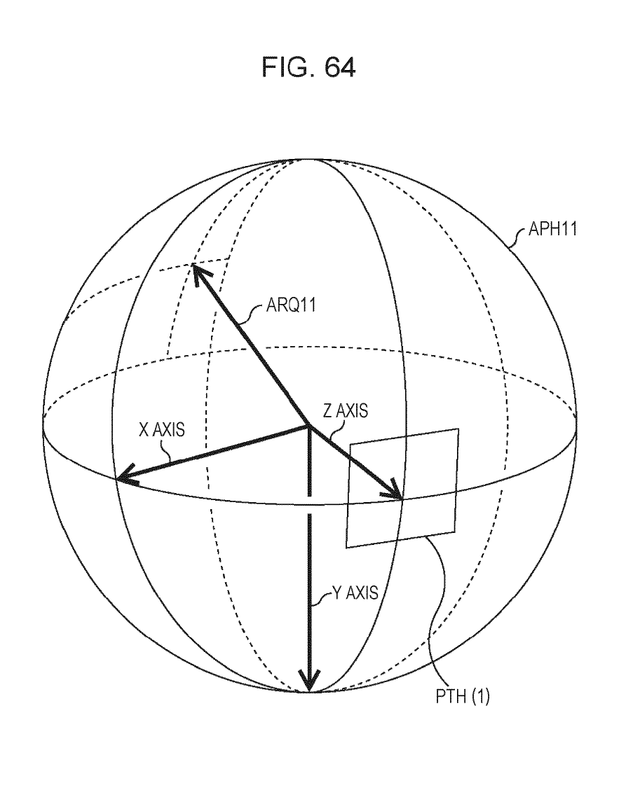

Accordingly, as shown in FIG. 64, for example, it is possible to acquire a panoramic image (omnidirectional image) of 360° by mapping a value at each pixel position (X₍ₛ₎, Y₍ₛ₎) in each captured image as light coming from the direction represented by Equation (135) (or Equation (316)) in a memory for a canvas of the omnidirectional sphere, which is prepared in advance.

In FIG. 64, an X axis, a Y axis, and a Z axis of a three-dimensional coordinate system (XYZ coordinate system) with reference to the imaging direction in which the first captured image PTH(1) is captured are shown. In this example, the Z-axis direction is a direction from the origin of the XYZ coordinate system toward the center position of the first captured image PTH(1), namely the imaging direction of the captured image PTH(1). In addition, the Y axis is in the lower direction (vertical direction) in the drawing.

Furthermore, a side surface of the omnidirectional sphere around the origin of the XYZ coordinate system is regarded as a canvas region APH11.

A direction represented by Equation (135) (or Equation (136)) is acquired for the position (X₍ₛ₎, Y₍ₛ₎) in the s-th captured image when the panoramic image of 360° is generated. It is assumed that a direction represented by the arrow ARQ11, for example, is acquired as the direction represented by Equation (135) (or Equation (136)) as a result.

In such a case, a pixel value of a pixel at the position (X₍ₛ₎, Y₍ₛ₎) in the s-th captured image is mapped on the position of an intersection between the arrow ARQ11 and the canvas region APH11 in the canvas region APH11. That is, the pixel value of the pixel is regarded as a pixel value of a pixel in the panoramic image, which is located at the position of the intersection between the arrow ARQ11 and the canvas region APH11.

Here, the pixel value of the pixel in the captured image is generally a value from 0 to 255 when the captured image is a monochrome image, and is a value expressing three primary colors, namely red, green, and blue by 0 to 255 when the captured image is a color image.

If the mapping of the respective captured images on the canvas region APH11 is performed as described above, an image on the canvas region APH11 which is acquired as a result is regarded as a panoramic image of 360°.

In addition, the homogeneous transformation matrix H_{s,s+1} may be acquired by applying the following condition instead of acquiring the 3×3 matrix H_{s,s+1} which minimizes the error E in Equation (134) under the aforementioned conditions of Equation (131) and Equation (133) and the condition that “the value on the third row and the third column of the homogeneous transformation matrix H_{s,s+1} is positive”.

That is, two-dimensional coordinates of the captured images are normal orthogonal systems, and a straight line connecting between an optical axis center of the camera and the center of an imaging element is orthogonal to the plane of the imaging element when the captured images are captured by a general digital camera. In addition, the focal distance F is one as described above.

Here, if it is assumed that imaging is performed while a digital camera is rotated about an optical axis, the homogeneous transformation matrix H_{s,s+1} is supposed to be an orthogonal matrix. Thus, the condition that the homogeneous transformation matrix H_{s,s+1} is an orthogonal matrix is added.

That is, the 3×3 matrix H_{s,s+1} which minimizes the error E of Equation (134) may be acquired under the conditions of Equation (131) and Equation (133), the condition that “the value on the third row and the third column of the homogeneous transformation matrix H_{s,s+1} is positive”, and the condition that “the matrix H_{s,s+1} is an orthogonal matrix”.

It is possible to generate a panoramic image (omnidirectional image) of 360° from the N captured images, which are successively captured while the imaging device is turned, by executing Step STP1 and Step STP2 as described above. In addition, a specific way of solving such a method is described in “M. Brown and D. G. Lowe, “Recognising Panorama,” ICCV pp 1218-1225, 2003”, for example.

[Concerning Positional Deviation between Adjacent Captured Images]

Now, description will be given of how to solve the aforementioned equations for generating the panoramic image from another aspect.

It is a matter of course that the correspondence relationship which is acquired in Step STP1 and is represented by Equation (128) (and Equation (129)) includes a calculation error. In addition, there is also an error caused by lens distortion. Furthermore, it is difficult to precisely rotate the imaging device about the optical center when the imaging device is panned, and an error due to a deviation in the rotation center also occurs.

If it is assumed that these errors do not occur at all, the homogeneous transformation matrix H_{s,s+1} which precisely satisfy Equation (130) for all m is present, and the matrix H_{s,s+1} also satisfies Equation (133).

However, since the errors are present in practice, there is no case where Equation (133) is satisfied.

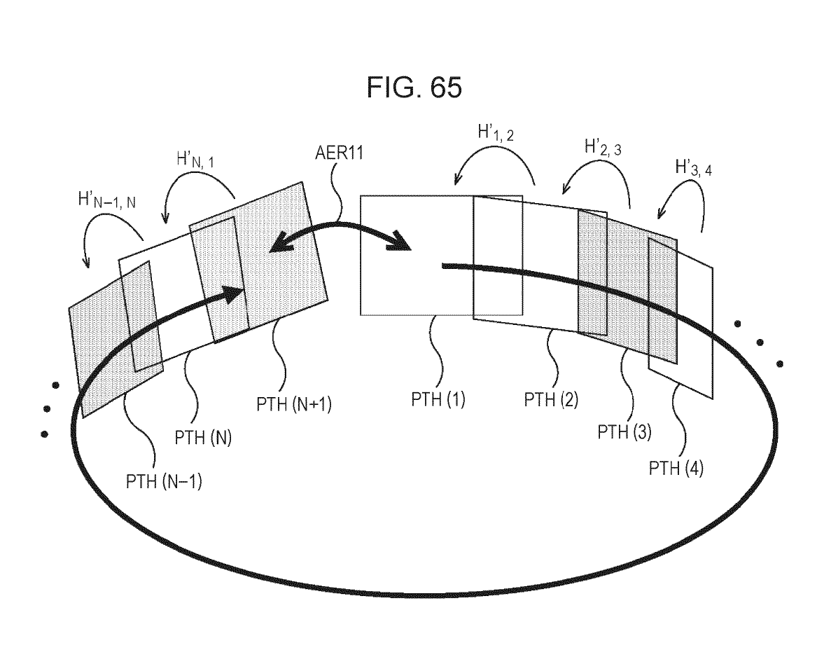

That is, when images are analyzed by the processing in Step STP1, a positional relationship between the first image and the second image is acquired, a positional relationship between the second image and the third image is acquired, and the respective positional relationships between the N−1-th image and the N-th image are acquired thereafter in the same manner, and further, a positional relationship between the N-th image and the first image is acquired from the correspondence relationship of Equation (128) (and Equation (129)), a unit matrix is supposed to be acquired ideally by accumulating these positional relationships since the imaging device is turned. However, the result of accumulating the respective positions does not form a unit matrix due to errors as shown in FIG. 65, for example.

In FIG. 65, the respective captured images from the first captured image PTH(1) to the N+1-th captured image PTH(N+1) are aligned in accordance with the acquired positional relationships.

In the drawing, H′_{s,s+1} (where s=1 to N−1) represents a homogeneous transformation matrix which is a positional relationship between the s-th and the s+1-th captured image, and H′_{N, 1} represents a homogeneous transformation matrix which is a positional relationship between the N-th and the first captured images.

In addition, the N+1-th captured image PTH(N+1) represents a position corresponding to the turning, which is acquired by accumulating the positional relationships (homogeneous transformation matrixes H_{s,s+1}) from the first to the N-th captured images in ascending order and further accumulating the positional relationship (homogeneous transformation matrix H′_{N,1}) between the N-th and the first captured images.

More specifically, the homogeneous transformation matrix H′_{s,s+1} is a 3×3 matrix which substantially satisfies the following Equation (137) to the maximum extent in relation to the relationship of Equation (128) (or Equation (129)) about the correspondence relationship acquired by analyzing the s-th and the s+1-th captured images.

$$\begin{matrix}[ Math . 137 ] & \\ [ \begin{matrix}{X}_{a ( s , m )} \\ {Y}_{a ( s , m )} \\ 1\end{matrix} ] ∝ {H}_{s , s + 1}^{′} [ \begin{matrix}{X}_{b ( s + 1 , m )} \\ {Y}_{b ( s + 1 , m )} \\ 1\end{matrix} ] & ( 137 )\end{matrix}$$

That is, acquisition of a solution which minimizes the error E represented by Equation (134) is as follows.

First, positional relationships corresponding to the turning represented by the following Equation (138) are acquired by accumulating the positional relationships from the first to the N-th captured images in ascending order and further accumulating the positional relationship between the N-th and the first captured images.

$$\begin{matrix}[ Math . 138 ] & \\ {\prod }_{k = 1 to N}^{ } {H}_{k , k + 1}^{′} = {H}_{1 , 2}^{′} {H}_{2 , 3}^{′} {H}_{3 , 4}^{′} … {H}_{N - 2 , N - 1}^{′} {H}_{N - 1 , N}^{′} {N}_{N , 1}^{′} & ( 138 )\end{matrix}$$

Then, the acquisition of the solution means that a difference represented by Equation (138) between the positional relationships corresponding to the turning (homogeneous transformation matrix) and the unit matrix is allocated to each of the positional relationships between adjacent captured images (the positional relationship between the first and the second captured images, the positional relationship between the second and the third captured images, . . . , the positional relationship between the N−1-th and the N-th captured images, and the positional relationship between the N-th and the first captured image). That is, the total amount of errors to be allocated to the positional relationships between the adjacent captured images is the difference between the homogeneous transformation matrix represented by Equation (138) and the unit matrix, and the total amount is allocated to each of the positional relationships between the adjacent captured images in small amounts.

In FIG. 65, the position determined by Equation (138) is a position of the N+1-th captured image PTH(N+1), and the arrow AER11 between the N+1-th captured image PTH(N+1) and the first captured image PTH(1) represents the difference between the homogeneous transformation matrix represented by Equation (138) and the unit matrix.

The above description can also be described in other words as follows.

First, a matrix H_{s,s+1} acquired by adding a 3×3 matrix H′_{s,s+1} which substantially satisfies Equation (137) to the maximum extent and a minute 3×3 matrix Δ_{s,s+1}, which is represented by the following Equation (139) is considered in relation to the relationship of Equation (128) (or Equation (129)) about the correspondence relationships acquired by analyzing the s-th and the s+1-th captured images.

$$\begin{matrix}[ Math . 139 ] & \\ \begin{matrix}\begin{matrix}\begin{matrix}\begin{matrix}\begin{matrix}\begin{matrix}{H}_{1 , 2} = {H}_{1 , 2}^{′} + {Δ}_{1 , 2} \\ {H}_{2 , 3} = {H}_{2 , 3}^{′} + {Δ}_{2 , 3}\end{matrix} \\ {H}_{3 , 4} = {H}_{3 , 4}^{′} + {Δ}_{3 , 4}\end{matrix} \\ ⋮\end{matrix} \\ {H}_{N - 2 , N - 1} = {H}_{N - 2 , N - 1}^{′} + {Δ}_{N - 2 , N - 1}\end{matrix} \\ {H}_{N - 1 , N} = {H}_{N - 1 , N}^{′} + {Δ}_{N - 1 , N}\end{matrix} \\ {H}_{N , 1} = {H}_{N , 1}^{′} + {Δ}_{N , 1}\end{matrix} & ( 139 )\end{matrix}$$

At this time, the matrix Δs,s+1 is adjusted such that the matrix Hs,s+1 represented by Equation (139) satisfies Equation (133), namely the following Equation (140). It is a matter of course that, the respective elements in the matrix Δs,s+1 are adjusted to values which are as close as possible to zero.

$$\begin{matrix} [ Math . 140 ] & \\ {\prod }_{k = 1 to N}^{ } ( {H}_{k , k + 1}^{′} + {Δ}_{k , k + 1} ) = ( {H}_{1 , 2}^{′} + {Δ}_{1 , 2} ) ( {H}_{2 , 3}^{′} + {Δ}_{2 , 3} ) ( {H}_{3 , 4}^{′} + {Δ}_{3 , 4} ) … … ( {H}_{N - 2 , N - 1}^{′} + {Δ}_{N - 2 , N - 1} ) ( {H}_{N - 1 , N}^{′} + {Δ}_{N , 1 , N} ) ( {H}_{N , 1}^{′} + {Δ}_{N , 1} ) ∝ [ \begin{matrix}1 & 0 & 0 \\ 0 & 1 & 0 \\ 0 & 0 & 1\end{matrix} ] & ( 140 )\end{matrix}$$

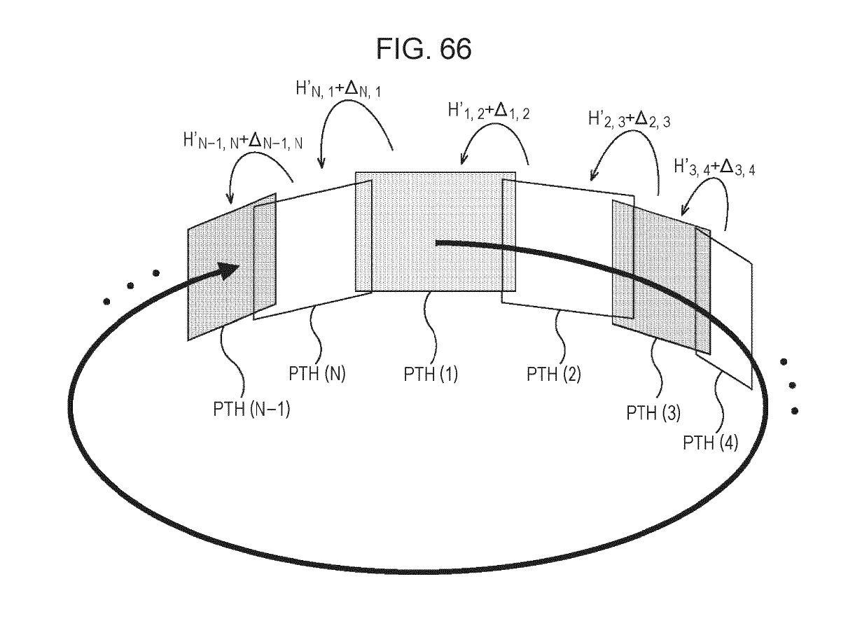

With such processing, the first captured image PTH(1) and the N-th captured image PTH(N) overlap with each other as shown in FIG. 66. In FIG. 66, the same reference numerals are given to parts corresponding to those in FIG. 65, and the description thereof will be appropriately omitted.

In FIG. 66, the respective captured images from the first captured image PTH(1) to the N-th captured image PTH(N) are aligned in accordance with the positional relationships determined by the sum of the homogeneous transformation matrix H′_{s,s+1} and the matrix Δ_{s,s+1}.

Incidentally, an amount of errors to be allocated to each of the positional relationships between the adjacent captured images, namely the matrix Δs,s+1 increases as the difference between the homogeneous transformation matrix represented by Equation (138) and the unit matrix, which is represented by the arrow AER11 in FIG. 65, increases.

Accordingly, the matrix H_{s,s+1}=H′_{s,s+1}+Δ_{s,s+1} as an optimized positional relationship causes positional deviations between the adjacent captured images when the difference between the homogeneous transformation matrix represented by Equation (138) and the unit matrix is large. That is, the matrix H_{s,s+1}=H′_{s,s+1}+Δ_{s,s+1} is greatly deviated from the homogeneous transformation matrix H_{s,s+1} which satisfies Equation (130).

That is, the errors (matrix Δ_{s,s+1}) to be allocated to the adjacent images increase if the positional relationships (homogeneous transformation matrix H_{s,s+1}) between the adjacent images are optimized so as to minimize the error E represented by Equation (134) when the errors increase for a reason that the error due to the lens distortion is large or a reason that the imaging device is not rotated about the optical center when panned.

As a result, positional deviations occur between the adjacent images, and it is not possible to acquire a panoramic image with high quality. That is, failures in images occur in the panoramic image due to the errors (positional deviations).

The present technology was made in view of such circumstances and is designed to enable acquisition of a panoramic image with high quality, which includes less failures.

### [Overview of Present Technology]

The present technology is for reducing the total amount of errors to be allocated to positional relationships between adjacent captured images, which is regarded as the difference between the homogeneous transformation matrix represented by Equation (138) and the unit matrix in the related art, by regarding the total amount of errors as a difference between the homogeneous transformation matrix represented by Equation (138) and an appropriate orthogonal matrix. Since it is also possible to reduce the amount of errors to be allocated to each positional relationship between adjacent captured images with such a configuration, it is possible to acquire a panoramic image with high quality, in which a positional deviation between the adjacent images is less noticeable even if the positional relationship between the adjacent images is optimized.

In the following description, it is assumed that the focal distances F of all the captured images are one, and that the rotation direction of the imaging device is the positive direction of the X axis in the same manner as in the aforementioned cases.

If the imaging device is rotated in the negative direction of the X axis, it is possible to deal with the situation as the situation in which the imaging device is rotated in the positive direction of the X axis by using images acquired by rotating all the captured images by 180° as the captured images. In addition, if the imaging device is rotated in the positive direction of the Y axis, it is possible to deal with the situation as the situation in which the imaging device is rotated in the positive direction of the X axis by using images acquired by rotating all the captured images by −90° as the captured images.

Furthermore, if the imaging device is rotated in the negative direction of the Y axis, it is possible to deal with the situation as the situation in which the imaging device is rotated in the positive direction of the X axis by using images acquired by rotating all the captured images by 90° as the captured images. Accordingly, generality is not lost even if the present technology is limited to the case where the rotation direction of the imaging device is the positive direction of the X axis.

First, description will be given of key points of the present technology.

In the related art, a panoramic image of 360° is considered to be generated from N captured images which are successively captured and acquired while an imaging device is panned, namely turned by 360°. That is, when positional relationships between the adjacent captured images are accumulated in ascending order from the first captured image, the captured images is aligned in exactly one circuit (that is, Equation (133) is satisfied).

Since the captured images corresponding to 360° are captured, it is significantly natural to generate the panoramic image (omnidirectional image) of 360° by acquiring optimal positional relationships to acquire an image of 360° and mapping the captured images on an omnidirectional sphere in accordance with the positional relationships.

For this reason, errors (matrix Δ_{s,s+1}) are allocated to adjacent captured images, and the total errors are made to correspond to the difference between the homogeneous transformation matrix of Equation (138) and the unit matrix, which is represented by the arrow AER11 in FIG. 65.

In contrast, according to the present technology, mapping is performed for an image of an angle (0) other than 360° regardless of that the captured images corresponding to 360° are captured. That is, optimization calculation is performed on the assumption that accumulation of the positional relationships between the adjacent captured images in ascending order from the first captured image may not be performed for one circuit.

In other words, the optimization calculation is performed on the assumption that accumulation of the positional relationships between the adjacent captured images in ascending order from the first captured image corresponds to rotation by θ°.

It is possible to reduce the total amount of errors to be allocated to the positional relationships between the adjacent captured images as compared with that in the related art by appropriately selecting the angle θ. Accordingly, since it is also possible to reduce the amount of errors (δ_{s,s+1} as will be described later) to be allocated to the positional relationships of the adjacent captured images, a positional deviation is not noticeable between the adjacent captured images even if the positional relationship between the adjacent captured images is optimized.

In addition, an image acquired by rendering the captured images corresponding to the angle θ is regarded as if the image was a panoramic image (omnidirectional image) of 360°.

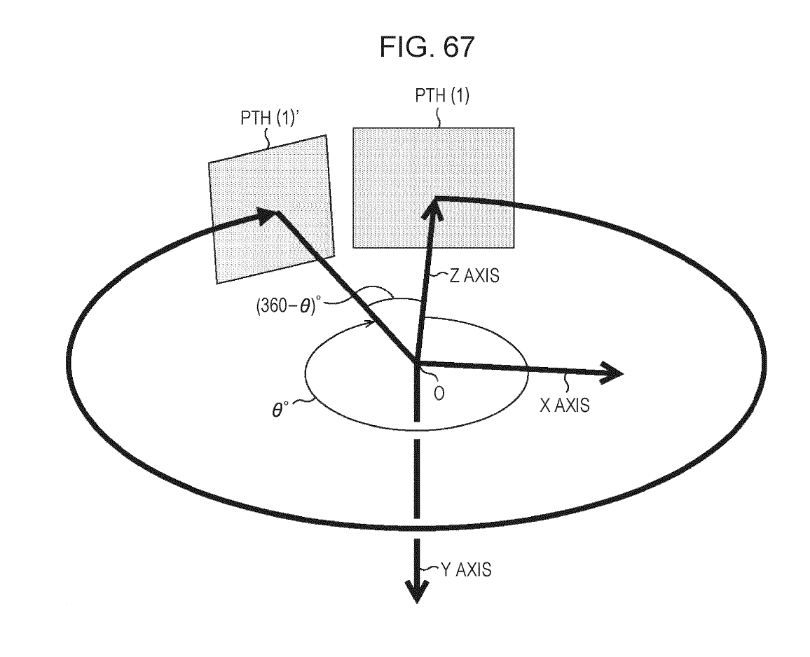

Next, description of the key points of the present technology will be given again with reference to FIGS. 67 to 71. Although FIGS. 67 to 70 are diagrams in the same situation and should originally be described as one diagram, the diagram will be complicated, and therefore, FIGS. 67 to 70 are divided into four diagrams.

It is assumed that the captured images are successively captured while an imaging device is rotated about the origin O by θ° as shown in FIG. 67, for example.

In FIG. 67, the XYZ coordinate system which includes the origin O as the center and includes an X axis, a Y axis, and a Z axis as axes is a three-dimensional coordinate system with reference to an imaging direction of the first captured image PTH(1).

In FIG. 67, the captured image PTH(1)′ is an image acquired by rotating the first captured image PTH(1) about the Y axis as a rotation axis by the angle θ.

If the respective captured images acquired by imaging are aligned at positions determined by the positional relationship between the captured images as described above, the state in FIG. 68 is achieved. In FIG. 68, the respective captured images from the first captured image PTH(1) to the N+1-th captured image PTH(N+1) are aligned in accordance with the acquired positional relationships. That is, the respective captured images PTH(s) are aligned at the positions acquired by accumulating the homogeneous transformation matrixes H′_{s,s+1}.

In addition, the position of the N+1-th captured image PTH(N+1) is a position corresponding to the turning, which is acquired by accumulating the homogeneous transformation matrixes H′_{s,s+1} representing the positional relationships from the first to the N-th captured image in ascending order and further accumulating the homogeneous transformation matrix H′_{N,1} representing the positional relationship between the N-th and the first captured images. That is, the position of the N+1-th captured image is a position represented by the homogeneous transformation matrix of Equation (138).

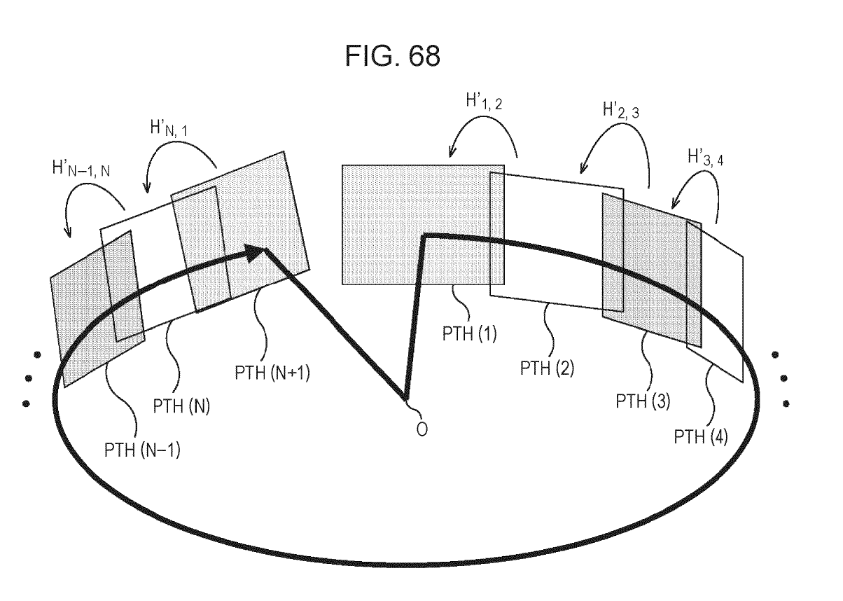

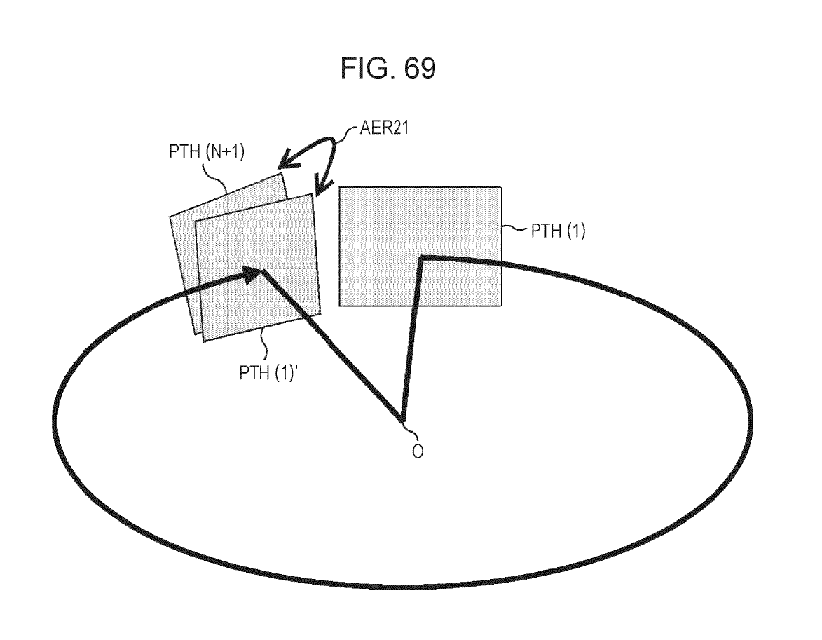

According to the present technology, as shown in FIG. 69, a difference between the captured image PTH(N+1) and the captured image PTH(1)′ is regarded as the total amount of errors to be allocated to the positional relationships between the adjacent captured images.

Here, the captured image PTH(N+1) is an image at a position corresponding to the turning, which is acquired by accumulating the homogeneous transformation matrix H′_{s,s+1} from the first to the N-th captured images in ascending order and further accumulating the homogeneous transformation matrix H′_{n, 1}. In addition, the captured image PTH(1)′ is an image acquired by rotating the captured image PTH(1) about the Y axis as a rotation axis by the angle θ.

In FIG. 69, the arrow AER21 represents a difference between the positions of the captured image PTH(N+1) and the captured image PTH(1)′, namely a difference between the position represented by Equation (138) and the position acquired by rotating the captured image PTH(1) by the angle θ.

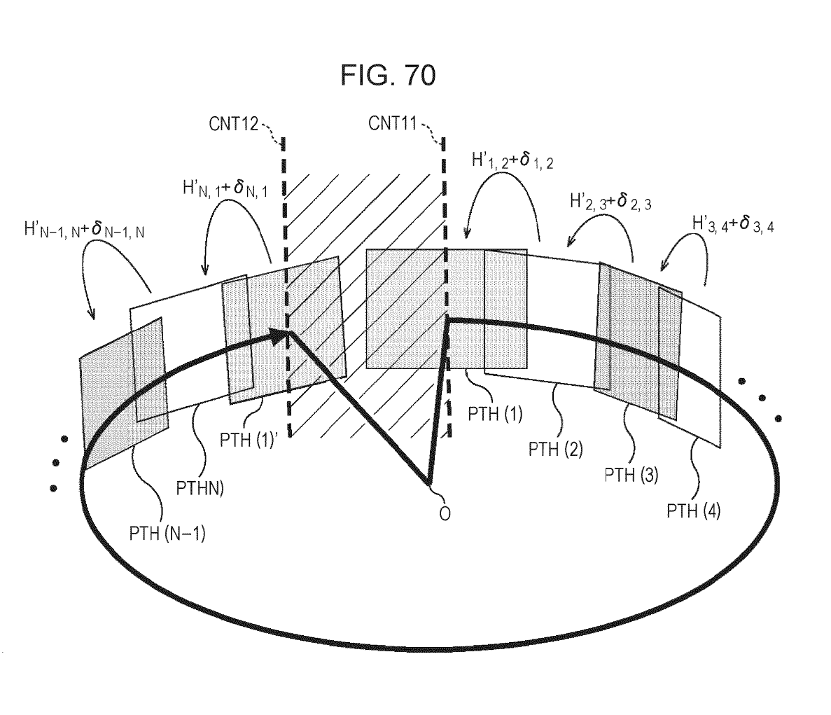

That is, if it is assumed that the errors to be allocated to the adjacent captured images is δ_{s,s+1} as shown in FIG. 70, optimization is performed such that a position acquired by accumulating the optimized positional relationships (H′_{s,s+1}+δ_{s,s+1}) from s=1 to s=N is the position of the captured image PTH(1)′.

In FIG. 70, the position of the captured image PTH(1)′ is the position acquired by accumulating the optimized positional relationships (H′_{s,s+1}+δ_{s,s+1}) from s=1 to s=N.

Incidentally, the total amount of errors to be allocated to the positional relationships between the adjacent captured images in the example of the present technology which is shown in FIG. 69 is obviously smaller than that in the example of FIG. 65 as can be understood from the comparison between FIGS. 65 and 69.

That is, in relation to the errors to be allocated to the adjacent captured images, the error δ_{s,s+1} in the present technology is smaller than Δ_{s,s+1} in the related art. Therefore, according to the present technology, positional deviations is not noticeable in the adjacent captured images even if the positional relationships of the adjacent captured images are optimized.

Now, description will be given of a method of generating the panoramic image (omnidirectional image) of 360° herein.

If the respective captured images PTH(s) (where s=1 to N) are arranged at positions shown in FIG. 70, for example, it is a matter of course that a region in a direction other than the region of θ°, namely the hatched region from the dotted line CNT11 to the dotted line CNT12 in FIG. 70 cannot be rendered.

However, the captured image PTH(1) on the dotted line CNT11 is completely the same image as the captured image PTH(1)′ on the dotted line CNT12. This is because, optimization is performed such that the position of the image after the turning is located at the position of the captured image PTH(1)′ rotated by θ° with respect to the first captured image PTH(1).

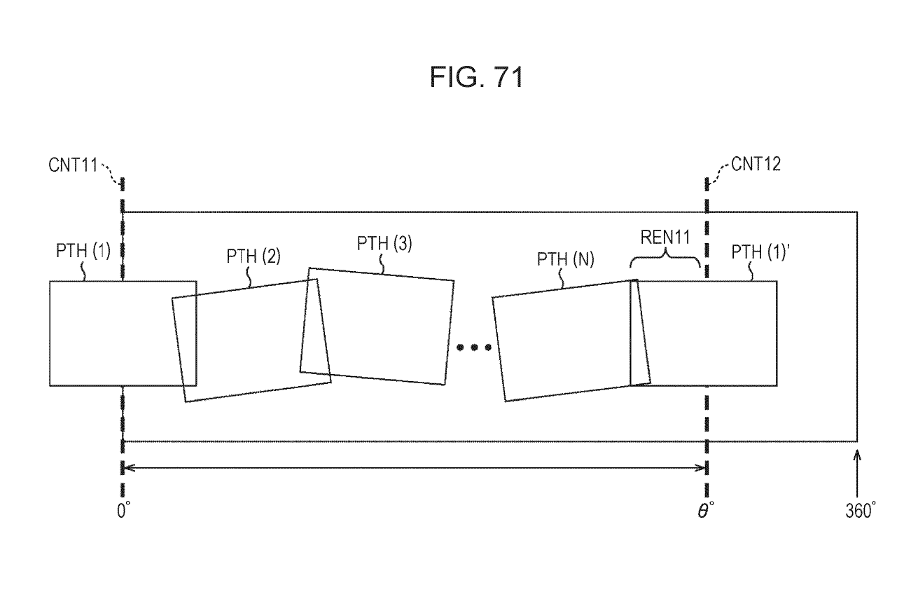

Thus, a panoramic image acquired by rendering a part from 0° to θ° is regarded as if the panoramic was a panoramic image of 360° according to the present technology as shown in FIG. 71. In such a case, images at a position of θ° (a position which is made to appear as 360°) and at a position of 0° are the same, and a panoramic image of 360° without any inconsistency is generated.

In addition, FIG. 71 is a developed figure of a panoramic image of 360°, and the horizontal direction in the drawing represents a position corresponding to each rotation angle when the imaging device is rotated from the dotted line CNT11 in FIG. 70. In FIG. 71, the same reference numerals are given to parts corresponding to those in FIG. 70, and the description thereof will be appropriately omitted.

In FIG. 71, the captured image PTH(1) to the captured image PTH(N) and the captured image PTH(1)′ are aligned in an order in the horizontal direction in the drawing.

In this example, the panoramic image is generated by rendering the part from the position of the dotted line CNT11 to the position of the dotted line CNT12, namely the part from 0° to θ°, that is, by mapping the captured images on the canvas region. At this time, the part corresponding to the region REN11, namely the part in the captured image PTH(1) from the end on the left side of the drawing to the position of the dotted line CNT12 is rendered by using the first captured image PTH(1).

The following description will be given of a case in which the images are extended in the horizontal direction by 360/θ times and the rendering is performed on the images corresponding to 360° instead of rendering the region from 0° to θ°.

### [Specific Description of Present Technology]

Next, more specific description will be given of the present technology.

First, a coordinate transformation matrix T_{(A, B, C, θ)} for rotation by θ° with respect to a direction of a three-dimensional vector (A, B, C) is generally represented by the following Equation (141). Here, it is assumed that the length of the vector (A, B, C) is one.

$$\begin{matrix}[ Math . 141 ] & \\ {T}_{( A , B , C , θ )} ≡ [ \begin{matrix}\begin{matrix}{A}^{2} + \\ ( 1 - {A}^{2} ) cos ( θ )\end{matrix} & \begin{matrix}AB ( 1 - cos ( θ ) ) - \\ C sin ( θ )\end{matrix} & \begin{matrix}AC ( 1 - cos ( θ ) ) + \\ B sin ( θ )\end{matrix} \\ \begin{matrix}AB ( 1 - cos ( θ ) ) + \\ C sin ( θ )\end{matrix} & \begin{matrix}{B}^{2} + \\ ( 1 - {B}^{2} ) cos ( θ )\end{matrix} & \begin{matrix}BC ( 1 - cos ( θ ) ) - \\ A sin ( θ )\end{matrix} \\ \begin{matrix}AC ( 1 - cos ( θ ) ) - \\ B sin ( θ )\end{matrix} & \begin{matrix}BC ( 1 - cos ( θ ) ) + \\ A sin ( θ )\end{matrix} & \begin{matrix}{C}^{2} + \\ ( 1 - {C}^{2} ) cos ( θ )\end{matrix}\end{matrix} ] & ( 141 )\end{matrix}$$

In the optimization calculation of the present technology, the homogeneous transformation matrix H_{s,s+1} (where s=1 to N) which minimizes the error E of Equation (134), A, B, C, and θ are acquired under the condition that Equation (131) and the following Equation (142) are satisfied and the condition that the value on the third row and the third column of the homogeneous transformation matrix H_{s,s+1} is positive.

$$\begin{matrix} [ Math . 142 ] & \\ {\prod }_{k = 1 to N}^{ } {H}_{k , k + 1} = {H}_{1 , 2} {H}_{2 , 3} {H}_{3 , 4} … {H}_{N - 2 , N - 1} {H}_{N - 1 , N} {H}_{N , 1} ∝ {T}_{( A , B , C , θ )} & ( 142 )\end{matrix}$$

The coordinate transformation matrix T_{(A,B,C,θ)} is a matrix which is acquired by rotating an arbitrary position in the three-dimensional space about the vector (A, B, C) as a rotation axis by the angle θ. Accordingly, Equation (142) represents that the imaging direction of the captured image which is turned with respect to the first captured image is a direction acquired by rotating the imaging direction of the first captured image about the vector (A, B, C) as the rotation axis by the angle θ. That is, Equation (142) represents that the rotation angle when the imaging device is rotated by one circuit is θ°.

However, since the left side in Equation (142) is supposed to be a unit matrix if there is no error, the angle θ is supposed to be within a range from (360-45)° to (360+45)°. Thus, the angle θ is within a range within the range from (360−45)° to (360+45)°.

In addition, B is equation or greater than 0.8 in order to prevent parts which become unstable in the process of calculation in the rendering part as will be described later and cannot be rendered from increasing. In addition, the value of B is not necessarily equal or greater than 0.8, and may be equal to or greater than 0.9 or may be equal to or greater than 0.7.

That is, according to the optimization calculation of the present technology, the homogeneous transformation matrix H_{s,s+1} (where s=1 to N) which minimizes the error E of Equation (134), A, B, C, and θ are acquired under the condition that Equation (131) and Equation (142) are satisfied, the condition that the value on the third row and the third column of the homogeneous transformation matrix H_{s,s+1} is positive, the condition that the angle θ is within a range from (360-45)° to (360+45)°, and the condition that B is equal to or greater than 0.8.

The condition that the homogeneous transformation matrix H_{s,s+1} is an orthogonal matrix may be further added to the optimization calculation of the present technology.

That is, the homogeneous transformation matrix H_{s,s+1} (where s=1 to N) which minimizes the error E of Equation (134), A, B, C, and θ may be acquired under the condition that Equation (131) and Equation (142) are satisfied, the condition that the value on the third row on the third column of the homogeneous transformation matrix H_{s,s+1} is positive, the condition that the homogeneous transformation matrix H_{s,s+1} is an orthogonal matrix, the condition that the angle θ is within the range from (360-45)° to (360+45)°, and the condition that B is equal to or greater than 0.8.

Now, the aforementioned optimization in the related art will be compared with the optimization according to the present technology.

If it is assumed that the angle θ=360° in Equation (142), the coordinate transformation matrix T_{(A,B,c,θ)} is a unit matrix. Since any values are available for A, B, and C when the angle θ=360°, for example, it is considered that A=0, B=1, and C=0.

That is, the optimization in the related art corresponds to a case where the angle θ is forcedly set to zero in the optimization according to the present technology. Specifically, the optimization in the related art corresponds to a case where the angle θ is forcedly set to zero in the solution which minimizes the error E of Equation (134) under the condition that Equation (131) and Equation (142) are satisfied, the condition that the value on the third row and the third column of the homogeneous transformation matrix H_{s,s+1} is positive, and the condition that the angle θ is within the range from (360−45)° to (360+45)°.

It is obvious that in comparison between the error minimization of Equation (134), in which the angle θ is limited to zero, and the error minimization of Equation (134), in which the angle θ is variable, it is possible to acquire a solution, which causes a smaller number of errors, by the latter minimization.

Accordingly, since it is possible to reduce the amount of errors to be allocated to the positional relationships between the adjacent captured images by the optimization according to the present technology, positional deviations in the adjacent captured images become less noticeable even if the positional relationships between the adjacent captured images are optimized.

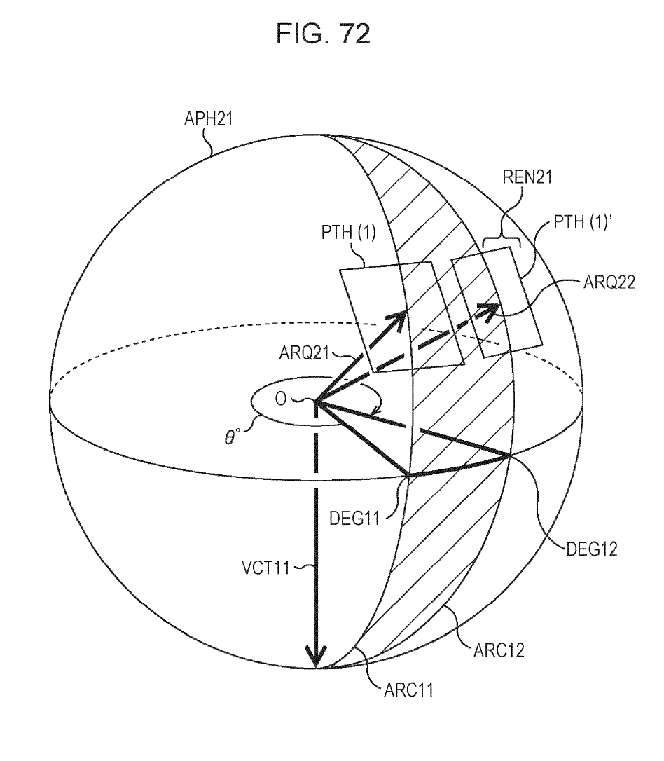

It is assumed that rendering for the panoramic image (omnidirectional image) of 360° is performed after the optimization according to the present technology is performed as described above. In such a case, data in a region (the hatched region in the drawing) between an arc ARC11 and an arc ARC12 of a sphere becomes meaningless data in the canvas region APH21 on the surface of the omnidirectional sphere to which the respective captured images are projected as shown in FIG. 72. That is, the region becomes a region which cannot be used for the panoramic image.

In FIG. 72, the same reference numerals are given to parts corresponding to those in FIG. 67, and the description thereof will be appropriately omitted.

In FIG. 72, the arrow VCT11 represents the direction of the vector (A, B, C) acquired by the optimization calculation, and imaging is performed while the imaging device is rotated about an axis, which is parallel to the direction of the arrow VCT11 at the position of the origin O, by the angle θ when the captured images are captured. Here, the canvas region APH21 is on the surface of the sphere which includes the origin O at the center and has a length of the vector (A, B, C) as a radius.

In addition, the arrow ARQ21 represents the imaging direction of the first captured image PTH(1), and a position of an intersection between the arrow ARQ21 and the spherical canvas region APH21 is the position of the arc ARC11.

Furthermore, the arrow ARQ22 represents a direction of the captured image PTH(1)′ which is acquired by rotating the first captured image PTH(1) about the vector (A, B, C) as a rotation axis by the angle θ. In addition, the position of the captured image PTH(1)′ is a position acquired by accumulating the optimized positional relationships (H′_{s,s+1}+δ_{s,s+1}) from s=1 to s=N.

That is, the direction of the arrow ARQ22 is a direction acquired by rotating the arrow ARQ21 (the imaging direction of the captured image PTH(1)) about the vector (A, B, C) as a rotation axis by the angle θ. A position of an intersection between the arrow ARQ22 and the canvas region APH21 is the position of the arc ARC12.

The region from the arc ARC11 to the arc ARC12 on the canvas region APH21 is a region which is not used for generating the panoramic image in FIG. 72, and the region corresponds to the hatched region from the dotted line CNT11 to the dotted line CNT12 in FIG. 70.

In addition, a region REN21, that is, a part in the captured image PTH(1)′ from the right end in the drawing to the arc ARC12 on the canvas region APH21 corresponds to the region REN11 in FIG. 71, and the rendering is performed on this part by using the first captured image PTH(1).

Incidentally, the optimization according to the present technology by which the homogeneous transformation matrix H_{s,s+1} which minimizes the error E, the vector (A, B, C), and the angle θ is performed such that the relationship of Equation (142) is established. For this reason, an image at the part corresponding to the ark ARC11 and an image at the part corresponding to the arc ARC12 in the canvas region APH21 coincide with each other.

Thus, if a resulting image (panoramic image) is output as if a position DEG11 on the arc arch was a position at which the rotation angle of the imaging device is 0° and a position DEG12 on the arc ARC12 was a position at which the rotation angle is 360°, it is possible to output an image without any inconsistency as a panoramic image (omnidirectional image) of 360°.

The image without any inconsistency means that the image at the part corresponding to 0°, namely the image at the position DEG11 or on the arc ARC11 and the image at the part corresponding to 360°, namely the image at the position DEG12 or on the arc ARC12 coincide with each other (the images are the same).

In addition, a direction acquired by rotating the direction of the arrow ARQ21, which is the imaging direction of the captured image PTH(1), about the vector (A, B, C) as a rotation axis by the angle θ, namely the direction of the arrow ARQ22 is a direction of a vector represented by the following Equation (143). Then, the vector represented by Equation (143) is a value in a three-dimensional coordinate system with reference to the imaging direction of the first captured image PTH(1).

$$\begin{matrix} [ Math . 143 ] & \\ {\prod }_{k = 1 to N}^{ } {H}_{k , k + 1} [ \begin{matrix}0 \\ 0 \\ 1\end{matrix} ] = {H}_{1 , 2} {H}_{2 , 3} {H}_{3 , 4} … {H}_{N - 2 , N - 1} {H}_{N - 1 , N} {H}_{N , 1} [ \begin{matrix}0 \\ 0 \\ 1\end{matrix} ] ∝ {T}_{( A , B , C , θ )} [ \begin{matrix}0 \\ 0 \\ 1\end{matrix} ] & ( 143 )\end{matrix}$$

Incidentally, when the present technology is realized, the canvas region (the captured images to be projected) is stretched as if θ° appears as 360°, instead of performing the rendering from 0° to θ°.

That is, an input direction of a light beam in a three-dimensional space which is projected to a position (X₍ₛ₎, Y₍ₛ₎) in the s-th captured image is represented by Equation (135) by using the homogeneous transformation matrix H_{s,s+1} (where s=1 to N) acquired by the optimization calculation. The direction represented by Equation (135) is stretched by (360/θ) times in the rotation direction around the vector (A, B, C) as an axis. The thus acquired direction after being stretched is a finally acquired direction.

That is, the pixel value of the pixel at the position (X₍ₛ₎, Y₍ₛ₎) in each captured image is mapped as light flew from the direction represented by the following Equation (144) at a memory position corresponding to the canvas region on the omnidirectional sphere. With such processing, the image on the canvas region is regarded as a panoramic image of 360°. In addition, the pixel value of the pixel in the captured image is generally a value from 0 to 255 when the captured image is a monochrome image, and is a value expressing three primary colors, namely red, green, and blue by 0 to 255 when the captured image is a color image.

$$\begin{matrix} [ Math . 144 ] & \\ {T}_{( A , B , C , \frac{360 - θ}{θ} {θ}^{′} )} ( {\prod }_{k = 1 to N}^{ } {H}_{k , k + 1} [ \begin{matrix}{X}_{( s )} \\ {Y}_{( s )} \\ 1\end{matrix} ] ) = {T}_{( A , B , C , \frac{360 - θ}{θ} {θ}^{′} )} {H}_{1 , 2} {H}_{2 , 3} {H}_{3 , 4} … {H}_{s - 2 , s - 1} {H}_{s - 1 , s} [ \begin{matrix}{X}_{( s )} \\ {Y}_{( s )} \\ 1\end{matrix} ] & ( 144 )\end{matrix}$$

In addition, the angle θ′ in Equation (144) is a value defined as follows.

That is, an angle θ″ is defined as a value of equal to or greater than 0° and less than 360°, which is calculated by the following Equation (145).

$$\begin{matrix}[ Math . 145 ) & \\ \begin{matrix}\begin{matrix}\begin{matrix}[ \begin{matrix}{t}_{1} \\ {t}_{2} \\ {t}_{3}\end{matrix} ] = [ \begin{matrix}- AC \\ - BC \\ {A}^{2} + {B}^{2}\end{matrix} ] \div \sqrt{{( - AC )}^{2} + {( - BC )}^{2} + {( {A}^{2} + {B}^{2} )}^{2}} ( 145 ) \text{-} 1 \\ \begin{matrix}[ \begin{matrix}{t}_{4} \\ {t}_{5} \\ {t}_{6}\end{matrix} ] = {\sum }_{k = 1 to s - 1}^{ } {H}_{k , k + 1} [ \begin{matrix}{X}_{( s )} \\ {Y}_{( s )} \\ 1\end{matrix} ] \\ = {H}_{1 , 2} {H}_{2 , 3} {H}_{3 , 4} … {H}_{s - 2 , s - 1} {H}_{s - 1 , s} [ \begin{matrix}X ( s ) \\ Y ( s ) \\ 1\end{matrix} ]\end{matrix} ( 145 ) \text{-} 2\end{matrix} \\ [ \begin{matrix}{t}_{7} \\ {t}_{8} \\ {t}_{9}\end{matrix} ] = [ \begin{matrix}{t}_{4} - ( {At}_{4} + {Bt}_{5} + {Ct}_{6} ) A \\ {t}_{5} - ( {At}_{4} + {Bt}_{5} + {Ct}_{6} ) B \\ {t}_{6} - ( {At}_{4} + {Bt}_{5} + {Ct}_{6} ) C\end{matrix} ] \div \sqrt{\begin{matrix}{( {t}_{4} - {( {At}_{4} + {Bt}_{5} + {Ct}_{6} )}^{2} A )}^{2} + \\ {( {t}_{5} - ( {At}_{4} + {Bt}_{5} + {Ct}_{6} ) B )}^{2} + \\ {( {t}_{6} - ( {At}_{4} + {Bt}_{5} + {Ct}_{6} ) C )}^{2}\end{matrix}} ( 145 ) \text{-} 3\end{matrix} \\ \begin{matrix}[ \begin{matrix}{t}_{7} \\ {t}_{8} \\ {t}_{9}\end{matrix} ] = {T}_{( A , B , C , {θ}^{″} )} [ \begin{matrix}{t}_{1} \\ {t}_{2} \\ {t}_{3}\end{matrix} ] \\ = [ \begin{matrix}\begin{matrix}{A}^{2} + \\ ( 1 - {A}^{2} ) cos ( θ )\end{matrix} & \begin{matrix}AB ( 1 - cos ( {θ}^{″} ) ) - \\ C sin ( {θ}^{″} )\end{matrix} & \begin{matrix}AC ( 1 - cos ( {θ}^{″} ) ) + \\ B sin ( {θ}^{″} )\end{matrix} \\ \begin{matrix}AB ( 1 - cos ( θ ) ) + \\ C sin ( {θ}^{″} )\end{matrix} & \begin{matrix}{B}^{2} + \\ ( 1 - {B}^{2} ) cos ( {θ}^{″} )\end{matrix} & \begin{matrix}BC ( 1 - cos ( {θ}^{″} ) ) - \\ A sin ( {θ}^{″} )\end{matrix} \\ \begin{matrix}AC ( 1 - cos ( {θ}^{″} ) ) - \\ B sin ( {θ}^{″} )\end{matrix} & \begin{matrix}BC ( 1 - cos ( {θ}^{″} ) ) + \\ A sin ( {θ}^{″} )\end{matrix} & \begin{matrix}{C}^{2} + \\ ( 1 - {C}^{2} ) cos ( {θ}^{″} )\end{matrix}\end{matrix} ] [ \begin{matrix}{t}_{1} \\ {t}_{2} \\ {t}_{3}\end{matrix} ] ( 145 ) \text{-} 4\end{matrix}\end{matrix} \} & ( 145 )\end{matrix}$$

It is assumed that the angle θ′=θ″ when conditions that the angle θ is equal to or greater than 360°, that s is equal to or greater than (N/2), and that θ″ is equal to or less than 90° are not satisfied. That is, when the conditions are not satisfied, the angle θ′ is equal to or greater than 0° and less than 360°.

In addition, it is assumed that the angle θ′ is (θ″+360)° when the conditions that the angle θ is equal to or greater than 360°, that s is equal to or greater than (N/2), and that 8″ is equal to or less than 90° are satisfied. That is, the angle θ′ is equal to or greater than 360° when the conditions are satisfied.

In addition, a matrix T_{(A, B, C, (360-θ)/θ×θ′)} in Equation (144) is a matrix acquired by substituting (360−8)/θ×θ′ into the angle θ of the coordinate transformation matrix T_{(A, B, C, θ)} defined by Equation (141), and specifically is a coordinate transformation matrix represented by the following Equation (146).

$$\begin{matrix}[ Math . 146 ] & \\ {T}_{( A , B , C , \frac{360 - θ}{θ} {θ}^{′} )} = [ \begin{matrix}\begin{matrix}{A}^{2} + \\ ( 1 - {A}^{2} ) cos ( \frac{360 - θ}{θ} {θ}^{′} )\end{matrix} & AB ( \begin{matrix}\begin{matrix}1 - \\ cos ( \frac{360 - θ}{θ} {θ}^{′} ) -\end{matrix} \\ C sin ( \frac{360 - θ}{θ} {θ}^{′} )\end{matrix} ) & \begin{matrix}AC ( \begin{matrix}1 - \\ cos ( \frac{360 - θ}{θ} {θ}^{′} )\end{matrix} ) + \\ B sin ( \frac{360 - θ}{θ} {θ}^{′} )\end{matrix} \\ \begin{matrix}AB ( \begin{matrix}1 - \\ cos ( \frac{360 - θ}{θ} {θ}^{′} )\end{matrix} ) + \\ C sin ( \frac{360 - θ}{θ} {θ}^{′} )\end{matrix} & \begin{matrix}{B}^{2} + \\ ( 1 - {B}^{2} ) cos ( \frac{360 - θ}{θ} {θ}^{′} )\end{matrix} & \begin{matrix}BC ( 1 - cos ( \frac{360 - θ}{θ} {θ}^{′} ) ) - \\ A sin ( \frac{360 - θ}{θ} {θ}^{′} )\end{matrix} \\ \begin{matrix}AC ( \begin{matrix}1 - \\ cos ( \frac{360 - θ}{θ} {θ}^{′} )\end{matrix} ) - \\ B sin ( \frac{360 - θ}{θ} {θ}^{′} )\end{matrix} & \begin{matrix}BC ( \begin{matrix}1 - \\ cos ( \frac{360 - θ}{θ} {θ}^{′} )\end{matrix} ) + \\ A sin ( \frac{360 - θ}{θ} {θ}^{′} )\end{matrix} & \begin{matrix}{C}^{2} + \\ ( 1 - {C}^{2} ) cos ( \frac{360 - θ}{θ} {θ}^{′} )\end{matrix}\end{matrix} ] & ( 146 )\end{matrix}$$

In addition, a reason that the direction acquired by stretching the direction of the light projected to the position (X₍ₛ₎, Y₍ₛ₎) in the captured image by (360°/θ) times is represented by Equation (144) and Equation (145) can be clearly understood from FIG. 73, for example. In FIG. 73, the same reference numerals are given to parts corresponding to those in FIG. 72, the description thereof will be appropriately omitted.

In FIG. 73, the arrow ARQ31 represents a direction which is expressed by using the homogeneous transformation matrix H_{s,s+1} (where s=1 to N) acquired by optimization and is represented by Equation (135), for the position (X₍ₛ₎, Y₍ₛ₎) in the s-th captured image. That is, the arrow ARQ31 represents a direction of the light to be projected to the position (X₍ₛ₎, Y₍ₛ₎).

In addition, the arrow ARQ32 is in a direction acquired by stretching the direction represented by the arrow ARQ31 by (360/θ) times in rotation direction around the vector (A, B, C) as an axis, namely a direction represented by Equation (144). In other words, the arrow ARQ32 is in a direction acquired by rotating the direction represented by the arrow ARQ31 about the vector (A, B, C) as a rotation axis by an angle ((360×θ′/θ)−θ′).

The direction represented by the arrow ARQ32 is a direction in which the pixel at the position (X₍ₛ₎, Y₍ₛ₎) in the captured image is finally rendered. That is, the pixel value of the pixel located at the position (X₍ₛ₎, Y₍ₛ₎) is mapped at the position of the intersection between the arrow ARQ32 and the canvas region APH21 in the canvas region APH21.

In the example of FIG. 73, for example, an angle (θ′°) between the direction of the arrow ARQ21 as an imaging direction of the first captured image and the arrow ARQ31 acquired by Equation (135) for the position (X₍ₛ₎, Y₍ₛ₎) in the s-th captured image, when viewed from the direction of the vector (A, B, C) is acquired.

This is because it is only necessary to rotate the arrow ARQ31 by an angle ((360/θ×θ′)−θ′)=(360−θ)/θ×θ′ in accordance with the angle θ′.

In addition, since the above discussion was made in relation to the three-dimensional coordinate system with reference to the imaging direction in which the first captured image is captured, the imaging direction of the first captured image, namely the direction represented by the arrow ARQ21 is a direction of a vector (0, 0, 1).

Furthermore, when the angle θ is equal to or greater than 360°, s is equal to or greater than (N/2), and θ″ is equal to or less than 90°, an offset of 360° is applied to the angle θ″ in Equation (145) as the angle θ′. This is because a case where 360° is exceeded when the imaging device is turned by one circuit is assumed. If s is equal to or greater than (N/S), this corresponds to a captured image which is close to the last captured image among the captured images, and therefore, it is difficult to consider that the angle θ′ is from 0° to 90°. This is because the angle θ′ should be considered to be equal to or greater than 360° in this case.

Equation (145)-1 which configures Equation (145) represents a direction (t₁, t₂, t₃) when the imaging direction in which the first captured image is captured, namely the arrow ARQ21 is projected to a plane orthogonal to the vector (A, B, C).

In addition, Equation (145)-2 represents a direction (t₄, t₅, t₆) represented by Equation (135), namely the direction of the arrow ARQ31, which is expressed by using the homogeneous transformation matrix H_{s,s+1} (where s=1 to N) acquired by the optimization calculation for the position (X₍ₛ₎, Y₍ₛ₎) in the s-th captured image.

Furthermore, Equation (145)-3 represents a direction (t₇, t₈, t₉) when the direction (t₄, t₅, t₆), namely the direction of the arrow ARQ31 is projected to the plane orthogonal to the vector (A, B, C).

Equation (145)-4 represents that the direction acquired by rotating the direction (t₁, t₂, t₃) by the angle θ″ is the direction (t₇, t₈, t₉). That is, the angle θ′ which satisfies Equation (145)-4 is an angle between the imaging direction in which the first captured image is captured and the direction (t₄, t₅, t₆), namely the direction of the arrow ARQ31 when viewed from the direction of the vector (A, B, C).

In addition, (t₄, t₅, t₆) (X₍ₛ₎, Y₍ₛ₎, 1) when s=1 in Equation (145)-2. Moreover, since transformation by the homogeneous transformation matrix H_{s,s+1} is not made when s=1, the following Equation (147) is used instead of Equation (144).

$$\begin{matrix}[ Math . 147 ] & \\ {T}_{( A , B , C , \frac{360 - θ}{θ} {θ}^{′} )} [ \begin{matrix}{X}_{( s )} \\ {Y}_{( s )} \\ 1\end{matrix} ] , \\ where s = 1. & ( 147 )\end{matrix}$$

Although the aforementioned series of drawings show examples of a case in which the angle θ is less than 360°, there is also a case where the angle θ exceeds 360° by the optimization calculation. All the aforementioned respective equations can also handle such a case, and the calculation can be performed without causing any problem.

In addition, description will be given of what should be noted when the panoramic image is generated.

For example, it is necessary to render the part corresponding to the region REN11 in FIG. 71 and the part corresponding to the region REN21 in FIG. 72 by using the first captured image.

In such a case, the first captured image may be rendered so as to satisfy the positional relationship of the homogeneous transformation matrix H_{s,s+1} (where s=N) acquired by the optimization calculation for the position in the N-th captured image, namely, the homogeneous transformation matrix H_{N,1}.

Thus, the N+1-th captured image is virtually generated, and the rendering of the captured images may be performed in the direction represented by the following Equation (148) for each position (X_{(N+1)}, Y_{(N+1)}) in the virtual captured image. Here, the N+1-th captured image is the same image as the first captured image.

$$\begin{matrix} [ Math . 148 ] & \\ {\prod }_{k = 1 to N}^{ } {H}_{k , k + 1} [ \begin{matrix}{X}_{( N + 1 )} \\ {Y}_{( N + 1 )} \\ 1\end{matrix} ] = {H}_{1 , 2} {H}_{2 , 3} {H}_{3 , 4} … {H}_{N - 2 , N - 1} {H}_{N - 1 , N} {H}_{N , 1} [ \begin{matrix}{X}_{( N + 1 )} \\ {Y}_{( N + 1 )} \\ 1\end{matrix} ] & ( 148 )\end{matrix}$$

In addition, when the angle θ′ exceeds the angle θ, the part corresponding to the angle θ′ is not necessary for generating the panoramic image since the part corresponding to the angle θ′ is the part corresponding to the hatched region from the dotted line CNT11 to the dotted line CNT12 in FIG. 70 and the hatched region from the arc ARC11 to the arc ARC12 in FIG. 72. Thus, when the angle θ′ exceeds the angle θ, the pixel data thereof is not mapped in the memory for the canvas region on the omnidirectional sphere, and the pixel data may be discarded.

### [Configuration Example of Image Processing Apparatus]

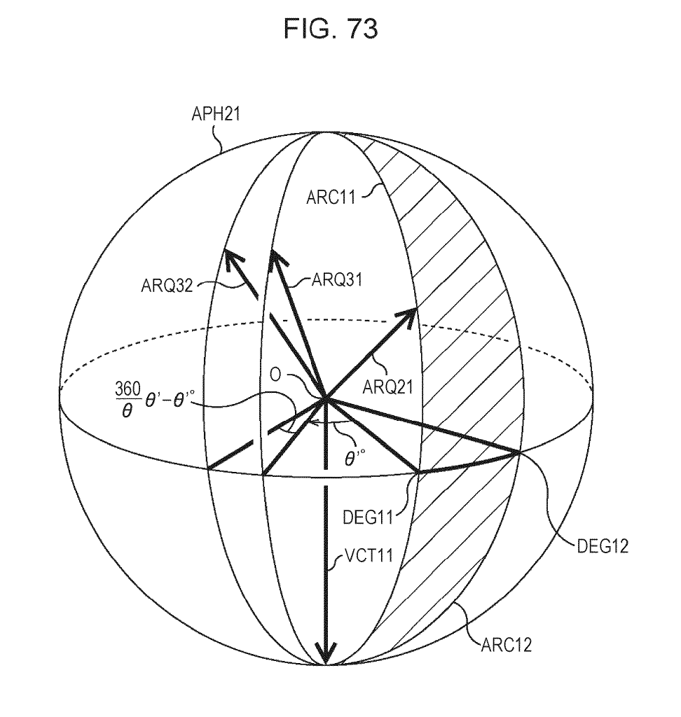

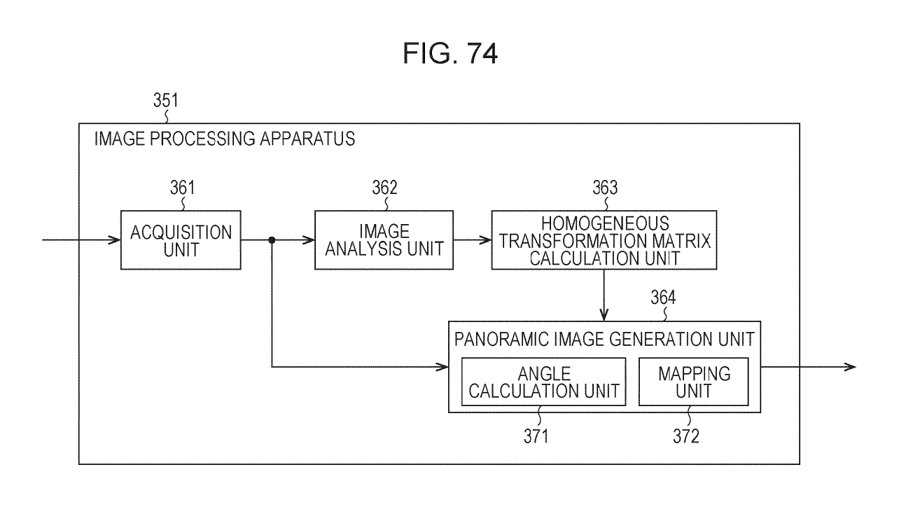

Next, description will be given of a specific embodiment to which the present technology is applied. FIG. 74 is a diagram showing a configuration example of an embodiment of an image processing apparatus to which the present technology is applied.

An image processing apparatus 351 in FIG. 74 is configured of an acquisition unit 361, an image analysis unit 362, a homogeneous transformation matrix calculation unit 363, and a panoramic image generation unit 364.

The acquisition unit 361 acquires N captured images which are successively captured while an imaging device such as a digital camera is rotated, and supplies the captured images to the image analysis unit 362 and the panoramic image generation unit 364.

The image analysis unit 362 detects corresponding positions between adjacent captured images based on the captured images supplied from the acquisition unit 361, and supplies the positions to the homogeneous transformation matrix calculation unit 363. The homogeneous transformation matrix calculation unit 363 calculates homogeneous transformation matrixes representing the positional relationships between the captured images based on the corresponding position detection result supplied from the image analysis unit 362 and supplies the homogeneous transformation matrixes to the panoramic image generation unit 364.

The panoramic image generation unit 364 generates a panoramic image based on the homogeneous transformation matrixes supplied from the homogeneous transformation matrix calculation unit 363 and the captured images supplied from the acquisition unit 361, and outputs the panoramic image. The panoramic image generation unit 364 is provided with the angle calculation unit 371 and the mapping unit 372.

The angle calculation unit 371 acquires the angle θ′ between the direction of the light projected to the position (X₍ₛ₎, Y₍ₛ₎) and the imaging direction of the first captured image for the position in each captured image. The mapping unit 372 maps the respective captured images in the canvas region by using the angle θ′ acquired for each position (X₍ₛ₎, Y₍ₛ₎) in the captured images, and generates a panoramic image.

### [Description of Panoramic Image Generation Processing]

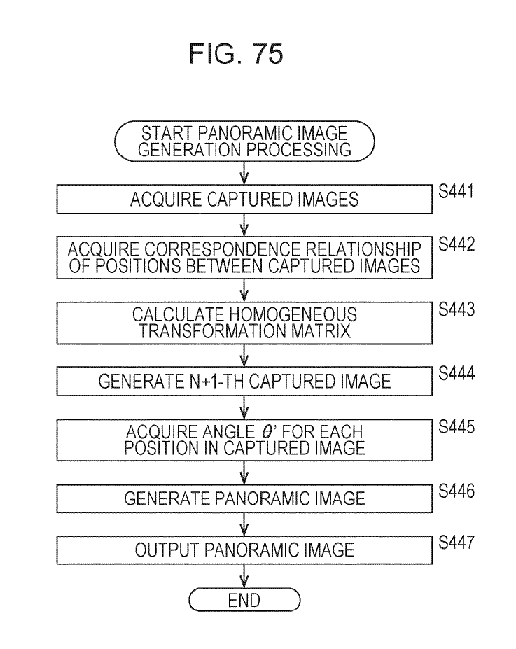

Next, description will be give of panoramic image generation processing by the image processing apparatus 351 with reference to the flowchart in FIG. 75.

In Step S441, the acquisition unit 361 acquires N captured images which are successively captured while an imaging device such as a digital camera is rotated, and supplies the captured images to the image analysis unit 362 and the panoramic image generation unit 364.

In Step S442, the image analysis unit 362 performs the block matching based on the captured images supplied from the acquisition unit 361 and acquires correspondence relationships of positions between adjacent captured images, which are represented by Equation (128) and Equation (129). The image analysis unit 362 supplies the acquired correspondence relationships of the positions between the captured images to the homogeneous transformation matrix calculation unit 363.

In Step S443, the homogeneous transformation matrix calculation unit 363 calculates homogeneous transformation matrixes based on the correspondence relationships of the positions between the captured images, which are supplied from the image analysis unit 362, and supplies the homogeneous transformation matrixes to the panoramic image generation unit 364.

For example, the homogeneous transformation matrix calculation unit 363 acquires the homogeneous transformation matrix H_{s,s+1} (where s=1 to N) which minimizes the error E in Equation (134), the vector (A, B, C), and the angle θ.

At this time, the homogeneous transformation matrix calculation unit 363 calculates the homogeneous transformation matrix H_{s,s+1} under the condition that Equation (131) and Equation (142) are satisfied, the condition that the value on the third row and the third column of the homogeneous transformation matrix H_{s,s+1} is positive, the condition that the angle θ is within a range from (360−45)° to (360+45)°, and the condition that B is equal to or greater than 0.8. In addition, A²+B²+C²=1. In addition, the condition that the homogeneous transformation matrix H_{s,s+1} is an orthogonal matrix may be further added.

The homogeneous transformation matrix calculation unit 363 supplies the this acquired homogeneous transformation matrix H_{s,s+1}, the vector (A, B, C), and the angle θ to the panoramic image generation unit 364.

In Step S444, the panoramic image generation unit 364 generates the N+1-th captured image based on the first captured image among the captured images supplied from the acquisition unit 361. That is, the first captured image is copied and is regarded as the N+1-th captured image as it is.

In Step S445, the angle calculation unit 371 acquires the angle θ′ at the position (X₍ₛ₎, Y₍ₛ₎) in each captured image based on the homogeneous transformation matrix H_{s,s+1}, the vector (A, B, C), and the angle θ supplied from the homogeneous transformation matrix calculation unit 363.

That is, the angle calculation unit 371 acquires the angle θ″ which satisfies Equation (145) for each position (X₍ₛ₎, Y₍ₛ₎) in s-th captured image (where s=1 to N+1). In addition, when s=1, (t₄, t₅, t₆) (X₍ₛ₎, Y₍ₛ₎, 1) is satisfied in Equation (145)-2.

Then, the angle calculation unit 371 sets the angle θ′=θ″ when the condition that the angle θ is equal to or greater than 360°, the condition that s is equal to or greater than (N/2), and the condition that 0″ is equal to or less than 90° are not satisfied.

In addition, the angle calculation unit 371 sets (θ″+360)° as the angle θ′ when the condition that the angle θ is equal to or greater than 360°, the condition that s is equal to or greater than (N/2), and the condition that θ″ is equal to or less than 90° are satisfied.

In Step S446, the mapping unit 372 maps the captured images in the canvas region prepared in advance based on the respective captured images, the angle θ′, the homogeneous transformation matrix H_{s,s+1}, the vector (A, B, C), and the angle θ, and generates a panoramic image.

That is, the mapping unit 372 calculates Equation (144) for the position (X₍ₛ₎, Y₍ₛ₎) in the s-th captured image and maps the pixel value of the pixel at the position (X₍ₛ₎, Y₍ₛ₎) at a position in the canvas region, which is determined by the direction represented by Equation (144). That is, the light projected to the position (X₍ₛ₎, Y₍ₛ₎) is regarded as light flow from the direction represented by Equation (144), and the pixel value of the pixel located at the position (X₍ₛ₎, Y₍ₛ₎) is mapped at a position at which the light intersect with the canvas region.

In addition, the mapping unit 372 calculates Equation (147) for the position (X₍ₛ₎, Y₍ₛ₎) and maps the pixel value of the pixel located at the position (X₍ₛ₎, Y₍ₛ₎) on a position in the canvas region, which is determined by the direction represented by Equation (147) when s=1. In addition, when the angle θ′ is an angle which exceeds the angle θ, the mapping is not performed on the position (X₍ₛ₎, Y₍ₛ₎).

In Step S447, the panoramic image generation unit 364 outputs the images, which are mapped on the canvas region, as a panoramic image, and the panoramic image generation processing is completed.

As described above, the image processing apparatus 351 performs the optimization calculation for minimizing the error E under the predetermined condition by setting the angle θ to be variable, and acquires the homogeneous transformation matrix. Then, the image processing apparatus 351 performs the mapping of the captured images by using the acquired homogeneous transformation matrix and generates the panoramic image.

By such optimization calculation, it is possible to reduce the amount of errors to be allocated to the positional relationships between the adjacent captured images and to make the positional deviations between the captured images unnoticeable. As a result, it is possible to acquire a panoramic image with high quality, which includes less failures in the images.

### Ninth Embodiment

### Concerning Simplification of Optimization Calculation

Since it is necessary to optimize the four parameters, namely A, B, C, and θ in addition to the variable to be optimized, namely the homogeneous transformation matrix H_{s,s+1}, the optimization calculation becomes complicated in the aforementioned eighth embodiment. For this reason, there is a requirement for simplifying the optimization calculation even if the performance is compromised to some extent. Thus, it is also possible to simplify the optimization calculation to make it possible to more simply perform the optimization calculation.

In such a case, A, B, and C are limited to zero, one, and zero, respectively, for example. In addition, the angle θ is a value which satisfies the following Equation (149). It is possible to reduce the variables to be optimized with such a configuration and to thereby reduce the calculation amount.

$$\begin{matrix} [ Math 149 ] & \\ \begin{matrix}\begin{matrix}[ \begin{matrix}{t}_{4}^{′} \\ {t}_{{5}^{′}} \\ {t}_{6}^{′}\end{matrix} ] ≡ {\prod }_{k = 1 to N}^{ } {H}_{k , k + 1}^{′} [ \begin{matrix}0 \\ 0 \\ 1\end{matrix} ] \\ = {H}_{1 , 2}^{′} {H}_{2 , 3}^{′} {H}_{3 , 4}^{′} … {H}_{N - 2 , N - 1}^{′} {H}_{N - 1 , N}^{′} {H}_{N , 1}^{′} [ \begin{matrix}0 \\ 0 \\ 1\end{matrix} ]\end{matrix} ( 149 ) \text{-} 1 \\ \begin{matrix}[ \begin{matrix}\begin{matrix}{t}_{4}^{′} \div \\ \sqrt{{t}_{4}^{′ 2} + {t}_{6}^{′ 2}}\end{matrix} \\ 0 \\ \begin{matrix}{t}_{6}^{′} \div \\ \sqrt{{t}_{4}^{′ 2} + {t}_{6}^{′ 2}}\end{matrix}\end{matrix} ] = {T}_{( 0 , 1 , 0 , θ )} [ \begin{matrix}0 \\ 0 \\ 1\end{matrix} ] \\ = [ \begin{matrix}cos ( θ ) & 0 & sin ( θ ) \\ 0 & 1 & 0 \\ - sin ( θ ) & 0 & cos ( θ )\end{matrix} ] [ \begin{matrix}0 \\ 0 \\ 1\end{matrix} ]\end{matrix} ( 149 ) \text{-} 2\end{matrix} \} & ( 149 )\end{matrix}$$

Here, description will be given of the angle θ which satisfies Equation (149) with reference to FIG. 76. In FIG. 76, the same reference numerals are given to parts corresponding to those in FIG. 72, and the description thereof will be omitted.

First, a 3×3 homogeneous transformation matrix H′_{s,s+1} which substantially satisfies Equation (137) to the maximum extent is considered from the relationship of Equation (128) (or Equation (129)) about the correspondence relationship acquired by analyzing the s-th captured image and the s+1-th captured image.

Then, a matrix which represents the positional relationships corresponding to the turning, which is acquired by accumulating the first homogenous transformation matrix to the N-th homogeneous transformation matrix in ascending order and further accumulating the homogeneous transformation matrix representing the positional relationship between the N-th and the first captured images, namely the matrix represented by Equation (138) is considered.

In FIG. 76, the captured image PTH31 is an image at a position represented by Equation (138). In addition, the captured image PTH32 is an image located at a position acquired by rotating the first captured image PTH(1) about the vector (0, 1, 0), namely the vector (A, B, C) which is represented by the arrow VCT11 as an axis by the rotation angle θ. That is, the captured image PTH32 is an image at the position acquired by accumulating the optimized positional relationships (H′_{s,s+1}+δ_{s,s+1}) from s=1 to s=N.

Incidentally, Equation (138) is originally supposed to be a unit matrix if there is no error. That is, a direction of (t₄′, t₅′, t₆′) represented by Equation (149)-1, namely the direction represented by the arrow ARQ41 in FIG. 76 is a vector in the direction of (0, 0, 1) if there is no error. However, since there is an error in practice, the vector (t₄′, t₅′, t₆′) does not become the vector (0, 0, 1).

In the example in FIG. 76, the arrow ARQ21 represents the imaging direction of the first captured image PTH(1), and the arrow ARQ21 corresponds to a Z axis in a three-dimensional coordinate system with reference to the imaging direction of the first captured image PTH(1). That is, a vector in the direction represented by the arrow ARQ21 is a vector (0, 0, 1).

In addition, the direction of the arrow VCT11 represents the direction of the vector (A, B, C), and in the example of FIG. 76, the direction of the arrow VCT11 corresponds to the Y axis in the three-dimensional coordinate system with reference to the imaging direction of the first captured image PTH(1).

In addition, (t₄′, t₅′, t₆′)−(0, 0, 1) as a difference between the direction of the arrow ARQ41, namely the vector (t₄′, t₅′, t₆′) and the direction of the arrow ARQ21, namely the vector (0, 0, 1) is the total amount of errors to be allocated to the positional relationships between the adjacent captured images in the related art.

In this embodiment, a (0, t₅′, 0) direction−a (0, 0, 1) direction as a difference in latitude direction is allocated to the positional relationships between the adjacent captured images in the same manner as in the related art. In FIG. 76, the arrow LER11 represents the errors in the latitude direction.

In contrast, a (t₄′, 0, t₆′) direction−a (0, 0, 1) direction as an error in the longitude direction is absorbed by a coordinate transformation matrix T_{(A, B, C, θ)}=T_{(0, 0, 1, θ)}. That is, the angle θ represented by Equation (149) may be calculated. In FIG. 76, the arrow LER12 represents the error in the longitude direction.

Since errors decrease by the amount corresponding to the longitude direction as compared with the related art although the total amount of errors to be allocated to the positional relationships between the adjacent captured images is larger in the ninth embodiment than in the eighth embodiment, there is an advantage in precision in positioning as compared with the related art. In addition, since the number of parameters to be optimized decreases as compared with the eighth embodiment, it is possible to implement high-speed computation.

If the above descriptions are summarized, it is only necessary to acquire the homogeneous transformation matrix H_{s,s+1} (where s=1 to N) which minimizes the error E of Equation (134) under the condition that Equation (131) and Equation (142) are satisfied and the condition that the value on the third row and the third column of the homogeneous transformation matrix H_{s,s+1} is positive, in the ninth embodiment of the present technology.

However, A=0, B=1, C=0, and the angle θ is a value represented by Equation (149) by using the homogeneous transformation matrix H′_{s,s+1} In addition, the angle θ is equal to or greater than (360−45)° and equal to or less than (360+45)°.

When the value of the angle θ represented by Equation (149) is not within the range of equal to or greater than (360−45)° and equal to or less than (360+45)°, and the value of the angle θ is equal to or greater than 180° and less than (360−45)°, the angle θ is forcedly set to (360−45)°. In addition, when the value of the angle θ exceeds 45° and is less than 180°, the angle θ is forcedly set to (360+45)°.

### [Description of Panoramic Image Generation Processing]

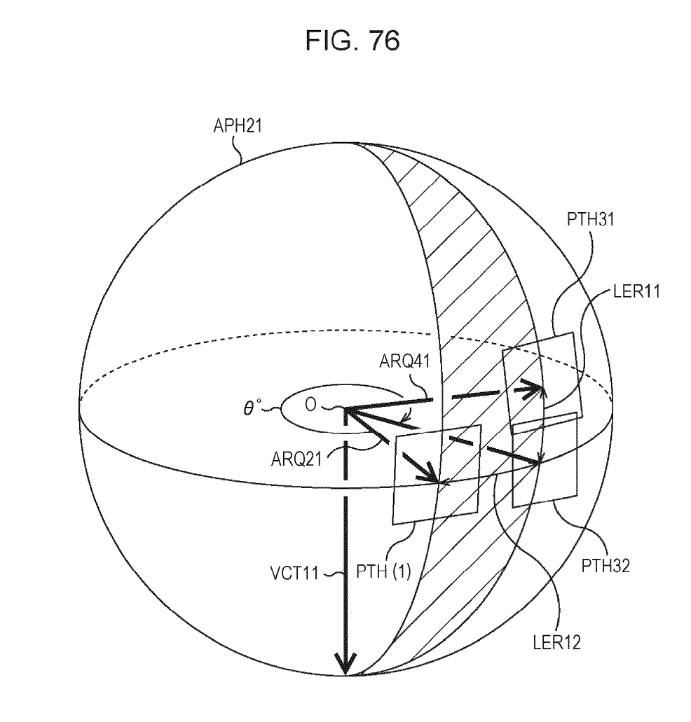

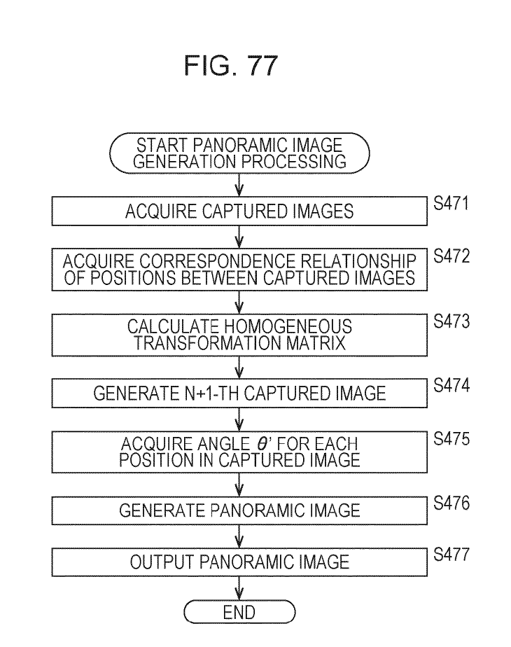

Next, description will be given of panoramic image generation processing performed by the image processing apparatus 351 when A=0, B=1, C=0, and the angle θ is a value which satisfies Equation (149) with reference to the flowchart in FIG. 77.

In addition, since the processing in Step S471 and Step S472 is the same as the processing in Step S441 and Step S442 in FIG. 75, the description thereof will be omitted.

In Step S473, the homogeneous transformation matrix calculation unit 363 calculates the homogeneous transformation matrix based on the correspondence relationships of the positions between the captured images supplied from the image analysis unit 362 and supplies the homogeneous transformation matrix to the panoramic image generation unit 364.

For example, the homogeneous transformation matrix calculation unit 363 acquires the homogeneous transformation matrix H_{s,s+1} (where s=1 to N) which minimizes the error E of Equation (134) and the angle θ.

At this time, the homogeneous transformation matrix calculation unit 363 calculates the homogeneous transformation matrix H_{s,s+1} under the condition that Equation (131) and Equation (142) are satisfied and the condition that the value on the third row and the third column of the homogeneous transformation matrix H_{s,s+1} is positive.

However, the vector (A, B, C)=(0, 1, 0), and the angle θ is a value represented by Equation (149) by using the homogeneous transformation matrix H′_{s,s+1} of Equation (137). In addition, the angle θ is equal to or greater than (360−45)° and equal to or less than (360+45)°.

In addition, the angle θ is forcedly set to (360−45)° when the angle θ represented by Equation (149) is not within the range of equal to or greater than (360−45)° and equal to or less than (360+45)° and the value of the angle θ is equal to or greater than 180 and less than (360-45)°, and the angle θ is forcedly set to (360+45)° when the value of the angle θ exceeds 45° and is less than 180°.

The homogeneous transformation matrix calculation unit 363 supplies the thus acquired homogeneous transformation matrix H_{s,s+1}, the vector (A, B, C), and the angle θ to the panoramic image generation unit 364.

If the processing in Step S473 is performed, then processing in Step S474 to Step S477 is completed and the panoramic image generation processing is completed though the description thereof will be omitted since the processing is the same as the processing in Step S444 to Step S447 in FIG. 75.

As described above, the image processing apparatus 351 performs the optimization calculation for minimizing the error E under the condition that the vector (A, B, C)=(0, 1, 0) and the condition that the angle θ satisfies Equation (149) and acquires the homogeneous transformation matrix. Then, the image processing apparatus 351 performs mapping of the captured images by using the acquired homogeneous transformation matrix and generates the panoramic image.

By such optimization calculation, it is possible not only to make the positional deviations between the captured images unnoticeable by reducing the amount of errors to be allocated to the positional relationships between the adjacent captured images but also to more quickly perform the optimization calculation. Therefore, it is possible to more quickly acquire a panoramic image with high quality, which includes less failures in images.

Here, the key points of the present technology described in the eighth embodiment and the ninth embodiment will be described again.

According to the present technology, the homogeneous transformation matrix H′_{s,s-1} as the positional relationship represented by Equation (137) is acquired by analyzing adjacent images, namely the s-th and the s+1-th captured images. If only the s-th and the s+1-th captured images are mentioned, the homogeneous transformation matrix H′_{s,s+1} is an optimal positional relationship.

However, if consistency in the turning is considered, it is necessary to allocate errors (described as Δ_{s,s+1} in the description about the related art and described as δ_{s,s+1} for the present technology) to the adjacent captured images.

Thus, a solution, which can make Δ_{s,s+1} as small as possible, and by which the homogeneous transformation matrix H_{s,s+1}=H′_{s,s+1}+Δ_{s,s+1} satisfies Equation (133), is acquired in the related art.

In contrast, a solution, which can make δ_{s,s+1} as small as possible, and by which the homogeneous transformation matrix H_{s,s+1}=H′_{s,s+1}+δ_{s,s+1} satisfies Equation (142), is acquired in the present technology. In the ninth embodiment, in particular, A=0, B=1, C=0, and the angle θ is a value which satisfies Equation (149) in Equation (142).

The above description was given in which the homogeneous transformation matrix H_{s,s+1} that minimizes the error E represented by Equation (134) is acquired under the condition that Equation (142) (or Equation (133)) is satisfied. That is, a solution which minimizes the error is acquired by the least squares method.

However, the present technology is not limited to the solving method by the least squares method, and the homogeneous transformation matrix H_{s,s+1} may be acquired by any other solving method. The point of the present technology is that Equation (142) (A=0, B=1, C=0, and the angle θ is the value which satisfies Equation (149) in Equation (142) in the ninth embodiment, in particular) is used instead of Equation (133), and the present technology is not limited to the least squares method represented by Equation (134).

That is, the homogeneous transformation matrix H_{s,s+1} which substantially satisfies Equation (130) to the maximum extent is acquired under the condition that Equation (133) is satisfied, in the related art. As one example thereof, the case where the homogeneous transformation matrix was acquired by the least squares method of Equation (134) was described.

According to the present technology, the homogeneous transformation matrix H_{s,s+1} which substantially satisfies Equation (130) to the maximum extent is similarly acquired under the condition that Equation (142) (A=0, B=1, C=0, and the angle θ is the value which satisfies Equation (149) in Equation (142) in the ninth embodiment, in particular) is satisfied. Then, as one example of how to acquire the homogeneous transformation matrix H_{s,s+1}, the case where the homogeneous transformation matrix was acquired by the least squares method of Equation (134) was described.

Accordingly, the point of the present technology is that the homogeneous transformation matrix H_{s,s+1} which substantially satisfies Equation (130) to the maximum extent is acquired under the condition that Equation (142) (A=0, B=1, C=0, and the angle θ is the value which satisfies Equation (149) in Equation (142) in the ninth embodiment, in particular) is satisfied. A method of acquiring the homogeneous transformation matrix H_{s,s+1} which substantially satisfies Equation (130) to the maximum extent is not limited to the least squares method, and any other method may be employed.

In addition, the present technology described in the eighth embodiment and the ninth embodiment can be configured as follows.

[1] An image processing method of outputting a panoramic image of 360° by using, as inputs, a plurality of captured images which an imaging device successively captures while being turned, the method including:

a positional relationship calculation step in which adjacent image positional relationships between mutually adjacent captured images are calculated;

an optimization step in which optimized adjacent image positional relationships and a virtual turning rotation angle are acquired;

a rendering step in which the respective captured images are rendered by the amount corresponding to the virtual turning rotation angle by using the optimized adjacent image positional relationships; and an output step in which the rendered images are output as a panoramic image of 360°,

wherein in the optimization step, the optimized adjacent image positional relationships are acquired such that the optimized adjacent image positional relationships are substantially equal to the adjacent image positional relationships to the maximum extent under a condition that a positional relationship acquired by accumulating the optimized adjacent image positional relationships is able to be expressed by rotation by an arbitrary angle (first angle), and further, the first angle is the virtual turning rotation angle.

[2] An image processing method of outputting a panoramic image of 360° by using, as inputs, a plurality of captured images which an imaging device successively captures while being turned, the method including:

a positional relationship calculation step in which adjacent image positional relationships between mutually adjacent captured images are calculated;

a positional relationship accumulation step in which the adjacent image positional relationships are accumulated to calculate an accumulated turned image positional relationship of the captured images when the captured images are turned with respect to a reference captured image;

a rotation angle calculation step in which a rotation angle (second angle) corresponding to the turning is acquired based on the accumulated turned image positional relationship;

an optimization step in which optimized adjacent image positional relationships are acquired;

a rendering step in which the respective captured images are rendered by an amount corresponding to the second angle by using the optimized adjacent image positional relationship; and

an output step in which the rendered images are output as a panoramic image of 360°,

wherein in the optimization step, the optimized adjacent image positional relationships are acquired such that the optimized adjacent image positional relationships are substantially equal to the adjacent image positional relationships to the maximum extent, and the positional relationship acquired by accumulating the optimized adjacent image positional relationships is completely equal to the rotation by the second angle.

### [Panoramic Exposure Correction in Consideration of Overexposure]

### Tenth Embodiment

### Concerning Panoramic Image

When a panoramic image is generated, exposure correction of the respective captured images may be performed in consideration of overexposure.

It is assumed that a plurality of, for example, N captured images are captured while an imaging device such as a digital camera is moved in the horizontal direction (X-axis direction). In addition, it is assumed that the captured images are captured such that projected images thereon have exactly 20% overlapping parts.

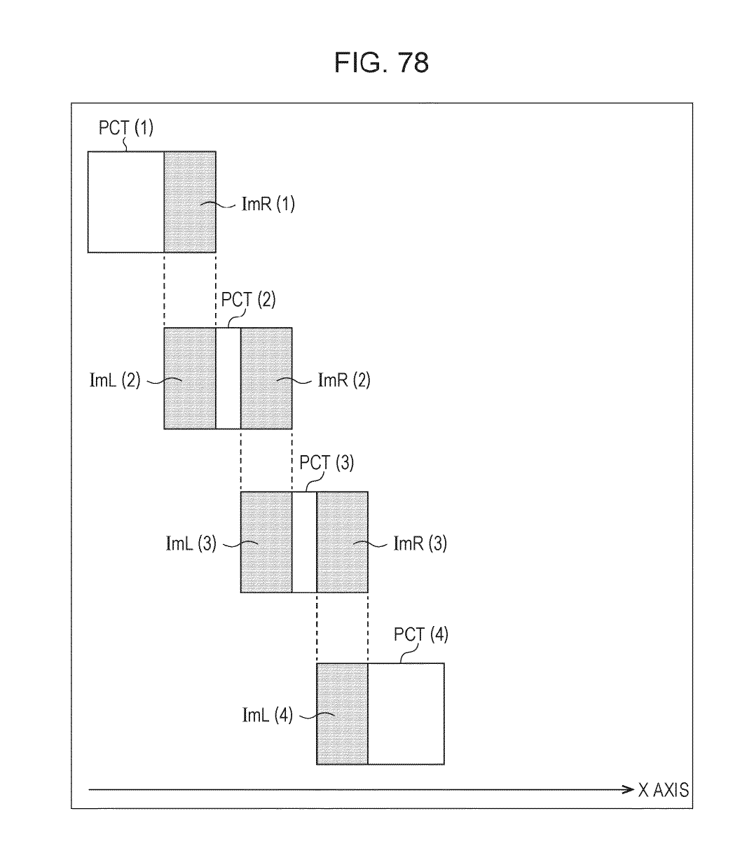

Here, positional relationships of the respective captured images will be shown in FIG. 78. In FIG. 78, only the first to the fourth captured images are shown for improving visualization, and illustration of the fifth to the N-th captured images is omitted. In FIG. 78, the horizontal direction of the drawing represents an X-axis direction as a moving direction of the imaging device, and the first captured image PCT(1) to the fourth captured image PCT(4) are aligned in the X-axis direction in accordance with the imaging directions thereof.

In FIG. 78, the same object is projected to a region ImR(k) with a size of 20% of the entire size, which is positioned in the k-th captured image PCT(k) on the right side in the drawing and a region ImL(k+1) with the size of 20% of the entire size, which is positioned in the k+1-th captured image PCT(k+1) on the left side in the drawing. Here, k=1 to N−1. Although the region ImR(k) and the region ImL(k) are depicted so as have larger areas than the actual areas in order to emphasize these regions in FIG. 78, the areas of these regions are the areas of 20% of the entire areas of the respective captured images in practice.

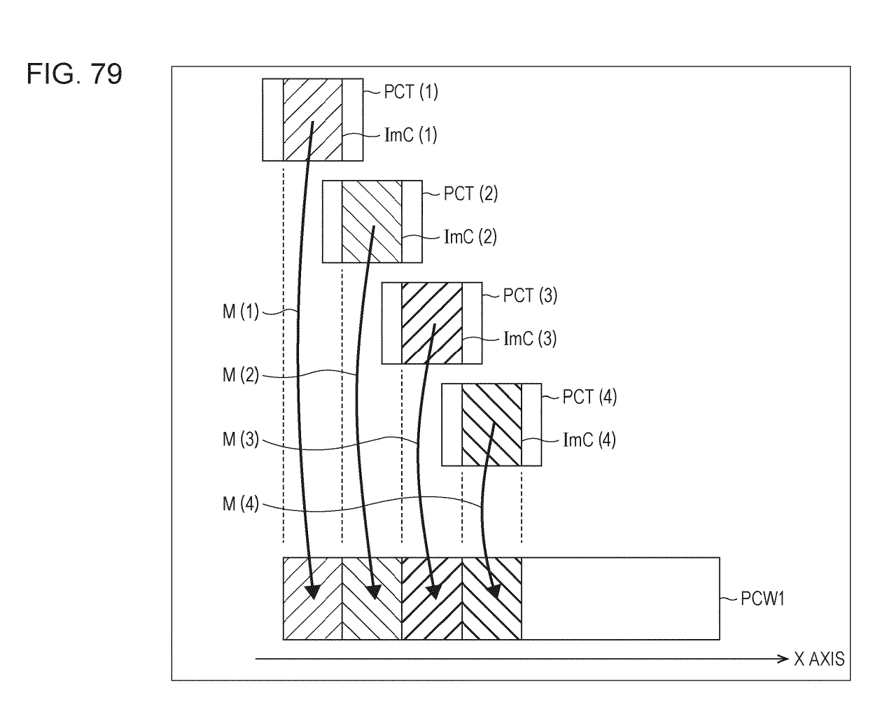

Incidentally, a panoramic image can be acquired from the N captured images by mapping the captured images as shown in FIG. 79.

In FIG. 79, the same reference numerals are given to parts corresponding to those in FIG. 78, and the description thereof will be appropriately omitted. In FIG. 79, only the first to the fourth captured images among the N captured images are shown, and illustration of the fifth to the N-th captured images is omitted in the same manner as in FIG. 78.

In the example of FIG. 79, 20% of areas in mutually adjacent captured images overlap (there are regions where the same object is captured). Thus, parts with the areas of 10% of the entire area, which are on both ends of each captured image, are ignored, and the remaining region with the area of 80% is used to generate the panoramic image PCW1. That is, the regions ImC(k) (where k=1 to N) at the centers of the respective captured images PCT(k) are connected to each other to generate the panoramic image PCW1.

In FIG. 79, processing of cutting the region ImC(k) with the area of 80% of the entire area, which is at the center of the k-th captured image PCT(k), and attaching the area ImC(k) to the panoramic image PCW1 is represented as M(k).

Incidentally, if imaging is performed by employing so-called automatic exposure when the respective images are captured, EV values (Exposure Values) which represent the exposure of the respective captured images are not necessarily constant. For this reason, it is necessary to adjust brightness in the region ImC(k) when the processing M(k) of attaching the region ImC(k) on the k-th captured image PCT(k) is performed.

That is, when the EV value when the k-th captured image PCT(k) is captured is represented as E(k), pixel values at all positions (pixels) in the region ImC(k) in the captured image is multiplied by 2^{E(k)}, and the captured image is attached to the panoramic image PCW1 when the processing M(k) is performed. Here, k=1 to N.

It is possible to acquire a panoramic image in which the respective regions have correct brightness by generating the panoramic image as described above. In addition, if such brightness adjustment is not performed, a level difference in brightness occurs in the acquired captured image at a part between adjacent captured images.

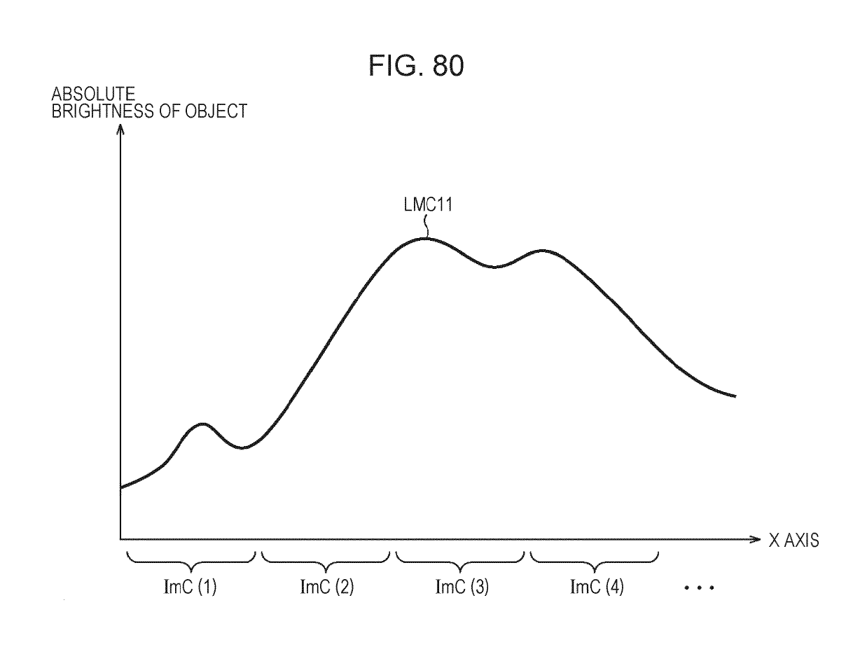

It is assumed that there is an object with brightness represented by the curve LMC11 as shown in FIG. 80, for example. In FIG. 80, the vertical direction and the horizontal direction represents brightness of the object and the moving direction of the imaging device, namely the X-axis direction.

In FIG. 80, a range (region) represented as ImC(k) (where k=1 to N) in the X-axis direction corresponds to the aforementioned region ImC(k) on the k-th captured image PCT(k). That is, ImC(k) represents the imaging range of the region ImC(k). In FIG. 80, illustration of the region ImC(5) to ImC(N) is omitted for improving visualization.

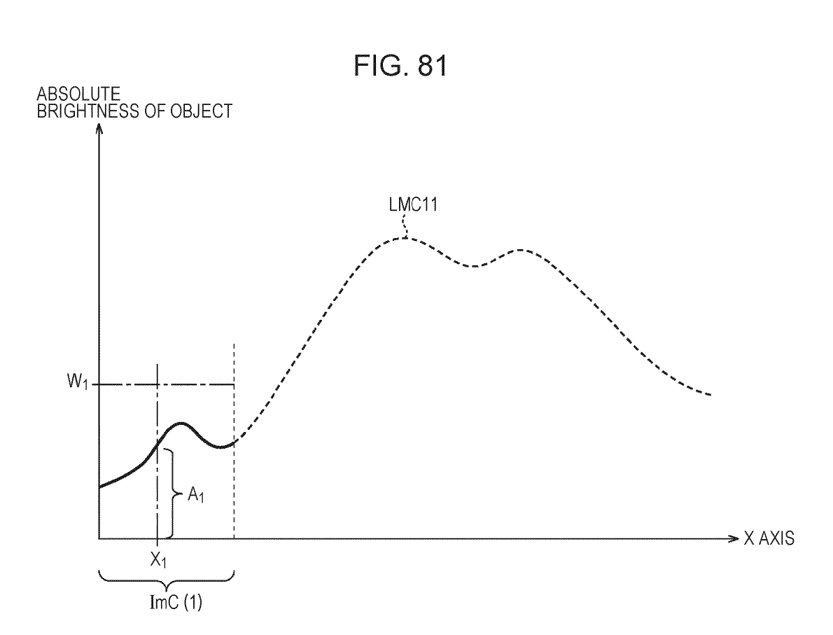

It is assumed that exposure is adjusted such that a value represented as W₁ is 255, and the EV value is set when the first captured image PCT(1) is captured as shown in FIG. 81, for example, in a case where the respective captured images PCT(k) are acquired by capturing the object with the brightness represented by the curve LMC11 as described above. In FIG. 81, the vertical direction and the horizontal direction of the drawing represents brightness of the object and the X-axis direction, the same reference numerals are given to parts corresponding to those in FIG. 80, and the description thereof will be omitted.

Now, it is assumed that absolute brightness of the object at a position X₁ in the X-axis direction is A₁ in the drawing, for example. If the first captured image PCT(1) is captured with such an EV value that the value represented as W₁ becomes 255 at this time, a pixel value of a pixel at the position X₁ on the captured image PCT(1), namely on the region ImC(1) is represented by the following Equation (150).

$$\begin{matrix}[ Math . 150 ] & \\ \frac{255 \times {A}_{1}}{{W}_{1}} & ( 150 )\end{matrix}$$

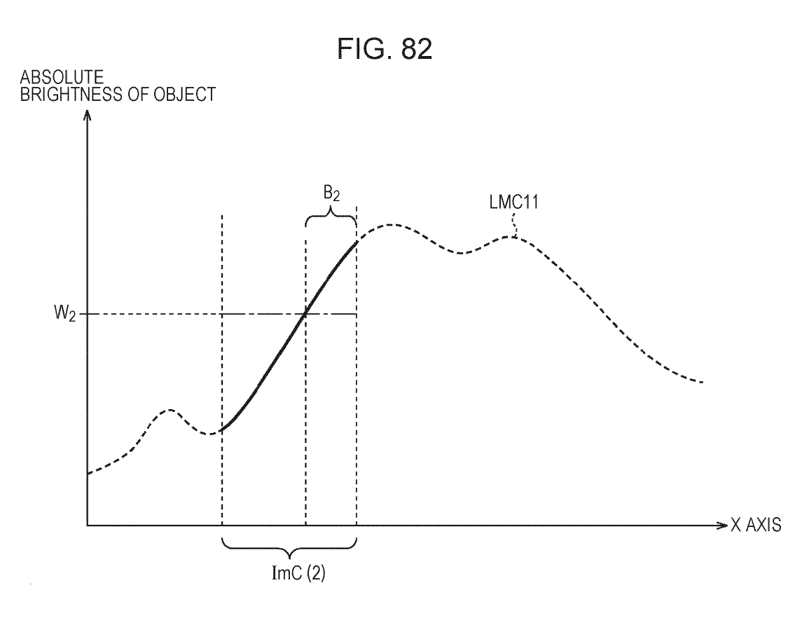

In addition, it is assumed that the exposure is adjusted such that the value represented as W₂ becomes 255 and the EV value is set when the second captured image PCT(2) is captured as shown in FIG. 82, for example.

In such a case, pixel values of pixels in the region on the captured image PCT(2), which corresponds to the part represented by B₂ in the drawing of the curve LMC11, exceed 255. For this reason, a phenomenon called saturation (saturation) and overexposure occurs. That is, the exposure amount at the part represented by B₂ of the curve LMC11 is excessively large, and the pixels are saturated.

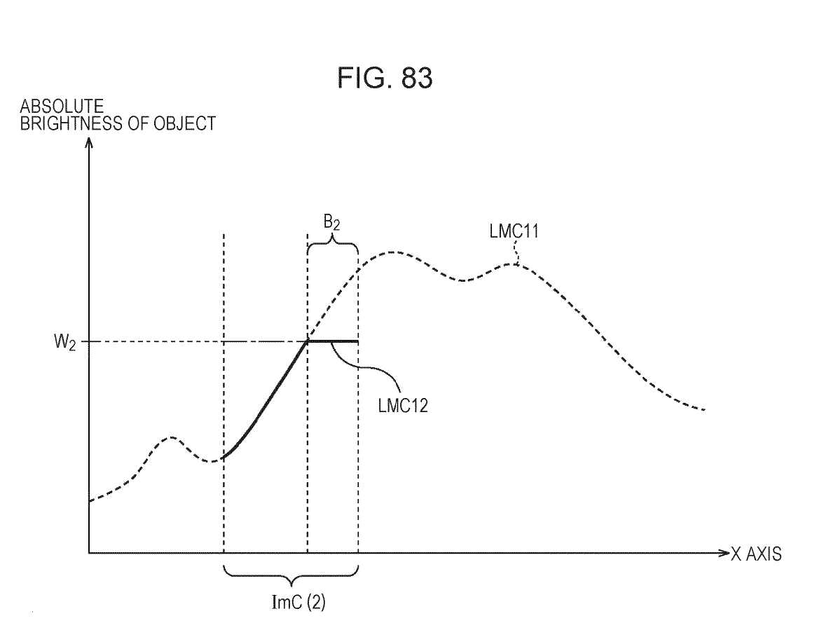

Accordingly, capturing of the captured image PCT(2) is equivalent to capturing of an object with brightness represented by a solid curved line LMC12 as shown in FIG. 83. That is, although the pixel values of the pixels in the region on the captured image PCT(2), which corresponds to the region B2, are originally values of equal to or greater than 255, all the pixel values of the pixels in the region become 255 since the maximum value available for the pixel values of the respective pixels is 255.

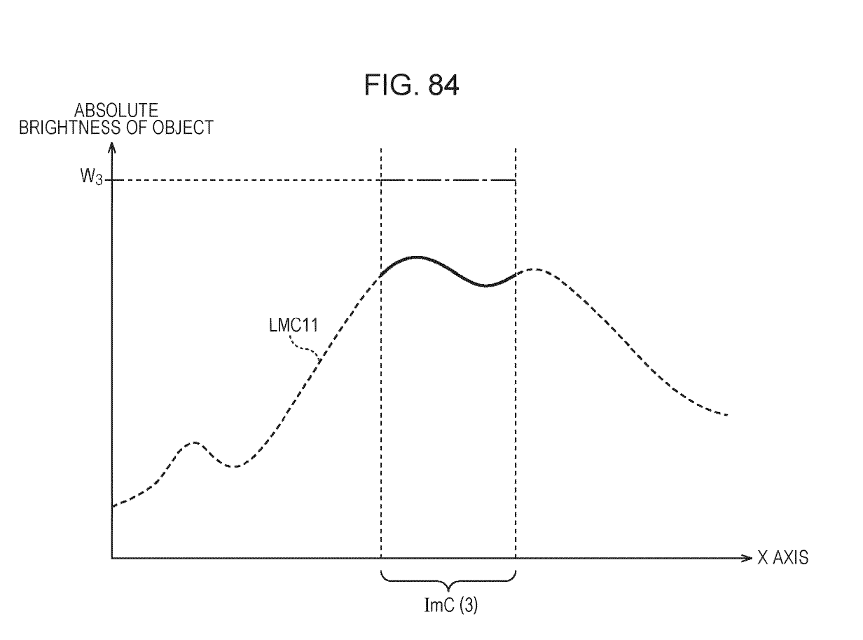

In FIGS. 82 and 83, the vertical direction and the horizontal direction represent brightness of the object and the X-axis direction, and in the drawing, the same reference numerals are given to parts corresponding to those in FIG. 80. Furthermore, the vertical direction and the horizontal direction in FIGS. 84 to 86 shown below also represent brightness of the object and the X-axis direction, and in the drawings, the same reference numerals are given to parts corresponding to those in FIG. 80, and the description thereof will be omitted.

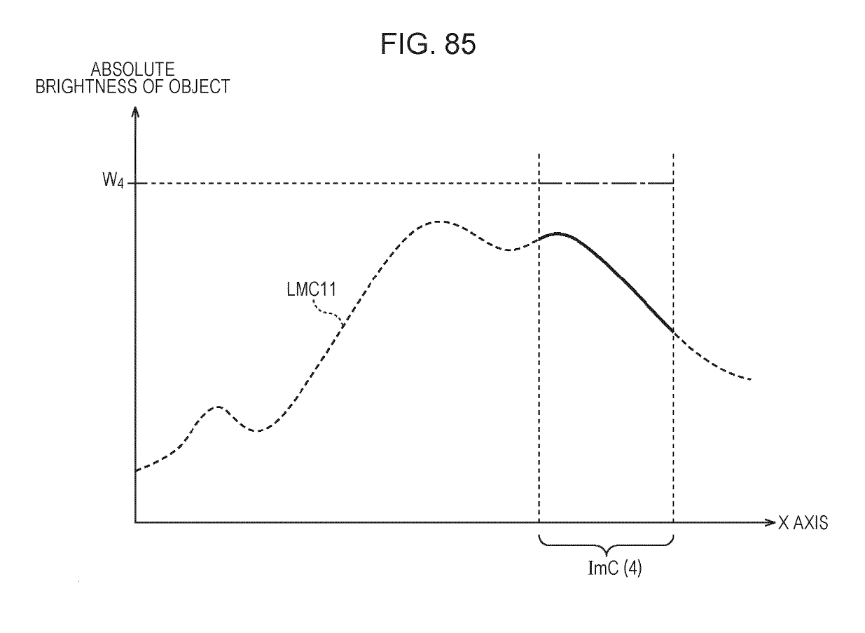

In addition, it is assumed that the exposure is adjusted such that a value represented as W₃ becomes 255 and the EV value is set when the third captured image PCT(3) is captured as shown in FIG. 84, for example. Similarly, it is assumed that the exposure is adjusted such that a value represented as W₄ becomes 255 and the EV value is set when the fourth captured image PCT(4) is captured as shown in FIG. 85. Furthermore, it is assumed that the exposure is similarly adjusted such that a value represented as Wₖ becomes 255 and the EV value is set when the fifth and the following captured images PCT(k) are captured.

The above descriptions can be summarized as follows.

That is, it is assumed that the object with the brightness represented by the curve LMC11 in FIG. 80 is captured in N captured images in a split manner. Here, it is assumed that the exposure is adjusted such that the value of Wₖ (the value representing absolute brightness of the object) becomes 255 and the EV value is set when the k-th captured image PCT(k) is captured as described above with reference to FIGS. 81 to 85, for example.

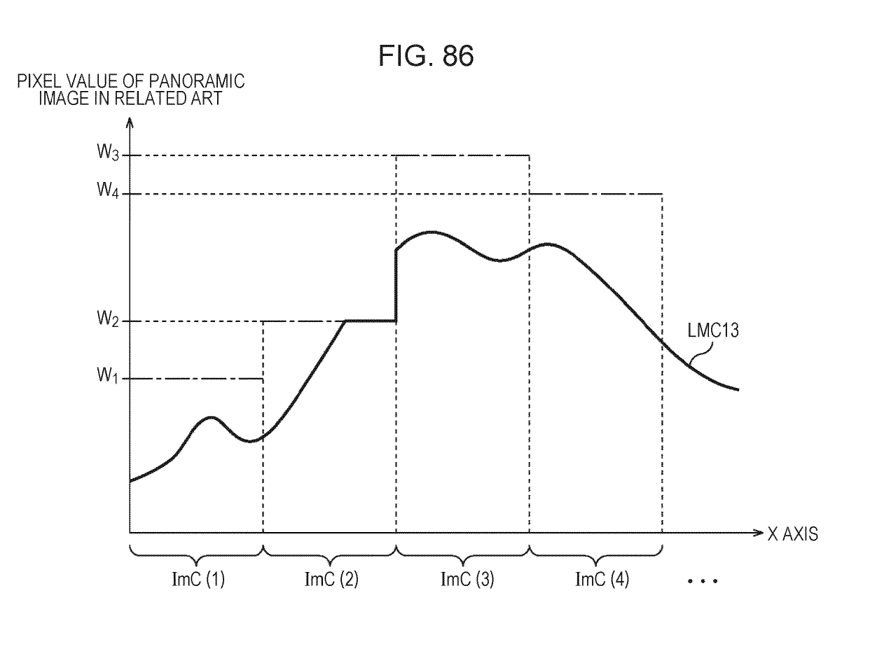

In such case, the same captured images as those when the object with the brightness represented by the curve LMC13 is captured N times in the split manner are acquired as shown in FIG. 86. Accordingly, brightness discontinues at a boundary position between the region ImC(2) and the region ImC(3) in the panoramic image, and a failure in the image occurs as shown in FIG. 86.

If the panoramic image is generated from the N captured images in which the EV values are not fixed, an image failure occurs, that is, brightness discontinues at a part, at which overexposure occurs, on the captured images.

In addition, Japanese Unexamined Patent Application Publication No. 2010-283743 has proposed a technology of handling a case where overexposure occurs as a failure in images by switching a drive mode of a solid-state imaging element.

However, a general imaging device with a solid-state imaging element which cannot switch the drive mode cannot suppress the failure in images. In addition, it is not possible to suppress failures in images, which have already been captured, by applying this technology as long as images are not captured again. This is obvious from the processing in Step S14 and Step S15 in FIG. 15 of Japanese Unexamined Patent Application Publication No. 2010-283743.

The present technology was made in view of such circumstances and is designed to enable acquisition of a panoramic image with higher quality by suppressing deterioration due to failures in images when the panoramic image is generated by connecting a plurality of captured images.

[Overview of Present Technology]

Next, description will be given of overview of the present technology.

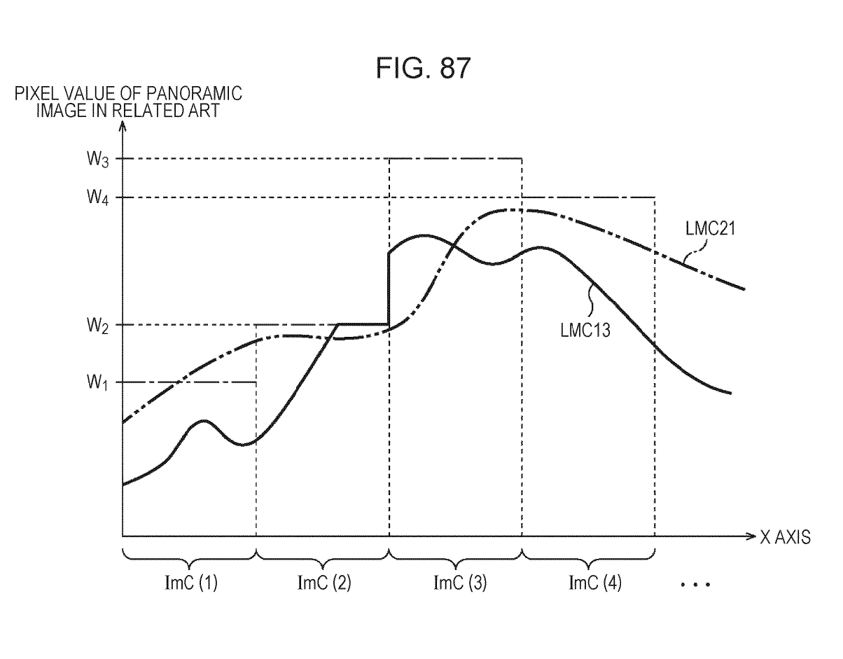

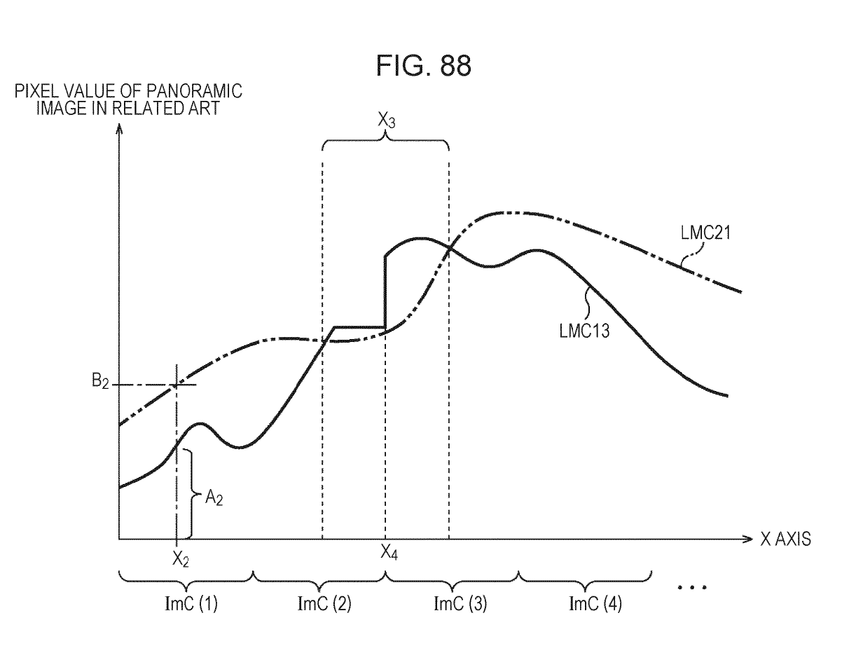

If a panoramic image is generated by using captured images, in which overexposure occurs, as shown in FIGS. 87 and 88, for example, brightness discontinues.

In FIGS. 87 and 88, the vertical direction and the horizontal direction represent brightness of the object and the X-axis direction, the same reference numerals are given to parts corresponding to those in FIG. 86, and the description thereof will be omitted. In FIGS. 87 and 88, illustration of the regions ImC(5) to the region ImC(N) is omitted for improving visualization.

If the panoramic image is generated from the N captured images, in which the EV values are not fixed, the same image as a panoramic image generated by capturing an object with the brightness represented by the curve LMC13 is acquired as described above, for example. That is, a failure occurs in the image.

Thus, according to the present technology, gain adjustment is performed in practice such that the same captured images as those when the object with the brightness represented by the curve LMC21 in FIGS. 87 and 88 is imaged can be acquired, when the object with the brightness represented by the curve LMC11 in FIG. 80 is imaged. That is, the gain adjustment is performed such that the brightness of the curve LMC21 becomes 255.

Specifically, when absolute brightness of an object at a position X₂ in the region ImC(1) in the first captured image PCT(1) is represented as A₂ as shown in FIG. 88, for example, a pixel value of a pixel located at the position X₂ in the captured image PCT(1) is a value represented by the following Equation (151).

$$\begin{matrix}[ Math . 151 ] & \\ \frac{255 \times {A}_{2}}{{W}_{1}} & ( 151 )\end{matrix}$$

In addition, the pixel value of the pixel located at the position X₂ on the final panoramic image is a value represented by the following Equation (152).

$$\begin{matrix}[ Math . 152 ] & \\ \frac{255 \times {A}_{2}}{{B}_{2}} & ( 152 )\end{matrix}$$

In addition, the value B₂ in Equation (152) is a value located at the position X₂ of the curve LMC21.

Incidentally, as shown in FIG. 88, the curve LMC13 is positioned on a further upper side than the curve LMC21 at a section X₃ between the region ImC(2) and the region ImC(3) in the drawing. Accordingly, since the pixel values of the pixels in the section X₃ on the final panoramic image exceeds 255, which is the maximum value of pixel values, the pixel values of these pixels are clipped at 255. Here, a position X₄ in the section X₃ is a position at the boundary part between the region ImC(2) and the region ImC(3).

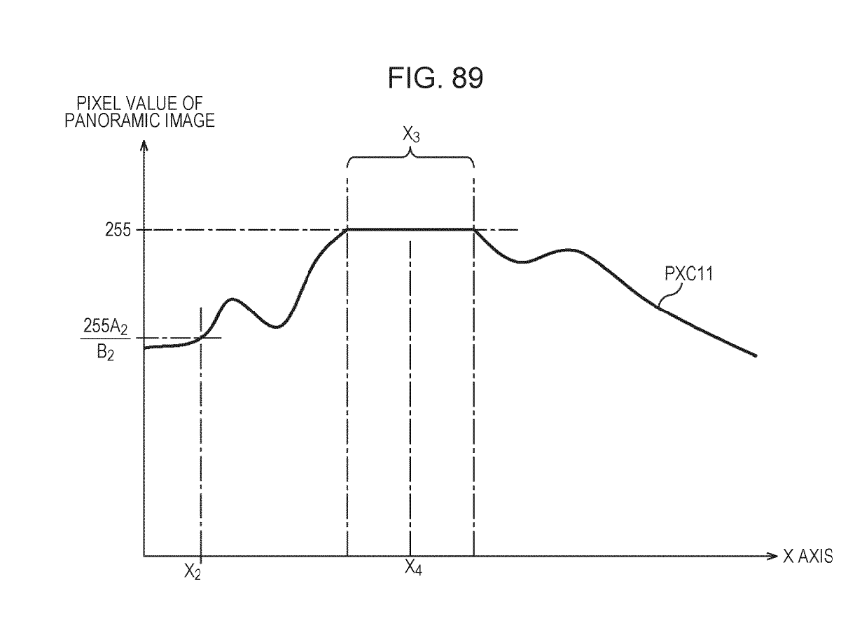

As a result, the pixel values of the respective pixels on the final panoramic image are as shown in FIG. 89. In FIG. 89, the vertical direction and the horizontal direction represent the pixel values of the pixels and the X-axis direction, and in FIG. 89, the same reference numerals are given to parts corresponding to those in FIG. 88, and the description thereof will be omitted.

In FIG. 89, the curve PXC11 represents the pixel values of the pixels at the respective positions on the panoramic Image. For example, a value in the section X₃ of the curve PXC11 is 255 as the maximum value as pixel values by the clipping.

If the curve LMC13 in FIG. 88 is compared with the curve PXC11 in FIG. 89, only a part corresponding to the region ImC(2) in the section X₃ is clipped for the curve LMC13, and brightness discontinues at the position X₄ as the boundary part between the region ImC(2) and the region ImC(3).

In contrast, entire the section X₃ is clipped for the curve PXC11, and therefore, brightness (pixel values) does not discontinue at the position X₄ while overexposure occurs. That is, a failure in the image does not occur.

This is because the curve LMC21 in FIG. 88 is set so as to be positioned on a further lower side than the curve LMC13 in FIG. 88, at the position X₄. That is, the value of the curve LMC21 is set to be smaller than the value of the curve LMC13 at a position at which brightness discontinues according to the method in the related art, namely a position at which overexposure occurs on one side of the adjacent captured images while overexposure does not occur in the other captured image, such as a position X₄.

Here, the curve LMC21 is a function which represents a targeted gain. More specifically, the function represented by the curve LMC21 represents an inverse number of the gain.

With such a configuration, it is possible to acquire an image, in which brightness continues in the vicinity of the position X₄, and to generate a panoramic image with no failures in the image.

In addition, exponential contrast does not occur by setting the curve LMC21 as a gradual curve although gradual contrast occurs in the panoramic image, a panoramic image which is satisfactory enough to be enjoyed is acquired.

Next, description will be given of a flow of processing when a panoramic image is generated in a case where the present technology is applied.

First, description will be given of coordinates and the like illustrating the flow of the processing.

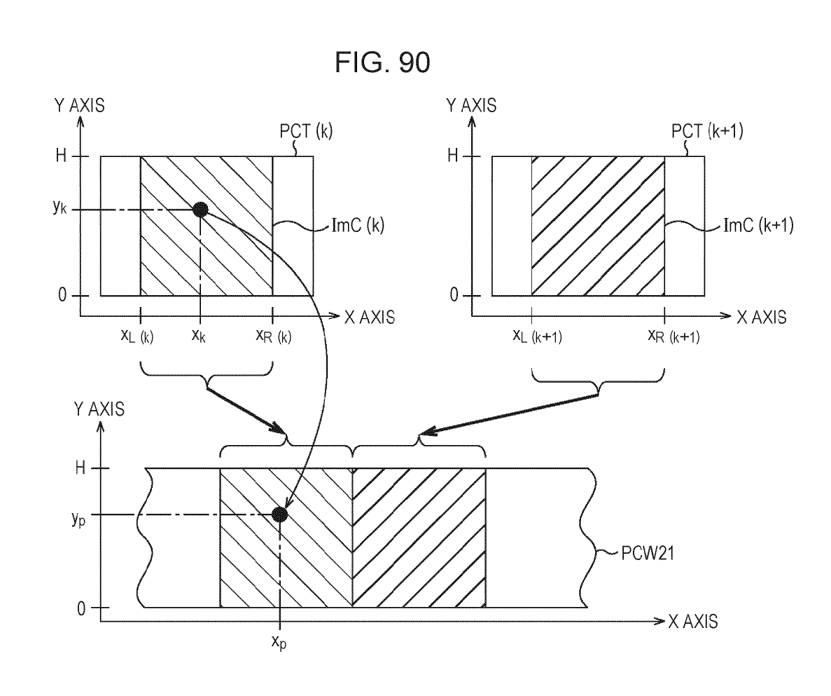

Captured images which the imaging device captures and acquires while moving in the horizontal direction (X-axis direction) are N captured images, namely the first to the N-th captured images. In addition, a region used for generating a panoramic image PCW21 in the k-th (where k=1 to N) captured image PCT(k) is set to a region from a position X=X_{L(k)} to a position X=X_{R(k)} in the X-axis direction as shown in FIG. 90.

In FIG. 90, the vertical axis and the horizontal axis represent an axis in a direction orthogonal to an X axis on the image (hereinafter, referred to as a Y axis) and the X axis.

In the example of FIG. 90, the captured image PCT(k), the captured image PCT(k+1), and the panoramic image PCW21 are images which have positions in the Y axis direction, namely the heights from a position Y=0 to a position Y=H in an XY coordinate system which includes the X axis and the Y axis as axes.

In addition, a region from a position X=X_{L(k)} to a position X=X_{R(k)} in the captured image PCT(k) and a region from a position X=X_{L(k+1)} to a position X=X_{R(k+1)} in the captured image PCT(k+1) are used to generate the panoramic image PCW21.

That is, the region from the position X=X_{L(k)} to the position X=X_{R(k)} in the captured image PCT(k) is the aforementioned region ImC(k), and the region from the position X=X_{L(k+1)} to the position X=X_{R(k+1)} in the captured image PCT(k+1) is the aforementioned region ImC(k+1).

A pixel, an X coordinate (the position on the X axis) of which is X_{R(k)}, in the k-th captured image PCT(k) and a pixel, an X coordinate of which is X_{L(k+1)}, in the k+1-th captured image PCT(k+1) are pixels to which the same object is projected, and the parts correspond to the boundary between the k-th and the k+1-th captured images.

Furthermore, an arbitrary position (Xₚ, Yₚ) in the final panoramic image PCW21 is rendered by using a pixel at a position (xₖ, yₖ) in the k-th captured image PCT(k).

However, k is a value which satisfies the following Equation (153), and the position (xₖ, yₖ) is a position which satisfies the following Equation (154).

$$\begin{matrix}[ Math . 153 ] & \\ {\sum }_{s = 1}^{k - 1} ( {X}_{R ( s )} - {X}_{L ( s )} ) \leq {x}_{p} < {\sum }_{s = 1}^{k} ( {X}_{R ( s )} - {X}_{L ( s )} ) & ( 153 ) \\ [ Math . 154 ] & \\ \{ \begin{matrix}{x}_{k} = {x}_{p} - \{ {\sum }_{s = 1}^{k - 1} ( {X}_{R ( s )} - {X}_{L ( s )} ) \} + {X}_{L ( k )} \\ {y}_{k} = {y}_{p}\end{matrix} & ( 154 )\end{matrix}$$

In addition, the height of the final panoramic image PCW21 in the Y-axis direction is equal to the height H of each captured image in the Y-axis direction, and the width of the panoramic image PCW21 in the X-axis direction is W defined by the following Equation (155).

$$\begin{matrix}[ Math . 155 ] & \\ W = {\sum }_{s = 1}^{N} ( {X}_{R ( s )} - {X}_{L ( s )} ) & ( 155 )\end{matrix}$$

If a pixel value of a pixel in the captured image which is captured with a predetermined EV value (E, for example) is D, absolute brightness of an object projected to the pixel is proportional to 2^{E}×D/255. Accordingly, the pixel value of the pixel becomes 2^{E}×D/MaxLevel if brightness is adjusted such that a predetermined value MaxLevel becomes 255.

### [Configuration Example of Image Processing Apparatus]

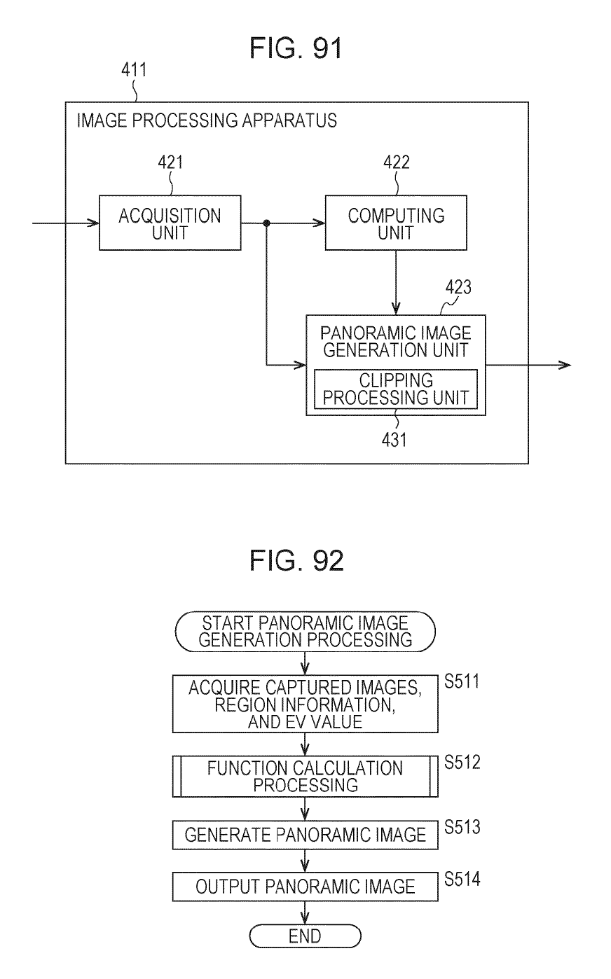

Next, description will be given of a specific embodiment to which the present technology is applied. FIG. 91 is a diagram showing a configuration example of an embodiment of an image processing apparatus to which the present technology is applied.

An image processing apparatus 411 in FIG. 91 is configured of the acquisition unit 421, a computing unit 422, and the panoramic image generation unit 423.

The acquisition unit 421 acquires N captured images which an imaging device such as a digital camera successively captures while turning in the positive direction of the X axis, EV values when the respective captured images are captured, and region information indicating regions in the respective captured images, which are used for generating the panoramic image. The acquisition unit 421 supplies the acquired captured images, the EV values, and the region information to the computing unit 422 and the panoramic image generation unit 423.

The computing unit 422 calculates a function which represents targeted brightness of the object at each position in the X-axis direction based on the captured images, the EV values, and the region information supplied from the acquisition unit 421 and supplies the calculation result to the panoramic image generation unit 423.

The panoramic image generation unit 423 generates a panoramic image based on the captured images, the EV values, and the region information supplied from the acquisition unit 421 and the function supplied from the computing unit 422 and outputs the panoramic image. In addition, the panoramic image generation unit 423 is provided with a clipping processing unit 431, and the clipping processing unit 431 clips pixel values as necessary when the panoramic image is generated.

### [Description of Panoramic Image Generation Processing]

Next, description will be given of panoramic image generation processing by the image processing apparatus 411 with reference to the flowchart in FIG. 92.

In Step S511, the acquisition unit 421 acquires N captured images, EV values of the respective captured images, and region information and supplies the captured images, the EV values, and the region information to the computing unit 422 and the panoramic image generation unit 423.

Here, the region information is information indicating the region ImC(k) in each captured image PCT(k) (where k=1 to N), which is used for generating the panoramic image. For example, the information indicating the region ImC(k) is information which indicates the position X_{L(k)} and the position X_{R(k)} as the X coordinates of both ends of the region ImC(k).

Hereinafter, an EV value of the k-th (where k=1 to N) captured image PCT(k) is referred to as E(k).

In Step S512, the computing unit 422 performs function calculation processing based on the captured image PCT(k), the region information, and the EV value E(k) supplied from the acquisition unit 421, and calculates a function MaxLevel(xₚ) for the position xₚ on the X axis in the panoramic image to be generated.

Here, the function MaxLevel(xₚ) is a function which represents targeted brightness (gain) of the object at each position xₚ, and is a function representing the curve LMC21 in FIG. 87. The function MaxLevel(xₚ) calculated by the computing unit 422 is supplied to the panoramic image generation unit 423. In addition, a detail of the function calculation processing will be described later.

In Step S513, the panoramic image generation unit 423 generates a panoramic image based on the captured image PCT(k), the region information, and the EV value E(k) supplied from the acquisition unit 421 and the function MaxLevel(xₚ) supplied from the computing unit 422.

Specifically, the panoramic image generation unit 423 is designed to generate a panoramic image with a height H in the Y axis direction and with a width W in the X-axis direction, and selects the position (xₚ, yₚ) on the panoramic image. Then, the panoramic image generation unit 423 acquires k, which satisfies the aforementioned Equation (153), for the selected position (xₚ, yₚ), calculates Equation (154) based on acquired k and the region information of the respective captured images, and acquires a position (xₖ, yₖ) in the captured image PCT(k) with respect to the position (xₚ, yₚ).

Furthermore, the panoramic image generation unit 423 calculates the pixel value of the pixel at the position (xₚ, yₚ) in the panoramic image by reading a pixel value D (k, xₖ, yₖ) of a pixel located at the acquired position (xₖ, yₖ) in the captured image PCT(k) and calculating the following Equation (156).

$$\begin{matrix}[ Math . 156 ] & \\ \frac{{2}^{E ( k )} \times D ( k , {x}_{k} , {y}_{k} )}{MaxLevel ( {x}_{p} )} & ( 156 )\end{matrix}$$

If the calculation value is calculated by the calculation of Equation (156), the clipping processing unit 431 performs clipping processing of the calculated pixel value as necessary.

That is, when the pixel value acquired by the calculation of Equation (156) exceeds 255 as the maximum value of values available for the pixel values, the clipping processing unit 431 performs clipping and sets the pixel value of the pixel at the position (xₚ, yₚ) to 255. That is, the calculated pixel value is clipped at 255.

In contrast, when the pixel value acquired by the calculation of Equation (156) does not exceed 255, the clipping processing unit 431 does not perform the clipping and sets the acquired pixel value as the pixel value of the pixel at the position (xₚ, yₚ).

Then, the panoramic image generation unit 423 maps the pixel value which is appropriately subjected to the clipping processing by the clipping processing unit 431, namely the pixel value calculated by the calculation of Equation (156) or 255 for the pixel at the position (xₚ, yₚ) in the panoramic image. That is, the acquired pixel value is regarded as the pixel value of the pixel at the position (xₚ, yₚ).

The panoramic image generation unit 423 performs the aforementioned mapping on each position (xₚ, yₚ) on the panoramic image and generates the panoramic image.

In Step S514, the panoramic image generation unit 423 outputs the generated panoramic image, and the panoramic image generation processing is completed.

As described above, the image processing apparatus 411 calculates the function MaxLevel(xₚ) which represents targeted brightness of the object and calculates the pixel value of each pixel in the panoramic image from the acquired function. At this time, the image processing unit 411 performs the clipping processing on the calculated pixel value as necessary and acquires a final pixel value.

It is possible to acquire a panoramic image with high quality, which includes no failures in the image, by acquiring the function representing the targeted brightness of the object and acquiring the pixel value of the pixel in the panoramic image.

### [Description of Function Calculation Processing]

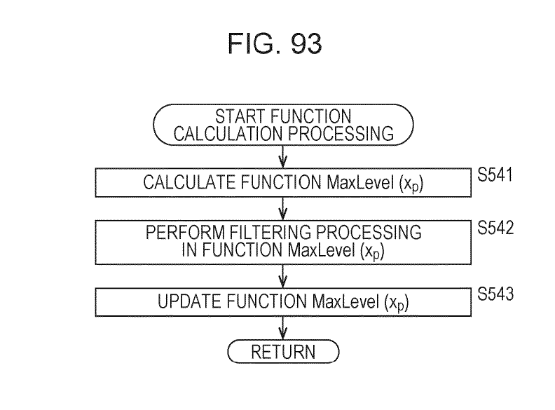

Next, description will be given of function calculation processing corresponding to the processing in Step S512 in FIG. 92 with reference to the flowchart in FIG. 93.

In Step S541, the computing unit 422 selects the position (xₚ, yₚ) on the panoramic image with the height H in the Y-axis direction and the width W in the X-axis direction. Then, the computing unit 422 acquires k which satisfies Equation (153) for the selected position (xₚ, yₚ), calculates Equation (154) based on acquired k and the region information of each captured image, and acquires the position (xₖ, yₖ) in the captured image PCT(k), which corresponds to the position (xₚ, yₚ).

Furthermore, the computing unit 422 calculates the function MaxLevel(xₚ) by reading the pixel value D(k, xₖ, yₖ) of the pixel located at the acquired position (xₖ, yₖ) in the captured image PCT(k) and calculating the following equation (157).

$$\begin{matrix}[ Math . 157 ] & \\ MaxLevel ( {x}_{p} ) ≡ ( 1 + margin ) \times {max}_{0 \leq {y}_{p} < H} ( \frac{{2}^{E ( k )} \times D ( k , {x}_{k} , {y}_{k} )}{255} ) & ( 157 )\end{matrix}$$

In Equation (157), k represents a value which satisfies Equation (153) and Equation (154), margin represents a predetermined value such as 0.1.

Furthermore, max(2^{E(k)}×D(k, xₖ, yₖ)/255) in Equation (157) represents a function which outputs the maximum value of a value 2^{E(k)}×D(k, xₖ, yₖ)/255 when yₚ as a Y coordinate is changed in the selected the position (xₚ, yₚ). That is, max(2^{E(k)}×D(k, xₖ, yₖ)/255) represents a function which outputs the maximum value of 2^{E(k)}×D(k, xₖ, yₖ)/255 at the position (xₚyₚ) for each yₚ which satisfies 0≦yₚ≦H.

The thus acquired function MaxLevel(xₚ) is a temporarily acquired provisional function, and the function MaxLevel(xₚ) is processed (changed) by the following processing.

For example, it is assumed that processing in Step S513 in FIG. 92, namely calculation of Equation (156) is performed by using the function MaxLevel(xₚ) acquired by the processing in Step S541. In such a case, a pixel value of each pixel in the panoramic image is a value of equal to or less than 255/(1+margin)=255/1.1=232 (a value in consideration of margin corresponding to 10% of 255).

Incidentally, the function MaxLevel(xₚ) is discontinuous for each value of xₚ as an X coordinate if any change is made, and contrast is generated for each value of xₚ in the panoramic image. In order to solve the problem, processing in Step S542 and Step S543 is performed after the processing in Step S541.

In Step S542, the computing unit 422 performs filtering processing using LPF (Low Pass Filter) on the function MaxLevel(xₚ) and regards a function acquired as a result as an updated function MaxLevel(xₚ).

By such filtering processing, the function MaxLevel(xₚ) becomes a function of a curve which smoothly change for the position xₚ. That is, a function of a gradual curve is acquired.

Although the thus acquired function MaxLevel(xₚ) is further processed (changed) by the following processing, it is assumed that the processing in Step S513 in FIG. 92, namely calculation of Equation (156) is performed by using the function MaxLevel(xₚ) acquired by the processing in Step S542. In such a case, the pixel value of each pixel in the panoramic image is a value which is substantially equal to or less than 255/(1+margin)=255/1.1=232 (a value in consideration of margin corresponding to 10% of 255).

In addition, since the function MaxLevel(xₚ) gradually changes even if the value of xₚ varies, exponential contrast does not occur for each value of xₚ in the acquired panoramic image, and a panoramic image which is satisfactory enough to be enjoyed is acquired. However, the aforementioned failure at the part of overexposure is not taken into consideration. Thus, the following processing in Step S543 is performed in order to solve the failure in the image at the part of overexposure.

In Step S543, the computing unit 422 updates the function MaxLevel(xₚ) such that a value in a predetermined section of the function MaxLevel(xₚ) becomes a smaller value as necessary.

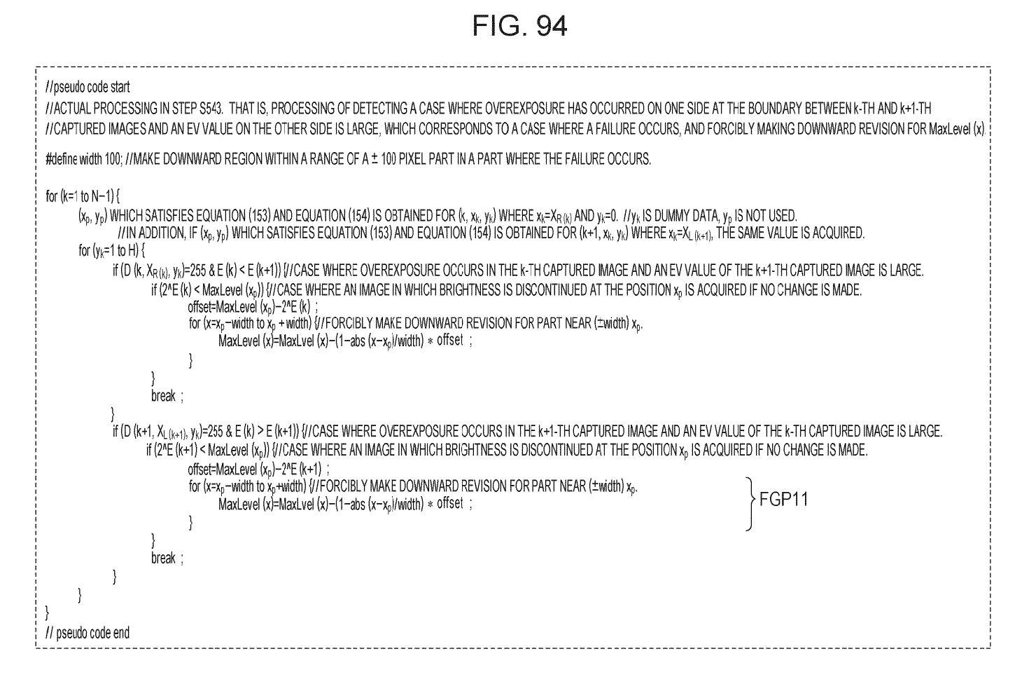

Specifically, the computing unit 422 executes a pseudo code shown in FIG. 94, for example. When overexposure occurs in one region of the region ImC(k) in the k-th captured image and the region ImC(k+1) in the k+1-th captured image at the boundary position thereof, and the EV value of the other region is large, for example, a failure in the images occurs. Thus, the region where such a failure in the images occur is detected and the function MaxLevel(xp) is forcedly corrected downward in the detected region in the processing represented by the pseudo code in FIG. 94.

That is, the computing unit 422 sets a value corresponding to a half of the width of the region, in which the function MaxLevel(xₚ) is corrected downward, in the X-axis direction to width, and sets the value of width to 100. That is, in the region where the failure in the images occur, the function MaxLevel(xₚ) is corrected downward in the region of ±100 pixels including the part.

Next, the computing unit 422 performs the following processing for each k (where k=1 to N−1). That is, the computing unit 422 acquires the position (xₚ, yₚ) on the panoramic image which satisfies Equation (153) and Equation (154) for a position (xₖ, yₖ)=(X_{R(k)}, 0) in the k-th captured image. In other words, the position (xₚ, yₚ) is acquired for (k, xₖ, yₖ).

In addition, yₖ is a dummy, and yₚ at the acquired position (xₚ, yₚ) is not used. In addition, xₖ may be set to be equal to X_{L(k+1)}, and the position (xₚ, yₚ) which satisfies Equation (153) and Equation (154) may be acquired for (k+1, xₖ, yₖ).

Next, the computing unit 422 determines whether or not the pixel value D(k, X_{R(k)}, yₖ) of the pixel at the position (x_{R(k)}, yₖ) in the k-th captured image is 255 and the EV value E(k) is less than the EV value E(k+1), for yₖ=1 to H.

Here, the case where the pixel value D(k, X_{R(k)}, yₖ)=255 and E(k)<E(k+1) is a case where overexposure occurs in the k-th captured image and the EV value E(k+1) of the k+1-th captured image is greater than the EV value E(k) of the k-th captured image.

When it is determined that the pixel value D(k, X_{R(k)}, yₖ)=255 and E(k)<E(k+1), the computing unit 422 further determines whether or not a value which is the E(k)-th power of 2 is less than the value of the function MaxLevel(xₚ). Here, 2^{E(k)}<MaxLevel(xₚ), brightness discontinues at the position xₚ if no change is made.

Thus, when it is determined that 2^{E(k)}<MaxLevel(xₚ), the computing unit 422 sets an offset=MaxLevel(xₚ)−2^{E(k)}. Then, the computing unit 422 sets MaxLevel(x)−(1-abs(x−xₚ)/width)×offset as a new function MaxLevel(xₚ) after the updating for the position X=x from xₚ-width to xₚ+width in the function MaxLevel(xₚ). Here, abs(x−xₚ) denotes an absolute value of (x−xₚ).

By such processing, a value in the vicinity of the position xₚ in the function MaxLevel(xₚ) is forcedly corrected downward.

In addition, the computing unit 422 performs the following processing for the position (xₚ, yₚ) on the panoramic image, which is acquired for each k (where k=1 to N−1).

That is, the computing unit 422 determines whether or not the pixel value D(k+1, X_{L(k+1)}, yₖ) of the pixel at the position (X_{L(k+1)}, yₖ) in the k+1-th captured image for yₖ=1 to H is 255 and the EV value E(k) is greater than the EV value E(k+1).

Here, the case where the pixel value D(k+1, X_{L(k+1)}, yₖ)=255 and E(k)>E(k+1) is a case where overexposure occurs in the k+1-th captured image and the EV value E(k) of the k-th captured image is greater than the EV value E(k+1) of the k+1-th captured image.

When it is determined that the pixel value D(k+1, X_{L(k+1)}, yₖ)=255 and E(k)>E(k+1), the computing unit 422 further determines whether or not the E(k+1)-th power of 2 is less than the value of the function MaxLevel(xₚ). Here, when 2^{E(k+1)}<MaxLevel(xₚ), brightness discontinues at the position xₚ if no change is made.

Thus, when it is determined that 2^{E(k+1)}<MaxLevel(xₚ), the computing unit 422 sets an offset=MaxLevel(xₚ)−2^{E(k+1)}. Then, the computing unit 422 sets MaxLevel(x)−(1-abs(x−xₚ)/width)×offset as a new function MaxLevel(xₚ) after the updating for the position X=x from xₚ−width to xₚ+width in the function MaxLevel(xₚ). Here, abs(x−xₚ) represents an absolute value of (x−xₚ).

If the function MaxLevel(xₚ) is acquired as described above, the computing unit 422 supplies the acquired function MaxLevel(xₚ) to the panoramic image generation unit 423, and the function calculation processing is completed. In addition, if the function calculation processing is completed, then the processing moves on to Step S513 in FIG. 92.

The function MaxLevel(xₚ) generated by the function calculation processing smoothly changes at the position xₚ and satisfies MaxLevel(xₚ)<LMC13 at a position, at which a failure in the image occurs due to overexposure, for example, the position X₄ in FIG. 88. Accordingly, it is possible to solve the failure in the image (discontinuity of brightness) at the part of overexposure if the panoramic image is generated by the calculation of Equation (156) in Step S513 in FIG. 92 by using the function MaxLevel(xₚ).

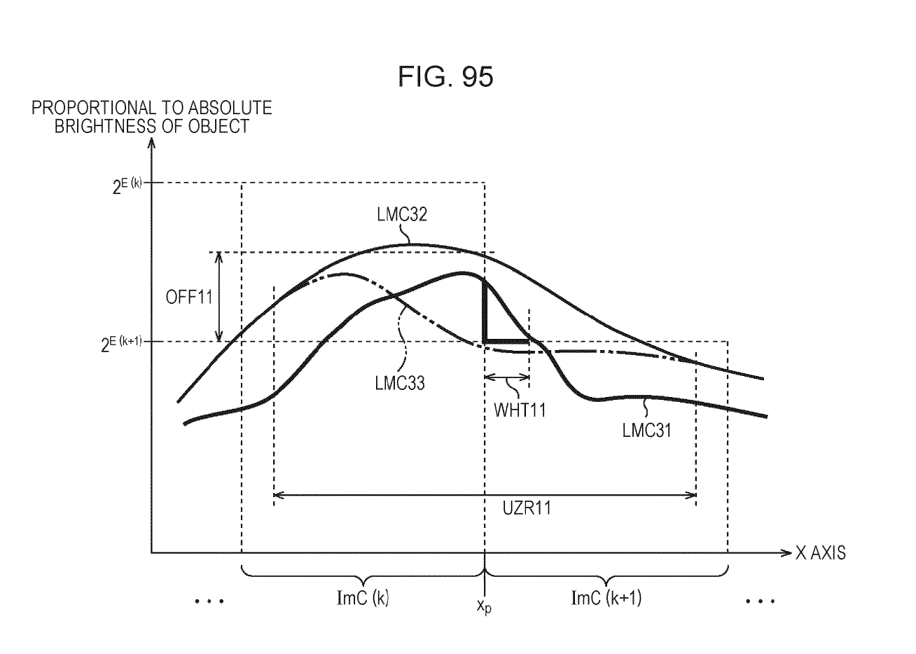

When the processing is performed on the part corresponding to FGP11 of the pseudo code shown in FIG. 94, for example, the EV value E(k) of the k-th captured image is greater than the EV value E(k+1) of the k+1-th captured image, and overexposure occurs at the position X_{L(k+1)} at the left end of the region ImC(k+1) in the k+1-th captured image as shown In FIG. 95. In such a case, the value of the function MaxLevel(xₚ) acquired in Step S542 in FIG. 93 is greater than 2^{E(k+1)}.

In FIG. 95, the vertical axis and the horizontal axis represent brightness of the object and the X-axis. In the drawing, the curve LMC31 to the curve LMC33 represent actual absolute brightness of the object, the function MaxLevel(xₚ) acquired in the processing in Step S542, and the final function MaxLevel(xₚ) acquired in the processing in Step S543, respectively.

Since the EV value E(k) when the k-th captured image is captured is greater than the EV value E(k+1) when the k+1-th captured image is captured in the example of FIG. 95, 2^{E(k+1)}<2^{E(k)} as represented by the vertical axis in the drawing.

In addition, overexposure occurs at a part corresponding to the left end of the k+1-th captured image, namely a part at the position X_{L(k+1)} (a part where the position X=xₚ in the drawing) in the region ImC(k+1). For this reason, the pixel value of each pixel in the panoramic image at a part corresponding to the region WHT11 on the further right side than the position xₚ on the panoramic image, in which overexposure occurs, in the drawing is 2^{E(k+1)}.

Furthermore, the value of the curve LMC32 which represents the function MaxLevel(xₚ) acquired by the processing in Step S542 in FIG. 93 is greater than 2^{E(k+1)}.

Now, if the panoramic image is generated by the calculation of Equation (156) in Step S513 in FIG. 92 by using the function MaxLevel(xₚ) represented by the curve LMC32, a failure in the image (discontinuity of brightness) occurs at the position xₚ in the panoramic image.

Thus, the function MaxLevel(xₚ) is corrected downward such that the gradual curve is maintained and the function MaxLevel(xₚ) is equal to or less than 2^{E(k+1)} at the position xₚ. With such processing, the curve LMC32 is corrected downward, and the curve LMC33 is acquired.

Here, the region UZR11 in the drawing is a region as a target of the downward correction, and the region UZR11 is a region with a width, which has a center at the position xₚ, of 2×width. In the drawing, a length OFF11 in the vertical axis direction is a value of the offset used for calculating the function MaxLevel(xₚ) after the downward correction. That is, the length OFF11 is a differential between the value of the curve LMC32 (function MaxLevel(xₚ)) at the position xₚ and 2^{E(k+1)}.

If the panoramic image is generated by the calculation of Equation (156) in Step S513 in FIG. 92 while correcting downward the function MaxLevel(xₚ) as described above, overexposure occurs at each position in the vicinity of the position xₚ in the panoramic image, and a failure in the image (discontinuity of brightness) does not occur.

According to the present technology, it is possible to avoid a failure in the image due to discontinuous brightness on the panoramic image and to acquire a panoramic image with high quality as described above.

The present technology described in the tenth embodiment can be configured as follows.

[1] An image processing method of generating a single output image by using a plurality of captured images as inputs and connecting the captured images, including:

a gain value calculation step in which a gain value G(x, y) at a pixel position (x, y) of the output image is acquired; and

a rendering step in which a value acquired by multiplying pixel data at a pixel position in a corresponding k-th captured image by (2^{E(k)})×G(X, y) where an EV value when the K-th captured image is captured is represented as E(k) is set as the pixel data at each pixel position (x, y) in the output image,

wherein in the gain value calculation step, the gain value G(x, y) is a function which gradually changes with respect to the pixel position (x, y), and the gain value G(x, y) is fixed such that the following condition is satisfied, that is, 1/(2^{E(m)})≦G(x, y) is satisfied when the pixel position (x, y) of the output image corresponds to a connected part of two captured images, overexposure occurs in an m-th captured image, which is one of the two captured images, and an EV value of an n-th captured image, which is the other captured image, is greater than that of the m-th captured image.

[2] The image processing method according to [1],

wherein in the gain value calculation step, the gain value G(x, y) is fixed such that the gain value G(x, y) becomes an inverse number of a function acquired by performing LPF (Low Pass Filter) on the maximum value of a value acquired by multiplying pixel data at a pixel position in an s-th captured image, which corresponds to the vicinity of each pixel position (x, y) in the output image, by 2^{E(s)} at a part which does not satisfy the condition.

### [Horizontal Detection Under Condition of Constant Tilt]

### Eleventh Embodiment

### Concerning Panoramic Image

When a panoramic image is generated, elevation angles or depression angles when the captured images are captured may be acquired, and the panoramic image may be generated on the assumption that the elevation angles or the depression angles of the respective captured images are constant.

It is possible to generate the panoramic image by editing the plurality of captured images which are acquired by a digital camera imaging in various directions, for example. That is, if the first to N-th N captured images and imaging directions, in which the respective N captured images are captured, in a coordinate system with reference to the imaging direction in which the first captured image is captured are provided, it is possible to generate the panoramic image.

Specifically, a method of generating a panoramic image is described in “M. Brown and D. Lowe. Automatic Panoramic Image Stitching using Invariant Features. International Journal of Computer Vision, 74(1), pages 59-73, 2007”, for example.

In Chapter 5 “Automatic Panorama Straightening” in this article, an imaging direction, in which the first captured image is captured, in a world coordinate system is acquired on the assumption that the lateral direction of the captured image is horizontal.

However, when imaging is performed in order to acquire a panoramic image, a wide angle lens is generally used in many cases. In addition, it is difficult to perform imaging while maintaining a horizontal state when the wide angle lens is used. For this reason, some digital camera with a wide angle lens includes a digital level in recent years.

Accordingly, the assumption of the above article that the lateral direction of the captured images is horizontal is not generally established. Therefore, the panoramic image acquired by the technology disclosed in the above article becomes an image in which the lateral axis is not horizontal in most cases, and it is not possible to generate a panoramic image with satisfactory appearance.

That is, since there is no appropriate method of detecting the imaging direction, in which the first captured image is captured, in the world coordinate system in the technology described in the above article, the lateral axis of the panoramic image as a resulting image does not coincide with a horizontal line, and the panoramic image becomes an image with unsatisfactory appearance.

The present technology was made in view of such circumstances, and is designed to enable acquisition of a panoramic image with high quality, which has a satisfactory appearance.

### [Concerning Present Technology]

Next, description will be given of the present technology. The present technology is a technology for generating a panoramic image by editing a plurality of captured images acquired by an imaging device such as a digital camera imaging in various directions. Here, problems to be solved by the present technology will be clearly described before describing a specific embodiment to which the present technology is applied.

The problem to be solved by the present technology is a problem of calculating positional relationships of N captured images, namely an imaging direction, in which the first captured image is captured, in an absolute coordinate system when imaging directions in which the N respective captured images are captured are input to the coordinate system with reference to the imaging direction in which the first captured image is captured. Hereinafter, the absolute coordinate system will be referred to as a world coordinate system.

This problem is expressed by using equations as follows.

First, it is assumed that a 3×3 homogeneous transformation matrix P₍ₛ₎ (where s=1 to N) is provided as information indicating the imaging directions, in which the N respective captured images are captured, in the coordinate system with reference to the imaging direction in which the first captured image is captured. That is, it is assumed that the homogeneous transformation matrix P₍ₛ₎ described below is provided.

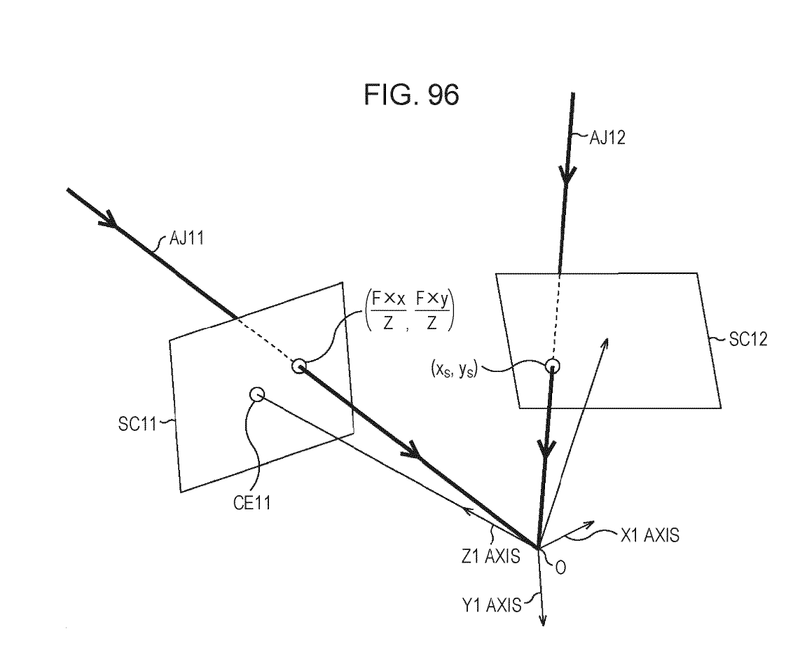

As shown in FIG. 96, an X1Y1Z1 coordinate system with reference to the imaging direction in which the first captured image is captured is considered.

The origin O of the coordinate system is an optical axis center of the imaging device when the first captured image is captured. In addition, a direction from the origin O to a center CE11 of a screen SC11 when the first captured image is captured is a Z1-axis direction of the X1Y1Z1 coordinate system. Moreover, an image on the screen SC11 is the first captured image.

Here, if it is assumed that a focal distance of the imaging device is F, coordinates in the X1Y1Z1 coordinate system which indicate the position of the center CE11 of the screen SC11 when the first captured image is captured are (0, 0, F).

In addition, a light beam flowing from a predetermined position (x, y, z) in the X1Y1Z1 coordinate system toward the origin O, which is represented by the arrow AJ11, is projected to a position (F×x/z, F×y/z) in the first captured image. Furthermore, a light beam flowing from a predetermined position (x′, y′, z′) in the X1Y1Z1 coordinate system toward the origin O, which is represented by the arrow AJ11, is projected to a position (xₛ, yₛ) (where s=1 to N) in the s-th captured image which satisfies the following Equation (158).

$$\begin{matrix}[ Math . 158 ] & \\ [ \begin{matrix}{x}^{′} \\ {y}^{′} \\ {z}^{′}\end{matrix} ] ∝ {P}_{( s )} [ \begin{matrix}{x}_{s} \\ {y}_{s} \\ F\end{matrix} ] & ( 158 )\end{matrix}$$

In addition, the position (F×x/z, F×y/z) is a position in the coordinate system with reference to the first captured image, and the position (xₛ, yₛ) is a position in the coordinate system with reference to the s-th captured image. Moreover, the homogeneous transformation matrix P₍₁₎ when s=1 in Equation (158) is a 3×3 unit matrix.

Accordingly, the problem to be solved by the present technology is equivalent to a problem of acquiring the 3×3 homogeneous transformation matrix P when the homogeneous transformation matrix P₍ₛ₎ (where s=1 to N) is provided. Here, the homogeneous transformation matrix P is a 3×3 matrix, which includes a mutually orthogonal Xw axis, a Yw axis, and a Zw axis as axes, and according to which a light beam flowing from a position (x_{w}, y_{w}, z_{w}) in the world coordinate system with an origin Ow toward the origin Ow is projected to a position (x₁, y₁) in the first captured image which satisfies the following Equation (159). That is, the homogeneous transformation matrix P is a matrix which satisfies Equation (159) when the light directed from the position (x_{w}, y_{w}, z_{w}) toward the origin Ow is projected to the position (x₁, y₁) in the first captured image.

$$\begin{matrix}[ Math . 159 ] & \\ [ \begin{matrix}{x}_{w} \\ {y}_{w} \\ {z}_{w}\end{matrix} ] ∝ P [ \begin{matrix}{x}_{1} \\ {y}_{1} \\ F\end{matrix} ] & ( 159 )\end{matrix}$$

In Equation (159), the position (x₁, y₁) is a position in the coordinate system with reference to the first captured image.

Moreover, a general panoramic image generation process is as follows.

First, N captured images acquired by an imaging device such as a digital camera imaging in various directions are prepared (Process ST1). Then, positional relationships of the respective captured images are acquired by matching processing on the captured images (Process ST2). With such a process, imaging directions, in which the N respective captured images are imaged, in the coordinate system with reference to the imaging direction in which the first captured image is captured is acquired. That is, the aforementioned homogeneous transformation matrix P₍ₛ₎ is acquired. Since a specific calculation procedure is described in the aforementioned article, the description thereof will be omitted.

Then, the imaging direction of the first captured image in the world coordinate system is calculated from the information on the imaging directions, in which the N respective captured images are captured, in the coordinate system with reference to the imaging direction in which the first captured image is captured, which is acquired in Process ST2, namely the homogeneous transformation matrix P₍ₛ₎ (where s=1 to N) (Process ST3). That is, the aforementioned homogeneous transformation matrix P is calculated.

Furthermore, the imaging directions, in which the N respective captured images are captured, in the world coordinate system are acquired from the imaging directions of the N respective captured images in the coordinate system with reference to the imaging direction of the first captured image, which is acquired in Process ST2, and the imaging direction, in which the first captured image is captured, in the world coordinate system, which is acquired in Process ST3 (Process ST4).

Specifically, the imaging directions of the N respective captured images in the world coordinate system can be acquired by multiplication between the homogeneous transformation matrix P₍ₛ₎ and the homogeneous transformation matrix P. Since such calculation is known in the field of computer graphics, the detailed description thereof will be omitted. In addition, the homogeneous transformation matrix P(s) is a homogeneous transformation matrix which represents the imaging directions of the N respective captured images in the coordinate system with reference to the imaging direction of the first captured image, which is acquired in Process ST2. Furthermore, the homogeneous transformation matrix P is a homogeneous transformation matrix which represents the imaging direction of the first captured image in the world coordinate system, which is acquired in Process ST3.

Next, a panoramic image (omnidirectional image) is generated by mapping pixel values of pixels in the N respective captured images as light beams incident from the imaging directions, in which the N respective captured images are captured, in the world coordinate system, which is acquired in Process ST4, on a sky canvas (Process ST5).

Incidentally, Process ST1, Process ST2, Process ST4, and Process ST5 are known technologies in the panoramic image generation process, and it is possible to acquire a panoramic image, the lateral axis of which coincides with the horizontal line, if the remaining process ST3 can be solved. That is, it is only necessary to solve the problem, which can be solved by the aforementioned present technology.

Thus, the following description will be given of a method of solving the problem, which can be solved by the aforementioned present technology. That is, acquisition of the 3×3 homogeneous transformation matrix P when the homogeneous transformation matrix P₍ₛ₎ (where s=1 to N) is provided will be described.

According to Chapter 5 “Automatic Panorama Straightening” in the aforementioned article by “M. Brown and D. Lowe.”, the imaging direction of the first captured image in the world coordinate system is acquired on the assumption that the lateral directions of the captured images are horizontal. That is, the homogeneous transformation matrix P is acquired such that a vector represented by the following Equation (160) for arbitrary s is orthogonal to a vector (0, 1, 0).

$$\begin{matrix}[ Math . 160 ] & \\ {PP}_{( s )} [ \begin{matrix}1 \\ 0 \\ F\end{matrix} ] - {PP}_{( s )} [ \begin{matrix}0 \\ 0 \\ F\end{matrix} ] & ( 160 )\end{matrix}$$

However, since the assumption itself that the lateral directions of the captured images are horizontal is not correct in many cases as described above, it is not possible to achieve a significantly satisfactory result. That is, it is not possible to acquire a panoramic image with a satisfactory appearance in many cases.

According to the present technology, an attention is paid to a point that imaging is generally performed while the imaging device is rotated in a state where a tilt angle of the imaging device is constant with respect to the horizontal line when images are captured while the imaging device is rotated, and the homogeneous transformation matrix P is acquired under the condition. With such a configuration, it is possible to more precisely acquire the homogeneous transformation matrix P.

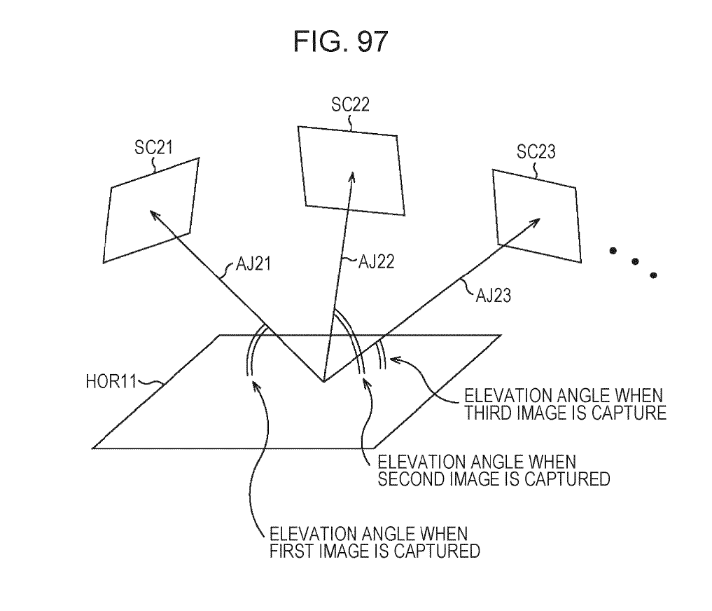

Here, the state where the imaging is performed while the imaging device is rotated with a constant tilt angle with respect to the horizontal line means that tilt angles, that is, elevation angles or depression angles when the first to the N-th captured images are captured with respect to a horizontal plane HOR11 are the same as shown in FIG. 97, for example.

In FIG. 97, the horizontal plane HOR11 is a plane which is substantially parallel with the ground, namely a plane configured of a point, a Yw coordinate of which is 0 (Yw=0), in the world coordinate system. In addition, a screen SC21 to a screen SC23 represents screens when the first to the third captured images are captured. Furthermore, a straight line AJ21 to a straight line AJ23 are lines which connects a predetermined position on the horizontal plane HOR11, for example, a position of a rotation center of the imaging device when the respective captured images are captured with the centers of the respective screens SC21 to SC23, respectively.

In the example of FIG. 97, only the first to the third captured images among the N captured images are shown for simplifying the description.

In this example, angles between the straight line AJ21 to the straight line AJ23 and the horizontal plane HOR11 are tilt angles which are elevation angles (looking-up angles) or depression angles (looking-down angles) when the first to the third captured images are captured. Therefore, if the respective elevation angles or the depression angles of the first to the N-th captured images are the same, the N captured images are images captured and acquired while the imaging device is rotated under the condition that the tilt angles of the imaging device with respect to the horizontal line, namely the horizontal plane HOR11 are constant.

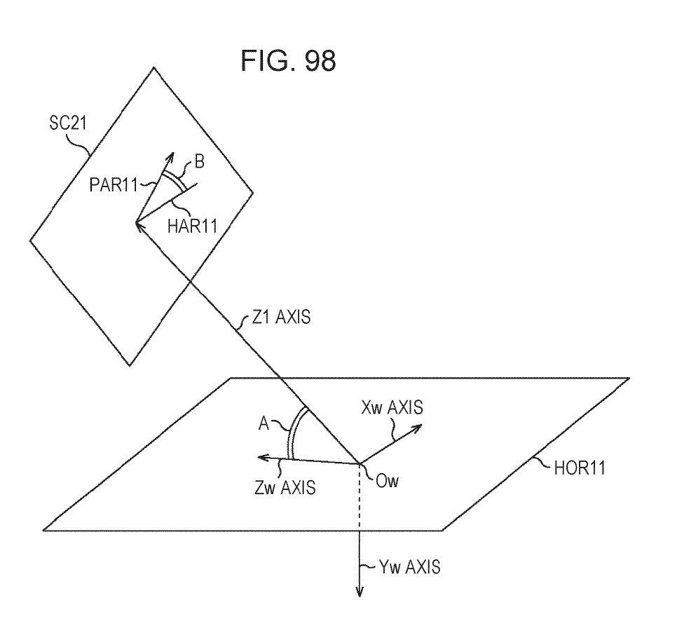

In addition, an elevation angle (or a depression angle) when the first captured image is captured with respect to the horizontal plane HOR11 which has a Yw coordinate of 0 (Yw=0) in the world coordinate system is represented as an angle A as shown in FIG. 98, for example. For example, A is a negative value when the angle A is an elevation angle, and A is a positive value when the angle A is a depression angle. In FIG. 98, the same reference numerals are given to parts corresponding to those in FIG. 97, and the description thereof will be appropriately omitted.

In FIG. 98, an angle between a straight line connecting the origin Ow of the world coordinate system on the horizontal plane HOR11 and the center of the screen SC21, namely the Z1 axis of the X1Y1Z1 coordinate system and the horizontal plane HOR11 is the angle A.

In addition, the lateral directions of the captured images are not always horizontal as described above, that is, the longitudinal direction of the screen SC21 and the horizontal plane HOR11 are not always parallel with each other.

Here, it is assumed that an angle between the lateral direction of the first captured image and the horizontal plane is B, and that the first captured image is captured so as to be inclined by the angle B with respect to the horizontal plane. That is, it is assumed that an angle between a straight line PAR11 which is parallel with the longitudinal direction of the screen SC21 and a straight line HAR11 which is parallel with the horizontal plane HOR11 on the screen SC21 is the angle B.

In such a case, the aforementioned homogeneous transformation matrix P is represented by the following Equation (161). This is because transformation by the homogeneous transformation matrix P is coordinate transformation for rotating a predetermined coordinate system upward by the angle A and further inclining the coordinate system by the angle B.

$$\begin{matrix}[ Math . 161 ] & \\ P = [ \begin{matrix}1 & 0 & 0 \\ 0 & cos ( A ) & sin ( A ) \\ 0 & - sin ( A ) & cos ( A )\end{matrix} ] [ \begin{matrix}cos ( B ) & sin ( B ) & 0 \\ - sin ( B ) & cos ( B ) & 0 \\ 0 & 0 & 1\end{matrix} ] & ( 161 )\end{matrix}$$

Incidentally, a 3×3 homogeneous transformation matrix PP₍ₛ₎ which represents an imaging direction, in which the s-th captured image is captured, in the world coordinate system, namely a product of the homogeneous transformation matrix P and the homogeneous transformation matrix P₍ₛ₎ is represented by the following Equation (162) by substituting Equation (161) into the homogeneous transformation matrix P.

$$\begin{matrix}[ Math . 162 ] & \\ {PP}_{( s )} = [ \begin{matrix}1 & 0 & 0 \\ 0 & cos ( A ) & sin ( A ) \\ 0 & - sin ( A ) & cos ( A )\end{matrix} ] [ \begin{matrix}cos ( B ) & sin ( B ) & 0 \\ - sin ( B ) & cos ( B ) & 0 \\ 0 & 0 & 1\end{matrix} ] {P}_{( s )} & ( 162 )\end{matrix}$$

Accordingly, a light beam flowing from a direction represented by the following Equation (163) toward the origin Ow of the world coordinate system is projected at the center position in the s-th captured image in the world coordinate system.

$$\begin{matrix}[ Math . 163 ] & \\ [ \begin{matrix}1 & 0 & 0 \\ 0 & cos ( A ) & sin ( A ) \\ 0 & - sin ( A ) & cos ( A )\end{matrix} ] [ \begin{matrix}cos ( B ) & sin ( B ) & 0 \\ - sin ( B ) & cos ( B ) & 0 \\ 0 & 0 & 1\end{matrix} ] {P}_{( s )} [ \begin{matrix}0 \\ 0 \\ F\end{matrix} ] & ( 163 )\end{matrix}$$

In addition, an angle between the direction represented by Equation (163) and the plane (that is, the horizontal plane) of Yw=0 in the world coordinate system is supposed to be the angle A.

In addition, it is almost impossible to continuously capture the images while maintaining a constant elevation angle (depression angle) in a strict sense. For this reason, there is substantially no case where the angle between the direction represented by Equation (163) and the plane of Yw=0 in the world coordinate system becomes the angle called the angle A without any error for all s (where s=1 to N).

Thus, the angle A is acquired by the least squares method. That is, the angle A and the angle B which minimize the dispersion of the following Equation (164) are acquired for s=1 to N.

$$\begin{matrix} [ Math . 164 ] & \\ \frac{\begin{matrix}[ \begin{matrix}0 & 1 & 0\end{matrix} ] [ \begin{matrix}1 & 0 & 0 \\ 0 & cos ( A ) & sin ( A ) \\ 0 & - sin ( A ) & cos ( A )\end{matrix} ] \\ [ \begin{matrix}cos ( B ) & sin ( B ) & 0 \\ - sin ( B ) & cos ( B ) & 0 \\ 0 & 0 & 1\end{matrix} ] {P}_{( s )} [ \begin{matrix}0 \\ 0 \\ F\end{matrix} ]\end{matrix}}{\vert [ \begin{matrix}1 & 0 & 0 \\ 0 & cos ( A ) & sin ( A ) \\ 0 & - sin ( A ) & cos ( A )\end{matrix} ] [ \begin{matrix}cos ( B ) & sin ( B ) & 0 \\ - sin ( B ) & cos ( B ) & 0 \\ 0 & 0 & 1\end{matrix} ] {P}_{( s )} [ \begin{matrix}0 \\ 0 \\ F\end{matrix} ] \vert} = \frac{\begin{matrix}[ \begin{matrix}0 & 1 & 0\end{matrix} ] [ \begin{matrix}1 & 0 & 0 \\ 0 & cos ( A ) & sin ( A ) \\ 0 & - sin ( A ) & cos ( A )\end{matrix} ] \\ [ \begin{matrix}cos ( B ) & sin ( B ) & 0 \\ - sin ( B ) & cos ( B ) & 0 \\ 0 & 0 & 1\end{matrix} ] {P}_{( s )} [ \begin{matrix}0 \\ 0 \\ F\end{matrix} ]\end{matrix}}{\vert {P}_{( s )} [ \begin{matrix}0 \\ 0 \\ F\end{matrix} ] \vert} & ( 164 )\end{matrix}$$

Here, meaning of Equation (164) will be described. Equation (164) represents an inner product between the direction from the origin Ow of the world coordinate system toward the center position (image center) of the s-th captured image and the vector (0, 1, 0). That is, Equation (164) represents an inner product between the direction from the origin Ow toward the center position of the s-th captured image and the vertical direction, and if the value is substantially constant (that is, dispersion is the minimum) regardless of s, then the elevation angles (depression angles) when the captured images are captured are substantially constant regardless of s.

In addition, if the angle A and the angle B which minimize the dispersion of Equation (164) where s=1 to N are acquired, it is possible to acquire the homogeneous transformation matrix P by substituting the acquired angle A and the angle B into Equation (161). In addition, as the angle A and the angle B which minimize the dispersion of Equation (164) where s=1 to N, it is only necessary to perform actual calculation for all the combinations of the angle A and the angle B and acquire a combination of the angles which minimize the dispersion among all the combinations.

### [Configuration Example of Image Processing Apparatus]

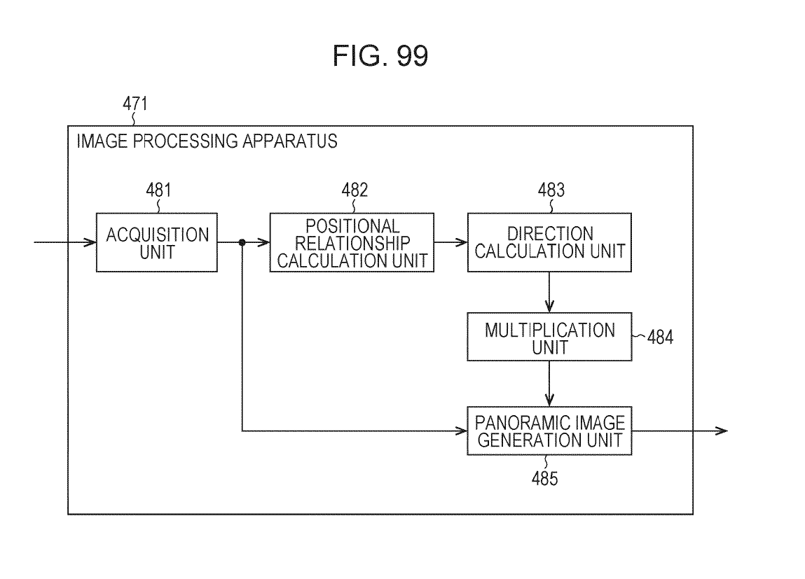

Nest, description will be given of a specific embodiment to which the present technology is applied. FIG. 99 is a diagram showing a configuration example of an embodiment of an image processing apparatus to which the present technology is applied.

An image processing apparatus 471 in FIG. 99 is configured of an acquisition unit 481, a positional relationship calculation unit 482, a direction calculation unit 483, a multiplication unit 484, and a panoramic image generation unit 485.

The acquisition unit 481 acquires N captured images which an imaging device such as a digital camera successively captures while being rotated, and supplies the captured images to the positional relationship calculation unit 482 and the panoramic image generation unit 485.

The positional relationship calculation unit 482 calculates the homogeneous transformation matrix P₍ₛ₎ which represents the positional relationships between the captured images based on the captured images supplied from the acquisition unit 481, and supplies the homogeneous transformation matrix P₍ₛ₎ to the direction calculation unit 483. The direction calculation unit 483 calculates the homogeneous transformation matrix P which represents the imaging direction of the first captured image in the world coordinate system based on the homogeneous transformation matrix P₍ₛ₎ supplied from the positional relationship calculation unit 482, and supplies the homogeneous transformation matrix P₍ₛ₎ and the homogeneous transformation matrix P to the multiplication unit 484.

The multiplication unit 484 calculates the imaging directions of the respective captured images in the world coordinate system by multiplying the homogeneous transformation matrix P₍ₛ₎ by the homogeneous transformation matrix P, which are supplied from the direction calculation unit 483, and supplies the imaging directions to the panoramic image generation unit 485.

The panoramic image generation unit 485 generates a panoramic image based on the captured images supplied from the acquisition unit 481 and the imaging directions of the respective captured images supplied from the multiplication unit 484, and outputs the panoramic image.

### [Description of Panoramic Image Generation Processing]

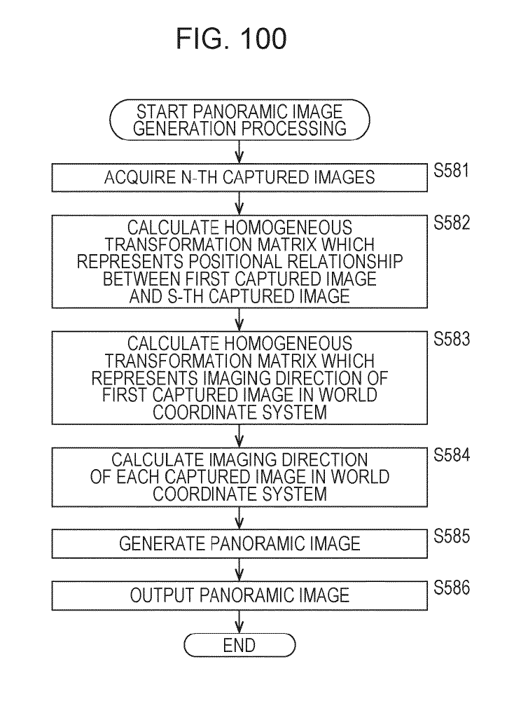

Next, description will be given of panoramic image generation processing performed by the image processing apparatus 471 with reference to the flowchart in FIG. 100.

In Step S581, the acquisition unit 481 acquires N captured images from an external portable medium or the like and supplies the captured images to the positional relationship calculation unit 482 and the panoramic image generation unit 485. Here, the acquired N captured images are images which an imaging device such as a digital camera successively captures while being rotated.

In Step S582, the positional relationship calculation unit 482 performs the matching processing based on the respective captured images supplied from the acquisition unit 481, calculates a homogeneous transformation matrix P₍ₛ₎ (where s=1 to N) which represents the positional relationship between the first captured image and the s-th captured image, and supplies the homogeneous transformation matrix P₍ₛ₎ to the direction calculation unit 483.

In Step S583, the direction calculation unit 483 calculates the homogeneous transformation matrix P which represents the imaging direction of the first captured image in the world coordinate system based on the homogeneous transformation matrix P₍ₛ₎ of each s (where s=1 to N), which is supplied from the positional relationship calculation unit 482.

Specifically, the direction calculation unit 483 calculates the homogeneous transformation matrix P by acquiring the angle A and the angle B which minimize the aforementioned dispersion of Equation (164) for each s and substituting the acquired angle A and the angle B into Equation (161). The direction calculation unit 483 supplies the calculated homogeneous transformation matrix P and the homogeneous transformation matrix P₍ₛ₎ to the multiplication unit 484.

In Step S584, the multiplication unit 484 calculates the imaging directions of the respective captured images in the world coordinate system by multiplying the homogeneous transformation matrix P₍ₛ₎ by the homogeneous transformation matrix P supplied from the direction calculation unit 483 for each s (where s=1 to N). That is, the aforementioned calculation of Equation (162) is performed, and the imaging direction of the s-th captured image in the world coordinate system is acquired. The multiplication unit 484 supplies the calculated imaging directions of the respective captured images in the world coordinate system to the panoramic image generation unit 485.

In Step S585, the panoramic image generation unit 485 generates a panoramic image based on the captured images supplied from the acquisition unit 481 and the imaging directions of the respective captured images supplied from the multiplication unit 484.

Specifically, the panoramic image generation unit 485 prepares a spherical canvas region which includes the origin Ow of the world coordinate system as the center. Then, the panoramic image generation unit 485 maps the pixel values of the pixels in the s-th captured image as light beams flowing from the imaging direction of the s-th captured image in the world coordinate system on the canvas region for each s (where s=1 to N). That is, pixel values of the pixels in the captured image are written at positions of intersections between straight lines which pass the pixels in the s-th captured image and is in directions determined from the imaging direction of the s-th captured image and the canvas region.

With such processing, the pixel values of the pixels in the respective captured images are written in the canvas region, and the panoramic image is acquired. That is, the image on the canvas region is regarded as a panoramic image.

In Step S586, the panoramic image generation unit 485 outputs the generated panoramic image, and the panoramic image generation processing is completed. The panoramic image output from the panoramic image generation unit 485 is stored on a storage unit such as a hard disk or supplied to and displayed by a display unit, for example.

As described above, the image processing apparatus 471 acquires the angle A, which is the tilt angle when the first captured image is captured, from the homogeneous transformation matrix P₍ₛ₎ representing the positional relationships between the respective captured images and calculates the imaging direction of the first captured image in the world coordinate system. Then, the image processing apparatus 471 acquires the imaging directions of the respective captured images by using the acquired imaging direction of the first captured image and generates the panoramic image.

It is possible to acquire a panoramic image with high quality, the lateral direction of which coincides with the horizontal line, and which has a satisfactory appearance, by acquiring the tilt angles when the captured images are captured from the homogeneous transformation matrixes representing the positional relationships between the captured images as described above.

In addition, the present technology described in the eleventh embodiment can be configured as follows.

[1] An image processing method for generating a panoramic image based on a plurality of captured images which an imaging device successively captures while being turned, the method comprising:

an acquisition step in which the plurality of captured images and imaging directions, in which the respective captured images are captured, in a coordinate system with reference to an imaging direction in which the first captured image is captured are acquired;

a direction calculation step in which the imaging direction, in which the first captured image is captured, in a world coordinate system is calculated;

a rendering step in which pixel values of pixels in the respective captured images are written in a memory for a panoramic image based on the imaging direction, in which the first captured image is captured, in the world coordinate system and the imaging directions, in which the respective captured images are captured, in the coordinate system with reference to the imaging direction in which the first captured image is captured; and

an output step in which the image data on the memory, which is rendered in the rendering step, is output as the panoramic image,

wherein in the direction calculation step, the imaging direction, in which the first captured image is captured, in the world coordinate system under a condition that tilt angles of the imaging directions, in which the respective captured images are captured, with respect to a horizontal line are constant.

[Horizontal and Vertical Conditions are added to 360° Turning Optimization]

### Twelfth Embodiment

In addition, when the positional relationships between the captured images are acquired for generating the panoramic image, the positional relationships may be acquired by adding a condition relating to the horizontal direction and the vertical direction.

For example, it is possible to create a panoramic image from a plurality of captured images which a digital camera successively captures while being rotated. That is, the captured images captured in an order while the digital camera is rotated are assumed to be the first captured image, the second captured image, . . . , and the N-th captured image in an imaging order.

The panoramic image can be acquired by analyzing the thus acquired a total of N captured images to acquire the positional relationships of the respective captured images when the captured images are captured, further preparing a canvas on a sphere, and rendering pixels on the captured images in the imaging directions of the respective captured images.

A processing method for generating a panoramic image is described in “M. Brown and D. Lowe. Automatic Panoramic Image Stitching using Invariant Features. International Journal of Computer Vision, 74(1), pages 59-73, 2007”, for example.

Specifically, corresponding pixel positions are specified between arbitrary two (the s-th and the t-th captured images) captured images among the N captured images first. That is, a plurality of pixel positions (hereinafter, referred to as feature points) at edge parts or with clear texture in the s-th captured image are acquired.

Then, positions with the same features as those of the plurality of respective features on the s-th captured image, namely positions with the same edges or the same textures are searched for in the t-th captured image, and the positions of the matched feature points, which are acquired as a result of the searching, are recorded.

As described above, a plurality of relationships of the corresponding pixel positions are acquired between the s-th captured image and the t-th captured image. By performing such correspondence relationships on all the combinations of s and t, correspondence relationships of pixel positions are acquired for all the combinations of the captured images. From such correspondences, it is possible to acquire relative positional relationships between the images when the respective captured images are captured.

Next, imaging directions of the respective captured images with respect to an absolute coordinate system are acquired from the acquired relative positional relationships between the captured images such that the X axis when the respective captured images are captured, namely the horizontal direction viewed from a user when the respective captured images are captured become mutually horizontal. In addition, the positional relationships between the captured images are expressed as “relative rotations” in Chapter 5 in the above article, and the absolute coordinate system is expressed as a “world coordinate” in Chapter 5 in the above article.

In addition, the panoramic image is generated by mapping pixels in the respective captured images on the canvas of the sphere on the assumption that the respective captured images are acquired by imaging in the aforementioned imaging directions.

Incidentally, it is possible to precisely acquire the relative positional relationships between the respective captured images if no errors are incorporated in the aforementioned processing process. In addition, it is possible to acquire an absolute coordinate system, in which the X axis when the respective captured images are captured is completely horizontal, from the precise relative positional relationships between the respective captured images.

However, it is not possible to precisely acquire the relative positional relationships between the respective captured images since there are errors in practice.

Furthermore, the processing of acquiring the relative positional relationships between the captured images and the processing of acquiring the imaging directions of the respective captured images in the absolute coordinate system are independent processing in the aforementioned technology.

In the processing of acquiring the relative positional relationships between the captured images, it is not possible to precisely acquire the relative positional relationships between the captured images since errors are included in the relationships of the corresponding pixel positions, which are acquired by the matching of the feature points.

In addition, since it is not possible to precisely acquire the relative positional relationships between the captured images, it is not possible to acquire the absolute coordinate system, in which the X axis during the imaging becomes completely horizontal, for all the captured images in the processing of acquiring the imaging directions of the respective captured images in the absolute coordinate system.

Accordingly, the absolute coordinate system is acquired by the least squares method in practice in the aforementioned technology. That is, an absolute coordinate system, in which the X axis when the respective captured images are captured becomes substantially horizontal to the maximum extent, is acquired.

For this reason, although the panoramic image is an image in which the horizontal direction is correctly expressed when all the captured images are viewed as a whole, it is not possible to state that horizontal directions are not correct if the individual captured images are considered.

That is, whether or not a coordinate system in which the X axes of all the captured images are horizontal is present is not taken into consideration at all in the processing of acquiring the relative positional relationships between the captured images. For this reason, although it is possible to acquire a coordinate system, in which the X axes are substantially horizontal to the maximum extent, in the processing of acquiring the imaging directions of the respective captured images in the absolute coordinate system, the X axes are not necessarily horizontal. That is, although the X axes are averagely horizontal since the coordinate system for horizontal X axes are acquired by the least squares method, the coordinate system is not a coordinate system in which the X axes of the individual captured images are horizontal.

Accordingly, there are many cases where panoramic images are configured of inclined images when each part is viewed although the horizontal direction is correctly expressed in the entire panoramic image as a final result. According to the aforementioned technology, the panoramic image as the final result becomes an inclined image when each part is viewed as described above, and it is not possible to acquire a panoramic image with high quality.

The present technology was made in view of such circumstances, and is designed to enable acquisition of a panoramic image with higher quality.

### [Overview of Present Technology]

First, description will be given of overview of the present technology.

Although the processing of acquiring the relative positional relationships between the captured images and the processing of acquiring the imaging directions of the respective captured images in the absolute coordinate system are independent in the aforementioned related art, these two kinds of processing are implemented by calculation at the same time by optimization performed once in the present technology.

That is, calculation for acquiring a coordinate system which substantially satisfies the relationships of the corresponding pixel positions, which are acquired by the matching of the feature points between the captured images, to the maximum extent and allows the X axes when the respective captured images are captured to be substantially horizontal to the maximum extent is performed. Here, the reason that the relationships of the corresponding pixel positions are substantially satisfied to the maximum extent is because there are errors, and the condition is implemented by the least squares method in order to minimize the errors.

That is, it is assumed that the directions when the respective captured images are captured are unknown numbers (orthogonal matrixes Hₛ as will be described later). In addition, correspondence relationships of the positions of the feature points in the captured images are expressed by the orthogonal matrixes Hₛ as the unknown numbers, and errors from relationships of corresponding pixel positions, which are acquired by image analysis in practice, are assumed to be δ1.

Furthermore, directions of the X axes when the respective captured images are captured are expressed by the orthogonal matrixes Hₛ as the unknown numbers, and a difference from the horizontal direction is assumed to be δ2. Then, optimization is performed by acquiring orthogonal matrixes Hₛ when the total value of δ1 and δ2 is minimized.

If the description is given again, two kinds of processing of acquiring the relative positional relationship between the captured images, which minimize δ1, by the optimization calculation and then acquiring the positions in the respective captured images on the absolute coordinate system, which minimize δ2, by the optimization calculation are performed in the related art. In contrast, positions in the respective captured images on the absolute coordinate system, which minimize the total value of δ1 and δ2, are acquired by the optimization calculation performed once in the present technology. Specifically, δ1 is the first item in Equation (174) which will be described later, and δ2 is the second item in Equation (174).

### [Configuration Example of Image Processing Apparatus]

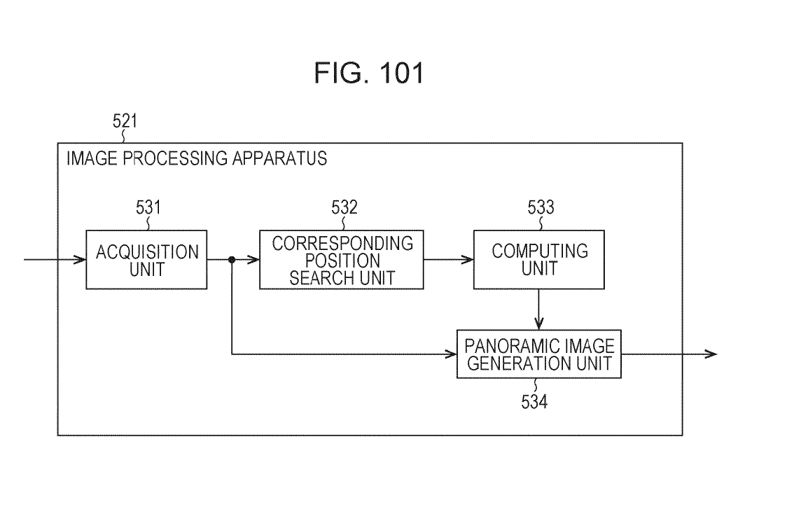

Next, description will be given of a specific embodiment to which the present technology is applied. FIG. 101 is a diagram showing a configuration example of an embodiment of an image processing apparatus to which the present technology is applied.

An image processing apparatus 521 in FIG. 101 is configured of an acquisition unit 531, a corresponding position search unit 532, a computing unit 533, and a panoramic image generation unit 534.

The acquisition unit 531 acquires a plurality of captured images which an imaging device such as a camera successively captures while being rotated, and supplies the captured images to the corresponding position search unit 532 and the panoramic image generation unit 534.

The corresponding position search unit 532 searches for positions of corresponding feature points between the captured images from the respective captured images supplied from the acquisition unit 531 and supplies the search result to the computing unit 533. The computing unit 533 acquires the imaging directions, in which the respective captured images are captured, based on the search result supplied from the corresponding position search unit 532 and supplies the imaging directions to the panoramic image generation unit 534.

The panoramic image generation unit 534 generates a panoramic image based on the captured images from the acquisition unit 531 and the imaging directions from the computing unit 533, and outputs the panoramic image.

### [Description of Panoramic Image Generation Processing]

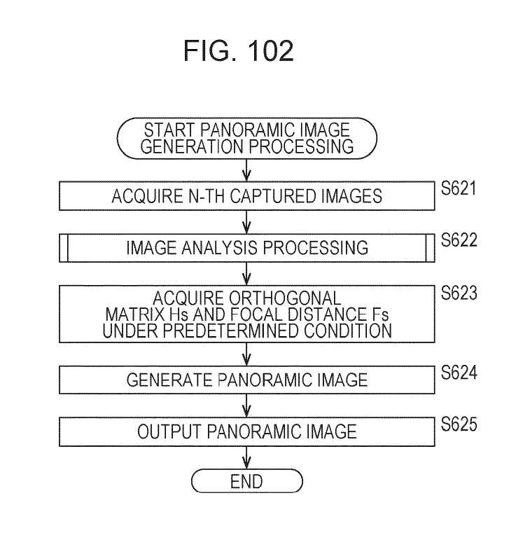

Next, description will be given of panoramic image generation processing performed by the image processing apparatus 521 with reference to the flowchart in FIG. 102.

In Step S621, the acquisition unit 531 acquires N captured images from an external portable medium or the like and supplies the captured images to the corresponding position search unit 532 and the panoramic image generation unit 534. Here, the acquired N captured images are images which an imaging device such as a camera successively captures while being rotated.

In Step S622, the corresponding position search unit 532 performs image analysis processing and acquires correspondence relationships of feature points between the captured images from the respective captured images supplied from the acquisition unit 531.

Although a detail of the image analysis processing will be described later, the correspondence relationships represented by the following Equation (165) are acquired in the image analysis processing, and the correspondence relationships are supplied to the computing unit 533.

$$\begin{matrix}[ Math . 165 ] & \\ [ \begin{matrix}X ( s , t , i ) \\ Y ( s , t , i )\end{matrix} ] {\vert}_{@ Image ( s )} ⇔ [ \begin{matrix}X ( t , s , i ) \\ Y ( t , s , i )\end{matrix} ] {\vert}_{@ Image ( t )} , \\ where \\ s = 1 to ( N - 1 ) , t = ( s + 1 ) to N , \\ i = 1 to {i}_{max} ( s , t ) & ( 165 )\end{matrix}$$

In Equation (165), X(s, t, i) and Y(s, t, i) represent an X coordinate value and a Y coordinate value in a coordinate system with reference to the s-th captured image, and a position (X(s,t,i), Y(s,t,i)) represents a position on the s-th captured image (two-dimensional image).

Similarly, X(t, s, i) and Y(t, s, i) represent an X coordinate value and a Y coordinate value in a coordinate system with reference to the t-th captured image, and a position (X(t,s,i), Y(t,s,i)) represents a position on the t-th captured image (two-dimensional image).

In addition, the index “i” in Equation (165) is used for the numbering in order to discriminate the feature points (projected images of objects with features) on the captured image. Here, the number of objects with features, namely the number of feature points projected to both the s-th captured image and the t-th captured image is assumed to be iₘₐₓ (s, t), and the respective feature points are identified by i=1 to iₘₐₓ (s, t).

Furthermore, the symbol “ [symbol] ” in Equation (165) means that objects with the same feature are projected. That is, it is possible to state the following fact for arbitrary s, t, and i.

An object projected to a position (X(s,t,i), Y(s,t,i)) on the s-th captured image is also projected to a position (X(t,s,i), Y(t,s,i)) on the t-th captured image. However, an error is also included to the correspondence relationships acquired by the image analysis processing.

Incidentally, it is assumed that a direction in which an image is captured to acquire the s-th captured image on an absolute coordinate system (hereinafter, referred to as a world coordinate system) including an Xw axis, a Yw axis, and a Zw axis, which are mutually orthogonal, as axes is expressed by a 3×3 orthogonal matrix Hₛ (where 1≦s≦N).

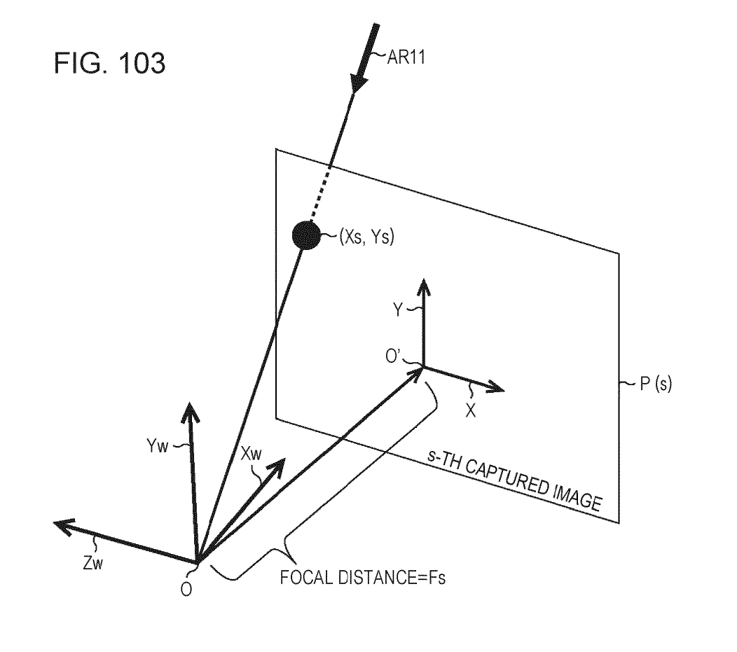

An XY coordinate system which has an origin O′ at the center position of the captured image P(s) and includes an X axis and a Y axis, which are mutually orthogonal, as axes is considered as a coordinate system with reference to the s-th captured image P(s) as shown in FIG. 103, for example, and an arbitrary position on the captured image P(s) in the coordinate system is assumed to be (Xₛ, Yₛ). In addition, a coordinate system which includes an origin O and includes an Xw axis, a Yw axis and a Zw axis as axes is assumed to be the world coordinate system.

At this time, the object projected to the position (Xₛ. Yₛ) on the captured image P(s) is present in the direction represented by the arrow AR11 in the three-dimensional world coordinate system. Here, the direction represented by the arrow AR11 is a direction of a straight line connecting the origin O of the world coordinate system and the position (Xₛ, Yₛ).

The direction represented by the arrow AR11 is represented by the following Equation (166).

$$\begin{matrix}[ Math . 166 ] & \\ {H}_{s} [ \begin{matrix}{X}_{s} \\ {Y}_{s} \\ {F}_{s}\end{matrix} ] = [ \begin{matrix}{H}_{s ( 1 , 1 )} & {H}_{s ( 1 , 2 )} & {H}_{s ( 1 , 3 )} \\ {H}_{s ( 2 , 1 )} & {H}_{s ( 2 , 2 )} & {H}_{s ( 2 , 3 )} \\ {H}_{s ( 3 , 1 )} & {H}_{s ( 3 , 2 )} & {H}_{s ( 3 , 3 )}\end{matrix} ] [ \begin{matrix}{X}_{s} \\ {Y}_{s} \\ {F}_{s}\end{matrix} ] & ( 166 )\end{matrix}$$

In Equation (166), Fₛ represents a focal distance of the imaging device when the s-th captured image P(s) is captured. That is, the focal distance Fₛ is a distance from the origin O of the world coordinate system to the origin O′ of the XY coordinate system. In Equation (166), the indexes (1, 1) to (3, 3) added to the respective elements in the orthogonal matrix Hₛ represent elements on the first row and the first column to the third row and the third column.

Accordingly, it is possible to state that the orthogonal matrix Hs represents the imaging direction of the captured image P(s) in the world coordinate system, that is, the positional relationship of the captured image P(s) in the world coordinate system.

Here, since the object projected to the position (X(s,t,i), Y(s,t,i)) on the s-th captured image is also projected to the position (X(t,s,i), Y(t,s,i)) on the t-th captured image, the following Equation (167) is established for arbitrary s, t, and i if the direction of the object in the world coordinate system is considered.

$$\begin{matrix}[ Math . 167 ] & \\ {H}_{s} [ \begin{matrix}X ( s , t , i ) \\ Y ( s , t , i ) \\ {F}_{s}\end{matrix} ] ∝ {H}_{t} [ \begin{matrix}X ( t , s , i ) \\ Y ( t , s , i ) \\ {F}_{t}\end{matrix} ] & ( 167 )\end{matrix}$$

If Equation (167) is deformed, the following Equation (168) and Equation (169) are acquired. Since errors are included in Equation (168) and Equation (169), the equal sign is not established in a strict sense.

$$\begin{matrix} [ Math . 168 ] & \\ \frac{{H}_{s ( 1 , 1 )} X ( s , t , i ) + {H}_{s ( 1 , 2 )} Y ( s , t , i ) + {H}_{s ( 1 , 3 )} {F}_{s}}{{H}_{s ( 3 , 1 )} X ( s , t , i ) + {H}_{s ( 3 , 2 )} Y ( s , t , i ) + {H}_{s ( 3 , 3 )} {F}_{s}} = \frac{{H}_{t ( 1 , 1 )} X ( t , s , i ) + {H}_{t ( 1 , 2 )} Y ( t , s , i ) + {H}_{t ( 1 , 3 )} {F}_{t}}{{H}_{t ( 3 , 1 )} X ( t , s , i ) + {H}_{t ( 3 , 2 )} Y ( t , s , i ) + {H}_{t ( 3 , 3 )} {F}_{t}} & ( 168 ) \\ [ Math . 169 ] & \\ \frac{{H}_{s ( 2 , 1 )} X ( s , t , i ) + {H}_{s ( 2 , 2 )} Y ( s , t , i ) + {H}_{s ( 2 , 3 )} {F}_{s}}{{H}_{s ( 3 , 1 )} X ( s , t , i ) + {H}_{s ( 3 , 2 )} Y ( s , t , i ) + {H}_{s ( 3 , 3 )} {F}_{s}} = \frac{{H}_{t ( 2 , 1 )} X ( t , s , i ) + {H}_{t ( 2 , 2 )} Y ( t , s , i ) + {H}_{t ( 2 , 3 )} {F}_{t}}{{H}_{t ( 3 , 1 )} X ( t , s , i ) + {H}_{t ( 3 , 2 )} Y ( t , s , i ) + {H}_{t ( 3 , 3 )} {F}_{t}} & ( 169 )\end{matrix}$$

Incidentally, a person who captures the captured images performs imaging while maintaining the imaging device to be horizontal. That is, if the person performs the imaging while looking up or looking down, the X-axis directions of the coordinate systems with reference to the respective captured images are horizontal.

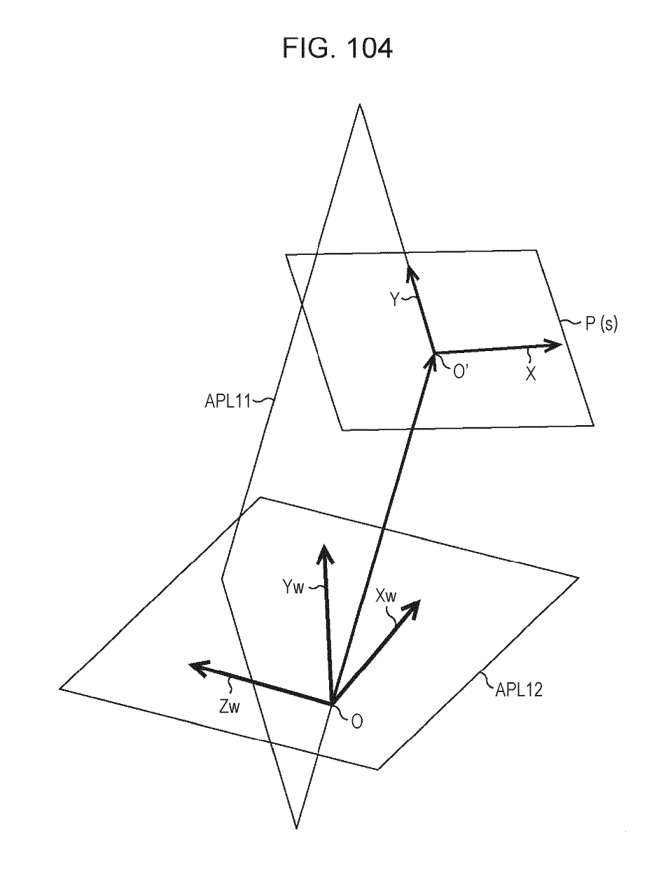

In addition, planes including the imaging direction in which the respective captured images are captured and the Y axes of the XY coordinate systems with reference to the respective captured images include a vertical direction as shown in FIG. 104. In FIG. 104, the same reference numerals are given to parts corresponding to those in FIG. 103, and the description thereof will be appropriately omitted.

In FIG. 104, the s-th captured image P(s) is shown, and in this example, the imaging direction of the captured image P(s) is a direction from the origin O of the world coordinate system toward the origin O′ of the XY coordinate system with reference to the s-th captured image P(s).

In addition, the vertical direction described herein is a vertical direction viewed from the person who captures the captured images, and the horizontal direction is a direction, which is orthogonal to the vertical direction, and in which the imaging device is rotated.

In the example of FIG. 104, the plane APL11 including the imaging direction of the captured image P(s) and the Y axis of the XY coordinate system with reference to the captured image P(s) includes the vertical direction, namely the Yw axis of the world coordinate system.

In addition, since the X-axis directions of the respective captured images including the captured image P(s) are horizontal during the imaging, the X-axis directions of the respective captured images are orthogonal to the Yw axis of the world coordinate system. That is, the plane APL12 which includes the Xw axis and the Zw axis of the world coordinate system is parallel with the X axis of the XY coordinate system.

Accordingly, the following Equation (170) is established for arbitrary s. In other words, the fact that Equation (170) is satisfied means that the X axis is orthogonal to the Yw axis, and therefore, it is possible to state that the world coordinate system, which is determined so as to satisfy Equation (170), is a coordinate system with a correct horizontal direction.

$$\begin{matrix}[ Math . 170 ] & \\ [ \begin{matrix}0 & 1 & 0\end{matrix} ] {H}_{s} [ \begin{matrix}1 \\ 0 \\ 0\end{matrix} ] = {H}_{s ( 2 , 1 )} = 0 & ( 170 )\end{matrix}$$

Equation (170) represents that a value of a product between a three-dimensional lateral vector (0, 1, 0) and a three-dimensional longitudinal vector configured of the first column of the orthogonal matrix Hₛ is zero.

Since the planes including the imaging directions of the respective captured images and the Y axes of the XY coordinate systems with reference to the respective captured images include the vertical direction, planes including the imaging directions of the captured images and the Y axes of the XY coordinate systems include the Yw axis of the world coordinate system. Accordingly, the following Equation (171) is established for arbitrary s. In other words, if the world coordinate system is determined so as to satisfy Equation (171), it is possible to state that the world coordinate system is a coordinate system with a correct vertical direction.

$$\begin{matrix}[ Math . 171 ] & \\ [ \begin{matrix}0 & 1 & 0\end{matrix} ] [ \begin{matrix}{tmpX}_{s} \\ {tmpY}_{s} \\ {tmpZ}_{s}\end{matrix} ] = {tmpY}_{s} = 0 & ( 171 )\end{matrix}$$

In Equation (171), tmpXₛ, tmpYₛ and tempZₛ are values which satisfy the following Equation (172).

$$\begin{matrix}[ Math . 172 ] & \\ [ \begin{matrix}{tmpX}_{s} & {tmpY}_{s} & {tmpZ}_{s}\end{matrix} ] {H}_{s} [ \begin{matrix}0 \\ 1 \\ 0\end{matrix} ] = 0 , \\ [ \begin{matrix}{tmpX}_{s} & {tmpY}_{s} & {tmpZ}_{s}\end{matrix} ] {H}_{s} [ \begin{matrix}0 \\ 0 \\ 1\end{matrix} ] = 0 , \\ ‖ [ \begin{matrix}{tmpX}_{s} \\ {tmpY}_{s} \\ {tmpZ}_{s}\end{matrix} ] ‖ = 1 & ( 172 )\end{matrix}$$

A vector (tmpXₛ, tmpYₛ, tmpZₛ) on the world coordinate system configured of tmpXₛ, tmpYₛ, and tmpZₛ is a vector orthogonal to the imaging direction of the captured image P(s) and the Y axis of the XY coordinate system with reference to the captured image P(s), namely a vector orthogonal to the plane APL11. Accordingly, Equation (171) represents that the vector (tmpXₛ, tmpYₛ, tmpZₛ) is orthogonal to the Yw axis. In other words, Equation (171) represents that the Yw axis of the world coordinate system is included in the plane APL11.

Furthermore, the following Equation (173) is derived from Equation (171) and Equation (172).

$$\begin{matrix}[ Math . 173 ] & \\ \begin{matrix}[ \begin{matrix}0 & 1 & 0\end{matrix} ] [ \begin{matrix}{tmpX}_{s} \\ {tmpY}_{s} \\ {tmpZ}_{s}\end{matrix} ] = {tmpY}_{s} \\ = \sqrt{\frac{{( {H}_{s ( 1 , 2 )} {H}_{s ( 3 , 3 )} - {H}_{s ( 1 , 3 )} {H}_{s ( 3 , 2 )} )}^{2}}{\begin{matrix}{( {H}_{s ( 1 , 2 )} {H}_{s ( 3 , 3 )} - {H}_{s ( 1 , 3 )} {H}_{s ( 3 , 2 )} )}^{2} + \\ {( {H}_{s ( 1 , 2 )} {H}_{( 2 , 3 )} - {H}_{s ( 1 , 3 )} {H}_{s ( 2 , 2 )} )}^{2} + \\ {( {H}_{s ( 2 , 2 )} {H}_{s ( 3 , 3 )} - {H}_{s ( 2 , 3 )} {H}_{s ( 3 , 2 )} )}^{2}\end{matrix}}} \\ = 0\end{matrix} & ( 173 )\end{matrix}$$

If the above descriptions are summarized, it is possible to state the following facts.

That is, it is assumed that the respective captured images are images acquired by the imaging in directions represented by the orthogonal matrix Hₛ (where 1≦s≦N) on the world coordinate system which is an absolute coordinate system. In such a case, mapping of pixel values of pixels in the respective captured images on the canvas on the sphere in order to generate a panoramic image will be considered.

If the orthogonal matrix Hs is a matrix which satisfies the aforementioned Equation (168) and Equation (169) at this time, it is possible to perform the mapping on the omnidirectional sphere without causing any failure at connected parts of the respective captured images.

In addition, if Equation (170) is satisfied for all s, the lateral axis direction of the panoramic image generated by the mapping on the omnidirectional sphere coincides with the horizontal direction, and it is possible to acquire an image which is not inclined with respect to the horizontal direction. Moreover, if Equation (173) is satisfied for all s, the longitudinal axis direction of the panoramic image generated by the mapping on the omnidirectional sphere coincides with the vertical direction, and it is possible to acquire an image which is not inclined with respect to the vertical direction.

Since errors are incorporated in the actual captured images, the orthogonal matrix Hₛ which completely satisfies the aforementioned Equation (168), Equation (169), Equation (170), and Equation (173) is not necessarily present.

Returning to the description of the flowchart in FIG. 102, if the image analysis processing is performed in Step S622 and the correspondence relationships of the feature points between the captured images are acquired, the processing moves on to Step S623.

In Step S623, the computing unit 533 acquires the orthogonal matrix Hₛ and the focal length Fₛ (where s=1 to N) which substantially satisfy Equation (168), Equation (169), and Equation (170) to the maximum extent based on the correspondence relationships between the captured images represented by Equation (165), which are supplied from the corresponding position search unit 532.

That is, the orthogonal matrix Hₛ and the focal distance Fₛ which minimize the errors are acquired by the least squares method. Specifically, the 3×3 orthogonal matrix Hₛ and the focal distance Fₛ which minimize the following Equation (174) are acquired.

$$\begin{matrix} [ Math . 174 ] & \\ {\sum }_{{s = 1 ∼ N}_{{t = ( s + 1 ) ∼ N}_{i = 1 ∼ {i}_{max} ( s . t )}}} \{ \begin{matrix}{( \begin{matrix}\frac{{H}_{s ( 1 , 1 )} X ( s , t , i ) + {H}_{s ( 1 , 2 )} Y ( s , t , i ) + {H}_{s ( 1 , 3 )} {F}_{s}}{{H}_{s ( 3 , 1 )} X ( s , t , i ) + {H}_{s ( 3 , 2 )} Y ( s , t , i ) + {H}_{s ( 3 , 3 )} {F}_{s}} - \\ \frac{{H}_{t ( 1 , 1 )} X ( t , s , i ) + {H}_{t ( 1 , 2 )} Y ( t , s , i ) + {H}_{t ( 1 , 3 )} {F}_{t}}{{H}_{t ( 3 , 1 )} X ( t , s , i ) + {H}_{t ( 3 , 2 )} Y ( t , s , i ) + {H}_{t ( 3 , 3 )} {F}_{t}} \end{matrix} )}^{2} + \\ {( \begin{matrix}\frac{{H}_{s ( 2 , 1 )} X ( s , t , i ) + {H}_{s ( 2 , 2 )} Y ( s , t , i ) + {H}_{s ( 2 , 3 )} {F}_{s}}{{H}_{s ( 3 , 1 )} X ( s , t , i ) + {H}_{s ( 3 , 2 )} Y ( s , t , i ) + {H}_{s ( 3 , 3 )} {F}_{s}} - \\ \frac{{H}_{t ( 2 , 1 )} X ( t , s , i ) + {H}_{t ( 2 , 2 )} Y ( t , s , i ) + {H}_{t ( 2 , 3 )} {F}_{t}}{{H}_{t ( 3 , 1 )} X ( t , s , i ) + {H}_{t ( 3 , 2 )} Y ( t , s , i ) + {H}_{t ( 3 , 3 )} {F}_{t}}\end{matrix} )}^{2}\end{matrix} \} + ω {\sum }_{s = 1 ∼ N} {( {H}_{s ( 2 , 1 )} )}^{2} & ( 174 )\end{matrix}$$

Here, the first item in Equation (174) is a total sum of a sum of squared difference between the left side and the right side of Equation (168) for each of s, t, and i and a sum of squared difference between the left side and the right side of Equation (169), and the second item in Equation (174) is a square sum of the element H_{s(2,1)} of the orthogonal matrix Hₛ represented by Equation (170) for each s. In addition, ω represents a weight in Equation (174), and the weight ω is a predetermined appropriate scalar value.

Accordingly, if the value of the weight ω is reduced, for example, a solution which places more emphasis on the relationships between Equation (168) and Equation (169) is acquired. That is, it is possible to acquire a panoramic image which includes no failures at the connected parts of the respective captured images even if the horizontal direction is slightly inclined. In contrast, if the value of the weight ω is set to be larger, a solution which places more emphasis on the relationship of Equation (170) is acquired, and it is possible to acquire a panoramic image which is not inclined with respect to the horizontal direction even if failures slightly occur at the connected parts of the respective captured images.

In addition, since the orthogonal matrix Hₛ is an orthogonal matrix, Equation (174) is solved under restriction that the following Equation (175) is satisfied for all s (where s=1 to N).

$$\begin{matrix}[ Math . 175 ] & \\ \begin{matrix}{H}_{s}^{T} {H}_{s} = [ \begin{matrix}{H}_{s ( 1 , 1 )} & {H}_{s ( 2 , 1 )} & {H}_{s ( 3 , 1 )} \\ {H}_{s ( 1 , 2 )} & {H}_{s ( 2 , 2 )} & {H}_{s ( 3 , 2 )} \\ {H}_{s ( 1 , 3 )} & {H}_{s ( 2 , 3 )} & {H}_{s ( 3 , 3 )}\end{matrix} ] [ \begin{matrix}{H}_{s ( 1 , 1 )} & {H}_{s ( 1 , 2 )} & {H}_{s ( 1 , 3 )} \\ {H}_{s ( 2 , 1 )} & {H}_{s ( 2 , 2 )} & {H}_{s ( 2 , 3 )} \\ {H}_{s ( 3 , 1 )} & {H}_{s ( 3 , 2 )} & {H}_{s ( 3 , 3 )}\end{matrix} ] \\ = [ \begin{matrix}1 & 0 & 0 \\ 0 & 1 & 0 \\ 0 & 0 & 1\end{matrix} ]\end{matrix} & ( 175 )\end{matrix}$$

In addition, optimization of Equation (168) to Equation (170) performed by the calculation of Equation (174) is a non-linear problem and may be performed by repeated calculation by a gradient method or the like.

Furthermore, the aforementioned relationship of Equation(173) is not explicitly expressed in the optimization calculation. This is because Equation (173) is also optimized by optimizing Equation (170) since Equation (173) is satisfied if Equation (170) is satisfied when the matrix Hₛ is an orthogonal matrix.

For such a reason, Equation (173) may not be included in Equation (174) for the optimization calculation. That is, the vertical direction of the panoramic image becomes correct if attention is paid to making the horizontal direction of the panoramic image acquired as a resulting image correct.

By the aforementioned calculation of Equation (174), optimized solutions of the imaging direction (orthogonal matrix Hₛ) of the s-th captured image in the world coordinate system and the focal distance Fₛ for all s (where s=1 to N) are acquired. That is, positional relationships, by which the horizontal direction is substantially correct and substantially no failures occurs at the connected part of the respective captured images, are acquired. The computing unit 533 supplies the acquired orthogonal matrix Hₛ and the focal distance Fₛ to the panoramic image generation unit 534.

In Step S624, the panoramic image generation unit 534 generates a panoramic image based on the captured images supplied from the acquisition unit 531 and the orthogonal matrix Hₛ and the focal distance Fₛ supplied from the computing unit 533.

Specifically, the panoramic image generation unit 534 prepares a sphere canvas on the world coordinate system, first. That is, the panoramic image generation unit 534 secures a sphere canvas on a memory which is not shown in the drawing, namely a region corresponding to a spherical surface.

Then, the panoramic image generation unit 534 maps the pixel value of the pixel at each position (Xₛ, Yₛ) in each captured image as light flowing from the direction represented by Equation (166) on the spherical canvas by using the orthogonal matrix Hₛ and the focal distance Fₛ.

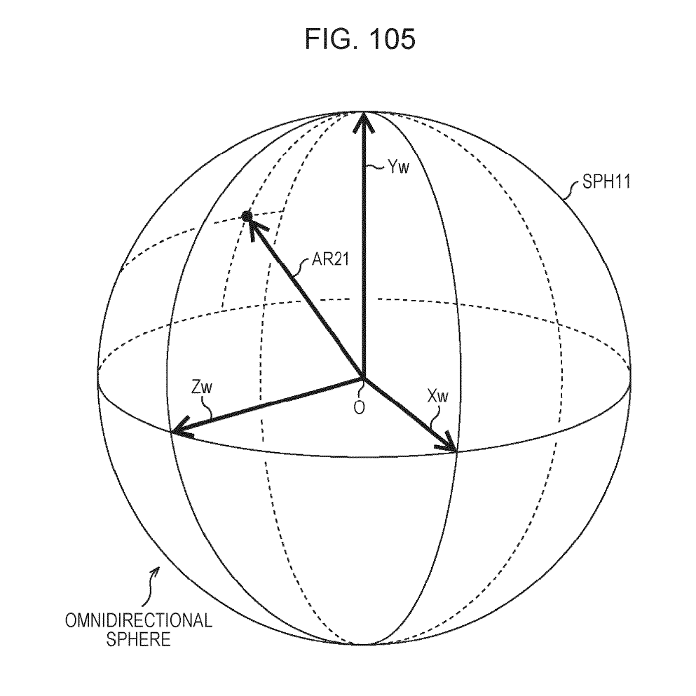

That is, a spherical canvas SPH11 around the origin O as a center of the world coordinate system which includes the Xw axis, the Yw axis, and the Zw axis as the axes is prepared as shown in FIG. 105, for example. Then, the pixel value of the pixel at the position (Xₛ, Yₛ) in the captured image is written at a position on the spherical canvas SPH11, which is specified by Equation (166), and the written pixel value is regarded as a pixel value of a pixel at the position on the canvas SPH11. The writing processing is equivalent to projecting the respective captured images to the spherical canvas SPH11.

For example, the direction of the arrow AR21 which passes through the origin O is a direction acquired by Equation (166) for the position (Xₛ, Yₛ) in the captured image, and the pixel value of the pixel located at the position (Xₛ, Yₛ) in the captured image is written at the position of the intersection between the arrow AR21 and the canvas SPH11. More specifically, the panoramic image generation unit 534 writes, at a position in the memory corresponding to the position on the canvas SPH11, the pixel value of the pixel at the position (Xₛ, Yₛ) in the captured image.

In addition, the pixel value of the pixel in the captured image is generally a value from 0 to 255 when the captured image is a monochrome image, and is a value expressing three primary colors, namely R (red), G (green), and B (blue) by 0 to 255 when the captured image is a color image.

A panoramic image (omnidirectional image) is acquired on the canvas by mapping the captured images on the spherical canvas for the N respective captured images as described above.

In Step S625, the panoramic image generation unit 534 outputs the panoramic image generated on the spherical canvas, and the panoramic image generation processing is completed. The panoramic image output by the panoramic image generation unit 534 is stored on a storage unit such as a hard disk or supplied to and displayed by a display unit.

As described above, the image processing apparatus 521 regards the orthogonal matrixes Hₛ representing the imaging directions as variables (unknown numbers) and acquires the orthogonal matrix Hₛ so as to minimize the amount in deviations in the positional relationships of the feature points between the captured images which are expressed by the orthogonal matrixes Hₛ and the amount in deviations in horizontal degrees of the X axes of the XY coordinate systems with reference to the respective captured images and of the XwZw plane of the world coordinate system. Then, the image processing apparatus 521 maps the captured images on the spherical canvas based on the orthogonal matrixes Hₛ and generates a panoramic image.

It is possible to acquire the world coordinate system, in which the X axes of the individual captured images are substantially horizontal, by evaluating the amount of deviations in the positional relationships of the feature points and the amount of deviations in the horizontal degrees of the X axes and the XwZw plane at the same time and acquiring the orthogonal matrixes Hs representing the imaging directions. As a result, the finally acquired panoramic image becomes an image which is not inclined even when each part is viewed. That is, it is possible to simply acquire a panoramic image with high quality.

### [Description of Image Analysis Processing]

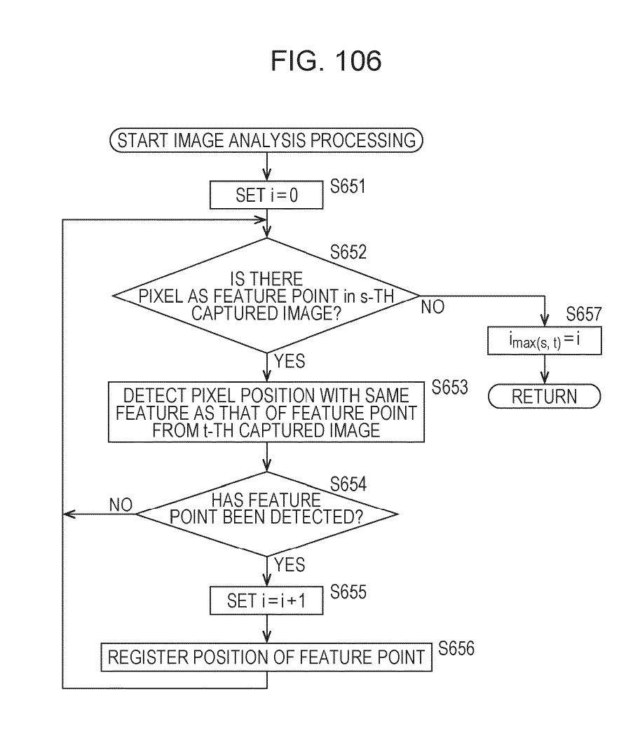

Next, description will be given of image analysis processing corresponding to the processing in Step S622 in FIG. 102 with reference to the flowchart in FIG. 106. In addition, the image analysis processing is processing for acquiring a correspondence relationship of pixel positions between two captured images, namely between the s-th and the t-th captured images, which is represented by Equation (165).

In Step S651, the corresponding position search unit 532 sets a variable i for identifying a feature point in the s-th captured image to 0. The variable i described herein is a variable i for specifying the feature point in Equation (165).

In Step S652, the corresponding position search unit 532 detects a feature point, namely a projected image of an object with a feature from the s-th captured image and determines whether or not there is a pixel which functions as a feature point in the s-th captured image. At this time, feature points which have already been detected in the s-th captured image are excluded, and it is determined whether or not a new feature point has been detected.

When it is determined in Step S652 that there is a pixel which functions as a feature point, the corresponding position search unit 532 detects a pixel position (feature point) with the same feature as that of the feature point in the s-th captured image, which is detected in Step S652, from the t-th captured image in Step S653. That is, a feature point on the t-th captured image, which is to be matched with the feature point on the s-th captured image, is detected.

In Step S654, the corresponding position search unit 532 determines whether or not the corresponding feature point (pixel position) has been detected from the t-th captured image. That is, it is determined whether or not the feature point has been detected in the processing in Step S653.

If it is determined in Step S654 that no feature point has been detected, the processing returns to Step S652, and the aforementioned processing is repeated. That is, the next new feature point is detected from the s-th captured image, and a feature point on the t-th captured image, which corresponds to the feature point, is detected.

In contrast, if it is determined in Step S654 that a feature point has been detected, the corresponding position search unit 532 increments the variable i for identifying the feature point by one and sets the variable i to be equal to i+1 in Step S655.

In Step S656, the corresponding position search unit 532 registers the position of the detected feature point, and the processing returns to Step S652. That is, the corresponding position search unit 532 sets the position of the feature point on the s-th captured image, which is detected in Step S652, to (X(s,t,i) Y(s,t,i), sets the position of the feature point on the t-th captured image, which is detected in Step S653, to (X(t,s,i), Y(t,s,i)), and maintains these positions.

If it is determined in Step S652 that there is no pixel which functions as a feature point in the s-th captured image, detection of all the feature points on the s-th captured image is completed, and therefore, the processing proceeds to Step S657.

In Step S657, the corresponding position search unit 532 substitute the value of the variable i at the current point into a value iₘₐₓ(s,t) which represents the number of corresponding feature points in the s-th captured image and supplies the positional relationships of the respective captured images acquired by the aforementioned processing and the value of iₘₐₓ(s,t) to the computing unit 533.

If the correspondence relationships of the feature points between the captured images are acquired for the respective combination of s and t (where s=1 to N−1 and t=s+1 to N) as described above, the image analysis processing is completed, and then the processing proceeds to Step S623 in FIG. 102.

Since there is also a case where some acquired correspondence relationships of the feature points are incorrect, it is possible to acquire more correct correspondence relationships by deleting the feature points other than the correct feature points from the registration data by a RANSAC (Random Sample Consensus) method, for example.

The image processing apparatus 521 acquires the correspondence relationships of the feature points between the captured images as described above.

### Modification Example 1 of Twelfth Embodiment

### Description of Panoramic Image Generation Processing

In the above description, the calculation of Equation (174) is performed under the restriction that the acquired matrix Hₛ is an orthogonal matrix. However, the degree of freedom further increases if the restriction is removed. Thus, optimization with no restriction about the orthogonal matrix will be considered.

That is, if it is assumed that the matrix Hₛ is a general 3×3 matrix which is not an orthogonal matrix, the imaging direction in which the respective captured images are captured are not necessarily orthogonal to the Y axes of the XY coordinate systems with reference to the captured images. In addition, the imaging directions in which the respective captured images are captured are not necessarily orthogonal to the X axes of the XY coordinate systems with reference to the captured images. Furthermore, the X axes are not necessarily orthogonal to the Y axes in the XY coordinate systems with reference to the captured images.

A case where the matrix Hₛ which substantially satisfies Equation (167), namely Equation (168) and Equation (169) to the maximum extent under the condition that the matrix Hₛ is an orthogonal matrix for all s is acquired and a case where the matrix Hₛ which substantially satisfies Equation (167) to the maximum extent under the condition that the matrix Hₛ may not be an orthogonal matrix will be considered.

Hereinafter, calculation of the matrix Hₛ under the condition that the matrix Hₛ is an orthogonal matrix will also be referred to as a case with orthogonal restriction, and calculation of the matrix Hₛ under the condition that the matrix Hₛ may not be an orthogonal matrix will also be referred to as a case with no orthogonal restriction.

Since it is a matter of course that the above three directions, namely the imaging direction, the X axis, and the Y axis are orthogonal to each other during the imaging, Equation (167) is completely satisfied even in the case with orthogonal restriction if calculation processing can be performed without causing any error.

However, since the relationship of Equation (165) which is acquired by the image analysis actually includes errors, there is no case where Equation (167) is completely satisfied in the case with orthogonal restriction. Similarly, there is also no case where Equation (167) is completely satisfied even in the case with no orthogonal restriction, but however, the relationship of Equation (167) is further satisfied in the case with no orthogonal restriction than in the case with orthogonal restriction since the degree of freedom is higher in the case with no orthogonal restriction. That is, it is possible to acquire a solution of the matrix Hₛ with less error.

For example, mapping of pixels in the respective captured images on the spherical canvas will be considered on the assumption that the respective captured images are images acquired by capturing images in the directions represented by the matrix Hₛ (where s=1 to N) on the absolute coordinate system (world coordinate system). In such a case, it is possible to map the captured images on the spherical canvas (omnidirectional sphere) with less failures at the connected parts of the respective captured images in the case with no orthogonal restriction than in the case with orthogonal restriction.

In contrast, since the case where the matrix Hs is not an orthogonal matrix is also permitted, it is necessary to take whether or not the vertical direction of the panoramic image is correct into consideration as well as that the horizontal direction of the panoramic image is correct.

Accordingly, it is only necessary to perform optimization for minimizing the error represented by the following Equation (176) instead of the processing of acquiring the matrix Hₛ and Fₛ which minimize Equation (174) under the condition that Equation (175) is satisfied, as in Step S623 in FIG. 102 when the matrix Hₛ and Fₛ are acquired. That is, the matrix Hs and Fs which minimize Equation (176) may be acquired.

$$\begin{matrix} [ Math . 176 ] & \\ {\sum }_{{s = 1 ∼ N}_{{t = ( s + 1 ) ∼ N}_{i = 1 ∼ {i}_{max} ( s . t )}}} \{ \begin{matrix}{( \begin{matrix}\frac{{H}_{s ( 1 , 1 )} X ( s , t , i ) + {H}_{s ( 1 , 2 )} Y ( s , t , i ) + {H}_{s ( 1 , 3 )} {F}_{s}}{{H}_{s ( 3 , 1 )} X ( s , t , i ) + {H}_{s ( 3 , 2 )} Y ( s , t , i ) + {H}_{s ( 3 , 3 )} {F}_{s}} - \\ \frac{{H}_{t ( 1 , 1 )} X ( t , s , i ) + {H}_{t ( 1 , 2 )} Y ( t , s , i ) + {H}_{t ( 1 , 3 )} {F}_{t}}{{H}_{t ( 3 , 1 )} X ( t , s , i ) + {H}_{t ( 3 , 2 )} Y ( t , s , i ) + {H}_{t ( 3 , 3 )} {F}_{t}} \end{matrix} )}^{2} + \\ {( \begin{matrix}\frac{{H}_{s ( 2 , 1 )} X ( s , t , i ) + {H}_{s ( 2 , 2 )} Y ( s , t , i ) + {H}_{s ( 2 , 3 )} {F}_{s}}{{H}_{s ( 3 , 1 )} X ( s , t , i ) + {H}_{s ( 3 , 2 )} Y ( s , t , i ) + {H}_{s ( 3 , 3 )} {F}_{s}} - \\ \frac{{H}_{t ( 2 , 1 )} X ( t , s , i ) + {H}_{t ( 2 , 2 )} Y ( t , s , i ) + {H}_{t ( 2 , 3 )} {F}_{t}}{{H}_{t ( 3 , 1 )} X ( t , s , i ) + {H}_{t ( 3 , 2 )} Y ( t , s , i ) + {H}_{t ( 3 , 3 )} {F}_{t}}\end{matrix} )}^{2}\end{matrix} \} + {ω}_{1} {\sum }_{s = 1 ∼ N} {( {H}_{s ( 2 , 1 )} )}^{2} + {ω}_{2} {\sum }_{s = 1 ∼ N} ( \frac{( {( {H}_{s ( 1 , 2 )} {H}_{s ( 3 , 3 )} - {H}_{s ( 1 , 3 )} {H}_{s ( 3 , 2 )} )}^{2} )}{\begin{matrix}{( {H}_{s ( 1 , 2 )} {H}_{s ( 3 , 3 )} - {H}_{s ( 1 , 3 )} {H}_{s ( 3 , 2 )} )}^{2} + \\ {( {H}_{s ( 1 , 2 )} {H}_{s ( 2 , 3 )} - {H}_{s ( 1 , 3 )} {H}_{s ( 2 , 2 )} )}^{2} + \\ {( {H}_{s ( 2 , 2 )} {H}_{s ( 3 , 3 )} - {H}_{s ( 2 , 3 )} {H}_{s ( 3 , 2 )} )}^{2}\end{matrix}} ) & ( 176 )\end{matrix}$$

In addition, ω₁ and ω₂ represent weights in Equation (176), and values of ω₁ and ω₂ are set to appropriate scalar values.

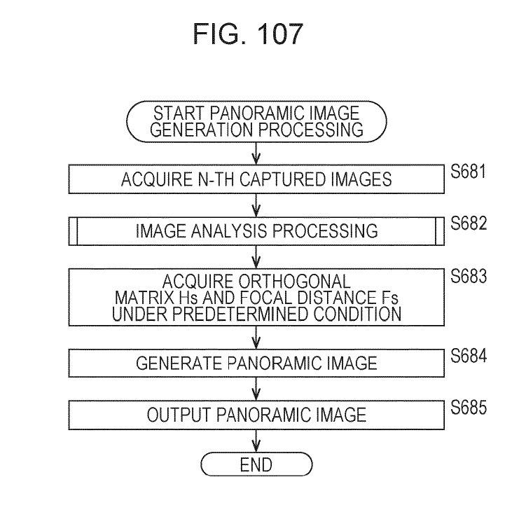

When the matrix Hₛ and Fₛ are acquired with no orthogonal restriction as described above, the panoramic image generation processing shown in FIG. 107 is performed by the image processing apparatus 521. Hereinafter, the panoramic image generation processing by the image processing apparatus 521 will be described with reference to the flowchart in FIG. 107.

In addition, since processing in Step S681 and Step S682 is the same as the processing in Step S621 and Step S622 in FIG. 102, the description thereof will be omitted.

In Step S683, the computing unit 533 acquires the aforementioned 3×3 matrix Hₛ and the focal distance Fₛ (where s=1 to N) which minimize Equation (176) based on the correspondence relationships between the captured images represented by Equation (165), which are supplied from the corresponding position search unit 532.

The computing unit 533 supplies the acquired matrix Hₛ and the focal distance Fₛ to the panoramic image generation unit 534, then processing in Step S684 and Step S685 is performed, and the panoramic image generation processing is completed. Since the processing in Step S684 and Step S685 is the same as the processing in Step S624 and Step S625 in FIG. 102, and the description thereof will be omitted.

The image processing apparatus 521 acquires the matrix Hₛ and the focal distance Fₛ and generates the panoramic image from the acquired matrix Hₛ and the focal distance Fₛ as described above. With such a configuration, it is possible to simply acquire a panoramic image with high quality.

According to the present technology, it is possible to simultaneously optimize the processing of acquiring the relative positional relationships between the captured images and the processing of acquiring the imaging directions of the respective captured images in the world coordinate system as described above. Accordingly, it is possible to acquire a world coordinate system in which the X axes of the individual captured images are substantially horizontal, and it is possible to acquire a panoramic image which is not inclined even when each part is viewed.

In addition, the present technology described in the twelfth embodiment and the modification example thereof can be configured as follows.

[1] An image processing method for generating a panoramic image based on a plurality of captured images which an imaging device successively captures while a direction of the imaging direction is changed, the method including the steps of:

determining imaging positions so as to satisfy at least one of a first condition that lateral axes of the respective captured images are substantially horizontal to the maximum extent in a world coordinate system and a second condition that planes including imaging directions of the respective captured images and vertical axes of the captured image include a vertical direction to the maximum extent, when the imaging positions of the captured images in the world coordinate system, which allow the respective captured images to be smoothly connected, are acquired; and

mapping the captured images on the spherical canvas on the assumption that the captured images are captured at the imaging positions and regarding the spherical canvas as a panoramic image.

[2] An image processing method for generating a panoramic image based on N captured images which an imaging device successively captures whine a direction of the imaging device is changed, the method including:

an acquisition step in which the N captured images are acquired;

a corresponding point calculation step in which a position V(s,t,Vs) in a same-order coordinate expression of a t-th captured image, where the same object as an object projected to a position Vs in a same-order coordinate expression of an s-th captured image is projected, is acquired by analyzing the s-th captured image and the t-th captured image for each combination of s and t (s=1 to N−1, t=s+1 to N);

an optimization step in which a 3×3 matrix is regarded as Hs (s=1 to N), and when
a first deviation amount is defined as a deviation amount between a direction represented as HsVs and a direction represented as HtV(s,t,Vs),
a second deviation amount is defined as a value of a product between a three-dimensional lateral vector (0, 1, 0) and a three-dimensional longitudinal vector configured of the first column of the matrix Hs, and
a third deviation amount is defined by a distance between a plane including three points, namely an origin, a three-dimensional position configured of the second column of the matrix Hs, and a three-dimensional position configured of the third column of the matrix Hs and the vector (0, 1, 0),

a matrix which minimizes the total value of the first deviation amount and the second deviation amount, minimizes a total value of the first deviation amount and the third deviation amount, or minimizes a total value of the first deviation amount, the second deviation amount, and the third deviation amount is acquired as the matrix Hs;

a rendering step in which values of pixels at the respective positions in the s-th captured image are mapped on a spherical canvas by the matrix Hs (s=1 to N) acquired in the optimization step; and

an output step in which the spherical canvas rendered in the rendering step is output as the panoramic image.

### [Correction of Horizontal and Vertical Directions by Image Deformation]

### Thirteenth Embodiment

### Concerning Panoramic Image

In addition, the horizontal direction and the vertical direction of the panoramic image may be corrected by performing image deformation when the panoramic image is generated.

It is possible to generate a panoramic image by editing a plurality of captured images acquired by an imaging device such as a digital camera capturing images in various directions, for example. That is, it is possible to generate a wide panoramic image by connecting the first to N-th captured images, namely the total of N captured images.

A specific method for generating a panoramic image is described in “M. Brown and D. Lowe. Automatic Panoramic Image Stitching using Invariant Features. International Journal of Computer Vision, 74(1), pages 59-73, 2007”, for example.

According to this article, positional relationships of the first to the N-th captured images are acquired, first when the panoramic image is generated (Step STA1). The positional relationships acquired here are relative positional relationships between the captured images and are not positions in an absolute coordinate system (hereinafter, referred to as a world coordinate system) (see Chapters 2 to 4 in the article).

Next, imaging directions of the respective captured images in the world coordinate system are acquired on the assumption that the lateral directions of the captured images are horizontal in Step STA2 (see Chapter 5 in the article).

Furthermore, pixels values of pixels at the respective positions (Xₛ, Yₛ) in the respective captured images are mapped as light flowing from the imaging directions acquired in Step STA2 on a predetermined canvas region, and a panoramic image is generated in step STA3. Here, the pixel value of the pixel in the captured image is generally a value from 0 to 255 when the captured image is a monochrome image, and is a value expressing three primary colors, namely red, green, and blue by 0 to 255 when the captured image is a color image.

Now, generation of the panoramic image will be described again in detail.

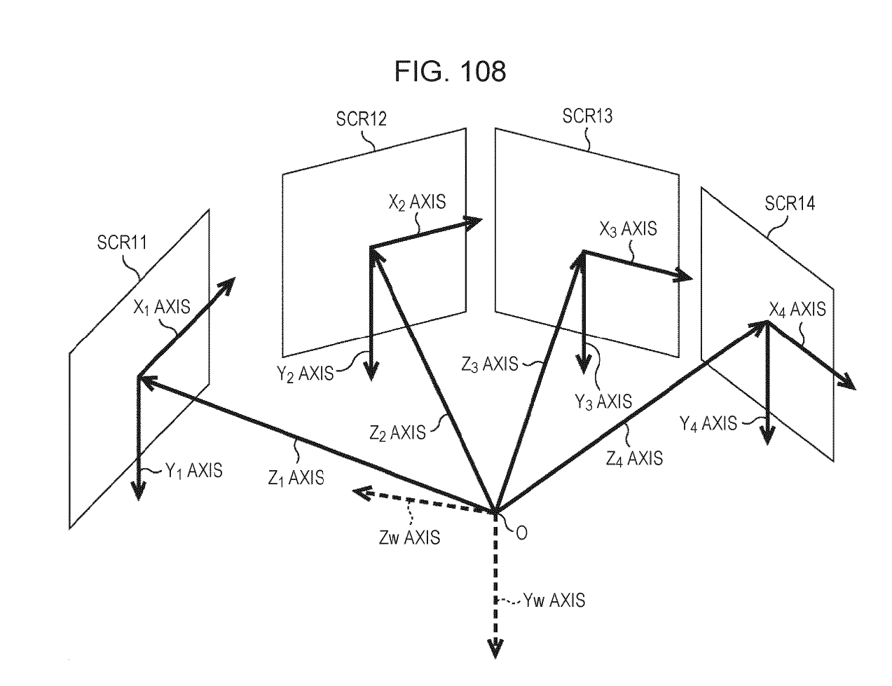

FIG. 108 shows a state when an imaging device such as a digital camera captures images in various directions. Here, an example of a case where four captured images are captured, namely a case where N=4 is shown.

In this example, a screen SCR11 to a screen SCR14 represent screens (projected planes) when the first to the fourth captured images are captured, respectively. Directions of a Z₁ axis to a Z₄ axis represent imaging directions of the first to the fourth captured images, respectively. Here, the screen SCR11 to the screen SCR14 intersect with the Z₁ axis to the Z₄ axis at the center positions of the respective screens, respectively.

Furthermore, the X₁ axis and the Y₁ axis which are orthogonal to each other represent axes of an X₁Y₁ coordinate system on the screen SCR11 which has an origin at a position of the intersection between the screen SCR11 and the Z₁ axis, and the coordinate system is also a coordinate system for pixel positions in the first captured image. In addition, an X₁Y₁Z₁ coordinate system which includes the X₁ axis, the Y₁ axis, and the Z₁ axis as axes is a normal orthogonal coordinate system.

Similarly, an Xₛ axis and a Yₛ axis which are orthogonal to each other represent axes of an XₛYₛ coordinate system on the screen, which has an origin at a position of the intersection between a screen of the s-th captured image and the Zₛ axis, and the coordinate system is also a coordinate system for pixel positions in the s-th captured image (where s=2 to 4).

In FIG. 108, the first to the fourth captured images are captured while the imaging device is rotated about the origin O as an optical axis center of the imaging device from the left direction to the right direction in the drawing. Light beams flowing from far sides to the optical axis center form images on the intersections between the light beams and the respective screens SCR11 to SCR14, and the captured images are formed. Here, distances from the origin O (optical axis center) to the respective screens SCR11 to SCR14 are F as focal distances of the lens of the imaging device.

Although the screen SCR11 to the screen SCR14 are illustrated so as not to overlap with each other in order to avoid complicated drawing, imaging is performed such that adjacent screens partially overlap in practice. That is, a light beam which is flowing from a far side to the optical axis center and intersects with two screens is present. In other words, there is an object which is projected to two captured images.

In FIG. 108, an axis which passes through the optical axis center (origin O) and is in a direction substantially vertical to all the four axes, namely the X₁ axis to the X₄ axis is represented as a Y_{w} axis, and an axis which is orthogonal to the Y_{w} axis and is in a direction included in a plane configured of the Y₁ axis and the Z₁ axis is represented as a Z_{w} axis. In addition, an axis which is in a direction orthogonal to the Y_{w} axis and the Z_{w} axis is represented as an X_{w} axis (not shown). Hereinafter, the three-dimensional coordinate system which has the origin O as the origin thereof and includes the X_{w} axis, the Y_{w} axis, and the Z_{w} axis as the axes will also be referred to as an X_{w}Y_{w}Z_{w} coordinate system.

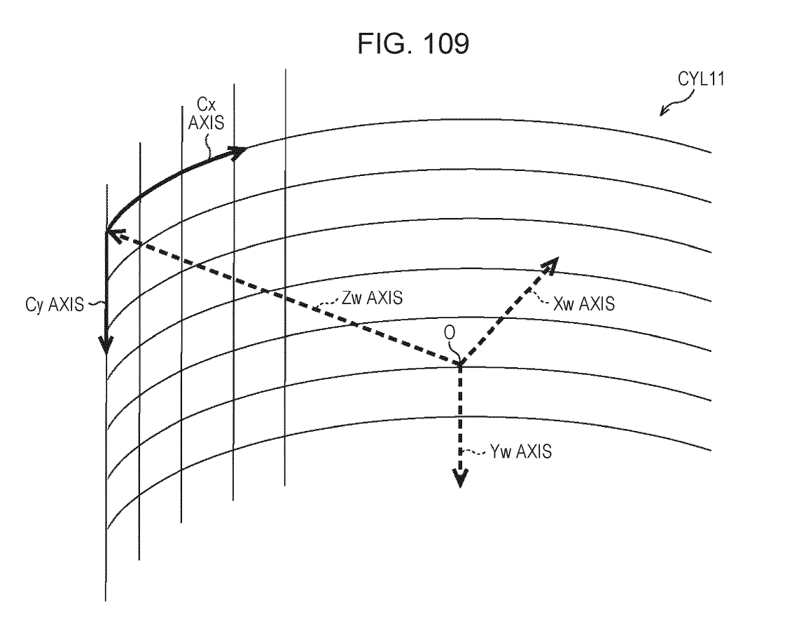

In addition, FIG. 109 shows a cylindrical surface (a side surface of a cylinder) for generating a panoramic image. In FIG. 109, the same reference numerals are given to parts corresponding to those in FIG. 108, and the description thereof will be omitted.

In FIG. 109, a side surface CYL11 of a circle with a radius F around the Y_{w} axis as a center in the X_{w}Y_{w}Z_{w} coordinate system which is defined in FIG. 108 and has the optical axis center as the origin O is a cylindrical surface used for generating the panoramic image. In addition, (Cx, Cy) is introduced as coordinates on the cylindrical surface.

That is, a Cx axis and a Cy axis which are orthogonal to each other are defined on the side surface CYL11, and a position of the CxCy coordinate system which includes the Cx axis and the Cy axis as axes is (Cx, Cy).

Here, a point where the position (Cx, Cy)=(0, 0), namely an origin of the CxCy coordinate system is a point where the position (X_{w}, Y_{w}, Z_{w})=(0, 0, F) in the X_{w}Y_{w}Z_{w} coordinate system. In addition, the Cy axis is an axis which is parallel with the Y_{w} axis.

Now, it is possible to acquire the positional relationship between the s-th and the s+1-th captured images by analyzing the s-th captured image and the s+1-th captured image.

Specifically, a plurality of pixel positions (hereinafter, referred to as feature points) such as edge parts or parts with clear textures in the s+1-th captured image are acquired.

Then, positions with the same features, namely positions with the same edges and the same textures as those of the plurality of feature points in the s+1-th captured image are searched for in the s-th captured image. That is, matching of the feature points is performed. If such matching is performed, positions of the corresponding feature points between the s-th captured image and the s+1-th captured image are recorded.

With such processing, a plurality of relationships of the corresponding pixel positions between the s-th captured image and the s+1-th captured image are acquired. If these correspondence relationships are used, it is possible to acquire a relative positional relationship between the images when the s-th captured image and the s+1-th captured image are captured.

Here, acquisition of the positional relationships between the captured images specifically means acquisition of the homogenous transformation matrixes (homography) represented by the following Equation (177).

$$\begin{matrix}[ Math . 177 ] & \\ [ \begin{matrix}{X}_{s} \\ {Y}_{s} \\ 1\end{matrix} ] ∝ {H}_{s , s + 1} [ \begin{matrix}{X}_{s + 1} \\ {Y}_{s + 1} \\ 1\end{matrix} ] & ( 177 )\end{matrix}$$

In Equation (177), the 3×3 matrix H_{s,s+1} is the homogeneous transformation matrix. Equation (177) means that an object projected to a pixel position (Xₛ₊₁, Yₛ₊₁) in the Xₛ₊₁Yₛ₊₁ coordinate system on the s+1-th captured image is the same as an object projected to a pixel position (Xₛ, Yₛ) in the XₛYₛ coordinate system on the s-th captured image, which satisfies Equation (177).

Incidentally, it is possible to acquire a homogeneous transformation matrix H′_{1,s} as a positional relationship between an arbitrary captured image (the s-th captured image) and the first captured image by accumulating the homogeneous transformation matrixes between the adjacent images as represented by the following Equation (178).

$$\begin{matrix}[ Math . 178 ] & \\ {H}_{1 , s}^{′} ≡ ( {\prod }_{t = 1}^{s - 1} {H}_{t , t + 1} ) = {H}_{1 , 2} {H}_{2 , 3} … {H}_{s - 2 , s - 1} {H}_{s - 1 , s} & ( 178 )\end{matrix}$$

Incidentally, even if the relative positional relationships of the captured images are acquired as described above, it is important to select what kind of coordinate system (world coordinate system) the mapping is to be performed on. If an inappropriate world coordinate system is set, the vertical and the horizontal directions of the generated panoramic image are inclined obliquely, and it is not possible to acquire a panoramic image with high quality.

Thus, according to the aforementioned article, an axis which allows the X₁ axis to the X₄ axis to be substantially horizontal to the maximum extent is acquired by the least squares method and is set as an X axis of the world coordinate system on the assumption that imaging is performed while lateral axes of the captured images, namely the X₁ axis to the X₄ axis are maintained to be parallel with the horizontal line. That is, the aforementioned X_{w}Y_{w}Z_{w} coordinate system is acquired as the world coordinate system.

Here, if the positional relationship (homogeneous transformation matrix) between the world coordinate system and the first captured image is represented as H_{w,1}, a homogenous transformation matrix H_{w,s} as a positional relationship between an arbitrary captured image (the s-th captured image) and the world coordinate system is represented by the following Equation (179).

$$\begin{matrix}[ Math . 179 ] & \\ \begin{matrix}{H}_{w , s} ≡ {H}_{w , 1} {H}_{1 , s} = {H}_{w , 1} ( {\prod }_{t = 1}^{s - 1} {H}_{t , t + 1} ) \\ = {H}_{w , 1} {H}_{1 , 2} {H}_{2 , 3} … {H}_{s - 2 , s - 1} {H}_{s - 1 , s}\end{matrix} & ( 179 )\end{matrix}$$

That is, the pixel position (Xₛ, Yₛ) in the XₛYₛ coordinate system on the s-th captured image coincides with the position (X_{w}, Y_{w}) represented by the following Equation (180) on a virtual image with reference to the world coordinate system.

$$\begin{matrix}[ Math . 180 ] & \\ [ \begin{matrix}{X}_{w} \\ {Y}_{w} \\ 1\end{matrix} ] ∝ {H}_{w , s} [ \begin{matrix}{X}_{s} \\ {Y}_{s} \\ 1\end{matrix} ] & ( 180 )\end{matrix}$$

In addition, if Equation (180) is deformed, the following Equation (181) is acquired.

$$\begin{matrix}[ Math . 181 ] & \\ [ \begin{matrix}{X}_{w} \\ {Y}_{w} \\ 1\end{matrix} ] ∝ [ \begin{matrix}1 & 0 & 0 \\ 0 & 1 & 0 \\ 0 & 0 & F\end{matrix} ] {H}_{w , s} [ \begin{matrix}1 & 0 & 0 \\ 0 & 1 & 0 \\ 0 & 0 & 1 / F\end{matrix} ] [ \begin{matrix}{X}_{s} \\ {Y}_{s} \\ 1\end{matrix} ] & ( 181 )\end{matrix}$$

If it is assumed that the virtual image with reference to the world coordinate system is captured with the same focal distance F as that of the first to the fourth captured images, the light of the object projected to the pixel position (Xₛ, Yₛ) in the s-th captured image becomes light flowing from the direction represented by the right side in Equation (181) in the world coordinate system.

In addition, since the position (Cx, Cy) in the CxCy coordinate system, which is shown in FIG. 109, is represented by the following Equation (182) in the world coordinate system (X_{w}Y_{w}Z_{w} coordinate system), Equation (183) is derived as a result.

$$\begin{matrix}[ Math . 182 ] & \\ [ \begin{matrix}F \times sin ( \frac{Cx}{F} ) \\ Cy \\ F \times cos ( \frac{Cx}{F} )\end{matrix} ] & ( 182 ) \\ [ Math . 183 ] & \\ [ \begin{matrix}F \times sin ( \frac{Cx}{F} ) \\ Cy \\ F \times cos ( \frac{Cx}{F} )\end{matrix} ] ∝ [ \begin{matrix}1 & 0 & 0 \\ 0 & 1 & 0 \\ 0 & 0 & F\end{matrix} ] {H}_{w , s} [ \begin{matrix}1 & 0 & 0 \\ 0 & 1 & 0 \\ 0 & 0 & 1 / F\end{matrix} ] [ \begin{matrix}{X}_{s} \\ {Y}_{s} \\ F\end{matrix} ] & ( 183 )\end{matrix}$$

Since the light of the object projected to the pixel position (Xₛ, Yₛ) in the s-th captured image is light flowing from the direction represented by the right side in Equation (181) in the world coordinate system, the light penetrates through the position (Cx, Cy) represented by Equation (183) on the cylindrical surface (the side surface CYL11 in FIG. 109).

Accordingly, it is possible to generate a panoramic image by mapping the pixel value of the pixel at the position (Xₛ, Yₛ) in the XₛYₛ coordinate system of each captured image on the position (Cx, Cy) represented by Equation (183) on the cylindrical surface and regarding image data acquired by deploying the cylindrical surface as the panoramic image. In addition, the pixel value of the pixel in the captured image is generally a value from 0 to 255 when the captured image is a monochrome image, and is a value expressing three primary colors, namely red, green, and blue by 0 to 255 when the captured image is a color image.

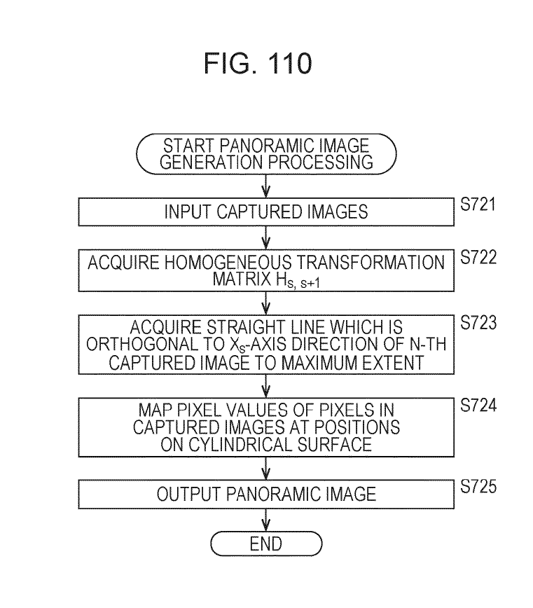

The panoramic image can be generated as described above, and the series of processing corresponds to processing shown in FIG. 110. Here, description will be given of panoramic image generation processing for generating a panoramic image by the aforementioned method with reference to the flowchart in FIG. 110.

In Step S721, the first to the N-th captured images are input. In the aforementioned example, N=4.

In Step S722, adjacent captured images are analyzed and a simultaneous transformation matrix H_{s,s+1} (where s=1 to N−1) as a correspondence relationship of an object projected to the captured images is acquired.

In Step S723, a straight line which is substantially vertical to the Xₛ-axis direction (where s=1 to N) of the N-th captured image to the maximum extent is acquired. In addition, a coordinate system which has the optical center as an origin O and includes a Y_{w} axis in the direction of the straight line acquired in Step S723 is regarded as a world coordinate system. In addition, a positional relationship of the first captured image in the world coordinate system is regarded as a homogeneous transformation matrix H_{w,1}.

Furthermore, Equation (179) is calculated, and a homogeneous transformation matrix H_{w,s} (where s=2 to N) as a positional relationship between the s-th captured image and the world coordinate system is acquired.

In Step S724, the pixel value of the pixel at the position (Xₛ, Yₛ) in the XₛYₛ coordinate system of the s-th captured image (where s=1 to N) is mapped on the position (Cx, Cy), which is represented by Equation (183), on a cylindrical surface with a radius F around the Y_{w} axis as a center in the world coordinate system.

In Step S725, the cylindrical surface on which the pixel value is mapped is deployed, the deployed diagram is output as a panoramic image, and the panoramic image generation processing is completed.

In addition, since the captured images have overlapping parts, and pixel values in any one captured image, at the part where two captured images overlap, are mapped on the cylindrical surface. Since a center part of a captured image more clearly appears than a circumferential part in general, it is more preferable to use the center part of the captured image for generating the panoramic image as much as possible.

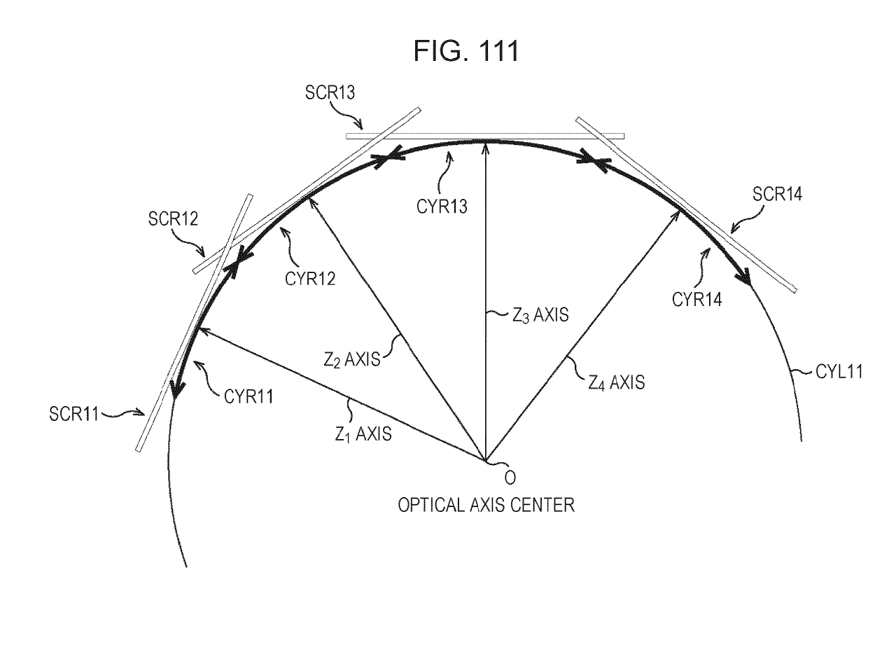

The panoramic image may be generated by using partial regions of the captured images as shown in FIG. 111, for example. In FIG. 111, the same reference numerals are given to parts corresponding to those in FIGS. 108 and 109, and the description thereof will be appropriately omitted.

FIG. 111 is a diagram of the screen SCR11 to the screen SCR14 in FIG. 108 when viewed from the Y_{w}-axis direction. In this example, partial regions of adjacent screens overlap with each other.

For example, the first captured image is targeted and mapping of the pixel values therein is performed at the part corresponding to the region CYR11 on the cylindrical side surface CYL11, and the second captured image is targeted and mapping therefrom is performed at the part corresponding to the region CYR12 on the side surface CYL11 when the panoramic image is generated. In addition, the third captured image is targeted and mapping therefrom is performed at the part corresponding to the region CYR13 on the side surface CYL11, and the fourth captured image is targeted and mapping therefrom is performed at the part corresponding to the region CYR14 on the side surface CYL11. With such processing, it is possible to acquire a clearer panoramic image.

Incidentally, it is a matter of course that errors are incorporated in the calculation process for acquiring the simultaneous transformation matrixes H_{s,s+1} representing the positional relationships in the process in Step S722 in FIG. 110. Therefore, the errors are also included in the world coordinate system acquired by the processing in Step S723.

That is, it is not possible to acquire a world coordinate system in which the Xₛ axes (where s=1 to N) of all the captured images are completely horizontal, and slight variations occur.

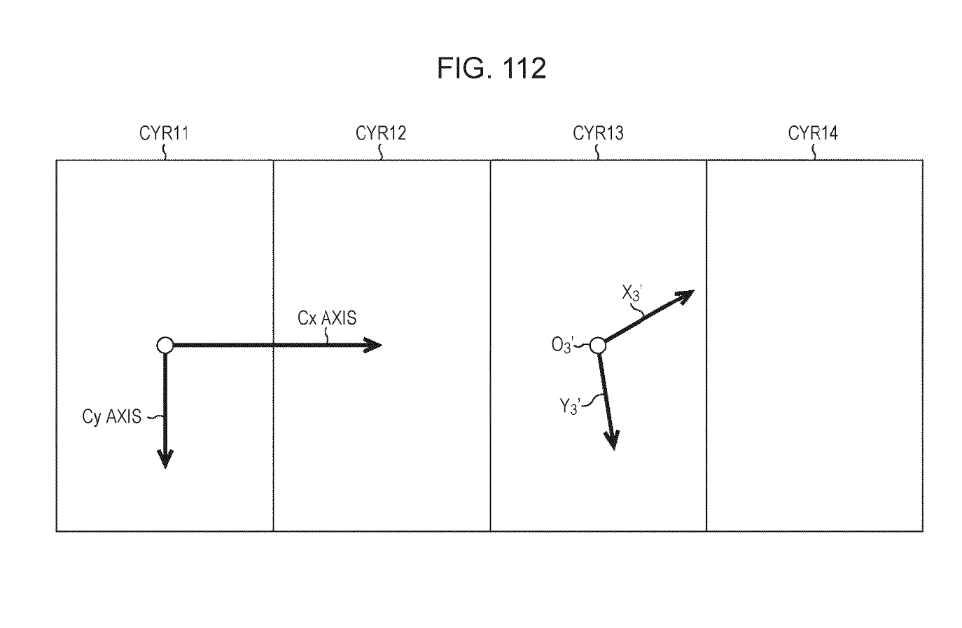

Accordingly, there is a case where the horizontal direction is not maintained in the generated panoramic image regardless of the fact that the person who captures the images performs imaging such that the lateral axis of the imaging device is maintained to be horizontal as shown in FIG. 112, for example. In the drawing, the lateral direction and the longitudinal direction represent a Cx-axis direction and a Cy-axis direction. In FIG. 112, the same reference numerals are given to parts corresponding to those in FIG. 109 or 111, and the description thereof will be appropriately omitted.

FIG. 112 shows an example where the number N of the captured images is four, and FIG. 112 shows a panoramic image acquired by deploying the side surface CYL11 of the cylinder in FIG. 111. In addition, only an effective region in the deployed cylindrical surface is shown in FIG. 112.

In the panoramic image, pixels in the first captured image are mapped in the region CYR11 corresponding to about ¼ at the left end in the drawing, and pixels in the second captured image are mapped in the following region CYR12 corresponding to about ¼. Furthermore, pixels in the third captured image are mapped in the region CYR13 corresponding to about ¼ of the panoramic image, which follows the region CYR12, and pixels in the fourth captured image are mapped in the region CYR14 corresponding to ¼ at the right end of the drawing.

For example, how the pixels in the third captured image are mapped on the panoramic image (side surface CYL11) will be considered.

First, it is assumed that a center position (X₃, Y₃)=(0, 0) of an X₃Y₃ coordinate system of the third captured image is mapped on a position of a point O₃′ on the panoramic image by Equation (183). In addition, it is assumed that an X₃ axis as the lateral axis and a Y₃ axis as the longitudinal axis of the third captured image are mapped in directions of X₃′ and Y₃′ represented by arrows.

In FIG. 112, the X₃ axis is not in a completely horizontal direction (the lateral direction in the drawing) on the panoramic image due to the errors in the calculation process. Similarly, the Y₃ axis is not also in a completely vertical direction (the longitudinal direction in the drawing) due to the errors.

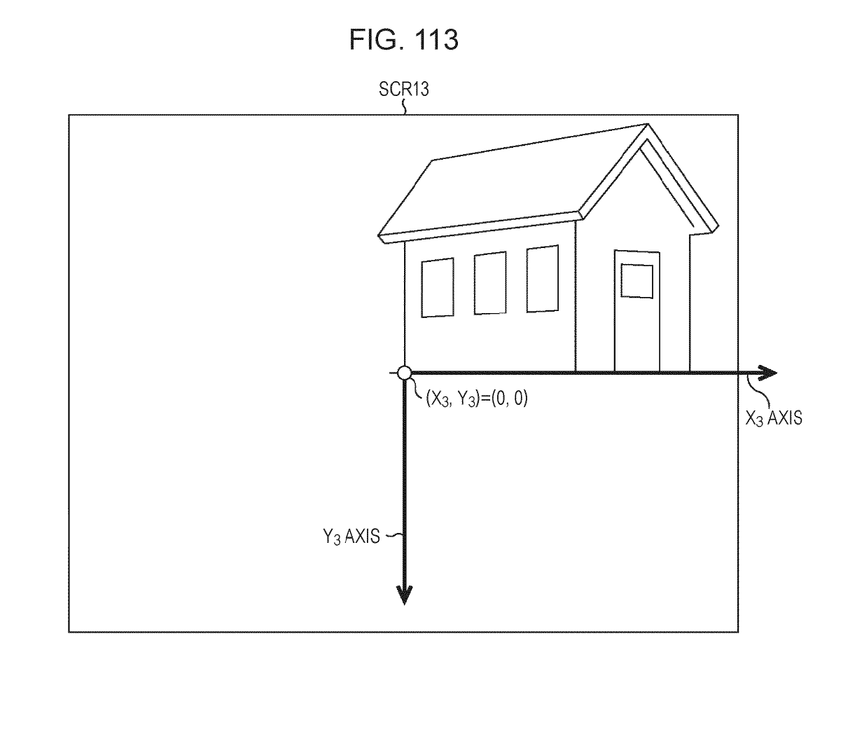

If it is assumed that the third captured image is an image acquired by imaging a house as shown in FIG. 113, for example, the house is inclined on the panoramic image.

In addition, the lateral direction and the longitudinal direction in the drawing represent the X₃-axis direction and the Y₃-axis direction, respectively, and in FIG. 113, the same reference numerals are given to parts corresponding to those in FIG. 108, and the description thereof will be omitted.

In the example of FIG. 113, the house as an object is imaged by the person who captures the image such that the lateral axis of the captured image is horizontal. However, there is a case where the object such as a house in FIG. 113, for example, is obliquely inclined on the finally generated panoramic image regardless of the fact that the imaging is performed such that the horizontal direction and the vertical direction of the object correctly appear on the third captured image.

As described above, there is a case where the generated panoramic image becomes an inclined image in which the vertical and the horizontal directions are not correctly projected.

The present technology was made in view of such circumstances, and is designed to enable acquisition of a panoramic image with high quality, in which the vertical and the horizontal directions are correctly projected when the panoramic image is generated by connecting a plurality of captured images.

### [Overview of Present Technology]

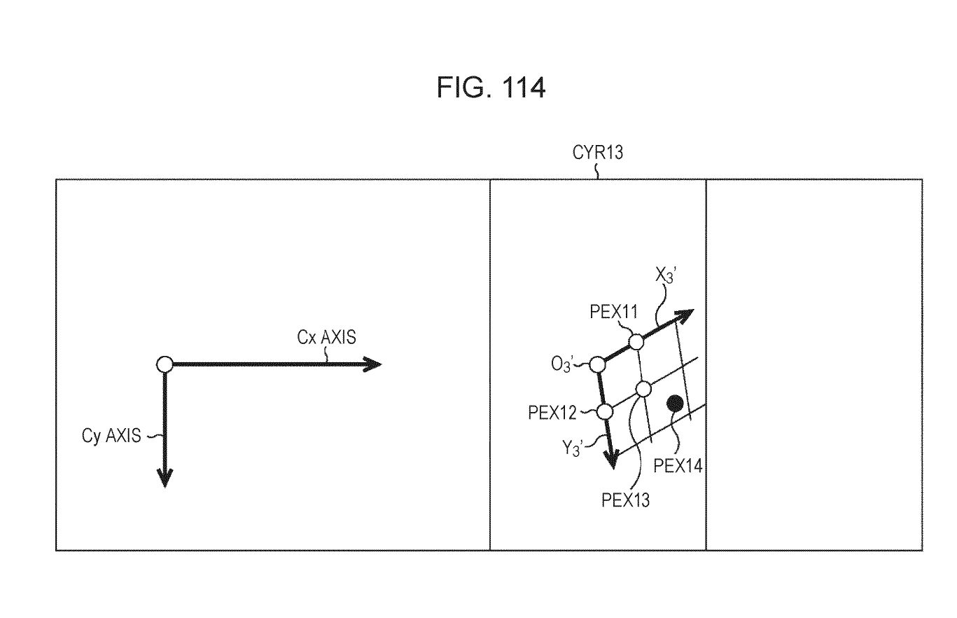

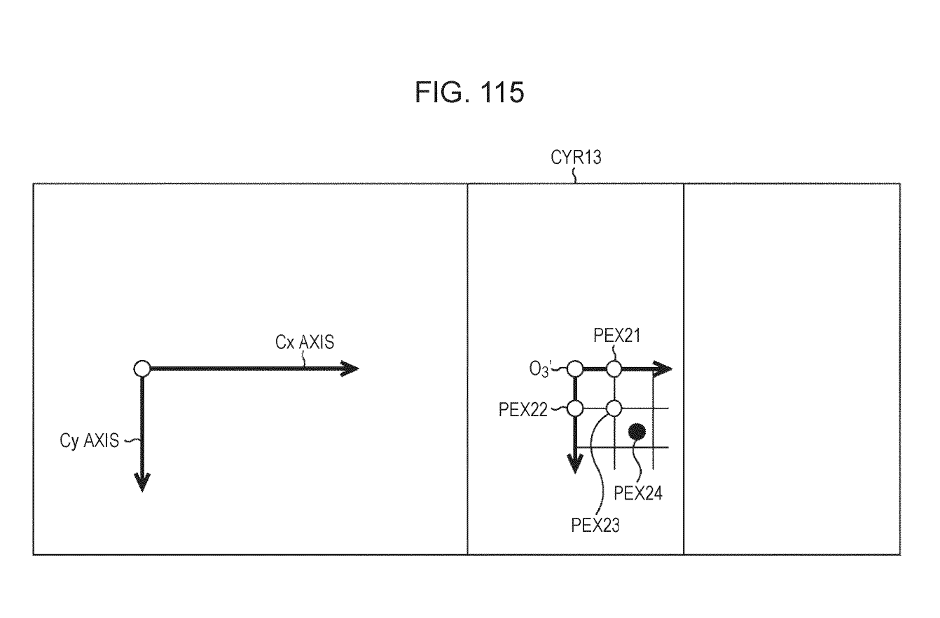

First, description will be given of overview of the present technology with reference to FIGS. 114 and 115.

In addition, FIGS. 114 and 115 show a cylindrical surface on which a panoramic image is generated, and the lateral direction and the longitudinal direction in the drawing represent the Cx-axis direction and the Cy-axis direction. In FIGS. 114 and 115, the same reference numerals are given to parts corresponding to those in FIG. 112, and the description thereof will be appropriately omitted.

In FIG. 114, a point PEX11 to a point PEX13 on the region CYR13 represent positions at which pixels at the positions (X₃, Y₃)=(1, 0), (0, 1), and (1, 1) in the X₃Y₃ coordinate system of the third captured image are mapped by Equation (183). In addition, the point PEX14 on the region CYR13 represents an arbitrary point (Cx, Cy)=(Cx₀, Cy₀) in the CxCy coordinate system.

Here, if the mapping destination of the four points at the pixel positions (X₃, Y₃)=(0, 0), (0, 1), (1, 0), and (1, 1) on the third captured image by Equation (183) are positioned on a horizontal and vertical lattice pattern by some processing, the problem described above with reference to FIGS. 112 and 113 is solved. That is, a panoramic image in which the vertical and the horizontal directions are correctly projected can be acquired.

Thus, according to the present technology, image deformation processing for moving the mapping destinations (white circles in FIG. 114) of the four point at the pixel positions (X₃, Y₃)=(0, 0), (0, 1), (1, 0), and (1, 1) on the third captured image by Equation (183) to the positions (white circles in FIG. 115) as shown in FIG. 115 is performed on the panoramic image shown in FIG. 114.

In FIG. 115, the position of the point O_{3′} on the panoramic image is the same as the position in FIG. 114. That is, the position, on which the pixel at the position (X₃, Y₃)=(0, 0) as the center position of the third captured image is mapped, in the region CYR13 is not moved in the image deformation processing.

In addition, a point PEX21 to a point PEX23 on the region CYR13 represents movement destinations of the point PEX11 to the point PEX13 by the image deformation processing. That is, the point PEX11 to the point PEX13 are moved to the positions of the point PEX21 to the point PEX23 by the image deformation processing. Furthermore, the point PEX24 on the region CYR13 represents the movement destination of the point PEX14 by the image deformation processing.

If a new panoramic image shown in FIG. 115 acquired by performing such image deformation processing is output as a final panoramic image, it is possible to present a panoramic image with high quality, in which the vertical and the horizontal directions are correctly projected.

Since generation of the panoramic image shown in FIG. 115 from the panoramic image shown in FIG. 114 by the image deformation processing is a main idea of the present technology, the term is defined as follows in order to avoid confusion about which panoramic image the term indicates.

That is, a panoramic image corresponding to the panoramic image in FIG. 114, which is generated from N captured images, is referred to as a temporary panoramic image in the following description. In addition, a final panoramic image acquired by deforming the temporary panoramic image by the image deformation processing according to the present technology is referred to as a final panoramic image. That is, the panoramic image shown in FIG. 114 is a temporary panoramic image, and the panoramic image shown in FIG. 115 is a final panoramic image.

Now, the present technology will be specifically described below.

### (Idea Step No. 1)

First, in order to perform the image deformation processing (transformation processing) from the panoramic image in FIG. 114 to the panoramic image in FIG. 115, it is necessary to acquire where the center position (Xₛ, Yₛ)=(0, 0) of the s-th captured image is located on the temporary panoramic image.

In addition, it is also necessary to acquire which directions the Xₛ axis and the Yₛ axis of the s-th captured image are in, on the temporary panoramic image.

The aforementioned Equation (183) represents the corresponding position (Cx, Cy) on the temporary panoramic image when the position (Xₛ, Yₛ) of arbitrary s where s=1 to N is given. That is, Cx and Cy are functions of s, Xs, and Ys, respectively. Thus, in order to explicitly represent the fact, Cx and Cy will be described as in the following Equation (184).

$$\begin{matrix}[ Math . 184 ] & \\ \begin{matrix}Cx = Cx ( s , {X}_{s} , {Y}_{s} ) \\ Cy = Cy ( s , {X}_{s} , {Y}_{s} )\end{matrix} \} & ( 184 )\end{matrix}$$

In addition, Equation (184) (Equation (183)) is a function which can be fixed by image analysis on the captured images.

First, the center position (Xₛ, Yₛ)=(0, 0) of the s-th captured image is mapped at the position, which is represented by the following Equation (185), on the temporary panoramic image.

$$\begin{matrix}[ Math . 185 ] & \\ [ \begin{matrix}Cx ( s , 0 , 0 ) \\ Cy ( s , 0 , 0 )\end{matrix} ] & ( 185 )\end{matrix}$$

In addition, which directions the Xₛ axis and the Yₛ axis of the s-th captured image are on the temporary panoramic image are represented by the following Equation (186) and Equation (187), respectively.

$$\begin{matrix}[ Math . 186 ] & \\ [ \begin{matrix}\frac{\partial Cx}{\partial {X}_{s}} \\ \frac{\partial Cy}{\partial {X}_{s}}\end{matrix} ] {\vert}_{( Xs , Ys ) = ( 0 , 0 )} & ( 186 ) \\ [ Math . 187 ] & \\ [ \begin{matrix}\frac{\partial Cx}{\partial {Y}_{s}} \\ \frac{\partial Cy}{\partial {Y}_{s}}\end{matrix} ] {\vert}_{( Xs , Ys ) = ( 0 , 0 )} & ( 187 )\end{matrix}$$

### (Idea Step No. 2)

Next, which position on the final panoramic image an arbitrary point (Cx₀, Cy₀) on the temporary panoramic image is moved to by the image deformation processing according to the present technology will be considered.

When s=3, the point PEX14 in FIG. 114 represents the arbitrary point (Cx₀, Cy₀) on the temporary panoramic image, and the point PEX24 in FIG. 115 represents the position on the final panoramic image after moving the point (Cx₀, Cy₀).

In order to consider the movement, it is necessary to decompose the position (Cx₀, Cy₀) on the temporary panoramic image into a component in the direction in which the X₃ axis is mapped and a component in the direction in which the Y₃ axis is mapped. That is, α and β which satisfy the following Equation (188) are acquired for the arbitrary position (Cx₀, Cy₀).

$$\begin{matrix} [ Math . 188 ] & \\ [ \begin{matrix}{Cx}_{0} - Cx ( s , 0 , 0 ) \\ {Cy}_{0} - Cy ( s , 0 , 0 )\end{matrix} ] = α [ \begin{matrix}\frac{\partial Cx}{\partial {X}_{s}} \\ \frac{\partial Cy}{\partial {X}_{s}}\end{matrix} ] {\vert}_{( Xs , Ys ) = ( 0 , 0 )} + β [ \begin{matrix}\frac{\partial Cx}{\partial {Y}_{s}} \\ \frac{\partial Cy}{\partial {Y}_{s}}\end{matrix} ] {\vert}_{( Xs , Ys ) = ( 0 , 0 )} & ( 188 )\end{matrix}$$

Here, α is the amount of the component in the direction of the X₃ axis mapped on the temporary panoramic image, and β is the amount of the component in the direction of the Y₃ axis mapped on the temporary panoramic image.

Then, it is only necessary to move the position (Cx₀, Cy₀) to the position represented by the following Equation (189) by using α and β which satisfy Equation (188). That is, the position represented by Equation (189) is a position on the final panoramic image after moving the position (Cx₀, Cy₀).

$$\begin{matrix}[ Math . 189 ] & \\ [ \begin{matrix}Cx ( s , 0 , 0 ) + α \\ Cx ( s , 0 , 0 ) + β\end{matrix} ] & ( 189 )\end{matrix}$$

In addition, if Equation (188) is solved for α and β and the acquired α and β are substituted into Equation (189), the following Equation (190) is acquired.

$$\begin{matrix}[ Math . 190 ] & \\ [ \begin{matrix}Cx ( s , 0 , 0 ) + \frac{\begin{matrix}( {Cx}_{0} - Cx ( s , 0 , 0 ) ) \times ( \frac{\partial Cy}{\partial {Y}_{s}} {\vert}_{( Xs , Ys ) = ( 0 , 0 )} ) - \\ ( {Cy}_{0} - Cy ( s , 0 , 0 ) ) \times ( \frac{\partial Cx}{\partial {Y}_{s}} {\vert}_{( Xs , Ys ) = ( 0 , 0 )} )\end{matrix}}{\begin{matrix}( \frac{\partial Cx}{\partial {X}_{s}} {\vert}_{( Xs , Ys ) = ( 0 , 0 )} ) \times ( \frac{\partial Cy}{\partial {Y}_{s}} {\vert}_{( Xs , Ys ) = ( 0 , 0 )} ) - \\ ( \frac{\partial Cy}{\partial {X}_{s}} {\vert}_{( Xs , Ys ) = ( 0 , 0 )} ) \times ( \frac{\partial Cx}{\partial {Y}_{s}} {\vert}_{( Xs , Ys ) = ( 0 , 0 )} )\end{matrix}} \\ Cy ( s , 0 , 0 ) + \frac{\begin{matrix}- ( {Cx}_{0} - Cx ( s , 0 , 0 ) ) \times ( \frac{\partial Cy}{\partial {X}_{s}} {\vert}_{( Xs , Ys ) = ( 0 , 0 )} ) + \\ ( {Cy}_{0} - Cy ( s , 0 , 0 ) ) \times ( \frac{\partial Cx}{\partial {X}_{s}} {\vert}_{( Xs , Ys ) = ( 0 , 0 )} )\end{matrix}}{\begin{matrix}( \frac{\partial Cx}{\partial {X}_{s}} {\vert}_{( Xs , Ys ) = ( 0 , 0 )} ) \times ( \frac{\partial Cy}{\partial {Y}_{s}} {\vert}_{( Xs , Ys ) = ( 0 , 0 )} ) - \\ ( \frac{\partial Cy}{\partial {X}_{s}} {\vert}_{( Xs , Ys ) = ( 0 , 0 )} ) \times ( \frac{\partial Cx}{\partial {Y}_{s}} {\vert}_{( Xs , Ys ) = ( 0 , 0 )} )\end{matrix}}\end{matrix} ] & ( 190 )\end{matrix}$$

The thus acquired Equation (190) includes partial differentials of the function Cx and the function Cy by Xₛ and Yₛ. Since the function Cx and the function Cy are complicated equations, it is slightly difficult to acquire the partial differentials by the calculation. Thus, the partial differential values may be approximately acquired based on the movement amount by which the pixel position is moved by a significantly small amount (0.001 in Equation (191)) as represented by the following Equation (191).

$$\begin{matrix}[ Math . 191 ] & \\ \begin{matrix}\begin{matrix}\begin{matrix}\frac{\partial Cx}{\partial {X}_{s}} {\vert}_{( Xs , Ys ) = ( 0 , 0 )} = \frac{Cx ( s , 0.001 , 0 ) - Cx ( s , 0 , 0 )}{0.001} \\ \frac{\partial Cy}{\partial {X}_{s}} {\vert}_{( Xs , Ys ) = ( 0 , 0 )} = \frac{Cy ( s , 0.001 , 0 ) - Cy ( s , 0 , 0 )}{0.001}\end{matrix} \\ \frac{\partial Cx}{\partial {Y}_{s}} {\vert}_{( Xs , Ys ) = ( 0 , 0 )} = \frac{Cx ( s , 0 , 0.001 ) - Cx ( s , 0 , 0 )}{0.001}\end{matrix} \\ \frac{\partial Cy}{\partial {Y}_{s}} {\vert}_{( Xs , Ys ) = ( 0 , 0 )} = \frac{Cy ( s , 0 , 0.001 ) - Cy ( s , 0 , 0 )}{0.001}\end{matrix} & ( 191 )\end{matrix}$$

At each position (Cx₀, Cy₀) in the region, in which the s-th captured image is mapped, on the temporary panoramic image, the respective positions (points) may be moved by Equation (190).

### (Idea Step No. 3)

Next, how to deal with the boundary part between the t-th and the t+1-th captured images for arbitrary t (where t=1 to N−1) will be described.

At each position (Cx₀, Cy₀) in the region, in which the t-th captured image is mapped, on the temporary panoramic image, a position of the moving destination is acquired by a transformation equation acquired by substituting t into the variable s in Equation (190).

In contrast, at each position (Cx₀, Cy₀) in the region, in which the t+1-th captured image is mapped, on the temporary panoramic image, a position of the moving destination is acquired by a transformation equation acquired by substituting t+1 to the variable s in Equation (190).

Accordingly, the transformation equation for the t-th captured image differs from the transformation equation for the t+1-th captured image if any change is not made, a failure in the images occurs at the boundary part between the t-th and the t+1-th captured images.

Thus, the following weighted function is provided such that the transformation equation acquired by substituting t into the variable s in Equation (190) is gradually changed into the transformation equation acquired by substituting t+1 into the variable s in Equation (190).

That is, in the vicinity of the position, at which the center part (Xₜ, Yₜ)=(0, 0) of the t-th captured image, on the temporary panoramic image, transformation (image deformation processing) by the transformation equation acquired by substituting t into the variable s in Equation (190) is performed.

Then, transformation is gradually shifted from the transformation by the transformation equation acquired by substituting t into the variable s in Equation (190) to the transformation by the transformation equation acquired by substituting t+1 into the variable s in Equation (190) toward the position, at which the center part (Xₜ₊₁, Yₜ₊₁)=(0, 0) of the t+1-th captured image is mapped, on the temporary panoramic image.

Furthermore, it is only necessary to finally perform the transformation by the transformation equation acquired by substituting t+1 into the variable s in Equation (190) in the vicinity of the position, at which the center part (Xₜ₊₁, Yₜ₊₁)=(0, 0) of the t+1-th captured image is mapped, on the temporary panoramic image.

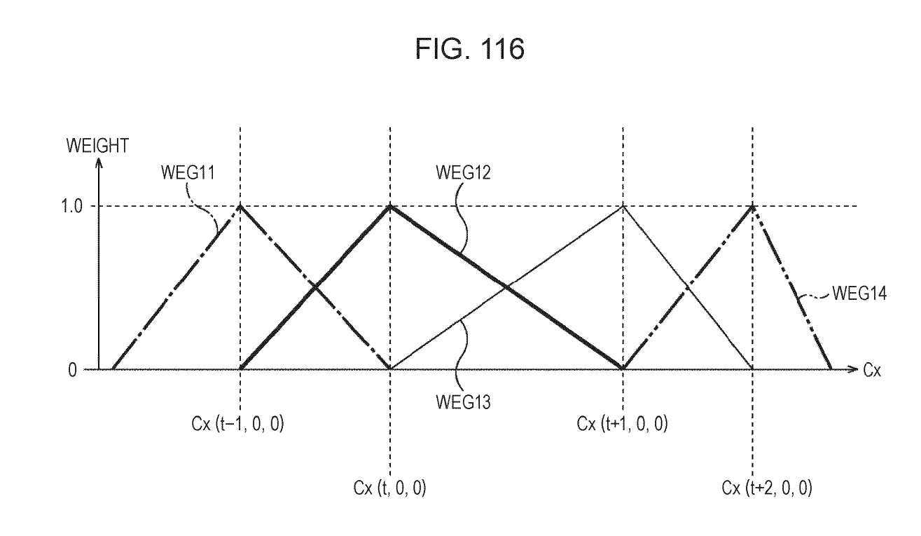

Specifically, it is only necessary to acquire the transformation equation by using the weight shown in FIG. 116, for example. In FIG. 116, the lateral direction and the longitudinal direction of the drawing represent the position in the Cx-axis direction on the temporary panoramic image and the size of weight, respectively.

In Example of FIG. 116, the polygonal curve WEG11 to the polygonal curve WEG14 represent weights at the respective positions of a transformation equation, which is acquired by substituting t−1, t, t+1, and t+2 into the variable s in Equation (190). In addition, a total of weights at the respective positions in the Cx-axis direction of the temporary panoramic image is constantly set to one at the respective positions. For example, the total value of weights represented by the polygonal curve WEG11 and the polygonal curve WEG12 is one at a position Cx=Cx(t−1,0,0) in the Cx-axis direction.

If attention is paid to the weight represented by the polygonal curve WEG12, the weight at the position Cx=Cx(t,0,0) on the temporary panoramic image, at which the center position of the t-th captured image is mapped, is one. In addition, the weight represented by the polygonal curve WEG12 linearly decreases toward the further side from the position Cx=Cx(t,0,0).

In the same manner as the weight represented by the polygonal curve WEG12, the weights represented by the polygonal curve WEG11, the polygonal curve WEG13, and the polygonal curve WEG14 are also linearly changed in accordance with positions on the temporary panoramic image.

In addition, since it is a matter of course that no captured image is present on the left side (on the side of the −Cx axis) of the first captured image, the weight of the transformation equation acquired by substituting one into the variable s in Equation (190) becomes one in the vicinity of the end of the temporary panoramic image.

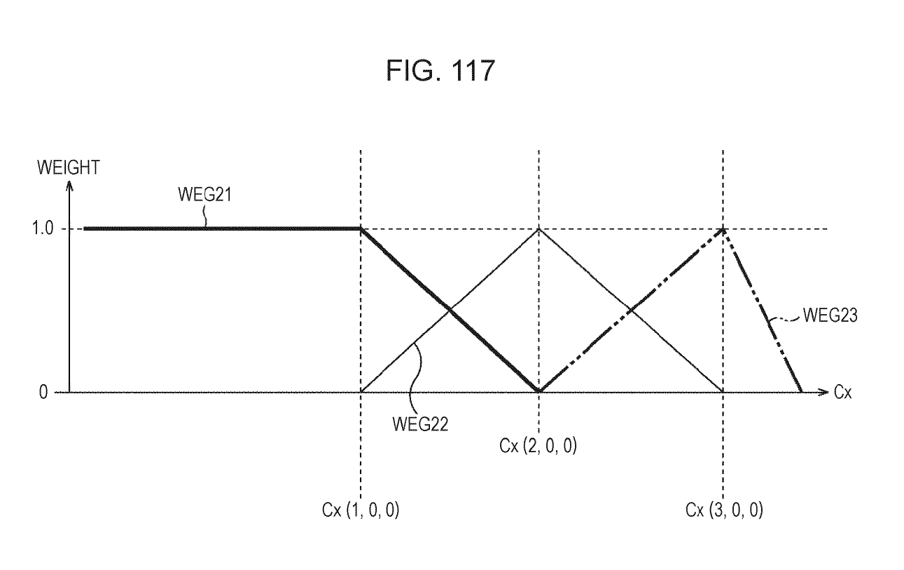

In FIG. 117, the lateral direction and the longitudinal direction of the drawing represent the position in the Cx-axis direction on the temporary panoramic image and the size of the weight, respectively.

In the example of FIG. 117, the polygonal curve WEG21 to the polygonal curve WEG23 represent weights at the respective positions of the transformation equations acquired by substituting 1, 2, and 3 into the variable s in Equation (190). In addition, a total of weights at the respective positions in the Cx-axis direction of the temporary panoramic image is constantly set to one at the respective positions.

If attention is paid to the weight represented by the polygonal curve WEG21, the weight is one at a position on the left side from the position Cx=Cx(1,0,0) on the temporary panoramic image, at which the center position of the first captured image is mapped, in the drawing.

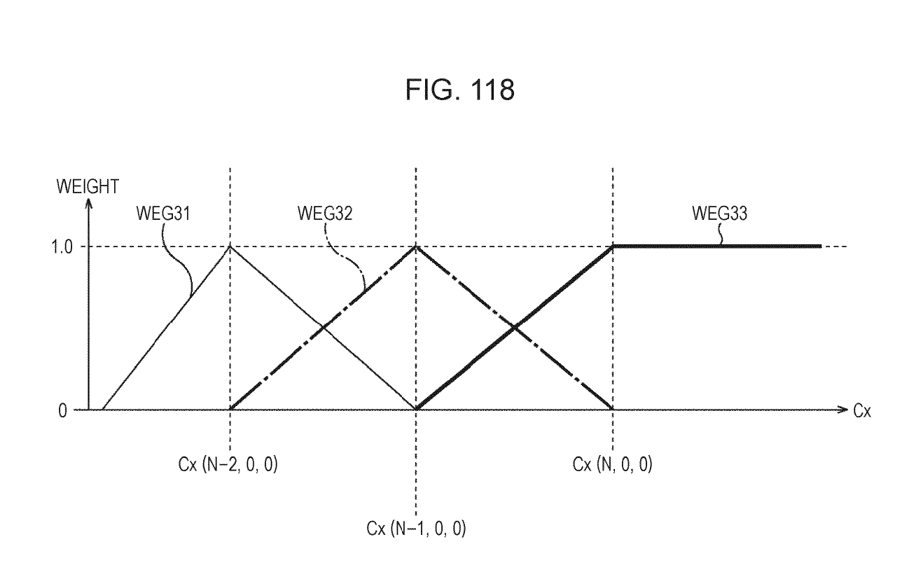

Similarly, since there is no captured image on the right side (the side of the +Cx axis) of the N-th captured image, the weight of the transformation equation acquired by setting the variable s in Equation (190) to N becomes one in the vicinity of the end of the temporary panoramic image as shown in FIG. 118.

In FIG. 118, the lateral direction and the longitudinal direction of the drawing represent the position in the Cx-axis direction on the temporary panoramic image and the size of the weight, respectively.

In the example of FIG. 118, the polygonal curve WEG31 to the polygonal curve WEG33 represent weights at the respective positions of transformation equations acquired by substituting N−2, N−1, and N into the variable s in Equation (190). In addition, the total of the weights at the respective positions in the Cx-axis direction of the temporary panoramic image is constantly set to one at the respective positions.

If attention is paid to the weight represented by the polygonal curve WEG33, the weight is one at a position on the right side from the position Cx=Cx(N,0,0) on the temporary panoramic image, at which the center position of the N-th captured image is mapped, in the drawing.

The weight of the transformation equation in Equation (190) described above is represented by the following Equation (192).

$$\begin{matrix} [ Math . 192 ] & \\ {W}_{t} ( Cx , Cy ) = \{ \begin{matrix}1 & ( \begin{matrix}when t = 1 , \\ Cx < Cx ( 1 , 0 , 0 )\end{matrix} ) \\ 0 & ( \begin{matrix}when 2 \leq t , \\ Cx < Cx ( t - 1 , 0 , 0 )\end{matrix} ) \\ \frac{Cx - Cx ( t - 1 , 0 , 0 )}{Cx ( t , 0 , 0 ) - Cx ( t - 1 , 0 , 0 )} & ( \begin{matrix}when 2 \leq t , \\ Cx ( t - 1 , 0 , 0 ) \leq \\ Cx < Cx ( t , 0 , 0 )\end{matrix} ) \\ \frac{Cx ( t + 1 , 0 , 0 ) - Cx}{Cx ( t + 1 , 0 , 0 ) - Cx ( t , 0 , 0 )} & ( \begin{matrix}\begin{matrix}when t \leq N - 1 , \\ Cx ( t , 0 , 0 ) \leq Cx <\end{matrix} \\ Cx ( T + 1 , 0 , 0 )\end{matrix} ) \\ 0 & ( \begin{matrix}when t \leq N - 1 , \\ Cx ( t + 1 , 0 , 0 ) \leq Cx\end{matrix} ) \\ 1 & ( when t = N , Cx ( N , 0 , 0 ) \leq Cx )\end{matrix} & ( 192 )\end{matrix}$$

Equation (192) represents a weight Wₜ(Cx, Cy) of the transformation equation acquired by substituting t into the variable s in Equation (190) in relation to the image deformation processing at the position (Cx, Cy) on the temporary panoramic image.

The weight Wₜ(Cx, Cy) is a value determined by Cx, t, Cx(t−1,0,0), Cx(t,0,0), and Cx(t+1,0,0) and does not depend on Cy.

Accordingly, it is only necessary to generate the final panoramic image by copying (mapping) the pixel value of the pixel located at the position (Cx, Cy)=(Cx₀, Cy₀) on the temporary panoramic image at the position, which is represented by the following Equation (193), on the final panoramic image.

$$\begin{matrix} [ Math . 193 ] & \\ {\sum }_{s = 1}^{N} {W}_{s} ( {Cx}_{0} , {Cy}_{0} ) \times ( \begin{matrix}Cx ( s , 0 , 0 ) + \frac{\begin{matrix}( {Cx}_{0} - Cx ( s , 0 , 0 ) ) \times ( \frac{\partial Cy}{\partial {Y}_{s}} {\vert}_{( Xs , Ys ) = ( 0 , 0 )} ) - \\ ( {Cy}_{0} - Cy ( s , 0 , 0 ) ) \times ( \frac{\partial Cx}{\partial {Y}_{s}} {\vert}_{( Xs , Ys ) = ( 0 , 0 )} )\end{matrix}}{\begin{matrix}( \frac{\partial Cx}{\partial {X}_{s}} {\vert}_{( Xs , Ys ) = ( 0 , 0 )} ) \times ( \frac{\partial Cy}{\partial {Y}_{s}} {\vert}_{( Xs , Ys ) = ( 0 , 0 )} ) - \\ ( \frac{\partial Cy}{\partial {X}_{s}} {\vert}_{( Xs , Ys ) = ( 0 , 0 )} ) \times ( \frac{\partial Cx}{\partial {Y}_{s}} {\vert}_{( Xs , Ys ) = ( 0 , 0 )} )\end{matrix}} \\ Cy ( s , 0 , 0 ) + \frac{\begin{matrix}- ( {Cx}_{0} - Cx ( s , 0 , 0 ) ) \times ( \frac{\partial Cy}{\partial {X}_{s}} {\vert}_{( Xs , Ys ) = ( 0 , 0 )} ) + \\ ( {Cy}_{0} - Cy ( s , 0 , 0 ) ) \times ( \frac{\partial Cx}{\partial {X}_{s}} {\vert}_{( Xs , Ys ) = ( 0 , 0 )} )\end{matrix}}{\begin{matrix}( \frac{\partial Cx}{\partial {X}_{s}} {\vert}_{( Xs , Ys ) = ( 0 , 0 )} ) \times ( \frac{\partial Cy}{\partial {Y}_{s}} {\vert}_{( Xs , Ys ) = ( 0 , 0 )} ) - \\ ( \frac{\partial Cy}{\partial {X}_{s}} {\vert}_{( Xs , Ys ) = ( 0 , 0 )} ) \times ( \frac{\partial Cx}{\partial {Y}_{s}} {\vert}_{( Xs , Ys ) = ( 0 , 0 )} )\end{matrix}}\end{matrix} ) & ( 193 )\end{matrix}$$

That is, the transformation equation represented by Equation (193) is a transformation equation acquired by performing weighted addition of the transformation equation for every variable s represented by Equation (190) by the weight Wₜ(Cx, Cy) for each position represented by Equation (192).

### [Configuration Example of Image Processing Apparatus]

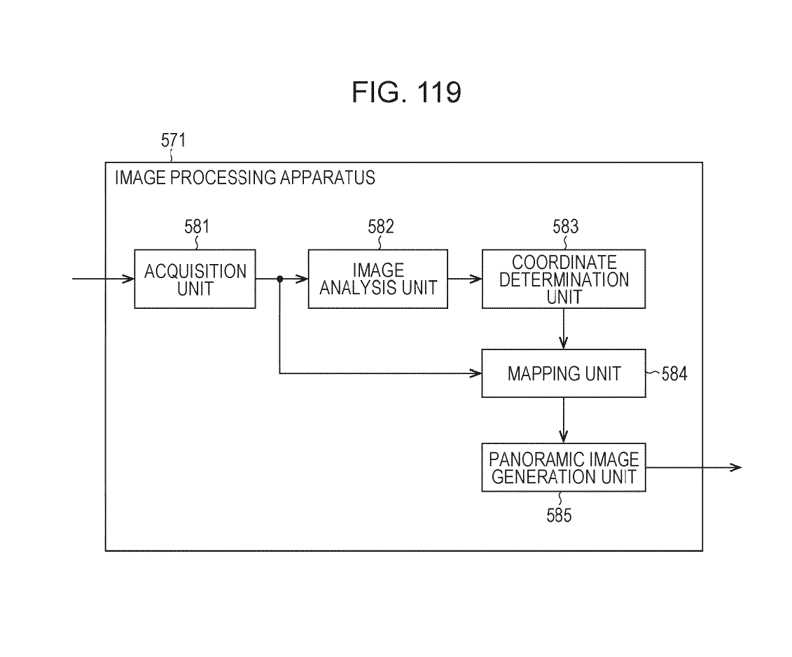

Next, description will be given of a specific embodiment to which the present technology is applied. FIG. 119 is a diagram showing a configuration example of an embodiment of an imaging processing apparatus to which the present technology is applied.

An image processing apparatus 571 in FIG. 119 is configured of an acquisition unit 581, an image analysis unit 582, a coordinate determination unit 583, a mapping unit 584, and a panoramic image generation unit 585.

The acquisition unit 581 acquires N captured images which an imaging device such as a digital camera successively captures while being rotated, and focal distances F of the respective captured images and supplies the captured images and the focal distances F to the image analysis unit 582 and the mapping unit 584.

The image analysis unit 582 performs image analysis based on the captured images and the focal distances supplied from the acquisition unit 581, acquires the homogeneous transformation matrixes H_{s,s+1} representing positional relationships between the captured images, and supplies the homogeneous transformation matrixes H_{s,s+1} to the coordinate determination unit 583. The coordinate determination unit 583 determines a world coordinate system based on the homogeneous transformation matrixes H_{s,s+1} supplied from the image analysis unit 582, calculates the homogeneous transformation matrixes H_{w,s} representing the positional relationships between the respective captured images and the world coordinate system, and supplies the homogeneous transformation matrixes H_{w,s} to the mapping unit 584.

The mapping unit 584 generates a temporary panoramic image based on the homogeneous transformation matrixes H_{w,s} supplied from the coordinate determination unit 583 and the captured images and the focal distances supplied from the acquisition unit 581. The mapping unit 584 supplies the generated temporary panoramic image, the homogeneous transformation matrixes H_{w,s}, and the focal distances to the panoramic image generation unit 585.

The panoramic image generation unit 585 generates a final panoramic image based on the temporary panoramic image, the homogeneous transformation matrixes H_{w,s}, and the focal distances supplied from the mapping unit 584 and outputs the final panoramic image.

### [Description of Panoramic Image Generation Processing]

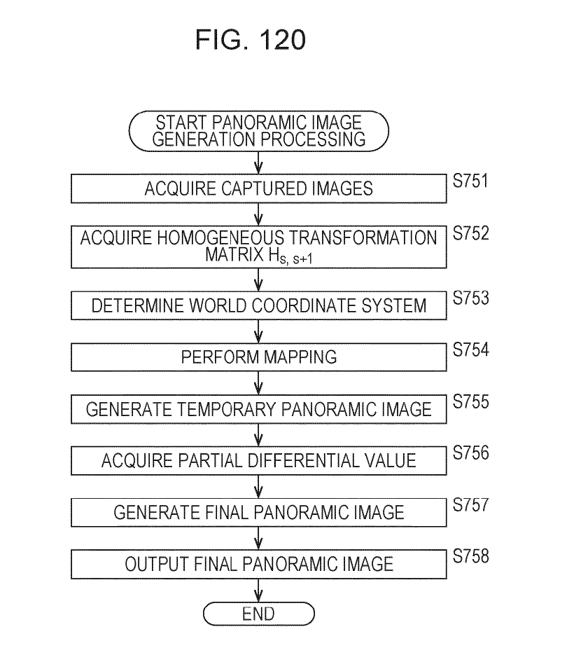

Next, description will be given of panoramic image generation unit by the image processing apparatus 571 with reference to the flowchart in FIG. 120.

In Step S751, the acquisition unit 581 acquires N captured images and focal distances F of the respective captured images and supplies the captured images and the focal distances F to the image analysis unit 582 and the mapping unit 584.

In Step S752, the image analysis unit 582 performs image analysis on the adjacent captured images based on the captured images and the focal distances supplied from the acquisition unit 581, acquires the homogeneous transformation matrixes H_{s,s+1} representing correspondence relationships of an object projected to the captured images, and supplies the homogeneous transformation matrixes H_{s,s+1} to the coordinate determination unit 583.

In Step S753, the coordinate determination unit 583 determines a world coordinate system based on the homogeneous transformation matrixes H_{s,s+1} supplied from the image analysis unit 582.

That is, the coordinate determination unit 583 acquires a straight line which is substantially vertical to the Xₛ-axis direction (where s=1 to N) of the N-th captured image to the maximum extent, and regards, as the world coordinate system, a coordinate system which has the optical axis center of the image device as an origin O and includes the Y_{w}-axis direction in the direction of the acquired straight line.

In addition, the coordinate determination unit 583 regards the positional relationship of the first captured image in the world coordinate system as the homogeneous transformation matrix H_{w,1} and performs the calculation of Equation (179) to calculate homogeneous transformation matrix H_{w,s} (where s=1 to N) as positional relationships between the s-th captured image and the world coordinate system. The coordinate determination unit 583 supplies the calculated homogeneous transformation matrix H_{w,s} to the mapping unit 584.

In Step S754, the mapping unit 584 performs mapping of the captured images on the cylindrical surface based on the homogeneous transformation matrix H_{w,s} supplied from the coordinate determination unit 583 and the captured images and the focal distances F supplied from the acquisition unit 581.

That is, the mapping unit 584 maps the pixel value of the pixel located at the position (Xₛ, Yₛ) in the XₛYₛ coordinate system of the s-th captured image (where s=1 to N), at the position (Cx, Cy), which is represented by Equation (183), on the cylindrical surface of the radius F around the Y_{w} axis as a center in the world coordinate system.

In Step S755, the mapping unit 584 regards the image acquired by deploying the cylindrical surface on which the pixel values are mapped as a temporary panoramic image, and supplies the temporary panoramic image, the homogeneous transformation matrix H_{w,s}, and the focal distances F to the panoramic image generation unit 585.

In Step S756, the panoramic image generation unit 585 acquires partial differential values.

That is, the panoramic image generation unit 585 fixes the value of Equation (185) by solving Equation (183) at the position (Xₛ, Yₛ)=(0, 0) for each s (where s=1 to N) based on the homogeneous transformation matrix H_{w,s} and the focal distances F supplied from the mapping unit 584.

Here, the position (Xₛ, Yₛ)=(0, 0) is the center position of the s-th captured image in the XₛYₛ coordinate system. With such a configuration, a position of the moving destination (mapping destination) of the center position (Xₛ, Yₛ)=(0, 0) of the s-th captured image on the temporary panoramic image is acquired.

In addition, the panoramic image generation unit 585 fixes the value of Equation (191) by solving Equation (183) at the position (Xₛ, Yₛ)=(0, 0), solving Equation (183) at the position (Xₛ, Yₛ)=(0.001, 0), and solving Equation (183) at the position (Xₛ, Yₛ)=(0, 0.001) for each s (where s=1 to N) based on the homogeneous transformation matrix H_{w,s} and the focal distances F. With such processing, the respective partial differential values represented by Equation (191) are acquired.

In Step S757, the panoramic image generation unit 585 generates a final panoramic image based on the position of the mapping destination for the center position of the captured image and the partial differential values, which are acquired in Step S756, and the temporary panoramic image supplied from the mapping unit 584.

That is, the panoramic image generation unit 585 copies (maps) pixel values of pixels at all the positions (Cx, Cy)=(Cx₀, Cy₀) on the temporary panoramic image, at positions determined, which are acquired by the calculation of Equation (193), on the final panoramic image which is to be generated.

That is, the panoramic image generation unit 585 generates the final panoramic image by regarding the pixel values of the pixels located at the positions (Cx₀, Cy₀) on the temporary panoramic image as pixel values of pixels at positions on the final panoramic image, which are acquired by substituting the positions (Cx₀, Cy₀) into Equation (193). The processing in Step S756 and Step S757 is the image deformation processing performed on the temporary panoramic image.

In Step S758, the panoramic image generation unit 585 outputs the generated final panoramic image, and the panoramic image generation processing is completed.

As described above, the imaging processing apparatus 571 acquires the positional relationships between the world coordinate system and the respective captured images from the plurality of captured images which are successively captured, and generates the temporary panoramic image. Then, the image processing apparatus 571 performs the image deformation processing on the acquired temporary panoramic image and generates the final panoramic image.

By performing the image deformation processing on the temporary panoramic image as described above, it is possible to acquire a panoramic image with high quality, in which the vertical and the horizontal directions are correctly projected.

Although the above description was given in which the lateral axes (Xₛ axes) and the longitudinal axes (Yₛ axes) of the respective captured images (s-th captured image) were corrected on the panoramic image by the image deformation processing, it is also possible to correct only the lateral axes (Xₛ axes) of the respective captured images (s-th captured image), for example, without performing the correction of the longitudinal axes (Yₛ axes) when it is desirable to reduce the processing amount.

That is, the partial differential value of Cy by Yₛ is forcedly set to one, and the partial differential value of Cx by Xₛ is forcedly set to zero in Equation (190) and Equation (193). With such processing, it is possible to reduce the processing amount.

Alternatively, when it is desirable to reduce the processing amount, it is also possible to correct only the longitudinal axes (Yₛ axes) of the respective captured images (s-th captured image) without correcting the lateral axes (Xₛ axes). That is, the partial differential value of Cx by Xₛ is forcedly set to one, and the partial differential value of Cy by Yₛ is forcedly set to zero in Equation (190) and Equation (193). With such processing, it is possible to reduce the processing amount. As described above, a considerable improvement effect is observed merely by correcting only the axes on one side.

Furthermore, according to the present technology, it is possible to examine which direction at least one of the lateral axis and the longitudinal axis of each captured image is mapped in on the temporary panoramic image as can be understood from the aforementioned embodiment.

In addition, the image deformation processing is applied such that the direction becomes a correct direction. Furthermore, the image deformation processing which is optimal for the s-th captured image is performed on a region, in which the center part of the s-th captured image is used, on the temporary panoramic image. In addition, the image deformation processing is gradually changed from the image deformation processing optimal which is optimal for the s-th captured image to the image deformation processing which is optimal for the t-th captured image as regions shift from the region where the center part of the s-th captured image is used to the region where the center part of the t-th captured image is used.

Although the above description was made in which the image deformation processing was performed on the panoramic image (temporary panoramic image) generated once, the temporary panoramic image is data which is temporarily generated in the course of the processing according to the present technology and is not presented to the user in actual processing.

In addition, the present technology described in the thirteenth embodiment can be configured as follows.

[1] An image processing method for generating a panoramic image based on a plurality of captured images acquired by an imaging device capturing images in a plurality of directions, the method including:

a positional relationship calculation step in which positional relationships between captured images are acquired;

a direction calculation step in which a direction corresponding to a lateral axis or a longitudinal axis of each captured image on a virtual panoramic image acquired by connecting the captured images based on the positional relationships between the captured images is calculated for at least one of the lateral axis and the longitudinal axis of each captured image;

a deformation function calculation step in which a deformation function for deforming the direction calculated in the direction calculation step into a horizontal direction or a vertical direction; and

a panoramic image generation step in which the panoramic image is generated by connecting the captured images based on the positional relationships between the captured images and the deformation function.

[2] The image processing method according to [1],

wherein in the panoramic image generation step, the panoramic image is generated while a weight of the deformation function is changed depending on positions on the panoramic image.

[Lens Distortion Amount Detection from Relationship of Turning]

### Fourteenth Embodiment

### Concerning Lens Distortion

In addition, when imaging is performed while an imaging device is rotated, lens distortion may be detected from the acquired captured images.

In a case of captured images captured by an imaging device such as a digital camera, for example, the images are distorted due to lens distortion. Thus, lens distortion correction by image processing is generally performed.

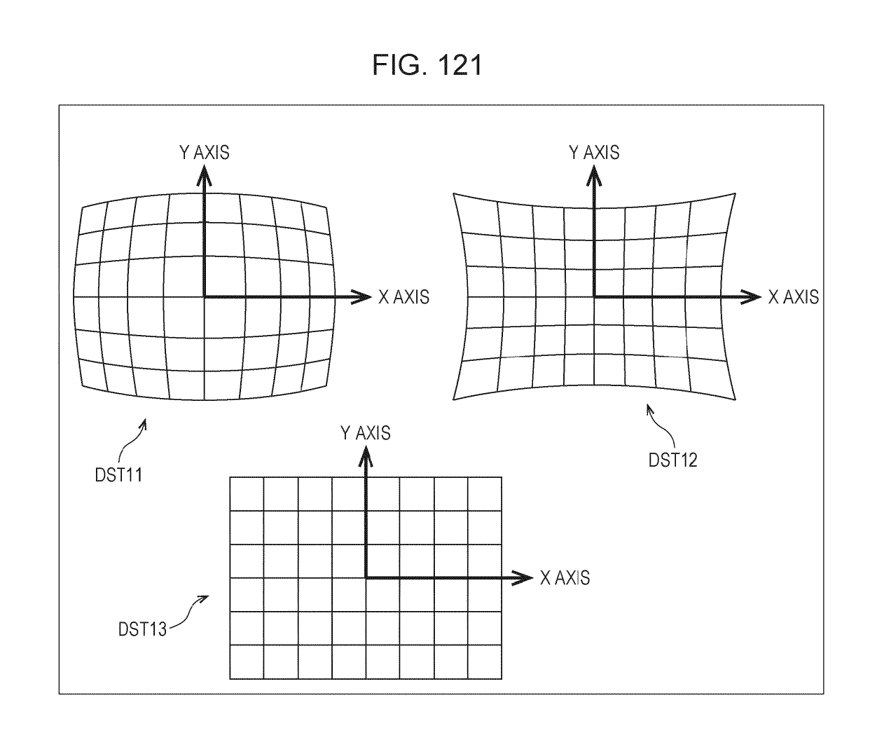

When an object with a square lattice pattern is captured as shown in FIG. 121, for example, a captured image distorted as shown by the arrow DST11 is acquired if the imaging is performed with a lens including barrel-shaped distortion. In addition, a captured image distorted as shown by the arrow DST12 is acquired if the imaging is performed with a lens including bobbin-shaped distortion.

Since the square lattice is formed by longitudinal and lateral straight lines, it is desirable that the respective lines configuring the square lattice as the object be straight lines even on the captured image which is acquired by imaging the square lattice.

Thus, in distortion correction, these captured images are deformed into the captured image represented by the arrow DST13 by performing image processing, more specifically, image deformation processing on the captured images represented with the arrows DST11 and the DST12. In relation to the captured image represented with the arrow DST13, the square lattice pattern captured as the object correctly appears in a square lattice shape even on the captured image.

It is possible to provide a desirable captured image with no distortion to user by performing such distortion correction.

Incidentally, such image deformation processing requires an input of a parameter relating to how much an image on the captured image is distorted (lens distortion parameter).

Since lenses generally have individual differences, and the lens distortion parameter differs depending on the lenses. For this reason, a method of automatically acquiring the lens distortion parameter from the captured image which is actually captured by using the lens is required.

A method of acquiring the lens distortion parameter is described in “H. S. Sawhney and R. Kumar, “True multi-image alignment and its application to mosaicing and lens distortion correction,” IEEE Transactions on Pattern Analysis and Machine Intelligence, vol. 21, no. 3, pp. 235243, March 1999”, for example.

According to this article, a plurality of captured images are captured by a camera first, and corresponding positions in the captured images are acquired. Then, parallel movement components between images (translation parameters in the article), affine transformation components between images (affine parameters in the article), and lens distortion parameters (cubic term of radial distortion) are acquired from the positional relationship.

Since the problem is complicated, an idea of roughly acquiring a low-resolution image and then acquiring a high-resolution image with high precision (idea IDE1) and an idea of separately acquiring, in an order, the parallel movement components, the affine transformation components, and the lens distortion parameters (idea IDE2) are introduced.

Although the lens distortion parameters are acquired by the idea IDE1 and the idea IDE2 as described above in the article, the processing amount is huge, and it takes excessive time to perform the calculation even if such ideas are implemented.

The present technology was made in view of such circumstances, and is designed to enable more quick acquisition of lens distortion.

### [Overview of Present Technology]

Next, description will be given of overview of the present technology.

First, two important characteristics of the present technology will be described.

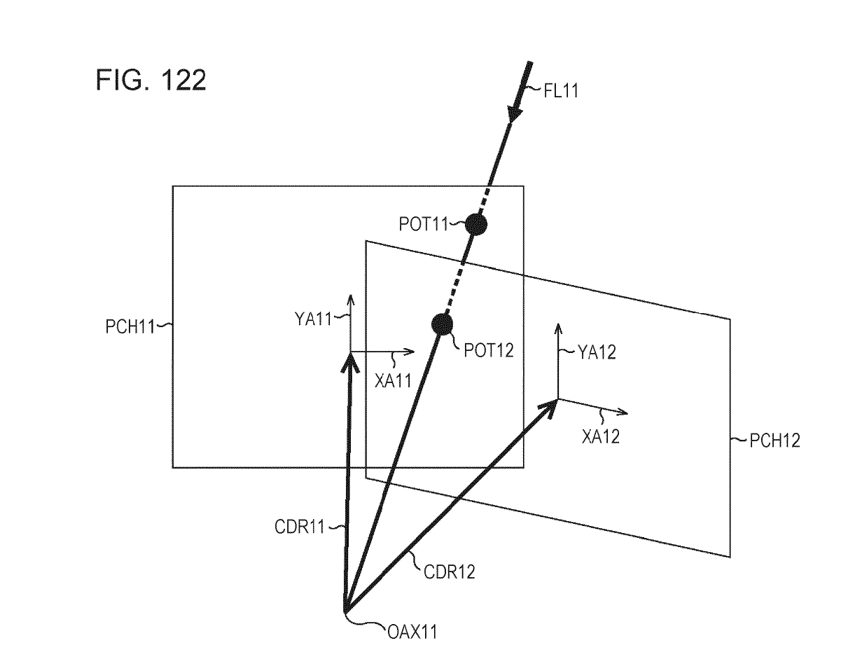

A positional relationship between two images captured in different imaging directions as shown in FIG. 122, for example, will be considered. In the drawing, the point OAX11 represents a position of an optical axis center of the imaging device which captures the two captured images.

In FIG. 122, it is assumed that the first captured image is an image acquired by capturing the image in a direction represented by the arrow CDR11 from the point OAX11. In addition, it is assumed that the second captured image is an image acquired by capturing the image in a direction represented by the arrow CDR12 from the point OAX11.

At this time, light emitted from a direction represented by the arrow FL11 toward the point OAX11 (light emitted from an object) is projected at a position POT11 on a screen PCH11, to which the captured image is projected, when the first captured image is captured.

In addition, light emitted from a direction represented by the arrow FL11 toward the point OAX11 (light emitted from the object) is projected at a position POT12 on a screen PCH12, to which the captured image is projected, when the second captured image is captured.

Accordingly, the projected image at the position POT11 on the first captured image and the projected image at the position POT12 on the second captured image are images of the same object.

In addition, XA11 and YA11 in the drawing represents an X axis and a Y axis for representing a coordinate system of the screen PCH11. Similarly, XA12 and YA12 represent an X axis and a Y axis for representing a coordinate system of the screen PCH12.

Between the two captured images which are captured as described above, the relationship between the corresponding points (positions at which the same object is projected) can generally be expressed by a homogeneous transformation matrix (homography) H_{1,2}. That is, the relationship is represented by the following Equation (194).

[Math. 194]

V₁∝H_{1,2}V₂ (194)

Here, V₁ and V₂ in Equation (194) represent positions on the first and the second captured images, and V₁ and V₂ are expressed by same-order coordinates (homogeneous coordinates). That is, V₁ and V₂ are three-dimensional vertical vectors, each of which is configured of three elements, namely an X coordinate of the captured image on the first row, a Y coordinate of the captured image on the second row, and “1” on the third row. In addition, the homogeneous transformation matrix H_{1,2} is a 3×3 matrix which represents the positional relationship between the first and the second captured images.

In addition, the homogeneous transformation matrix H_{1,2} can be acquired by analyzing the first captured image and the second captured image.

Specifically, pixel positions on the second captured image, which correspond to pixel positions of at least four or more points, for example, M points (Xa₍ₖ₎, Ya₍ₖ₎ (where k=1 to M) on the first captured image are acquired. That is, it is possible to consider small regions around pixels located at the centers thereof on the first captured image and to search for regions, which are to be matched with the small regions, in the second captured image.

Such processing is generally called block matching. With such processing, pixel positions (Xa₍ₖ₎, Ya₍ₖ₎ in the first captured image and pixel positions (Xb₍ₖ₎, Yb₍ₖ₎ in the second captured image, which correspond to the pixel positions (Xa₍ₖ₎, Ya₍ₖ₎, are acquired. Here, k=1 to M.

Thus, it is only necessary to express these positions by same-order coordinates and to acquire a matrix H_{1,2} which satisfies Equation (194). Since a method of acquiring a homogeneous transformation matrix by analyzing two images as described above is known, the detailed description thereof will be omitted.

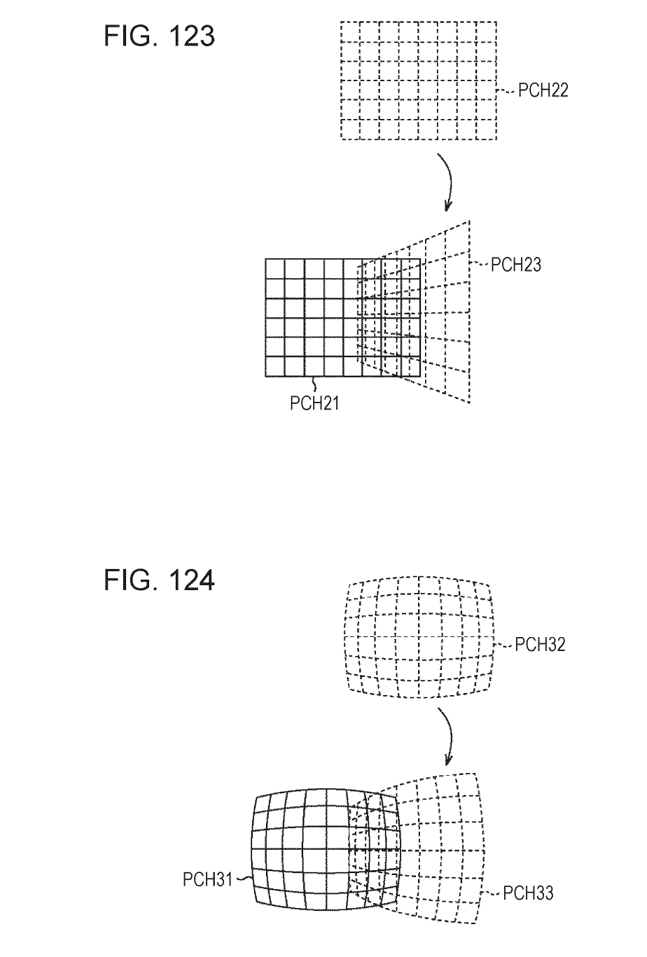

Incidentally, description will be continued on the assumption that there is no distortion. Now, it is assumed that a homogeneous transformation matrix Hi_{1,2} as the positional relationship between the first captured image PCH21 and the second captured image PCH22 is acquired by image analysis as shown in FIG. 123. In addition, the index “i” of the homogeneous transformation matrix Hi_{1,2} means an ideal state (ideal) without including any distortion.

That is, the matrix Hi_{1,2} which satisfies the following Equation (195) is acquired by the correspondence relationship between projected images which appear on the captured image PCH21 and on the captured image PCH22.

[Math. 195]

V₁∝Hi_{1,2}V₂ (195)

Then, if all positions on the second captured image PCH22 are transformed by Equation (195) and the second captured image PCH22 is mapped on the first captured image PCH21 (two-dimensional plane), a captured image PCH23 is acquired.

In addition, the captured image PCH21 and the captured image PCH22 are illustrated to have square lattice patterns for improving visualization. Furthermore, the second captured image PCH22 is represented by a dotted line. The captured image PCH23 is shown in a state where the square lattice pattern is deformed by Equation (195). By overlapping the captured image PCH21 and the captured image PCH23, the projected images projected at the respective positions completely coincide with each other.

Next, a case where there is barrel-shaped distortion will be considered. As shown in FIG. 124, a homogeneous transformation matrix Hb_{1,2} as a positional relationship between the first captured image PCH31 and the second captured image PCH32 is acquired by image analysis.

That is, the homogeneous transformation matrix Hb_{1,2} which satisfies the following Equation (196) is acquired from a correspondence relationship between projected images which appear on the captured image PCH31 and the captured image PCH32. The index “b” of the matrix Hb_{1,2} means barrel-shaped distortion (barrel). Since the distortion is non-linear in this case, it is not possible to completely satisfy the correspondence relationship of the projected images, and a homogeneous transformation matrix which satisfies the correspondence relationship to the maximum extent is acquired.

[Math. 196]

V₁∝Hb_{1,2}V₂ (196)

Then, if all positions on the second captured image PCH32 are transformed by Equation (196) and the second captured image PCH32 is mapped on the first captured image PCH31 (two-dimensional plane), the captured image PCH33 is acquired.

In addition, the captured image PCH31 and the captured image PCH32 are illustrated to have square lattice patterns including barrel-shaped distortion for improving visualization. Furthermore, the second captured image PCH32 is represented by a dotted line. The captured image PCH33 is shown in a state where the square lattice pattern including the barrel-shaped distortion is deformed by Equation (196). By overlapping the captured image PCH31 and the captured image PCH33, the projected images projected at the respective positions substantially coincide with each other.

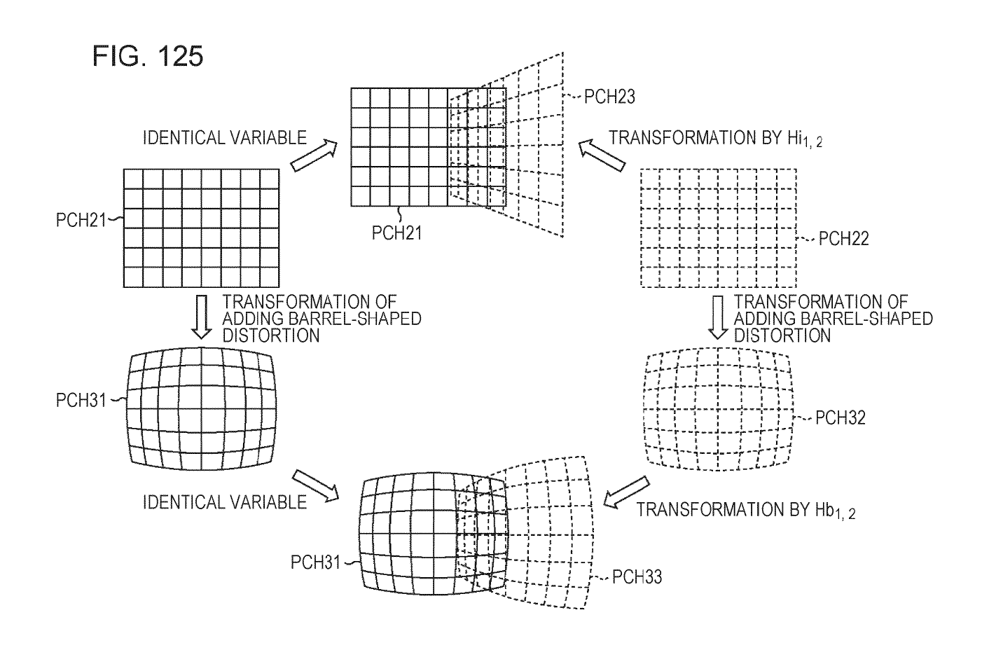

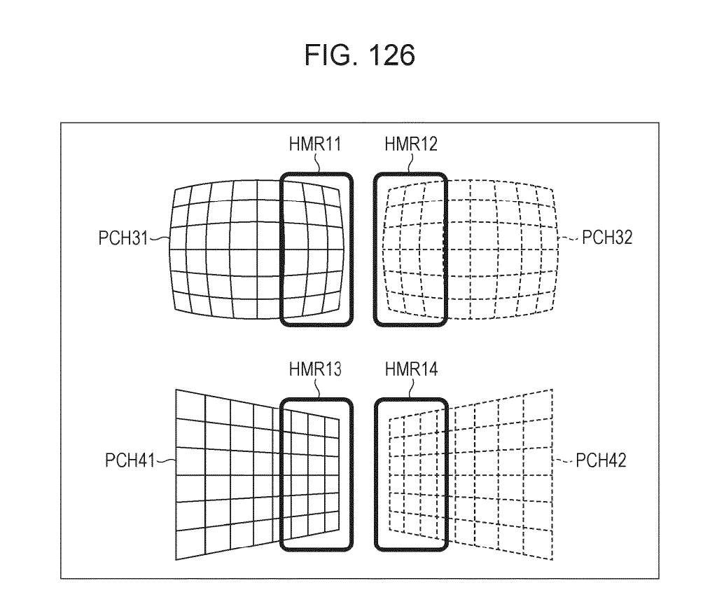

The above descriptions are summarized as shown in FIG. 125. In FIG. 125, the same reference numerals are given to parts corresponding to those in FIG. 123 or 124, and the description thereof will be omitted. Although the captured images image PCH21 and the captured image PCH31 are respectively shown at two locations in FIG. 125, they are captured images transformed by identical transformation and are the same, and therefore, the same reference numerals are applied.

In FIG. 125, if the captured image PCH23 which is acquired by deforming the second captured image PCH22 without including any distortion by the homogeneous transformation matrix Hi_{1,2} overlaps with the first captured image PCH21 without including any distortion, the projected images projected at the respective positions coincide with each other. In other words, transformation by which the projected images coincide with each other is acquired as the homogeneous transformation matrix Hi_{1,2}.

In addition, if barrel-shaped distortion is applied to the first captured image PCH21 without including any distortion, the first captured image PCH31 including the barrel-shaped distortion is acquired. Similarly, if barrel-shaped distortion is applied to the second captured image PCH22 without including any distortion, the second captured image PCH32 including the barrel-shaped distortion is acquired.

If the captured image PCH33 which is acquired by deforming the second captured image PCH32 including the barrel-shaped distortion overlaps with the first captured image PCH31 including the barrel-shaped distortion, the projected images projected at the respective positions substantially coincide with each other. In other words, transformation by which the projected images substantially coincide is acquired as the homogeneous transformation matrix Hb_{1,2}.

Here, attention is paid to a projected image which is projected to an arbitrary position W₂ (expressed by a same-order coordinates) on the second captured image PCH22 without including any distortion. The same projected image is located at a position, which is represented by the following Equation (197), on the first captured image PCH21 without including any distortion.

[Math. 197]

Hi_{1,2}W₂ (197)

When transformation for applying the barrel-shaped distortion is represented as D (transformation function D), the position, which is represented by Equation (197), on the first captured image PCH21 without including any distortion corresponds to a position, which is represented by the following Equation (198), on the first captured image PCH31 including the barrel-shaped distortion. Accordingly, the same projected image as the target projected image is located at a position, which is represented by Equation (198), on the first captured image PCH31 including the barrel-shaped distortion.

[Math. 198]

D(Hi_{1,2}W₂) (198)

In addition, the position W₂ on the second captured image PCH22 without including any distortion corresponds to a position, which is represented by the following Equation (199), on the second captured image PCH32 including the barrel-shaped distortion. Accordingly, the same projected image as the target projected image is located at the position, which is represented by Equation (199), on the second captured image PCH32 including the barrel-shaped distortion.

[Math. 199]

D(W₂) (199)

Furthermore, a position, which is represented by Equation (199), on the second captured image 32 including the barrel-shaped distortion corresponds to a position, which is represented by the following Equation (200), on the first captured image PCH31 including the barrel-shaped distortion. Accordingly, the same projected image as the target projected image is located at the position, which is represented by Equation (200), on the first captured image PCH31 including the barrel-shaped distortion.

[Math. 200]

Hb_{1,2}D(W₂) (200)

Since the aforementioned Equation (198) and Equation (200) are supposed to be constantly equal to each other at an arbitrary position W₂, the following Equation (201) is established for the arbitrary position W₂.

[Math. 201]

D(Hi_{1,2}W₂)∝Hb_{1,2}D(W₂) (201)

Equation (201) represents relationship of the transformation function D for applying the barrel-shaped distortion, the homogeneous transformation matrix Hi_{1,2}, and the homogeneous transformation matrix Hb_{1,2}.

As can been understood from the imaging condition in FIG. 122, a region in the first captured image, which is used for acquiring the homogeneous transformation matrix Hb_{1,2} by the image analysis, corresponds to a part on the right side in FIG. 122, and a region in the second captured image corresponds to a part on the left side.

That is, as shown in FIG. 126, the region in the first captured image PCH31, which is used for acquiring the homogeneous transformation matrix Hb_{1,2}, is a range represented as a region HMR11 on the right side in the drawing. In FIG. 126, the same reference numerals are given to parts corresponding to those in FIG. 125, and the description thereof will be omitted.

In the second captured image PCH32, a region which is used for acquiring the homogeneous transformation matrix Hb_{1,2} is a range represented as a region HMR12 on the left side in the drawing.

Accordingly, positions where the projected images are in a correspondence relationship are acquired in the two regions HMR11 and HMR12, and the homogeneous transformation matrix Hb_{1,2} is acquired.

In contrast, an image region other than the region HMR11 on the captured image PCH31 and an image region other than the region HMR12 on the captured image PCH32 are not used for the image analysis.

Here, an image which is acquired by deforming the first captured image PCH31 is referred to as a captured image PCH41, and an image which is acquired by deforming the second captured image PCH32 is referred to as a captured image PCH42. In such a case, acquisition of a correspondence relationship between the projected image at the part corresponding to the region HMR11 and the projected image at the part corresponding to the region HMR12 is substantially equivalent to acquisition of a correspondence relationship between a projected image at a part corresponding to a region HMR13 in the captured image PCH41 and a projected image at a part corresponding to a region HMR14 in the captured image PCH42.

This is because degrees of deformation in the square lattice patterns in the region HMR11 and the region HMR13 (or the region HMR12 and the region HMR14) are substantially the same. In other words, a homogeneous transformation matrix representing a correspondence relationship between the captured image PCH31 and the captured image PCH32 and the homogeneous transformation matrix representing a correspondence relationship between the captured image PCH 41 and the captured image PCH42 are substantially the same.

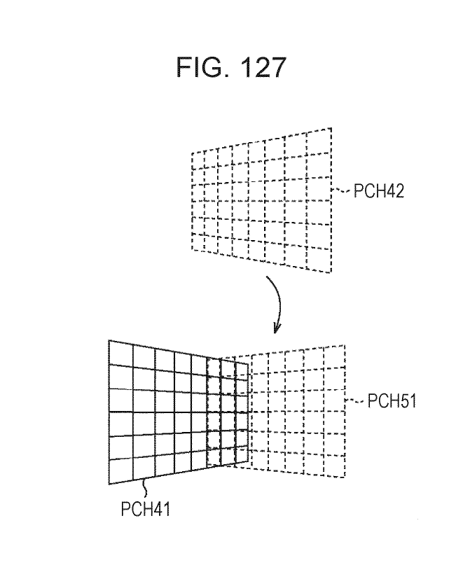

That is, if the homogeneous transformation matrix Hb_{1,2} (Equation (196)) as the positional relationship between the first captured image PCH31 and the second captured image PCH32 in the case where the barrel-shaped distortion is included as described above with reference to FIG. 124 is used, and all the positions on the captured image PCH42 are transformed and mapped on the captured image PCH41, a captured image PCH51 as shown in FIG. 127 is acquired. In FIG. 127, the same reference numerals are given to parts corresponding to those in FIG. 126, and the description thereof will be omitted.

By performing such transformation and overlapping the captured image PCH41 with the captured image PCH51, the projected images projected at the respective positions substantially coincide with each other.

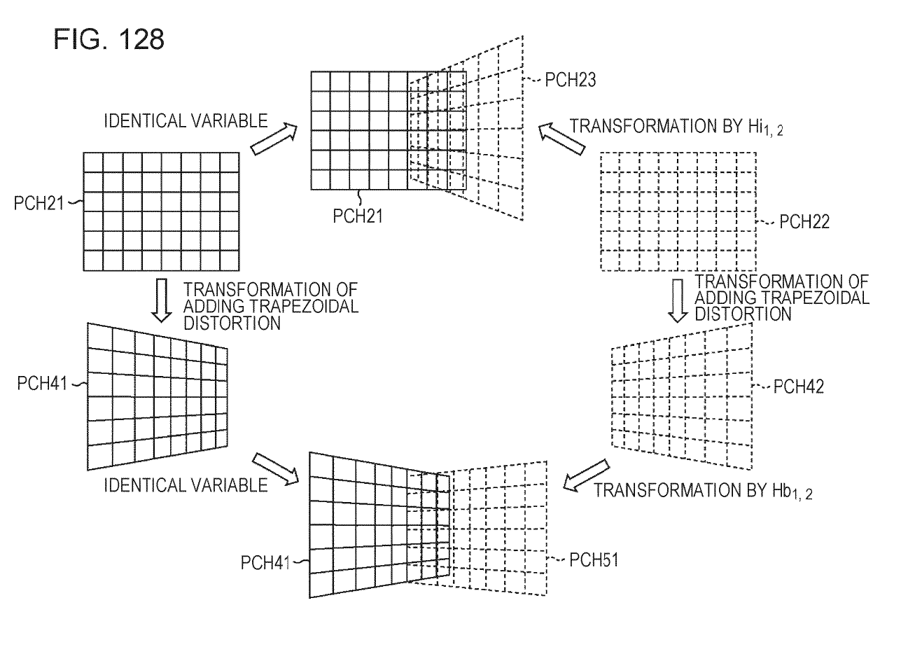

The above descriptions are summarized as shown in FIG. 128. In FIG. 128, the same reference numerals are given to parts corresponding to those in FIG. 123 or 127, and the description thereof will be appropriately omitted. Although the captured images image PCH21 and the captured image PCH41 are respectively shown at two locations in FIG. 128, they are captured images transformed by identical transformation and are the same, and therefore, the same reference numerals are applied.

In FIG. 128, if the captured image PCH23 which is acquired by deforming the second captured image PCH22 without including any distortion by the homogeneous transformation matrix Hi_{1,2} overlaps with the first captured image PCH21 without including any distortion (or an image acquired by performing identical transformation on the captured image PCH21), the projected images projected at the respective positions coincide with each other. In other words, transformation by which the projected images coincide is acquired as the homogeneous transformation matrix Hi_{1,2}.

By performing trapezoidal deformation on the first captured image PCH21 without including any distortion, the captured image PCH21 becomes the first captured image PCH41 after trapezoidal deformation. Similarly, if the second captured image PCH22 without including any distortion is subjected to the trapezoidal deformation, the second captured image PCH42 after trapezoidal deformation is acquired.

If a captured image PCH51 which is acquired by deforming the second captured image PCH42 after the trapezoidal deformation by the homogeneous transformation matrix Hb_{1,2} overlaps with the first captured image PCH41 (or an image acquired by performing identical transformation on the captured image PCH41), the projected images projected at the respective positions substantially coincide with each other.

Here, attention is paid to a projected image which is projected to the arbitrary position W₂ (expressed by same-order coordinates) on the second captured image PCH22 without including any distortion. The same projected image as the projected image is located at a position, which is represented by Equation (197), on the first captured image PCH21 without including any distortion (or an image acquired by performing identical transformation on the captured image PCH21).

When the transformation matrix for performing trapezoidal transformation from the captured image PCH21 into the captured image PCH41 is represented as D_{Left}, the position, which is represented by Equation (197), on the first captured image PCH21 without including any distortion (or the image acquired by performing identical transformation on the captured image PCH21) corresponds to a position, which is represented by the following Equation (202), on the first captured image PCH41 after the trapezoidal deformation. Accordingly, the same projected image as the target projected image is located at a position, which is expressed by Equation (202), on the first captured image PCH41 after the trapezoidal deformation.

[Math. 202]

D_{Left}Hi_{1,2}W₂ (202)

In addition, when the transformation matrix for performing trapezoidal transformation from the captured image PCH22 into the captured image PCH42 is represented as D_{Right}, the position W₂ on the second captured image PCH22 without including any distortion corresponds to a position, which is represented by the following Equation (203), on the second captured image PCH42 after the trapezoidal deformation. Accordingly, the same projected image as the target projected image is located at a position, which is expressed by Equation (203), on the first captured image PCH42 after the trapezoidal deformation.

[Math. 203]

D_{Right}W₂ (203)

Furthermore, a position, which is represented by Equation (203), on the second captured image PCH42 after the trapezoidal deformation corresponds to a position, which is expressed by the following Equation (204), on the first captured image PCH41 after the trapezoidal deformation (or an image acquired by performing the identical transformation on the captured image PCH41). Therefore, the same projected image as the target projected image is located at the position, which is represented by Equation (204), on the first captured image PCH41 after the trapezoidal deformation.

[Math. 204]

Hb_{1,2}D_{Right}W₂ (204)

Since Equation (202) and Equation (204) are supposed to be constantly equal to each other for the arbitrary position W₂, the following Equation (205) is established.

[Math. 205]

D_{Left}Hi_{1,2}∝Hb_{1,2}D_{Right} (205)

Furthermore, if Equation (205) is deformed, the following Equation (206) is acquired.

[Math. 206]

Hb_{1,2}∝D_{Left}Hi_{1,2}D_{Right}⁻¹ (206)

Equation (205) (or Equation (206)) represents a relationship of the transformation matrix D_{Left} for trapezoidal transformation, the transformation matrix D_{Right}, the homogeneous transformation matrix Hi_{1,2}, and the homogeneous transformation matrix Hb_{1,2}. In addition, the transformation matrix D_{Left} and the transformation matrix D_{Right} are 3×3 matrixes.

Now, values of transformation matrix D_{Left} and the transformation matrix D_{Right} will be specifically described below.

As can be understood from the deformation from the captured image PCH21 to the captured image PCH41 in FIG. 128, specifically, the transformation matrix D_{Left} can be approximated by the following Equation (207). Similarly, as can be understood from the deformation from the captured image PCH22 to the captured image PCH42 in FIG. 128, specifically, the transformation matrix D_{Right} can be approximated by the following Equation (208). However, δ is a positive minute value in Equation (207) and Equation (208).

$$\begin{matrix}[ Math . 207 ] & \\ {D}_{Left} = [ \begin{matrix}1 - δ & 0 & 0 \\ 0 & 1 & 0 \\ \sqrt{2 δ} & 0 & 1\end{matrix} ] & ( 207 ) \\ [ Math . 208 ] & \\ {D}_{Right} = [ \begin{matrix}1 - δ & 0 & 0 \\ 0 & 1 & 0 \\ - \sqrt{2 δ} & 0 & 0\end{matrix} ] & ( 208 )\end{matrix}$$

Accordingly, when the positional relationship between the captured images in a case where the images are captured in two imaging directions by a lens without including any distortion is represented by the homogeneous transformation matrix Hi_{1,2}, and the positional relationship between the captured images in a case where the images are captured in the two same imaging directions by a lens including barrel-shaped distortion is represented by the homogeneous transformation matrix Hb_{1,2}, the relationship of the following Equation (209) is established. The relationship is derived from the aforementioned Equation (206).

$$\begin{matrix} [ Math . 209 ] & \\ {Hb}_{1 , 2} ∝ [ \begin{matrix}1 - δ & 0 & 0 \\ 0 & 1 & 0 \\ \sqrt{2 δ} & 0 & 1\end{matrix} ] {{Hi}_{1 , 2} [ \begin{matrix}1 - δ & 0 & 0 \\ 0 & 1 & 0 \\ - \sqrt{2 δ} & 0 & 1\end{matrix} ]}^{- 1} = [ \begin{matrix}1 - δ & 0 & 0 \\ 0 & 1 & 0 \\ \sqrt{2 δ} & 0 & 1\end{matrix} ] {Hi}_{1 , 2} [ \begin{matrix}1 / ( 1 - δ ) & 0 & 0 \\ 0 & 1 & 0 \\ \sqrt{2 δ} / ( 1 - δ ) & 0 & 1\end{matrix} ] & ( 209 )\end{matrix}$$

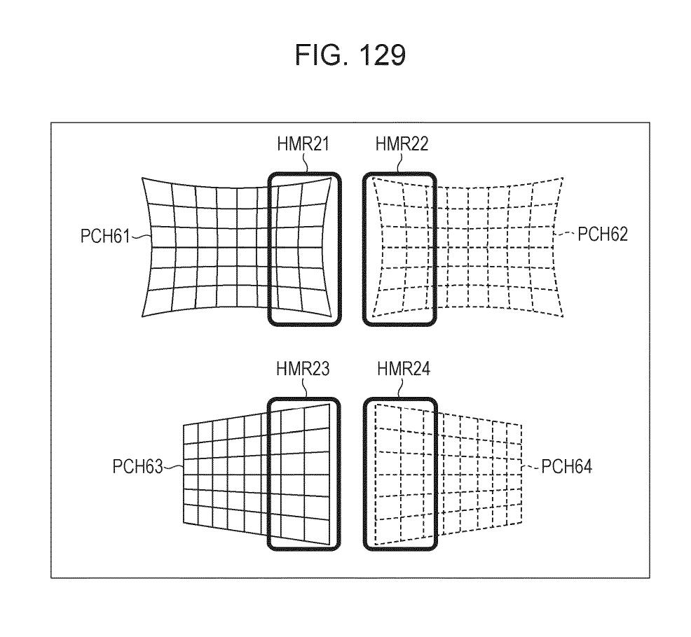

In the above description, the case of the barrel-shaped distortion was considered. Next, a case of bobbin-shaped distortion will be considered. It is assumed that the first captured image PCH61 and the second captured image PCH62 include bobbin-shaped distortion as shown in FIG. 129, for example.

In addition, it is assumed that a homogeneous transformation matrix (homography) Hp_{1,2} as a positional relationship between the first captured image PCH61 and the second captured image PCH62 is acquired by image analysis. Moreover, the index “p” of the homogeneous transformation matrix Hp_{1,2} means “bobbin-shaped distortion” (pincushion)

That is, the homogeneous transformation matrix Hp_{1,2} is acquired from a correspondence relationship between projected images which appear on the captured image PCH61 and the captured image PCH62. Since the distortion is non-linear in this case, it is not possible to completely satisfy the correspondence relationship of the projected images, and a homogeneous transformation matrix which substantially satisfies the correspondence relationship to the maximum extent is acquired.

If consideration is made in the same manner as in the description of FIG. 126, regions used for acquiring the homogeneous transformation matrix Hp_{1,2} by the image analysis are a region HMR21 as a part on the right side in the first captured image PCH61 and a region HMR22 as a part on the left side in the second captured image PCH62.

Positions, at which the projected images are in the correspondence relationship, in the two regions HMR21 and HMR22 are acquired, and the homogeneous transformation matrix Hp_{1,2} is acquired.

Acquisition of a correspondence relationship between the projected image at the part corresponding to the region HMR21 and the projected image at the part corresponding to the region HMR22 is substantially equivalent to acquisition of a correspondence relationship between a projected image at a part corresponding to a region HMR23 in the captured image PCH63 and a projected image at a part corresponding to a region HMR24 in the captured image PCH64 by deforming the first captured image PCH61 to the captured image PCH63 and deforming the second captured image PCH62 to the captured image PCH64. This is because degrees of deformation in the square lattice patterns in the region HMR21 and the region HMR23 (or the region HMR22 and the region HMR24) are substantially the same.

A transformation matrix for deforming the first captured image PCH61 to the captured image PCH63 is the aforementioned transformation matrix D_{Right}, and a transformation matrix for deforming the second captured image PCH62 to the captured image PCH64 is the aforementioned transformation matrix D_{Left}.

Accordingly, it is possible to derive the following Equation (210) by making consideration in the same manner as in deriving Equation (209) in the case of the barrel-shaped distortion. That is, when the positional relationship between the captured images in a case where the images are captured in two imaging directions by a lens without including any distortion is referred to as the homogeneous transformation matrix Hi_{1,2} and the positional relationship between the captured images in a case where the images are captured in the two same imaging directions by a lens including bobbin-shaped distortion is referred to as the homogeneous transformation matrix Hp_{1,2}, the relationship of Equation (210) is established.

$$\begin{matrix} [ Math . 210 ] & \\ {Hp}_{1 , 2} ∝ [ \begin{matrix}1 - δ & 0 & 0 \\ 0 & 1 & 0 \\ - \sqrt{2 δ} & 0 & 1\end{matrix} ] {{Hi}_{1 , 2} [ \begin{matrix}1 - δ & 0 & 0 \\ 0 & 1 & 0 \\ - \sqrt{2 δ} & 0 & 1\end{matrix} ]}^{- 1} = [ \begin{matrix}1 - δ & 0 & 0 \\ 0 & 1 & 0 \\ - \sqrt{2 δ} & 0 & 1\end{matrix} ] {Hi}_{1 , 2} [ \begin{matrix}1 / ( 1 - δ ) & 0 & 0 \\ 0 & 1 & 0 \\ - \sqrt{2 δ} / ( 1 - δ ) & 0 & 1\end{matrix} ] & ( 210 )\end{matrix}$$

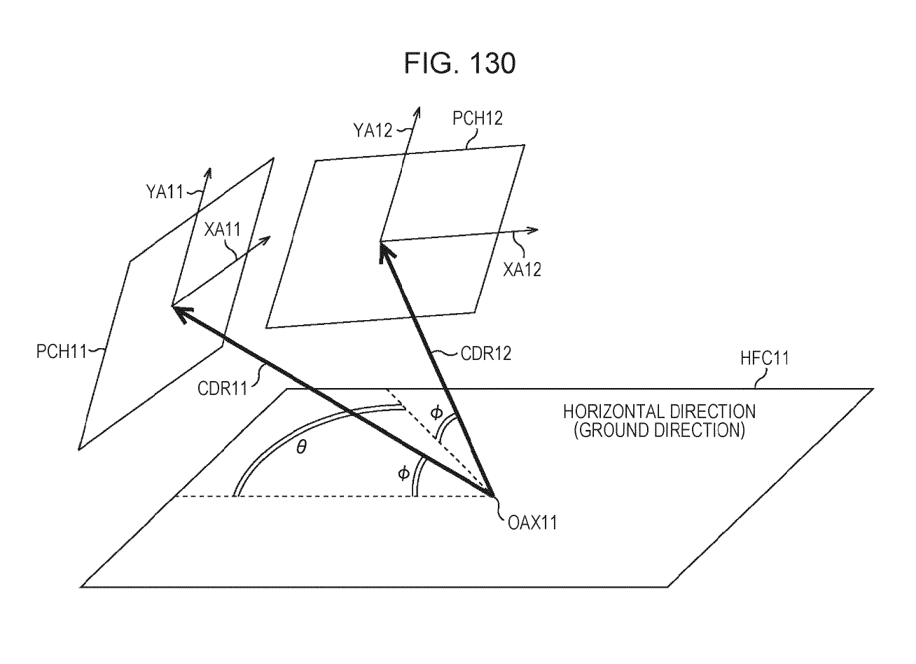

Incidentally, it is assumed that two captured images are captured at a tilt angle φ and at a rotation angle θ as shown in FIG. 130. In FIG. 130, the same reference numerals are given to parts corresponding to those in FIG. 122, and the description thereof will be appropriately omitted.

In FIG. 130, an image projected to the screen PCH11 is the first captured image (hereinafter, also referred to as a captured image PCH11), and an image projected to the screen PCH12 is the second captured image (hereinafter, also referred to as a captured image PCH12). In addition, a plane which includes a point OAX11 and is parallel with a ground when the images are captured is a horizontal plane HFC11.

In this example, an angle of a direction of the arrow CDR11 with respect to the horizontal direction, namely an angle of the direction of the arrow CDR11 with respect to the horizontal plane HFC11 is φ (tilt angle φ). Similarly, an angle of a direction of the arrow CDR12 with respect to the horizontal direction (horizontal plane HFC11) is also φ. In addition, an angle between the direction of the arrow CDR11 and the direction of the arrow CDR12 when viewed from a vertical direction, namely from a direction orthogonal to the horizontal plane HFC11 is θ (rotation angle θ).

In such a case, if a focal distance of the imaging device which captures the captured image PCH11 and the captured image PCH12 is F, a homogeneous transformation matrix Hi (F, φ, and θ) representing the positional relationship between the first captured image PCH11 and the second captured image PCH12 is represented by the following Equation (211).

$$\begin{matrix} [ Math . 211 ] & \\ Hi ( F , φ , θ ) = [ \begin{matrix}1 & 0 & 0 \\ 0 & cos ( φ ) & - F sin ( φ ) \\ 0 & \frac{sin ( φ )}{F} & cos ( φ )\end{matrix} ] [ \begin{matrix}cos ( θ ) & 0 & F sin ( θ ) \\ 0 & 1 & 0 \\ - \frac{sin ( θ )}{F} & 0 & cos ( θ )\end{matrix} ] [ \begin{matrix}1 & 0 & 0 \\ 0 & cos ( φ ) & F sin ( φ ) \\ 0 & - \frac{sin ( φ )}{F} & cos ( φ )\end{matrix} ] & ( 211 )\end{matrix}$$

This is because transformation for correcting the tilt angle φ is represented by the following Equation (212), transformation for rotation in the horizontal direction by θ is represented by the following Equation (213), and transformation for implementing the tilt angle φ is represented by the following Equation (214). Accordingly, it is possible to acquire the positional relationship between the two captured images PCH11 and PCH12 in a case where the images are captured at the tilt angle φ and at the rotation angle θ by multiplying Equation (212) to Equation (214). In addition, the transformation for correcting the tilt angle φ is transformation of setting the tilt angle φ to zero, and the transformation for implementing the tilt angle φ is transformation for inclining the imaging device such that the tilt angle φ increases by a predetermined angle.

$$\begin{matrix}[ Math . 212 ] & \\ [ \begin{matrix}1 & 0 & 0 \\ 0 & cos ( φ ) & - F sin ( φ ) \\ 0 & \frac{sin ( φ )}{F} & cos ( φ )\end{matrix} ] & ( 212 ) \\ [ Math . 213 ] & \\ [ \begin{matrix}cos ( θ ) & 0 & F sin ( θ ) \\ 0 & 1 & 0 \\ - \frac{sin ( θ )}{F} & 0 & cos ( θ )\end{matrix} ] & ( 213 ) \\ [ Math . 214 ] & \\ [ \begin{matrix}1 & 0 & 0 \\ 0 & cos ( φ ) & F sin ( φ ) \\ 0 & - \frac{sin ( φ )}{F} & cos ( φ )\end{matrix} ] & ( 214 )\end{matrix}$$

Although the two captured images were described hitherto, hereinafter, description will be given of a plurality of captured images which the imaging device successively captures while being panned, namely turned by 360°.

A case where imaging is performed N times in a direction of a tilt angle of φ° while the imaging device is rotated by (360/N)°, namely a case where N captured images are captured will be considered. In addition, it is assumed that the tilt angles are constantly φ when all the N images are captured. At this time, it is only necessary to substituting θ=360/N into the homogeneous transformation matrix Hi (F, (p, θ) defined by Equation (211) for a homogeneous transformation matrix representing a positional relationship between adjacent captured images, and the substitution result is represented by the following Equation (215).

$$\begin{matrix}[ Math . 215 ] & \\ Hi ( F , φ , \frac{360}{N} ) = [ \begin{matrix}1 & 0 & 0 \\ 0 & cos ( φ ) & - F sin ( φ ) \\ 0 & \frac{sin ( φ )}{F} & cos ( φ )\end{matrix} ] [ \begin{matrix}cos ( \frac{360}{N} ) & 0 & F sin ( \frac{360}{N} ) \\ 0 & 1 & 0 \\ - \frac{sin ( \frac{360}{N} )}{F} & 0 & cos ( \frac{360}{N} )\end{matrix} ] [ \begin{matrix}1 & 0 & 0 \\ 0 & cos ( φ ) & F sin ( φ ) \\ 0 & - \frac{sin ( φ )}{F} & cos ( φ )\end{matrix} ] & ( 215 )\end{matrix}$$

Since rotation is made by (360/N) for the first captured image, the second captured image, the third captured image, . . . , it is a matter of course that the N power of the homogeneous transformation matrix Hi (F, φ, 360/N) in Equation (215) is a unit matrix as represented by the following Equation (216).

$$\begin{matrix}[ Math . 216 ] & \\ {( Hi ( F , φ , \frac{360}{N} ) )}^{N} = [ \begin{matrix}1 & 0 & 0 \\ 0 & 1 & 0 \\ 0 & 0 & 1\end{matrix} ] & ( 216 )\end{matrix}$$

Incidentally, how about a case where images are captured by a lens including barrel-shaped distortion? The positional relationship (homogeneous transformation matrix) of two captured images in the case where the images are captured by a lens including barrel-shaped distortion was represented by Equation (209) by using the positional relationship (homogeneous transformation matrix) in the case where the images are captured by the lens without including any distortion. Therefore, the homogeneous transformation matrix Hb (F, φ, θ) representing the positional relationship in the case where the images are captured by the lens including the barrel-shaped distortion is represented by the following Equation (217).

$$\begin{matrix} [ Math . 217 ] & \\ Hb ( F , φ , \frac{360}{N} ) ∝ [ \begin{matrix}1 - δ & 0 & 0 \\ 0 & 1 & 0 \\ \sqrt{2 δ} & 0 & 1\end{matrix} ] Hi ( F , φ , \frac{360}{N} ) [ \begin{matrix}1 / ( 1 - δ ) & 0 & 0 \\ 0 & 1 & 0 \\ \sqrt{2 δ} / ( 1 - δ ) & 0 & 1\end{matrix} ] & ( 217 )\end{matrix}$$

In addition, the homogeneous transformation matrix Hp (F, φ, θ) representing the positional relationship in the case where the images are captured by the lens including the bobbin-shaped distortion is represented by the following Equation (218).

$$\begin{matrix} [ Math . 218 ] & \\ Hp ( F , φ , \frac{360}{N} ) ∝ [ \begin{matrix}1 - δ & 0 & 0 \\ 0 & 1 & 0 \\ - \sqrt{2 δ} & 0 & 1\end{matrix} ] Hi ( F , φ , \frac{360}{N} ) [ \begin{matrix}1 / ( 1 - δ ) & 0 & 0 \\ 0 & 1 & 0 \\ - \sqrt{2 δ} / ( 1 - δ ) & 0 & 1\end{matrix} ] & ( 218 )\end{matrix}$$

These Equation (217) and Equation (218) respectively represent positional relationships between two captured images when the images are captured by using the lens including the barrel-shaped distortion or using the lens including the bobbin-shaped distortion at the tilt angle φ and the rotation angle θ.

Although the N power of the homogeneous transformation matrix is a unit matrix as represented by Equation (216) if there is no lens distortion, the N power of the homogeneous transformation matrix is not a unit matrix when lens distortion is present. That is, the matrixes represented by the following Equation (219) and Equation (220) are not unit matrixes.

$$\begin{matrix}[ Math . 219 ] & \\ {( Hb ( F , φ , \frac{360}{N} ) )}^{N} & ( 219 ) \\ [ Math . 220 ] & \\ {( Hp ( F , φ , \frac{360}{N} ) )}^{N} & ( 220 )\end{matrix}$$

If F=4000, φ=0°, N=36 (that is, 360/N=10°, for example, are substituted, in practice, it is a matter of course that Equation (216) is satisfied, but however, values of Equation (219) and Equation (220) become values represented by the following Equation (221) and Equation (222). Here, the value δ, which represents a distortion amount, in Equation (217) and Equation (218) are set to 10⁻¹². The following description will be continued on the assumption that the value of δ representing the distortion amount is 10⁻¹².

$$\begin{matrix}[ Math . 221 ] & \\ {( Hb ( F , φ , \frac{360}{N} ) )}^{N} ∝ [ \begin{matrix}1 & 0 & - 868.47 \\ 0 & 1.0218 & 0 \\ 0.0000507949 & 0 & 1\end{matrix} ] , \\ F = 4000 , \\ φ = 0 , \\ N = 36. & ( 221 ) \\ [ Math . 222 ] & \\ {( Hp ( F , φ , \frac{360}{N} ) )}^{N} ∝ [ \begin{matrix}1 & 0 & 787.97 \\ 0 & 1.0204 & 0 \\ - 0.0000524066 & 0 & 1\end{matrix} ] , \\ F = 4000 , \\ φ = 0 , \\ N = 36. & ( 222 )\end{matrix}$$

In addition, if F=4000, φ=5°, N=36 (that is, 360/N=10°, for example, are substituted, it is a matter of course that Equation (216) is satisfied, but however, values of Equation (219) and Equation (220) become values represented by the following Equation (223) and Equation (224).

$$\begin{matrix} [ Math . 223 ] & \\ {( Hb ( F , φ , \frac{360}{N} ) )}^{N} ∝ [ \begin{matrix}0.99982 & 0.0188419 & - 861.45 \\ - 0.0188512 & 1.02129 & 8.03422 \\ 0.00005037 & 0.0000004695 & 1\end{matrix} ] , \\ F = 4000 , \\ φ = 0 , \\ N = 36. & ( 223 ) \\ [ Math . 224 ] & \\ {( Hp ( F , φ , \frac{360}{N} ) )}^{N} ∝ [ \begin{matrix}0.999855 & - 0.017102 & 781.92 \\ 0.017094 & 1.01999 & 6.617 \\ - 0.000052016 & 0.0000004404 & 1\end{matrix} ] , \\ F = 4000 , \\ φ = 0 , \\ N = 36. & ( 224 )\end{matrix}$$

Incidentally, which position in the initial first captured image the center of the captured image after the imaging device is rotated by one circuit corresponds to when the captured images are captured will be considered.

First, the center position of the captured image after the imaging device is rotated by one circuit is a pixel position represented by the following Equation (225), that is, a position (0, 0) in an XY coordinate system with reference to the imaging direction of the first captured image when there is no lens distortion. This is because the center of the captured image is still the center of the image even after the imaging device is rotated by one circuit if there is no distortion.

$$\begin{matrix}[ Math . 225 ] & \\ \begin{matrix}{( Hi ( F , φ , \frac{360}{N} ) )}^{N} [ \begin{matrix}0 \\ 0 \\ 1\end{matrix} ] = [ \begin{matrix}1 & 0 & 0 \\ 0 & 1 & 0 \\ 0 & 0 & 1\end{matrix} ] [ \begin{matrix}0 \\ 0 \\ 1\end{matrix} ] \\ = [ \begin{matrix}0 \\ 0 \\ 1\end{matrix} ]\end{matrix} & ( 225 )\end{matrix}$$

In contrast, how about a case where lens distortion is present? When F=4000, φ=0°, and N=36 (that is, 360/N=10°, the center position of the captured image after being rotated by one circuit is a pixel position represented by the following Equation (226) and Equation (227).

$$\begin{matrix}[ Math . 226 ] & \\ {( Hb ( F , φ , \frac{360}{N} ) )}^{N} [ \begin{matrix}0 \\ 0 \\ 1\end{matrix} ] ∝ [ \begin{matrix}1 & 0 & - 868.47 \\ 0 & 1.0218 & 0 \\ 0.0000507949 & 0 & 1\end{matrix} ] [ \begin{matrix}0 \\ 0 \\ 1\end{matrix} ] = [ \begin{matrix}- 868.47 \\ 0 \\ 1\end{matrix} ] , \\ where \\ F = 4000 , \\ φ = 0 , \\ N = 36. & ( 226 ) \\ [ Math . 227 ] & \\ {( Hp ( F , φ , \frac{360}{N} ) )}^{N} [ \begin{matrix}0 \\ 0 \\ 1\end{matrix} ] ∝ [ \begin{matrix}1 & 0 & 787.97 \\ 0 & 1.0204 & 0 \\ - 0.0000524066 & 0 & 1\end{matrix} ] [ \begin{matrix}0 \\ 0 \\ 1\end{matrix} ] = [ \begin{matrix}787.97 \\ 0 \\ 1\end{matrix} ] , \\ where \\ F = 4000 , \\ φ = 0 , \\ N = 36. & ( 227 )\end{matrix}$$

That is, if barrel-shaped distortion is present, the center position is located on a further left side by 868.47 pixels in terms of a numerical value regardless of the fact that the imaging device is rotated by one circuit, as represented by Equation (226). That is, if the homogeneous transformation matrixes between adjacent images are accumulated, the result (rotation angle) is less than 360° instead of 360° regardless of the fact that the imaging corresponding to one circuit is performed.

In contrast, if there is bobbin-shaped distortion, the center position is located on a further right side by 787.97 pixels in terms of a numerical value regardless of the fact that the imaging device is rotated by one circuit, as represented by Equation (227). That is, if the homogeneous transformation matrixes between the adjacent images are accumulated, the result (rotation angle) exceeds 360° instead of being 360° regardless of the fact that the imaging corresponding to one circuit is performed. This is the first characteristic that the present applicant newly discovered.

Furthermore, a case where imaging is performed by rotating the imaging device while the imaging device is tilted will be considered. Which direction a Y axis of the captured image after the imaging device is rotated by one circuit corresponds to on the initial first captured image will be considered. In addition, it is possible to know the direction of the Y axis by acquiring a difference between a pixel position to which the position (X, Y)=(0, 1) in the XY coordinate system with reference to the imaging direction of the captured image corresponds and a pixel position to which a position (X, Y)=(0, 0) corresponds. This is calculated in practice as follows.

First, since the pixel position to which the position (0, 1) corresponds is a position represented by the following Equation (228) and the pixel position to which the position (0, 0) corresponds is a position represented by the following Equation (229) if there is no lens distortion, the difference therebetween is (0, 1). That is, the Y axis of the captured image after the imaging device is rotated by one circuit is in a direction of (0, 1) (a direction from the position (0, 0) toward the position (0, 1)) on the initial first captured image. It is a matter of course that the Y axis of the captured image is in the same direction as that in the Y axis of the first captured image even after the imaging device is rotated by one circuit if there is no distortion.

$$\begin{matrix}[ Math . 228 ] & \\ \begin{matrix}{( Hi ( F , φ , \frac{360}{N} ) )}^{N} [ \begin{matrix}0 \\ 1 \\ 1\end{matrix} ] = [ \begin{matrix}1 & 0 & 0 \\ 0 & 1 & 0 \\ 0 & 0 & 1\end{matrix} ] [ \begin{matrix}0 \\ 1 \\ 1\end{matrix} ] \\ = [ \begin{matrix}0 \\ 1 \\ 1\end{matrix} ]\end{matrix} & ( 228 ) \\ [ Math . 229 ] & \\ \begin{matrix}{( Hi ( F , φ , \frac{360}{N} ) )}^{N} [ \begin{matrix}0 \\ 0 \\ 1\end{matrix} ] = [ \begin{matrix}1 & 0 & 0 \\ 0 & 1 & 0 \\ 0 & 0 & 1\end{matrix} ] [ \begin{matrix}0 \\ 0 \\ 1\end{matrix} ] \\ = [ \begin{matrix}0 \\ 0 \\ 1\end{matrix} ]\end{matrix} & ( 229 )\end{matrix}$$

In contrast, how about a case where barrel-shaped distortion is present? When F=4000, φ=5°, and N=36 (that is, 360/N=10°, the pixel position to which the position (0, 1) corresponds is a position represented by the following Equation (230), the pixel position to which the position (0, 0) corresponds is a position represented by the following Equation (231), and therefore, the difference therebetween is a value represented by Equation (232). That is, the Y axis of the captured image after the imaging device is rotated by one circuit is inclined on the initial first captured image. A direction of the inclination is a positive direction of the X axis, and the amount thereof is about 0.02 pixels. That is, the Y axis of the captured image after the imaging device is rotated by one circuit is rotated in a clockwise direction.

$$\begin{matrix} [ Math . 230 ] & \\ {( Hb ( F , φ , \frac{360}{N} ) )}^{N} [ \begin{matrix}0 \\ 1 \\ 1\end{matrix} ] ∝ [ \begin{matrix}0.99982 & 0.0188419 & - 861.45 \\ - 0.0188512 & 1.02129 & 8.03422 \\ 0.00005037 & 0.0000004695 & 1\end{matrix} ] [ \begin{matrix}0 \\ 1 \\ 1\end{matrix} ] = [ \begin{matrix}- 861.43 \\ 9.05551 \\ 1.0000004695\end{matrix} ] ∝ [ \begin{matrix}- 861.43 \\ 9.05551 \\ 1\end{matrix} ] , \\ where \\ F = 4000 , \\ φ = 5 , \\ N = 36. & ( 230 ) \\ [ Math . 231 ] & \\ {( Hb ( F , φ , \frac{360}{N} ) )}^{N} [ \begin{matrix}0 \\ 0 \\ 1\end{matrix} ] ∝ [ \begin{matrix}0.99982 & 0.0188419 & - 861.45 \\ - 0.0188512 & 1.02129 & 8.03422 \\ 0.00005037 & 0.0000004695 & 1\end{matrix} ] [ \begin{matrix}0 \\ 0 \\ 1\end{matrix} ] = [ \begin{matrix}- 861.43 \\ 8.03422 \\ 1\end{matrix} ] , \\ where \\ F = 4000 , \\ φ = 5 , \\ N = 36. & ( 231 ) \\ [ Math . 232 ] & \\ [ \begin{matrix}- 861.43 \\ 9.055\end{matrix} ] - [ \begin{matrix}- 861.45 \\ 8.03422\end{matrix} ] \approx [ \begin{matrix}0.2 \\ 1\end{matrix} ] & ( 232 )\end{matrix}$$

Next, a case of bobbin-shaped distortion will be considered. When F=4000, φ=5°, and N=36 (that is, 360/N=10°, the pixel position to which the position (0, 1) corresponds is a position represented by the following Equation (233), the pixel position to which the position (0, 0) corresponds is a position represented by the following Equation (234), and therefore, the difference therebetween is a value represented by Equation (235). That is, the Y axis of the captured image after the imaging device is rotated by one circuit is inclined on the initial first captured image. A direction of the inclination is a negative direction of the X axis, and the amount thereof is about 0.02 pixels. That is, the Y axis of the captured image after the imaging device is rotated by one circuit is rotated in a counterclockwise direction.

$$\begin{matrix} [ Math . 233 ] & \\ {( Hp ( F , φ , \frac{360}{N} ) )}^{N} [ \begin{matrix}0 \\ 1 \\ 1\end{matrix} ] ∝ [ \begin{matrix}0.999855 & - 0.017102 & 781.92 \\ 0.017094 & 1.01999 & 6.617 \\ - 0.000052016 & 0.0000004404 & 1\end{matrix} ] [ \begin{matrix}0 \\ 1 \\ 1\end{matrix} ] = [ \begin{matrix}781.902 \\ 7.63699 \\ 1.0000004404\end{matrix} ] ∝ [ \begin{matrix}781.902 \\ 7.63698 \\ 1\end{matrix} ] , \\ where \\ F = 4000 , \\ φ = 5 , \\ N = 36. & ( 233 ) \\ [ Math . 234 ] & \\ {( Hp ( F , φ , \frac{360}{N} ) )}^{N} [ \begin{matrix}0 \\ 0 \\ 1\end{matrix} ] ∝ [ \begin{matrix}0.999855 & - 0.017102 & 781.92 \\ 0.017094 & 1.01999 & 6.617 \\ - 0.000052016 & 0.0000004404 & 1\end{matrix} ] [ \begin{matrix}0 \\ 0 \\ 1\end{matrix} ] = [ \begin{matrix}781.92 \\ 6.617 \\ 1\end{matrix} ] , \\ where \\ F = 4000 , \\ φ = 5 , \\ N = 36. & ( 234 ) \\ [ Math . 235 ] & \\ [ \begin{matrix}781.90 \\ 7.63698\end{matrix} ] - [ \begin{matrix}781.92 \\ 6.617\end{matrix} ] \approx [ \begin{matrix}- 0.02 \\ 1\end{matrix} ] & ( 235 )\end{matrix}$$

As described above, if imaging is performed by rotating the imaging device in the right direction viewed from the person who captures the images while the imaging device is tilted upward, and the homogeneous transformation matrixes between adjacent images after the imaging device is rotated by one circuit are accumulated when the barrel-shaped distortion is present, the Y axis is rotated in the clockwise direction. In contrast, if imaging is performed by rotating the imaging device in the right direction viewed from the person who captures the images while the imaging device is tilted upward, and the homogeneous transformation matrixes between the adjacent images are accumulated after the imaging device is rotated by one circuit when the bobbin-shaped distortion is present, the Y axis is rotated in the counterclockwise direction. This is the second characteristic that the present applicant newly discovered.

Based on the two characteristics described above, it is possible to determine whether or not lens distortion is present in the captured image by performing the following processing according to the present technology.

As can be understood from the calculation of Equation (217) and Equation (218), the value on the first row and the third column of the homogeneous transformation matrix between the adjacent images, which is represented by Equation (217) and Equation (218) is a value represented by the following Equation (236). In addition, the value on the first row and the second column of the homogeneous transformation matrix is a value represented by the following Equation (237). Here, δ representing the distortion amount is approximated on the assumption that δ is a minute value.

$$\begin{matrix}[ Math . 236 ] & \\ F cos ( φ ) sin ( \frac{360}{N} ) & ( 236 ) \\ [ Math . 237 ] & \\ - sin ( φ ) sin ( \frac{360}{N} ) & ( 237 )\end{matrix}$$

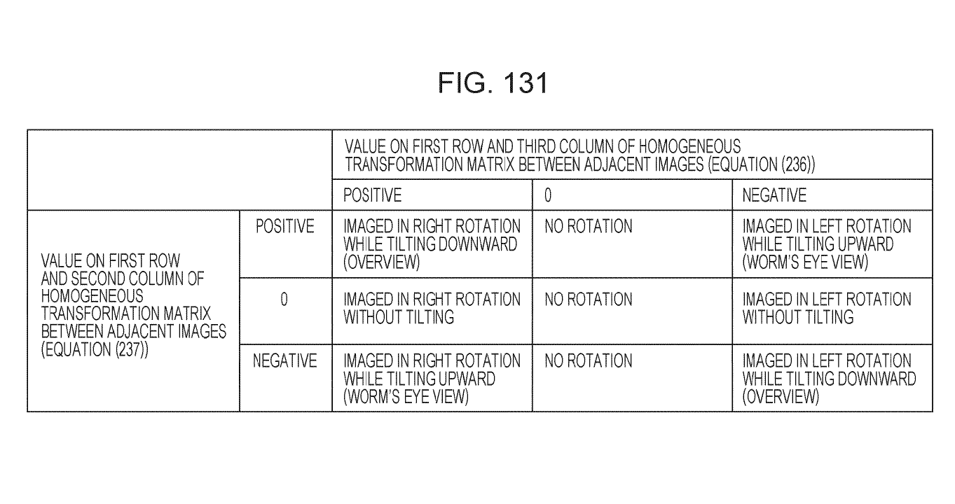

Accordingly, the fact that the value on the first row and the third column of the homogeneous transformation matrix between the adjacent images (the value of Equation (236)) is positive means the fact that θ=2π/N is positive, namely rotation in the right direction. Furthermore, the fact that the value on the first row and the second column (the value of Equation (237)) is negative means the fact that φ is positive when θ is positive, namely the fact that imaging is performed while the imaging device is tilted upward. The same is true to the other cases as shown in FIG. 131 as a result.

That is, it is possible to specify the rotation direction and the tilting direction (worm's eye view or overview) when the captured images are captured, from the value of Equation (236) and the value of Equation (237).

For example, when the value of Equation (236) is positive and the value of Equation (237) is positive, it is possible to know that the respective captured images were captured by rotating the imaging device in the right direction while the imaging device was tilted downward. In addition, when the value of Equation (236) is positive and the value of Equation (237) is zero, it is possible to know that the respective captured images were captured by rotating the imaging device in the right direction without tilting the imaging device. Furthermore, when the value of Equation (236) is positive and the value of Equation (237) is negative, it is possible to know that the respective captured images were captured by rotating the imaging device in the right direction while the imaging device was tilted upward.

In addition, when the value of Equation (236) is zero, it is possible to know that the respective captured images were captured in a state where the imaging device is not rotated.

When the value of Equation (236) is negative and the value of Equation (237) is positive, it is possible to know that the respective captured images were captured by rotating the imaging device in the left direction while the imaging device is tilted upward. In addition, when the value of Equation (236) is negative and the value of Equation (237) is zero, it is possible to know that the respective captured images are captured by rotating the imaging device in the left direction without tilting the imaging device. Furthermore, when the value of Equation (236) is negative and the value of Equation (237) is negative, it is possible to know that the respective captured images were captured by rotating the imaging device in the left direction while the imaging device is tilted downward.

### [Configuration Example of Image Processing Apparatus]

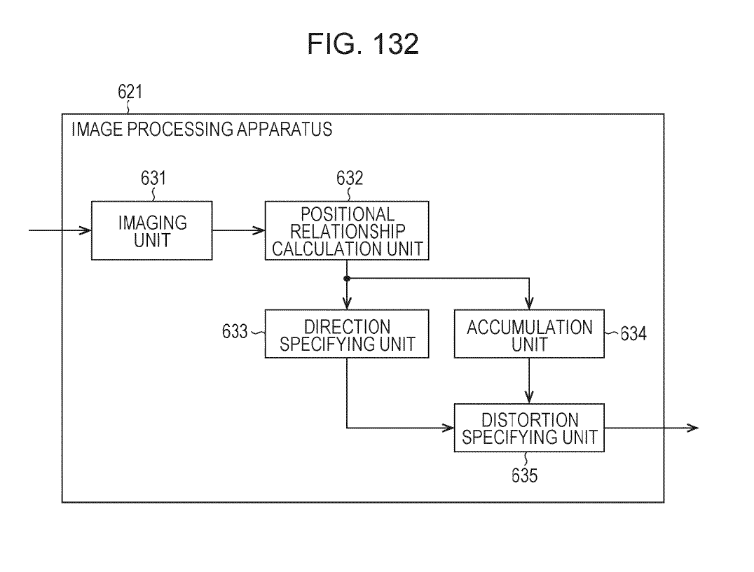

Next, description will be given of a specific embodiment to which the present technology is applied. FIG. 132 is a diagram showing a configuration example of an embodiment of an image processing apparatus to which the present technology is applied.

An image processing apparatus 621 in FIG. 132 is configured of an imaging unit 631, a positional relationship calculation unit 632, a direction specifying unit 633, an accumulation unit 634, and a distortion specifying unit 635.

The imaging unit 631 successively captures a plurality of captured images in a state where the image processing apparatus 621 is rotated, and supplies the acquired captured images to the positional relationship calculation unit 632. The positional relationship calculation unit 632 calculates homogeneous transformation matrixes representing positional relationships between the captured images which are supplied from the imaging unit, and supplies the homogeneous transformation matrixes to the direction specifying unit 633 and the accumulation unit 634.

The direction specifying unit 633 specifies a tilt direction and a rotation direction of the image processing apparatus 621 when the captured images are captured based on the homogeneous transformation matrixes supplied from the positional relationship calculation unit 632, and supplies the tilt direction and the rotation direction to the distortion specifying unit 635. Here, the tilt direction and the rotation direction of the image processing apparatus 621 are a tilt direction and a rotation direction viewed from the person who captures the captured images by operating the image processing apparatus 621.

The accumulation unit 634 accumulates the homogeneous transformation matrixes supplied from the positional relationship calculation unit 632, calculates a homogeneous transformation matrix when the image processing apparatus 621 is turned (rotated by one circuit) for capturing the captured images, and supplies the homogeneous transformation matrix to the distortion specifying unit 635.

The distortion specifying unit 635 specifies lens distortion on the captured images, which is caused by the lens, based on the tilt direction and the rotation direction supplied from the direction specifying unit 633 and the homogeneous transformation matrix supplied from the accumulation unit 634, and outputs the specification result.

### [Description of Distortion Detection Processing]

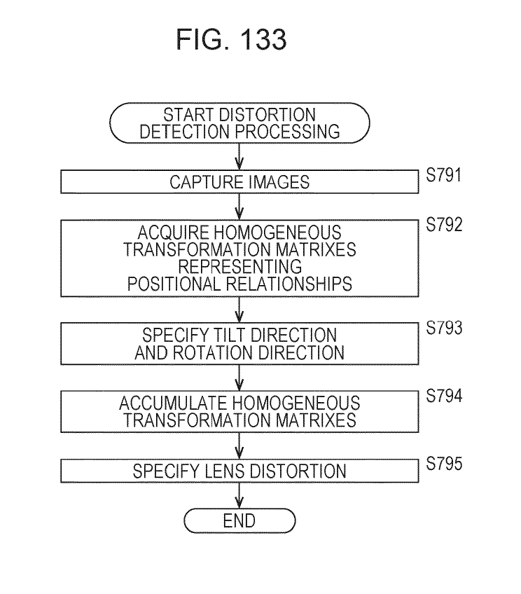

Next, description will be given of distortion detection processing by the image processing apparatus 621 with reference to the flowchart in FIG. 133.

In Step S791, the imaging unit 631 performs imaging in response to an operation by a user as a person who captures the images and supplies the acquired captured images to the positional relationship calculation unit 632.

Specifically, the user successively images an object by panning, that is, by turning the image processing apparatus 621 by 360°. As described above, the imaging unit 631 captures a total N captured images including the first captured image, the second captured image, . . . , and the N-th captured image until the image processing apparatus 621 is turned, in a state where the image processing apparatus 621 is rotated.

In Step S792, the positional relationship calculation unit 632 calculates homogeneous transformation matrixes representing the positional relationships between the adjacent captured images based on the captured images supplied from the imaging unit 631 and supplies the homogeneous transformation matrixes to the direction specifying unit 633 and the accumulation unit 634.

That is, the positional relationship calculation unit 632 acquires homogeneous transformation matrixes H_{s,s+1} (where s=1 to N−1) as the positional relationship between the s-th captured image and the s+1-th captured image by the image analysis.

In addition, the positional relationship calculation unit 632 also acquires a homogeneous transformation matrix N_{N,1} as the positional relationship between the N-th captured image and the first captured image by the image analysis.

Specifically, the positional relationship calculation unit 632 acquires pixel positions, which correspond to pixel positions of at least four or more points, for example, M points (Xa₍ₖ₎, Ya₍ₖ₎) (where k=1 to M) on the s-th captured image, on the s+1-th captured image. That is, the positional relationship calculation unit 632 acquires the corresponding pixel positions by considering small regions around pixels in the s-th captured image and searching for regions, which are to be matched with the small regions, in the s+1-th captured image.

Such processing is generally called block matching. With such processing, the pixel positions (Xa₍ₖ₎, Ya₍ₖ₎) in the s-th captured image and the pixel positions (Xb₍ₖ₎, Yb₍ₖ₎) corresponding thereto in the s+1-th captured image are acquired. Here, k=1 to M.

Thus, the positional relationship calculation unit 632 expresses these pixel positions by same-order coordinates and acquires the homogeneous transformation matrixes H_{s,s+1} which satisfy the following Equation (238). Since errors may occur in the image analysis and there is also an error caused by lens distortion in a strict sense, matrixes H_{s,s+1} which substantially satisfy Equation (238) to the maximum extent are acquired for all k=1 to M.

$$\begin{matrix}[ Math . 238 ] & \\ [ \begin{matrix}{Xa}_{( k )} \\ {Ya}_{( k )} \\ 1\end{matrix} ] ∝ {H}_{s , s + 1} [ \begin{matrix}{Xb}_{( k )} \\ {Yb}_{( k )} \\ 1\end{matrix} ] & ( 238 )\end{matrix}$$

In addition, the homogeneous transformation matrix H_{N,1} is also acquired in the same manner as in the calculation of the homogeneous transformation matrixes H_{s,s+1}.

In Step S793, the direction specifying unit 63 specifies the tilt direction and the rotation direction of the image processing apparatus 621 based on the homogeneous transformation matrixes supplied from the positional relationship calculation unit 632, and supplies the tilt direction and the rotation direction to the distortion specifying unit 635.

Specifically, the direction specifying unit 633 acquires an average value of elements on the first row and the third column and an average value of elements on the first row and the second column of the homogeneous transformation matrixes H_{s,s+1} (where s=1 to N−1) and the homogeneous transformation matrix H_{N,1}. That is, the average value of the values of the aforementioned Equation (236) and an average value of the values of Equation (237) are acquired.

Then, the direction specifying unit 633 specifies the tilt direction and the rotation direction of the image processing apparatus 621 based on the respective acquired average values and a table shown in FIG. 131, which is recorded in advance (table). With such processing, one of the upper direction, the lower direction, and no tilting is specified as a tilt angle, and one of the right direction (right rotation) and the left direction (left rotation) is specified as a rotation direction.

For example, when the average value of the elements on the first row and the third column is positive and the average value of the elements on the first row and the second column is negative, it is determined that the tilt direction is the upward direction and the rotation direction is the right direction based on FIG. 131.

More specifically, when the average value of the elements on the first row and the third column of the homogeneous transformation matrixes is zero, the image processing apparatus 621 is not rotated, and therefore, it is determined that presence of lens distortion cannot be determined, and the distortion detection processing is completed.

In Step S794, the accumulation unit 634 accumulates the homogeneous transformation matrix H_{s,s+1} (where s=1 to N−1) and the homogeneous transformation matrix H_{N,1} supplied from the positional relationship calculation unit 632, calculates a homogeneous transformation matrix H_{round} after the image processing apparatus 621 is turned, and supplies the homogeneous transformation matrix H_{round} to the distortion specifying unit 635.

Specifically, the accumulation unit 634 calculates the homogeneous transformation matrix H_{round} by calculating the following Equation (239).

[Math. 239]

H_{round}≡H1,2H2,3H_{3,4} . . . H_{N-2,N-1}H_{N-1,N}H_{N,1} (239)

In Step S795, the distortion specifying unit 635 specifies lens distortion on the captured images based on the tilt direction and the rotation direction supplied from the direction specifying unit 633 and the homogeneous transformation matrix H_{round} supplied from the accumulation unit 634, and outputs the specification result. For example, whether barrel-shaped distortion is present, bobbin-shaped distortion is present, or distortion is not present in the captured images (lens) is specified.

Specifically, the distortion specifying unit 635 specifies which position the center position (0, 0) of the N-th captured image after the image processing apparatus 621 is rotated by one circuit when the images are captured corresponds to on the initial first captured image. Here, the center position (0, 0) of the N-th captured image is a center position of the N-th captured image in the XY coordinate system with reference to the imaging direction of the N-th captured image, and which position the center position is located at in the XY coordinate system with reference to the imaging direction of the first captured image is specified.

That is, the distortion specifying unit 635 calculates the position (Xc, Yc) (vector (Xc, Yc)) by calculating the following Equation (240). The position (Xc, Yc) is a position of the center position (0, 0) of the N-th captured image in the coordinate system with reference to the imaging direction of the N-th captured image, in the coordinate system with reference to the imaging direction of the first captured image.

$$\begin{matrix}[ Math . 240 ] & \\ [ \begin{matrix}Xc \\ Yc \\ 1\end{matrix} ] ∝ {H}_{round} [ \begin{matrix}0 \\ 0 \\ 1\end{matrix} ] & ( 240 )\end{matrix}$$

In addition, the distortion specifying unit 635 specifies which direction the Y axis of the captured image after the image processing apparatus 621 is rotated by one circuit, namely the N-th captured image corresponds to on the initial first captured image. Specifically, the distortion specifying unit 635 specifies in which direction the Y axis of the N-th captured image is directed in the coordinate system with reference to the imaging direction of the first captured image by calculating the following Equation (241) and further calculating the following Equation (242).

$$\begin{matrix}[ Math . 241 ] & \\ [ \begin{matrix}Xtmp \\ Ytmp \\ 1\end{matrix} ] ∝ {H}_{round} [ \begin{matrix}0 \\ 1 \\ 1\end{matrix} ] & ( 241 ) \\ [ Math . 242 ] & \\ [ \begin{matrix}Xd \\ Yd\end{matrix} ] ≡ [ \begin{matrix}Xtmp \\ Ytmp\end{matrix} ] - [ \begin{matrix}Xc \\ Yc\end{matrix} ] & ( 242 )\end{matrix}$$

In addition, a vector (Xd, Yd) acquired by the calculation of Equation (242) represents a direction of the Y axis of the N-th captured image in the coordinate system with reference to the imaging direction of the first captured image.

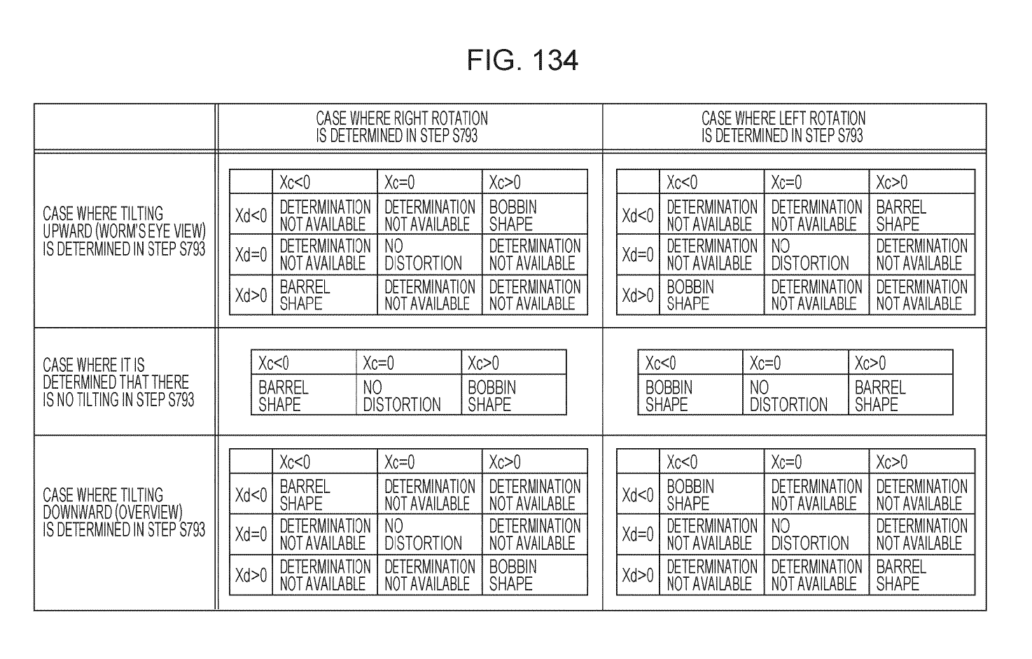

Furthermore, the distortion specifying unit 635 specifies lens distortion by using the thus acquired value of Xc, the value of Xd, and the table shown in FIG. 134, which is recorded in advance (table).

In the table shown in FIG. 134, more tables are prepared for each combination of the tilt direction and the rotation direction.

When the tilt direction is the upper direction and the rotation direction is the right direction (right rotation), the upper left table in the drawing is used.

In such a case, it is determined that bobbin-shaped distortion has occurred when Xc>0 and Xd<0, it is determined that no distortion has occurred when Xc=0 and Xd=0, it is determined that barrel-shaped distortion has occurred when Xc<0 and Xd>0, and it is determined that determination cannot be made in the other cases.

Here, the case where determination cannot be made is a case where distortion specified by the value of Xc has no consistency with the distortion specified by the value of Xd, and in such a case, it is determined that the determination on the presence of the lens distortion cannot be made, and the distortion detection processing is completed.

In addition, when there is no tilt in relation to the tilt direction and the rotation direction is the right direction, for example, the left center table in the drawing is used. In such a case, it is determined that the barrel-shaped distortion has occurred when Xc<0, it is determined that no distortion has occurred when Xc=0, and it is determined that the bobbin-shaped distortion has occurred when Xc>0.

Furthermore, when the tilt direction is the downward direction and the rotation direction is the right direction, for example, the left lower table in the drawing is used.

In such a case, it is determined that the barrel-shaped distortion has occurred when Xc<0 and Xd<0, it is determined that no distortion has occurred when Xc=0 and Xd=0, it is determined that the bobbin-shaped distortion has occurred when Xc>0 and Xd>0, and it is determined that determination cannot be made in the other cases.

Similarly, when the tilt direction is the upper direction and the rotation direction is the left direction (left rotation), for example, the right upper table in the drawing is used.

In such a case, it is determined that the barrel-shaped distortion has occurred when Xc>0 and Xd<0, it is determined that no distortion has occurred when Xc=0 and Xd=0, it is determined that the bobbin-shaped distortion has occurred when Xc<0 and Xd>0, and it is determined that determination cannot be made in the other cases.

In addition, when there is no tilt in relation to the tilt direction and the rotation direction is the left direction, for example, the right center table in the drawing is used. In such a case, it is determined that the bobbin-shaped distortion has occurred when Xc<0, it is determined that no distortion has occurred when Xc=0, and it is determined that the barrel-shaped distortion has occurred when Xc>0.

Furthermore, when the tilt direction is the downward direction and the rotation direction is the left direction, for example, the right lower table in the drawing is used.

In such a case, it is determined that the bobbin-shaped distortion has occurred when Xc<0 and Xd<0, it is determined that no distortion has occurred when Xc=0 and Xd=0, it is determined that the barrel-shaped distortion has occurred when Xc>0 and Xd>0, and it is determined that determination cannot be made in the other cases.

The distortion specifying unit 635 specifies the lens distortion with reference to the table shown in FIG. 134 and outputs the specification result, and the distortion detection processing is completed.

As described above, the image processing apparatus 621 analyzes captured images successively captured and acquired while being panned, namely turned by 360°, acquires the positional relationships between the captured images, and acquires the calculatory center position of the captured image after the image processing apparatus 621 is turned. Then, the image processing apparatus 621 specifies presence of lens distortion and a type of the lens distortion by utilizing the characteristic that the acquired center position does not return to the original center position due to the lens distortion although the acquired center position is supposed to return to the original position, namely the center position of the first captured image. With such processing, it is possible to more simply and quickly acquire the lens distortion.

In addition, the present technology described in the fourteenth embodiment can be configured as follows.

[1] A lens distortion amount measurement method including:

a positional relationship calculation step in which positional relationships between adjacent captured images are calculated based on the captured images which are successively captured by an imaging device provided with a lens while an imaging direction is changed;

a positional relationship accumulation step in which the positional relationships between the captured images are accumulated to acquire a positional relationship of the captured image after the imaging device is turned with respect to the captured image as a reference; and

a distortion determination step in which distortion of the lens is determined based on the positional relationship of the captured image after the imaging device is turned with respect to the captured image as the reference.

[2] The lens distortion amount measurement method according to [1],

wherein in the distortion determination step, it is determined that distortion of the lens is barrel-shaped distortion when the positional relationship of the captured image after the imaging device is turned with respect to the captured image as the reference is less than 360°, and it is determined that distortion of the lens is bobbin-shaped distortion when the positional relationship of the captured image after the imaging device is turned with respect to the captured image as the reference exceeds 360°.

[3] The lens distortion amount measurement method according to [1],

wherein in the distortion determination step,
it is determined that distortion of the lens is the barrel-shaped distortion when any one of the following conditions is satisfied, that is,
when a first condition is satisfied, that is, when the captured images are captured while the imaging device is tilted upward (worm's eye view) and is rotated rightward and a positional relationship of the captured image after the imaging device is turned with respect to the captured image as the reference is inclined in a clockwise direction,
when a second condition is satisfied, that is, when the captured images are captured while the imaging device is tilted upward (worm's eye view) and is rotated leftward and the positional relationship of the captured image after the imaging device is turned with respect to the captured image as the reference is inclined in a counterclockwise direction,
when a third condition is satisfied, that is, when the captured images are captured while the imaging device is tilted downward (overview) and is rotated rightward and the positional relationship of the captured image after the imaging device is turned with respect to the captured image as the reference is inclined in the counterclockwise direction, or
when a fourth condition is satisfied, that is, when the captured images are captured while the imaging device is tilted downward (overview) and is rotated leftward and the positional relationship of the captured image after the imaging device is turned with respect to the captured image as the reference is inclined in the clockwise direction, and

it is determined that distortion of the lens is bobbin-shaped distortion when one of the following conditions are satisfied, that is,
when a fifth condition is satisfied, that is, when the captured images are captured while the imaging device is tilted upward (worm's eye view) and is rotated rightward and the positional relationship of the captured image after the imaging device is turned with reference to the captured image as the reference is inclined in the counterclockwise direction,
when a sixth condition is satisfied, that is, when the captured images are captured while the imaging device is tilted upward (worm's eye view) and is rotated leftward and the positional relationship of the captured image after the imaging device is turned with respect to the captured image as the reference is inclined in the clockwise direction,
when a seventh condition is satisfied, that is, when the captured images are captured while the imaging device is tilted downward (overview) and is rotated rightward and the positional relationship of the captured image after the imaging device is turned with respect to the captured image as the reference is inclined in the counterclockwise direction, or
when an eighth condition is satisfied, that is, when the captured images are captured while the imaging device is tilted downward (overview) and is rotated leftward and the positional relationship of the captured image after the imaging device is turned with respect to the captured image as the reference is inclined in the counterclockwise direction.

Incidentally, the aforementioned series of processing can be executed by hardware or software. When the series of processing is executed by software, a program configuring the software is installed in a computer. Here, the computer includes a computer which is assembled in a dedicated hardware, and a general-purposed personal computer capable of executing various functions by installing various programs.

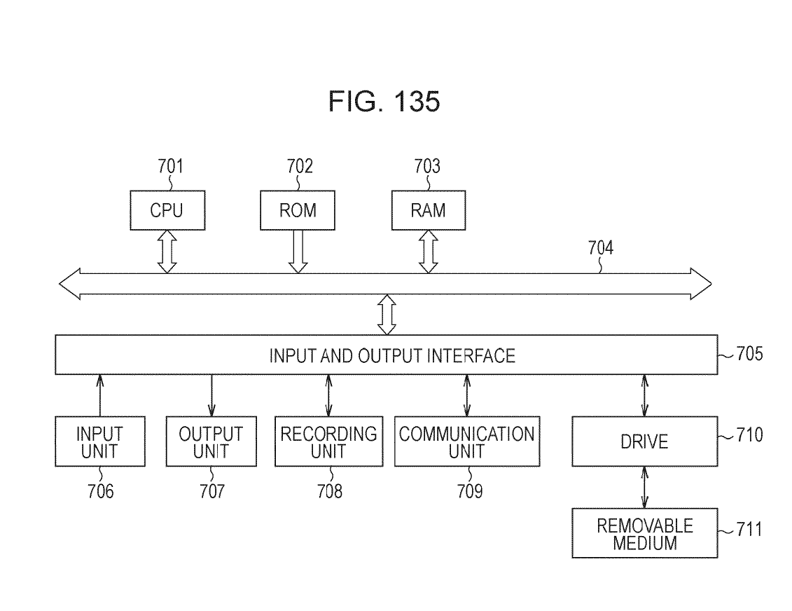

FIG. 135 is a block diagram showing a configuration example of hardware of a computer which executes the aforementioned series of processing by a program.

In the computer, a CPU (Central Processing Unit) 701, a ROM (Read Only Memory) 702, and a RAM (Random Access Memory) 703 are connected to each other by a bus 704.

Furthermore, an input and output interface 705 is connected to the bus 704. To the input and output interface 705, an input unit 706, an output unit 707, a recording unit 708, a communication unit 709, and a drive 710 are connected.

The input unit 706 is configured of a keyboard, a mouse, a microphone, and the like. The output unit 707 is configured of a display, a speaker, and the like. The recording unit 708 is configured of a hard disk, a non-volatile memory, and the like. The communication unit 709 is configured of a network interface and the like. The drive 710 drives a removable medium 711 such as a magnetic disk, an optical disc, a magneto-optical disc, or a semiconductor memory.

In the computer configured as described above, the aforementioned series of processing is performed by the CPU 701 loading the program, which is recorded in the recording unit 708, for example, in the RAM 703 via the input and output interface 705 and the bus 704 and executing the program.

The program executed by the computer (CPU 701) can be provided by being recorded as a package medium or the like in a recording medium 711. In addition, the program can be provided via a wired or wireless transmission medium such as a local area network, the Internet, or digital satellite broadcasting.

According to the computer, the program can be installed in the recording unit 708 via the input and output interface 705 by attaching the removable medium 711 to the drive 710. In addition, the program can be received by the communication unit 709 via a wired or wireless transmission medium and installed in the recording unit 708. In another example, the program can be installed in advance in the ROM 702 or the recording unit 708.

In addition, the program executed by the computer may be a program by which the processing is performed in the time series manner in the order described in this specification or may be a program by which the processing is performed in parallel or as necessary when the program is accessed, for example.

In addition, embodiments of the present technology are not limited to the aforementioned embodiments, and various modifications can be made without departing from the gist of the present technology.

For example, it is possible to employ, for the present technology, a configuration of cloud computing in which one function is allocated to a plurality of apparatuses via a network and is processed in a cooperative manner.

In addition, the respective steps described in the aforementioned flowcharts may be executed by a single apparatus or may be allocated to and executed by a plurality of apparatuses.

Furthermore, when a plurality of processes are included in a single step, the plurality of processes included in the step can be executed by a single apparatus or can be allocated to and executed by a plurality of apparatuses.

Furthermore, the present technology can be configured as follows.

[1] An information processing apparatus which generates a single data item by connecting a plurality of data arranged in an order, the apparatus including:

a first map calculation unit which calculates a map H1 representing a correlation between mutually adjacent data items under a first condition with a higher degree of freedom;

a second map calculation unit which calculates a map H2 representing the correlation between the mutually adjacent data items under a second condition with a lower degree of freedom as compared to the first condition; and

a data generation unit which acquires a map H3 and generates the single data item based on the map H3, the map H3 being configured such that the correlation between target data as the data item and adjacent data adjacent to the target data becomes a relationship closer to the correlation represented by the map H1 than to the correlation represented by the map H2 at a position in the target data close to the adjacent data and becomes a relationship closer to the relationship represented by the map H2 than to the correlation represented by the map H1 at a position in the target data far from the adjacent data, based on the map H1 and the map H2.

[2] The information processing apparatus according to [1],

wherein the map H3 is a map configured such that the correlation at each position in the target data is a relationship acquired by prorating the correlation represented by the map H1 and the correlation represented by the map H2 in accordance with the position in the target data.

[3] The information processing apparatus according to [1] or [2],

wherein the map H3 is a map configured such that the correlation between the target data and the adjacent data becomes the correlation represented by the map H1 at a first position in the target data in the vicinity of the adjacent data and becomes the correlation represented by the map H2 at a second position in the target data far from the adjacent data.

[4] The information processing apparatus according to any one of [1] to [3],

wherein the plurality of data items are a plurality of captured images arranged in an order, and

wherein the data generation unit generates a panoramic image as the single data by acquiring a homogeneous transformation matrixes representing positional relationships between the captured images as the map H3 and connecting the captured images based on the homogeneous transformation matrix.

[5] The information processing apparatus according to [4],

wherein the first map calculation unit calculates a homogeneous transformation matrixes Q1 which represent positional relationships between the mutually adjacent captured images as the map H1,

wherein the second map calculation unit calculates homogeneous transformation matrixes Q2 which represent positional relationships between the mutually adjacent captured images as the map H2 under a condition that the map H2 is an orthogonal matrix,

wherein the information processing apparatus further includes
a first homogeneous transformation matrix calculation unit which calculates a homogeneous transformation matrix Q1₁ₛ representing a positional relationship between a reference first captured image and an s-th captured image by accumulating the homogeneous transformation matrixes Q2 acquired for the first captured image to an s−1-th captured image in the captured images arranged in an order and multiplying the accumulated homogeneous transformation matrixes Q2 by the homogeneous transformation matrix Q1 of the s-th captured image, and
   a second homogeneous transformation matrix calculation unit which calculates a homogeneous transformation matrix Q2₁ₛ representing a positional relationship between the first and the s-th captured images by accumulating the homogeneous transformation matrixes Q2 acquired for the first to the s-th captured images, and
wherein the data generation unit calculates a homogeneous transformation matrix Q3₁ₛ as the map H3 representing a positional relationship between the first and the s-th captured images based on the homogeneous transformation matrix Q1₁ₛ, and the homogeneous transformation matrix Q2₁ₛ.

[6] The information processing apparatus according to [5],

wherein the data generation unit acquires the homogeneous transformation matrix Q3₁ₛ at each position on the s-th captured image by performing weighted addition of the homogeneous transformation matrix Q1₁ₛ and the homogeneous transformation matrix Q2₁ₛ with a weight in accordance with the position on the s-th captured image.

[7] The information processing apparatus according to any one of [1] to [3],

wherein the plurality of data items are a plurality of captured images arranged in an order, and

wherein the data generation unit generates a panoramic image as the single data item by acquiring gain values of the respective color components between the captured images as the map H3 and connecting the captured images after gain adjustment based on the gain values.

[8] The information processing apparatus according to [7],

wherein the first map calculation unit calculates gain values G1 of the respective color components between the mutually adjacent captured images as the map H1 under a condition that the gain values of the respective color components are independent,

wherein the second map calculation unit calculates gain values G2 of the respective color components between the mutually adjacent captured images as the map H2 under a condition that the gain values of the respective color components are the same,

wherein the information processing apparatus further includes
a first accumulated gain value calculation unit which calculates a gain value G11s between a reference first captured image and an s-th captured image by accumulating the gain values G2 acquired for the first captured image to an s−1-th captured image in the captured images arranged in an order and multiplying the accumulated gain values G2 by the gain value G1 of the s-th captured image, and
a second accumulated gain value calculation unit which calculates a gain value G2₁ₛ between the first and the s-th captured images by accumulating the gain values G2 acquired for the first to the s-th captured images, and

wherein the data generation unit calculates a gain value G3₁ₛ between the first and the s-th captured images as the map H3 based on the gain value G1₁ₛ and the gain value G2₁ₛ.

[9] The information processing apparatus according to [8],

wherein the data generation unit acquires the gain value G3₁ₛ at each position on the s-th captured image by performing weighted addition of the gain value G1₁ₛ and the gain value G2₁ₛ with a weight in accordance with the position on the s-th captured image.

[10] An information processing method for generating a single data item by connecting a plurality of data items arranged in an order, the method including the steps of:

calculating a map H1 which represents a correlation between mutually adjacent data items under a first condition with a higher degree of freedom;

calculating a map H2 which represents the correlation between the mutually adjacent data items under a second condition with a lower degree of freedom as compared to the first condition; and

acquiring a map H3 and generating the single data item based on the map H3, the map H3 being configured such that the correlation between target data as the data item and adjacent data adjacent to the target data becomes a relationship closer to the correlation represented by the map H1 than to the correlation represented by the map H2 at a position in the target data close to the adjacent data and becomes a relationship closer to the relationship represented by the map H2 than to the correlation represented by the map H1 at a position in the target data far from the adjacent data, based on the map H1 and the map H2.

[11] A program for information processing, which is for generating a single data item by connecting a plurality of data items arranged in an order, and which causes a computer to execute processing including the steps of:

calculating a map H1 which represents a correlation between mutually adjacent data items under a first condition with a higher degree of freedom;

calculating a map H2 which represents the correlation between the mutually adjacent data items under a second condition with a lower degree of freedom as compared to the first condition; and

acquiring a map H3 and generating the single data item based on the map H3, the map H3 being configured such that the correlation between target data as the data item and adjacent data adjacent to the target data becomes a relationship closer to the correlation represented by the map H1 than to the correlation represented by the map H2 at a position in the target data close to the adjacent data and becomes a relationship closer to the relationship represented by the map H2 than to the correlation represented by the map H1 at a position in the target data far from the adjacent data, based on the map H1 and the map H2.

[12] An image processing apparatus including:

a forward direction calculation unit which calculates a homogeneous transformation matrix Q1 representing a positional relationship between a reference first captured image and an s-th captured image by accumulating, in ascending order from the first captured image to an s-th captured image, homogeneous transformation matrixes H representing positional relationships between mutually adjacent captured images acquired for the N respective captured images that an imaging device captures while being turned;

a backward direction calculation unit which calculates a homogeneous transformation matrix Q2 representing a positional relationship between the first and the s-th captured images by accumulating inverse matrixes of the homogeneous transformation matrixes H in descending order from the N-th captured image to the s-th captured image; and

a homogeneous transformation matrix calculation unit which calculates a homogeneous transformation matrix Q3 representing a positional relationship between the first and the s-th captured images by prorating the homogeneous transformation matrix Q1 and the homogeneous transformation matrix Q2.

[13] The image processing apparatus according to [12],

wherein the homogeneous transformation matrix calculation unit prorates the homogeneous transformation matrix Q1 and the homogeneous transformation matrix Q2 such that a proportion of the proration of the homogeneous transformation matrix Q1 becomes greater as a difference in imaging orders between the first and the s-th captured images is smaller.

[14] The image processing apparatus according to [13],

wherein the homogeneous transformation matrix calculation unit prorates the homogeneous transformation matrix Q1 and the homogeneous transformation matrix Q2 such that a difference between a proportion of the proration of the homogeneous transformation matrix Q1 for the s−1-th captured image and a proportion of the proration of the homogeneous transformation matrix Q1 for the s-th captured image becomes greater as an angle between a direction of the s−1-th captured image and a direction of the s-th captured image is larger.

[15] The image processing apparatus according to any one of [12] to [14],

wherein the homogeneous transformation matrix calculation unit prorates the homogeneous transformation matrix Q1 and the homogeneous transformation matrix Q2 by performing weighted addition of a direction acquired by transforming a predetermined direction with reference to the s-th captured image by the homogeneous transformation matrix Q1 and a direction acquired by transforming the predetermined direction by the homogeneous transformation matrix Q2.

[16] The image processing apparatus according to any one of [12] to [15], further including: a panoramic image generation unit which generates a panoramic image by connecting the captured images based on the homogeneous transformation matrix Q3.

[17] An image processing method including the steps of:

calculating a homogeneous transformation matrix Q1 representing a positional relationship between a reference first captured image and an s-th captured image by accumulating, in ascending order from the first captured image to an s-th captured image, homogeneous transformation matrixes H representing positional relationships between mutually adjacent captured images acquired for the N respective captured images that an imaging device captures while being turned;

calculating a homogeneous transformation matrix Q2 representing a positional relationship between the first and the s-th captured images by accumulating inverse matrixes of the homogeneous transformation matrixes H in descending order from the N-th captured image to the s-th captured image; and

calculating a homogeneous transformation matrix Q3 representing a positional relationship between the first and the s-th captured images by prorating the homogeneous transformation matrix Q1 and the homogeneous transformation matrix Q2.

[18] A program which causes a computer to execute processing including the steps of:

calculating a homogeneous transformation matrix Q1 representing a positional relationship between a reference first captured image and an s-th captured image by accumulating, in ascending order from the first captured image to the s-th captured image, homogeneous transformation matrixes H representing positional relationships between mutually adjacent captured images acquired for the N respective captured images that an imaging device captures while being turned;

calculating a homogeneous transformation matrix Q2 representing a positional relationship between the first and the s-th captured images by accumulating inverse matrixes of the homogeneous transformation matrixes H in descending order from the N-th captured image to the s-th captured image; and

calculating a homogeneous transformation matrix Q3 representing a positional relationship between the first and the s-th captured images by prorating the homogeneous transformation matrix Q1 and the homogeneous transformation matrix Q2.

### REFERENCE SIGNS LIST

101 IMAGE PROCESSING APPARATUS, 113 FORWARD DIRECTION CALCULATION UNIT, 114 BACKWARD DIRECTION CALCULATION UNIT, 115 OPTIMIZED HOMOGENEOUS TRANSFORMATION MATRIX CALCULATION UNIT, 261 IMAGE PROCESSING APPARATUS, 273 POSITIONAL RELATIONSHIP CALCULATION UNIT, 274 POSITIONAL RELATIONSHIP CALCULATION UNIT, 275 HOMOGENEOUS TRANSFORMATION MATRIX CALCULATION UNIT, 276 HOMOGENEOUS TRANSFORMATION MATRIX CALCULATION UNIT, 277 PANORAMIC IMAGE GENERATION UNIT, 301 IMAGE PROCESSING APPARATUS, 312 GAIN VALUE CALCULATION UNIT, 313 GAIN VALUE CALCULATION UNIT, 314 ACCUMULATED GAIN VALUE CALCULATION UNIT, 315 ACCUMULATED GAIN VALUE CALCULATION UNIT, 316 PANORAMIC IMAGE GENERATION UNIT

1. An information processing apparatus which generates a single data item by connecting a plurality of data arranged in an order, the apparatus comprising:
a first map calculation unit which calculates a map H1 representing a correlation between mutually adjacent data items under a first condition with a higher degree of freedom;
a second map calculation unit which calculates a map H2 representing the correlation between the mutually adjacent data items under a second condition with a lower degree of freedom as compared to the first condition; and
a data generation unit which acquires a map H3 and generates the single data item based on the map H3, the map H3 being configured such that the correlation between target data as the data item and adjacent data adjacent to the target data becomes a relationship closer to the correlation represented by the map H1 than to the correlation represented by the map H2 at a position in the target data close to the adjacent data and becomes a relationship closer to the relationship represented by the map H2 than to the correlation represented by the map H1 at a position in the target data far from the adjacent data, based on the map H1 and the map H2.

2. The information processing apparatus according to claim 1,
wherein the map H3 is a map configured such that the correlation at each position in the target data is a relationship acquired by prorating the correlation represented by the map H1 and the correlation represented by the map H2 in accordance with the position in the target data.

3. The information processing apparatus according to claim 2,
wherein the map H3 is a map configured such that the correlation between the target data and the adjacent data becomes the correlation represented by the map H1 at a first position in the target data in the vicinity of the adjacent data and becomes the correlation represented by the map H2 at a second position in the target data far from the adjacent data.

4. The information processing apparatus according to claim 1,
wherein the plurality of data items are a plurality of captured images arranged in an order, and
wherein the data generation unit generates a panoramic image as the single data by acquiring a homogeneous transformation matrixes representing positional relationships between the captured images as the map H3 and connecting the captured images based on the homogeneous transformation matrix.

5. The information processing apparatus according to claim 4,
wherein the first map calculation unit calculates a homogeneous transformation matrixes Q1 which represent positional relationships between the mutually adjacent captured images as the map H1,
wherein the second map calculation unit calculates homogeneous transformation matrixes Q2 which represent positional relationships between the mutually adjacent captured images as the map H2 under a condition that the map H2 is an orthogonal matrix,
wherein the information processing apparatus further comprises
a first homogeneous transformation matrix calculation unit which calculates a homogeneous transformation matrix Q1₁ₛ representing a positional relationship between a reference first captured image and an s-th captured image by accumulating the homogeneous transformation matrixes Q2 acquired for the first captured image to an s−1-th captured image in the captured images arranged in an order and multiplying the accumulated homogeneous transformation matrixes Q2 by the homogeneous transformation matrix Q1 of the s-th captured image, and
a second homogeneous transformation matrix calculation unit which calculates a homogeneous transformation matrix Q2₁ₛ representing a positional relationship between the first and the s-th captured images by accumulating the homogeneous transformation matrixes Q2 acquired for the first to the s-th captured images, and
wherein the data generation unit calculates a homogeneous transformation matrix Q3₁ₛ as the map H3 representing a positional relationship between the first and the s-th captured images based on the homogeneous transformation matrix Q1₁ₛ, and the homogeneous transformation matrix Q2₁ₛ.

6. The information processing apparatus according to claim 5,
wherein the data generation unit acquires the homogeneous transformation matrix Q3₁ₛ at each position on the s-th captured image by performing weighted addition of the homogeneous transformation matrix Q1₁ₛ and the homogeneous transformation matrix Q2₁ₛ with a weight in accordance with the position on the s-th captured image.

7. The information processing apparatus according to claim 1,
wherein the plurality of data items are a plurality of captured images arranged in an order, and
wherein the data generation unit generates a panoramic image as the single data item by acquiring gain values of the respective color components between the captured images as the map H3 and connecting the captured images after gain adjustment based on the gain values.

8. The information processing apparatus according to claim 7,
wherein the first map calculation unit calculates gain values G1 of the respective color components between the mutually adjacent captured images as the map H1 under a condition that the gain values of the respective color components are independent,
wherein the second map calculation unit calculates gain values G2 of the respective color components between the mutually adjacent captured images as the map H2 under a condition that the gain values of the respective color components are the same,
wherein the information processing apparatus further comprises
a first accumulated gain value calculation unit which calculates a gain value G1₁ₛ between a reference first captured image and an s-th captured image by accumulating the gain values G2 acquired for the first captured image to an s−1-th captured image in the captured images arranged in an order and multiplying the accumulated gain values G2 by the gain value G1 of the s-th captured image, and
a second accumulated gain value calculation unit which calculates a gain value G2₁ₛ between the first and the s-th captured images by accumulating the gain values G2 acquired for the first to the s-th captured images, and
wherein the data generation unit calculates a gain value G3₁ₛ between the first and the s-th captured images as the map H3 based on the gain value G1₁ₛ and the gain value G2₁ₛ.

9. The information processing apparatus according to claim 8,
wherein the data generation unit acquires the gain value G3₁ₛ at each position on the s-th captured image by performing weighted addition of the gain value G1₁ₛ and the gain value G2₁ₛ with a weight in accordance with the position on the s-th captured image.

10. An information processing method for generating a single data item by connecting a plurality of data items arranged in an order, the method comprising the steps of:
calculating a map H1 which represents a correlation between mutually adjacent data items under a first condition with a higher degree of freedom;
calculating a map H2 which represents the correlation between the mutually adjacent data items under a second condition with a lower degree of freedom as compared to the first condition; and
acquiring a map H3 and generating the single data item based on the map H3, the map H3 being configured such that the correlation between target data as the data item and adjacent data adjacent to the target data becomes a relationship closer to the correlation represented by the map H1 than to the correlation represented by the map H2 at a position in the target data close to the adjacent data and becomes a relationship closer to the relationship represented by the map H2 than to the correlation represented by the map H1 at a position in the target data far from the adjacent data, based on the map H1 and the map H2.

11. A program for information processing, which is for generating a single data item by connecting a plurality of data items arranged in an order, and which causes a computer to execute processing comprising the steps of:
calculating a map H1 which represents a correlation between mutually adjacent data items under a first condition with a higher degree of freedom;
calculating a map H2 which represents the correlation between the mutually adjacent data items under a second condition with a lower degree of freedom as compared to the first condition; and
acquiring a map H3 and generating the single data item based on the map H3, the map H3 being configured such that the correlation between target data as the data item and adjacent data adjacent to the target data becomes a relationship closer to the correlation represented by the map H1 than to the correlation represented by the map H2 at a position in the target data close to the adjacent data and becomes a relationship closer to the relationship represented by the map H2 than to the correlation represented by the map H1 at a position in the target data far from the adjacent data, based on the map H1 and the map H2.

12. An image processing apparatus comprising:
a forward direction calculation unit which calculates a homogeneous transformation matrix Q1 representing a positional relationship between a reference first captured image and an s-th captured image by accumulating, in ascending order from the first captured image to an s-th captured image, homogeneous transformation matrixes H representing positional relationships between mutually adjacent captured images acquired for the N respective captured images that an imaging device captures while being turned;
a backward direction calculation unit which calculates a homogeneous transformation matrix Q2 representing a positional relationship between the first and the s-th captured images by accumulating inverse matrixes of the homogeneous transformation matrixes H in descending order from the N-th captured image to the s-th captured image; and
a homogeneous transformation matrix calculation unit which calculates a homogeneous transformation matrix Q3 representing a positional relationship between the first and the s-th captured images by prorating the homogeneous transformation matrix Q1 and the homogeneous transformation matrix Q2.

13. The image processing apparatus according to claim 12,
wherein the homogeneous transformation matrix calculation unit prorates the homogeneous transformation matrix Q1 and the homogeneous transformation matrix Q2 such that a proportion of the proration of the homogeneous transformation matrix Q1 becomes greater as a difference in imaging orders between the first and the s-th captured images is smaller.

14. The image processing apparatus according to claim 13,
wherein the homogeneous transformation matrix calculation unit prorates the homogeneous transformation matrix Q1 and the homogeneous transformation matrix Q2 such that a difference between a proportion of the proration of the homogeneous transformation matrix Q1 for the s−1-th captured image and a proportion of the proration of the homogeneous transformation matrix Q1 for the s-th captured image becomes greater as an angle between a direction of the s−1-th captured image and a direction of the s-th captured image is larger.

15. The image processing apparatus according to claim 12,
wherein the homogeneous transformation matrix calculation unit prorates the homogeneous transformation matrix Q1 and the homogeneous transformation matrix Q2 by performing weighted addition of a direction acquired by transforming a predetermined direction with reference to the s-th captured image by the homogeneous transformation matrix Q1 and a direction acquired by transforming the predetermined direction by the homogeneous transformation matrix Q2.

16. The image processing apparatus according to claim 15, further comprising:
a panoramic image generation unit which generates a panoramic image by connecting the captured images based on the homogeneous transformation matrix Q3.

17. An image processing method comprising the steps of:
calculating a homogeneous transformation matrix Q1 representing a positional relationship between a reference first captured image and an s-th captured image by accumulating, in ascending order from the first captured image to an s-th captured image, homogeneous transformation matrixes H representing positional relationships between mutually adjacent captured images acquired for the N respective captured images that an imaging device captures while being turned;
calculating a homogeneous transformation matrix Q2 representing a positional relationship between the first and the s-th captured images by accumulating inverse matrixes of the homogeneous transformation matrixes H in descending order from the N-th captured image to the s-th captured image; and
calculating a homogeneous transformation matrix Q3 representing a positional relationship between the first and the s-th captured images by prorating the homogeneous transformation matrix Q1 and the homogeneous transformation matrix Q2.

18. A program which causes a computer to execute processing comprising the steps of:
calculating a homogeneous transformation matrix Q1 representing a positional relationship between a reference first captured image and an s-th captured image by accumulating, in ascending order from the first captured image to the s-th captured image, homogeneous transformation matrixes H representing positional relationships between mutually adjacent captured images acquired for the N respective captured images that an imaging device captures while being turned;
calculating a homogeneous transformation matrix Q2 representing a positional relationship between the first and the s-th captured images by accumulating inverse matrixes of the homogeneous transformation matrixes H in descending order from the N-th captured image to the s-th captured image; and
calculating a homogeneous transformation matrix Q3 representing a positional relationship between the first and the s-th captured images by prorating the homogeneous transformation matrix Q1 and the homogeneous transformation matrix Q2.
